(19) United States
(12) Patent Application Publication
(10) Pub. No.: US 2021/0289794 A1
(43) Pub. Date: Sep. 23, 2021

(54) COMPOSITIONS AND RELATED METHODS FOR AGRICULTURE

(71) Applicant: Flagship Pioneering Innovations V, Inc., Cambridge, MA (US)

(72) Inventors: Ignacio MARTINEZ, Lexington, MA (US); Maier Steve AVENDANO AMADO, Cambridge, MA (US); Thomas Michael MALVAR, North Stonington, CT (US); Rama Krishna SIMHADRI, Brookline, MA (US); Yunlong YANG, Melrose, MA (US); Adam Javier MARTINEZ, Revere, MA (US)

(21) Appl. No.: 17/262,436

(22) PCT Filed: Jul. 25, 2019
(86) PCT No.: PCT/US19/43354

§ 371 Date: Jan. 22, 2021

Related U.S. Application Data
(60) Provisional application No. 62/703,304, filed on Jul. 25, 2018.

(51) Int. Cl. A01N 63/20; A01N 25/06

(52) U.S. Cl. CPC A01N 63/20; A01N 25/06

(57) ABSTRACT

The invention comprises methods for decreasing colonization by a bacterium of a gut of a stink bug, the method comprising providing a composition comprising vanillin or an analog thereof; and delivering said composition to an egg from which the stink bug will hatch, whereby colonization by the bacterium within the gut of the stink bug hatched from the egg treated with the composition is decreased relative to a stink bug hatched from an untreated egg. In some embodiments, the decrease in colonization by the bacterium decreases the fitness of the stink bug, e.g., decreases reproductive ability, survival, rate of development, number of eggs, number of hatched eggs, adult emergence rate, body length, body width, body mass, or cuticle thickness. In some embodiments of the methods herein, the bacterial colonization-disrupting agent is an inhibitor of bacterial metabolism. In some embodiments, the bacterial colonization-disrupting agent is a polyhydroxyalkanoate (PHA) synthesis inhibitor.

### CROSS-REFERENCE TO RELATED APPLICATIONS

This application claims benefit of U.S. Provisional Application No. 62/703,304, filed Jul. 25, 2018, the contents of which are incorporated herein by reference in their entirety.

### SEQUENCE LISTING

The instant application contains a Sequence Listing which has been submitted electronically in ASCII format and is hereby incorporated by reference in its entirety. Said ASCII copy, created on Jul. 17, 2019, is named 51215-012WO2_Sequence_Listing_07.17.19_ST25 and is 60,129 bytes in size.

### BACKGROUND

Plant pests, including insect pests, are pervasive in the human environment.

### SUMMARY OF THE INVENTION

In a first aspect, the invention comprises a method for decreasing colonization by a bacterium of a gut of a stink bug, the method comprising (a) providing a composition comprising vanillin or an analog thereof; and (b) delivering said composition to an egg from which the stink bug will hatch, whereby colonization by the bacterium within the gut of the stink bug hatched from the egg treated with the composition is decreased relative to a stink bug hatched from an untreated egg.

In some embodiments, the composition is delivered to an egg mass of a stink bug. In some embodiments, the decrease in colonization by the bacterium decreases the fitness of the stink bug, e.g., decreases reproductive ability, survival, rate of development, number of eggs, number of hatched eggs, adult emergence rate, body length, body width, body mass, or cuticle thickness.

In some embodiments, the colonization is in the v4 region of the gut. In some embodiments, colonization by the bacterium of the v4 region of the gut is decreased by at least 5%. In some embodiments, the size of the v4 region of the gut is decreased.

In some embodiments, the stink bug is a Halyomorpha species (e.g., Halyomorpha halys), a Nezara species, an Oebalus species, a Chinavia species, an Euthyrhynchus species, an Euschistus species, an Alcaeorrhynchus species, or a Podisus species.

In some embodiments, the bacterium is an endosymbiont, e.g., an endosymbiont is of the genus Pantoea. In some embodiments, the endosymbiont is Candidatus Pantoea carbekii.

In some embodiments, the composition is a liquid, a solid, an aerosol, a paste, a gel, or a gas composition. In some embodiments, the composition is delivered as a spray. In some embodiments, the composition comprises an agriculturally acceptable carrier. In some embodiments, the composition comprises a wetting solution.

Disclosed herein are compositions and methods for altering the fitness of insects for agriculture or commerce, wherein the composition includes a bacterial colonization-disrupting agent (e.g., an agent (e.g., a lipopolysaccharide (LPS) synthesis inhibitor or a polyhydroxyalkanoate (PHA) synthesis inhibitor) that decreases colonization of a bacteria (e.g., an endosymbiotic bacteria) in the gut of the insect.

In one aspect, provided herein is a method of altering the fitness of an insect comprising delivering to the insect an effective amount of a composition including a bacterial colonization-disrupting agent. In some embodiments, the method includes decreasing the fitness of the insect delivered the bacterial colonization-disrupting agent. Alternatively, in some embodiments, the method includes increasing the fitness of the insect delivered the bacterial colonization-disrupting agent.

In another aspect, provided herein is a method of decreasing bacterial colonization in the gut of an insect including delivering to the insect an effective amount of a composition including a bacterial colonization-disrupting agent.

In some embodiments of the methods herein, the bacterial colonization-disrupting agent is an inhibitor of bacterial metabolism. In some embodiments, the bacterial colonization-disrupting agent is a polyhydroxyalkanoate (PHA) synthesis inhibitor.

In another aspect, provided herein is a method of altering the fitness of an insect including delivering to the insect an effective amount of a composition including a PHA synthesis inhibitor. In some embodiments, the method includes decreasing the fitness of the insect delivered the PHA inhibitor. In some embodiments, the method includes increasing the fitness of the insect delivered the PHA inhibitor.

In some embodiments, the PHA synthesis inhibitor is vanillin or an analog thereof. In some embodiments, the PHA synthesis inhibitor is one or more compounds in Table 1. In some embodiments, the PHA synthesis inhibitor is levulinic acid or an analog thereof. In some embodiments, the PHA synthesis inhibitor is acrylic acid or an analog thereof. In some embodiments, the PHA synthesis inhibitor is 2-bromooctanoic acid or an analog thereof.

In some embodiments of the methods herein, the bacterial colonization-disrupting agent is an inhibitor of cell envelope biogenesis (e.g., biogenesis of the membrane(s) or other structures that surround and protect the bacterial cytoplasm, e.g., cell wall, inner membrane, and outer membrane). In some embodiments of the methods herein, the bacterial colonization-disrupting agent is a lipopolysaccharide (LPS) synthesis inhibitor.

In another aspect, provided herein is a method of altering the fitness of an insect including delivering to the insect an LPS synthesis inhibitor. In some embodiments, the method includes decreasing the fitness of the insect delivered the LPS synthesis inhibitor. In some embodiments, the method includes increasing the fitness of the insect delivered the LPS synthesis inhibitor.

In some embodiments, the LPS synthesis inhibitor is an inhibitor of core oligosaccharide synthesis in the bacteria. In some embodiments, the LPS synthesis inhibitor inhibits an enzyme involved in core oligosaccharide synthesis in the bacteria. In some embodiments, the enzyme has at least 40%, 50%, 60%, 70%, 80%, 90%, 95%, 98%, 99%, or 100% sequence identity to a polypeptide having the amino acid sequence of WaaA, WaaC, WaaF, or WaaG. In some embodiments, the LPS synthesis inhibitor (e.g., the inhibitor of an enzyme involved in LPS synthesis) is a sugar. In some embodiments, the sugar is ADP-2-fluoroheptose (AFH). In some embodiments, the sugar is 2-aryl-5-methyl-4-(5-aryl-furan-2-yl-methylene)-2,4-dihydro-pyrazol-3-ones (DHPO). In some embodiments, the sugar is AFH and DHPO. In some embodiments, the sugar is one or more compounds in Table 7.

In some embodiments, the LPS synthesis inhibitor inhibits expression of a gene involved in core oligosaccharide synthesis in the bacteria. In some embodiments, the gene has at least 40%, 50%, 60%, 70%, 80%, 90%, 95%, 98%, 99%, or 100% sequence identity to a polynucleotide having the nucleotide sequence of waaA, waaC, waaF, or waaG.

In some embodiments, the bacterial colonization-disrupting agent is an inhibitor of bacterial cell wall biogenesis. In some embodiments, the inhibitor of bacterial cell wall biogenesis is an inhibitor of undecaprenyl pyrophosphate phosphatase (UppP), e.g., bacitracin.

In some embodiments, the bacterial colonization-disrupting agent is an inhibitor of flagellar function, e.g., cellulose.

In some embodiments of the methods herein, the insect is a plant pest. In some embodiments, the plant pest is of the order Coleoptera, Diptera, Hemiptera, Lepidoptera, Orthoptera, Thysanoptera, or Acarina. In some embodiments, the insect is a stink bug, bean bug, beetle, weevil, fly, aphid, whitefly, leafhopper, scale, moth, butterfly, grasshopper, cricket, thrip, or mite. In some embodiments, the insect is of the genus Riptortus. In some embodiments, the insect is of the genus Halyomorpha.

In some embodiments of the methods herein, the insect is a vector of an animal pathogen and/or a human pathogen. In some embodiments, the insect is a mosquito, a midge, a louse, a sandfly, a tick, a triatomine bug, a tsetse fly, or flea.

In some embodiments of the methods herein, the bacteria is an endosymbiotic bacteria. In some embodiments, the endosymbiont resides in the gut of the insect. In some embodiments, the bacteria resides in a specialized cell or a specialized organ in the gut of the insect. In some embodiments, the specialized organ is a midgut crypt or a bacteriome. In some embodiments, the specialized cell is a bacteriocyte. In some embodiments, the endosymbiotic bacteria is of the genus Burkholderia. In some embodiments, the endosymbiotic bacteria is of the genus Pantoea.

In some embodiments of the methods herein, the method is effective to decrease the fitness of the insect relative to an untreated insect. In some embodiments, the decrease in fitness of the insect is a decrease (e.g., by about 2%, 5%, 10%, 20%, 30%, 40%, 50%, 60%, 70%, 80%, 90%, 100%, or more than 100%) in reproductive ability, survival, rate of development, number of hatched eggs, adult emergence rate, body length, or weight relative to an untreated insect.

In some embodiments, the method is effective to decrease bacterial colonization (e.g., by about 2%, 5%, 10%, 20%, 30%, 40%, 50%, 60%, 70%, 80%, 90%, 100%, or more than 100%) in the gut of the insect relative to an untreated insect.

In some embodiments, the method is effective to inhibit a physical interaction between the bacteria and the gut of the insect.

In some embodiments of the methods herein, the composition is delivered to the insect to at least one habitat where the insect grows, lives, or reproduces.

In some embodiments of the methods herein, the composition is a liquid, a solid, an aerosol, a paste, a gel, or a gas composition.

In some embodiments of the methods herein, the composition is delivered as an insect comestible composition for ingestion by the insect.

In some embodiments of the methods herein, the composition is delivered to the insect by ingestion, infusion, injection, or spraying. In some embodiments, the composition is delivered to eggs of the insect.

In some embodiments of the methods herein, the composition includes an agriculturally acceptable carrier.

In yet another aspect, provided herein is a modified insect produced by a method including contacting the insect with a composition including a bacterial colonization-disrupting agent in accordance with any of the methods herein.

In a further aspect, provided herein is a screening assay to identify a bacterial colonization-disrupting agent, including the steps of (a) exposing a target insect to one or more agents; and (b) identifying an agent that (i) decreases the fitness of the target insect (e.g., by about 2%, 5%, 10%, 20%, 30%, 40%, 50%, 60%, 70%, 80%, 90%, 100%, or more than 100%), and (ii) inhibits colonization of a bacterium in the gut of the target insect (e.g., by about 2%, 5%, 10%, 20%, 30%, 40%, 50%, 60%, 70%, 80%, 90%, 100%, or more than 100%).

In some embodiments of the assay herein, the decrease in fitness is decreased survival of the target insect. In some embodiments, the decrease in fitness is a decrease in reproductive ability, survival, rate of development, number of hatched eggs, adult emergence rate, body length, or body mass. In some embodiments, the agent is effective to inhibit a physical interaction between the bacteria and the gut of the insect.

In some embodiments of the assay herein, the bacteria is an endosymbiotic bacteria. In some embodiments, the endosymbiotic bacteria resides in the gut of the insect. In some embodiments, the bacteria resides in a specialized cell or a specialized organ in the gut of the insect. In some embodiments, the specialized organ is a midgut crypt or a bacteriome. In some embodiments, the specialized cell is a bacteriocyte. In some embodiments, the bacterium is of the genus Burkholderia. In some embodiments, the bacterium is of the genus Pantoea.

In some embodiments of the assay herein, the bacterial colonization-disrupting agent is a PHA synthesis inhibitor.

In some embodiments of the assay herein, the bacterial colonization-disrupting agent is an LPS synthesis inhibitor.

In some embodiments of the assay herein, the insect is a plant pest. In some embodiments, the plant pest is of the order Coleoptera, Diptera, Hemiptera, Lepidoptera, Orthoptera, Thysanoptera, or Acarina.

In some embodiments of the assay herein, the insect is a vector of an animal pathogen and/or a human pathogen. In some embodiments, the insect is a mosquito, a midge, a louse, a sandfly, a tick, a triatomine bug, a tsetse fly, or flea.

In another aspect, provided herein is a modified insect produced by a method including contacting the insect with a composition including a bacterial colonization-disrupting agent identified by the screening assay herein.

In yet another aspect, provided herein is a method of decreasing the fitness of an insect including delivering to the insect an effective amount of a composition including a bacterial colonization-disrupting agent identified by the screening assay herein.

In a further aspect, provided here in is a composition including a bacterial colonization-disrupting agent and a carrier, wherein the composition is formulated for delivery to an insect, or a habitat thereof.

In some embodiments of the composition herein, the bacterial colonization-disrupting agent is a polyhydroxyalkanoate (PHA) synthesis inhibitor. In some embodiments, the PHA synthesis inhibitor is vanillin or an analog thereof. In some embodiments, the PHA synthesis inhibitor is one or more compounds in Table 1. In some embodiments, the PHA synthesis inhibitor is levulinic acid or an analog thereof. In some embodiments, the PHA synthesis inhibitor is acrylic acid or an analog thereof. In some embodiments, the PHA synthesis inhibitor is 2-bromooctanoic acid or an analog thereof.

In some embodiments of the composition herein, the bacterial colonization-disrupting agent is an inhibitor of bacterial cell envelope biogenesis. In some embodiments, the inhibitor of bacterial cell envelope biogenesis is a lipopolysaccharide (LPS) synthesis inhibitor. In some embodiments, the LPS synthesis inhibitor is an inhibitor of core oligosaccharide synthesis in the bacteria. In some embodiments, the LPS synthesis inhibitor inhibits an enzyme involved in core oligosaccharide synthesis in the bacteria. In some embodiments, the enzyme has at least 40%, 50%, 60%, 70%, 80%, 90%, 95%, 98%, 99%, or 100% sequence identity to a polypeptide having the amino acid sequence of WaaA, WaaC, WaaF, or WaaG. In some embodiments, the LPS synthesis inhibitor (e.g., the inhibitor of an enzyme involved in LPS synthesis) is a sugar. In some embodiments, the sugar is ADP-2-fluoroheptose (AFH). In some embodiments, the sugar is 2-aryl-5-methyl-4-(5-aryl-furan-2-yl-methylene)-2,4-dihydro-pyrazol-3-ones (DHPO). In some embodiments, the sugar is AFH and DHPO. In some embodiments, the sugar is one or more compounds in Table 7.

In some embodiments, the LPS synthesis inhibitor inhibits expression of a gene involved in core oligosaccharide synthesis in the bacteria. In some embodiments, the gene has at least 40%, 50%, 60%, 70%, 80%, 90%, 95%, 98%, 99%, or 100% sequence identity to a polynucleotide having the nucleotide sequence of waaA, waaC, waaF, or waaG.

In some embodiments, the bacterial colonization-disrupting agent is an inhibitor of bacterial cell wall biogenesis. In some embodiments, the inhibitor of bacterial cell wall biogenesis is an inhibitor of undecaprenyl pyrophosphate phosphatase (UppP), e.g., bacitracin.

In some embodiments, the bacterial colonization-disrupting agent is an inhibitor of flagellar function, e.g., cellulose.

In some embodiments of the composition herein, the bacterial colonization-disrupting agent is at least 0.1%, 0.2%, 0.4%, 0.5%, 0.8%, 1%, 2%, 5%, 10%, 20%, 30%, 40%, 50%, 60%, 70%, 80%, or 90% of the composition. In some embodiments, the carrier is a liquid, a solid, an aerosol, a paste, a gel, or a gas composition. In some embodiments, the carrier is a sugar syrup, corn syrup, or honey. In some embodiments, the carrier is a nanoparticle or lipid membrane.

In some embodiments of the composition herein, the composition is formulated for delivery to the insect, for example, by ingestion, infusion, injection, spraying, smoking, or fogging. In some embodiments, the composition is formulated for delivery to at least one habitat, for example, where the insect grows, lives, reproduces, or feeds. In some embodiments, the composition is formulated for delivery to a plant ingested by the insect. In another aspect, provided herein is a modified plant or part thereof including a bacterial colonization-disrupting agent, wherein the plant or part thereof is ingested by an insect. In some embodiments, the plant is genetically engineered to produce the bacterial colonization-disrupting agent, e.g., by expression from a heterologous genetic construct.

### Definitions

As used herein, the term “bacterial colonization-disrupting agent” refers to an agent that impedes or disrupts colonization of a bacteria in the gut of an insect (e.g., colonization of the surface of the gut or colonization of a cell (e.g., bacteriocyte) or organ (e.g., bacteriome or crypt) therein). For example, the agent may alter properties of the bacteria (e.g., bacterial metabolism or bacterial cell surface), or components thereof, and/or the insect gut, or components thereof, such that the bacteria can no longer adhere, associate with, or propagate in the gut of the insect. Exemplary bacterial colonization-disrupting agents include lipopolysaccharide (LPS) synthesis inhibitors, polyhydroxyalkanoate (PHA) synthesis inhibitors, inhibitors of cell wall biogenesis, and inhibitors of flagellar function.

As used herein, the term “colonizing” refers to persistence of a bacterium in an insect in an amount and for a duration sufficient to establish a population of bacteria in the insect (e.g., insect gut) that persists for the lifespan of the insect. The bacterium, once colonized, may further be vertically transmitted through at least one additional generation, e.g., two or more generations (e.g., life cycles) of the insect.

As used herein, the term “effective amount” refers to an amount of a bacterial colonization-disrupting agent, or composition including said agent sufficient to effect the recited result, e.g., to decrease the fitness of an insect; to reach a target level (e.g., a predetermined or threshold level) of a bacterial colonization-disrupting agent concentration inside a target insect; to reach a target level (e.g., a predetermined or threshold level) of a bacterial colonization-disrupting agent concentration inside a target insect gut; to reach a target level (e.g., a predetermined or threshold level) of a bacterial colonization-disrupting agent concentration inside a target insect bacteriocyte; to reach a target level (e.g., a predetermined or threshold level) of a bacterial colonization-disrupting agent concentration inside a target insect crypt; and/or to decrease colonization of one or more microorganisms (e.g., endosymbiont) in the gut of the target insect.

As used herein “decreasing the fitness of an insect” refers to any unfavorable alteration to insect physiology, or any activity carried out by said insect, as a consequence of administration of a bacterial colonization-disrupting agent, including, but not limited to, any one or more of the following desired effects: (1) decreasing a population of an insect by about 10%, 20%, 30%, 40%, 50%, 60%, 70%, 80%, 90%, 95%, 99%, 100% or more; (2) decreasing the reproductive rate of an insect by about 10%, 20%, 30%, 40%, 50%, 60%, 70%, 80%, 90%, 95%, 99%, 100% or more; (3) decreasing the mobility of an insect by about 10%, 20%, 30%, 40%, 50%, 60%, 70%, 80%, 90%, 95%, 99%, 100% or more; (4) decreasing the body weight of an insect by about 10%, 20%, 30%, 40%, 50%, 60%, 70%, 80%, 90%, 95%, 99%, 100% or more; (5) decreasing the metabolic rate or activity of an insect by about 10%, 20%, 30%, 40%, 50%, 60%, 70%, 80%, 90%, 95%, 99%, 100% or more; or (6) decreasing plant infestation by an insect by about 10%, 20%, 30%, 40%, 50%, 60%, 70%, 80%, 90%, 95%, 99%, 100% or more. A decrease in insect fitness can be determined in comparison to an insect to which the bacterial colonization-disrupting agent has not been administered.

As used herein, the term “fitness” refers to the ability of an insect to survive, grow, and/or to produce surviving offspring. Fitness of an organism may be measured by one or more parameters, including, but not limited to survival, life span, reproductive ability, reproductive rate, reproductive period, number of eggs laid, number of hatched eggs, developmental rate, adult emergence rate, mobility, body size (e.g., body length, body mass, or body width (e.g., pronotal width of a stink bug)), cuticle (exoskeleton) thickness, pigmentation, or metabolic rate.

As used herein, the term “gut” refers to any portion of an insect's gut, including, the foregut, midgut, or hindgut of the insect, and any specialized organ (e.g., crypt or bacteriome) or cell (e.g., bacteriocyte) therein. As used herein, the terms “v1”, “v2”, “v3”, and “v4” refer to morphologically distinct regions of the midgut dissected from an adult hemipteran insect (e.g., a stink bug or a bean bug), which are numbered respectively from anterior to posterior. As used herein, v1 refers to the stomach-like midgut first region; v2 refers to the tubular midgut second region; v3 refers to the expanded sac-like midgut third region; and v4 refers to the midgut fourth region, which contains numerous crypts having lumen that may include symbiotic cells. Bacterial colonization may occur in one, more than one, or all regions of the gut. In some examples, bacterial colonization occurs in the v4 region of the midgut. The v1-v4 regions may also be referred to as m1-m4 (Duron and Noel, Environmental Microbiology Reports, 8(5):715-727).

As used herein, the term “host” refers to an organism (e.g., insect) carrying resident microorganisms (e.g., endogenous microorganisms, endosymbiotic microorganisms (e.g., primary or secondary endosymbionts), commensal organisms, and/or pathogenic microorganisms).

As used herein, “increasing the fitness of an insect” refers to any favorable alteration in insect physiology, phenotype, or any activity of the insect, including, but not limited to, any one or more of the following desired effects: (1) increasing a population of an insect by about 1%, 2%, 3%, 4%, 6%, 7%, 8%, 9%, 10%, 20%, 30%, 40%, 50%, 60%, 70%, 80%, 90%, 95%, 99%, 100% or more; (2) increasing the reproductive rate of an insect by about 1%, 2%, 3%, 4%, 6%, 7%, 8%, 9%, 10%, 20%, 30%, 40%, 50%, 60%, 70%, 80%, 90%, 95%, 99%, 100% or more; (3) increasing the mobility of an insect by about 1%, 2%, 3%, 4%, 6%, 7%, 8%, 9%, 10%, 20%, 30%, 40%, 50%, 60%, 70%, 80%, 90%, 95%, 99%, 100% or more; (4) increasing the body weight of an insect by about 1%, 2%, 3%, 4%, 6%, 7%, 8%, 9%, 10%, 20%, 30%, 40%, 50%, 60%, 70%, 80%, 90%, 95%, 99%, 100% or more; (5) increasing the metabolic rate or activity of an insect by about 1%, 2%, 3%, 4%, 6%, 7%, 8%, 9%, 10%, 20%, 30%, 40%, 50%, 60%, 70%, 80%, 90%, 95%, 99%, 100% or more; (6) increasing pollination (e.g., number of plants pollinated in a given amount of time) by an insect by about 1%, 2%, 3%, 4%, 6%, 7%, 8%, 9%, 10%, 20%, 30%, 40%, 50%, 60%, 70%, 80%, 90%, 95%, 99%, 100% or more; (7) increasing production of insect byproducts (e.g., honey or silk) by about 1%, 2%, 3%, 4%, 6%, 7%, 8%, 9%, 10%, 20%, 30%, 40%, 50%, 60%, 70%, 80%, 90%, 95%, 99%, 100% or more; (8) increasing nutrient content of the insect (e.g., protein, fatty acids, or amino acids) by about 1%, 2%, 3%, 4%, 6%, 7%, 8%, 9%, 10%, 20%, 30%, 40%, 50%, 60%, 70%, 80%, 90%, 95%, 99%, 100% or more; or (9) increasing insect resistance to pesticides by about 1%, 2%, 3%, 4%, 6%, 7%, 8%, 9%, 10%, 20%, 30%, 40%, 50%, 60%, 70%, 80%, 90%, 95%, 99%, 100% or more. An increase in insect fitness can be determined in comparison to a control (e.g., an untreated insect).

The term “insect” or “arthropod” includes any organism belonging to the phylum Arthropoda and to the class Insecta or the class Arachnida, in any stage of development, i.e., immature or adult insects. As used herein, the term “beneficial insect” refers to an insect whose presence confers benefits to agricultural, horticultural, or commercial applications, or whose presence or activity is otherwise desirable.

As used herein, the term “microorganism” refers to bacteria or fungi. Microorganisms may refer to microorganisms resident in an insect (e.g., endogenous microorganisms, endosymbiotic microorganisms (e.g., primary or secondary endosymbionts)) or microorganisms exogenous to the insect, including those that produce bacterial colonization-disrupting agents.

As used herein, the term “peptide,” “protein,” or “polypeptide” encompasses any chain of naturally or non-naturally occurring amino acids (either D- or L-amino acids), regardless of length (e.g., at least 2, 3, 4, 5, 6, 7, 10, 12, 14, 16, 18, 20, 25, 30, 40, 50, 100, or more amino acids), the presence or absence of post-translational modifications (e.g., glycosylation or phosphorylation), or the presence of, e.g., one or more non-amino acyl groups (for example, sugar, lipid, etc.) covalently linked to the peptide, and includes, for example, natural proteins, synthetic, or recombinant polypeptides and peptides, hybrid molecules, peptoids, or peptidomimetics.

As used herein, “percent identity” between two sequences is determined by the BLAST 2.0 algorithm, which is described in Altschul et al. (J. Mol. Biol. 215:403-410, 1990). Software for performing BLAST analyses is publicly available through the National Center for Biotechnology Information.

As used herein, the term “pest” refers to an insect that causes damage to plants or other organisms, are present where they are not wanted, or otherwise are detrimental to humans, for example, by impacting human agricultural methods or products.

As used herein, the term “plant” refers to whole plants, plant organs, plant tissues, seeds, plant cells, seeds, and progeny of the same. Plant cells include, without limitation, cells from seeds, suspension cultures, embryos, meristematic regions, flowers, callus tissue, leaves, roots, shoots, gametophytes, sporophytes, pollen, or microspores. Plant parts include differentiated or undifferentiated tissues including, but not limited to the following: roots, stems, shoots, leaves, pollen, seeds, tumor tissue, and various forms of cells and culture (e.g., single cells, protoplasts, embryos, or callus tissue). The plant tissue may be in a plant or in a plant organ, tissue, or cell culture.

As used herein, the term “symbiont” or “insect symbiont” refers to an intracellular or extracellular microorganism that, upon colonization of an insect, confers fitness benefits to the insect. An “endosymbiont” refers to a microorganism capable of living within an insect cell or organ, such as a bacteriocyte or crypt.

As used herein, the term “untreated insect” or “unmodified insect” refers to an insect, or population thereof, that has not been specifically contacted with or delivered (e.g., in accordance with a method described herein) a bacterial colonization-disrupting agent (e.g., has not been contacted with or delivered a bacterial colonization-disrupting agent at any point in time, or has been assessed at a point in time prior to contact with or delivery of the bacterial colonization-disrupting agent).

Other features and advantages of the invention will be apparent from the following Detailed Description and the Claims.

### BRIEF DESCRIPTION OF THE DRAWINGS

The figures are meant to be illustrative of one or more features, aspects, or embodiments of the invention and are not intended to be limiting.

FIG. 1 is a scatter plot showing the ratio of expression of the Candidatus Pantoea carbekii (P. carbekii) dnaK gene and the Halyomorpha halys 60s gene based on pooled qPCR data from 2^{nd}, 3^{rd}, and 4th instar H. halys hatched from eggs treated with ethanol and bleach (Bleached) or not treated with ethanol or bleach (Non-bleached). Bars indicate mean and standard deviation.

FIG. 2A is a graph showing the number of nymphs that are in the 2^{nd} instar, 3^{rd} instar, 4^{th} instar, 5^{th} instar, or adult developmental stage at a given number of days after hatching. Individuals were hatched from ethanol-treated and bleached (bl) eggs (dashed lines) or eggs that were not treated with ethanol or bleach (control) (solid lines). Error bars indicate standard deviation.

FIG. 2B is a box plot showing the average number of days after hatching at which a population of H. halys hatched from ethanol-treated and bleached eggs or eggs that were not treated with ethanol or bleach (control) reaches 50% adult insects. t=t value; df=degrees of freedom.

FIG. 3A is a photograph showing guts dissected from H. halys individuals of the same age that were hatched from ethanol-treated and bleached eggs (symbiont-free) or eggs that were not treated with ethanol or bleach (control). The v1, v2, v3, and v4 regions of the gut are labeled.

FIG. 3B is a photograph showing size and color differences between female H. halys individuals of the same age that were hatched from ethanol-treated and bleached eggs (symbiont-free; right) or eggs that were not treated with ethanol or bleach (control; left).

FIG. 3C is a scatter plot showing the average width of the pronotum (pronotal width; a proxy for size) in female and male H. halys individuals that were hatched from ethanol-treated and bleached eggs (Bleached) or eggs that were not treated with ethanol or bleach (Non-Bleached).

FIG. 4 is a scatter plot showing the average number of eggs in an egg mass produced by female H. halys individuals that were hatched from ethanol-treated and bleached eggs (Bleached) or eggs that were not treated with ethanol or bleach (Control).

FIG. 5 is a scatter plot showing the ratio of expression of the P. carbekii dnaK gene and the H. halys 60s gene based on pooled qPCR data from late 2nd instar H. halys nymphs hatched from eggs that were treated with a negative control (water), a positive control (Rifamycin S), or a polyhydroxyalkanoate (PHA) inhibitor (2-bromooctanoic acid, acrylic acid, vanillin, or levulinic acid). Asterisks show statistical significance of p<0.05 when compared to the water control group, and numbers above the asterisks show fold difference (reduction) of means compared to the water controls.

FIG. 6 is a scatter plot showing the ratio of expression of the P. carbekii dnaK gene and the H. halys 60s gene based on pooled qPCR data from late 2nd instar H. halys nymphs hatched from eggs that were treated with a negative control (water), a positive control (Rifamycin S), or the cell wall synthesis inhibitor bacitracin. The asterisks show statistical significance of p<0.05 when compared to the water control group, and the numbers above the asterisks show fold difference (reduction) of means compared to the water controls.

FIG. 7 is a scatter plot showing the ratio of expression of the P. carbekii dnaK gene and the H. halys 60s gene based on pooled qPCR data from late 2^{nd} instar H. halys nymphs hatched from eggs that were treated with a negative control (water), a positive control (Rifamycin S), or the flagellar function inhibitor cellulose. The asterisks show statistical significance of p<0.05 when compared to the water control group, and the numbers above the asterisks show fold difference (reduction) of means compared to the water controls.

FIG. 8 is a diagram showing the developmental stages of the brown marmorated stink bug (H. halys) including eggs, 1^{st} instar insects, 2^{nd} instar insects, 3^{rd} instar insects, 4^{th} instar insects, 5^{th} instar insects, and male and female adult insects.

### DETAILED DESCRIPTION

Provided herein are methods and compositions including bacterial colonization-disrupting agents useful for decreasing or preventing bacterial colonization in the gut of insects. The integrity of the gut microbiota is important for insect fitness. A number of insects have evolved to be obligatorily dependent on bacterial symbionts, including intracellular symbionts (e.g., endosymbionts). Many of these bacteria reside in the gut of insects, and in some cases, the insect harbors such bacteria in specialized cells (bacteriocytes) or organs (bacteriomes or crypts). By impeding colonization of bacteria in the insect gut or in the specialized organs or cells therein, the present methods and compositions can be used to decrease the fitness of a variety of insects, such as insects that are considered pests in agricultural or commercial industries or otherwise insects harmful to humans or animals (e.g., insect vectors of disease).

A variety of bacterial colonization-disrupting agents are useful in the present methods. The methods and compositions described herein are based, in part, on the examples which illustrate how different agents, for example, lipopolysaccharide (LPS) synthesis inhibitors, polyhydroxyalkanoate (PHA) synthesis inhibitors, inhibitors of cell wall biogenesis, or inhibitors of flagellar function, can be used to decrease colonization of symbiotic microorganisms in insect hosts (e.g., endosymbiotic Burkholderia in bean bugs or Candidatus Pantoea carbekii in stink bugs) to decrease the fitness of these hosts. Screening methods are also provided herein for identifying additional bacterial colonization-disrupting agents.

### I. Methods of Altering Insect Fitness

Provided herein are methods of altering the fitness (e.g., decreasing the fitness or increasing the fitness) of an insect by delivering to the insect a composition including a bacterial colonization-disrupting agent. Examples of insects that can be targeted by the present methods, fitness benefits that can be conferred by the present methods, and methods for delivering the bacterial colonization-disrupting agent to insects are further described, below.

i. Insects

The bacterial colonization-disrupting agents herein can be applied to a variety of insects. For example, the insect may be an agricultural pest. Pests include insects that cause damage to plants or other organisms, or otherwise are detrimental to humans, for example, human agricultural methods or products.

In some instances, the insect is of the order: Acari, Araneae, Anoplura, Coleoptera, Collembola, Dermaptera, Dictyoptera, Diplura, Diptera (e.g., spotted-wing Drosophila), Embioptera, Ephemeroptera, Grylloblatodea, Hemiptera (e.g., aphids, Greenhous whitefly), Homoptera, Hymenoptera, Isoptera, Lepidoptera, Mallophaga, Mecoptera, Neuroptera, Odonata, Orthoptera, Phasmida, Plecoptera, Protura, Psocoptera, Siphonaptera, Siphunculata, Thysanura, Strepsiptera, Thysanoptera, Trichoptera, or Zoraptera.

In some instances, the insect is of the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gaffinae, Dermatophagoides pteronyssinus, Dermatophagoides farinae, Dermacentor spp., Eotetranychus spp., Epitrimerus gyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp., Trombicula alfreddugesi, Vaejovis spp., or Vasates lycopersici.

In some instances, the insect is of the class Chilopoda, for example, Geophilus spp. or Scutigera spp.

In some instances, the insect is of the order Collembola, for example, Onychiurus armatus.

In some instances, the insect is of the class Diplopoda, for example, Blaniulus guttulatus;

In some instances, the insect is of the class Insecta, e.g. from the order Blattodea, for example, Blattella asahinai, Blattella germanica, Blatta orientalis, Leucophaea maderae, Panchlora spp., Parcoblatta spp., Periplaneta spp., or Supella longipalpa.

In some instances, the insect is of the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp. (e.g., corn rootworm), Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psyffiodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., or Zabrus spp.;

In some instances, the insect is of the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophaga, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp. (e.g., Musca domestica), Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., or Tipula spp.

In some instances, the insect is of the order Heteroptera, for example, Alydidae, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygasterspp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentatomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., or Triatoma spp.

In some instances, the insect is of the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma pini, Aphis spp. (e.g., Apis gossypii), Arboridia apicalis, Arytainilla spp., Aspidiella spp., Aspidiotus spp., Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp., Chaetosiphon fragaefolii, Chionaspis tegalensis, Chlorita Chondracris rosea, Chromaphis juglandicola, Chrysomphalus ficus, Cicadulina mbila, Coccomytilus haffi, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp., Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Homalodisca vitripennis, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphum spp., Saissetia spp., Scaphoideus titanus, Schizaphis graminum, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, or Zygina spp.

In some instances, the insect is of the order Hymenoptera, for example, Acromyrmex spp., Athalia spp., Atta spp., Diprion spp., Hoplocampa spp., Lasius spp., Monomorium pharaonis, Sirex spp., Solenopsis invicta, Tapinoma spp., Urocerus spp., Vespa spp., or Xeris spp.

In some instances, the insect is of the order Isopoda, for example, Armadillidium vulgare, Oniscus asellus, or Porcellio scaber.

In some instances, the insect is of the order Isoptera, for example, Coptotermes spp., Cornitermes cumulans, Cryptotermes spp., Incisitermes spp., Microtermes obesi, Odontotermes spp., or Reticulitermes spp.

In some instances, the insect is of the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp., Spodoptera praefica, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, or Virachola spp.

In some instances, the insect is of the order Orthoptera or Saltatoria, for example, Acheta domesticus, Dichroplus spp., Gryllotalpa spp., Hieroglyphus spp., Locusta spp., Melanoplus spp., or Schistocerca gregaria.

In some instances, the insect is of the order Phthiraptera, for example, Damalinia spp., Haematopinus spp., Linognathus spp., Pediculus spp., Ptirus pubis, or Trichodectes spp.

In some instances, the insect is of the order Psocoptera for example Lepinatus spp., or Liposcelis spp.

In some instances, the insect is of the order Siphonaptera, for example, Ceratophyllus spp., Ctenocephalides spp., Pulex irritans, Tunga penetrans, or Xenopsylla cheopsis.

In some instances, the insect is of the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, or Thrips spp.

In some instances, the insect is of the order Zygentoma (=Thysanura), for example, Ctenolepisma spp., Lepisma saccharina, Lepismodes inquilinus, or Thermobia domestica.

In some instances, the insect is of the class Symphyla, for example, Scutigerella spp.

In some instances, the insect is a mite, including but not limited to, Tarsonemid mites, such as Phytonemus pallidus, Polyphagotarsonemus latus, Tarsonemus bilobatus, or the like; Eupodid mites, such as Penthaleus erythrocephalus, Penthaleus major, or the like; Spider mites, such as Oligonychus shinkajii, Panonychus citri, Panonychus mori, Panonychus ulmi, Tetranychus kanzawai, Tetranychus urticae, or the like; Eriophyid mites, such as Acaphylla theavagrans, Aceria tulipae, Aculops lycopersici, Aculops pelekassi, Aculus schlechtendali, Eriophyes chibaensis, Phyllocoptruta oleivora, or the like; Acarid mites, such as Rhizoglyphus robini, Tyrophagus putrescentiae, Tyrophagus similis, or the like; Bee brood mites, such as Varroa jacobsoni, Varroa destructor or the like; Ixodides, such as Boophilus microplus, Rhipicephalus sanguineus, Haemaphysalis longicornis, Haemophysalis flava, Haemophysalis campanulata, Ixodes ovatus, Ixodes persulcatus, Amblyomma spp., Dermacentor spp., or the like; Cheyletidae, such as Cheyletiella yasguri, Cheyletiella blakei, or the like; Demodicidae, such as Demodex canis, Demodex cati, or the like; Psoroptidae, such as Psoroptes ovis, or the like; Scarcoptidae, such as Sarcoptes scabiei, Notoedres cati, Knemidocoptes spp., or the like. In certain instances, the insect is a bean bug (e.g., a Riptortus species, e.g., Riptortus pedestris).

In some instances, the insect is a stink bug, e.g., a member of the Pentatomidae, e.g., a Halyomorpha species (e.g., Halyomorpha halys (St\dot{a}l)), a Nezara species (e.g., Nezara viridula), an Oebalus species (e.g., Oebalus pugnax), a Chinavia species (e.g., Chinavia hilaris), an Euthyrhynchus species (e.g., Euthyrhynchus floridanus), an Euschistus species (e.g., Euschistus servus), an Alcaeorrhynchus species (e.g., Alcaeorrhynchus grandis), or a Podisus species. In certain instances, the stink bug is the brown marmorated stink bug (Halyomorpha halys (St\dot{a}l)).

The methods and compositions provided herein may also be used with any insect host that is considered a vector for a pathogen that is capable of causing disease in animals.

For example, the insect host may include, but is not limited to those with piercing-sucking mouthparts, as found in Hemiptera and some Hymenoptera and Diptera such as mosquitoes, bees, wasps, midges, lice, tsetse fly, fleas and ants, as well as members of the Arachnidae such as ticks and mites; order, class or family of Acarina (ticks and mites) e.g. representatives of the families Argasidae, Dermanyssidae, Ixodidae, Psoroptidae or Sarcoptidae and representatives of the species Amblyomma spp., Anocenton spp., Argas spp., Boophilus spp., Cheyletiella spp., Chorioptes spp., Demodex spp., Dermacentor spp., Denmanyssus spp., Haemophysalis spp., Hyalomma spp., Ixodes spp., Lynxacarus spp., Mesostigmata spp., Notoednes spp., Ornithodoros spp., Ornithonyssus spp., Otobius spp., otodectes spp., Pneumonyssus spp., Psoroptes spp., Rhipicephalus spp., Sancoptes spp., or Trombicula spp.; Anoplura (sucking and biting lice) e.g. representatives of the species Bovicola spp., Haematopinus spp., Linognathus spp., Menopon spp., Pediculus spp., Pemphigus spp., Phylloxera spp., or Solenopotes spp.; Diptera (flies) e.g. representatives of the species Aedes spp., Anopheles spp., Calliphora spp., Chrysomyia spp., Chrysops spp., Cochliomyia spp., Cw/ex spp., Culicoides spp., Cuterebra spp., Dermatobia spp., Gastrophilus spp., Glossina spp., Haematobia spp., Haematopota spp., Hippobosca spp., Hypoderma spp., Lucilia spp., Lyperosia spp., Melophagus spp., Oestrus spp., Phaenicia spp., Phlebotomus spp., Phormia spp., Acari (sarcoptic mange) e.g., Sarcoptidae spp., Sarcophaga spp., Simulium spp., Stomoxys spp., Tabanus spp., Tannia spp. or Zzpu/alpha spp.; Mallophaga (biting lice) e.g. representatives of the species Damalina spp., Felicola spp., Heterodoxus spp. or Trichodectes spp.; or Siphonaptera (wingless insects) e.g. representatives of the species Ceratophyllus spp., Xenopsylla spp; Cimicidae (true bugs) e.g. representatives of the species Cimex spp., Tritominae spp., Rhodinius spp., or Triatoma spp.

In some instances, the insect is a blood-sucking insect from the order Diptera (e.g., suborder Nematocera, e.g., family Colicidae). In some instances, the insect is from the subfamilies Culicinae, Corethrinae, Ceratopogonidae, or Simuliidae. In some instances, the insect is of a Culex spp., Theobaldia spp., Aedes spp., Anopheles spp., Aedes spp., Forciponiyia spp., Culicoides spp., or Helea spp. In certain instances, the insect is a mosquito. In certain instances, the insect is a tick. In certain instances, the insect is a mite. In certain instances, the insect is a biting louse.

Alternatively, the insect may be a beneficial insect, such as a plant pollinator, a natural competitor of a pest, or a producer of useful substances for humans or animals. The term beneficial insect refers to an insect that confers a benefit (e.g., economical and/or ecological) to humans, animals, an ecosystem, and/or the environment. For example, the insect may be an insect that is involved in the production of a commercial product, including, but not limited to, insects cultivated to produce food (e.g., honey from honey bees, e.g., Apis mellifera), materials (such as silk from Bombyx mori), and/or substances (e.g., lac from Laccifer lacca or pigments from Dactylopius coccus and Cynipidae). In some instances, the insect may be harvested, or one or more parts of the insect may be harvested, and processed for use in the manufacture of a consumable product, including any product safe for human or animal consumption (e.g., ingestion). Additionally, the insect may include insects that are used in agricultural applications, including insects that aid in the pollination of crops, spreading seeds, or pest control. Further, in some instances, the insect may be an insect that is useful for waste disposal and/or organic recycling (e.g., earthworms, termites, or Diptera larvae). The insect may be one that has its native (i.e., unaltered) microbiota. Alternatively, the insect may be one that has received probiotic compositions prior to or during delivery of the bacterial colonization-disrupting agent.

In some instances, the insect may be harvested and distributed in a whole form (e.g., as the whole, unprocessed insect) as a consumable product. In some instances, the whole harvested insect is processed (e.g., ground up) and distributed as a consumable product. Alternatively, one or more parts of the insect (e.g., one or more body parts or one or more substances) may be extracted from the insect for use in the manufacture of a consumable product. In some instances, the insect may be a moth, butterfly, fly, cricket, grasshopper, locust, spider, or beetle. In some instances, an insect species is selected based upon their natural nutritional profile or nutrient content. Examples of nutrients include vitamins, carbohydrates, amino acids, polypeptides, or fatty acids.

In some instances, the insect produces a useable product (e.g., honey, silk, beeswax, or shellac). In some instances, the insect is a bee. Exemplary bee genera include, but are not limited to Apis, Bombus, Trigona, and Osmia. In some instances, the bee is a honeybee (e.g., an insect belonging to the genus Apis). In some instances, the honeybee is the species Apis mellifera (the European or Western honey bee), Apis cerana (the Asiatic, Eastern, or Himalayan honey bee), Apis dorsata (the “giant” honey bee), Apis florea (the “red dwarf” honey bee), Apis andreniformis (the “black dwarf” honey bee), or Apis nigrocincta. In some instances, the insect is a silkworm. The silkworm may be a species in the family Bombycidae or Saturniidae. In some instances, the silkworm is Bombyx mori In some instances, the insect is a lac bug. The lac bug may be a species in the family Kerriidae. In some instances, the lac bug is Kerria lacca.

In some instances, the insect aids in pollination of a plant (e.g., bees, beetles, wasps, flies, butterflies, or moths). In some examples, the insect aiding in pollination of a plant is beetle. In some instances, the beetle is a species in the family Buprestidae, Cantharidae, Cerambycidae, Chrysomelidae, Cleridae, Coccinellidae, Elateridae, Melandryidae, Meloidae, Melyridae, Mordellidae, Nitidulidae, Oedemeridae, Scarabaeidae, or Staphyllinidae. In some instances, the insect aiding in pollination of a plant is a butterfly or moth (e.g., Lepidoptera). In some instances, the butterfly or moth is a species in the family Geometridae, Hesperiidae, Lycaenidae, Noctuidae, Nymphalidae, Papilionidae, Pieridae, or Sphingidae. In some instances, the insect aiding in pollination of a plant is a fly (e.g., Diptera). In some instances, the fly is in the family Anthomyiidae, Bibionidae, Bombyliidae, Calliphoridae, Cecidomiidae, Certopogonidae, Chrionomidae, Conopidae, Culicidae, Dolichopodidae, Empididae, Ephydridae, Lonchopteridae, Muscidae, Mycetophilidae, Phoridae, Simuliidae, Stratiomyidae, or Syrphidae. In some instances, the insect aiding in pollination is an ant (e.g., Formicidae), sawfly (e.g., Tenthredinidae), or wasp (e.g., Sphecidae or Vespidae). In some instances, the insect aiding in pollination of a plant is a bee. In some instances, the bee is in the family Andrenidae, Apidae, Colletidae, Halictidae, or Megachilidae.

In some instances, the insect aids in pest control. For example, the insect aiding in pest control may be a species belonging to the family Braconidae (e.g., parasitoid wasps), Carabidae (e.g., ground beetles), Chrysopidae (e.g., green lacewings), Coccinellidae (e.g., ladybugs), Hemerobiidae (e.g., brown lacewings), Ichneumonidae (e.g., ichneumon wasps), Lampyridae (e.g., fireflies), Mantidae (e.g., praying mantises), Myrmeleontidae (e.g., antilions), Odonata (e.g., dragonflies and damselflies), or Syrphidae (e.g., hoverfly). In other instances, the insect aiding in pest control is an insect that competes with an insect that is considered a pest (e.g., an agricultural pest). For example, the Mediterranean fruit fly, Ceratitis capitata is a common pest of fruits and vegetables worldwide. One way to control C. captitata is to release the sterilized male insect into the environment to compete with wild males to mate the females. In these instances, the insect may be a sterilized male belonging to a species that is typically considered a pest.

In some instances, the insect aids in degradation of waste or organic material. In some examples, the insect aiding in degradation of waste or organic material belongs to Coleoptera or Diptera. In some instances, the insect belonging to Diptera is in the family Calliphoridae, Curtonotidae, Drosophilidae, Fanniidae, Heleomyzidae, Milichiidae, Muscidae, Phoridae, Psychodidae, Scatopsidae, Sepsidae, Sphaeroceridae, Stratiomyidae, Syrphidae, Tephritidae, or Ulidiidae. In some instances, the insect belonging to Coleoptera is in the family Carabidae, Hydrophilidae, Phalacaridae, Ptiliidae, or Staphylinidae.

In particular instances, the bacterial colonization-disrupting agents disclosed herein may be used to increase the fitness of a honeybee.

ii. Decreasing Insect Fitness

In instances where the bacterial colonization-disrupting agent disrupts colonization of bacteria beneficial to an insect, the present methods are effective to decrease the fitness of the insect. For example, a bacterial colonization-disrupting agent as described herein can be contacted with an insect in an amount and for a time sufficient to: (a) reach a target level (e.g., a predetermined or threshold level) of concentration inside a target insect (e.g., inside the gut, or a cell (e.g., bacteriocyte) or organ (e.g., bacteriome or crypt) therein); and (b) decrease the fitness of the target insect. The decrease in insect fitness may manifest as a deterioration or decline in the physiology of the insect (e.g., as measured by survival) as a consequence of administration of the bacterial colonization-disrupting agent. The fitness of the insect may be measured by one or more parameters, including, but not limited to, reproductive rate, lifespan, mobility, fecundity, body weight, metabolic rate or activity, or survival in comparison to an insect to which the bacterial colonization-disrupting agent has not been administered.

For example, the methods or compositions provided herein may be effective to decrease the overall health of the insect or to decrease the overall survival of the insect. In some instances, the decreased survival of the insect is about 2%, 5%, 10%, 20%, 30%, 40%, 50%, 60%, 70%, 80%, 90%, 100%, or more than 100% relative to a reference level (e.g., a level found in an insect that does not receive a bacterial colonization-disrupting agent). In some instances, the methods and compositions are effective to decrease insect reproduction (e.g., reproductive rate) in comparison to an insect to which the bacterial colonization-disrupting agent has not been administered. In some instances, the methods and compositions are effective to decrease other physiological parameters, such as mobility, body weight, life span, fecundity, or metabolic rate, by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

In some instances, the decrease in insect fitness may manifest as a decrease in the production of one or more nutrients in the insect (e.g., vitamins, carbohydrates, amino acids, or polypeptides) in comparison to an insect to which the bacterial colonization-disrupting agent has not been administered. In some instances, the methods or compositions provided herein may be effective to decrease the production of nutrients in the insect (e.g., vitamins, carbohydrates, amino acids, or polypeptides) by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). In some instances, the methods or compositions provided herein may decrease nutrients in the insect by decreasing the production of nutrients by one or more microorganisms (e.g., endosymbiont) in the insect in comparison to an insect to which the bacterial colonization-disrupting agent has not been administered.

In some instances, the decrease in insect fitness may manifest as an increase in the insect's sensitivity to a pesticidal agent and/or a decrease in the insect's resistance to a pesticidal agent in comparison to an insect to which the bacterial colonization-disrupting agent has not been administered. In some instances, the methods or compositions provided herein may be effective to increase the insect's sensitivity to a pesticidal agent by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). The pesticidal agent may be any pesticidal agent known in the art, including insecticidal agents. In some instances, the methods or compositions provided herein may increase the insect's sensitivity to a pesticidal agent by decreasing the insect's ability to metabolize or degrade the pesticidal agent into usable substrates.

In some instances, the decrease in insect fitness may manifest as an increase in the insect's sensitivity to an allelochemical agent and/or a decrease in the insect's resistance to an allelochemical agent in comparison to an insect to which the bacterial colonization-disrupting agent has not been administered. In some instances, the methods or compositions provided herein may be effective to decrease the insect's resistance to an allelochemical agent by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). In some instances, the allelochemical agent is caffeine, soyacystatin N, monoterpenes, diterpene acids, or phenolic compounds. In some instances, the methods or compositions provided herein may increase the insect's sensitivity to an allelochemical agent by decreasing the insect's ability to metabolize or degrade the allelochemical agent into usable substrates in comparison to an insect to which the bacterial colonization-disrupting agent has not been administered.

In some instances, the methods or compositions provided herein may be effective to decease the insect's resistance to parasites or pathogens (e.g., fungal, bacterial, or viral pathogens or parasites) in comparison to an insect to which the bacterial colonization-disrupting agent has not been administered. In some instances, the methods or compositions provided herein may be effective to decrease the insect's resistance to a pathogen or parasite (e.g., fungal, bacterial, or viral pathogens; or parasitic mites) by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

In some instances, the decrease in insect fitness may manifest as other fitness disadvantages, such as decreased tolerance to certain environmental factors (e.g., a high or low temperature tolerance), decreased ability to survive in certain habitats, or a decreased ability to sustain a certain diet in comparison to an insect to which the bacterial colonization-disrupting agent has not been administered. In some instances, the methods or compositions provided herein may be effective to decrease insect fitness in any plurality of ways described herein. Further, the bacterial colonization-disrupting agent may decrease insect fitness in any number of insect classes, orders, families, genera, or species (e.g., 1 insect species, 2, 3, 4, 5, 6, 7, 8, 9, 10, 15, 20, 30, 40, 50, 60, 70, 80, 90, 100, 150, 200, 200, 250, 500, or more insect species). In some instances, the bacterial colonization-disrupting agent acts on a single insect class, order, family, genus, or species. Insect fitness may be evaluated using any standard methods in the art. In some instances, insect fitness may be evaluated by assessing an individual insect. Alternatively, insect fitness may be evaluated by assessing an insect population.

iii. Increasing Insect Fitness

In instances where the bacterial colonization-disrupting agent disrupts colonization of bacteria harmful to an insect (e.g., pathogenic bacteria), the present methods are effective to confer a variety of fitness benefits to insects. For example, the increase in insect fitness may manifest as an improvement in the physiology of the insect (e.g., improved health or survival, or increased nutritional profile) as a consequence of administration of the bacterial colonization-disrupting agent. The fitness of the insect may be measured by one or more parameters, including, but not limited to, reproductive rate, lifespan, mobility, fecundity, body weight, nutritional profile, metabolic rate or activity, or survival in comparison to an insect to which the bacterial colonization-disrupting agent has not been administered. In some instances, the bacterial colonization-disrupting agent may increase the fitness of the insect in a transient manner. Alternatively, the bacterial colonization-disrupting agent may increase the fitness of the insect for the duration of the insect's lifespan.

For example, the methods or compositions provided herein may be effective to improve the overall health of the insect or to improve the overall survival of the insect in comparison to an insect to which the bacterial colonization-disrupting agent has not been administered. In some instances, the improved survival of the insect is about 2%, 5%, 10%, 20%, 30%, 40%, 50%, 60%, 70%, 80%, 90%, 100%, or greater than 100% greater relative to a reference level (e.g., a level found in an insect that does not receive a bacterial colonization-disrupting agent).

In some instances, the methods and compositions are effective to increase insect reproduction (e.g., reproductive rate) in comparison to an insect to which the bacterial colonization-disrupting agent has not been administered. In some instances, the methods and compositions are effective to increase other physiological parameters, such as mobility, body weight, life span, fecundity, or metabolic rate, by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

In some instances, the increase in insect fitness may manifest as an increased production of a product generated by said insect in comparison to an insect to which the bacterial colonization-disrupting agent has not been administered. In some instances, the methods or compositions provided herein may be effective to increase the production of a product generated by the insect, as described herein (e.g., honey, beeswax, beebread, propolis, silk, or lac), by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

For example, the methods or compositions provided herein may be effective to improve the nutritional profile of the insect or to improve the overall nutrient content (e.g., vitamin, carbohydrate, amino acid, polypeptide, or fatty acid content) of the insect in comparison to an insect to which the bacterial colonization-disrupting agent has not been administered. In some instances, the improved nutritional profile or nutrient content of the insect is about 2%, 5%, 10%, 20%, 30%, 40%, 50%, 60%, 70%, 80%, 90%, 100%, or greater than 100% greater relative to a reference level (e.g., a level found in an insect that does not receive a bacterial colonization-disrupting agent).

In some instances, the increase in insect fitness may manifest as an increase in the frequency or efficacy of a desired activity carried out by the insect (e.g., pollination, predation on pests, seed spreading, or breakdown of waste or organic material) in comparison to an insect to which the bacterial colonization-disrupting agent has not been administered. In some instances, the methods or compositions provided herein may be effective to increase the frequency or efficacy of a desired activity carried out by the insect (e.g., pollination, predation on pests, seed spreading, or breakdown of waste or organic material) by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

In some instances, the increase in insect fitness may manifest as an increase in the production of one or more nutrients in the insect (e.g., vitamins, carbohydrates, amino acids, or polypeptides) in comparison to an insect to which the bacterial colonization-disrupting agent has not been administered. In some instances, the methods or compositions provided herein may be effective to increase the production of nutrients in the insect (e.g., vitamins, carbohydrates, amino acids, or polypeptides) by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). In some instances, the methods or compositions provided herein may increase nutrients in the insect by increasing the production of nutrients by one or more microorganisms (e.g., endosymbiont) in the insect.

In some instances, the increase in insect fitness may manifest as a decrease in the insect's sensitivity to a pesticidal agent and/or an increase in the insect's resistance to a pesticidal agent in comparison to an insect to which the bacterial colonization-disrupting agent has not been administered. In some instances, the methods or compositions provided herein may be effective to decrease the insect's sensitivity to a pesticidal agent by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). In some instances, the insect's sensitivity to the pesticidal agent is altered by administering a bacterial colonization-disrupting agent that degrades a pesticidal agent (e.g., pesticidal-degrading bacteria, e.g., a neonicotinoid-degrading bacteria or an organophosphorus insecticide-degrading bacteria). The pesticidal agent may be any pesticidal agent known in the art, including insecticidal agents. In some instances, the pesticidal agent is a neonicotinoid (e.g., imidacloprid) or an organophosphorus insecticide (e.g., a phosphorothioate, e.g., fenitrothion). In some instances, the methods or compositions provided herein may decrease the insect's sensitivity to a pesticidal agent by increasing the insect's ability to metabolize or degrade the pesticidal agent into usable substrates.

In some instances, the increase in insect fitness may manifest as a decrease in the insect's sensitivity to an allelochemical agent and/or an increase in the insect's resistance to an allelochemical agent in comparison to an insect to which the bacterial colonization-disrupting agent has not been administered. In some instances, the methods or compositions provided herein may be effective to increase the insect's resistance to an allelochemical agent by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent). In some instances, the allelochemical agent is caffeine, soyacystatin N, monoterpenes, diterpene acids, or phenolic compounds. In some instances, the methods or compositions provided herein may decrease the insect's sensitivity to an allelochemical agent by increasing the insect's ability to metabolize or degrade the allelochemical agent into usable substrates.

In some instances, the methods or compositions provided herein may be effective to increase the insect's resistance to parasites or pathogens (e.g., fungal, bacterial, or viral pathogens; or parasitic mites (e.g., Varroa destructor mite in honeybees)) in comparison to an insect to which the bacterial colonization-disrupting agent has not been administered. In some instances, the methods or compositions provided herein may be effective to increase the insect's resistance to a pathogen or parasite (e.g., fungal, bacterial, or viral pathogens; or parasitic mites (e.g., Varroa destructor mite in honeybees)) by about 2%, 5%, 10%, 20%, 30%, 40%, 50%, 60%, 70%, 80%, 90%, 100%, or greater than 100% relative to a reference level (e.g., a level found in an insect that does not receive a bacterial colonization-disrupting agent).

In some instances, the increase in insect fitness may manifest as other fitness advantages, such as improved tolerance to certain environmental factors (e.g., a high or low temperature tolerance), improved ability to survive in certain habitats, or an improved ability to sustain a certain diet (e.g., an improved ability to metabolize soy vs corn) in comparison to an insect to which the bacterial colonization-disrupting agent has not been administered. In some instances, the methods or compositions provided herein may be effective to increase insect fitness in any plurality of ways described herein. Further, the bacterial colonization-disrupting agent may increase insect fitness in any number of insect classes, orders, families, genera, or species (e.g., 1 insect species, 2, 3, 4, 5, 6, 7, 8, 9, 10, 15, 20, 30, 40, 50, 60, 70, 80, 90, 100, 150, 200, 200, 250, 500, or more insect species). In some instances, the bacterial colonization-disrupting agent acts on a single insect class, order, family, genus, or species.

In some embodiments of the methods herein, the method is effective to increase the fitness of the insect relative to an untreated insect. In some embodiments, the increase in fitness is an increase in survival, life span, reproductive ability, reproductive rate, reproductive period, number of eggs laid, number of hatched eggs, developmental rate, adult emergence rate, mobility, body size (e.g., body length, body mass, or body width (e.g., pronotal width of a stink bug)), cuticle (exoskeleton) thickness, pigmentation, or metabolic rate of the insect relative to an untreated insect. In some embodiments, the increase in fitness is an increase in vitellogenin protein in the insect relative to an untreated insect. In some embodiments, the increase in fitness is an increase in vitellogenin gene expression in the insect relative to an untreated insect.

Insect fitness may be evaluated using any standard methods in the art. In some instances, insect fitness may be evaluated by assessing an individual insect. Alternatively, insect fitness may be evaluated by assessing an insect population. For example, an increase in insect fitness may manifest as an increase in successful competition against other insects, thereby leading to an increase in the size of the insect population.

iv. Insects in Agriculture

By decreasing the fitness of insects, such as agricultural pests (e.g., stink bugs or bean bugs), that are harmful to plants, or increasing the fitness of beneficial insects (e.g., pollinating insects, e.g., bees) the bacterial colonization-disrupting agents provided herein may be effective to promote the growth of plants that are typically harmed by said insects. The bacterial colonization-disrupting agent may be delivered to the plant using any of the formulations and delivery methods described herein, in an amount and for a duration effective to decrease insect fitness and thereby benefit the plant, e.g., increase crop growth, increase crop yield, decrease pest infestation, and/or decrease damage to plants. This may or may not involve direct application of the bacterial colonization-disrupting agent to the plant. For example, in instances where the primary insect habitat is different than the region of plant growth, the bacterial colonization-disrupting agent may be applied to either the primary insect habitat, the plants of interest, or a combination of both.

In some instances, the plant may be an agricultural food crop, such as a cereal, grain, legume, fruit, or vegetable crop, or a non-food crop, e.g., grasses, flowering plants, cotton, hay, hemp. The compositions described herein may be delivered to the crop any time prior to or after harvesting the cereal, grain, legume, fruit, vegetable, or other crop. Crop yield is a measurement often used for crop plants and is normally measured in metric tons per hectare (or kilograms per hectare). Crop yield can also refer to the actual seed generation from the plant. In some instances, the bacterial colonization-disrupting agent may be effective to increase crop yield (e.g., increase metric tons of cereal, grain, legume, fruit, or vegetable per hectare and/or increase seed generation) by about 2%, 5%, 10%, 20%, 30%, 40%, 50%, 60%, 70%, 80%, 90%, 100%, or more in comparison to a reference level (e.g., a crop to which the bacterial colonization-disrupting agent has not been administered).

In some instances, the plant (e.g., crop) may be at risk of developing a pest infestation (e.g., by an insect) or may have already developed a pest infestation. The methods and compositions described herein may be used to reduce or prevent pest infestation in such crops by reducing the fitness of insects that infest the plants. In some instances, the bacterial colonization-disrupting agent may be effective to reduce crop infestation (e.g., reduce the number of plants infested, reduce the pest population size, reduce damage to plants) by about 2%, 5%, 10%, 20%, 30%, 40%, 50%, 60%, 70%, 80%, 90%, 100%, or more in comparison to a reference level (e.g., a crop to which the bacterial colonization-disrupting agent has not been administered). In other instances, the bacterial colonization-disrupting agent may be effective to prevent or reduce the likelihood of crop infestation by about 2%, 5%, 10%, 20%, 30%, 40%, 50%, 60%, 70%, 80%, 90%, 100%, or more in comparison to a reference level (e.g., a crop to which the bacterial colonization-disrupting agent has not been administered).

Any suitable plant tissues may benefit from the compositions and methods described herein, including, but not limited to, somatic embryos, pollen, leaves, stems, calli, stolons, microtubers, and shoots. The methods described herein may include treatment of angiosperm and gymnosperm plants such as acacia, alfalfa, apple, apricot, artichoke, ash tree, asparagus, avocado, banana, barley, beans, beet, birch, beech, blackberry, blueberry, broccoli, brussels sprouts, cabbage, canola, cantaloupe, carrot, cassava, cauliflower, cedar, a cereal, celery, chestnut, cherry, Chinese cabbage, citrus, clemintine, clover, coffee, corn, cotton, conifers, cowpea, cucumber, cypress, eggplant, elm, endive, eucalyptus, fava beans, fennel, figs, fir, fruit and nut trees, geranium, grape, grapefruit, groundnuts, ground cherry, gum hemlock, hemp, hickory, kale, kiwifruit, kohlrabi, larch, lettuce, leek, lemon, lime, locust, pine, maidenhair, maize, mango, maple, melon, millet, mushroom, mustard, nuts, oak, oats, okra, onion, orange, an ornamental plant or flower or tree, papaya, palm, parsley, parsnip, pea, peach, peanut, pear, peat, pepper, persimmon, pigeon pea, pine, pineapple, plantain, plum, pomegranate, potato, pumpkin, radicchio, radish, rapeseed, raspberry, rice, rye, sorghum, sallow, soybean, spinach, spruce, squash, strawberry, sugarbeet, sugarcane, sunflower, sweet potato, sweet corn, tangerine, tea, tobacco, tomato, trees, triticale, turf grasses, turnips, a vine, walnut, watercress, watermelon, wheat, yams, yew, and zucchini.

v. Insects as Disease Vectors

By decreasing the fitness of host insects that carry animal pathogens, the bacterial colonization-disrupting agents provided herein are effective to reduce the spread of vector-borne diseases. The bacterial colonization-disrupting agent may be delivered to the insects using any of the formulations and delivery methods described herein, in an amount and for a duration effective to reduce transmission of the disease, e.g., reduce vertical or horizontal transmission between vectors and/or reduce transmission to animals. For example, the bacterial colonization-disrupting agent described herein may reduce vertical or horizontal transmission of a vector-borne pathogen by about 2%, 5%, 10%, 20%, 30%, 40%, 50%, 60%, 70%, 80%, 90%, 100%, or more in comparison to a host organism to which the bacterial colonization-disrupting agent has not been administered. As an another example, the bacterial colonization-disrupting agent described herein may reduce vectorial competence of an insect vector by about 2%, 5%, 10%, 20%, 30%, 40%, 50%, 60%, 70%, 80%, 90%, 100%, or more in comparison to a host organism to which the bacterial colonization-disrupting agent has not been administered.

Non-limiting examples of diseases that may be controlled by the compositions and methods provided herein include diseases caused by Togaviridae viruses (e.g., Chikungunya, Ross River fever, Mayaro, Onyon-nyong fever, Sindbis fever, Eastern equine enchephalomyeltis, Wesetern equine encephalomyelitis, Venezualan equine encephalomyelitis, or Barmah forest); diseases caused by Flavivirdae viruses (e.g., Dengue fever, Yellow fever, Kyasanur Forest disease, Omsk haemorrhagic fever, Japaenese encephalitis, Murray Valley encephalitis, Rocio, St. Louis encephalitis, West Nile encephalitis, or Tick-borne encephalitis); diseases caused by Bunyaviridae viruses (e.g., Sandly fever, Rift Valley fever, La Crosse encephalitis, California encephalitis, Crimean-Congo haemorrhagic fever, or Oropouche fever); disease caused by Rhabdoviridae viruses (e.g., Vesicular stomatitis); disease caused by Orbiviridae (e.g., Bluetongue); diseases caused by bacteria (e.g., Plague, Tularaemia, Q fever, Rocky Mountain spotted fever, Murine typhus, Boutonneuse fever, Queensland tick typhus, Siberian tick typhus, Scrub typhus, Relapsing fever, or Lyme disease); or diseases caused by protozoa (e.g., Malaria, African trypanosomiasis, Nagana, Chagas disease, Leishmaniasis, Piroplasmosis, Bancroftian filariasis, or Brugian filariasis).

vi. Application Methods

An insect described herein can be exposed to a composition including the bacterial colonization-disruption agent herein in any suitable manner that permits delivering or administering the composition to the insect or to an egg or egg mass from which the insect will hatch. The bacterial colonization-disrupting agent may be delivered either alone or in combination with other active or inactive substances and may be applied by, for example, spraying, injection (e.g., microinjection), through plants, pouring, dipping, in the form of concentrated liquids, gels, solutions, suspensions, sprays, powders, pellets, briquettes, bricks and the like, formulated to deliver an effective concentration of the bacterial colonization-disrupting agent. Amounts and locations for application of the compositions described herein are generally determined by the habitat of the insect, the lifecycle stage at which the insect can be targeted by the bacterial colonization-disrupting agent, the site where the application is to be made, and the physical and functional characteristics of the bacterial colonization-disrupting agent.

In some instances, the composition is sprayed directly onto a plant e.g., crops, by e.g., backpack spraying, aerial spraying, crop spraying/dusting etc. In instances where the bacterial colonization-disrupting agent is delivered to a plant, the plant receiving the bacterial colonization-disrupting agent may be at any stage of plant growth. For example, formulated bacterial colonization-disrupting agents can be applied as a seed-coating or root treatment in early stages of plant growth or as a total plant treatment at later stages of the crop cycle. In some instances, the bacterial colonization-disrupting agent may be applied as a topical agent to a plant. In some instances, the composition is sprayed or applied onto an egg or an egg mass from which the insect will hatch.

Further, the bacterial colonization-disrupting agent may be applied (e.g., in the soil in which a plant grows, or in the water that is used to water the plant) as a systemic agent that is absorbed and distributed through the tissues of a plant. In some instances, plants or food organisms may be genetically transformed to express the bacterial colonization-disrupting agent. For example, in some instances, the bacterial colonization-disrupting agent is delivered in a modified plant for ingestion by the insect. Alternatively, the bacterial colonization-disrupting agent may be delivered in an attenuated bacteria or modified bacteria for ingestion by the insect.

Delayed or continuous release can also be accomplished by coating the bacterial colonization-disrupting agent or a composition with the bacterial colonization-disrupting agent(s) with a dissolvable or bioerodable coating layer, such as gelatin, which coating dissolves or erodes in the environment of use, to then make the bacterial colonization-disrupting agent available, or by dispersing the agent in a dissolvable or erodable matrix. Such continuous release and/or dispensing means devices may be advantageously employed to consistently maintain an effective concentration of one or more of the bacterial colonization-disrupting agents described herein.

In some instances, the bacterial colonization-disrupting agent may be recommended for field application as an amount of agent per hectare (g/ha or kg/ha) or the amount of active ingredient (e.g., bacterial colonization-disrupting agent) per hectare (kg a.i./ha or g a.i./ha). Bacterial colonization-disrupting agents of the invention can be applied at a variety of amounts per hectare, for example at about 0.0001, 0.001, 0.005, 0.01, 0.1, 1, 2, 10, 100, 1,000, 2,000, 5,000 (or any range between about 0.0001 and 5,000) kg/ha. For example, about 0.0001 to about 0.01, about 0.01 to about 10, about 10 to about 1,000, about 1,000 to about 5,000 kg/ha.

In some instances where the bacterial colonization-disrupting agent is delivered to an insect or an egg or egg mass produced by the insect, the insect, egg, or egg mass can be simply “soaked” or “sprayed” with a solution including the bacterial colonization-disrupting agent. In other instances, the bacterial colonization-disrupting agents may be administered to the insect by oral ingestion, but may also be administered by means which permit penetration through the cuticle or penetration of the insect's respiratory system. For example, the bacterial colonization-disrupting agent can be linked to a food component (e.g., comestible) of the insect for ease of delivery and/or in order to increase uptake of the bacterial colonization-disrupting agent by the insect. Methods for oral introduction include, for example, directly mixing a bacterial colonization-disrupting agent with the insect's food, spraying the bacterial colonization-disrupting agent in the insect's habitat or field, as well as engineered approaches in which a species that is used as food is engineered to express a bacterial colonization-disrupting agent, then fed to the insect to be affected. In some instances, for example, the bacterial colonization-disrupting agent can be incorporated into, or overlaid on the top of, the insect's diet. For example, the bacterial colonization-disrupting agent can be sprayed onto a field of crops which an insect inhabits.

The bacterial colonization-disrupting agent can also be incorporated into the medium in which the insect grows, lives, reproduces, feeds, or infests. For example, a bacterial colonization-disrupting agent can be incorporated into a food container, feeding station, protective wrapping, or a hive. For some applications the bacterial colonization-disrupting agent may be bound to a solid support for application in powder form or in a trap or feeding station. As an example, for applications where the composition is to be used in a trap or as bait for a particular insect, the compositions may also be bound to a solid support or encapsulated in a time-release material.

### II. Bacterial Colonization-Disrupting Agents

A variety of bacterial colonization-disrupting agents may be used in accordance with the present methods. Bacterial colonization-disrupting agents can be differentiated either by their chemical composition, or by their physiological functions. For example, the agent may alter properties of the bacteria (e.g., bacterial metabolism or bacterial cell surface) and/or the insect gut, such that the bacteria can no longer adhere, associate with, or propagate in the gut of the insect. Exemplary bacterial colonization-disrupting agents and methods of screening for such agents are further described, below. Colonization of the insect (e.g., colonization of a bacteriome of the insect, the gut of the insect, or the v4 region of the gut of the insect) may be decreased by between 1% and 100%, e.g., decreased by at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or decreased by 100%.

The size (e.g., area or mass) of a cell, organ, region, or tissue of the insect that may be colonized by a bacterium (e.g., a bacteriocyte or a v4 region of the gut) may be decreased as a result of treatment with a colonization-disrupting agent, e.g., decreased by between 1% and 100%, e.g., decreased by at least 1%, at least 2%, at least 3%, at least 4%, at least 5%, at least 6%, at least 7%, at least 8%, at least 9%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or decreased by 100%. In some examples, the size of the cell, organ, region, or tissue of the insect that may be colonized (e.g., a bacteriocyte or a v4 region of the gut) is used as a measure of colonization; for example, a smaller size of the cell, organ, region, or tissue may indicate a greater decrease in colonization.

i. Classes of Bacterial Colonization-Disrupting Agents

In some instances, the bacterial colonization-disrupting agent alters (e.g., inhibits) bacterial metabolism. Bacteria residing in the gut of an insect depend on production of certain nutrients to thrive in the insect, or a cell or organ therein. For example, polyhydroxyalkanoate (PHA) is a linear polyester that is synthesized and used as storage compounds of carbon and energy sources. Generally, the biosynthesis of PHA granules is promoted when bacteria face stressful environments, such as nutrition-deficient conditions. As described in Example 1, synthesis of PHA is one exemplary bacterial metabolic pathway that can be targeted to disrupt bacterial colonization of the insect gut (e.g., such as colonization of the gut of Riptortus pedestris by Burkholderia).

Accordingly, in some instances, the bacterial colonization-disrupting agent is a PHA synthesis inhibitor. PHA granules are mainly synthesized from acetyl coenzyme A (acetyl-CoA) by three different enzymes, such as the products of phaA (ketothiolase), phaB (acetyl-CoA reductase), and phaC (PHA synthase). The surfaces of PHA granules are surrounded by various proteins, such as PhaP (a surface protein of PHA granules; phasin), PhaR (a negative regulator of PhaP), and PhaZ (PHA depolymerase). In some instances, the bacterial colonization-disrupting agent is an inhibitor of a gene involved in PHA biosynthesis, such as phaA, phaB, phaC, phaP, phaR, or phaZ gene expression. In other instances, the bacterial colonization-disrupting agent in binds a protein involved in PHA biosynthesis, such as PhaA, PhaB, PhaC, PhaP, PhaR, or PhaZ. In certain instances the PHA synthesis inhibitor is vanillin or an analog thereof (Table 1; Table 2). In other instances, the PHA synthesis inhibitor is levulinic acid or an analog thereof, e.g, an analog as provided in Table 4; acrylic acid or an analog thereof, e.g, an analog as provided in Table 5; or 2-bromooctanoic acid (2BA) or an analog thereof, e.g, an analog as provided in Table 6. In still other instances, the PHA synthesis inhibitor is furfural, 2,3-butanedione, 3-(3,4-dichlorophenyl)-1,1-dimethylurea (DCMU), or 4-pentenoic acid.

TABLE 1
Analogs of vanillin

| Compound | |
|---|---|
| Number | Compound Name |
| 1 | 3-Hydroxy-4-methoxybenzaldehyde |
| 2 | 3,4-Dimethoxybenzaldehyde |
| 3 | 3-(2-Methoxyphenoxy)benzaldehyde |
| 4 | 3,4-Dihydroxy-5-methoxybenzaldehyde |
| 5 | 3-Hydroxy-4,5-dimethoxybenzaldehyde |
| 6 | 4-Hydroxy-3,5-dimethoxybenzaldehyde |
| 7 | 3,4,5-Trimethoxybenzaldehyde |
| 8 | Oxanthrene-2,8-dicarbaldehyde |
| 9 | 4-(2-Methoxyphenoxy)benzaldehyde |
| 10 | 3′-Hydroxy-4′-methoxy[1,1′-biphenyl]-4-carbaldehyde |
| 11 | 4′-Hydroxy-3′-methoxy[1,1′-biphenyl]-4-carbaldehyde |
| 12 | 3′-Hydroxy-4′-methoxy[1,1′-biphenyl]-3-carbaldehyde |
| 13 | 4′-Hydroxy-3′-methoxy[1,1′-biphenyl]-3-carbaldehyde |
| 14 | 4-Hydroxy-5-methoxy-2-methylbenzaldehyde |
| 15 | 5-Hydroxy-4-methoxy-2-methylbenzaldehyde |
| 16 | 3′,4′-Dimethoxy[1,1′-biphenyl]-4-carbaldehyde |
| 17 | 3′,4′-Dimethoxy[1,1′-biphenyl]-3-carbaldehyde |
| 18 | 4,5-Dimethoxybenzene-1,2-dicarbaldehyde |
| 19 | 6,7-Dimethoxynaphthalene-2-carbaldehyde |

TABLE 2
Analogs of vanillin

| | | | |
|---|---|---|---|
| 4-Hydroxybenzaldehyde | 4-Isocyano-2-methoxyaniline | 1-(4-Chloro-2-fluoro-5- | 2-Propan-2-yloxy-4-prop-1- |
| | | methoxyphenyl)propan-1-one | en-2-ylphenol |
| 2-Methoxy-4-vinylphenol | 1-[4-(Ethylamino)-3- | 4-Methoxypyridin-3-ol | Methyl 3-ethoxy-4- |
| | methylphenyl]ethanone | | hydrazinylbenzoate |
| Guaiacol | 1-[4-(Ethynylamino)-3- | 3-Methoxy-2- | Methyl 3-methoxy-4- |
| | methylphenyl]ethanone | methylbenzonitrile | phosphanyloxybenzoate |
| Acetovanillone | 1-(3-Ethynoxyphenyl)ethanone | 3-Methoxy-5- | 1-(3-Methoxy-4- |
| | | methylbenzaldehyde | phosphanyloxyphenyl)ethanone |
| Chloroxine | 3-Bromo-1-fluoro-1,3-diazinane- | 3,5-Dimethoxy-4- | Methyl 4-(1-hydroxyethyl)-3- |
| | 2,4-dione | methylbenzaldehyde | methoxybenzoate |
| Kojic acid | 2-(3-Methyl-2-oxoimidazolidin-1- | (4-Hydroxy-3- | 1-(4-Hydroxybenzo[d]thiazol- |
| | yl)acetonitrile | methoxyphenyl)(p- | 7-yl)ethanone |
| | | tolyl)methanone | |
| 5-Methoxyfuraldehyde | 1-(3-Methoxy-4-methylphenyl)- | (5R)-5-Acetyl-2- | 1-Aminopiperidine-2,4-dione |
| | N-methylmethanimine | methylcyclohex-2-en-1-one | |
| O-Anisidine | 5-Chloro-2-methoxy-4- | 3,4-Dimethoxy-5- | 1-(3-Methoxy-4,5- |
| | methylphenol | methylbenzaldehyde | dimethylphenyl)ethanone |
| 4-Chloro-2- | 4-Acetyl-1-ethyl-3- | 4-Hydroxy-3- | 6-Isocyano-2-methoxypyridin- |
| methoxyaniline | methylpiperazin-2-one | pentoxybenzaldehyde | 3-ol |
| 2-Methoxy-4- | 4-(2-Oxopropyl)piperidine-1- | 2-Iodo-3-methoxybenzonitrile | 4-(2-Fluoroethoxy)-3- |
| methylphenol | carbaldehyde | | hydroxybenzaldehyde |
| 2,4- | 2,3-Difluoro-4-(hydroxymethyl)- | 4-Hydroxy-3-(2- | 6-Chloro-2-fluoro-3- |
| Dihydroxybenzaldehyde | 6-methylphenol | methylpropoxy)benzaldehyde | (fluoromethoxy)benzaldehyde |
| Propenylguaiacol | 3,5-Dichloro-6-methoxy-4- | 4-Hydroxy-3-methoxy- | 2-Chloro-6-fluoro-3- |
| | methylbenzene-1,2-diol | benzoic acid allyl ester | (fluoromethoxy)benzaldehyde |
| 4′- | 3,5-Difluoro-6-methoxy-4- | 2-(3,4-Dimethoxyphenyl)-3- | 4-Hydroxy-3-methoxy-5- |
| Hydroxyacetophenone | methylbenzene-1,2-diol | methyloxirane | methylbenzoic acid |
| Veratraldehyde | Methyl 3-fluoro-3-methyl-2- | 3,4-Difluoro-2-methoxyaniline | 3-Ethoxy-5- |
| | oxobicyclo[3.1,0]hexane-6- | | methylbenzaldehyde |
| | carboxylate | | |
| Ethyl vanillin | 6-Methoxy-5-methyloxan-2-one | (4-Hydroxy-3-methoxyphenyl) | (NE)-N-[(3-ethoxy-5- |
| | | formate | methylphenyl)methylidene]hy- |
| | | | droxylamine |
| Vanillic acid | 3,5,6-Tri m eth y I-4-oxo py ran-2- | 1-(2,4,5-Trifluoro-3- | 1-(3-Methoxy-4-propan-2- |
| | carbaldehyde | methoxyphenyl)ethanone | ylphenyl)ethanone |
| 4-Hydroxy-3,5- | 1-[3-Methoxy-4- | 1-Methyl-2-oxo-1,2- | (3-Methoxy-5- |
| dimethoxybenzaldehyde | (trifluoromethyl)phenyl]-N- | dihydropyridine-4-carbonitrile | sulfanylphenyl)methanol |
| | methylmethanimine | | |
| 2-Methoxybenzaldehyde | 4-(Isocyanatomethyl)-2- | 3,4-Dihydroxy-5- | 3-Ethoxy-2- |
| | methoxyphenol | methylbenzaldehyde | fluorobenzaldehyde |
| 3,4- | 1,4-Dimethyl-2,5-dioxopyrrole-3- | 4-Hydroxy- | 4-Acetyl-1-propan-2- |
| Dihydroxybenzaldehyde | carbonitrile | benzo[b]thiophene-7- | ylpiperazin-2-one |
| | | carboxaldehyde | |
| 2-Hydroxy-3- | 2-Methoxy-N,4,5-trimethylaniline | 3-Hydroxy-4-methoxy-5- | 5-Chloro-6- |
| methoxybenzaldehyde | | acetonylidenefuran-2(5H)- | methoxypicolinaldehyde |
| | | one | |
| 2-Propenal, 3-(4- | 1,3-Cyclopentadiene-1,3- | 2,4-Dihydroxy-5- | Deuterio-(4-hydroxy-3- |
| hydroxy-3- | dicarbaldehyde | methoxybenzaldehyde | methylphenyl)methanone |
| methoxyphenyl)- | | | |
| 4-Hydroxy-3,5- | 3-Isocyanato-4- | 2-Hydroxy-5-methoxybenzoyl | 5-Oxo-1,2-oxazolidine-2- |
| dimethoxybenzyl alcohol | methylbenzaldehyde | chloride | carboxamide |
| Syringic acid | (4-Amino-3-methoxy-2- | N-(3- | 2-Cyclopentyl-1-(4-hydroxy-3- |
| | methylphenyl)acetonitrile | Chlorophenyl)methanimine | methoxyphenyl)ethanone |
| Tropolone | 2,4-Dimethoxybenzenesulfinate | 2,5-Difluoro-3- | 2-Methoxy-6-methyl-4- |
| | | methoxybenzaldehyde | propan-2-yl phenol |
| Vanylglycol | 5-(Methoxymethyl)-1,3- | 1-(3,6-Dihydroxy-2- | 1-(3-Hydroxy-4- |
| | oxathiolane-2-thione | methoxyphenyl)ethanone | methoxyphenyl)-2,2- |
| | | | dimethylpropan-1-one |
| 4-Aminobenzaldehyde | 4-Acetyl-1-methylpiperazine- | 3,5-Dichloro-2- | 5-Fluoro-4-hydroxy-2- |
| | one | methoxyaniline | methylbenzaldehyde |
| 3-Methoxybenzaldehyde | 1-Acetylpyrrolidine-3- | Allyl-4,5- | 2-Chloro-4-fluoro-3- |
| | carbaldehyde | dimethoxybenzaldehyde | methoxybenzaldehyde |
| Ethyl vanillate | 4-(Methylamino)cyclohexane-1- | 2-Bromo-1-(4-hydroxy-3- | (3E)-3-(Hydroxymethylidene)- |
| | carbaldehyde | methylphenyl)ethanone | 2-methylcyclohexene-1- |
| | | | carbaldehyde |
| Isovanillin | 2-Ethoxy-4-propylphenol | 3-Hydroxy-4-[(4- | 3-Ethoxy-4-hydroxy-5- |
| | | methoxyphenyl)methoxy]benz- | methoxybenzoic acid |
| | | aldehyde | |
| 3-Hydroxy-4- | 3-Oxopyrrolidine-1- | 2-Fluoro-4- | 3-Ethoxy-4-hydroxy-5- |
| methoxybenzoic acid | carbaldehyde | (hydroxymethyl)phenol | methoxybenzaldehyde |
| 4-Hydroxybenzonitrile | 5-Bromo-4-fluoro-2- | Methyl 4-iodo-3- | 3-Methoxy-4- |
| | methoxyphenol | methoxybenzoate | (methylamino)benzamide |
| Vanillylidene acetone | 1-(5-Acetyl-1-amino-4- | p-Anisaldehyde-%7CA-d1 | (2S,3R)-3-Methylpyrrolidine- |
| | methylpyrrol-3-yl)ethanone | | 1,2-dicarbaldehyde |
| 3′,4′- | 4-Hydroxy-3-methyl-5- | 1-[3-[(Dimethylamino)methyl]- | (2S,5R)-5-Methylpyrrolidine- |
| Dimethoxyacetophenone | phosphanyloxybenzaldehyde | 4-hydroxyphenyl]ethanone | 1,2-dicarbaldehyde |
| 3′,4′- | 4-Methylcyclopentane-1,2- | 3-Hydroxy-4-methoxy-2-(1- | 1-Azido-5-chloro-2,4- |
| Dihydroxyacetophenone | dicarbaldehyde | methylprop-2- | dimethoxybenzene |
| | | enyl)benzaldehyde | |
| 1-(4-Hydroxy-3- | (4-Formyl-2-methoxyphenyl) | 4-Bromo-2-methoxy-6- | 1-[5-Methoxy-2- |
| methoxyphenyl)propan- | sulfate | methylphenol | (methylamino)phenyl]ethanone |
| 1-one | | | |
| 3,5-Dichloro-4- | 4-Formyl-2-methoxyphenyl | 4-Hydroxy-5-methoxy-1- | 5-Iodo-2-methoxy-4- |
| hydroxybenzaldehyde | hydrogen sulfate | indanone | methylphenol |
| Homovanillyl alcohol | 3-Isocyano-5- | 1-Acetyl-3-chloro-2-hydroxy- | 4-Chloro-6- |
| | methoxybenzonitrile | 5-methoxybenzene | methoxypicolinaldehyde |
| 3-Chloro-4- | 6-Methoxy-3-methyl-1- | 3-(Allyloxy)-4-hydroxybenzoic | (1R,2R,4S)-2-Azido-4- |
| hydroxybenzaldehyde | benzothiophen-5-ol | acid methyl ester | (methoxymethyl)cyclohexan- |
| | | | 1-ol |
| 4,5-Dichloroguaiacol | 2-Methoxy-3-methyl-4-(prop-1- | 5-Bromo-2,4-dimethoxy-3- | 2-Hydroxy-5- |
| | en-1-yl)phenol | methylphenol | (methylideneamino)benzaldehyde |
| Acetosyrinqone | 3,5-Dimethyl-3H-pyran-2,6- | 4-Hydroxy-3-[(4- | 2-Methyl-5- |
| | dione | methoxyphenyl)methoxy]ben | (methylideneamino)benzaldehyde |
| | | zaldehyde | |
| 4-(1-Hydroxyethyl)-2- | 3-(4-Hydroxy-3-methoxyphenyl)- | 3-Hydroxy-2-iodo-4- | 2-Methoxy-4-(1- |
| methoxyphenol | 2-methylprop-2-enal | methoxybenzaldehyde | methoxyethyl)phenol |
| 4-Hydroxy-3- | 3-[5-(5-Formyl-2- | 2H-Pyran-4-carboxaldehyde, | 2-Methoxy-4- |
| methoxyphenylacetone | hydroxyphenoxy)pentoxy]-4- | 3-methyl-2-oxo- | oxatricyclo[4.2.1.03,7]nonan- |
| | hydroxybenzaldehyde | | 5-one |
| Tetrachloroquaiacol | 1-(Chloromethyl)-6-hydroxy-4,5- | 2,4-Dihydroxy-3- | 4-Methoxycyclopenta-1,3- |
| | dimethyl-2-oxopyridine-3- | methoxybenzaldehyde | diene-1-carbaldehyde |
| | carbonitrile | | |
| 4,5,6-Trichloroquaiacol | 2-Chloro-4- | Phenol, 2-methoxy-4- | 1-(8-Methylquinolin-7- |
| | (methylamino)benzonitrile | (methoxymethyl)-3-methyl- | yl)ethanone |
| 2,4-Dimethoxyaniline | 5-(Methoxymethyl)-1,3,4- | 5-Tert-Butyl-4-hydroxy-2- | 3-Chloro-2-fluoro-6- |
| | oxadiazole-2-carbaldehyde | methylbenzaldehyde | hydroxybenzaldehyde |
| 2-Methoxy-4- | 2,3,4-Trifluoro-5- | 2-Hydroxy-5-prop-1-en-2- | 4-Isocyano-2-methoxyphenol |
| propylphenol | methoxybenzoic acid ethyl ester | ylcyclohex-2-en-1-one | |
| Isophthalaldehyde, 5- | 1,3-Dimethyl-5- | 4-Hydroxy-m-anisaldehyde, | 4-Chloro-2-methoxy-3,6- |
| ethoxy-4-hydroxy- | sulfanylidenepyrrolidin-2-one | bromo derivative | dimethylphenol |
| 4-Hydroxy-5- | 2-Methoxy-4-(3- | 3-Cyclopentyloxy-4- | 1-(Chloromethoxy)-3- |
| methoxyisophthal- | methylbutyl)phenol | hydroxybenzaldehyde | methoxybenzene |
| aldehyde | | | |
| 5-Bromovanillin | 2,4-Dimethoxybenzene-1,3-diol | Methyl 4-hydroxy-3- | 3-Acetyl-4- |
| | | iodobenzoate | methylbenzaldehyde |
| 2,6-Dichloro-4- | N-(2-Formyl-4- | 4-(Methoxymethyl)benzene- | 3- |
| hydroxybenzonitrile | methoxyphenyl)formamide | 1,2-diol | (Methylideneamino)benzaldhyde |
| Acetophenone, 3,4- | 4-Cyano-2-ethoxybenzoyl | Phenol, 6-bromo-2,4- | (1R,2R,4R)-2-Methoxy-4- |
| dihydroxy-5-methoxy- | chloride | dimethoxy-3-methyl- | methylcyclohexan-1-ol |
| Methyl vanillate | 2,4-Dihydroxy-5- | 4-[2-(4-Fluorophenyl)ethoxy]- | 5-Hydroxy-2-[2-(4-hydroxy-3- |
| | methylbenzaldehyde | 3-hydroxybenzaldehyde | methoxyphenyl)ethynyl]-4- |
| | | | methoxybenzaldehyde; |
| | | | praseodymium |
| 3,5-Dimethyl-4- | Ethyl acetate; 4-hydroxy-3- | 3-Acetyl-4- | 5-Hydroxy-2-iodo-4- |
| hydroxybenzonitrile | methoxybenzaldehyde | hydroxybenzaldehyde | methoxybenzaldehyde; |
| | | | praseodymium |
| 2,3- | 2-Methoxy-1-methyl-4- | 3-Cyclopropoxy-4- | 4-Hydroxy-2-iodo-5- |
| Dimethoxybenzonitrile | thionitrosobenzene | hydroxybenzaldehyde | methoxybenzaldehyde; |
| | | | praseodymium |
| 3,4- | Ethyl 2-methylpropanoate; 4- | 4-(Chloromethoxymethyl)- | 3-Hydroxy-4- |
| Dimethylbenzaldehyde | hydroxy-3- | 1,2-dimethoxybenzene | methoxybenzaldehyde; |
| | methoxybenzaldehyde | | praseodymium |
| 2-Amino-2,4,6- | 2-Chloro-6-methoxy-4- | Methyl 3-bromo-4-hydroxy-5- | 1-(4-Hydroxy-3-methoxy-5- |
| cycloheptatrien-1-one | methylaniline | methoxybenzoate | methylphenyl)propan-2-one |
| 3,4- | 1-Azido-2,4-dimethoxybenzene | 2-Methoxy-4- | 4-Chloro-2-fluoro-3- |
| Dichlorobenzaldehyde | | (methylthio)phenol | methoxybenzonitrile |
| trans-2- | 3-(Difluoromethoxy)-4- | 2,5-Difluoro-3-methoxybenzyl | 4-(Hydroperoxymethyl)-2- |
| Cyanocyclobutanecarbox- | hydroxybenzaldehyde | alcohol | methoxyphenol |
| amide | | | |
| 4-Chloro-2- | 1-(3-Hydroxy-4- | 1H-Pyrrole-2-carbonitrile, 5- | 3-Ethoxy-4-(1-ethyl-propoxy)- |
| methoxyphenol | phenylmethoxyphenyl)propan-1- | chloro-1-(methoxymethoxy)- | benzaldehyde |
| | one | | |
| Phenol, 2,4-dichloro-6- | 4-Methoxy-3-pentan-3- | Benzyl vanillin | 4-Cyanophenol-2,3,5,6-d4 |
| methoxy- | yloxybenzaldehyde | | |
| 2,3-Dihydroxypyridine | 3-(2-Ethylbutoxy)-4- | 3-Oxo-1-cyclohexene-1- | 2-Oxazolecarboxaldehyde, 5- |
| | methoxybenzaldehyde | carbonitrile | ethoxy- |
| Ethyl 3,5-dichloro-4- | 4-(Chloromethyl)-2- | 1-Ethoxy-3- | 1-(4-Ethynoxy-6- |
| hydroxybenzoate | methoxyphenol | (methoxymethyl)benzene | methylpyridin-2-yl)ethanone |
| Benzaldehyde, 2,3- | 6-Formylbicyclo[2.2.1]heptane- | 4-Methoxy-2-naphthaldehyde | 4-Hydroxy-3-methoxy-5- |
| dichloro-4-hydroxy-5- | 2-carbonitrile | | methylbenzaldehyde; yttrium |
| methoxy- | | | |
| 2-Chloro-4-hydroxy-5- | 4-Sec-butoxy-3- | Ethyl(3-methoxybenzyl) ether | 3-Butoxy-4- |
| methoxybenzaldehyde | methoxybenzaldehyde | | propoxybenzaldehyde |
| 3-Chloro-4-hydroxy-5- | 2,3-Difluoro-6- | 2-Benzyl-5-hydroxy-4- | 4-(Cyclopropylmethoxy)-3- |
| methoxybenzaldehyde | hydroxybenzaldehyde | methoxybenzaldehyde | hydroxybenzaldehyde |
| 4-Methoxybenzaldehyde | 3-(2-Bromo-1,1,2,2- | (S)-(−)-2-(Methoxymethyl)-1- | 1-(3-Fluoro-4-hydroxy-5- |
| | tetrafluoroethoxy)-4- | pyrrolidinecarboxaldehyde | methoxyphenyl)ethanone |
| | hydroxybenzaldehyde | | |
| 1-(4-Hydroxy-3,5- | 4-Hydroxy-3-(1,1,2,2- | 3-Methoxy-4-[(3-methyl-2- | 2-Ethoxy-4-propan-2-ylphenol |
| dimethylphenyl)ethanone | tetrafluoroethoxy)benzaldehyde | buten-1-yl)oxy]benzaldehyde | |
| Dichloro-2,6- | 4-Hydroxy-3-methoxyphenethyl | 2-Methylveratraldehyde | 5-Formyl-2-hydroxy-3-methyl- |
| dimethoxyphenol | chloride | | benzoic acid methyl ester |
| 4-Hydroxy-3- | 6-Formyl-3-hydroxy-2- | 4-Acetyl-N-methylaniline | 3-Methoxy-4-(pent-3- |
| (hydroxymethyl)benzaldehyde | methoxybenzoic acid | | yloxy)benzaldehyde |
| 2-Cyano-1- | 2-Chloro-4-fluoro-5- | 1-(3-Hydroxy-4-methoxy-5- | 4-(But-2-ynyloxy)-3- |
| aziridinecarboxamide | isocyanatobenzaldehyde | methylphenyl)ethanone | methoxybenzaldehyde |
| 3,4,5-Trichloroguaiacol | 2,4-Dichloro-5- | 2,4- | 3-(But-2-ynyloxy)-4- |
| | isocyanatobenzaldehyde | Dihydroxyisophthalaldehyde | methoxybenzaldehyde |
| 4-Hydroxy-3- | 3,5-Dichloro-4-(hydroxymethyl)- | 2,3-Dimethoxy-5- | Ethyl 3-hydroxy-4- |
| methoxyphenyl acetate | 2,6-dimethylphenol | methylbenzaldehyde | (trideuteriomethoxy)benzoate |
| 2-Bromo-4-hydroxy-5- | 2′,6′-Dimethoxy-4′-formyl- | 2,5-Dihydroxy-4-methoxy- | 3-Hydroxy-4- |
| methoxybenzaldehyde | formanilide | benzaldehyde | phosphanyloxybenzaldehyde |
| 3,4,6-Trichloroquaiacol | 6-Hydroxy-5- | 3-Methoxy-4-hydroxy-5- | 7-Hydroxy- |
| | methoxybenzo[b]thiophene | benzylbenzaldehyde | benzo[b]thiophene-4- |
| | | | carbaldehyde |
| 3-Chloro-4-hydroxy-5- | 3-Chloro-4- | 2-Benzyl-3-hydroxy-4- | 4-Hydroxy-3- |
| methoxybenzoic acid | (hydroxymethyl)phenol | methoxybenzaldehyde | methoxybenzaldehyde; |
| | | | rutherfordium |
| 2-Chloro-4-hydroxy-5- | 1,3-Dimethyl-4- | (3-Methoxy-4- | 3- |
| methoxybenzoic acid | sulfanylideneimidazolidin-2-one | methylphenyl)methanol | (Methylideneamino)benzonitrile |
| 3-Methoxytropolone | 1,3-Dimethylimidazolidine-2,4- | 2-Cyclohexen-1-one, 6- | (2E,4E)-5-(4-Hydroxy-3- |
| | dithione | hydroxy-3-methyl- | methoxyphenyl)penta-2,4- |
| | | | dienal |
| 2-Hydroxy-5- | 3-Butyl-4-hydroxybenzaldehyde | 2-Amino-4-hydroxy-5- | 1-Ethenoxynaphthalen-2-ol |
| (hydroxymethyl)benzaldehyde | | methoxybenzaldehyde | |
| 2-Chlorosyringaldehyde | 3-(Hexyloxy)-4- | Methyl 3-cyano-4- | 2-(4-Isocyano-5-methoxy-2- |
| | hydroxybenzaldehyde | hydroxybenzoate | methylphenyl)oxirane |
| 3,4-Dichloro-2- | 2,5-Dichloro-4- | 2-Methoxy-4-(1,3- | 2-(4-Isocyano-3- |
| methoxyphenol | hydroxybenzonitrile | oxathiolane-2-yl)phenol | methoxyphenyl)oxirane |
| 2-Chloro-4-hydroxy-3- | 5-Acetyl-2- | 3-Formyl-4- | 2-(4-Isocyano-3-methoxy-2- |
| methoxybenzaldehyde | hydroxyphenylacetonitrile | hydroxybenzonitrile | methylphenyl)oxirane |
| 4-Formyl-2- | 3-Methylcyclobutane-1,2- | 3-Hydroxy-2- | 2-(2-Fluoro-4-isocyano-5- |
| methoxyphenyl acetate | dicarbonitrile | methoxybenzaldehyde | methoxyphenyl)oxirane |
| 4-(Ethoxymethyl)-2- | (5-Chloro-2,4- | 4-Amino-3- | 3-Hydroxy-4-methoxy-2-(4- |
| methoxyphenol | dimethoxyphenyl)carbamic acid | methoxybenzonitrile | methylphenyl)benzaldehyde |
| Vanillyl alcohol | 2-Methoxy-N,3,4,5,6- | 2-Methoxy-4,6- | 1-(1-Hydroxy-6- |
| | pentamethylaniline | dimethylaniline | sulfanylidenepyridin-2- |
| | | | yl)ethanone |
| 4-Ethyl-2- | 4-Methoxy-2-methylcyclohexa- | 4-(1-Chlorovinyl)-1,3- | N-(2,4- |
| methoxyphenol | 1,4-dien-1-ol | dimethoxybenzene | Dimethoxyphenyl)thiohydroxyl- |
| | | | amine |
| 5-Acetyldihydrofuran- | 2-Ethoxy-4-methoxyphenol | 2-Iodo-3,4- | 4-Methoxy-3-(1,1,2,2,2- |
| 2(3H)-one | | dimethoxybenzaldehyde | pentadeuterioethoxy)benzal- |
| | | | dehyde |
| N-(2-Methoxy-4- | 6-Methoxybenzo[d]isoxazole | 3,4-Dihexyloxybenzaldehyde | 3-Ethoxy-4- |
| nitrophenyl)acetamide | | | (trideuteriomethoxy)benzal- |
| | | | dehyde |
| 2-Ethoxyphenol | 3-Methyl-5- | (2-Methoxy-4-nitro- | 3-(1,1,2,2,2- |
| | (trifluoromethoxy)benzonitrile | phenyl)hydrazine | Pentadeuterioethoxy)-4- |
| | | | (trideuteriomethoxy)benzal- |
| | | | dehyde |
| 2,4-Diethoxyaniline | (5-Formyl-2-hydroxyphenyl) | 4-Oxo-6-methyl-4H-pyran-2- | 1-Ethoxy-2-methoxy-4- |
| | cyanate | carbaldehyde | (methoxymethyl)benzene |
| 5-Chloro-2,4- | 3-Hydroxy-4-(2- | 3-Bromo-3- | 1-Fluoro-2-methoxy-4- |
| dimethoxyaniline | hydroxyethoxy)benzaldehyde | (methoxymethyl)cyclobutane- | (methoxymethyl)benzene |
| | | 1-carbonitrile | |
| 2-Chloro-3′,4′- | 2,6-Dichloro-4-(2- | 2-Allyloxy-4-nitrophenol | 3-Amino-6-methyloxan-2-one |
| dihydroxyacetophenone | methoxypropan-2-yl)phenol | | |
| 4-Ethoxy-3- | 4-Ethylsulfinylphenol | 1,3- | Methyl 3,4- |
| methoxybenzaldehyde | | Benzenedicarboxaldehyde, 4- | bis(trideuteriomethoxy)benzoate |
| | | hydroxy-2-methyl- | |
| 3-Fluoro-4- | 3-Aminotetrahydro-1,3-oxazine-2- | 2-Ethoxy-4-vinylphenol | 6-(Hydroxymethyl)-4- |
| methoxybenzaldehyde | one | | methoxyoxan-3-ol |
| 3-Hydroxy-4H-pyran-4- | 2-Methyl-4-methylsulfinylphenol | (2R)-2-Hydroxy-4- | Benzaldehyde, 4-hydroxy-3- |
| one | | methylcyclohexan-1-one | methoxy-5-propyl- |
| 3-Hydroxy-2H-pyran-2- | (4-Formyl-2-methoxyphenyl) | 4-Bromo-3- | 3-Hydroxy-4- |
| one | hydrogen sulfite | methoxybenzaldehyde | octoxybenzaldehyde |
| 5-Hydroxy-2-methyl-4H- | 5-Acetyl-7-chloro-8- | Benzaldehyde, 3,4-bis[2-(2- | Benzaldehyde, 4-hydroxy-3- |
| pyran-4-one | hydroxyquinoline | hydroxyethoxy)ethoxy]- | methyl-5-(2-propen-1-yl)- |
| 1-Methyl-6-oxo-1,6- | 1-(7-Bromo-8-hydroxy-quinolin- | 4-Methoxy-3- | 3-Methoxy-2,4- |
| dihydropyridine-3- | 5-yl)-ethanone | (trideuteriomethoxy)benzal- | dimethylbenzonitrile |
| carboxamide | | dehyde | |
| 2′-Hydroxy-5′- | (3,4-Dimethoxyphenyl)-(4- | 4-Methoxy-2-oxo-2H-pyran-6- | 4-Methyl-1-oxo-1,4-thiazinan- |
| methoxyacetophenone | hydroxy-3- | carbaldehyde | 3-one |
| | methoxyphenyl)methanone | | |
| 2-Methoxyhydroquinone | (4-Fluorophenyl)-(4-hydroxy-3- | 2H-Pyran-6-carboxaldehyde, | 3-Hydroxy-2-iodo-4-methoxy- |
| | methoxyphenyl)methanone | 4-methoxy-3,5-dimethyl-2- | 5-methylbenzaldehyde |
| | | oxo- | |
| 1,3-Dimethyluracil | 2′-Methyl-3-methoxy-4- | 4-Amino-3-mercapto-benzoic | 5-Fluoro-3-hydroxy-6- |
| | hydroxybenzophenone | acid ethyl ester | isocyano-1-methylpyridin-2- |
| | | | one |
| 1-(4-Hydroxy-2- | 4-Hydroxy-3- | 2-Methoxyphenol-d3 | 2,5-Dihydroxycyclohex-2-en- |
| methylphenyl)ethanone | methoxybenzaldehyde; phenyl- | | 1-one |
| | methoxymethylbenzene | | |
| 4′-Hydroxy-3′- | (3-Fluorophenyl)-(4-hydroxy-3- | 4-Thiazolidinone, 3,5- | 4-Hydroxy-3- |
| methylacetophenone | methoxyphenyl)methanone | dimethyl-2-thioxo- | (methoxymethyl)-5- |
| | | | methylbenzonitrile |
| Methyl 4-hydroxy-3,5- | (4-Hydroxy-3-methoxyphenyl)- | 1-(4-Hydroxy-3- | 3-(Difluoromethoxy)-4- |
| dimethoxybenzoate | (4-methoxyphenyl)methanone | dimethylamino- | fluorobenzonitrile |
| | | phenyl)ethanone | |
| Vanillylamine | Ethyl 3-chloro-4- | 4-Hydroxy-3- | 5-(Deuteriomethoxymethyl)- |
| | (methylamino)benzoate | methoxybenzaldehyde | 2-methoxy-N-methylaniline |
| Methyl 3-chloro-4- | 3-Methoxy-4-hydroxybenzoic | 4-Hydroxy-3-(methoxy- | 4-Fluoro-5-iodo-2- |
| hydroxy-5- | acid pentyl ester | 13C)benzaldehyde | methoxyphenol |
| methoxybenzoate | | | |
| 6-Hydroxynicotinamide | 4,5-Dichloro-3- | Ethanone, 1-[4-hydroxy-3- | 1-(3-Hydroxy-4-prop-2- |
| | methoxybenzaldehyde | (methylsulfonyl)phenyl]- | enoxyphenyl)ethanone |
| 3-Methoxybenzonitrile | 1-(2,4-Dimethoxy-phenyl)-ethyl | 2- | 5-Amino-2,3-dimethyl-1,3- |
| | chloride | (Methoxymethyl)benzaldehyde | thiazinan-4-one |
| 4-Methoxy-2,6- | 3,5-Dimethoxy-4- | 3- | 6-Amino-3,4-dimethyl-1,4- |
| dimethylphenol | hydroxybenzoic acid chloride | (Methoxymethyl)benzaldehyde | thiazepan-5-one |
| 3,5-Dichloro-4- | 5-Chloro-3-ethoxy-2- | 2-Ethoxy-d5-phenol | 6-Amino-2,4-dimethyl-1,4- |
| hydroxybenzonitrile | methylbenzene-1,4-diol | | thiazepan-5-one |
| 3,4- | 3-Amino-2-methoxy-6- | 1-(3-Hydroxy-4- | (3-Methoxy-4- |
| Diethoxybenzaldehyde | methylbenzenethiol | methoxyphenyl)-2- | methylphenyl)methanimine |
| | | phenylethanone | |
| 4,6-Diacetylresorcinol | 7-Sulfanylideneoxepan-2-one | 1-[4-Hydroxy-3- | 1-[(4R)-2-Acetyl-4- |
| | | (trideuteriomethoxy)phenyl]ethanone | methylcyclohexyl]ethanone |
| beta- | 1-(3-Methoxy-4- | 7-Hydroxybenzofuran-4- | 2- |
| Hydroxypropiovanillone | methylphenyl)ethanethione | carbaldehyde | (Tritritiomethoxy)benzaldehyde |
| 3,5-Dimethyl-4- | 4-Hydroxy-3- | 5-Formylthiophene-2- | 2- |
| hydroxybenzaldehyde | methoxybenzaldehyde; urea | carboxamide | (111C)Methoxybenzaldehyde |
| 4-Ethoxy-3- | 3-Hydroxy-4- | 1-Methyl-6-oxo-1,6- | (4-Cyano-3- |
| hydroxybenzaldehyde | methylthiobenzaldehyde | dihydropyridine-2- | fluorophenyl)oxidanium |
| | | carboxamide | |
| 2-Ethoxy-4- | 4′-Hydroxy-3′,5′-dimethoxy- | 4-Cyano-1-aminopyridinium | 1-Amino-3,5,6- |
| methylphenol | alpha-iodoacetophenone | | trimethylpyrimidine-2,4-dione |
| 2-Methoxy-6- | 6-Hydroxy-3-methoxy-2- | 3-Methoxy-4- | (2E)-2-(Hydroxymethylidene)- |
| methylphenol | methylcyclohex-2-en-1-one | hydroxyphenylacetylene | 4,4-dimethyl-5- |
| | | | sulfanylidenethiolan-3-one |
| 3-Bromo-4- | 5-Ethoxynicotinonitrile | Curvulol | (5S)-3-Methoxy-5- |
| hydroxybenzaldehyde | | | methylcyclohexan-1-one |
| 4-Hydroxy-3,5- | 3,4-Difluoro-2-methoxyphenol | 1-(3-Chloro-4- | 1-(3,4-Dimethoxyphenyl)-3- |
| dimethoxybenzamide | | ethoxyphenyl)ethanone | (3-hydroxy-4- |
| | | | methoxyphenyl)propan-1-one |
| 2-Methoxy-4-nitrophenol | 4-Hydroxy-3- | 4-Methoxypicolinaldehyde | (3Z,5R)-3- |
| | methoxybenzaldehyde; 3- | | (Hydroxymethylidene)-1,5- |
| | methylbutyl acetate | | dimethylpyrrolidin-2-one |
| Methyl 3,5-dichloro-4- | 1-Vinyl-3-methylpyrimidine- | 6-Methoxypyridine-2- | 4-Tritiooxybenzaldehyde |
| hydroxybenzoate | 2,4(1H,3H)-dione | carbaldehyde | |
| 3,4-Dihydroxy-5- | Acetyloxy-(5-formyl-2-hydroxy- | 4-Hydroxyisophthalonitrile | 4-Methoxy-5- |
| methoxybenzaldehyde | 3-methoxyphenyl)mercury | | (methoxymethyl)-2- |
| | | | methylthiolan-3-ol |
| Methyl 3-chloro-4- | 2-Methoxy-6-nitrosophenol | 6-Ethoxy-4,5-dimethyl-2,3- | 4-[(4- |
| hydroxybenzoate | | dihydro-1H-inden-1-one | Hydroxyphenyl)methoxy]-3- |
| | | | methoxybenzaldehyde |
| 3-Hydroxy-4- | 2-Ethyl-4-hydroxy-3- | 4-Ethoxy-5,7-dimethyl-2,3- | 2,5-Dimethoxy-N- |
| methoxybenzyl alcohol | methoxybenzamide | dihydro-1H-inden-1-one | methylbenzamide |
| 4-Hydroxy-3- | 3-Methoxy-2- | 1-Methyl-6-oxo-1,6- | 4-(4-Hydroxybutoxy)-3- |
| methoxybenzonitrile | methylperoxybenzaldehyde | dihydropyridine-2-carbonitrile | methoxybenzaldehyde |
| 4-Hydroxy-3- | Ethyl 5-acetyl-4-hydroxy-3,6- | 2-Acetyl-4-cyanophenol | 4-(2-Butoxyethoxy)-3- |
| methoxyphenylacetonitrile | dihydro-2H-pyridine-1- | | methoxybenzaldehyde |
| | carboxylate | | |
| 3-Chloro-4- | 3-Hydroxy-4-methyl-5- | Methyl 3-acetyl-4- | Methyl 3-azido-4- |
| methoxybenzaldehyde | methylidenefuran-2-one | hydroxybenzoate | hydroxybenzoate |
| 2,5-Diacetylthiophene | 2-(Methoxymethyl)-4,6- | 5-Methoxy-2- | 2-(3-Ethoxyphenyl)oxirane |
| | dimethylphenol | methylbenzaldehyde | |
| Butyl vanillate | 3-Methoxy-4-[(E)-prop-1- | (R)-(+)-2-(Methoxymethyl)-1- | 3-(3-Methyl-2- |
| | enoxy]benzaldehyde | pyrrolidinecarboxaldehyde | oxoimidazolidin-1-yl)propanal |
| 4- | N-Ethyl-4-hydroxy-3- | Ethanone, 1-(4-hydroxy-3- | Benzonitrile, 2-fluoro-5- |
| (Methoxymethyl)phenol | methoxybenzamide | propylphenyl)- | isocyanato- |
| 5-Iodovanillin | 4,6-Didiazo-1- | 2-Hydroxy-5- | 4-Amino-3-ethoxybenzamide |
| | methylcyclohexene | methylcyclohepta-2,4,6-trien- | |
| | | 1-one | |
| 2-Methoxy-4- | 4-Hydroxy-5-methoxycyclohept- | 3-Amino-6-methoxypyridine- | 1-Acetylpiperidine-3- |
| (methoxymethyl)phenol | 2-en-1-one | 2(1H)-thione | carbonitrile |
| 1-Propanone, 1-(4- | 2H-Pyran-2-one-6- | 2-Methoxy-3-methylaniline | 2-Ethoxy-4-(2- |
| hydroxy-3,5- | carboxaldehyde | | hydroxyethyl)phenol |
| dimethoxyphenyl)- | | | |
| Benzonitrile, 4-amino- | 2-Methoxy-5-methyl-4- | 4-Amino-2,3- | 3-(Methoxymethyl)pyrrolidine- |
| 2,5-dimethoxy- | nitrophenol | dimethylbenzaldehyde | 1-carbaldehyde |
| 2,4-Dihydroxy-3- | 5-Fluoro-2,4-dimethoxy-pyridine | Methyl 4-hydroxy-3,5- | 3-(Hydroxymethyl)azetidine- |
| methylbenzaldehyde | | dimethylbenzoate | 1-carboxamide |
| 4-Chloro-2-methoxy-5- | 1-(4-Cyanophenyl)-2- | 2-Isopropenyl-4- | Methyl 4-ethenoxy-3- |
| methylaniline | methylhydrazine | methoxyphenol | methoxybenzoate |
| 3-Methoxybenzyl | 4-(2-Methoxyethyl)piperazine-1- | 4-Hydroxy-3- | 4-Chloro-3-ethoxy-2- |
| alcohol | carbaldehyde | methoxymethoxybenzaldehyde | fluorobenzaldehyde |
| 2,4-Dimethoxybenzyl | 2-(2-Methoxy-3,5- | 3-Hydroxy-4- | 2-Chloro-3- |
| alcohol | dimethylphenyl)acetaldehyde | (methoxymethoxy)benzal- | methoxyhydroquinone |
| | | dehyde | |
| 2,4- | 2-Chloro-1-(2,4-dihydroxy-3- | 2-Chloro-1-(2-hydroxy-5- | Acetic acid; 1-(4-hydroxy-3- |
| Dimethoxybenzenediazonium | methoxyphenyl)ethanone | methoxyphenyl)ethanone | methoxyphenyl)ethanone |
| 2-(Chloromethyl)-5- | Benzo[d]thiazole-5- | 4-Amino-3,5-dimethoxy- | 4-Carbamoyloxazol-2- |
| hydroxy-4H-pyran-4-one | carbaldehyde | benzoic acid methyl ester | ylmethanol |
| 4,5-Dimethoxy-2- | 6-Amino-4,5-dimethyl- | 2-Methyl-3-oxocyclohexane- | (4R)-6-(Hydroxymethyl)-4- |
| methylbenzaldehyde | nicotinonitrile | 1-carbonitrile | methoxyoxan-3-ol |
| 4-Hydroxy-5-isopropyl- | 5-Quinoxalinecarbonitrile, 8- | 4-Hydroxy-6- | 1-(4-Hydroxy-3- |
| 3-methylbenzaldehyde | amino- | methoxybenzene-1,3- | methoxyphenyl)ethanone |
| | | dicarbaldehyde | |
| Methyl homovanillate | 4-Hydroxy-5-methoxy-2- | 1,4-Dimethyl-6- | Formaldehyde; 3-(4-hydroxy- |
| | (4,4,5,5-tetramethyl-1,3,2- | oxopyrimidine-2-carbonitrile | 3-methoxyphenyl)-1-(4- |
| | dioxaborolan-2-yl)benzaldehyde | | hydroxyphenyl)prop-2-en-1- |
| | | | one |
| 2-Ethoxy-4-nitroaniline | 3-Methylisoeuqenol | 1-(5-Hydroxypyridin-2- | 3-(4-Hydroxy-3- |
| | | yl)ethanone | methoxyphenyl)-1-(4- |
| | | | hydroxyphenyl)prop-2-en-1- |
| | | | one |
| Methyl 5-acetylsalicylate | 1-[3-Chloro-5- | 3-Chloro-4- | 5′-Hydroxy-2′-iodo-4′- |
| | (difluoromethoxy)phenyl]eth- | methylbenzaldehyde | methoxyacetophenone |
| | anone | | |
| Benzaldehyde, 2,6- | 3-Chloro-5-(1- | 2-Chloro-5-methoxybenzene- | 1-(5-Hydroxy-2-iodo-4- |
| dichloro-4-hydroxy-3- | fluoroethoxy)benzaldehyde | 1,4-diol | methoxyphenyl)propan-1-one |
| methoxy- | | | |
| 3′,5′-Dichloro-4′- | 3-Chloro-5- | 3- | 3-Hydroxy-1-(4-hydroxy-3- |
| hydroxyacetophenone | (difluoromethoxy)benzaldehyde | Oxocyclopentanecarbaldehyde | methoxyphenyl)butan-1-one |
| 2-Methoxy-3- | 3-Chloro-5- | 3-Hydroxy-5-methyl-2,5- | 4-Hydroxy-1-(4-hydroxy-3- |
| methylphenol | methoxybenzaldehyde | dihydrofuran-2-one | methoxyphenyl)butan-1-one |
| 2-Hydroxy-1-(4-hydroxy- | 3,4-Diethoxy-2- | 3-Methoxy-4-[2- | 1-(Methoxymethyl)-3- |
| 3-methoxyphenyl)eth | fluorobenzaldehyde | (vinyloxy)ethoxy]benzal- | methylenecyclobutane- |
| anone | | dehyde | carbonitrile |
| 3-Methoxyphenyl | 2,4,5-Trifluoro-3- | 2,4,5-Trimethoxyphenol | 1-(Cyanomethyl)-3- |
| isocyanate | methoxybenzaldehyde | | methylenecyclobutane- |
| | | | carbonitrile |
| 2,4,6-Trimethoxyphenol | 4-Hydroxy-3-methoxy-2-(2- | 4- | 5-(Methoxymethyl)-4-methyl- |
| | oxopropyl)benzaldehyde | Hydroxytetrachlorobenzonitrile | 1,3-oxazol-2-thiol |
| 2-Cyclopenten-1-one, 2- | 4-Hydroxy-3- | 4-Hydroxy-5-methoxy[1,1′- | 1-(4-Hydroxy-3- |
| hydroxy-3,4-dimethyl- | methoxybenzaldehyde; 2- | biphenyl]-2-carbaldehyde | methoxyphenyl)but-3-en-2- |
| | propan-2-yloxypropane | | one |
| 3-Ethoxybenzaldehyde | 3-Hydroxy-4- | 5-Hydroxy-4-methoxy-2-(2- | 2,4-Difluoro-6-methoxyphenol |
| | methoxybenzaldehyde; 2- | methylphenyl)benzaldehyde | |
| | propan-2-yloxypropane | | |
| N-(2,4- | 3-Butoxybenzonitrile | Ethyl 4-hydroxy-3- | 3-Chloro-5-hydroxy-1,2- |
| Dimethoxyphenyl)acetamide | | methylbenzoate | dimethylpyridin-4(1 H)-one |
| 3-Ethoxybenzonitrile | 3-Cyano-5-ethoxybenzoyl | 4-(3-Hydroxy-4- | Methyl 3-chloro-4-hydroxy-5- |
| | chloride | methoxyphenyl)-4-oxo- | isopropoxybenzoate |
| | | butanoic acid | |
| 2-Methoxy-4- | 4-Butyloxy-3- | 4-(4-Hydroxy-3- | 5-Ethyl-4-fluoro-2- |
| (oxiranylmethyl)phenol | hydroxybenzaldehyde | methoxyphenyl)-4- | methoxyphenol |
| | | oxobutanoic acid | |
| Acetamide, N-(2- | 3-Hydroxy-4- | Benzaldehyde, 3-(1,1- | 5-Hydroxy-6-oxo-1H- |
| methoxy-5-methyl-4- | propoxybenzaldehyde | dimethylethyl)-4-hydroxy-5- | pyrimidine-2-carboxamide |
| nitrophenyl)- | | methyl- | |
| 3-Ethoxy-4- | 3-Methoxy-5-methylbenzonitrile | 4-Mercapto-2-methoxyphenol | 1-(3-Cyclopentyloxy-4- |
| hydroxybenzoic acid | | | hydroxyphenyl)ethanone |
| 1-(3-Hydroxy-4- | 3-Chloro-5-methoxybenzonitrile | 5-Mercapto-2-methoxyphenol | 1-(4-Hydroxy-3- |
| methoxyphenyl)ethanone | | | methoxyphenyl)ethanone; 2- |
| | | | methoxyphenol |
| 2,4-Dimethyl-1,2,4- | 3,5-Diethoxy-4- | Methyl 5-acetyl-2,4- | 2-Chloro-4-hydroxy-3- |
| thiadiazolidine-3,5- | hydroxybenzaldehyde | dihydroxybenzoate | methylbenzonitrile |
| dithione | | | |
| 5′-Fluoro-2′- | 4-Hydroxy-2,3- | 4-Methoxy-2-methylphenol | Hex-5-enyl 4-hydroxy-3- |
| hydroxyacetophenone | dimethoxybenzaldehyde | | methoxybenzoate |
| 4H-Pyran-4-one, 3- | 3-Hydroxy-4-(2- | 2-Hydroxy-3- | 3-Fluoro-5-hydroxypyridine-2- |
| hydroxy-6- | phenylethoxy)benzaldehyde | methoxybenzonitrile | carbonitrile |
| (hydroxymethyl)-2- | | | |
| methyl- | | | |
| 2-(3- | 2,5-Difluoro-4- | 1-Amino-4-ethylpiperazine- | Ethanone, 1-[3-(ethylthio)-4- |
| Methoxyphenyl)oxirane | hydroxybenzaldehyde | 2,3-dione | hydroxyphenyl]- |
| 3-Methoxybenzamide | 3-Bromo-2,5-difluoro-4- | n-Ethyl-2,4-dimethoxyaniline | 4-Hydrazinyl-3-methoxy-2- |
| | hydroxybenzaldehyde | | methylbenzoic acid |
| Methyl 3,4-dihydroxy-5- | 2-Methoxy-4- | 6-Chloro-1-ethenyl-3- | (3S,4S)-3-Amino-4- |
| methoxybenzoate | (methylamino)phenol | hydroxypyridine-2-thione | ethoxypyrrolidine-1-carboxylic |
| | | | acid |
| 4-Hydroxyimino-2- | 4-(Dimethylamino)-2- | 2(1H)-Pyridinone, 3-hydroxy- | 2,4- |
| methoxy-2,5- | methoxyphenol | 6-methyl- | Bis(methoxymethyl)benzene- |
| cyclohexadiene-1-one | | | 1,3-diol |
| 3-(Chloromethyl)-4- | 2,3-Dimethoxy-4- | 2,3,4-Trimethoxy-6- | 2-Methoxy-3-hydroxy-6- |
| methoxybenzaldehyde | fluorobenzaldehyde | methyl phenol | cyanopyridine |
| 3-Ethoxybenzamide | 1-(3-(Vinyloxy)phenyl)ethanone | 2-Chloro-3- | 2-Chloro-4-hydroxy-5- |
| | | methoxybenzaldehyde | methylbenzonitrile |
| 4-Ethyl-2,3- | 3-Hydroxy-1-methyl-1,3- | 4-Methoxy-6-methylpyridine- | 3-Methanehydrazonoyl-2- |
| dioxopiperazine-1- | diazinane-2,4-dione | 2-carbaldehyde | methoxyphenol |
| carbonyl chloride | | | |
| 3-Amino-5- | 1,3-Dihydroxy-1,3-diazinane- | 1-Methoxy-2,3,5- | 2-Chloro-5-hydroxy-3- |
| ((methylthio)methyl)ox- | 2,4-dione | trifluorobenzene | methylpyrimidin-4(3H)-one |
| azolidin-2-one | | | |
| 6-Hydroxy-1,5-dimethyl- | 3-(2,2-Dimethylpropoxy)-4- | 3-Methoxy-5-methyl-1,2- | 5-Fluoro-2-methoxy-4-nitro- |
| 2-oxo-1,2- | methoxybenzaldehyde | benzenediol | phenol |
| dihydropyridine-3- | | | |
| carbonitrile | | | |
| 2-Hydroxy-5- | Aminocyclohexenone | 2-Hydroxy-5- | Methyl 3-(difluoromethoxy)-4- |
| methoxybenzamide | | methylcyclohexan-1-one | methylbenzoate |
| Hydrazine, (2,5- | 4-(Hydroxymethyl)-2,3,6- | 2-Methoxy-3,4,5,6- | 6-Oxo-2,3-dihydro-1H- |
| dimethoxybenzyl)- | trimethylphenol | tetramethylphenol | pyridine-4-carbonitrile |
| 4-Methoxy-3- | 2,6-Difluoro-4- | 1-(2-Hydroxy-3-methoxy-4- | 1-[3-Hydroxy-4-(2- |
| methylbenzaldehyde | (hydroxymethyl)phenol | methylphenyl)ethanone | phenylethoxy)phenyl]ethanone |
| 2-(4- | 4-Amino-3- | 2,5-Dimethoxy-3,4- | 3-Chloro-2,4-dimethoxy-N- |
| Hydroxyphenyl)oxirane | (methoxymethoxy)benzonitrile | dimethylbenzaldehyde | methylbenzamide |
| Hexyl vanillate | 3,4-Dihydroxybenzene-1,2- | Methyl 4-amino-3- | 5-Hydroxy-4-methyl-6-oxo- |
| | dicarbaldehyde | mercaptobenzoate | 1H-pyridine-2-carbonitrile |
| p- | 6-Oxo-1,6-dihydropyridine-2- | Ethyl 3-acetyl-4- | 6-Hydroxy-5-methoxy-3H-1- |
| Hydroxymethylphenyl- | carbaldehyde | hydroxybenzoate | benzofuran-2-one |
| hydrazine | | | |
| 1-Chloro-2,4- | 5-Fluoro-5-methoxycyclohexa- | 3-Hydroxy-4-methoxyphenyl | 4-Amino-3-methoxy-2- |
| dimethoxybenzene | 1,3-diene-1-carbaldehyde | formate | methylbenzonitrile |
| 4-Hydroxy-3- | 3-Ethyl-4-hydroxybenzaldehyde | 3-Methoxy-5-methylcyclohex- | 4-Ethoxy-3- |
| methylbenzaldehyde | | 2-en-1-one | hydroxybenzamide |
| 2(1 H)-Pyridinethione, 1- | (E)-3-(2-Formyl-4,5- | 5-Methoxy-3- | 1-(4-Hydroxy-3- |
| ethyl-3-hydroxy-6- | dimethoxyphenyl)prop-2-enoic | thiophenecarboxaldehyde | methoxyphenyl)propan-1- |
| methyl- | acid | | one; octan-2-ol |
| 3,4-Dimethoxy-5- | 3-Ethoxy-4-(2-hydroxy-2- | 5-Hydroxy-4-methoxy-2- | Acetic acid; 1-(4-hydroxy-3- |
| hydroxybenzaldehyde | methylpropoxy)benzaldehyde | methylbenzaldehyde | methoxyphenyl)propan-1-one |
| 3-Chloro-2- | Benzaldehyde, 3-(2- | 4-Methoxy-6-methylbenzene- | 2-Pyridinecarboxamide, 1,6- |
| methoxyaniline | hydroxyethoxy)-4-(1- | 1,3-diol | dihydro-5-hydroxy-6-oxo- |
| | methylethoxy)- | | |
| 3- | 3-Ethoxy-5- | 4-Bromo-5- | 1-[4-Hydroxy-3-methoxy-5- |
| (Trifluoromethoxy)benzo- | hydroxybenzaldehyde | methoxythiophene-2- | [(Z)-prop-1- |
| nitrile | | carbaldehyde | enyl]phenyl]ethanone |
| 2-(Methoxymethyl)-1- | 2-Methoxy-4- | 3-Methyl-4-sulfanylidene-3,4- | 1-[3-Methoxy-4-[(Z)-prop-1- |
| pyrrolidinecarbaldehyde | (methoxymethyl)aniline | dihydropyrimidin-2(1H)-one | enoxy]phenyl]ethanone |
| 3H-Pyrimidine-4-thione, | 3-Methoxy-4-methylpyridin-2- | 4-(Ethylamino)benzaldehyde | 3-Acetyl-2-methylbenzonitrile |
| 5-hydroxy-2-methyl-3- | amine | | |
| vinyl- | | | |
| 3-(4-Hydroxy-3- | 5-Methoxyisoindolin-1-one | 2-Chloro-6-(methyloxy)-4- | 1-(3-Methoxy-2-methyl-4- |
| methoxyphenyl)-1- | | nitrophenol | methylsulfanylphenyl)ethanone |
| phenylprop-2-en-1-one | | | |
| Danielone | 6-Methoxy-4,5,6- | [(1S,3R)-3- | (1R,2R)-2- |
| | trimethylcyclohexa-2,4-dien-1- | Methoxycyclohexyl]methanol | Methoxybicyclo[4.1.0]heptan- |
| | amine | | 7-one |
| Homovanillin | 2-Methoxy-4-methylcyclohexan- | 6-Methoxy-4-methyl-2H- | 2- |
| | 1-ol | pyran-2-one | Methoxybicyclo[4.1.0]heptan- |
| | | | 7-one |
| 1,4-Dihydroxy-2- | 1-Ethyl-3-methyl-4- | 1-(3-Ethoxy-4- | 2-Methoxy-4- |
| methoxy-6- | sulfanylideneimidazolidin-2-one | hydroxyphenyl)ethanone | [(phosphanylamino)methyl]phenol |
| methylbenzene | | | |
| 4-(Methylsulfinyl)phenol | 2-Hydroxy-5-methylcyclohexa- | 2-Oxopyran-4-carbaldehyde | 2-Bromo-5-ethoxybenzonitrile |
| | 2,5-dien-1-one | | |
| Ethanone, 1-(2-chloro-4- | 3-Methyl-5-methylidene-2- | 1-(4-Hydroxy-3- | 3-Methoxypyrazole-1- |
| hydroxy-5- | sulfanylidene-1,3-oxazolidin-4- | phenylmethoxyphenyl)ethanone | carboxamide |
| methoxyphenyl)- | one | | |
| 3-Chloro-2- | 3-Methyl-5-methylidene-2- | 1-(3-Ethoxy-4- | 5-Ethoxy-2-methylbenzonitrile |
| methoxyphenol | sulfanylidene-1,3-thiazolidin-4- | methoxyphenyl)ethanone | |
| | one | | |
| 2,4(1H,3H)- | 3-Amino-1-ethyl-6- | 2,4-Dimethoxy-6- | 1-(4-Hydroxy-3- |
| Pyrimidinedione, 1- | methylpyridin-2(1H)-one | methylphenol | trifluoromethoxyphenyl)ethanone |
| (hydroxymethyl)-3- | | | |
| methyl- | | | |
| 4- | 3-[10-(3- | 2-Ethoxy-4-methoxyaniline | 4-Dimethylphosphoryl-1- |
| Hydroxyisophthalaldehyde | Formylphenoxy)decoxy]-4- | | ethyl-2-methoxybenzene |
| | hydroxybenzaldehyde | | |
| 2-Methoxy-4- | 4-Hydrazinyl-3-methoxybenzoic | 1,3-Diamino-5- | 2-Methylidene-3- |
| methylaniline | acid | fluoropyrimidine-2,4-dione | oxocyclohexane-1- |
| | | | carbonitrile |
| 2-Ethoxy-4-nitrophenol | 5-Formyl-2-hydroxybenzonitrile | 2-Bromo-1-(3-chloro-4- | 5-Quinolinecarbonitrile, 8- |
| | | hydroxyphenyl)ethanone | amino- |
| 4-Hydroxy-3- | 3-Hydroxybenzene-1,2- | 2-Methoxy-5-methyl-4- | (2R,5S)-2-Methoxy-5- |
| nitrosobenzaldehyde | dicarbaldehyde | (methylthio)phenol | (methoxymethyl)oxolan-3-ol |
| 2,6-Dichloro-4- | 3,4-Difluoro-2- | 2-Methoxy-5-methyl-4- | 3-Methoxy-4- |
| (hydroxymethyl)phenol | (fluoromethoxy)aniline | methylsulphinylphenol | methylidenecyclohexa-2,5- |
| | | | dien-1-one |
| Benzenemethanol, 2- | 2-Ethoxy-3,4-difluoroaniline | 5-Methanesulfinyl-2-methoxy- | 6-(Methoxymethyl)cyclohexa- |
| chloro-4-hydroxy-5- | | 4-methylphenol | 1,3-diene-1-carbonitrile |
| methoxy- | | | |
| 1-(2-Chloro-4-hydroxy- | 5,6-Dimethoxypyridazine-3- | 4-Hydroxy-2,5- | 4-Cycloprop-2-en-1-yl-2- |
| 3- | carboxaldehyde | dimethylbenzaldehyde | methoxyphenol |
| methoxyphenyl)ethanone | | | |
| Benzenemethanol, 2- | 3-Cyclopent-3-enyloxy-4- | (2,5- | 4-Cyclopropyl-2- |
| chloro-4-hydroxy-3,5- | methoxybenzaldehyde | Dimethoxyphenyl)hydrazine | methoxycyclohexa-1,5-dien- |
| dimethoxy- | | | 1-ol |
| 1,4-Benzenediol, 2- | Methyl-2-fluoro-4-hydroxy-5- | 1-[3,5-Dichloro-4- | 4-Cyclopropyl-2- |
| chloro-, 4-acetate | isopropyloxybenzoate | (methylamino)phenyl]ethan- | (difluoromethoxy)-N,6- |
| | | 1-one | dimethylaniline |
| 2,3,5-Trichloro-4- | 3-Cyclopent-2-enyloxy-4- | 1-[3,5-Dichloro-4- | 4-(Hydroxymethyl)-2- |
| ethenyl-6- | methoxybenzaldehyde | (ethylamino)phenyl]ethan-1- | methoxy-6-methylphenol |
| methoxyphenol | | one | |
| 4-Ethyl-2-methoxy-6- | 1-Fluoro-2-isocyanato-4- | 1-Chloro-3,5-dimethoxy-2- | Phosphanyl 4-aminooxy-3- |
| methylphenol | methoxybenzene | methylbenzene | methoxybenzoate |
| 4-Ethyl-2-methoxy-5- | 1,3-Diamino-1H-pyrimidine-2,4- | (3-Chloro-5- | 3-Ethyl-4-hydroxybenzonitrile |
| methylphenol | dione | methoxyphenyl)methanol | |
| 2- | 4-Methyl-3-oxopiperazine-1- | 4-Chloro-3- | 3-(4-Hydroxy-3- |
| (Dichloromethoxy)phenol | carboxylic acid | methoxybenzaldehyde | methoxyphenyl)-3- |
| | | | oxopropanenitrile |
| 1-(2-Chloro-4-hydroxy- | 4-Methoxy-3-[(2-methylpropan- | 2-Chloro-5- | 4-Acetyl-1-ethylpyridin-2-one |
| 3,5- | 2-yl)oxy]benzaldehyde | methoxybenzaldehyde | |
| dimethoxyphenyl)ethanone | | | |
| 1-(2,6-Dichloro-4- | 2,3-Bis(methoxymethyl)phenol | 3-Hydroxy-5-iodo-4- | 6-Acetyl-1-methyl-3- |
| hydroxy-3,5- | | methoxybenzaldehyde | (methylamino)-3,4- |
| dimethoxyphenyl)ethanone | | | dihydropyridin-2-one |
| 2-Chloro-4- | 2-Methoxy-4-methyl-6-(prop-2- | 3,5-Dihydroxy-4- | 2-(4-Hydroxy-3- |
| hydroxybenzaldehyde | en-1-yl)phenol | methoxybenzaldehyde | methoxyphenyl)-1- |
| | | | phenylprop-2-en-1-one |
| 3,5- | 1,5-Diisocyanato-2,3- | 5-Acetylthiophene-3- | 3-(Cyanomethyl)cyclobutane- |
| Dihydroxypyrimidine- | dimethylbenzene | carbonitrile | 1-carbonitrile |
| 2,4(1h,3h)-dione | | | |
| Phenol, 2-chloro-4- | (4-Formyl-2-methoxyphenyl) | 5-Chloro-8-hydroxy-2- | 3,4-Dihydroxy-5- |
| ethenyl-6-methoxy- | hypobromite | methylquinoline | methoxybenzonitrile |
| 1-(3-Chloro-4-hydroxy- | 4-Hydroperoxy-3- | 8-Methylquinoline-5- | 4-Hydroxy-3- |
| 5- | methoxybenzaldehyde | carbonitrile | (trifluoromethyl)benzamide |
| methoxyphenyl)ethanone | | | |
| 2-Hydroxy-5- | 2-Hydroxy-1-(3-hydroxy-4- | 4-(Ethoxymethyl)-1,2- | 3-Cyclopropyl-4- |
| carbomethoxybenzyloxy- | methoxyphenyl)ethanone | dimethoxybenzene | hydroxybenzamide |
| amine | | | |
| 1,3-Dimethyl-4-thiouracil | 3-Fluorophthalaldehyde | 4-Methoxy-2- | 4-Methoxy-6- |
| | | methylthiophene-3- | (methoxymethyl)pyridin-3-ol |
| | | carbaldehyde | |
| 4-((3,7-Dimethylocta- | 3-Ethoxy-4-[(2-methyl-2-propen- | 4-Methoxythiophene-3- | 2-Ethenoxy-4-prop-2- |
| 2,6-dien-1-yl)oxy)-3- | 1-YL)oxy]benzaldehyde | carbaldehyde | enylphenol |
| methoxybenzaldehyde | | | |
| 5-Acetylsalicylamide | 3-Ethoxy-4-hydroxy-5-(2-methyl- | Prenyloxyvanillin | Ethanone, 1-(4-chloro-3- |
| | 2-propen-1-yl)benzaldehyde | | ethoxyphenyl)- |
| 2-Hydroxy-1-(4-hydroxy- | 4-Hydroxy-3-methoxy-5-(2- | 4′-Ethoxy-3′- | 2-Ethoxy-5-nitrophenol |
| 3-methoxyphenyl)propan- | methylprop-2- | methylacetophenone | |
| 1-one | enyl)benzaldehyde | | |
| 3-Pyridazinamine, 4- | 3-Hydroxy-4- | 3-Hydroxy-4- | 3′-Ethoxy-5′- |
| methoxy-6-methyl- | sulfanylbenzaldehyde | (trideuteromethoxy)benzalde- | fluoroacetophenone |
| | | hyde | |
| 1-[4-Hydroxy-3- | 3,5-Difluoro-4-methoxyfuran-2- | 5-Methylcycloheptane-1,4- | 1-Amino-2H-azepin-7-one |
| methoxy-5-(prop-2-en-1- | carbaldehyde | dione | |
| yl)phenyl]ethanone | | | |
| 4-(Heptyloxy)-3- | Aminopyrone | 3-Ethoxy-4,5- | (4-Fluoro-3-methoxyphenyl) |
| methoxybenzaldehyde | | dihydroxybenzaldehyde | acetate |
| CID 226341 | 3-(1,1,2- | 4-Amino-3-chloro-5- | 4-Hydroxy-1-(4-hydroxy-3- |
| | Trifluoroethoxy)benzaldehyde | (trifluoromethyl)benzaldehyde | methoxyphenyl)pentane-1,3- |
| | | | dione |
| Vanillil | 1-Aminopiperidine-4- | 6-Methoxyindan-5-ol | 1-(4-Hydroxy-3- |
| | carbaldehyde | | methoxyphenyl)undecane- |
| | | | 1,2-dione |
| 1,2-Bis(4-hydroxy-3- | 4-Chloro-2-(chloromethyl)-6- | 6-Hydroxy-2,3,4- | Propanoyl vanillin |
| methoxyphenyl)ethanone | methoxy-3-methylaniline | trimethylbenzaldehyde | |
| 1-(4-Hydroxy-3- | 3-(Chloromethyl)benzaldehyde | 2-Methyl-5- | O-(2,4- |
| methylphenyl)propan-1- | | methoxyhydroquinone | Dimethoxyphenyl)hydroxylamine |
| one | | | |
| 2,6-Dimethyl-3-hydroxy- | 5-Hydroxy-4-oxo-4H-pyran-2- | 1-(Chloromethyl)-4-methoxy- | 2-Hydroxy-3- |
| 4H-pyran-4-one | carbaldehyde | 2-(methoxymethyl)benzene | methoxybicyclo[2.2.1]heptane- |
| | | | 7-carbonitrile |
| 1-(3,4- | 3-Butoxy-5-fluoro-4- | 3,4-Dibutoxybenzaldehyde | 4-Amino-5-ethoxy-2- |
| Dimethoxyphenyl)-2-(4- | hydroxybenzaldehyde | | fluorobenzoic acid |
| hydroxy-3- | | | |
| methoxyphenyl)ethane- | | | |
| 1,2-dione | | | |
| 3-Chloro-1-(4-hydroxy- | 2,4-Diisocyanato-1-prop-1-en-2- | 1-Amino-5-fluorouracil | 2-(Difluoromethyl)-4- |
| 3- | ylbenzene | | methoxyphenol |
| methoxyphenyl)propan- | | | |
| 1-one | | | |
| Propyl 4-hydroxy-3- | 3-Benzyloxy4-hydroxy-5-iodo | 1-(4-Hydroxy-3- | (E)-1,5-Bis-(4-hydroxy-3- |
| methoxybenzoate | benzaldehyde | methoxyphenyl)prop-2-en-1- | methoxyphenyl)-pent-4-ene- |
| | | one | 1,3-dione |
| 3′-Chloro-4′- | 3-Hydroxy-6- | 3-Methoxy-2- | 1,5-Bis(4-hydroxy-3- |
| aminoacetophenone | methylphthalaldehyde | sulfanylbenzaldehyde | methoxyphenyl)pent-4-ene- |
| | | | 1,3-dione |
| 3-Ethoxy-4-hydroxy-5- | 3-Ethoxy-4-methylbenzonitrile | 2-Mercapto-3- | (3-Hydroxy-2-methoxyphenyl) |
| iodobenzaldehyde | | methoxybenzonitrile | cyanate |
| 2,4- | 3-Fluoro-4-hydroxybenzamide | 4-Acetylthiophene-2- | 1-[4-(Hydroxymethyl)-3- |
| Dimethoxybenzamide | | carbaldehyde | methoxyphenyl]ethanone |
| 4-(1-Ethoxyethyl)-2- | 6-Fluoro-2-hydroxy-3- | 3-Methoxy-2- | 1-Amino-3H-azepin-2-one |
| methoxyphenol | methoxybenzaldehyde | methylbenzaldehyde | |
| n-(2,4- | 6-Amino-2-chloronicotinonitrile | 2,4- | 1-(4-Hydroxy-3- |
| Dimethoxyphenyl)form- | | Dimethoxybenzenesulfinic | methoxyphenyl)ethanone; |
| amide | | acid | phenol |
| 2-Chloro-1-(4-hydroxy- | 6-Ethoxy-1,3-benzoxazol-5-ol | 4-Acetyl-2-oxopiperazine-1- | (5R)-3,3-Difluoro-4-methoxy- |
| 3- | | carbonyl chloride | 5-(methoxymethyl)oxolan-2- |
| methoxyphenyl)ethanone | | | one |
| 2-Hydroxy-3-methoxy-5- | 3-Isocyanatothiobenzaldehyde | 1-(4-Hydroxy-2,3- | 5-Chloro-2,4- |
| methylbenzonitrile | | dimethoxyphenyl)ethanone | dimethoxyphenol |
| 1-(5-Hydroxy-4- | 4-Amino-3-methoxy-N,N- | 4-Ethoxy-2- | 3-Fluoro-5-hydroxy-1-methyl- |
| methoxy-2- | dimethylbenzenesulfonamide | methylbenzaldehyde | 6-oxo-1,6-dihydro-pyridine-2- |
| methylphenyl)ethanone | | | carbonitrile |
| 3-Ethoxy-4- | 3-Hydroxy-5-methoxy-4- | 3-Hydroxy-4- | 3.5-Difluoro-1-methyl-6-oxo- |
| methoxybenzaldehyde | methylbenzaldehyde | pentyloxybenzaldehyde | 1.6-dihydro-pyridine-2- |
| | | | carbonitrile |
| 4-Methoxytropone | 2,4-Difluoro-6- | 2-Methoxymethyl-4- | 2,4-Dimethoxy-2H-pyrimidin- |
| | hydroxybenzaldehyde | methylphenol | 1-amine |
| 6- | 5-Chloro-2-fluoro-4- | 3-Oxo-1-cyclohexene-1- | 4-Methoxy-N-methyl-1,3- |
| (Hydroxymethyl)pyridine- | methoxybenzaldehyde | carbaldehyde | thiazole-2-carboxamide |
| 3,4-diol | | | |
| 5-Amino-1,3- | 5-Chloro-2-fluoro-4- | 5-Bromo-4-chloro-2- | 4-Methoxyfuro[3,2-b]pyrrol-6- |
| dimethylpyrimidine- | hydroxybenzaldehyde | methoxyphenol | ol |
| 2,4(1h,3h)-dione | | | |
| Benzaldehyde, 4,6- | Methyl 4-chloro-3-(2-chloro- | n-(2-Methoxy-4- | 1H-Azepine-2,5-dione, |
| dihydroxy-2,3-dimethyl- | ethoxy)-2-methylbenzoate | methylphenyl)acetamide | tetrahydro-1-methyl- |
| 2-Chloro-4- | 4-Hydroxy-3-(2- | 4-(2- | Acetic acid; 1-(4-hydroxy-3- |
| (hydroxymethyl)phenol | methylpropyl)benzaldehyde | Hydroxyphenoxy)benzaldehyde | methoxyphenyl)propan-1-one |
| 3′-Allyl-4′- | 4-Hydroxy-3-(2-methylprop-2- | 2-Fluoro-1-(3-hydroxy-4- | 4-(Aminooxymethyl)-2- |
| hydroxyacetophenone | enyl)benzonitrile | methoxyphenyl]ethanone | methoxyphenol |
| 4-Bromo-2- | 4-Bromo-3-methoxybenzonitrile | 2-(3- | 1-Methoxyimidazo[1,2- |
| methoxyphenol | | Methoxyphenyl)acetaldehyde | blpyrazol-3-ol |
| 2-Bromo-3-chloro-4- | 4-Hydroxy-3-methoxy-5-propan- | 4-Amino-3- | 3,5-Dichloro-2,6- |
| hydroxy-5- | 2-ylbenzaldehyde | chlorobenzaldehyde | dimethoxypyridine |
| methoxybenzaldehyde | | | |
| 2-Amino-4-hydroxy-3- | 4-Hydroxy-2,5- | 2-Methoxy-4-formylphenyl | 4-Methyl-2,3-dihydro-1- |
| methoxybenzaldehyde | dimethylbenzonitrile | chloroformate | benzofuran-7-ol |
| 5-Formyl-2- | 3-Methoxy-4- | 2,4-Diethoxyphenol | 1-(4-Hydroxy-3- |
| hydroxyphenyl acetate | (trifluoromethyl)benzonitrile | | methoxyphenyl)-3- |
| | | | phenylprop-2-en-1-one |
| 5-Hydroxy-2- | 4-Hydroxy-3- | 2-Ethoxy-6-methyl-4- | 1-(Aminomethyl)-3- |
| methylpyrimidin-4(3h)- | methoxybenzaldehyde; sulfamic | nitrophenol | methylpyrimidine-2,4-dione |
| one | acid | | |
| 4-Amino-2,5- | 2-(2,6-Difluorophenyl)-4- | 1-Aminopiperidin-2-one | 4-Hydroxy-3- |
| diethoxybenzonitrile | hydroxy-5- | | (methoxymethyl)benzamide |
| | methoxybenzaldehyde | | |
| (2- | 4-Hydroxy-5-methoxy-2-(4- | 1-(4-Amino-3-chloro-5-fluoro- | 4-Hydroxy-3-methoxy-2- |
| Methoxyphenyl)acetal- | methoxyphenyl)benzaldehyde | phenyl)-ethanone | methylbenzamide |
| dehyde | | | |
| 8-Hydroxyquinoline-5- | 2-(2-Formyl-5-hydroxy-4- | 1-(4-Amino-3-chloro-5- | 5-Amino-1-hydroxy-4- |
| carbaldehyde | methoxyphenyl)benzoic acid | (trifluoromethyl)phenyl)eth- | methoxypyridin-2-one |
| | | anone | |
| 5- | 4-Hydroxy-2-[3- | 2-Chloro-4-methyl-6- | 6-Amino-2-hydroxy-5- |
| Hydroxypicolinaldehyde | (hydroxymethyl)phenyl]-5- | methoxyphenol | methoxypyridazin-3-one |
| | methoxybenzaldehyde | | |
| 4-(Ethoxymethyl)-2,6- | 4-Hydroxy-5-methoxy-2- | 3-Acetyl-4-hydroxycyclohexa- | 5-Ethoxy-4- |
| dimethylphenol | phenylbenzaldehyde | 1,3-diene-1-carbonitrile | fluorocyclohexene-1- |
| | | | carbonitrile |
| 2-Chloro-4,5- | 4-Hydroxy-5-methoxy-2-(2- | Ethyl 5-acetyl-2- | 4-Hydroxy-3- |
| dimethoxybenzaldehyde | methylphenyl)benzaldehyde | hydroxybenzoate | (hydroxymethyl)benzonitrile |
| 4-Methoxy-2- | 2-(2-Fluorophenyl)-4-hydroxy-5- | 4-Methoxypyridine-2- | 3-Ethynoxybenzonitrile |
| methylbenzaldehyde | methoxybenzaldehyde | carbonitrile | |
| 3,4-Bis(prop-2-en-1- | 2-(2-Ethylphenyl)-4-hydroxy-5- | 2-Bromo-1-(3-hydroxy-4- | 2,4- |
| yloxy)benzaldehyde | methoxybenzaldehyde | methoxyphenyl)ethanone | Bis(fluoromethoxymethyl)phe |
| | | | nol |
| 4-Methoxy-6- | 4-Hydroxy-2-[4- | Ethyl 3-ethoxy-4- | 1-(Bromomethoxy)-3- |
| nitrobenzene-1,3-diol | (hydroxymethyl)phenyl]-5- | hydroxybenzoate | (methoxymethyl)benzene |
| | methoxybenzaldehyde | | |
| Methyl 3,4- | 3-Pyridinecarboxaldehyde, 6- | 4-Ethoxy-3-hydroxybenzoic | 3-(Difluoromethoxy)-2,4- |
| dihydroxybenzoate | hydrazinyl- | acid | difluorobenzamide |
| 3-Methoxy-4- | 5-Ethoxy-2-fluoro-4- | 3-Fluoro-2-methoxyphenol | 1-(4-Hydroxy-3- |
| methylphenylacetonitrile | hydroxybenzaldehyde | | methoxyphenyl)ethanone; met |
| | | | hanol |
| 3-Methoxy-4- | 3-Chloro-4-hydroxy-5- | 1-(4-Hydroxy-2,3- | 4-Hydroxy-3-methoxybenzoic |
| (methylamino)benzoic | methylbenzaldehyde | dimethylphenyl)ethanone | acid sodium |
| acid | | | |
| 3-Hydroxyisoxazole-5- | 5-Ethoxycyclohexa-1,5-diene-1- | 6-Chloro-2,3,4- | 1-(4-Chloro-1-fluoro-3- |
| carboxamide | carbaldehyde | trimethoxyphenol | methoxycyclohexa-2,4-dien- |
| | | | 1-yl)ethanone |
| 6-Methoxybenzofuran-3- | 2-Ethyl-3-oxo-1H-pyrazole-5- | (R)-2-(3,4- | 4-Hydroxy-5-methoxy-2- |
| ol | carbonitrile | Dimethoxyphenyl)oxirane | methylbenzoic acid |
| 1-(4-Hydroxy-2,5- | 4-Ethoxy-3-fluorobenzaldehyde | 2-Chloro-1,5-dimethoxy-3- | 1-(4-Hydroxy-5-methoxy-2- |
| dimethylphenyl)ethanone | | methylbenzene | methylphenyl)ethanone |
| 1-(3,4- | Benzaldehyde, 3- | Ethyl 2-chloro-4-fluoro-5- | 1-(2-Ethyl-4-hydroxy-5- |
| Dimethoxyphenyl)-3-(3- | (fluoromethoxy)- | isocyanatobenzoate | methoxyphenyl)ethanone |
| hydroxy-4- | | | |
| methoxyphenyl)prop-2- | | | |
| en-1-one | | | |
| 3-Methyl-2-thioxo-1,3- | Cycloheptanone, 3-methoxy- | 4-Fluoro-2-methoxyaniline | 3-Hydroxy-6- |
| thiazinan-4-one | | | methylidenecyclohex-3-ene- |
| | | | 1,2-dione |
| 4-Hydroxy-2- | 3-Fluoro-4-aminobenzaldehyde | 2-Bromo-1-(4-hydroxy-3- | 2-Methoxy-3-methyl-4- |
| methylbenzonitrile | | methoxyphenyl)ethanone | nitrophenol |
| 1-(3-Chloro-6-hydroxy- | 3-Chloro-6-hydroxy-2- | alpha-Iodo-3′-methoxy-4′- | 4-Acetyl-2- |
| 2,4- | methylbenzaldehyde | hydroxyacetophenone | methoxybenzonitrile |
| dimethylphenyl)ethanone | | | |
| 3-Acetyl phenyl | (2R)-2-(3- | 4- | (3,5-Difluoro-3- |
| isocyanate | Methoxyphenyl)oxirane | Cyanocyclohexanecarboxal- | methoxycyclohexa-1,4-dien- |
| | | dehyde | 1-yl)methanol |
| N-(2-Methoxy-4- | 6-(4-Formyl-2- | 3-(2- | 2-(Difluoromethoxy)-4- |
| nitrophenyl)formamide | methoxyphenoxy)hexanoic acid | Chloroethoxy)benzonitrile | propan-2-ylphenol |
| 2-Hydroxy-3-methoxy- | 1,3,6-Trimethyl-2-oxopyridine-4- | 2-Amino-5-formyl-4- | Chloro 4-chlorooxy-3- |
| 7,8- | carbonitrile | methylthiophene-3- | methoxybenzoate |
| dihydrobenzo[7]annulen- | | carbonitrile | |
| 9-one | | | |
| 1,3-Dimethyl-5- | 2-Nitroso-4,5- | 3-Oxocyclopent-1-ene-1- | 1-Amino-3-methyluracil |
| hydroxyuracil | dimethoxybenzaldehyde | carbonitrile | |
| 5-(Chloromethyl)-2- | 4-Hydroxy-3-methoxy-2-prop-2- | 2-Bromo-4- | 3-Methoxy-2-methyl-4- |
| hydroxybenzaldehyde | enylbenzaldehyde | methoxymethylphenol | (methylamino)benzoic acid |
| 1-Methyl-2-oxopyridine- | 2,5-Dihydroxy-6- | 4-Tert-butyl-2-ethoxyphenol | 5-(Chloromethyl)-2- |
| 3,4-dicarbonitrile | methoxybenzaldehyde | | methoxyphenol |
| 5-Hydroxy-4-methoxy-1- | 6-Hydroxy-2-methyl-3- | Methyl 3,4-diethoxybenzoate | O-(3-Methoxy-4- |
| methyl-3H-pyridine-2,6- | methylidenecyclohexan-1-one | | methylphenyl)hydroxylamine |
| dione | | | |
| 4-(1-Ethylsulfanylethyl)- | 3-Chloro-4-hydroxybenzamide | 2-Ethyl-4-hydroxy-3- | 1-(4-Aminooxy-3- |
| 2-methoxyphenol | | methoxybenzaldehyde | methoxyphenyl)ethanone |
| 1,2-Dimethoxy-4-(1- | 1H-Indazol-5-ol, 4-methoxy- | 1-(5-Hydroxy-4-methoxy-2- | 4-Aminooxy-3- |
| methoxyethyl)benzene | | methylphenyl)propan-1-one | methoxybenzonitrile |
| Benzoic acid, 4-hydroxy- | 2,6-Dimethoxy-3-methylpyridine | 1-(4-Hydroxy-5-methoxy-2- | 1,3-Dimethoxy-6- |
| 3-methoxy-, 1- | | methylphenyl)propan-1-one | methylcyclohexa-1,3-diene |
| methylethyl ester | | | |
| 5,6,7-Trichloroquinolin- | 4-(Dimethoxymethyl)-2- | 2-Methoxy-1-aminopyridinium | 1-(4-Butoxy-3- |
| 8-ol | methoxy-6-methylphenol | | hydroxyphenyl)ethanone |
| 4-Methoxy-1- | 5-Amino-3-ethyl-2,6- | 4-Acetyl-2- | 4-Methyl-1-oxo-1,4- |
| methylpyridin-2(1H)-one | dimethylpyrimidin-4-one | methoxybenzaldehyde | thiazepan-3-one |
| 1-Chloro-2,4- | N-(2,3,4,6- | 6-Hydroxy-7-methoxytetralin | 1-(4-Hydroxy-3- |
| diisocyanatobenzene | Tetramethylphenyl)methanimine | | methoxyphenyl)but-2-en-1- |
| | | | one |
| 1,3-Dichloro-dihydro- | 4-Hydroxy-3- | 4-(Hydroxymethyl)-2- | 2-Methoxy-6-methyl-4-propyl- |
| pyrimidine-2,4-dione | methoxybenzaldehyde; | methoxy-3-methylphenol | phenol |
| | praseodymium | | |
| 3-Hydroxy-4- | 4,5-Dimethoxy-2- | 4-(Dimethylaminomethyl)-6- | 1-[3-Hydroxy-2- |
| methoxybenzamide | trimethylstannylbenzaldehyde | fluoro-2-methoxyphenol | (methoxymethyl)phenyl]eth- |
| | | | anone |
| 4-Hydroxy-3- | 3-Hydroxy-2- | Ethanone, 1-[4-hydroxy-3-(1- | 3-Methyl-2-oxo-1H-pyridine- |
| methoxybenzamide | (hydroxymethyl)benzaldehyde | methylethyl)phenyl]- | 4-carbonitrile |
| 4-Hydroxy-3,5- | 4-Amino-2H-triazine-1- | 1-(3-Tert-butyl-4- | 2-(4-Hydroxy-3- |
| dimethoxy-N- | carbaldehyde | hydroxyphenyl)ethanone | methoxycyclohexa-2,4-dien- |
| methylbenzamide | | | 1-ylidene)acetonitrile |
| 4-Hydroxy-3- | 5-Chloro-2-methoxy-4- | 4-Hydroxy-3-isopropyl- | 4-Chloro-2,4- |
| methoxybenzohydroxamic | methylaniline | benzoic acid methyl ester | dimethoxycyclohexa-1,5- |
| acid | | | dien-1-amine |
| 1,4-Methano-1H- | (3,5-Dichloro-2- | 3-Dimethylamino-4-hydroxy- | N-[(3,4- |
| cyclopenta[c]furan-3,5- | methoxyphenyl)hydrazine | benzoic acid methyl ester | Dimethoxyphenyl)methyl]methan- |
| dione, tetrahydro- | | | imine |
| 1,3-Bis(4-hydroxy-3- | (5-Chloro-2-methoxy-3- | 4-Cyclopropyl-2- | 4-(Dimethylamino)-2- |
| methoxyphenyl)prop-2- | methylphenyl)hydrazine | methoxyphenol | (methylideneamino)phenol |
| en-1-one | | | |
| 1H-Pyrrole-3,4- | (5-Chloro-4-methyl-2- | 3-Acetyl-5-fluorobenzonitrile | Methyl 2-cyclopropyl-5- |
| dicarbonitrile, 2-amino- | methoxyphenyl)hydrazine | | methoxybenzoate |
| 1-(ethylideneamino)-5- | | | |
| methyl- | | | |
| (2- | Benzoic acid, 2,3-dichloro-4- | 5-Bromo-2-methoxy-4- | 1-(Difluoromethoxy)-3- |
| Methoxyphenyl)hydrazine | hydroxy-, methyl ester | methylPhenol | (methoxymethyl)benzene |
| 5-Hydroxypyrimidin- | Methyl 2,3-difluoro-4- | 2-Amino-4-chloro-3,5- | 1-Ethoxy-3-fluoro-5- |
| 4(3H)-one | hydroxybenzoate | dicyanothiophene | methoxybenzene |
| 1- | (4-Formyl-2- | 2H-1,3-Thiazine-2-thione, 5- | 2-(Difluoromethoxy)-1-fluoro- |
| (Methoxymethyl)pyridin- | methoxyphenyl)carbamic acid | acetyl-3,6-dihydro- | 4-methoxybenzene |
| 1-ium-3-carbonitrile | | | |
| 3-Methoxy-4- | 1-Butoxybutane; 4-hydroxy-3- | 6-Methoxyoxane-2- | 1-Fluoro-3-methoxy-5- |
| hydroxyphenylglycolaldehyde | methoxybenzaldehyde | carbonitrile | (methoxymethyl)benzene |
| 3-Dimethylallyl-4- | 1-Cyclopropyl-2,4- | Ethanone, 1-(2-amino-3,5- | 2-Methyl-4- |
| hydroxybenzaldehyde | dimethoxybenzene | dimethoxyphenyl)- | (methylamino)benzonitrile |
| 4-Hydroperoxy-2- | (2,4- | 5-Acetyl-2-hydroxybenzoyl | 3-(Methoxymethyl)-5- |
| methoxy-phenol | Dimethoxyphenyl)methanimine | chloride | methylbenzaldehyde |
| 4-Hydroxy-2- | 3-Amino-1,6-dimethylpyrazin-2- | 3- | 1-(3-Acetyl-5-bromo-4- |
| methylbenzaldehyde | one | (Chloromethoxy)benzonitrile | hydroxyphenylfethanone |
| 4-Hydroxy-2- | (1-Amino-piperidin-4-yl)- | 4-Chloro-3- | 3-Butoxy-4-hydroxybenzoic |
| methoxybenzaldehyde | methanol | hydroxybenzaldehyde | acid |
| 4- | 1-(3-Tert-butyl-4-hydroxy-5- | Methyl 4-acetyl-3- | (2-Chloro-5-ethoxy-4- |
| Methoxybenzene- | methylphenyl)ethanone | methoxybenzoate | methylphenyl)methanol |
| carbothialdehyde | | | |
| Vanillic acid, heptyl | (5-Formyl-2-methoxyphenyl) | 3-Hydroxy-6-methyl-3,4- | 4-Bromo-2-fluoro-3- |
| ester | formate | dihydro-2H-pyran-2-one | methoxybenzonitrile |
| 3,4-Dimethoxybenzyl | 1-(3-Hydroxy-4- | 2-Methoxy-4-(2- | 3-(Cyclopropylmethoxy)-4- |
| methyl ether | methoxyphenyl)butan-2-one | hydroxyethenyl)phenol | hydroxybenzaldehyde |
| 1,3-Dimethoxy-2,4,5- | 2,5,6- | 2,3-Dihydro-5-hydroxy-2- | Deuterio-(2,3,5,6- |
| trimethylbenzene | Trimethoxynicotinaldehyde | (hydroxymethyl)-4H-pyran-4- | tetradeuterio-4- |
| | | one | deuteriooxyphenyl)methanone |
| 2,3,5-Trichloro-4- | Piperidi ne-1,2-dicarbaldehyde | 2,4-Dicyano-3-methylaniline | Vanillin-13C6 |
| hydroxybenzaldehyde | | | |
| 2,3,6-Trichloro-4- | 8-Hydroxy-4-methylquinoline-5- | 5-(Methoxymethyl)thiophene- | 2,3,6-Trideuterio-5-hydroxy- |
| hydroxybenzaldehyde | carbonitrile | 2-carbaldehyde | 4-methoxybenzaldehyde |
| 2,5-Dichloro-4- | 2-Thiophenecarbonitrile, 5- | 5-Hydroxy-1-methyluracil | 2-Deuterio-4- |
| hydroxybenzaldehyde | chloro-4-formyl- | | methoxybenzaldehyde |
| Benzaldehyde, 4,5,6- | 4-Iodo-3-methoxybenzonitrile | 4-(1-Hydroxyethyl)-2,6- | 3-Deuterio-4- |
| trichloro-2-hydroxy | | dimethoxyphenol | methoxybenzaldehyde |
| 2,3,5,6-Tetrachloro-4- | 4-Methoxy-3,5- | 3-Hydroxy-2-methoxy-6- | 2-Deuterio-4- |
| hydroxybenzaldehyde | dimethylpicolinaldehyde | (methoxymethyl)benzaldehyde | hydroxybenzaldehyde |
| 5,6- | Methyl 3- | 2-Methoxy-3,4- | 2-Chloro-6-ethoxy-4- |
| Dichlorosalicylaldehyde | (methoxymethyl)benzoate | dimethyl phenol | nitrophenol |
| 2-Chloro-6- | 5-Chloro-7-fluoro-quinolin-8-ol | 2,3,4-Trimethoxy-5- | Phenol, 2,4-dichloromethoxy- |
| hydroxybenzaldehyde | | methyl phenol | |
| 2-Hydroxy-3,4,5- | Methyl 4-formamido-3- | 5-Acetyl-2-hydroxybenzene- | 2-Fluoro-4-(iodomethyl)-6- |
| trimethyl-2-cyclopenten- | methylbenzoate | 1-sulfonyl chloride | methoxyphenol |
| 1-one | | | |
| Vanillyl acetate | Methyl 3-chloro-4- | 1-(4-Hydroxy-3- | 2,3,6-Trichloro-4-hydroxy-5- |
| | formamidobenzoate | sulfanylphenyl)ethanone | methoxybenzaldehyde |
| 3-(4-Hydroxy-3- | Methyl 4-formylamino-3- | Methyl 4-hydroxy-3- | 3-Hydroxy-1-(4-hydroxy-3- |
| methoxyphenyl)propanal | methoxybenzoate | (trifluoromethyl)benzoate | methoxyphenyl)prop-2-en-1- |
| | | | one |
| Benzaldehyde, 3,4- | Methyl 3-chloro-4- | 3-Methoxy-4-propan-2- | Ethanone, 1-[3-chloro-5-(1,1- |
| dimethoxy-, o- | (methylamino)benzoate | ylbenzaldehyde | dimethylethyl)-4- |
| methyloxime | | | hydroxyphenyl]- |
| 3-Allyloxy-4- | 3-Methyl-4-methylamino- | Benzaldehyde, 4-methoxy-3- | 2-Oxo-3- |
| methoxybenzaldehyde | benzoic acid methyl ester | [(methylthio)methoxy]- | oxabicyclo[3.1.0]hexane-6- |
| | | | carbaldehyde |
| 3-Amino-2,6-dimethyl- | 2-Pyridinecarboxylic acid, 6- | 6-Oxo-2,3-dihydropyran-2- | 4-Hydroxy-3- |
| 4(3H)-pyrimidinone | cyano-5-hydroxy-, methyl ester | carbaldehyde | (methylsulfanyl)benzaldehyde |
| 3-(Hydroxymethyl)-1- | Methyl 5-formyl-2-hydroxy-3- | Benzoic acid, 4- | 3-Acetyl-2,4- |
| methylpyrrolidin-2-one | iodobenzoate | (mercaptomethyl)-3-methoxy-, | dihydroxybenzaldehyde |
| | | methyl ester | |
| p-Benzoquinone, 2,6- | 2,3-Difluoro-4- | 1-(4-Hydroxy-3- | 5-Methoxy-1-methyl-1H- |
| dimethoxy-, 4-oxime | hydroxybenzaldehyde | methoxyphenyl)butan-1-one | imidazole-2-carbonitrile |
| 2-Hydroxy-3,5,5- | Ethyl 3-chloro-4-hydroxy-5- | 1-(4-Hydroxy-3-methoxy- | (4S,6R)-4-Methoxy-6- |
| trimethyl-2-cyclohexen- | methylbenzoate | phenyl)-pentan-1-one | methyloxan-2-one |
| 1-one | | | |
| 4- | Ethyl 3-chloro-5-fluoro-4- | 1-(4-Hydroxy-3- | 3-(Hexyloxy)-4- |
| Methoxycycloheptanone | hydroxybenzoate | methoxyphenyl)hexan-1-one | propoxybenzaldehyde |
| 2-Methoxymethyl-2- | 2-Methoxy-4-(oxiran-2- | 1-(4-Hydroxy-3- | 2′,4′-Dihydroxy-3′- |
| methylpyrrolidine-1- | yl)cyclohexan-1-ol | methoxyphenyl)heptan-1-one | methoxyacetophenone |
| carboxaldehyde | | | |
| 4-(Benzyloxy)-2-fluoro- | 4-Ethoxy-2,3-difluoro-6- | 4-Carbamoyl-2- | 1-(5-Bromo-2,4-dihydroxy-3- |
| 5-hydroxybenzaldehyde | methylbenzaldehyde | mercaptothiazole | methoxyphenyl)ethan-1-one |
| 4-(Benzyloxy)-3- | Benzaldehyde, 3-ethyl-4- | 2-N,N-Dimethylamino-5- | 3-Chloro-4-methoxy-5- |
| hydroxybenzaldehyde | hydroxy-5-methoxy- | hydroxy-4-pyrimidone | methylbenzaldehyde |
| 3-Hydroxy-1,2,6- | 3-(4-Benzyloxybutoxy)-4- | 2,3,5-Trichloro-4,6- | 6-Bromo-1-ethenyl-3- |
| trimethylpyridin-4-one | hydroxybenzaldehyde | dimethoxyphenol | hydroxypyridine-2(1H)-thione |
| Furan-2(5H)-one, 5- | 3-Ethoxy-2-hydroxybenzonitrile | 2,4,5-Trifluoro-3- | 5-Isocyanato-2- |
| trichioromethyl-3- | | methoxybenzonitrile | methylbenzonitrile |
| hydroxy-4-methyl- | | | |
| 3-Fluoro-2- | 5-Fluoro-2-hydroxy-3- | 4-Iodo-3- | 1-Cyclohexene-1- |
| methoxyaniline | methoxybenzonitrile | methoxybenzaldehyde | carboxaldehyde, 2-chloro-3- |
| | | | (hydroxymethylene)- |
| 2-Hydroxy-6- | 4-(3-Methoxy-4- | 1-(4-Hydroxy-3- | 3-(Difluoromethoxy)-2,4,6- |
| methylbenzaldehyde | hydroxyphenyl)butanal | methoxyphenyl)propane-1,2- | trimethylbenzaldehyde |
| | | dione | |
| 3-Hydroxy-4- | 5-Ethyl-4-hydroxy-3- | 5-Acetyl-2-chloro-4- | 4-Hydroxy-3-methoxy-5- |
| methylbenzaldehyde | methylbenzaldehyde | hydroxybenzonitrile | nitrosobenzaldehyde |
| 4-Formyl-2- | 5-Methoxynicotinonitrile | 1,4-Dihydro-5-hydroxy-4-oxo- | 2-Fluoro-6-hydroxy-3- |
| methoxytropone | | 2-pyridinecarboxaldehyde | methylbenzaldehyde |
| 3-Ethoxy-4- | 5-Methoxycyclohexa-1,5-diene- | 4,5-Dihydroxy-2- | 2-Methoxy-3- |
| propoxybenzaldehyde | 1-carbaldehyde | methylbenzaldehyde | (methoxymethyl)phenol |
| 2-Fluoro-4- | 2-Chloro-1-(3-chloro-4- | 1-(3,4-Dimethoxypyrazol-1- | 2-Propen-1-one, 3-(3- |
| hydroxybenzaldehyde | hydroxyphenyl)ethanone | yl)ethanone | hydroxy-4-methoxyphenyl)-1- |
| | | | phenyl- |
| 3-Fluoro-4- | 3-(2-Ethoxyethoxy)-4- | 1-Methyl-2-oxo-1,2- | Isomagnaldehyde |
| hydroxybenzaldehyde | methoxybenzaldehyde | dihydropyridine-4- | |
| | | carbaldehyde | |
| 4-Fluoro-3- | 3-Hydroxy-4- | Thieno[2,3-b]furan-5- | 2-(Methoxymethyl)-4- |
| hydroxybenzaldehyde | methyl phthalaldehyde | carboxaldehyde | nitrosophenol |
| 2,4(1H,3H)- | 3-Chloro-4-methoxybenzamide | Benzofuran-6-carbaldehyde | 1,3-Dimethyl-6-methylidene- |
| Pyrimidinedione, | | | 2-oxopyrimidine-4-carbonitrile |
| dihydro-1,3-dimethyl- | | | |
| 5-Chloro-2- | 4-Hydroxy-3- | 3-Methoxy-4- | 3-Amino-1,6-dimethyl-1,2- |
| methoxyphenol | isopropylbenzaldehyde | (methylthio)benzaldehyde | dihydropyridin-2-one |
| 3,6-Difluoro-2- | 3-Chloro-2,4,5-trifluoro-6- | Methyl 5-Formyl-2- | 2-Amino-4-chloropyrimidine- |
| methoxyphenol | methoxyaniline | hydroxybenzoate | 5-carbonitrile |
| 5-Cyanotropolone | 2-Fluoro-4- | 2,3-Dimethoxy-4- | 4-Amino-2-fluoro-5- |
| | (methylamino)benzonitrile | methylphenol | methoxybenzonitrile |
| 3-Ethoxy-4- | Cyclopentanol; 3-hydroxy-4- | 2-Hydroxy-5-methoxy-3- | 3-(3-Hydroxy-4- |
| hydroxyphenylacetonitrile | methoxybenzaldehyde | methylcyclohexa-2,5-diene- | methoxyphenyl)-1-(4- |
| | | 1,4-dione | hydroxyphenyl)prop-2-en-1- |
| | | | one |
| Methyl 3-methoxy-4- | Benzaldehyde, 3-mercapto-4,5- | 2-Methoxy-3,5- | 6-Chloro-5- |
| methylbenzoate | dimethoxy- | dimethylbenzene-1,4-diol | methoxynicotinaldehyde |
| 3-Isopropoxy-4- | 1-(4-Chloro-2-fluoro-5- | 4-(2,3-Dihydroxypropoxy)-3- | 6-Chloro-4- |
| methoxybenzaldehyde | methoxyphenyl)ethanone | methoxybenzaldehyde | methoxypicolinaldehyde |
| 4-Methoxy-3- | 3,4-Dihydro-2H-1,4- | Cyclohexyl-(4-hydroxy-3- | 5-Fluoro-6-methoxypyridine- |
| propoxybenzaldehyde | benzoxazine-7-carboxamide | methoxyphenyl)methanone | 2-carbaldehyde |
| 3-Methoxy-4- | 2-Methyl-3- | 2′-Fluoro-4-hydroxy-3- | 2-Fluoro-3-methoxypyridine- |
| propoxybenzaldehyde | propoxybenzaldehyde | methoxybenzophenone | 5-carbaldehyde |
| 3-Butoxy-4- | 7-Methyl-5-nitroquinolin-8-ol | 4-Chlorobenzene-1,3- | 3-Isocyanatobenzaldehyde |
| methoxybenzaldehyde | | dicarbaldehyde | |
| 2-Chloro-4- | 1-Methoxy-3-(methoxymethyl)- | 6-Methoxy-5-methylpyridine- | 3-Iodo-5- |
| hydroxybenzonitrile | 5-methylbenzene | 2-carbaldehyde | methoxybenzaldehyde |
| 3-Amino-2,6- | Dihydroxytropylium | 5-Methoxy-4- | 3-(Aminomethyl)-4- |
| dimethoxypyridine | | methylnicotinaldehyde | hydroxybenzaldehyde |
| 2,4-Dimethoxyphenol | 4-Hydroxy-5-methoxy-2- | 3′-Ethoxy-4′- | 2-Formyl-6- |
| | methylbenzaldehyde | methylacetophenone | hydroxybenzamide |
| 2-Fluoro-3,4- | 3-Iodo4-hydroxy-5- | 4-Ethoxy-2,3- | 5-(4-Hydroxy-3- |
| dihydroxybenzaldehyde | methylbenzaldehyde | difluorobenzaldehyde | methoxyphenyl)penta-2,4- |
| | | | dienal |
| 2-Fluoro-4,5- | 1,2,3,5-Tetrafluoro-4- | 3,4- | 4-Hydroxy-3- |
| dihydroxybenzaldehyde | methoxybenzene | Bis(difluoromethoxy)benzal- | octoxybenzaldehyde |
| | | dehyde | |
| 4-Formyl-1,3-dimethyl- | 1-[4-(Hydroxymethyl)-5- | 4-Amino-3,5- | 1-(4-Hydroxy-3- |
| 1,3(2H)- | methylimidazol-1-yl]ethanone | dichlorobenzaldehyde | methoxyphenyl)nonadec-2- |
| dihydroimidazole-2- | | | en-1-one |
| thione | | | |
| 2-Fluoro-3- | 3,5-Dichloro-4-methoxy-2- | 3-Bromo-5-methyl-4- | 2-Chloro-3- |
| methoxybenzyl alcohol | methylbenzaldehyde | hydroxybenzaldehyde | (hydroxymethylidene)cyclo- |
| | | | pentene-1-carbaldehyde |
| (4-Fluoro-3- | 2-Methoxy-6-methylpyridin-3-ol | 1-Methyl-2-methoxy-6- | 3-(Hydroxymethylidene)-2- |
| methoxyphenyl)methanol | | methoxymethylbenzene | methylcyclohexene-1- |
| | | | carbaldehyde |
| 2-Chloro-5-hydroxy- | 5-Thioxo-4,5-dihydro-1,3,4- | 4-Hydroxy-3-methoxybenzoyl | (4-Formyl-2-methoxyphenyl) |
| 2,4,6-cycloheptatrien-1- | oxadiazole-2-carboxamide | chloride | 3-(3,4-dihydroxyphenyl)prop- |
| one | | | 2-enoate |
| 5-Chloro-2-hydroxy- | 4′-Hydroxy-3′-methoxy-2- | 4-Hydroxy-5-isopropyl-2- | 4,5-Dimethylthiophene-3- |
| 2,4,6-cycloheptatrien-1- | methyl-propiophenone | methylbenzaldehyde | carboxamide |
| one | | | |
| 3-Fluoro-4,5- | 3-Hydroxy-2-methoxy-4,6- | 4-Amino-3-bromo-2,5- | 4-Bromo-2-fluoro-3- |
| dihydroxybenzaldehyde | dimethyl-5- | difluorobenzaldehyde | methoxybenzaldehyde |
| | methylidenecyclohex-2-en-1- | | |
| | one | | |
| 3-Chloro-4- | 3-Methoxy-4-methylbenzamide | 4-Acetyl-2,6-dichloro-3- | Methyl 4-chloro-3- |
| fluorobenzaldehyde | | fluoroaniline | ethoxybenzoate |
| 5-Methoxy-2- | 3-Methoxy-5-methyl-2- | 5-Acetyl-2-amino-6-fluoro-3- | 2-(3-Amino-2-oxopyrrolidin-1- |
| thiophenecarboxamide | sulfanylbenzaldehyde | methylbenzonitrile | yl)acetaldehyde |
| 5-Isopropenyl-2- | 7-Hydroxy-2,3-dihydro-1H- | 3-Acetyl-5-chloro-2- | (E)-1,3-Bis(3-hydroxy-4- |
| hydroxy-2,4,6- | indene-4-carbaldehyde | fluorobenzonitrile | methoxyphenyl)prop-2-en-1- |
| cycloheptatrien-1-one | | | one |
| Benzoic acid, 3-formyl- | 4-Fluoro-2,5-dimethoxy-3,6- | (NE)-N-[[3- | Furoquaiaoxidin |
| 4,6-dihydroxy-2,5- | dimethylphenol | (difluoromethoxy)phenyl]methyl- | |
| dimethyl-, methyl ester | | idene]hydroxylamine | |
| 2,4-Dihydroxy-3,6- | 1-(3-Ethyl-4-hydroxy-5- | 2,4-Dihydroxy-3- | 2-Bromo-5-ethoxy-4- |
| dimethylbenzaldehyde | methylphenyl)ethanone | chlorobenzaldehyde | methylbenzaldehyde |
| 6-Methoxy-2- | 2-Amino-4-methylpyrimidine-5- | 3-Chloro-2- | 2-Methoxy-5-methyl-4- |
| (methylamino)tropone | carbonitrile | methoxybenzaldehyde | (oxiran-2-yl)benzonitrile |
| 3-Ethoxy-4- | 2-Chloro-4,6- | 4-Hydroxy-2,3- | 2-[(3-Hydroxy-4- |
| hydroxybenzyl alcohol | bis(methoxymethyl)phenol | dimethylbenzaldehyde | methoxyphenyl)methylidene]- |
| | | | 3-methylbutanal |
| Benzaldehyde, 2-fluoro- | 1-Acetyl-3,6-dihydro-2H- | 2-Fluoro-4- | Butyl 3-hydroxy-4- |
| 5-hydroxy-4-methoxy- | pyridine-5-carbaldehyde | hydrazinylbenzonitrile | methoxybenzoate |
| 6-Fluorovanillin | 2,4-Dimethyl-6- | 2-Chloro-5- | (E)-3-(4-Hydroxy-3- |
| | (methylideneamino)phenol | methoxybenzonitrile | methoxyphenyl)-2- |
| | | | methylprop-2-enal |
| 2-Fluoro-3-hydroxy-4- | 2,4-Dimethyl-6- | (3- | Allylvanillin |
| methoxybenzaldehyde | (propylideneamino)phenol | Methoxyphenyl)methanimine | |
| 3-Fluoro-4-hydroxy-5- | 3-Amino-1,5,6-trimethylpyridin- | 4-Formyl-1,2-benzoquinone | 1-(4-Hydroxy-3- |
| methoxybenzaldehyde | 2-one | | methoxyphenyl)-3- |
| | | | methylbutan-1-one |
| Benzaldehyde, 2-fluoro- | 3-Hydroxy-1,5,6- | [2-Ethoxy-3,5,6-trifluoro-4- | 3-Chloro-4-hydroxy-5- |
| 4-hydroxy-2-methoxy- | trimethylpyridin-2-one | (methoxymethyl)phenyl]meth- | methoxybenzoyl chloride |
| | | anol | |
| 3-Fluoro-5-hydroxy-4- | 3-Hydroxy-1,5,6- | 4-Formyl-1H-pyrazole-1- | 7-Hydroxy-2- |
| methoxybenzaldehyde | trimethylpyridine-2-thione | carbothioamide | methylbenzo[b]furan-4- |
| | | | carbaldehyde |
| 2-Fluoro-4- | 3-Hydroxy-1,5-dimethylpyridine- | 3-Methoxy-4- | 2-Chloro-1-(3-chloro-4- |
| (hydroxymethyl)-6- | 2-thione | methylbenzonitrile | hydroxy-5- |
| methoxyphenol | | | methoxyphenyl)ethanone |
| 2,6-Difluoro-3- | 3-Hydroxy-1,6-dimethyl-1H- | 5-Hydroxy-2,3-dimethylpyran- | 4-Chloro-5-methoxy-1,2- |
| methoxybenzaldehyde | pyridine-2-thione | 4-one | thiazole-3-carbonitrile |
| 2-Chloro-4,6- | (4-Ethoxy-2- | 2-Fluoro-6-methoxy-4- | 4-(2-Ethylbutoxy)-3- |
| dimethoxyaniline | methylphenyl)methanol | methyl phenol | methoxybenzaldehyde |
| Benzaldehyde, 2,5- | 4-Hydroxy-3- | 5-Hydroxy-6-methoxy-1- | (2S)-2-[3- |
| difluoro-3,4-dihydroxy- | methoxybenzaldehyde; | indanone | (Difluoromethoxy)phenyl]oxi- |
| | methoxymethane | | rane |
| Benzaldehyde, 2,6- | 3,4- | 1-Aminopiperidin-2-ol | 4-Methoxy-3-(4- |
| difluoro-3,4-dihydroxy- | Dihydroxybenzaldehyde; | | methylpentoxy)benzaldehyde |
| | ethoxyethane | | |
| 2-Allyl-3-hydroxy-4- | 2-Acetyl-4-hydroxy-3- | 5-Chloro-2,4- | (2,4-Dimethoxy-6- |
| methoxybenzaldehyde | methoxybenzaldehyde | dihydroxybenzaldehyde | methylphenyl)methanethiol |
| 2-Ethoxy-4-prop-2- | 3-Methoxy-4- | Methyl 4-(chloromethyl)-3- | 2-Bromo-3- |
| enylphenol | (sodiooxy)benzaldehyde | methoxybenzoate | methoxybenzonitrile |
| 1,3- | N-Hydroxy-3-methoxy-4- | 1- | Guaiacolethanon |
| Benzenedicarboxaldehyde, | methylbenzamide | (Cyanomethyl)cyclopentane- | |
| 2,4-dihydroxy-6- | | 1-carbonitrile | |
| methyl- | | | |
| 2,5-Dimethoxy-4- | 4-Methoxy-3- | Benzaldehyde, 3-(1,1- | 3-Fluoro-5-methoxy-4- |
| methylbenzaldehyde | (trifluoromethoxy)benzaldehyde | dimethylethyl)-4-hydroxy-5- | methylbenzaldehyde |
| | | methoxy- | |
| Methyl 4-amino-3- | 1-(3-Hydroxy-4- | 1-(3-Bromo-4-hydroxy-5- | 2-(3-Hydroxy-4- |
| methoxybenzoate | methoxyphenyl)propan-2-one | methylphenyl)ethanone | methoxyphenyl)propanal |
| 2-Methoxy-N-methyl-4- | Methyl 5-methyl-6-oxo-1,6- | Benzaldehyde, 5-acetyl-2,4- | 3-Chloro-5-methoxy-4- |
| nitroaniline | dihydropyridine-2-carboxylate | dihydroxy- | methylbenzaldehyde |
| 3-Fluoro-4,5- | (2-Formyl-4,5- | Phenol, 2-ethoxy-6-methyl- | 2-(3-Methoxy-4- |
| dimethoxybenzaldehyde | dimethoxyphenyl)boronic acid | | hydroxyphenyl)butanal |
| 5-Fluoro-2,3- | 2,6-Difluoro-4- | 4-Hydroxy-2,5- | 3-Bromo-5-methoxy-4- |
| dimethoxybenzaldehyde | hydroxybenzaldehyde | dimethoxybenzaldehyde | methylbenzaldehyde |
| 2,3,4-Trimethoxyphenol | (4-Formyl-2-methoxyphenyl) | 1-Nitroso-2,4- | 2-Hydroxy-5- |
| | (E)-3-(3,4- | dimethoxybenzene | (methoxymethyl)benzaldehyde |
| | dihydroxyphenyl)prop-2-enoate | | |
| 2-Fluoro-3,4- | 3-Ethoxy-4-(3- | 4-Chloro-2-fluoro-5- | 2-Ethoxy-4-(1- |
| dimethoxybenzaldehyde | hydroxypropoxy)benzaldehyde | methoxybenzaldehyde | hydroxyethyl)phenol |
| 2-Fluoro-4,5- | 2,5-Dimethyl-3-iodo-4- | 2-Amino-5-bromo-4-hydroxy- | 1-(3-Ethoxy-4- |
| dimethoxybenzaldehyde | hydroxybenzaldehyde | 3-methoxybenzaldehyde | hydroxyphenyl)propan-1-one |
| 2-Chloro-3-hydroxy-4- | 6-Bromo-2,4-diethoxy-3- | 1-(Dichloromethyl)-2,4- | 1-(3,4-Dihydro-2H-1,4- |
| methoxybenzaldehyde | methylphenol | diisocyanatobenzene | benzoxazin-7-yl)ethanone |
| Benzoic acid, 2,5- | (2E)-2-[(3-Hydroxy-4- | 2,3-Dihydrobenzofuran-6- | 5-Amino-4-chlorothiophene- |
| difluoro-4-hydroxy-3- | methoxyphenyl)methylidene]-3- | carbaldehyde | 2-carbonitrile |
| methoxy- | methylbutanal | | |
| 2,5-Difluoro-4-hydroxy- | (2Z)-2-[(3-Hydroxy-4- | N-[(3- | 3-Chloro-4-hydroxy-5- |
| 3-methoxybenzaldehyde | methoxyphenyl)methylidene]-3- | Methoxyphenyl)methyl]methan- | trifluoromethyl-benzaldehyde |
| | methylbutanal | imine | |
| 2,6-Difluoro-4-hydroxy- | 4-Methoxy-2,5-dimethylfuran-3- | 3,4,4′-Trihydroxy-3′- | 3-Fluoro-4- |
| 3-methoxybenzaldehyde | ol | methoxychalcone | methoxypicolinonitrile |
| Methyl 4-amino-3,5- | 3-Ethoxy-4-methylbenzaldehyde | 3′,4′-Dimethoxy-3,4- | 5-Chloro-4-methoxypyridine- |
| dichlorobenzoate | | dihydroxychalcone | 2-carbaldehyde |
| 4′-Amino-3′,5′- | 3-Methoxy-6-methylbenzene- | 3,4-Bis(3-methylbut-2- | 4,6-Dimethoxypyridin-3-ol |
| dichloroacetophenone | 1,2,4-triol | enoxy)benzaldehyde | |
| 3- | (3-Hydroxy-4-methoxy-phenyl)- | 3-(Difluoromethoxy)-2,4,5- | 3-Chloro-4-methoxypyridine- |
| (Trifluoromethoxy)benzal- | acetaldehyde | trifluorobenzamide | 2-carbonitrile |
| dehyde | | | |
| 1-(3-Bromo-4- | 4-Chloro-2-methoxy-N- | 6-Ethoxy-2,3-dihydro-1H- | 1-(4-Hydroxy-3- |
| hydroxyphenyl)ethanone | methylaniline | inden-1-one | methoxyphenyl)-3-(4- |
| | | | hydroxyphenyl)prop-2-en-1- |
| | | | one |
| 2,6-Difluoro-3,4- | 4,5-Dihydroxy-2,3- | Benzoic acid, 3,4-dihydroxy- | 4-Heptoxy-3- |
| dimethoxybenzaldehyde | dimethoxybenzaldehyde | 5-(1-methylethoxy)-, methyl | hydroxybenzaldehyde |
| | | ester | |
| 4-Bromo-2-methoxy-5- | 4-Bromo-5-fluoro-2- | 4,5-Dichloro-2,3- | Formic acid 2-methoxy-4- |
| methylphenol | methoxyphenol | dimethoxybenzaldehyde | formylphenyl ester |
| 3-Bromo-5-ethoxy-4- | 2-Fluoro-1-methoxy-3- | 3-(2- | 3-Hydroxy-4-prop-2- |
| hydroxybenzaldehyde | (methylsulfonyl)benzene | Fluoroethoxy)benzaldehyde | ynoxybenzaldehyde |
| 2,3,4,5-Tetrachloro-6- | 3,6-Difluoro-2- | (4-Amino-3-chloro-5- | 3-Hydroxy-4-(2- |
| methoxyaniline | methoxybenzaldehyde | trifluoromethyl-phenyl)- | phenylpropoxy)benzaldehyde |
| | | ethylene oxide | |
| 3-Ethoxy-4-hydroxy-5- | 3-Methyl-5- | 2-Amino-5-formylbenzonitrile | 1-(4-Hydroxy-3- |
| iodobenzonitrile | (trifluoromethoxy)benzaldehyde | | methoxyphenyl)-2- |
| | | | methoxyethanone |
| 4-Bromo-5- | 4-Fluoro-2-methoxy-N- | 1-(Methoxymethyl)-1,2- | 1-(3-Hydroxy-4- |
| (chloromethyl)-2- | methylaniline | dihydro-5H-tetrazole-5-thione | methoxyphenyl)decan-1-one |
| methoxyphenol | | | |
| 4-Methoxy-3-[(2- | 3-[(2S)-Butan-2- | 1-Methoxy-3- | 1-(4-Hydroxy-3- |
| methylprop-2-en-1- | yl]oxybenzaldehyde | methylnaphthalen-2-ol | methoxyphenyl)decan-1-one |
| yl)oxy]benzaldehyde | | | |
| 2-Methyl-3-oxocyclohex- | 3-Ethoxy-4-[(3-methyl-2-buten- | 3-Hydroxy-6- | Chloro-(5-formyl-2-hydroxy-3- |
| 1-ene-1-carbaldehyde | 1-YL)oxy]benzaldehyde | (methoxymethyl)-2H-pyran-2- | methoxyphenyl)mercury |
| | | one | |
| 1-Ethyl-3,5- | 2-(3-Ethoxyphenyl)acetaldehyde | Cyclopentane-1,2- | 3,4-Dimethoxy-5- |
| dimethylpyrimidine- | | dicarbaldehyde | trimethylstannylbenzaldehyde |
| 2,4(1H,3H)-dione | | | |
| 1,3-Dihydroxypyridin- | 2-Methoxy-4-[(2S)-oxiran-2- | 3′,5′-Difluoro-4′- | 4-(2-Hydroxy-4-methyl- |
| 2(1H)-one | yl]phenol | hydroxyacetophenone | phenoxy)-benzaldehyde |
| 3-Acetylbenzaldehyde | 3-Chloro-4-hydroxy-N- | (2R)-1-Methyl-5- | 4-Trifluoroethoxy-3- |
| | methylbenzamide | oxopyrrolidine-2- | hydroxybenzaldehyde |
| | | carbaldehyde | |
| 4-Isobutoxy-3- | 4-Chloro-2-methoxy-N,5- | 5-Hydroxy-4-methoxy-2,3- | Benzaldehyde, 4-hydroxy-3- |
| methoxybenzaldehyde | dimethylaniline | dimethylpyridine | (3-methoxypropoxy)- |
| 3-Methoxy-4-(3- | 5-Chloro-2,4-dimethoxy-N- | 5-Hydroxy-3-methyl-1H- | Lactoyl vanillin |
| methylbutoxy)benzaldehyde | methylaniline | pyrimidine-2,4-dione | |
| 1-(3-Chloro-4-hydroxy- | 3-((R)-Sec-Butoxy)-4-methoxy- | 2-Chloro-3- | 3-Methoxy-4-(pent-1- |
| 5- | benzaldehyde | (hydroxymethylene)-1- | ynyloxy)benzaldehyde |
| methylphenyl)ethanone | | cyclopentene-1-carbaldehyde | |
| 6-Acetyl-2(3H)- | 4-Hydroxy-5-methyl-isophthalic | 2-Methoxy-4- | 4-Methoxy-3-(pent-1- |
| benzothiazolone | acid dimethyl ester | (iodomethyl)phenol | ynyloxy)benzaldehyde |
| 4-Hydroxy-3- | 5-Hydroxy-3-methylpyridine-2- | 3-Hydroxypyridine-2,6- | 3-Methoxy-4-(but-1- |
| methoxyphenyl | carbonitrile | dicarbaldehyde | ynyloxy)benzaldehyde |
| thiocyanate | | | |
| 1-Amino-4,6- | 3-Hydroxy-4,6-dimethyl-1H- | 3,5-Dimethoxybenzene-1,2- | 4-Methoxy-3-(but-1- |
| dimethylpyridin-2(1H)- | pyridin-2-one | diol | ynyloxy)benzaldehyde |
| one | | | |
| 4-Isopropoxy-3- | (2S)-2-(3- | 5-Formyl-2,3- | 3-Ethoxy-5-fluoro-4- |
| methoxybenzaldehyde | Methoxyphenyl)oxirane | dihydroxybenzonitrile | hydroxybenzaldehyde |
| 1H-Isoindol-1-one, 2- | 2-(Difluoromethoxy)-4- | N-(4- | 4-Hydroxy-3-(2- |
| amino-2,3-dihydro- | nitroaniline | Formylphenyl)formamide | hydroxyethoxy)benzaldehyde |
| 5,7-Dimethyl-8- | 3-Amino-1-methyl-6- | 4-Hydroxy-3-methoxybenzyl | 4-Hydroxy-3-(2- |
| hydroxyquinoline | (trifluoromethyl)-1,2- | bromide | methoxyethoxy)benzaldehyde |
| | dihydropyridin-2-one | | |
| 3-Chloro-4-ethoxy-5- | 3-Amino-1-ethyl-6- | 2,4-Dimethoxy-N- | 4-Hydroxy-3- |
| methoxybenzaldehyde | (trifluoromethyl)pyridin-2(1H)- | methylaniline | methoxybenzaldehyde; (E)-4- |
| | one | | (4-hydroxy-3- |
| | | | methoxyphenyl)but-3-en-2- |
| | | | one |
| 1,3-Dimethylpyrimidine- | 6-Methoxy-1H-indazol-5-ol | 4-Chloro-2-(1,1,2,2- | Ethyl 2-(4-formyl-2- |
| 2,4(1H,3H)-dithione | | tetrafluoroethoxy)phenol | hydroxyphenoxy)acetate |
| 4-Hydroxy-5- | 3,4-Difluoro-5- | 1,4-Benzodioxine-6- | 3-Ethoxy-4-[(6- |
| methylisophthalaldehyde | methoxybenzaldehyde | carbaldehyde | hydroxyhexyl)oxy]benzal- |
| | | | dehyde |
| 3-(Chloromethoxy)-4- | 3,4-Difluoro-5- | 1,3-Dimethyl-5- | 4-(2-Ethoxyethoxy)-3- |
| methoxybenzaldehyde | hydroxybenzaldehyde | (methylamino)pyrimidine- | hydroxybenzaldehyde |
| | | 2,4(1H,3H)-dione | |
| 5-Amino-3- | (3,4-Difluoro-5- | 4-Tert-butoxy-3- | 3-Hydroxy-4-(3- |
| methylthiophene-2,4- | methoxyphenyl)methanol | methoxybenzaldehyde | methoxypropoxy)benzaldehyde |
| dicarbonitrile | | | |
| 3-(Hydroxymethyl)-4- | 4-Hydrazinyl-3- | 3-Hydroxy-4- | 4-(3-Fluoropropoxy)-3- |
| methoxybenzaldehyde | (trifluoromethyl)benzonitrile | isopropoxybenzaldehyde | hydroxybenzaldehyde |
| Ethanone, 1,1′-(4- | 2,6-Dimethoxy-3-pyridinol | 1-Chloro-2-(4- | 4-Hydroxy-3- |
| hydroxy-1,3- | | methoxyphenyl)hydrazine | methoxybenzaldehyde; |
| phenylene)bis- | | | phosphoric acid |
| Isoeugenol | 4-[(2R)-Oxiran-2-yl]phenol | 3-Amino-1,3-thiazolidine-2- | 2-Hydroxy-3- |
| | | thione | methoxybenzaldehyde; |
| | | | hydrate |
| Methyl 3,5-diformyl-2- | 4-Amino-3-methoxybenzoate | Ethyl 3-hydroxy-4- | 1,1-Diethoxyethane; 4- |
| hydroxybenzoate | | methoxybenzoate | hydroxy-3- |
| | | | methoxybenzaldehyde; |
| | | | propane-1,2-diol |
| 3-Ethoxy-4- | 3-Ethoxy-4-fluorobenzaldehyde | 7-Bromo-8-hydroxy-5- | Ethoxyethane; 4-hydroxy-3- |
| isopropoxybenzaldehyde | | quinolinecarbaldehyde | methoxybenzaldehyde |
| 2-Bromo-5-ethoxy-4- | 3-Hydroxy-4-(2- | 4-Acetoxy-2-methylphenol | (Z)-2-(4-Hydroxy-3- |
| hydroxybenzaldehyde | methoxyethoxy)benzaldehyde | | methoxyphenyl)-4-(4- |
| | | | hydroxyphenyl)-4-oxobut-2- |
| | | | enal |
| 3-Allyl-5-ethoxy-4- | 1-(3-Ethoxypiperidin-1- | 1-(3-Bromo-4-hydroxy-5- | Deute rio-[3-(1,1,2,2,2- |
| hydroxybenzaldehyde | yl)ethanone | methoxyphenyl)Ethanone | pentadeuterioethoxy)-4- |
| | | | (trideuteriomethoxy)phenyl]meth- |
| | | | anone |
| 2-Bromo-3-chloro-5- | 3-(3,4-Dimethoxyphenyl)-3- | 1-(2-Hydroxy-3-methyl-5- | 1,1-Diethoxyethane; 4- |
| ethoxy-4- | oxopropanal | nitrophenyl)ethan-1-one | hydroxy-3- |
| hydroxybenzaldehyde | | | methoxybenzaldehyde |
| 2-Chloro-5-ethoxy-4- | 2-[3- | 1-(3-Chloro-2-hydroxy-5- | 3-Ethoxy-4- |
| hydroxybenzaldehyde | (Difluoromethoxy)phenyl]oxirane | nitrophenyl)ethanone | hydroxybenzaldehyde |
| 5-Bromo-4- | 2,6-Diethoxypyridin-3-amine | Pyrrolidine-2,5-dithione | Hexadecanoic acid; 4- |
| (hydroxymethyl)-2- | | | hydroxy-3- |
| methoxyphenol | | | methoxybenzaldehyde |
| 2-Chloro-6-ethoxy-4- | 4-Amino-3-ethoxy-benzoic acid | 3-Hydroxy-4-(2- | 4-Hydroxy-3- |
| (hydroxymethyl)phenol | methyl ester | propenyloxy)benzaldehyde | methoxybenzaldehyde; |
| | | | pentanoic acid |
| 1-(3-Hydroxy-4- | Methyl 4-amino-3- | 3-Allyloxy-4- | Formic acid; 4-hydroxy-3- |
| methoxyphenyl)propan- | (difluoromethoxy)benzoate | hydroxybenzaldehyde | methoxybenzaldehyde |
| 1-one | | | |
| 2-Hydrazinylcyclohepta- | 3,4-Dimethoxyphenylglyoxal | (3-Methoxy-2- | 4-Hydroxy-3- |
| 2,4,6-trien-1-one | hydrate | methylphenyl)methanol | methoxybenzaldehyde; (E)- |
| | | | octadec-9-enoic acid |
| 3-Ethoxy-2-hydroxy-5- | 3,4-Dichloro-2,5- | 1,2-Dichloro-3,5- | Dodecanoic acid; 4-hydroxy- |
| nitrobenzaldehyde | dimethoxyphenol | dimethoxybenzene | 3-methoxybenzaldehyde |
| Methyl 5-acetyl-2- | 4-Chloro-2,6-dimethoxyphenol | 4-Chloro-2-methoxy-6- | 3-Ethoxy-4- |
| amino-4- | | methyl phenol | hydroxybenzaldehyde; |
| methylthiophene-3- | | | propane-1,2-diol |
| carboxylate | | | |
| 4-Hydroxy-3- | 1-(2,3-Dichloro-4-hydroxy-5,6- | 1-Formyl-3-oxopiperazine | Hexanoic acid; 4-hydroxy-3- |
| iodobenzaldehyde | dimethoxyphenyl)ethanone | | methoxybenzaldehyde |
| 1-(3-Chloro-4- | 3-Amino-4-hydroxy-5- | 4-Methyl-3-oxopiperazine-1- | 4-Hydroxy-3- |
| hydroxyphenyl)ethanone | methoxybenzaldehyde | carbonyl chloride | methoxybenzaldehyde; |
| | | | propanoic acid |
| 1-(4-Hydroxy-3- | (NE)-N-[[4- | 1,2,4-Triazin-5(4H)-one, 6- | Butanoic acid; 4-hydroxy-3- |
| iodophenyl)ethanone | (methoxymethyl)cyclopenten-l- | amino-3,4-dimethyl- | methoxybenzaldehyde |
| | yl]methylidene]hydroxylamine | | |
| 3-Chloro-4-hydroxy-5- | 7-Chloro-5-fluoro-quinolin-8-ol | 6-Amino-4-methyl-3- | 4-Hydroxy-3- |
| methoxybenzonitrile | | sulfanylidene-3,4-dihydro- | methoxybenzaldehyde; |
| | | 1,2,4-triazin-5(2H)-one | octadecanoic acid |
| Thiophene-2,4- | 5,7-Difluoro-quinolin-8-ol | o-Methoxy-m-methyl-p- | 3-Ethoxy-4- |
| dicarbaldehyde | | allyl phenol | hydroxybenzaldehyde; 2- |
| | | | methoxy-4-prop-2-enylphenol |
| 2,3-Diamino-6- | 1-(4-Hydroxy-3-methoxyphenyl)- | 2-Chloro-4-hydroxy-3- | Acetic acid; 3-ethoxy-4- |
| (trifluoromethyl)-4(3H)- | 3-(3-hydroxyphenyl)prop-2-en- | methoxybenzoic acid | hydroxybenzaldehyde |
| pyrimidinone | 1-one | | |
| 4-Oxopiperidine-1- | 1-(4-Hydroxy-3-methoxyphenyl)- | Methyl 1-acetyl-1H-pyrrole-3- | 3,4- |
| carboxamide | 3-(4-hydroxyphenyl)propan-1- | carboxylate | Dimethoxy(213C)cyclohexa- |
| | one | | 1,3,5-triene-1-carbaldehyde |
| 4-Hydroxy-3-methoxy-5- | Ethyl 3-chloro-5-cyano-2- | 3-Methoxy-4- | 3-Hydroxy-4-(1,1,2- |
| methylbenzaldehyde | hydroxy-6-methylbenzoate | hydroxyphenylglyoxal | trifluoroethoxy)benzaldehyde |
| 4-[(1S)-1-Hydroxyethyl]- | 3,4-Dimethoxy[7-13C]- | 3-Ethoxycyclohept-2-en-1- | 3-Hydroxy-4-(1,2,2- |
| 2-methoxyphenol | benzaldehyde | one | trifluoroethoxy)benzaldehyde |
| 2-Hydroxy-4- | Methyl 3,4-Dimethoxy[7-13C]- | 3,4- | Ethanol; 4-hydroxy-3- |
| pyridinecarboxaldehyde | benzoate | Diisopropoxybenzaldehyde | methoxybenzaldehyde; |
| | | | sulfuric acid |
| Methyl 4-amino-3- | 2-Pyridinecarbonitrile, 5- | 2-Bromo-4-hydroxy-3,5- | 2-(2-Fluoro-4-hydroxy-5- |
| chlorobenzoate | hydroxy-, 1-oxide | dimethoxybenzaldehyde | methoxyphenyl)acetaldehyde |
| 3-Allyl-4-hydroxy-5- | 6-Methoxypyridine-2-thiol | 4-Ethoxy-2-methoxyaniline | 3-Hydroxy-4- |
| methoxy-benzaldehyde | | | methoxybenzaldehyde |
| cis-Isoeugenol | 2,2,2-Trifluoro-1-(4-hydroxy-3- | 3-Amino-1-methylpyridin- | 3-Methoxy-4- |
| | methoxyphenyl)ethanone | 2(1H)-one | methylperoxybenzaldehyde |
| 4-(Hexyloxy)-3- | 2-Chloro-1-(4-hydroxy-3- | 5-Formyl-2-hydroxybenzoyl | 4-Hydroxy-3- |
| methoxybenzaldehyde | methylphenyl)ethanone | chloride | methoxybenzaldehyde; prop- |
| | | | 2-enyl hexanoate |
| 3-(3-Methoxy-4- | 1-(4-Amino-3-chlorophenyl)-2- | 3-Tert-butoxybenzaldehyde | 3-Ethoxy-4- |
| hydroxyphenyl)acrylonitrile | chloro-ethanone | | hydroxybenzaldehyde; 1-(4- |
| | | | hydroxy-3- |
| | | | methoxyphenyl)propan-1-one |
| 4-Butoxy-3- | 5-Cyano-2-hydroxybenzoyl | 3,3′-Dimethoxy-4,4′- | 3-Ethoxy-2-fluoro-4-(2- |
| ethoxybenzaldehyde | chloride | dihydroxybenzophenone | hydroxyethoxy)benzaldehyde |
| 4-Hydroxy-3- | 3-Hydroxy-4-methoxy-benzoyl | 4-Hydroxy-3-methoxy-2- | 2-Hydroxy-3- |
| propoxybenzaldehyde | chloride | methylbenzaldehyde | methoxybenzaldehyde; 4- |
| | | | hydroxy-3- |
| | | | methoxybenzaldehyde |
| 5-Allyl-2-hydroxy-3- | 5-Carbamoyl-2-hydroxybenzoyl | Ethanone, 1-[5-(1,1- | (Z)-3-(4-Hydroxy-3- |
| methoxybenzaldehyde | chloride | dimethylethyl)-2,4- | methoxyphenyl)-2- |
| | | dihydroxyphenyl]- | phenylprop-2-enal |
| 4-(Hexyloxy)-3- | 4-Acetyl-2-methoxybenzoyl | 4-Methoxy-5,6-dihydro-2H- | 2-(4-Hydroxy-3- |
| hydroxybenzaldehyde | chloride | thiopyran-2-one | methoxyphenyl)prop-2-enal |
| 4-(4-Formyl-2- | 3-(Ethenyloxy)benzaldehyde | 5-Hydroxy-1 H-pyridine-2- | 2-Ethyl-4-hydroxy-3- |
| methoxyphenoxy)butanoic | | thione | methoxybenzaldehyde; 4- |
| acid | | | hydroxy-3- |
| | | | methoxybenzaldehyde |
| 3-Ethoxy-4-(2- | 2-Methyl-4- | 4-Hydroxy-3- | 3-Ethoxy-4- |
| hydroxyethoxy)benzaldehyde | (methylamino)benzaldehyde | isopropoxybenzaldehyde | hydroxybenzaldehyde; prop-1- |
| | | | ene |
| 3- | 6-Ethoxypyridine-2- | N-(2,4- | 4-(4-Formyl-2- |
| Methoxythiobenzamide | carbaldehyde | Dimethoxyanilino)formamide | hydroxyphenoxy)butyl nitrate |
| 3-Bromo-5-ethoxy-4- | (2S)-1-Methyl-5-oxopyrrolidine- | 1-(4-Amino-3- | 4-(4-Chlorobutoxy)-3- |
| hydroxybenzonitrile | 2-carboxamide | methoxyphenyl)ethanone | hydroxybenzaldehyde |
| 4-Butoxy-3- | 1-(2-Thioxo-2,3-dihydrothiazol- | 1-(4-Hydroxy-3-iodo-5- | 4-(3-Bromopropoxy)-3- |
| methoxybenzaldehyde | 4-yl)ethanone | methoxyphenyl)ethanone | hydroxybenzaldehyde |
| 4-(Allyloxy)-3- | 1-[3-Methyl-4- | Methyl 3-methoxy-4- | 3-(4-Formyl-2- |
| methoxybenzaldehyde | (methylamino)phenyl]ethanone | methylaminobenzoate | hydroxyphenoxy)propyl |
| | | | nitrate |
| 3-Chloro-5-ethoxy-4- | 1-(4-Amino-2,3- | 3-Oxo-4-propan-2- | Azane; 4-hydroxy-3- |
| hydroxybenzaldehyde | dimethylphenyl)ethan-1-one | ylidenecyclohexene-1- | methoxybenzaldehyde; |
| | | carbaldehyde | hydrochloride |
| 3- | 1-(4-Hydroxy-3- | 5-Methoxythiophene-2- | 4-Aminooxy-3- |
| Ethoxybenzenecarbothioamide | nitrosophenyl)ethanone | carbaldehyde | methoxybenzaldehyde; |
| | | | hydrochloride |
| 3-Ethoxy-4-(2- | 4-(Hydroxymethyl)-1- | 4-Methoxy-3-methyl-2-oxo- | 4-Hydroxy-3- |
| methylpropoxy)benzaldehyde | methylpyridin-2(1H)-one | 2H-pyran-6-carbaldehyde | methoxybenzaldehyde; 2- |
| | | | methylpropanoic acid; propan- |
| | | | 2-one |
| 4-(3-Ethoxy-4-hydroxy- | 3,5-Difluoro-2-methoxyphenol | Methyl 2-azido-4-hydroxy-5- | Fulvene; 4-hydroxy-3- |
| phenyl)-4-oxo-butyric | | methoxybenzoate | methoxybenzaldehyde |
| acid | | | |
| 1-[4-Hydroxy-3- | 2-Fluoro-6-hydroxy-3- | (4S)-3-Oxo-4-prop-1-en-2- | 4-Hydroxy-3- |
| (methoxymethyl)phenyl] | methoxybenzaldehyde | ylcyclohexene-1- | methoxybenzaldehyde; (9Z,12Z)- |
| ethan-1-one | | carbaldehyde | octadeca-9,12-dienoic acid |
| 1-(3-Chloromethyl-4- | 4-Formyl-2-hydroxyphenyl | 3,4-Bis(2- | 4-Hydroxy-3- |
| hydroxy-phenyl)- | acetate | methoxyethoxy)benzaldehyde | methoxybenzaldehyde; 2- |
| ethanone | | | methoxy-4-[(E)-prop-1- |
| | | | enyl]phenol |
| 3-Isobutoxy-4- | N-(2-Methoxy-4- | 4-(2-Fluoroethoxy)-3- | (E)-1-(4-Hydroxy-3- |
| methoxybenzaldehyde | nitrophenyl)nitrous amide | methoxybenzaldehyde | methoxyphenyl)nonadec-10- |
| | | | en-1-one |
| 1-(2,4- | 4-[2-(Hydroxyamino)propyl]-2- | 4-(3-Fluoropropoxy)-3- | Butane-2,3-diol; 1,1- |
| Dimethoxyphenyl)-N- | methoxyphenol | methoxybenzaldehyde | diethoxyethane; 4-hydroxy-3- |
| methylmethanamine | | | methoxybenzaldehyde |
| 3-Chloro-5-ethoxy-4- | Methyl 3-fluoro-4-hydroxy-5- | 4-(4-Hydroxy-3- | 4-Hydroxy-3- |
| hydroxybenzoic acid | methoxybenzoate | ethoxyphenyl)-3-buten-2-one | methoxybenzaldehyde; oxolane- |
| | | | 2-carboxylic acid |
| 3-Chloro-5-ethoxy-4- | Methyl 3-acetyl-6-hydroxy-2,5- | 3-Methoxy-2- | 4-Hydroxy-3- |
| hydroxybenzonitrile | dimethylbenzoate | methylbenzamide | methoxybenzaldehyde; (E)-5- |
| | | | methyl-2-phenylhex-2-enal |
| 3-Chloro-4,5- | 3,5-Diethoxy-2-hydroxy-4- | 4-Methyl-2-methoxyresorcinol | 4-Hydroxy-3- |
| dihydroxybenzaldehyde | methylbenzaldehyde | | methoxybenzaldehyde; (Z)-5- |
| | | | methyl-2-phenylhex-2-enal |
| 4-(1,3-Dithiolan-2-yl)-2- | (1R,5S,8R)-1,8-Dimethyl-3- | 1-(3-Hydroxy-4- | 3-Ethoxy-2-fluoro-4- |
| methoxyphenol | azabicyclo[3.2.1]octane-2,4- | methoxyphenyl)-3- | hydroxybenzaldehyde |
| | dithione | methylbutan-1-one | |
| Phenol, 2-methoxy-4-(1- | 2,3-Difluoro-4,5- | Deuterio-(3,5-dideuterio-4- | 3-(Bromomethoxy)-4- |
| methylethenyl)- | dihydroxybenzaldehyde | hydroxyphenyl)methanone | hydroxybenzaldehyde |
| 3-Hydroxypyridine-2- | 2,3,5-Trifluoro-4- | 4-Hydroxybenzaldehyde-13C | 4-Hydroxy-3-(3- |
| thiol | hydroxybenzaldehyde | | methoxypropoxy)benzaldehyde; |
| | | | 4-methoxy-3-(3- |
| | | | methoxypropoxy)benzaldehyde |
| 3-Cyanophenyl | 1-(2-Sulfanylidene-3H-1,3- | 2-Chloro-3- | (6-Formyl-2,3- |
| isocyanate | thiazol-5-yl)ethanone | methoxybenzonitrile | dimethoxyphenyl)boronic acid |
| 1-Chloromethyl-2,4- | 2,4-Dimethoxycyclohexan-1- | 1-(5-Chloro-4-fluoro-2- | 3-Ethenyl-4-hydroxy-5- |
| diisocyanatobenzene | amine | hydroxyphenyl)ethanone | methoxybenzaldehyde |
| 2-Fluoro-4- | 4-Benzofurancarbonitrile, 7- | 3′-Methoxy-4′- | 4-Hydroxy-3- |
| hydroxybenzonitrile | hydroxy- | hydroxychalcone | methoxybenzaldehyde; 4- |
| | | | methylhexanoic acid |
| 2,4-Dimethoxybenzoyl | 6-Methylisoeugenol | 3-Methoxy-5-nitrocatechol | 4-Hydroxy-3- |
| chloride | | | methoxybenzaldehyde; 2- |
| | | | methylpentanoic acid |
| 2-Fluoro-5- | 6-Methyl-eugenol | 5-Methoxythiophene-2- | 4-Hydroxy-3- |
| methoxybenzaldehyde | | carbonitrile | methoxybenzaldehyde; (E)-2- |
| | | | methylbut-2-enoic acid |
| 2-Fluoro-4- | 1-(3,4-Dihydroxyphenyl)-2-(3,4- | 4-Cyclopentyloxy-3- | 4-Hydroxy-3- |
| methoxybenzaldehyde | dimethoxyphenyl)ethanone | hydroxybenzaldehyde | methoxybenzaldehyde; 5- |
| | | | methylhexanoic acid |
| 3-(2- | 1,3-Difluoro-5- | 4-Acetylcyclopent-2-en-1-one | 4-Hydroxy-3- |
| Bromoethoxy)benzaldehyde | (fluoromethyl)pyrimidine-2,4- | | methoxybenzaldehyde; 2- |
| | dione | | methylbutanoic acid |
| 3-Chloro-4- | 3-Methoxy-4- | 1-Acetyl-4-methyl-5- | 4-(Difluoromethoxymethoxy)- |
| hydroxybenzonitrile | sulfanylbenzaldehyde | oxocyclohex-3-ene | 3-hydroxybenzaldehyde |
| 4-Amino-3- | 4-Ethyl-5-fluoro-2- | 4-Hydroxy-3-methoxy-5- | 4- |
| (trifluoromethoxy)benzo- | methoxyphenol | phenylbenzaldehyde | [Difluoro(methoxy)methoxy]- |
| nitrile | | | 3-hydroxybenzaldehyde |
| 2,3-Difluoro-4- | 1-(2-Fluoro-4-hydroxy-5- | 1-(2,5-Dimethoxyphenyl)-N- | 4-Hydroxy-3- |
| hydroxybenzonitrile | methoxyphenyl)ethanone | methylmethanamine | methoxybenzaldehyde; 4- |
| | | | hydroxy-3-methoxy-5-(3- |
| | | | methylbut-2- |
| | | | enyl)benzaldehyde |
| 3- | 1-Ethyl-3-hydroxypyridine- | 1-(3-Amino-4- | Calcium; 4-hydroxy-3- |
| (Difluoromethoxy)benzal- | 2(1H)-thione | ethoxyphenyl)ethanone | methoxybenzaldehyde; |
| dehyde | | | carbonate |
| 3- | 3-Ethenoxy-4-methoxy-2- | (E)-3-(3-Hydroxy-4- | Ethanol; ethoxyethane; 4- |
| (Difluoromethoxy)benzo- | trimethylstannylbenzaldehyde | methoxyphenyl)-1-(4- | hydroxy-3- |
| nitrile | | hydroxyphenyl)prop-2-en-1- | methoxybenzaldehyde |
| | | one | |
| 3′-Fluoro-4′- | Methyl 3-methoxy-4- | 4-(2-Ethoxyethoxy)-3- | 3,7-Dimethyloct-6- |
| hydroxyacetophenone | (trifluoromethyl)benzoate | methoxybenzaldehyde | enal; ethanol; 4-hydroxy-3- |
| | | | methoxybenzaldehyde |
| 4-Fluoro-3- | Methyl 5-chloro-6- | Benzaldehyde, 3-ethoxy-4-(2- | 4-Hydroxy-3- |
| methoxybenzaldehyde | methoxypicolinate | methoxyethoxy)- | methoxybenzaldehyde; |
| | | | hydrochloride |
| 4-Fluoro-3- | Ethyl 5-chloro-6- | 3-Ethoxy-4-(2- | 4-Hydroxy-3- |
| methoxybenzonitrile | methoxypicolinate | propoxyethoxy)benzaldehyde | methoxybenzaldehyde; 2,6,10- |
| | | | trimethylundec-9-enal |
| 2-Fluoro-6- | 1-[3-(Difluoromethoxy)-5- | 3-(2- | 2-[4-Hydroxy-3- |
| methoxyphenol | fluorophenyl]ethanone | Chloroethoxy)benzaldehyde | (trideuteriomethoxy)phe- |
| | | | nyl]acetaldehyde |
| 4-Fluoro-2- | 4-Ethoxy-3,5- | 4-Fluoro-3- | Butane-2,3-dione; 4-hydroxy- |
| methoxyphenol | difluorobenzaldehyde | (trifluoromethoxy)benzonitrile | 3-methoxybenzaldehyde |
| 3′-Fluoro-5′- | 4-Ethoxy-2,3-difluorobenzyl | 3-Fluoro-4- | 3-Methoxy-4- |
| (trifluoromethyl)acetoph | alcohol | methoxybenzamide | (trimethylsilylmethoxy)benzal- |
| enone | | | dehyde |
| 2-Acetyl-5- | 3-Ethoxy-2,4- | 2-Chloro-6-fluoro-3- | 6-[(E)-But-1-enyl]-3-hydroxy- |
| cyanothiophene | difluorobenzaldehyde | methoxybenzonitrile | 2-methoxybenzaldehyde |
| Methyl 3,5-dimethoxy-4- | 3-Ethoxy-2-fluorobenzonitrile | 4-Hydroxy-2-iodo-5- | 2-Iodo-4-hydroxy-3- |
| methylbenzoate | | methoxybenzaldehyde | methoxybenzaldehyde |
| 1-(3-Acetyl-2,3-dihydro- | 3-Amino-6-methyl-2H-pyran-2- | 2-Ethoxy-3,5-dimethylaniline | 3-Hydroxy-4-methoxy-2- |
| 1H-imidazol-1-yl)-1- | one | | pentylbenzaldehyde |
| ethanone | | | |
| 2-Oxazolecarbonitrile, 5- | Anisaldehyde-[7-13C] | 3-Hydroxy-4- | 4-Hydroxy-3- |
| ethoxy-4-methyl- | | isobutoxybenzaldehyde | methoxybenzaldehyde; 3- |
| | | | hydroxy-2-methylpyran-4-one |
| 4-Methoxy-2,3,5- | 4-Anisaldehyde-13C6 | 3-Hydroxy-4-(3- | 3-Ethoxy-4- |
| trimethylbenzaldehyde | | methylbutoxy)benzaldehyde | hydroxybenzaldehyde; |
| | | | hydrochloride |
| 2-Hydroxy-4,5-dimethyl- | 5-Chloro-4-fluoro-2- | Hydroxycyclohexadienone | Acetic acid; 3-ethoxy-4- |
| 2,4,6-cycloheptatriene- | methoxyaniline | | hydroxybenzaldehyde |
| 1-one | | | |
| 3-Butoxybenzaldehyde | 6-Chloro-2,3-dihydroxypyridine | 2-Chloro-4- | 4-Hydroxy-3- |
| | | hydrazinylbenzonitrile | methoxybenzaldehyde; 4- |
| | | | (hydroxymethyl)-2- |
| | | | methoxyphenol |
| 4-Difluoromethoxy-3- | 4-Hydrazinyl-2- | 4-Ethylsulfonyl-2-methoxy-5- | 3,4- |
| hydroxybenzaldehyde | methylbenzonitrile | methylaniline | Dimethoxybenzaldehyde; 3- |
| | | | hydroxybenzaldehyde |
| 1-Isocyano-2,4- | 1-(4-Hydroxy-3-methoxyphenyl)- | 4-(2-Methylcyclopropyl)-2- | 4-Hydroxy-3- |
| dimethoxybenzene | 2-(4-hydroxyphenyl)ethanone | methoxyphenol | methoxybenzaldehyde; |
| | | | phenylmethanol |
| 1-(2,4- | 2-(4-Hydroxy-3-methoxyphenyl)- | 4-Ethoxy-2,5- | 4-[(E)-But-2-en-2-yl]oxy-3- |
| Dimethoxyphenyl)-2- | 1-(4-hydroxyphenyl)ethanone | dihydroxybenzaldehyde | ethoxybenzaldehyde |
| thiourea | | | |
| 2,4- | 1-(3-Hydroxy-6-methoxypyridin- | 1-(4-Hydroxy-3- | 4-[(E)-But-2-en-2-yl]oxy-3- |
| Dimethoxythiophenol | 2-YL)ethanone | methoxyphenyl)-2-butanone | methoxybenzaldehyde |
| 3-Methoxy-4- | 1-[3-Methoxy-4- | 1-Acetylpyrrole-3-carbonitrile | 4-Hydroxy-3-[(E)-1-(4- |
| (pentyloxy)benzaldehyde | (methylsulfanyl)phenyl]ethan-1- | | hydroxy-3- |
| | one | | methoxyphenyl)prop-1-en-2- |
| | | | yl]oxybenzaldehyde |
| 2,6- | 4-Hydroxy-3-(2- | (4-Formyl-2-methoxyphenyl) | 4-Hydroxy-3- |
| Dimethoxyisonicotinal- | hydroxyethoxy)benzonitrile | hydrogen carbonate | methoxybenzaldehyde; 2- |
| dehyde | | | methoxyphenol |
| 2-Chloro-1-(4-hydroxy- | 4-Hydroxy-3-methoxy- | 2-Methoxy-3,4- | (2E)-2-(3,4- |
| 3,5- | benzaldehyde; 2-methoxy-4- | dimethylaniline | Dimethoxyphenyl)penta-2,4- |
| dimethylphenyl)ethanone | methyl-phenol | | dienal |
| 3-(Chloromethyl)-4- | Benzoic acid, 4-amino-3-(2- | 2-Bromo-1-(3-fluoro-4- | (2Z)-2-(3,4- |
| hydroxy-5- | fluoroethoxy)-, methyl ester | hydroxyphenyl)ethanone | Dimethoxyphenyl)penta-2,4- |
| methoxybenzaldehyde | | | dienal |
| 1-[3- | 1-(2,4-Dihydroxy-5- | (2-Methoxy-4- | 3-Hydroxy-4- |
| (Difluoromethoxy)phe- | methoxyphenyl)ethanone | methylsulfonylphenyl)hydrazine | methoxybenzaldehyde; prop- |
| nyl]ethanone | | | 2-enoic acid |
| Ethyl 2,4,5-trifluoro-3- | 5-Bromo-3-ethoxy-2- | (2E)-3,7-Dimethylocta-2,6- | 3,4- |
| methoxybenzoate | methylbenzaldehyde | dienal; 4-hydroxy-3- | Dihydroxybenzaldehyde; 4- |
| | | methoxybenzaldehyde | hydroxy-3- |
| | | | propoxybenzaldehyde |
| 1-(4-Fluoro-3- | 1-Ethyl-6-hydroxy-4,5-dimethyl- | 6-Oxotetrahydro-2H-pyran-2- | 3-(Chloromethoxy)-4- |
| methoxyphenyl)ethanone | 2-oxopyridine-3-carbonitrile | carbaldehyde | hydroxybenzaldehyde |
| 2-Fluoro-5- | (E)-1,4-Bis(4-hydroxy-3- | 3-Methoxy-4- | 4-Hydroxy-3-methoxy-2- |
| methoxybenzonitrile | methoxyphenyl)-2,3- | (trifluoromethyl)benzaldehyde | propan-2-ylbenzaldehyde |
| | dimethylbut-2-ene-1,4-dione | | |
| 5-Fluoro-2- | 1-(4-Amino-2-fluoro-5- | 4-Oxopyrimidine-1- | 4-Hydroxy-3- |
| methoxyphenol | methoxyphenyl)ethanone | carboxamide | methoxybenzaldehyde; |
| | | | (9Z,12Z,15Z)-octadeca- |
| | | | 9,12,15-trienoic acid |
| 3-Fluoro-4- | 3-Bromo-5-fluoro-2- | 3-Methoxy-4,5,6- | (E)-3-(3,4- |
| methylbenzaldehyde | methoxyphenol | trimethylbenzene-1,2-diol | Dihydroxyphenyl)prop-2- |
| | | | enoic acid; 4-hydroxy-3- |
| | | | methoxybenzaldehyde |
| 4′-Hydroxy-3′- | 3-Propargyloxy-4- | 3,4,5-Trimethoxybenzene- | 4-Hydroxy-3- |
| (trifluoromethyl)aceto- | hydroxybenzaldehyde | 1,2-diol | methoxybenzaldehyde; (E)-3- |
| phenone | | | (4-hydroxy-3- |
| | | | methoxyphenyl)prop-2-enoic |
| | | | acid |
| 1-(5-Acetyl-2,4- | 5-Chloro-3-methoxypyridin-2- | 2-Fluoro-4- | 2-(4-Hydroxy-5-methoxy-2- |
| dihydroxy-3- | amine | (methylamino)benzaldehyde | methylphenyl)acetaldehyde |
| methylphenyl)ethan-1- | | | |
| one | | | |
| 2,4,5-Trifluoro-3- | 2-Methoxy-4-(thiophen-2- | 2-Oxo-2h-pyran-5- | 2-(2-Ethyl-4-hydroxy-5- |
| methoxybenzamide | YL)phenol | carboxamide | methoxyphenyl)acetaldehyde |
| 1-(3-Chloro-4- | 4-(2-Formylphenyl)-2- | 3-Oxocyclopentene-1- | 3-Hydroxy-4-[(2S)-2- |
| hydroxyphenyl)propan- | methoxyphenol | carbaldehyde | phenylpropoxy]benzaldehyde |
| 1-one | | | |
| 3-(Methylamino)-3,4- | 5-(2-Formylphenyl)-2- | 2-(3-Chloro-2- | 3-Hydroxy-4-[(2R)-2- |
| dihydroquinazolin-4-one | methoxyphenol | methoxyphenyl)acetonitrile | phenylpropoxy]benzaldehyde |
| 3-Iodo-4,5- | 4-(3-Formylphenyl)-2- | 2-(4-Fluoro-3- | 4-Methoxy-3-[(E)-4-methoxy- |
| dimethoxybenzaldehyde | methoxyphenol | methoxyphenyl)acetonitrile | 3-methylbut-1- |
| | | | enoxylbenzaldehyde |
| 2,6-Difluoro-4- | 5-(3-Formylphenyl)-2- | Phenol, 2-methoxytrimethyl- | Ethoxyethane; 3-hydroxy-4- |
| methoxybenzamide | methoxyphenol | | methoxybenzaldehyde |
| 2,6-Difluoro-4- | 4-(4-Formylphenyl)-2- | 1-Methoxy-3- | 2,5-Difluoro-3-hydroxy-4- |
| hydroxybenzonitrile | methoxyphenol | (methoxymethyl)imidazolidin- | methoxybenzaldehyde |
| | | 2-one | |
| 3-Chloro-5-fluoro-4- | 5-(4-Formylphenyl)-2- | 4-Ethoxy-2-methoxybenzoyl | 4-(4-Formylphenoxy)-3- |
| hydroxybenzaldehyde | methoxyphenol | chloride | hydroxybenzaldehyde |
| 3-Fluoro-4- | 5-Hydroxy-2-iodo-4- | 4-Fluoro-3-methoxy-2- | 3-Chloro-1-ethenylpyrimidine- |
| hydroxybenzonitrile | (methoxymethoxy)benzal- | methylthiobenzoyl Chloride | 2,4-dione |
| | dehyde | | |
| 4-Hydroxy-3- | 5-Acetyl-2-hydroxy-3- | 4-[(6-Hydroxyhexyl)oxy]-3- | 4-Hydroxy-3- |
| (trifluoromethyl)benzo- | methoxybenzaldehyde | methoxybenzaldehyde | methoxybenzaldehyde; (E)-3- |
| nitrile | | | phenylprop-2-enoic acid |
| 2-Methoxy-5- | Ethyl 4-chloro-3-ethoxybenzoate | 5-Ethoxynicotinaldehyde | 2-(2-Hydroxy-3- |
| (trifluoromethoxy)benzal- | | | methoxyphenyl)-2- |
| dehyde | | | oxoacetaldehyde |
| 4-Amino-2- | 2,4-Dimethoxy-6-methylaniline | 3-Methoxy-2,4- | 2-(3-Hydroxy-2- |
| fluorobenzonitrile | | dimethylbenzaldehyde | methoxyphenyl)-2- |
| | | | oxoacetaldehyde |
| Ethyl 4-chloro-5-cyano- | 5-Hydroxy-4,6-dimethyl-2,3- | 4-Ethoxy-3,5- | (4-Formyl-2-methoxyphenyl) |
| 2-hydroxybenzoate | dihydro-1H-inden-1-one | dimethylbenzaldehyde | hypochlorite |
| 6-Amino-2- | 1-(4-Amino-3-ethoxy-phenyl)- | 2-Thiophenecarboxaldehyde, | 3-Hydroxy-5-(hydroxymethyl)- |
| methylnicotinonitrile | ethanone | 4-methoxy- | 4-methoxybenzaldehyde |
| 5-Acetylthiophene-2- | 2-(4-Fluoro-3- | 4-Acetamido-3- | 3-Cyclopentyloxy-4- |
| carbaldehyde | methoxyphenyl)acetaldehyde | methoxybenzaldehyde | hydroxybenzoyl iodide |
| 2-Hydroxybenzene- | 2-Chloro-3-fluoro-6- | 4-Acetamido-3- | 4-Hydroxybenzaldehyde; 4- |
| 1,3,5-tricarbaldehyde | hydroxybenzaldehyde | methylbenzaldehyde | hydroxy-3- |
| | | | methoxybenzaldehyde |
| 3- | 4,6-Dimethoxypyridin-3-amine | 5-Oxo-1,2-oxazole-2- | Ethene; 4-hydroxy-3- |
| (Methylamino)thieno[3,2- | | carboxamide | methoxybenzaldehyde |
| d]pyrimidin-4-one | | | |
| 4-Acetamido-3- | 4-Cyanotetrahydrothiophenone | 3-Amino-1-methylpiperidine- | 4-(Difluoromethoxy)-3- |
| ethoxynitrobenzene | | 2,6-dione | hydroxybenzaldehyde; 3,4- |
| | | | dihydroxybenzaldehyde |
| 4-Sec-butoxy-3- | Methyl 4-amino-3- | 1-(3-Methoxy-2,4- | 4-Hydroxy-3- |
| ethoxybenzaldehyde | (trifluoromethoxy)benzoate | dimethylphenyl)ethanone | methoxybenzaldehyde; 1-(4- |
| | | | hydroxy-3- |
| | | | methoxyphenyl)but-3-en-2- |
| | | | one |
| 2-Methoxy-4,5- | (4-Amino-3- | 2-Ethoxy-4-ethyl-5- | 3,4- |
| dimethylphenol | methoxyphenyl)methanol | methylphenol | Dihydroxybenzaldehyde; 3- |
| | | | hydroxy-4- |
| | | | methoxybenzaldehyde |
| 2-Bromo-5- | 3-Hydroxy-4- | 5-Formyl-2-hydroxy-3- | 1,1-Diethoxyethane; 4- |
| ethoxybenzaldehyde | (trifluoromethoxy)benzaldehyde | methoxybenzonitrile | hydroxy-3- |
| | | | methoxybenzaldehyde; prop- |
| | | | 1-ene |
| 2-Methoxy-4-(1- | 2,4-Dimethoxy-5-methylpyridine | 2,3-Difluoro-4-hydroxy-5- | 1,1-Diethoxyethane; ethene; 4- |
| methylethyl)phenol | | methoxybenzaldehyde | hydroxy-3- |
| | | | methoxybenzaldehyde |
| 2,4- | 1-Chloro-5-isocyano-2,4- | 1-(4-Hydroxy-3-methoxy- | Butane; 1,1-diethoxyethane; 4- |
| Dihydroxybenzonitrile | dimethoxybenzene | phenyl)-prop-2-yn-1-ol | hydroxy-3- |
| | | | methoxybenzaldehyde |
| 2,4-Dihydroxy-3- | 5,6- | 3-Amino-1-hydroxypiperidin- | 3-Ethoxy-4- |
| methoxybenzoic acid | Dihydroxybicyclo[2.2.1]heptane- | 2-one | hydroxybenzaldehyde; octan- |
| | 2-carbaldehyde | | 2-ol |
| 7-Chloro-5- | Methyl 5-formyl-4- | 6-Difluoromethoxy-3H- | 4-[(E)-Pent-2-en-3-yl]oxy-3- |
| methylquinolin-8-ol | methylthiophene-2-carboxylate | isobenzofuran-1-one | [(Z)-pent-2-en-3- |
| | | | yl]oxybenzaldehyde |
| 3-Chloro-4-hydroxy-5- | 4-Hydroxy-3- | 4-Chloro-5-(chloromethyl)-2- | 4-Hydroxy-3- |
| (isopropyl)benzaldehyde | methoxybenzaldehyde; 2- | methoxyphenol | methoxybenzaldehyde; 1-(4- |
| | methylpropanoic acid | | hydroxy-3- |
| | | | methoxyphenyl)ethanone |
| Ethyl 3-chloro-4- | (3-Fluoro-2- | 6-Aminonicotinaldehyde | 2-(4-Hydroxy-3-iodo-5- |
| hydroxy-5- | methoxyphenyl)hydrazine | | methoxyphenyl)acetaldehyde |
| methoxybenzoate | | | |
| 3-Ethyl 1-methyl 4- | 3-Methoxy-4- | 3-Oxocyclohexa-1,5-diene-1- | 3-Hydroxy-4- |
| hydroxy-1,3- | (trifluoromethoxy)benzaldehyde | carbaldehyde | methoxybenzaldehyde; nitric |
| benzenedicarboxylate | | | acid |
| Ethyl 3,5-dimethyl-4- | 4-Hydroxy-3,5- | 5-Hydroxy-6-methoxy-3H- | 3-Fluoro-4-hydroxy-5- |
| hydroxybenzoate | bis(trideuteriomethyl)benzo- | isobenzofuran-1-one | propoxybenzaldehyde |
| | nitrile | | |
| 6-Mercaptonicotinamide | 2,3,4,5-Tetrafluoro-6- | 6- | 3-(2-Bromoethoxy)-4- |
| | methoxyaniline | (Methylamino)nicotin- | hydroxybenzaldehyde |
| | | aldehyde | |
| 2(1 H)-Pyridinethione, 3- | 2,4-Diisocyanatobenzoyl | 2-Bromo-4,6- | 3-Methoxy-4- |
| hydroxy-6-methyl- | chloride | dimethoxyaniline | sulfanyloxybenzaldehyde |
| Hexyl 3-hydroxy-4- | Formic acid 3-methoxyphenyl | 3-Ethoxy-2,6- | 3,4- |
| methoxybenzoate | ester | difluorobenzonitrile | Dimethoxybenzaldehyde; |
| | | | nitric acid |
| 4-(4-Hydroxy-3- | 3-(4-Hydroxy-3- | 2-Chloro-3-ethoxy-6-fluoro-5- | 1,1-Diethoxyethane; 3-ethoxy- |
| methoxyphenyl)-4- | methoxyphenyl)prop-1-en-1-one | hydroxybenzonitrile | 4-hydroxybenzaldehyde |
| oxobut-2-enoic acid | | | |
| 2,4(1H,3H)- | 2-Ethoxycyclobutane-1- | 3-Ethoxy-2-fluoro-5- | 1,1-Dimethoxyethanol; 4- |
| Pyrimidinedione, 5- | carbaldehyde | hydroxybenzonitrile | hydroxy-3- |
| hydroxy-1,3,6-trimethyl- | | | methoxybenzaldehyde |
| 1-Amino-5-chlorouracil | 4-[(Hydroxyamino)methyl]-2- | 2-Fluoro-5-hydroxy-3- | 4-(lodomethoxy)-3- |
| | methoxyphenol | methoxybenzonitrile | methoxybenzaldehyde |
| Vanillal S 10026 | 4-But-1-enyl-2-methoxyphenol | 6-Chloro-3-ethoxy-2- | 3-(5-Formyl-2- |
| | | fluorobenzonitrile | hydroxyphenoxy)-4- |
| | | | hydroxybenzaldehyde |
| 4-(2-Hydroxyethoxy)-3- | Bromvanillin | Potassium; 4-hydroxy-3- | 4-Hydroxybutanal; 4-hydroxy- |
| methoxybenzaldehyde | | methoxybenzaldehyde; | 3-methoxybenzaldehyde |
| | | hydroxide | |
| 5-Ethoxy-4-methoxy-2- | 1-Fluoro-2-methoxy-4,5- | 4-Fluoro-2-methoxy-5- | 4-(1-Hydroxy-4-oxobutan-2- |
| methyl-benzaldehyde | dimethylbenzene | methylaniline | yl)oxy-3- |
| | | | methoxybenzaldehyde |
| 2-Methylamino- | Iodovanillin | 6-Methoxy-2,3- | Acetaldehyde; ethanol; 4- |
| pyrimidine-5- | | dihydrobenzoxazole | hydroxy-3- |
| carbaldehyde | | | methoxybenzaldehyde |
| 4-(Difluoromethoxy)-3- | 1-(3-Hydroxy-4- | 1-(Chloromethyl)-2,4- | Methyl 2-(5-formyl-2- |
| methoxybenzaldehyde | methoxyphenyl)propane-1,2- | dimethoxybenzene | hydroxyphenoxy)butanoate |
| | dione | | |
| 2,3-Dimethyl-5- | Methyl 2-fluoro-5-methoxy-4- | 2-Chloro-5- | 4-Hydroxy-3- |
| (methylamino)thiopyran- | propylbenzoate | (trifluoromethoxy)benzal- | methoxybenzaldehyde; |
| 4-one | | dehyde | (2R,3S,4R,5R)-2,3,4,5,6- |
| | | | pentahydroxyhexanal |
| 4′-Hydroxy-5′-isopropyl- | (2,4,5-Trichloro-6-methoxy-3- | 5-Chloro-2-ethoxy-4- | 3-Hydroxy-2- |
| 2′-methylacetophenone | methylphenyljhydrazine | methoxyaniline | methoxybenzaldehyde; 3- |
| | | | hydroxy-4- |
| | | | methoxybenzaldehyde |
| 4- | 4-Methoxy-2- | 3,5-Dichloro-2-methoxy-4- | 3,4- |
| Dimethylphosphoryl- | (nitrosomethyl)phenol | methylaniline | Dihydroxybenzaldehyde; |
| phenol | | | propan-2-one |
| 4-(Allyloxy)-3- | 4-(Dichloromethyl)-2- | 3-Chloro-2,4- | (E)-4-(4-Formyl-2- |
| ethoxybenzaldehyde | methoxyphenol | dimethoxyaniline | methoxyphenoxy)-3- |
| | | | methylbut-2-enoic acid |
| 5-Oxopyrrolidine-3- | 3- | 2-Methoxy-4-nitrosoaniline | 3-Hydroxy-4- |
| carboxamide | (Chloromethoxy)benzaldehyde | | methoxybenzaldehyde; 4- |
| | | | hydroxy-3- |
| | | | methoxybenzaldehyde |
| Benzonitrile, 2,3,5,6- | Methyl 3,5-dimethoxy-4- | 2-Ethoxy-5-fluorophenol | 3,4- |
| tetrafluoro-4-hydroxy- | (methylamino)benzoate | | Dimethoxybenzaldehyde; |
| | | | ethanol |
| Ethanone, 1-(4- | 2-Chloro-4-hydroxy-3- | 4-Hydroxy-3-methoxy-2- | 4-Hydroxy-3- |
| hydrazinophenyl)- | methoxybenzoyl chloride | methylbenzoic acid | methoxybenzaldehyde; methyl |
| | | | hydrogen carbonate |
| 2,4-Difluoro-3- | 2-Ethoxy-4- | 2-Ethoxy-4-ethylphenol | Diethyl carbonate; 4-hydroxy- |
| methoxybenzaldehyde | (nitrosomethyl)phenol | | 3-methoxybenzaldehyde |
| 3-Bromo-5-chloro-4- | 4-(2-Hydroxyethoxy)-2-iodo-3- | (E)-1-(2,4-Dichloro-5- | Ethyl hydrogen carbonate; 4- |
| hydroxybenzaldehyde | methoxybenzaldehyde | isocyanatophenyl)-N- | hydroxy-3- |
| | | methoxymethanimine | methoxybenzaldehyde |
| 3-Hydroxy-1-methyl- | 1-(2-Oxoethyl)triazole-4- | (E)-1-(2-Chloro-4-fluoro-5- | Carbonic acid; 3-ethoxy-4- |
| 2(1h)-pyridinethione | carbonitrile | isocyanatophenyl)-N- | hydroxybenzaldehyde |
| | | methoxymethanimine | |
| 2,4-Difluoro-3- | 1-(2,4-Dichloro-5- | (3S,6R)-3-Hydroxy-6- | Carbonic acid; 4-hydroxy-3- |
| methoxyphenylacetonitrile | isocyanatophenyl)-N- | methyloxan-2-one | methoxybenzaldehyde |
| | methoxymethanimine | | |
| 5-Hydroxy-4- | 2,3,4,5-Tetramethyl-6- | 3-Hydroxy-1-(4-hydroxy-3- | 4-Hydroxy-3,5- |
| methoxybenzene-1,3- | (methylideneamino)phenol | methoxyphenyl)decan-1-one | dimethoxybenzaldehyde; sodi |
| dicarbaldehyde | | | urn |
| 1-(3- | 1-(Ethoxymethyl)-2,3,6-trifluoro- | 2-Benzyl-4-hydroxy-3- | 4-Hydroxy-3- |
| Ethoxyphenyl)ethanone | 5-methoxy-4-methylbenzene | methoxybenzaldehyde | methoxybenzaldehyde; sodiu |
| | | | m |
| 2-Fluoro-3- | 3-(4-Hydroxy-3-methoxyphenyl)- | 3-Sulfanylidenecyclohexa- | 4-Hydroxy-3- |
| methoxybenzaldehyde | 2-oxopropanal | 1,5-diene-1-carbaldehyde | methoxybenzaldehyde; 3- |
| | | | methoxybenzaldehyde |
| 2,6-Difluoro-3- | 2-Oxooxane-4-carbaldehyde | Dimethyl 2-methoxybenzene- | 1,1-Diethoxyethane; 3- |
| methoxybenzonitrile | | 1,4-dicarboxylate | hydroxy-4- |
| | | | methoxybenzaldehyde |
| 3-Ethoxy-4- | 2-Methoxy-4- | 1-Aminoazepan-2-one | 3-Ethoxy-4- |
| hydroxybenzonitrile | (nitrosomethyl)phenol | | hydroxybenzaldehyde; 2- |
| | | | methoxy-4-[(E)-prop-1- |
| | | | enyl]phenol |
| 2-Ethoxy-6- | Methyl 3,5-difluoro-4- | 5-Chloro-2,4- | 4-Hydroxy-3- |
| fluorobenzaldehyde | hydroxybenzoate | dimethoxybenzoyl chloride | methoxybenzaldehyde; |
| | | | sulfurous acid |
| 2',4'-Difluoro-3'- | 3-Chloro-4-diazo-6-ethoxy-N- | 4,5-Difluoro-2-methoxyphenol | Hexadecanal; 4-hydroxy-3- |
| methoxyacetophenone | methylcyclohexa-1,5-dien-1- | | methoxybenzaldehyde |
| | amine | | |
| 2,5-Difluoro-4- | 4-Ethoxy-3-(2- | 2-Methoxy-4-methylthio-5- | 3-Hydroxy-2-methoxy-6-prop- |
| methoxybenzaldehyde | hydroxyethoxy)benzaldehyde | fluoro-phenol | 2-enylbenzaldehyde |
| 2,4-Difluoro-3- | Methyl 3-methoxy-5-methyl-4- | 5-Hydroxy-2-(hydroxymethyl)- | (E)-1,3-Diphenylprop-2-en-1- |
| methoxybenzonitrile | (trifluoromethyl)benzoate | 3H-pyridin-4-one | one; 3-hydroxy-4- |
| | | | methoxybenzaldehyde |
| 5-Ethoxy-2- | 1-[4-(Difluoromethoxy)-3- | 1-(4-Chloro-3- | 3,4-Dimethoxycyclohexa-1,3- |
| hydroxybenzaldehyde | hydroxyphenyl]ethanone | methoxyphenyl)ethanone | dien-5-yne-1-carbaldehyde |
| 3-Difluoromethoxy-4- | Ethyl 3-(5-formyl-2- | 1-(4-Ethyl-3- | 3-Butoxy-2-fluoro-4- |
| methoxy-benzaldehyde | hydroxyphenoxy)propanoate | methoxyphenyl)ethanone | hydroxybenzaldehyde |
| 2,3-Dichloro-5-ethoxy-6- | 1,2,4-Trifluoro-5-methoxy-3- | 3-Bromo-5-fluoro-4- | 3-Hydroxy-4-methoxy-2-(4- |
| hydroxybenzaldehyde | (methoxymethyl)-6- | hydroxybenzaldehyde | methoxyphenyl)benzaldehyde |
| | methylbenzene | | |
| 5-Hydroxy-3H-1,3- | 1-Ethoxy-3-(ethoxymethyl)- | Methyl 3-ethoxy-4- | 4-[4- |
| thiazole-2-thione | 2,4,5-trifluoro-6-methylbenzene | hydroxybenzoate | (Dihydroxyamino)oxybutoxy]- |
| | | | 3-hydroxybenzaldehyde |
| Methyl 3-hydroxy-4- | 2-Isocyanato-4-methoxyphenol | 1-(4-Chloro-2-fluoro-5- | 4-[3- |
| methoxybenzoate | | propan-2- | (Dihydroxyamino)oxypropoxy]- |
| | | yloxyphenyl)ethanone | 3-hydroxybenzaldehyde |
| Methyl 2-hydroxy-5- | 1.3-Dimethyl-5,6-dimethylidene- | 3-Methoxy-5- | 3-Ethoxy-4- |
| methoxybenzoate | 1.3-diazinane-2,4-dione | trifluoromethoxybenzal- | hydroxybenzaldehyde; 4- |
| | | dehyde | hydroxy-3- |
| | | | methoxybenzaldehyde |
| 2-Allyl-4-methoxy-5- | (4-Formyl-2-methoxyphenyl) 3- | [3- | 3-(2-Hydroxyethoxy)-4-(2- |
| hydroxybenzaldehyde | (4-hydroxy-3- | (Methoxymethyl)cyclopentyl] | methoxyethoxy)benzaldehyde |
| | methoxyphenyl)prop-2-enoate | methanol | |
| 3,4- | 4-Amino-3-methoxybenzamide | 3- | 3-Hydroxy-4-(2- |
| Dipropoxybenzaldehyde | | (Isocyanomethoxy)benzal- | phenylmethoxyethoxy)benzal- |
| | | dehyde | dehyde |
| 3-Hydroxy-4- | 3-Methyl-2-oxoimidazolidine-1- | 1-(Difluoromethoxy)-3- | 3-Hydroxy-4- |
| methoxybenzophenone | carbaldehyde | methoxybenzene | methoxybenzaldehyde; 1-(4- |
| | | | hydroxy-3- |
| | | | methoxyphenyl)ethanone |
| Phenyl(3-methoxy-4- | 5-Chloro-4-cyano-2- | 1-(1-Acetylpyrrol-3- | 2-Fluoro-5-hydroxy-4-[2-(2- |
| hydroxyphenyl)metha- | methoxybenzoyl chloride | yl)ethanone | methoxyethoxy)ethoxy]benzal- |
| none | | | dehyde |
| 5-Chloro-2,3- | Ethyl (5-formyl-2- | 4-Hydroxy-3- | 3-Hydroxy-4-[2-(2- |
| dimethoxybenzaldehyde | hydroxyphenyl) carbonate | methoxybenzaldehyde; | methoxyethoxy)ethoxy]benzal- |
| | | sulfuric acid | dehyde |
| 1-(3-Methoxyphenyl)-N- | (2,4-Dimethoxyphenyl)diazene | 3-Butyl-4-hydroxy-5- | 2-Hydroxy-3-methoxy-5-(2- |
| methylmethanimine | | methoxybenzaldehyde | oxoethyl)benzaldehyde |
| 3-Ethoxybenzyl alcohol | (3-Hydroxy-4-methoxyphenyl)- | 4-Dimethylamino-3- | 3-Hydroxy-4-[(4- |
| | (4-methylphenyl)methanone | methoxybenzaldehyde | methylphenyl)methoxy]benzal- |
| | | | dehyde |
| 5-Methanehydrazonoyl- | (2-Chloro-4-methoxy-6- | 1-(4-Hydroxy-3- | 4-Hydroxy-3-[2-[2-(2- |
| 2-methoxyphenol | methylphenyl)hydrazine | methoxyphenyl)-2,2- | propoxyethoxy)ethoxy]eth- |
| | | dimethylpropan-1-one | oxy]benzaldehyde |
| 1-Aminopyridin-2(1h)- | Methyl 4-hydroxy-2-methyl-3- | 3-Bromo-1-ethenylpyrimidine- | 3-[2-[2-[2-(2- |
| one | prop-2-enoxybenzoate | 2,4-dione | Butoxyethoxy)ethoxy]ethoxy] |
| | | | ethoxy]-4- |
| | | | hydroxybenzaldehyde |
| Methanamine, N-[(3,4- | 3-Pyridinol, 4-methoxy-6- | 1-Hydroxymethyl-3-methyl- | 4-Methoxy-3- |
| dimethoxyphenyl)methyl | methyl- | imidazolidin-2-one | phosphanyloxybenzaldehyde |
| ene]- | | | |
| 3-(4-Hydroxy-3- | 5-Chloro-4-methyl-6-oxopyran- | 1- | 4-[4-(4-Formyl-2- |
| methoxyphenyl)-1-(4- | 2-carbaldehyde | Hydroxybicyclo[3.1.1]heptan- | methoxyphenoxy)butoxy]-3- |
| methoxyphenyl)prop-2- | | 2-one | hydroxybenzaldehyde |
| en-1-one | | | |
| 4-Ethyl-2- | 6-(Hydroxymethyl)-4- | 4-Hydroxy-2-methyl-5- | 3-(3-Methoxy-4- |
| methoxybenzenamine | methyliminopyran-3-ol | trifluoromethylbenzoic acid | hydroxybenzyl)-4-hydroxy-5- |
| | | methyl ester | methoxybenzaldehyde |
| 1-(3-Methoxy-4- | 2-Methoxy-3- | 4-Chloro-2-methoxy-3- | (E)-6-(3-Methoxy-4- |
| sulfanylphenyl)ethan-1- | (trifluoromethoxy)benzaldehyde | methylaniline | hydroxyphenyl)-5-hexene- |
| one | | | 1,2,4-trione |
| 4-Mercapto-3- | 2,3-Dimethoxy-4-aminopyridine | 2-(Diaziridin-1-yl)cyclohexa- | (5-Formyl-2- |
| methoxybenzonitrile | | 2,5-diene-1,4-dione | methoxyphenoxy)- |
| | | | hydroxyboron |
| 3-Methoxy-4- | 5-Methoxy-2-methylbenzonitrile | 3-Oxopiperidine-1- | 3,4- |
| methylbenzaldehyde | | carbaldehyde | Bis(hydroxymethoxy)benzal- |
| | | | dehyde |
| 3-Methoxy-4-[(2- | 3-Chloro-2,4,5-trimethyl-6- | 1-(4-Methyl-5- | Ethoxyethane; 4-hydroxy-3- |
| methylprop-2-en-1- | (trifluoromethoxy)aniline | sulfanylidenedithiol-3- | methoxybenzaldehyde; |
| yl)oxy]benzaldehyde | | yl)ethanone | phenol |
| Methyl 3-bromo-4- | 4-Chloro-N-methyl-2- | Hydrazine; 4-hydroxy-3- | (5-Formyl-2-hydroxy-4- |
| hydroxybenzoate | (methylideneamino)aniline | methoxybenzaldehyde | methylphenyl) acetate |
| 4-Methoxy-3- | 1,2,5-Trifluoro-4-methoxy-3- | 5-Chloro-4-methylthiophene- | 3-Hydroxy-4- |
| (pentyloxy)benzaldehyde | methylbenzene | 3-carboxamide | methoxybenzaldehyde; prop- |
| | | | 1-ene |
| 3-Hexoxy-4- | 3,4,5-Trimethyl-2-prop-2- | 4,5-Dichloro-2- | 4-Hydroxy-3- |
| methoxybenzaldehyde | enoxyphenol | (trifluoromethoxy)aniline | methoxybenzaldehyde; prop- |
| | | | 1-ene |
| Benzaldehyde, 3- | 2-Propenal, 3-(3-hydroxy-4- | 1-Methyl-5-oxopyrrolidine-3- | 3-(Fluoromethoxy)-4- |
| (heptyloxy)-4-methoxy- | methoxyphenyl)-, (E)- | carbothioamide | hydroxybenzaldehyde |
| 3- | 1-Amino-2- | 3,5-Difluoro-2,4- | 4-Hydroxy-2-(1-iodoethyl)-3- |
| Ethoxyphenylacetonitrile | sulfanylidenepyrimidin-4-one | dihydroxybenzaldehyde | methoxybenzaldehyde |
| 3-Chloro-2- | 4-Hydroxy-3- | 1-[3-Methoxy-4-[(E)-prop-1- | 3-Ethoxy-4-hydroxybenzoyl |
| methoxyphenylformamide | (iodomethoxy)benzaldehyde | enoxy]phenyl]ethanone | iodide |
| 5-Chloro-3-ethoxy-2- | 1-Acetylpiperidine-3- | 1-[4-Hydroxy-3-methoxy-5- | 1-(4-Hydroxy-2-iodo-3- |
| hydroxybenzaldehyde | carbaldehyde | [(E)-prop-1- | methoxyphenyl)propan-1-one |
| | | enyl]phenyl]ethanone | |
| 4(3H)-Pyrimidinone, 6- | 1-(6-Hydroxy-2,3- | Benzamide, 3-chloro-4- | 2-Ethyl-3-hydroxypyran-4- |
| methoxy-3-methyl- | dimethylphenyl)ethanone | hydroxy-N,N-dimethyl- | one; 4-hydroxy-3- |
| | | | methoxybenzaldehyde |
| 2-Fluoro-5- | 1-(3-Hydroxy-4-methoxy-2-prop- | Ethanol; 4-hydroxy-3- | 3-Ethoxy-5-ethyl-4- |
| (trifluoromethoxy)benzo- | 2-enylphenyl)ethanone | methoxybenzaldehyde | hydroxybenzaldehyde |
| nitrile | | | |
| 3-Ethoxy-4-hexoxy- | 5-Hydroxy-2- | 4-Hydroxy-3- | 4-Hydroxy-3-methoxy-5- |
| benzaldehyde | (hydroxymethyl)thiopyran-4-one | methoxybenzaldehyde; | propoxybenzaldehyde |
| | | propanoyl propanoate | |
| 1-(4-Hydroxy-2,3,5- | 2-(5-Formyl-2- | 3-Aminooxan-2-one | 3-Fluoro-5-(3-fluoropropoxy)- |
| trimethylphenyl)ethanone | hydroxyphenoxy)acetic acid | | 4-hydroxybenzaldehyde |
| 2,6-Difluoro-3- | 1,4-Dimethyl-6-oxopyridine-2- | 4-Hydroxy-3- | 1-(4-Heptoxy-3- |
| methoxybenzyl alcohol | carbaldehyde | methoxybenzaldehyde; | hydroxyphenyl)ethanone |
| | | methanol | |
| 3,5-Dimethyl-2- | 1-Amino-1,3-diazinane-2,4- | 3-(Dimethylamino)-4- | 4-Hydroxy-3- |
| sulfanylidene-1,3,5- | dione | hydroxybenzaldehyde | methoxybenzaldehyde; oxalic |
| thiadiazinan-4-one | | | acid |
| 4-Hydroxy-3- | 4-Ethoxy-2-methoxyphenol | 4-Hydroxy-2,3- | 3-Hydroxy-1-(4-hydroxy-3- |
| methoxycinnamaldehyde | | dimethylbenzonitrile | methoxyphenyl)propane-1,2- |
| | | | dione |
| 3-Hydroxy-5- | 5- | 4-Hydroxy-3-methoxy-5- | 4-[12-(4-Formyl-2- |
| methoxybenzaldehyde | (Hydroxymethyl)bicyclo[2.2.1]hep- | methylbenzonitrile | hydroxyphenoxy)dodecoxy]- |
| | tane-2,3-diol | | 3-hydroxybenzaldehyde |
| 2-Ethoxy-3- | 2-Ethenoxy-3-fluorophenol | 3-Chloro-4-hydroxy-5- | 4-(11-Bromoundecoxy)-3- |
| methylphenol | | methylbenzonitrile | hydroxybenzaldehyde |
| 2-Methoxy-4-[(1 e)-3- | 2,4-Bis(chloroamino)phenol | 1-(3,5-Dimethoxy-4- | 4-(12-Bromododecoxy)-3- |
| Methoxyprop-1-En-1- | | hydroxyphenyl)-1,2- | hydroxybenzaldehyde |
| Yljphenol | | ethanedithiol | |
| 4-Methoxy-3-(1- | 2-(3-Ethoxy-4- | 1-[2-Hydroxy-5- | (E)-2,3-Bis(4-hydroxy-3- |
| methylprop-2- | hydroxyphenyl)acetaldehyde | (methoxymethyl)phenyl]etha- | methoxyphenyl)prop-2-enal |
| enyloxy)benzaldehyde | | none | |
| 3-[(E)-But-2-enoxy]-4- | 1-Ethoxy-2,4,5-trifluoro-3- | 4-Hydroxy-3- | (Z)-2,3-Bis(4-hydroxy-3- |
| methoxybenzaldehyde | (methoxymethyl)-6- | methoxybenzaldehyde; | methoxyphenyl)prop-2-enal |
| | methylbenzene | propane-1,2-diol | |
| (Z)-3-(4-Hydroxy-3- | 2-Chloro-1-(4-hydroxy-3,5- | 4-Hydroxy-3-[(2- | Methyl 4-hydroxy-3- |
| methoxyphenyl)prop-2- | dimethoxyphenyl)ethanone | methylpropan-2- | (methoxy-d3)benzoate |
| enal | | yl)oxy]benzaldehyde | |
| 3,4-Dimethoxy- | 1-(5-Methoxy-2,4- | 3-Butan-2-yloxy-4- | 3-Formyl-N-methylpyrrolidine- |
| benzaldehyde O-methyl- | dimethylphenyl)ethanone | hydroxybenzaldehyde | 1-carboxamide |
| oxime | | | |
| Dehydrozingerone | 1-(2-Chloro-4-fluoro-5- | 3-(Butan-2-yloxy)-4- | 7-(4-Hydroxy-3- |
| | isocyanatophenyl)-N- | methoxybenzaldehyde | methoxyphenyl)-5-oxohept-6- |
| | methoxymethanimine | | enal |
| 4-Hydroxy-3-methoxy-5- | 4-Ethoxy-2-isocyanatophenol | 2-Hydroxy-5-(hydroxymethyl)- | 3-Fluoro-4- |
| [(E)-prop-1- | | 3-methoxybenzaldehyde | hydroxyphthalaldehyde |
| enyl]benzaldehyde | | | |
| 1-(4-Hydroxy-3- | 2,3-Dioxopiperazine-1- | 4-Hydroxy-3-(hydroxymethyl)- | 5-Hydroxy-4-methoxy-2- |
| methoxyphenyl)-3-(2- | carbaldehyde | 5-methoxybenzaldehyde | sulfanylbenzaldehyde |
| hydroxyphenyl)prop-2- | | | |
| en-1-one | | | |
| 3,3′-Dimethoxy-4,4′- | 4-Hydrazinobenzaldehyde | 1,2-Dihydroxy-3,5- | 3-Ethoxy-4- |
| dihydroxychalcone | | diformylbenzene | hydroxybenzamide |
| 1-Amino-2,4(1H,3H)- | 3-Methyl-4-hydroxyfuran-2- | 4-Hydroxy-3- | 5-(Oxiran-2-yl)-1,6,7,7a- |
| pyrimidinedione | carbaldehyde | methoxybenzaldehyde; 4- | tetrahydro-2,1,3- |
| | | hydroxy-3-methoxybenzoic | benzoxadiazole |
| | | acid | |
| 2,4-Dimethoxy-3- | 3,4- | Vanillylthiol | 3,4- |
| hydroxyacetophenone | Dihydroxybenzaldehyde; ethane | | Dimethoxybenzaldehyde; |
| | | | molecular iodine |
| 2-Amino-1-[(Z)- | 5-Hydroxy-2,3-dihydro-1,4- | (E)-1-(4-Hydroxy-3- | 3-Methoxy-5- |
| ethylideneamino]-5- | benzodioxine-8-carbonitrile | methoxyphenyl)nonadec-10- | methylidenecyclohexane-1- |
| methylpyrrole-3,4- | | ene-1,2-dione | carbonitrile |
| dicarbonitrile | | | |
| 1-(3,4- | Ethanone, 2-bromo-1-(4- | 3-Butoxy-4-hydroxy- | 2,3-Difluoro-4- |
| Dimethoxyphenyl)-3-(3- | hydroxy-3,5-dimethoxyphenyl)- | benzaldehyde | hydrazinylbenzaldehyde |
| hydroxy-4- | | | |
| methoxyphenyl)-2- | | | |
| propene-1-one | | | |
| 2-Propen-1-one, 3-(4- | 1-(Methylamino)-4- | 4-Amino-3,5- | 4,6-Dimethoxy-4H-pyrimidin- |
| hydroxy-3- | sulfanylpyridin-2-one | difluorobenzaldehyde | 3-amine |
| methoxyphenyl)-1- | | | |
| phenyl- | | | |
| (E)-3-(4-Hydroxy-3- | Methyl 4-hydroxy-2,3- | 2-Methoxy-4- | Methyl 3-(1- |
| methoxyphenyl)-1-(4- | dimethoxybenzoate | methylcyclohexa-1,3-dien-1- | chloroethylideneamino)-4- |
| methoxyphenyl)prop-2- | | ol | methylbenzoate |
| en-1-one | | | |
| 3′-Methoxy-4-fluoro-4′- | 4-Aminooxy-3- | 1-Amino-3,4-dimethyl-1,3- | 4-Fluoro-3-methoxy-2- |
| hydroxychalcone | methoxybenzaldehyde | dihydroimidazol-2-one | methylthiobenzaldehyde |
| 3-Hydroxy-6-methyl- | 3-Methoxy-4-prop-1- | 2-Methoxy-4,5- | 4-Acetyl-1-ethylpiperazine- |
| 2(2H)-pyranone | enoxybenzaldehyde | dimethylaniline | 2-one |
| 4-Allyl-2-ethoxyphenol | 3-Ethoxy-4-hydroxy-5- | 4-Amino-2-fluoro-3- | 4-(4-Formyl-2- |
| | methylbenzaldehyde | methoxybenzoic acid | methoxyphenoxy)-2- |
| | | | methylidene-4-oxobutanoic |
| | | | acid |
| O-Geranylvanillin | 4-Hydroxy-3-methoxy-5- | Benzenamine, 4- | 2-Methoxy-2,5- |
| | methylbenzoic acid methyl ester | (ethenylsulfonyl)-2-methoxy- | dihydropyridine-6-carbonitrile |
| | | 5-methyl- | |
| (E)-4-(4-Hydroxy-3- | 2-(2-Isocyanoethenyl)-4- | (4-Formyl-2-hydroxyphenyl) | 2-(2-Propoxyethoxy)ethyl 4- |
| methoxyphenyl)-4-oxo- | methoxyphenol | formate | hydroxy-3-methoxybenzoate |
| 2-butenoic acid | | | |
| 2-Methoxy-3,5- | 1-Ethenyl-3-iodopyrimidine-2,4- | 4-Hydroxy-3-methoxy-5- | 2,4-Dimethoxy-1- |
| dimethylphenol | dione | (trifluoromethyl)benzaldehyde | (nitrosomethyl)benzene |
| 2,4-Xylenol, 6-methoxy- | 4-[Chloro(ethoxy)methyl]-2- | 2,4-Dicyano-6- | (4-Formyl-2- |
| | fluoroaniline | methoxyphenol | methoxyphenoxy)boronic |
| | | | acid |
| 2-Ethoxy-4- | 2-(3-Chloro-2- | 4-Hydroxy-3- | 1-(4-Fluoro-2-hydroxy-5- |
| (methoxymethyl)phenol | methoxyphenyl)acetaldehyde | methoxybenzaldehyde; 2- | methylphenyl)ethanone |
| | | (oxiran-2- | |
| | | ylmethoxymethyl)oxirane | |
| 4,5-Dichloro-2- | N-Methyl-6-oxopyran-2- | 4-Chloro-2- | 4-(Diazenylmethyl)-2- |
| methoxyaniline | carboxamide | (difluoromethoxy)aniline | methoxyphenol |
| 5-Acetylthiophene-3- | 4-(Hydroxymethyl)-2,5- | 4-Hydroxy-3-iodo-5- | 3-Diazenyl-4- |
| carbaldehyde | dimethoxyphenol | methoxybenzonitrile | methylbenzaldehyde |
| 2-Methoxy-3- | 2,3,4-Trimethoxy-6- | 3-Allyl-2-chloro-4- | 3-(1,1-Dihydroxyethoxy)-4- |
| methylbenzaldehyde | methylaniline | hydroxybenzonitrile | methoxybenzaldehyde |
| 4-Methoxy-3-(2- | Methyl 1,2-dihydroquinoxaline- | 4-Ethenylsulfonyl-2- | 2-Methoxy-4- |
| methoxy-ethoxy)- | 6-carboxylate | methoxyaniline | (methoxymethyl)-1- |
| benzaldehyde | | | methylbenzene |
| 3-Methoxy-4-(2- | 5-(4-Hydroxy-3-methoxyphenyl)- | 5-Fluoro-1-benzofuran-6- | Ethane; 4-hydroxy-5-methoxy- |
| methoxyethoxy)benzal- | 3-oxopent-4-enal | carbaldehyde | 2-phenylbenzaldehyde |
| dehyde | | | |
| (5R)-5-Acetyloxolan-2- | 2-Methoxy-5- | 7-Fluoro-benzofuran-4- | 2-Methoxy-5-methyl-3,6- |
| one | (methoxymethyl)phenol | carbaldehyde | dimethylidenecyclohexa-1,4- |
| | | | diene-1,4-diol |
| (5S)-5-Acetyloxolan-2- | 3-Methoxy-4- | [(4-Chloro-3-methoxyphenyl)- | 4-[2-(3-Fluorophenyl)ethoxy]- |
| one | methylthiobenzaldehyde | chlorooxymethyl] hypochlorite | 3-hydroxybenzaldehyde |
| 3′,4′- | Methyl 4-(5-formyl-2- | 3-(2-Hydroxyethoxy)-4- | 3,5-Dimethyl-1- |
| Dimethoxyphenylglyoxal | hydroxyphenoxy)butanoate | methoxybenzaldehyde | nitrosopyrimidine-2,4-dione |
| 4-Hydroxy-3- | 3-Hydroxythiopyran-4-one | 4-Amino-1,2,4-triazin-3-one | 1-Acetyl-2,4-dimethylpyrrole- |
| (trifluoromethoxy)benzal- | | | 3-carbaldehyde |
| dehyde | | | |
| 2-(Difluoromethoxy)-4- | 1-(4-Hydroxy-3-methoxy-5- | (1E,6E)-1,7-Bis(4-hydroxy-3- | (5-Chloro-4- |
| methylaniline | methylphenyl)ethanone | methoxyphenyl)hepta-1,6- | methoxythiophen-3-yl) |
| | | diene-3,5-dione; 4-hydroxy-3- | formate |
| | | methoxybenzaldehyde | |
| 4-Hydroxy-3- | 2-Ethynoxy-4-methylphenol | 4-Hydroxy-3- | 5-Methylidenecyclopenta-1,3- |
| (trifluoromethyl)benzal- | | methoxybenzaldehyde; 2- | diene-1,2-dicarbaldehyde |
| dehyde | | methoxy-4-prop-2-enylphenol | |
| 3-Bromo-4-hydroxy-5- | 1-Ethoxy-3-methoxy-5- | Methyl 4-methyl-3-prop-2- | 3- |
| methoxybenzonitrile | methylbenzene | enoxybenzoate | Methanethioylcyclopentane- |
| | | | 1-carbaldehyde |
| 2-Bromo-5-ethoxy-4- | 4-Amino-3,5- | 2,3,5-Trifluoro-4- | 3-Methyl-2- |
| hydroxybenzonitrile | dimethoxybenzonitrile | hydroxybenzamide | sulfanylideneimidazole-1- |
| | | | carbaldehyde |
| (E)-3-Hydroxy-4- | 5-Hydroxy-4-methoxypyridine-2- | 4-Hydroxy-3- | 4-(Hydroxymethoxy)-3- |
| methoxychalcone | carbaldehyde | methylbenzamide | methoxybenzaldehyde |
| Benzaldehyde, 3- | (5-Formyl-2-hydroxyphenyl) | Acetoxy vanillin | 2-(3-Ethenyl-2- |
| (chloromethyl)-4- | hydrogen carbonate | | oxoimidazolidin-1- |
| hydroxy- | | | yl)acetaldehyde |
| 4-(Difluoromethyl)-3- | 2-Chloro-6-methylcyclohexene- | 4-Amino-3- | 2-Bromo-4-(diazenylmethyl)- |
| methoxybenzaldehyde | 1,3-dicarbaldehyde | ethyl benzaldehyde | 6-ethoxyphenol |
| 5-Ethyl-2-hydroxy-3- | 3-(4-Hydroxy-3- | 4-Amino-3- | 4-Hydroxy-3- |
| methoxybenzaldehyde | methoxyphenyl)prop-2-enoyl | methoxybenzaldehyde | (nitrosomethoxy)benzaldehyde |
| | chloride | | |
| 2-Hydroxy-5-methoxy-4- | 1-(4-Amino-3-methoxy-5- | 4-Ethyl-2,3-dioxopiperazine- | (3-Hydroxy-4- |
| methylbenzaldehyde | methylphenyl)ethanone | 1-carbaldehyde | methoxyphenyl)- |
| | | | oxomethanesulfinate |
| 2-Hydroxy-3,5- | 1-Ethylsulfinyl-3- | 2-Chloro-1-(4-hydroxy-2,5- | (3- |
| dimethoxy-4- | methoxybenzene | dimethoxyphenyl)ethanone | (113C)Methoxyphenyl)meth- |
| methylbenzaldehyde | | | anol |
| 2-Hydroxy-5-methoxy-3- | 5-Chloro-3,4-dimethyl-2- | 1-Hydroxy-6-oxopyridine-2- | 3-Hydroxy-2-methoxy-6-prop- |
| methylbenzaldehyde | (trifluoromethoxy)aniline | carboxamide | 1-enylbenzaldehyde |
| 2-Hydroxy-3-methoxy-5- | 6-(4-Hydroxy-3-methoxyphenyl)- | Cyclopentene-1,3- | 2,4-Dimethoxy-1- |
| methylbenzaldehyde | 2,4-dioxohex-5-enal | dicarbaldehyde | methylidenecyclohexane |
| (E)-3-(3-Fluorophenyl)- | 2,4-Dimethoxy-1- | 2-Methoxy-3,5,6- | 5-Methoxy-4-oxocyclohex-2- |
| 1-(4-hydroxy-3- | methylcyclohexane | trimethylbenzene-1,4-diol | ene-1-carbaldehyde |
| methoxyphenyl)prop-2- | | | |
| en-1-one | | | |
| 3-Ethoxy-4- | 2-Ethoxy-3,4,5,6- | (3-Fluorosulfanyl-4- | 2,4-Diethoxybenzene-1,3-diol |
| pentyloxybenzaldehyde | tetrafluoroaniline | hydroxyphenyl) | |
| | | thiohypofluorite | |
| (E)-3-(3-Hydroxy-4- | 3-Hydroxyoxane-2,6-dione | 3-Acetylimidazolidine-1- | (5-Formyl-2-hydroxyphenyl) |
| methoxyphenyl)-1-(4- | | carbaldehyde | methyl carbonate |
| methoxyphenyl)prop-2- | | | |
| en-1-one | | | |
| 4-Amino-2- | 1-Methyl-3-bromouracil | 5-Acetyl-2- | 3-Acetyl-4-hydroxybenzamide |
| methylbenzonitrile | | hydroxybenzonitrile | |
| 3-Ethoxy-4-hydroxy-5- | Copper; 4-hydroxy-3- | 3-Hydroxy-4-methoxy-2- | 4-But-2-en-2-yloxy-3- |
| iodobenzoic acid | methoxybenzoic acid | propylbenzaldehyde | ethoxybenzaldehyde |
| (E)-1-(4-Hydroxy-3- | 4-Hydroxy-5-oxocyclohexa-1,3- | 1-Amino-1,3-diazinan-2-one | 4-But-2-en-2-yloxy-3- |
| methoxyphenyl)-3-(4- | diene-1-carboxylic acid | | methoxybenzaldehyde |
| methylphenyl)prop-2-en- | | | |
| 1-one | | | |
| 3-Methoxy- | 3-Hydroxyfuran-2,5-dione | 5,6-Dioxocyclohexa-1,3- | 6-(4-Formyl-2- |
| benzaldehyde oxime | | diene-1-carbonitrile | methoxyphenoxy)-2- |
| | | | methylidene-6-oxohexanoic |
| | | | acid |
| 2,4-Diacetyl-5,6- | 4,5-Dihydroxy-6-oxopyran-2- | Benzene, 1-isocyanato-3- | Methyl 3-(4-hydroxy-3- |
| dimethylphenol | carboxylic acid | (methylsulfinyl)- | methoxyphenyl)-3- |
| | | | oxopropanoate |
| 3-Hydroxy-1-(4-hydroxy- | 2-Chloro-1-methoxy-4- | 6-Amino-4-methyl-3-methoxy- | 3-Oxocyclopentane-1- |
| 3- | (methoxymethyl)benzene | 1,2,4-triazin-5-one | carboxamide |
| methoxyphenyl)dodecan- | | | |
| 1-one | | | |
| 6-Hydroxy-5-methoxy-1- | 2,3-Dihydroxy-6-hydroxymethyl- | Ethyl 2-(5-formyl-2- | 3-Ethoxy-4-pent-2-en-3- |
| benzothiophen-3-one | pyran-4-one | hydroxyphenoxy)propanoate | yloxybenzaldehyde |
| 4-Hydroxy-3-(4- | 3-Hydroxy-2-oxo-2H-pyran-6- | Ethyl 2-(5-formyl-2- | 2,3-Bis(4-hydroxy-3- |
| methylphenoxy)benzal- | carboxylic acid | hydroxyphenoxy)acetate | methoxyphenyl)prop-2-enal |
| dehyde | | | |
| 3-(3-Hydroxy-4- | Benzaldehyde, 3-(2- | 4-N-Ethoxy-4-N-ethyl-2- | 2,3,5-Trideuterio-4-ethyl-6- |
| methoxyphenyl)- | fluoroethoxy)-4-methoxy- | methoxybenzene-1,4-diamine | methoxyphenol |
| propionaldehyde | | | |
| 3-Hydroxy-4- | 2,3-Difluoro-4- | 4-Methyl-1-benzofuran-7-ol | 2-(Diazenylmethyl)-4- |
| phenoxybenzaldehyde | hydrazinylbenzonitrile | | methoxyphenol |
| 3-Hydroxy-4- | 4-Chloro-3-ethoxybenzaldehyde | 4-Amino-3- | Vanilloylacetic acid |
| methoxycinnamaldehyde | | methoxybenzenethiol | |
| 2,4-Diacetyl-5- | 4-Methoxy-3-methyl-pyridine-2- | 4-Acetyl-1-methyl-3H-azepin- | 2-[4- |
| methylphenol | carbaldehyde | 2-one | (Fluoromethoxy)phenyl]acetal- |
| | | | dehyde |
| Ascopyrone M | 1-(3-Ethoxy-4- | 4-(Dimethoxymethyl)-2- | 3-Methoxy-4- |
| | hydroxyphenyl)propan-2-one | ethoxyphenol | methylcyclohepta-1,3,5- |
| | | | triene-1-carbaldehyde |
| 1-Hydroxy-6- | 1-(Isocyanomethyl)-2,4- | 5-(Methoxymethyl)-2,4- | 1-(1-Acetyl-4-iminopiperidin- |
| methoxypyridine-2- | dimethoxybenzene | dimethylbenzaldehyde | 3-yl)ethanone |
| thione | | | |
| 2-Cyclohexen-1-one, 2- | (2,4,5-Trifluoro-3- | (5-Formyl-2-hydroxyphenyl) | 3-Methoxy-4- |
| methyl-5-(2- | methoxyphenyl)methanol | formate | methylidenecyclohexane-1- |
| methyloxiranyl)- | | | carbonitrile |
| 6-Amino-4- | 3-Fluoro-4-hydroxy-5- | 4-Hydroxy-3- | (4-Hydroxy-3- |
| methylnicotinonitrile | methoxybenzoic acid | methoxybenzaldehyde | methoxyphenyl)- |
| | | | oxomethanesulfinate |
| 4-Amino-3,5- | 5-(Hydroxymethyl)-3- | 1-(Dichloromethyl)-2,4- | 3-(4-Hydroxybenzyl)-4- |
| dimethylbenzaldehyde | methoxybenzene-1,2-diol | dimethoxybenzene | hydroxy-5- |
| | | | methoxybenzaldehyde |
| 1-(3-Amino-4-hydroxy-5- | 2,6-Dimethoxy-N-methylpyridin- | 4-Methylthiophene-2,3- | 5-(Methoxymethyl)-3- |
| methoxyphenyl)ethanone | 3-amine | dicarbaldehyde | methylthiophene-2- |
| | | | carbaldehyde |
| 4-(3-Hydroxypropoxy)-3- | 1-(2-Amino-4-hydroxy-3- | 4-Amino-1,2,4-triazine-5(4H)- | 1-(2-Sulfanylidene-3H- |
| methoxybenzaldehyde | methoxyphenyl)ethanone | one | thiophen-5-yl)ethanone |
| 6-Acetyl-3-methyl-2H- | (2-Fluoro-3-methoxy-5- | 2-(Aminooxymethyl)-5- | 3-Ethoxy-5-fluorobenzyl |
| pyran-2-one | methylphenyl)methanol | hydroxypyran-4-one | alcohol |
| 3-Methoxy-4- | 4-Cyano-2-methoxybenzene-1- | 2-[(Aminooxy)methyl]-5- | 3-Ethoxy-5- |
| methylsalicylaldehyde | sulfonyl chloride | hydroxy-3-methyl-4(3H)- | fluorobenzaldehyde |
| | | pyrimidinone | |
| 2,3-Dimethoxy-4- | Methyl 4-hydrazinyl-3- | 1,3-Thiazolidine-2,5-dithione | 1-(4-Hydroxy-3-methoxy-2- |
| methylbenzaldehyde | methoxybenzoate | | methylphenyl)propan-1-one |
| 1-(2-Fluoro-3,4- | 2-Thiophenecarbonitrile, 4- | 3,4-Dipentoxybenzaldehyde | 3-Ethoxy-1-(4-hydroxy-3- |
| dimethoxyphenyl)ethanone | hydrazinyl- | | methoxy-phenyl)-propan-1- |
| | | | one |
| 1-(3,5-Dimethoxy-4- | 1-Hydroxy-4- | 4-Hydroxy-2,5- | 3-Hydroxy-2-methoxy-5- |
| hydroxyphenyl)-1- | methylbicyclo[2.2.2]octan-2-one | dimethylbenzene-1,3- | methylbenzaldehyde |
| propanol | | dicarbaldehyde | |
| 4-Iodo-2-methoxyphenol | 2-[(3S)-3-Amino-2-oxopyrrolidin- | 3-Ethoxy-6-hydroxy-2,4,5- | 4-Hydroxy-3-[(4-hydroxy-3- |
| | 1-yl]acetaldehyde | trimethylbenzaldehyde | methylphenyl)methyl]-5- |
| | | | methoxybenzaldehyde |
| 1-(3-Methoxy-4- | 4-Amino-2,5- | 4-Amino-5-methoxy-2- | 4-[5-(4-Formyl-2- |
| methylphenyl)ethanone | dimethylbenzaldehyde | methylbenzenesulfonyl | hydroxyphenoxy)pentoxy]-3- |
| | | chloride | hydroxybenzaldehyde |
| 2,4-Diacetyl-3- | 4-Amino-2-fluorobenzaldehyde | 3-Fluoro-4-hydroxy-5- | 4-(5-Bromopentoxy)-3- |
| methylphenol | | methoxybenzonitrile | hydroxybenzaldehyde |
| 4-Ethoxy-2- | (2R)-2-Aminocyclohexan-1-one | 1-Amino-1,3,5-triazin-2-one | 3-Hydroxy-4-methoxy-5- |
| fluorobenzaldehyde | | | (trifluoromethyl)benzaldehyde |
| (3S)-3-Hydroxyoxan-2- | 2-Methoxy-4-(oxiran-2- | 4-(Diethylamino)-2- | 4-Hydroxy-3-[2-[(3R)-3- |
| one | yl)benzonitrile | methoxyphenol | hydroxy-3- |
| | | | methylpentoxy]ethoxy]benzal- |
| | | | dehyde |
| 5-Acetyl-2,N- | 4-Methoxy-5-methyl-indan-1- | 3-Sulfanylidene-4-thia-1- | 4-Hydroxy-3-[2-(3-hydroxy-3- |
| dihydroxybenzamide | one | azabicyclo[3.2.0]heptan-7- | methylpentoxy)ethoxy]benzal- |
| | | one | dehyde |
| 3,5-Difluoro-4- | 4-Chloro-5-hydroxy-2,3- | 4-Methyl-2,3-dioxopiperazine- | 3-Butan-2-yl-4-hydroxy-5- |
| hydroxybenzaldehyde | dihydroinden-1-one | 1-carbaldehyde | methoxybenzaldehyde |
| 4-Hydroxy-3- | 4-Pyridinecarbonitrile, 3-fluoro- | 4-Amino-3,5- | 2-[(2-Formyl-5-hydroxy-4- |
| phenoxybenzaldehyde | 1,2-dihydro-2-oxo- | dimethoxybenzaldehyde | methoxyphenyl)methyl]-4- |
| | | | hydroxy-5- |
| | | | methoxybenzaldehyde |
| 2-Methyl-3,5- | Methyl 5,6-dihydroxypicolinate | 5-Methoxy-4-oxocyclohexa- | 1-(4-Hydroxy-3-propan-2- |
| dimethoxybenzaldehyde | | 1,5-diene-1-carbaldehyde | yloxyphenyl)ethanone |
| 2-Methoxy-4- | 4-[(E)-But-2-enyl]-2- | Pycnarrhine | 1-[4-Hydroxy-3-(2- |
| (trifluoromethyl)phenol | methoxyphenol | | methylpropoxy)phenyl]ethanone |
| 1-(4-Hydroxy-3- | 2,4-Difluoro-3-formylbenzamide | 2-(Chloroacetyl)-5- | 3-Hydroxy-4-(3- |
| methoxyphenyl)-butane- | | hydroxypyridin-4(1H)-one | phosphanylidyneprop-1- |
| 1,3-dione | | | ynoxy)benzaldehyde |
| 5-Hydroxy-4- | 4-(1,1-Dimethoxyethyl)-2- | 4-N-Ethoxy-2- | 4-(Fluoromethoxy)-3- |
| methylpicolinaldehyde | methoxyphenol | methoxybenzene-1,4-diamine | hydroxybenzaldehyde |
| 4-Hydroxy-2,3,5- | 3-Hydroxy-4-methoxy-2,3- | 7-Methyl-5-nitrosoquinolin-8- | (4-Formyl-2-methoxyphenyl) |
| trimethoxybenzaldehyde | dihydropyran-6-one | ol | hydrogen sulfate; methanol |
| 4-Bromo-2- | 3- | 6-Methyl-5-nitrosoquinolin-8- | 1-(3-Ethoxy-4- |
| (cyclopropylmethoxy)phe- | (Trifluoromethoxy)benzaldehyde | ol | hydroxyphenyl)-2,2- |
| nol | oxime | | dimethylpropan-1-one |
| (2,4- | 3,4- | 4-Chloro-2-(difluoromethoxy)- | 1-(3-Ethoxy-4- |
| Dimethoxyphenyl)hydra- | Bis(trideuteriomethoxy)benzal- | 3-fluoroaniline | hydroxyphenyl)-3- |
| zine | dehyde | | methylbutan-1-one |
| 5-Thioxo-5H- | Methyl 5-hydroxy-6- | 4-Methoxy-3-(2- | 1-(3-Ethoxy-4- |
| [1,2]dithiole-3-carboxylic | methoxypicolinate | methylbutoxy)benzaldehyde | hydroxyphenyl)pentan-1-one |
| acid amide | | | |
| 1,3-Dimethyl-6-(oxiran- | 5-Fluoro-2,4-dimethoxyphenol | 4-(2-Ethylhexoxy)-3- | 1-(3-Ethoxy-4- |
| 2-yl)pyrimidine-2,4- | | hydroxybenzaldehyde | hydroxyphenyl)-2- |
| dione | | | methylpropan-1-one |
| 3-Hydroxy-4-(3-methyl- | 4-Fluoro-2,5-dimethoxyphenol | 6-Hydroxy-2,3- | 1-(3-Ethoxy-4- |
| 2- | | dimethylbenzaldehyde | hydroxyphenyl)-2- |
| butenyloxy)benzaldehyde | | | methylbutan-1-one |
| 6-Hydroxy-2- | (4-Formyl-2-hydroxyphenyl) 3- | 3-(Dichloromethoxy)-4- | 1-(3-Hydroxy-4- |
| cyclohexen-1-one | (4-hydroxy-3- | hydroxybenzaldehyde | methoxyphenyl)prop-2-yn-1- |
| | methoxyphenyl)prop-2-enoate | | one |
| 4,6-Diacetyl-o-cresol | 1-Amino-6-methyl-4- | 3,5-Diethoxy-4- | 4-Hydroxy-3-[2-[2-[2-[2-[2-[2- |
| | sulfanylidenepyrimidin-2-one | hydroxybenzoic acid | [2-(2,2,2- |
| | | | trifluoroethoxy)ethoxy]ethoxy] |
| | | | ethoxy]ethoxy]ethoxy]ethoxy] |
| | | | ethoxy]benzaldehyde |
| 3-Methoxy-5-methyl- | 2-(5-Acetyl-2-hydroxy-3- | 4-(Methoxymethyl)thiophene- | 1-(4-Hydroxy-3- |
| 5,6,7,8- | methoxyphenyl)acetaldehyde | 2-carbaldehyde | methoxyphenyl)pentane-1,4- |
| tetrahydronaphthalen-2- | | | dione |
| ol | | | |
| 1-Ethyl-3- | 3-Isothiocyanato-2- | 4,5-Difluoro-2-methoxyaniline | 4-Hydroxy-3-methoxybenzoic |
| hydroxypyridin-2(1H)- | methylbenzaldehyde | | acid; hydrate |
| one | | | |
| 1,3-Dihydroxy-1H-1,3- | 1-(3-Fluoro-4-hydroxy-5-prop-2- | 3-Chloro-4-ethoxy-5- | (4-Formyl-2-methoxyphenyl) |
| diazepine-2,4(3H,7H)- | enylphenyl)ethanone | fluorobenzaldehyde | hypoiodite |
| dione | | | |
| Phenol, 4- | 4-Oxopyridine-1-carboxamide | 3,5-Difluoro-2-methoxyaniline | 2-Formyl-4,5- |
| [(dimethylamino)methyl]- | | | dimethoxycinnamaldehyde |
| 2-methoxy- | | | |
| Phenol, 4- | 2-(Methylamino)-3H-isoindol-1- | 4-Hydroxy-3- | 2-Methoxy-6-methyl-4- |
| [(dimethylamino)methyl]- | one | sulfanylbenzaldehyde | propionyl-phenol |
| 2-methoxy-6-methyl- | | | |
| 4-Amino-3- | 2,4-Diisocyanato-1- | 4-Acetamido-3- | 1,1′-Biphenyl; 4-hydroxy-3- |
| methylbenzaldehyde | methylcyclohexene | methoxybenzoic acid | methoxybenzaldehyde |
| 2-(3,4- | 4-Methoxy-3-(4-methoxy-3- | 2-Amino-4-cyanopyrazole | 4-Hydroxy-3-(2- |
| Dimethoxyphenyl)oxirane | methylbut-1- | | oxoethoxy)benzaldehyde |
| | enoxy)benzaldehyde | | |
| 6-Chloro-3-ethoxy-2- | (2-Methoxycyclohexyl) formate | 2-Ethoxy-4-nitrosophenol | (E)-3-(2,6- |
| fluoro-benzaldehyde | | | Dihydroxycyclohexa-2,4-dien- |
| | | | 1-yl)-1-(3-hydroxy-4- |
| | | | methoxyphenyl)prop-2-en-1- |
| | | | one |
| 2-Cyclohexen-1-one, 2- | 2-(Hydrazinylmethyl)cyclohexa- | 2,1-Benzisothiazole-6- | (2R)-1-(3-Hydroxy-4- |
| methyl-5-(2- | 2,5-diene-1,4-dione | carboxaldehyde | methoxyphenyl)-2- |
| methyloxiranyl)-, (5R)- | | | methylbutan-1-one |
| 3,4-Dimethoxy-2,6- | 4-Hydroxy-2-sulfanylidene-1,3- | 2,3,5,6-Tetrafluoro-4- | 3-Ethoxy-4- |
| dimethylbenzaldehyde | thiazole-3-carbaldehyde | hydroxybenzaldehyde | hydroxybenzaldehyde; 2- |
| | | | methyl-1-phenylpropan-2-ol |
| 3-Hydroxy-6- | 1-(4-Hydroxy-3-methoxy-5-prop- | 8-Hydroxyquinoline-5- | 3-Hydroxy-4- |
| (methoxymethyl)-4h- | 1-enylphenyl)ethanone | carbonitrile | methylperoxybenzaldehyde |
| pyran-4-one | | | |
| 3-Fluoro-2,4- | 3-Methoxy-4- | 2-Methoxy-5- | 4-Prop-2-enoyloxybutyl 4- |
| dimethoxyaniline | (sulfanylmethyl)benzaldehyde | methylcyclohexa-2,5-diene- | hydroxy-3-methoxybenzoate |
| | | 1,4-diimine | |
| 3-Acetyl-5-chloro-4- | 1-[2,4-Dihydroxy-5- | 6-(Hydroxymethyl)-4- | 1-(3-Hydroxy-4- |
| hydroxybenzoic acid | (methoxymethyl)phenyl]ethanone | methylpyran-2-one | methoxyphenyl)but-2-en-1- |
| | | | one |
| 4-Ethynyl-3- | 2-(3-Methyl-2-oxoimidazolidin-1- | 1-[3-(Difluoromethoxy)-4- | 4-Hydroxy-3-propoxybenzoic |
| methoxybenzaldehyde | yl)acetaldehyde | methoxyphenyl]ethanone | acid |
| 2,3,5-Trifluoro-4,6- | 1-(4-Hydroxy-3-methoxyphenyl)- | 1-(Chloromethyl)-4-methoxy- | Deuterio-(2-deuterio-4- |
| dimethoxyaniline | 5-(3-hydroxyprop-1- | 2,3,5,6-tetramethylbenzene | deuteriooxy-3- |
| | enoxy)pentan-1-one | | methoxyphenyl)methanone |
| 3-Hydroxy-6- | (4-Formyl-2-methoxyphenyl) | 1-(Chloromethyl)-4-methoxy- | 3-Hydroxy-4-methoxy-5-(2- |
| methyloxan-2-one | ethaneperoxoate | 2,3,5-trimethylbenzene | methylbutyl)benzaldehyde |
| 3-Methyl-2-thioxo- | (3-Methoxycyclohexyl) formate | 3-Amino-1,3-thiazinane-2,4- | 4-Deuteriooxy-3- |
| 2,3,6,7-tetrahydro-1,3- | | dione | methoxybenzaldehyde |
| thiazepine-4(5H)-one | | | |
| Methyl 5-cyano-2- | 3-Methoxy-4-oxocyclohex-2- | 5-Hydroxy-6-methoxy-3H-1- | (5-Formyl-2-hydroxyphenyl) |
| hydroxybenzoate | ene-1-carbaldehyde | benzofuran-2-one | carbamate |
| Methyl 4- | Deuterio-(2- | 4-Hydroxy-3- | 2-(4-Formyl-2- |
| (hydroxymethyl)-3- | methoxyphenyl)methanone | methoxybenzenesulfonyl | hydroxyphenoxy)acetic acid |
| methoxybenzoate | | chloride | |
| 4-Bromo-2-methoxy-3- | (2R)-2,3-Dimethylpyrrolidine-1- | 4-(3,4-Dimethoxyphenyl)-4- | 4-Hydroxy-3-methoxybenzoic |
| methylphenol | carboxamide | oxobutanal | acid; hydrochloride |
| 2- | 3-Acetyl-4-iminocyclohexa-2,5- | 2-(1-Fluoroethoxy)phenol | 4-Ethenoxy-3- |
| Methoxyterephthalaldehyde | dien-1-one | | methoxybenzaldehyde |
| 2,4-Difluoro-3- | 5-Oxo-1,2-dihydropyrrole-3- | 2-Amino-5-methoxy-2,4,6- | 4-Hydroxy-3- |
| formylbenzonitrile | carboxamide | cycloheptatrien-1-one | methoxybenzaldehyde; 2- |
| | | | methylpropan-1-ol |
| Ethanone, 1-(4-ethoxy- | 2,2-Dihydroxy-3-(4-hydroxy-3- | 3,4,5-Trichloro-2- | 2-Hydroxy-3-methoxy-5-[(Z)- |
| 3-methoxyphenyl)- | methoxyphenyl)-3-oxopropanal | ethoxyphenol | 1-oxobut-2-en-2- |
| | | | yl]benzaldehyde |
| 3-Bromo-5- | 3-Fluoro-4-hydroxy-5-propan-2- | 3,4-Dichloro-2-ethoxyphenol | (2E,4E)-1-(3-Hydroxy-4- |
| methoxybenzaldehyde | yloxybenzaldehyde | | methoxyphenyl)-5-(4- |
| | | | methoxyphenyl)penta-2,4- |
| | | | dien-1-one |
| 3-Fluoro-5- | 3,4-Bis(pent-2-en-3- | 2-Amino-4- | 3,4-Bis[(2-methylpropan-2- |
| methoxybenzonitrile | yloxy)benzaldehyde | methoxypyrimidine-5- | yl)oxy]benzaldehyde |
| | | carbaldehyde | |
| Methyl 4-formyl-3- | 5-Acetyl-4-methylthiophene-3- | 7-Oxabicyclo[4.2.0]octa- | 2-Hydroxy-3-methoxy-5- |
| methoxybenzoate | carbonitrile | 1(6),2,4-triene-4-carbonitrile | [(3E)-penta-1,3-dien-3- |
| | | | yl]benzaldehyde |
| 4-Methoxy-6- | (5-Formyl-2-methoxyphenyl) | 4-Hydroxy-3- | 4-Hydroxy-3-methoxy-2- |
| methyloxan-2-one | sulfite | methoxybenzaldehyde; 2- | sulfanylbenzaldehyde |
| | | methylpropanoyl 2- | |
| | | methylpropanoate | |
| 2-Formyl-4- | 3,4,5-Trifluoro-2-methoxyphenol | 3,4-Dichloro-2- | Benzoylvanillin |
| (hydroxyimino)-2,5- | | methoxyaniline | |
| cyclohexadien-1-one | | | |
| 5-Formyl-2- | Pyrrole-1,3-dicarbaldehyde | 3,4,5-Trichloro-2- | Sulfovanillin |
| hydroxybenzamide | | methoxyaniline | |
| 4-Chloro-3- | 1-(3-Methoxy-4-prop-1- | 5-Amino-2-ethylsulfinyl-1H- | Deuteroveratrumaldehyd |
| methoxybenzonitrile | enoxyphenyl)ethanone | pyrimidin-6-one | |
| 3-Methoxy-4,4′- | 3-Ethoxy-4- | 5-Amino-2-methylsulfinyl-1H- | 1-(4-Hydroxy-3-iodo-5- |
| dihydroxychalcone | hydroxybenzaldehyde; 2- | pyrimidin-6-one | methoxyphenyl)propane-1,2- |
| | methylpropanoic acid | | dione |
| Deuterio-(2,3,5,6- | 2-Methoxy-6-methyl-4-prop-1- | 2-(Bromomethyl)-3- | 4-Hydroxy-3-[2-(4-hydroxy-4- |
| tetradeuterio-4- | enylphenol | methoxybenzonitrile | methoxycyclohexa-1,5-dien- |
| methoxyphenyl)methanone | | | 1-yl)ethenyl]-5- |
| | | | methoxybenzaldehyde |
| 3,5-Difluoro-2,4- | Methyl 2-fluoro-3- | 2-Formyl-6- | Phosphovanilline |
| dimethoxyaniline | formylbenzoate | methoxybenzonitrile | |
| 2,6-Dimethoxy-4- | 2-Methoxy-4- | 4-Hydroxycyclohexa-2,4- | (4-Hydroxy-3- |
| nitrophenol | (sulfanylmethyl)phenol | diene-1-thione | methoxyphenyl)- |
| | | | trimethylsilylmethanone |
| 1-(4-(Benzyloxy)-3- | 4-Hydroxy-3-methoxy-5-(3- | 5-Hydroxy-1,3-thiazole-2,4- | 4-Hydroxy-3- |
| hydroxyphenyl)ethanone | methylbut-2-enyl)benzaldehyde | dicarbonitrile | (trichloromethoxy)benzaldehyde |
| Deuterio-(2,3,5,6- | 3-Chloro-2,4- | 2-Methoxy-3- | 6-Acetyl-2-hydroxy-3- |
| tetradeuterio-4- | dimethoxybenzamide | sulfanylbenzaldehyde | methoxybenzeneselenonic |
| hydroxyphenyl)methanone | | | acid |
| 2-Fluoro-3- | 3-Methoxy-4-pent-1-en-3- | Benzaldehyde; 4-hydroxy-3- | 4-Hydroxy-3-methyl-5- |
| methoxybenzonitrile | yloxybenzaldehyde | methoxybenzaldehyde | phenylmethoxybenzaldehyde |
| 2-Methoxy-4-(3- | 3-Methoxy-4-oxocyclohexa-1,5- | 2-Butoxy-4-nitrophenol | Iodoisovanillin |
| methyloxiranyl)phenol | diene-1-carbaldehyde | | |
| Benzenemethanethiol, | 4-Bromo-2-fluoro-5- | 2,5-Dimethoxy-4-nitrophenol | Bromoisovanillin |
| 2,4-dimethoxy- | methoxybenzaldehyde | | |
| 4(3H)-Quinazolinone, 2- | (1S,5R)-1,3-Dimethyl-3- | 2-Methoxy-6-methyl-4- | 2-(3-Hydroxy-4- |
| methyl-3-(methylamino)- | azabicyclo[3.2.1]octane-2,4- | nitrophenol | methoxyphenyl)-2- |
| | dione | | oxoacetaldehyde |
| Bromcreosol | 7-Amino-2-methylcycloheptane- | 2-Ethoxy-4-(2-methylprop-1- | 1-(3,4-Dimethoxyphenyl)-2- |
| | 1,4-dione | enyl)phenol | (3-hydroxy-4- |
| | | | methoxyphenyl)ethanone |
| 3-Amino-2,4-dimethoxy- | 1-[2-Hydroxy-5- | 4-(Chloromethyl)-1,3- | 1-(3,4-Dimethoxyphenyl)-2- |
| 6-methylpyridine | (methoxymethyl)-3- | dimethoxy-2,5- | (4-hydroxy-3- |
| | methylphenyl]ethanone | dimethylbenzene | methoxyphenyl)ethanone |
| 6-Hydroxy-2,3-dihydro- | 2-Fluoro-4-hydroxy-3- | 4-lmino-3-methoxycyclohexa- | Methyl 3-(4-formyl-2- |
| 1H-indolizin-5-one | phenylmethoxybenzaldehyde | 2,5-dien-1-one | methoxyphenoxy)prop-2- |
| | | | enoate |
| 3,5-Difluoro-4- | 3-Fluoro-4-hydroxy-5- | 1-Acetyl-4-methoxycarbonyl- | Geranylvanillin |
| hydroxybenzonitrile | phenylmethoxybenzaldehyde | imidazole | |
| 4-Hydroxy-3- | 2,3,6-Trideuterio-4,5- | Acetic acid; 4-hydroxy-3- | Geranylacetovanillone |
| methoxybenzaldehyde- | dimethoxybenzaldehyde | methoxybenzaldehyde | |
| d3 | | | |
| 3-Hydroxy-4-methoxy-5- | 3-Methoxy-4- | Methyl 3-ethoxy-4- | Prenylacetovanillone |
| methylbenzaldehyde | (trideuteriomethoxy)benzaldehyde | methylbenzoate | |
| 5-Fluoro-2,4- | 2,3,6-Trideuterio-4,5- | 3-Amino-4-ethoxybenzamide | (E)-1,7-Bis(4-hydroxy-3- |
| dimethoxyaniline | bis(trideuteriomethoxy)benzal- | | methoxyphenyl)hept-3-ene- |
| | dehyde | | 1,6-dione |
| 3-Fluoro-5- | 1-Chloro-4-(chloromethyl)-2- | 5-Chloro-2,4- | 1-(4-Hydroxy-3- |
| methoxybenzaldehyde | methoxybenzene | dimethoxybenzenediazonium | methoxyphenyl)heptadecan- |
| | | | 1-one |
| 3- | 2,6-Dideuterio-4-hydroxy-3,5- | 4-Amino-3-methoxy-N- | 1-(4-Hydroxy-3- |
| (Methoxymethyl)benzonitrile | bis(trideuteriomethyl)benzonitrile | methylbenzamide | methoxyphenyl)-4- |
| | | | methylpentan-1-one |
| 2-Chloro-3-ethoxy-6- | 5-Bromo-4-hydroxy-3-methoxy- | 4-Methoxypyridine-2- | 1-(3-Hydroxy-4- |
| fluorobenzaldehyde | 2-methylbenzaldehyde | carbothialdehyde | methoxyphenyl)-4- |
| | | | methylpentan-1-one |
| 3,5-Dichloro-2,4- | 1-(Ethenyloxy)-3- | 1,3-Dimethylpiperidine-2,6- | 1-(4-Hydroxy-3- |
| dimethoxy-6- | methoxybenzene | dione | methoxyphenyl)nonan-1-one |
| methylphenol | | | |
| 5-Acetyl-2- | 4-[(Chloroamino)methyl]-2- | 5-Chloro-3-fluoro-5- | 1-(4-Hydroxy-3- |
| aminobenzonitrile | methoxy-5-methylphenol | methoxycyclohexa-1,3-diene- | methoxyphenyl)icosan-1-one |
| | | 1-carbaldehyde | |
| Benzaldehyde, 2- | Methyl 4-ethyl-3- | 4-Chloro-N-ethyl-2- | 1,6-Bis(4-hydroxy-3- |
| hydroxy-3-methoxy-6- | methoxybenzoate | methoxyaniline | methoxyphenyl)hexane-1,6- |
| methyl- | | | dione |
| 1-(4-Hydroxy-3- | 3-Deuteriooxy-4- | 2-(4-Chloro-3- | 3-Ethynyl-4-hydroxy-5- |
| methoxyphenyl)-2-(4- | methylbenzaldehyde | methoxyphenyl)acetonitrile | methoxybenzaldehyde |
| methoxyphenyl)ethanone | | | |
| 1-(4-Hydroxy-3- | Deuterio-(4- | 2-Ethoxy-3,4-dimethylphenol | 3-Hydroxy-1-(3-hydroxy-4- |
| methoxyphenyl)-5- | hydroxyphenyl)methanone | | methoxyphenyl)propan-1-one |
| phenylpentan-1-one | | | |
| 2,3,5-Trimethyl-4- | 1-(2,4,5-Trifluoro-3-methoxy-6- | 3,5-Dichloro-2,4- | 3-Methoxy-4-prop-2- |
| hydroxybenzaldehyde | methylphenyl)ethanone | dihydroxybenzaldehyde | enylperoxybenzaldehyde |
| 1-Isopropenyl-2,4- | Benzaldehyde, 5-methoxy-2,4- | 4-Hydroxy-3- | 4-Hydroxy-3- |
| dimethoxybenzene | dimethyl- | methoxyphthalaldehyde | methoxybenzaldehyde; sulfane |
| (4-Chloro-3- | [3,4- | 2,4-Diisocyanatophenol | 2-(3,4-Dimethoxyphenyl)-4- |
| methoxyphenyl)methanol | Bis(trideuteriomethoxy)phenyl]- | | hydroxybenzaldehyde |
| | deuteriomethanone | | |
| 4-Amino-3- | 2,4-Difluoro-5- | 1-Formyl-4-methyl-3- | 3-Ethoxy-4- |
| bromobenzaldehyde | methoxybenzaldehyde | oxopiperazine | hydroxybenzaldehyde; 4- |
| | | | hydroxybenzaldehyde; oxirane |
| 2,3,5-Trimethoxy-4- | 3-Chloro-5-ethoxy-2- | 2-Ethoxy-3,6-dimethylphenol | 4-Hydroxy-3- |
| methylbenzaldehyde | methylbenzonitrile | | methoxybenzaldehyde; potassium |
| 4-Hydroxy-3- | 4-Methoxy-5- | 3,5-Dimethoxy-4- | 4-Ethoxy-2-ethyl-3- |
| methoxycyclohexane-1- | methylpicolinaldehyde | hydroxyphenyl glyoxal | hydroxybenzaldehyde |
| carbaldehyde | | | |
| 2,5-Difluoro-4- | 4-Methoxy-D3-benzaldehyde | 4-Ethylsulfinyl-2- | 1-[4-Hydroxy-3-(2- |
| hydrazinylbenzonitrile | | methoxyphenol | methylprop-2- |
| | | | enoxy)phenyl]ethanone |
| 4-Hydroxymethyl-2,5- | 1-Chloro-2-iodo-3-methoxy-5- | 4-Ethylsulfonyl-2- | 3-Hydroxy-4-[2-[2-[2-(2- |
| dimethylphenol | (methoxymethyl)benzene | methoxyphenol | methoxyethoxy)ethoxy]eth- |
| | | | oxy]ethoxy]benzaldehyde |
| 3-Acetoxy-6-hydroxy- | 1-[(3S,4S)-4-Azido-3- | 4-Chloro-2-fluoro-6- | 1,1-Diethoxyethane; 3- |
| 2,4,5-trimethylbenzyl | hydroxycyclohexyl]ethanone | hydroxybenzaldehyde | hydroxy-4- |
| chloride | | | methoxybenzaldehyde; |
| | | | propane-1,2-diol |
| 5-Hydroxy-2-iodo-4- | 4-Chloro-2-fluoro-3- | 4-Hydroxy-3- | 1-(4-Hydroxy-3- |
| methoxybenzaldehyde | methoxybenzaldehyde | methoxyphenylpropanal | methoxyphenyl)-3-(3- |
| | | | hydroxyphenyl)propan-1-one |
| 4-Hydroxy-3- | 2-Fluoro-5-hydroxy-3- | 1-(4-Hydroxy-2,3- | 4-Hydroxy-3- |
| methylbenzonitrile | methoxybenzaldehyde | dimethoxypyrrol-1- | methylperoxybenzaldehyde |
| | | yl)ethanone | |
| 5-Methoxy-3- | 2,4-Dimethoxy-5-methylbenzoyl | 5-Carbamoyl-4-chloro-2- | 4-Hydroxy-5-methoxy-2- |
| pyridinecarboxaldehyde | chloride | hydroxybenzoyl chloride | (trifluoromethyl)benzaldehyde |
| 2-Fluoro-6-methoxy-4- | 3-Hydroxy-4-methoxy-2- | 1-Amino-4-sulfanylpyridin-2- | 5-Ethoxy-6-hydroxyinden-1- |
| methylaniline | methylbenzaldehyde | one | one |
| Phenol, 2,4-dimethoxy- | 4-Hydroxy-2-methoxy-3- | 4-Formylisobenzofuran | 4-Hydroxy-3-methyl-5-prop-2- |
| 3-methyl- | methylbenzaldehyde | | ynoxybenzaldehyde |
| Benzaldehyde, 2,4- | 4-Hydroxybenzaldehyde- | 4-Ethoxy-3- | 4-Hydroxy-3-[2-[2-(2-prop-2- |
| dihydroxy-3,5- | 2,3,5,6-d4 | propoxybenzaldehyde | ynoxyethoxy)ethoxy]eth- |
| dimethoxy- | | | oxy]benzaldehyde |
| 4′-Hydroxy-3′-methoxy- | 1-(3-Bromo-4-hydroxy-5- | 4-Methoxy-2-nitrosophenol | 2-(4-Hydroxy-3-methoxy-5- |
| 4-phenylbutyrophenone | trifluoromethylphenyl)ethanone | | methylphenyl)-2- |
| | | | oxoacetaldehyde |
| 4- | 6-Methoxy-3,4- | 2-Chloro-5-ethoxy-4- | (4-Formyl-2-hydroxyphenyl) |
| (Methylamino)benzaldehyde | dimethylcyclohexa-1,5-dien-1-ol | (methylamino)benzenedia- | propanoate |
| | | zonium | |
| (3E)-2-Chloro-3- | 2-Chloro-4-methylcyclopenta- | 5-Cyano-2-formamidothiazole | (4-Formyl-2-hydroxyphenyl) |
| (hydroxymethylidene)cyclo- | 1,3-diene-1,3-dicarbaldehyde | | 2,2-dimethylpropanoate |
| hexene-1-carbaldehyde | | | |
| 1-(4-Hydroxy-3- | Methyl 2-methyl-5-[(2R)-oxiran- | 4-Dichlorophosphoryl-1,2- | 4-Hydroxy-3- |
| methoxyphenyl)-3- | 2-yl]benzoate | dimethoxybenzene | methoxybenzaldehyde; (1 E,4 |
| phenylpropan-1-one | | | E,8E)-2,6,6,9- |
| | | | tetramethylcycloundeca- |
| | | | 1,4,8-triene |
| 2-Iodo-4,5- | 3-Methoxy-4,5- | 4-Hydroxyfuran-2,3- | Deuterio-[2-deuterio-3- |
| dimethoxybenzaldehyde | dimethylbenzaldehyde | dicarbaldehyde | (deuteriomethoxy)-4- |
| | | | hydroxyphenyl]methanone |
| 3-(Benzyloxy)-4- | 1-(3-Methyl-1,4,5,6- | 5-Methoxybenzene-1,2,4-triol | 4-Hydroxy-3- |
| hydroxybenzaldehyde | tetrahydrocyclopenta[c]pyrrol-6- | | methoxybenzaldehyde; hydrate |
| | yl)ethanone | | |
| 2-Hydroxy-5,5-dimethyl- | 5-Methyl-4-oxo-2,3- | [2,2-Dimethylpropanoyloxy- | 4-Hydroxy-3-iodo-5- |
| 2-cyclohexen-1-one | dihydrothiopyran-6- | (4-formyl-2- | methoxybenzaldehyde; 4- |
| | carbaldehyde | hydroxyphenoxy)methyl] 2,2- | hydroxy-3- |
| | | dimethylpropanoate | methoxybenzaldehyde |
| (3-Methoxy-5- | 4-Oxo-2,3-dihydrothiopyran-6- | (E)-1-(3-Hydroxy-4- | 4-Hydroxy-3- |
| methylphenyl)methanol | carbaldehyde | methoxyphenyl)-3-(2,4,6- | methoxybenzaldehyde; phenol |
| | | trihydroxycyclohexa-2,4-dien- | |
| | | 1-yl)prop-2-en-1-one | |
| 2-Amino-4-methyl-3,5- | 3-Methoxycyclohexane-1- | 4-Ethylsulfonyl-2-methoxy-5- | Cyclopropanecarboxylic |
| pyridinedicarbonitrile | carbaldehyde | methylbenzenediazonium | acid; 4-hydroxy-3- |
| | | | methoxybenzaldehyde |
| 2,5-Dichloro-4- | 3-Fluoro-5-hydroxy-4- | 2-Methoxy-5-methyl-4- | Cyclobutanecarboxylic |
| hydroxybenzene-1,3- | methylbenzaldehyde | methylsulfonyl aniline | acid; 4-hydroxy-3- |
| dicarbonitrile | | | methoxybenzaldehyde |
| 2-Hydroxy-5-methoxy- | 3-(Ethenylideneamino)-5- | 4-(Ethoxymethyl)-2,6- | 4-Hydroxy-3- |
| 3,4,6- | methylbenzonitrile | dimethylBenzenamine | methoxybenzaldehyde; 3- |
| trimethylbenzaldehyde | | | methylbutanoic acid |
| 8-Hydroxy-2,2-dimethyl- | 4-Hydroxy-3-((2- | 3- | 1-(3-Hydroxy-4- |
| 2H-chromene-6- | (trimethylsilyl)ethoxy)me- | (Ethylideneamino)benzonitrile | methoxyphenyl)-2-methylbut- |
| carbaldehyde | thoxy)benzaldehyde | | 3-en-1-one |
| Pyrazolo[1,5-a]pyridine- | 3-Fluoro-4-hydroxy-5- | 4-Hydroxy-3-methoxy-5- | 4-[(E)-3-(4-Hydroxy-3- |
| 6-carbaldehyde | methylbenzaldehyde | [methoxy(phenyl)phosphoryl] | methoxyphenyl)prop-2- |
| | | benzaldehyde | enyl]benzaldehyde |
| 1-Methoxy-3- | 3-Fluoro-4-hydroxy-5- | 4-(Fluoromethoxy)-3- | 3-(4-Hydroxy-3- |
| (methoxymethyl)benzene | methylbenzonitrile | methoxybenzaldehyde | methoxyphenyl)-3- |
| | | | oxopropanal |
| 2-Pyridinecarbonitrile, 4- | 2-Fluoro-4-hydroxy-3- | 3-Hydroxy-4-[2-[2-(2- | 3-Decoxy-4- |
| methoxy-3,5-dimethyl- | methylbenzaldehyde | hydroxyethoxy)ethoxy]ethoxy] | hydroxybenzaldehyde |
| | | benzaldehyde | |
| (6S)-6- | 2-Ethoxy-4-prop-1-en-2- | 4-Hydroxy-3- | 2-[(1R)-Cyclohex-2-en-1-yl]- |
| Methoxycyclohexen-1-ol | ylphenol | methoxybenzaldehyde; | 3-hydroxy-4- |
| | | oxaldehydic acid | methoxybenzaldehyde |
| 3,4- | (2E)-3,7-Dimethylocta-2,6-dien- | (3,4- | |
| Dimethoxybenzaldehyde; | 1-ol; 4-hydroxy-3- | Dimethoxyphenyl)methyli- | |
| pentane-2,4-dione | methoxybenzoic acid | deneoxidanium | |

In some instances, the bacterial colonization-disrupting agent alters properties of the surface of the bacterial cell by, for example, targeting the biogenesis of the bacterial cell envelope (e.g., biogenesis of the membrane(s) or other structures that surround and protect the bacterial cytoplasm, e.g., cell wall, inner membrane, and outer membrane). The cell envelope represents the outermost layers of the bacterial cell and, in general, functions in the protection of the cell, communication with the environment, maintenance of cellular shape, stability, and rigidity of the cell, as well as allowing appropriate metabolism, growth, division, and colonization of the bacteria. Accordingly, in some instances, the bacterial colonization-disrupting agent targets genes or proteins required for the biosynthesis of molecules important for the integrity of the cell envelope, including the biosynthesis carbohydrate-containing macromolecules such as lipopolysaccharides (LPSs), peptidoglycan, lipoteichoic acids, teichoic acids, capsule polysaccharides, and lipoarabinomannan.

For example, LPS represents a major component of the outer leaflet of the outer membrane, and is composed of three domains: lipid A, core oligosaccharide (OS) and O-specific polysaccharide (or O antigen). As described in Examples 2 and 3, LPS biosynthesis (e.g., core oligosaccharide synthesis, e.g., L-Heptoses synthesis), is one exemplary cell envelope biogenesis pathway that can be targeted to disrupt bacterial colonization of the insect gut (e.g., disrupt colonization of the endosymbiont Burkholderia in the gut of Riptortus pedestris (Example 2) or disrupt colonization of the endosymbiont Candidatus Pantoea carbekii in the gut of Halyomorpha halys (Example 3)).

Accordingly, in some instances, the bacterial colonization-disrupting agent is an LPS synthesis inhibitor. In some instances, the LPS synthesis inhibitor is an inhibitor of core oligosaccharide synthesis in the bacteria. For example, the LPS synthesis inhibitor may inhibit an enzyme involved in core oligosaccharide synthesis in the bacteria, such as WaaA, WaaC, WaaF, or WaaG, or an enzyme. In some instances, the LPS synthesis inhibitor inhibits an enzyme having at least 40%, 50%, 60%, 70%, 80%, 90%, 95%, 98%, 99%, or 100% sequence identity to a polypeptide having the amino acid sequence of WaaA, WaaC, WaaF, or WaaG. In some instances, the LPS synthesis inhibitor inhibits expression of a gene involved in core oligosaccharide synthesis in the bacteria, such as waaA, waaC, waaF, or waaG. In some instances, the LPS synthesis inhibitor inhibits expression of a gene having at least 40%, 50%, 60%, 70%, 80%, 90%, 95%, 98%, 99%, or 100% sequence identity to a polynucleotide having the nucleotide sequence of waaA, waaC, waaF, or waaG. Exemplary LPS synthesis inhibitors are provided in Table 3.

TABLE 3
LPS synthesis inhibitors

ADP-2-fluoroheptose
2-aryl-5-methyl-4-(5-aryl-furan-2-yl-methylene)-2,4-
dihydro-pyrazol-3-ones
ADP-2-deoxy-2-fluoro-heptose
fullerene hexa-adducts bearing 12 copies of peripheral
sugars displaying the mannopyranose core structure of
bacterial l,d-heptoside

TABLE 4
Analogs of levulinic acid

| | | | |
|---|---|---|---|
| 2-Acetolactate | 2-Diazenylacetic acid | (2R,3S)-3-Methyl-2- | 1- |
| | | oxiranecarboxylic acid | (Chloromethyl)cyclopropane- |
| | | | 1-carboxylic acid |
| 3-Hydroxyphosphonoyl-2- | 3-Methoxy-3-oxoprop-1-ene-2- | (S)-5-Oxooxolane-3-carboxylic | 3-Methoxycarbonylpent-2- |
| oxopropanoic acid | sulfonic acid | acid | enoic acid |
| Acetoacetic acid | 2-Thiazoleacetic acid | 2-[(2R)-Oxiran-2-yl]acetic acid | 3-Ethoxy-2-methylprop-2- |
| | | | enoic acid |
| 3-Mercaptopyruvic acid | 5-Oxoprolinate | 3-Methylglycidic acid | 2,3,4-Trifluorohepta-2,4- |
| | | | dienoic acid |
| 3-Pyridineacetic acid | Ethoxyformic acid anion | 2-Sulfamoylacetic Acid | 1-Fluoropropan-2-yl |
| | | | hydrogen carbonate |
| b-Sulfinyl pyruvate | 4-Sulfanylidenebutanoic acid | (E)-3-Methyl-4-oxobut-2-enoic | Methyl 3-methylsulfonylbut- |
| | | acid | 2-enoate |
| gamma-Aminobutyric acid | (2-Oxoazetidin-1- | 5-Hydroxy-pent-2-ynoic acid | 3-Hydroperoxy-2,2- |
| | yl)methylphosphonic acid | | dimethylpropanoic acid |
| 4-Hydroxy-2-oxopentanoic | 1,3-Dioxolan-4-ylmethyl | 2,2,3-Trimethylbut-3-enoic Acid | 1-Carboxyoxyethyl acetate |
| acid | acetate | | |
| Benzoate | 3-Hydroxy-4-methylisoxazole- | Acetic acid, 2-hydroxy-, | 5-Bromopent-2-enoic acid |
| | 5-carboxylic Acid | carboxymethyl ester | |
| Benzoic acid | 2-(2- | (2R,3R)-3- | 4-Cyanato-2- |
| | Aminoacetyl)oxypropanoic | Methoxycarbonyloxirane-2- | methylidenebutanoic acid |
| | acid | carboxylic acid | |
| Aminooxyacetic acid | 2-Cyclopropylpropanoic acid | 2-Chloropyrimidine-5- | 2-Chloro-3-iminobutanoic |
| | | carboxylic Acid | acid |
| Acetylenedicarboxylic acid | 3,4,5-Trifluorothiophene-2- | 3-Nitroacrylic acid ethyl ester | 3-Chloropropyl hydrogen |
| | carboxylic acid | | carbonate |
| 2-Amino-4-oxopentanoic | 1-Methylsulfonylethyl formate | (3-Methyloxetan-3-yl)methyl | 3-Formylcyclobutane-1- |
| acid | | nitrate | carboxylic acid |
| 3-Hydroxybutyric acid | 2,5-Bis(sulfanyl)pentanoic acid | Propanoic acid, 2,3,3,3- | 3-Fluoropropyl hydrogen |
| | | tetrafluoro-2-methoxy- | carbonate |
| 3-Chlorobenzoic acid | 2,2-Difluoroethyl hydrogen | 4-Nitrobutan-2-one | 3-Bromo-4-bromooxy-4- |
| | carbonate | | oxobutanoic acid |
| 2,5-Dioxopentanoic acid | 2-(Oxiran-2-yl)-2-oxoacetic | 4-Nitro-2-butanol | (1R,2R)-2- |
| | acid | | Ethylcyclopropylacetic acid |
| 2-Phosphoglycolic Acid | Methylphosphinoacetic acid | 2,3-Dideuteriobutanedioic acid | 2,2,3,3-Tetrachlorobutanoic |
| | | | acid |
| Phosphonoacetic acid | Methylphosphinopropionic acid | O-(Methoxymethyl)glycolic acid | 3-Formamido-2- |
| | | | oxopropanoic acid |
| 3-(Methylthio)propionic acid | 1- | 5-Azidopentanoic Acid | Cyclopropanecarboxylic |
| | Fluorocyclopentanecarboxylic | | acid, 2-methylene-, (1R)- |
| | acid | | |
| N,N-Dimethylglycine | 2-[Ethenyl(fluoro)amino]acetic | 2-Butynoic acid, 4-methoxy- | 2-Chloro-5-oxopentanoic |
| | acid | | acid |
| But-2-enedioic acid | (Z)-3-Chloro-2-iodoprop-2- | Hexa-4,5-dienoic Acid | 3-Hydroxyprop-1-en-2-yl |
| | enoic acid | | hydrogen carbonate |
| Itaconic acid | 3,4,4-Trichloro-2- | (1S,2R)-2- | 5-Bromo-2,2- |
| | methylbutanoic acid | Methoxycarbonylcyclobutane- | difluoropentenoic acid |
| | | 1-carboxylic acid | |
| 2-Amino-5-oxopentanoic | 2-Chloro-5-methoxy-5- | (S)-2- | (2-Hydroxypropylamino) |
| acid | oxopentanoic acid | ((Methylsulfonyl)oxy)propanoic | hydrogen sulfate |
| | | acid | |
| 2-Methylbut-2-enedioic acid | 2-Chloro-2-(2-oxoazetidin-1- | (2S)-2-Hydroxy-4-oxopentanoic | 5-Bromo-4-methoxypent-3- |
| | yl)acetic acid | acid | enoic acid |
| Nicotinate | 2-Thionitrosopropanoic acid | (2R)-2- | 4-Bromo-2-fluorobut-2- |
| | | (Methoxycarbonylamino)propanoic | enoic acid |
| | | acid | |
| Nicotinic acid | 4-Phosphanylbutanoic acid | 3,3,4,4,4-Pentafluorobutanoic | 1,2,2-Trifluorocyclobutane- |
| | | Acid | 1-carboxylic acid |
| Pyrazine-2-carboxylic acid | Methoxymethyl hydrogen | 3,3,4,4,4-Pentafluoro-2- | (2R)-2-(Difluoroamino)-2- |
| | carbonate | methylidenebutanoic acid | fluoropropanoic acid |
| Succinic acid | 4-Phosphorosobutanoic acid | (1S,5R,6S)-2- | 5-Hydroxy-3-methylpent-2- |
| | | Oxobicyclo[3.1.0]hexane-6- | enoic acid |
| | | carboxylic acid | |
| Succinic semialdehyde | Hydroxy-(2- | Benzoic-4-D1 acid | 2-Methoxy-2-sulfanylacetic |
| | oxoniocarbonyl- | | acid |
| | cyclopropyl)oxidanium | | |
| 3,4-Dihydro-2H-pyrrole-2- | 1-Phosphanylaziridine-2- | 2,3-Dimethyl-4-nitropyridine | 3-Isocyanato-2-methylprop- |
| carboxylic acid | carboxylic acid | | 2-enoic acid |
| 3-Nitropropionic acid | (3S)-4-Amino-3- | Trifluoracetylalanin | 2-Bromo-3-(oxiran-2- |
| | (hydroxyamino)-4-oxobutanoic | | yl)propanoic acid |
| | acid | | |
| N-(Dithiocarboxy)sarcosine | (1S,5R,6S)-2- | 3,3-Difluorobutanoic Acid | [Ethenyl(dimethyl)silyl]formic |
| | Oxabicyclo[3.1,0]hexane-6- | | acid |
| | carboxylic acid | | |
| Phosphonomycin | 2-(2,2-Dichloro-1- | (E)-3-[(2R,3S)-3-Methyloxiran- | 2-Chloro-3-nitrosopropanoic |
| | methylcyclopropyl)-2-oxoacetic | 2-yl]prop-2-enoic acid | acid |
| | acid | | |
| Phosphoglycolohydroxamic | 3,4-Bis(sulfanyl)butanoic acid | alpha- | 4-Aminosulfanylbutanoic |
| Acid | | (Methoxycarbonylamino)- | acid |
| | | acrylic acid | |
| Hexa-2,4-dienoic acid | 3-Methoxypentanoic acid | 5-Bromolaevulinic acid | 2-Methyl-2- |
| | | | trimethylsilyloxypropanoic |
| | | | acid |
| Trigonelline | (Z)-4-Methoxy-4-oxidobut-3- | Pyrocarbonic acid ethyl ester | 4-Chloropent-2-enoic acid |
| | enoate | | |
| N-Methylnicotinic acid | 4-Methoxy-4-oxobutanoate | 2,3-Difluoroisonicotinic acid | 3-Imino-2-methylbutanoic |
| | | | acid |
| Isonicotinic acid | 2- | (R)-(+)-2-Methylsuccinamic | 4,6-Dichlorohex-2-enoic |
| | (Phosphanylmethylideneamino)acetic | acid | acid |
| | acid | | |
| Asparagine | 2-(Methylsulfonyl)ethyl acetate | S-Methyl-L-cysteine S,S- | 2,2-Difluoro-3- |
| | | dioxide | hydroxypentanoic acid |
| Mercaptosuccinic acid | [(3S)-Oxolan-3-yl] hydrogen | 4,4-Dimethoxybutanoic Acid | 5-Sulfanylpent-2-enoic acid |
| | carbonate | | |
| 4-Chlorobenzoic acid | Carboxymethyl-trimethyl- | (2Z,4S)-4-Acetoxy-2-pentenoic | 2-(4,5-Dihydro-3H-pyrazol- |
| | phosphonium | acid | 3-yl)acetic acid |
| 3-Mercaptopropionic acid | 3-Chloro-2-methyl-4- | (4R)-4-Hydroxyhexanoic acid | 2-Chloro-2-nitrosoacetic |
| | nitropyridine | | acid |
| Dichloroacetic acid | (E)-5-Methyl-4-oxohept-2- | 3,3,3-Trifluoro-2- | Carbonic acid 1- |
| | enoic acid | methylpropanoic acid | methylenebutyl ester |
| N-Acetylalanine | Pyridin-3-yl hydrogen | alpha-Nitroethyl acetate | Trimethylsilylalanine |
| | carbonate | | |
| Cyclohexanecarboxylic acid | 2-(Aziridin-1-yl)acetic acid | 3-Sulfolene-3-carboxylic acid | Trichlorisovaleriansaure |
| M-Toluic acid | 2-(Methoxycarbonyl)butanoic | 5-Iodopentanoic acid | 2-(2- |
| | acid | | Hydroxyethylamino)sulfanyl |
| | | | acetic acid |
| 4-Methylbenzoic acid | 2-[(2,2-Dichloroacetyl)- | 3-(Aminooxy)propanoic acid | 2-Methyl-4,6-dioxohex-2- |
| | methylamino]acetic acid | | enoic acid |
| 3-Chloropropionic acid | (Ethylsulfonyl)acetic acid | Methylbetain | Thiocyanoalanine |
| Valeric acid | 2-Hydroxypropyl dihydrogen | Alaninebetaine | 5-Methoxy-5-oxopent-3- |
| | phosphite | | enoic acid |
| 2,5-Hexanedione | 4-Hydroxy-3-methylhexanoic | 2-Isocyano-4-methylpentanoic | 7-Oxohept-3-enoic acid |
| | acid | acid | |
| 3-Iodopropionic acid | Bicyclo[4.1,0]hepta-1,3,5- | 3-Oxocyclopent-1- | 1,3-Difluoropropyl hydrogen |
| | triene-7-carboxylic acid | enecarboxylic acid | carbonate |
| 2,3-Dimercaptosuccinic acid | (Z)-3-Chlorohex-2-enoic acid | 5-Amino-4-oxo(313C)pentanoic | Bicyclo[3.1.0]hexane-2- |
| | | acid | carboxylic acid |
| Heptafluorobutyric acid | 4,5-Dimethylpyridine-3- | (1S,5S,6S)-6-Fluoro-4- | 5-Oxopent-2-enoic acid |
| | carboxylic acid | oxobicyclo[3.1,0]hex-2-ene-6- | |
| | | carboxylic acid | |
| Methyl difluoronitroacetate | 2-Fluoroethyl hydrogen | (2S,3R)-3-Methyloxirane-2- | 2-Hydroxy-3-(oxiran-2- |
| | carbonate | carboxylic acid | yl)propanoic acid |
| 2-Fluorobenzoic acid | 4-Methylperoxy-4-oxobutanoic | (1S)-2- | 2-Amino-2-(1- |
| | acid | Methylidenecyclopropane-1- | methoxycyclopropyl)acetic |
| | | carboxylic acid | acid |
| 3-Fluorobenzoic acid | 2-Bromo-3-chloropropanoic | 2-Bromo-2- | 5-Chlorohex-4-enoic acid |
| | acid | fluorocyclopropanecarboxylic | |
| | | acid | |
| 4-Fluorobenzoic acid | alpha-Keto-4-methoxybutyric | (S)-4-Methoxy-2-methyl-4- | 3-Cyclopropyl-2- |
| | acid | oxobutanoic acid | nitrosopropanoic acid |
| 3-Fluoropropanoic acid | Methyl(prop-2-enoyl)carbamic | 5-Bromo-5-hexenoic acid | 3H-Azepine-5-carboxylic |
| | acid | | acid |
| Hydantoic acid | 2-(Dichloroamino)-2- | Methoxyimino-acetic acid | (3-Hydroxy-2-oxopropyl) |
| | methylpropanoic acid | | hydrogen carbonate |
| 3-Furoic acid | 3- | 5,6-Difluoropyridine-3- | But-1-enyl hydrogen |
| | [Acetyl(chloro)amino]propanoic | carboxylic Acid | carbonate |
| | acid | | |
| Methylsuccinic acid | 2-(Chloroamino)pentanoic acid | 4,4,4-Trifluoro-2- | 2-Ethyl-4-oxopent-2-enoic |
| | | sulfanylbutanoic acid | acid |
| 4-Fluorobutanoic Acid | 2-(Chloroamino)butanedioic | 2,2-Difluoro-2-sulfamoylacetic | 2,3-Dichlorobut-2-enoic |
| | acid | acid | acid |
| 4-Hydroxybutanoic acid | 3-(Chloroamino)propanoic acid | O-(3- | 2-(Chloromethylidene)- |
| | | Carboxyphenyl)hydroxylamine | 4,4,4-trifluorobutanoic acid |
| Isovaleric acid | 2-Ethyliminopropanoic acid | 3-Carboxybenzenediazonium | 2-Propenoic acid, 3- |
| | | | (acetylthio)- |
| N-Acetylglycine | (E)-4-Amino-2,3-dichloro-4- | 4-(18F)Fluoranylbenzoic acid | 4,4,4-Trichloro-2-methylbut- |
| | oxobut-2-enoic acid | | 2-enoic acid |
| 4-Amino-4-oxobut-2-enoic | 3-Methyl-4-chloro-isoxazole-5- | 4-Fluoro-4-methylcyclohexa- | 3-Chloro-4-methoxy-4- |
| acid | yl acetic acid | 1,5-diene-1-carboxylic acid | oxobut-2-enoic acid |
| 2,3-Dichloropropionic acid | 2- | (E)-4-Methoxy-3-methyl-4- | (2S)-5-Amino-2- |
| | Hydroxybicyclo[3.1.0]hexane- | oxobut-2-enoic acid | (methylideneamino)-5- |
| | 6-carboxylic acid | | oxopentanoic acid |
| 3-Bromopropionic acid | 3-Amino-2-chloroisonicotinic | 2,2-Difluoro-5-hexenoic acid | 1,2,3-Trithiane-5-carboxylic |
| | acid | | acid |
| Dimethylmalonic acid | 2-Aminooxy-3-methylbut-2- | 2-Mercaptobutyric acid | 5-Hydroxyhex-3-enoic acid |
| | enoic acid | | |
| 2,2-Dimethylsuccinic acid | 2-(Propan-2- | Methacryloxyacetic acid | 2-(Ethoxyimino)propanoic |
| | ylideneamino)acetic acid | | acid |
| Acetylcysteine | 2,3-Dihydro-1,4-oxathiine-5- | 2-(Methyldisulfanyl)acetic acid | 4-Amino-4- |
| | carboxylic acid | | sulfanylidenebutanoic acid |
| 2-Chlorofumaric acid | 2-Acetyloxybut-3-enoic acid | 4-Mercapto-4-methyl pentanoic | 4-Chloro-4,4-difluorobut-2- |
| | | acid | enoic acid |
| 4-Chlorobutyric acid | 1-Iodopropan-2-yl hydrogen | (2R)-2-(Oxiran-2- | 2-Carboxyethenyl-ethyl- |
| | carbonate | ylmethyl)butanoic acid | dimethylazanium |
| Ethoxyacetic acid | (1 -Fluoro-2-methylpropan-2-yl) | (S,S)-(+)-Cyclopropane-1,2- | 1,1,2,2-Tetrachloroethyl |
| | hydrogen carbonate | dicarboxylic Acid Monomethyl | hydrogen carbonate |
| | | Ester | |
| Succinamic acid | 4-(Chloromethyl)thiophene-2- | (Methylsulfinyl)acetic acid | 4-Methoxy-2-methyl-4- |
| | carboxylic acid | | oxobut-2-enoic acid |
| 4-Methylpentanoic acid | 4-Oxo-2- | Benzoic acid-ring-UL-14C | 2- |
| | oxabicyclo[3.1.0]hexane-6- | | (Carbamoyldisulfanyl)acetic |
| | carboxylic acid | | acid |
| Hadacidin | 4-Hydroxy-2- | Glycine, N-(carboxymethyl)-N- | (2R)-1- |
| | thiabicyclo[3.1.0]hexane-1- | hydroxy- | Phosphanylazetidine-2- |
| | carboxylic acid | | carboxylic acid |
| 1,2-Diacetylethylene | 1- | 2-(Dimethylamino)propanoic | 2-Diazenylpropanoic acid |
| | (Carboxymethyl)cyclopropane | acid | |
| | carboxylic acid | | |
| 4,4-Dimethylpentanoic acid | 3,3-Dimethyl-2,4- | Acetic acid, [(2-oxopropyl)thio]- | 4-Chloro-3- |
| | dioxopentanoic acid | | methylthiophene-2- |
| | | | carboxylic acid |
| 5-Chlorovaleric acid | Propanoic acid, 3- | Pentaoxycarbonsaure | Tetrathiane-5-carboxylic |
| | (chlorosulfonyl)- | | acid |
| (Acetylthio)acetic acid | 1,3-Dioxol-2-ylmethyl | 3-Bromo-4-methoxy-4- | 5-Fluorocyclohexa-1,3- |
| | hydrogen carbonate | oxobutanoic acid | diene-1-carboxylic acid |
| trans-Hex-2-enoic acid | 2-(Chloroamino)-3- | N-Formylsarcosine | (Z)-Pent-3-enoate |
| | sulfanylpropanoic acid | | |
| Cycloheptanecarboxylic acid | 4-(Chloroamino)butanoic acid | 4-Oxazolecarboxylic acid, 2,3- | 2-Methylsulfanylbut-2- |
| | | dihydro-2-oxo- | enedioic acid |
| 3,3-Dichloroacrylic acid | Dioxane-3-carboxylic acid | 2-Butynoic acid, 4,4-difluoro- | 4-Cyanato-4-oxobut-2-enoic |
| | | | acid |
| 2-Fluoro-3-methylbutanoic | 1-Chloropropyl hydrogen | 4-Azidobutyric acid | Amino(2- |
| acid | carbonate | | methoxyethyl)carbamic acid |
| Cyclopropanecarboxylic acid | 2-Methyl-3,3- | 5-Fluorothiophene-2-carboxylic | 4,4-Dichloro-2- |
| | bis(sulfanyl)butanoic acid | acid | methylidenebutanoic acid |
| 2-Thiopheneacetic acid | 3,3-Bis(sulfanyl)butanoic acid | 2-Nitroethyl Acetate | 2-[(1-Chloropropan-2- |
| | | | yl)oxy]propanoic acid |
| 3-Chlorobutyric acid | 2-(1-Chloroethyl)-3-oxo-1H- | 6-(Trideuteriomethyl)pyridine-3- | 4-Chlorooxy-4-oxobut-2- |
| | pyrazole-5-carboxylic acid | carboxylic acid | enoic acid |
| 5-Bromovaleric acid | Diethylamino hydrogen | 2,5-Difluoropyridine-3- | Phosphorosomethyl |
| | carbonate | carboxylic Acid | dihydrogen phosphate |
| Trichloroacrylic acid | 2-(2-Carbamoyloxiran-2- | 2-[(2- | 2-Methoxypropan-2-yl |
| | yl)acetic acid | Chloroacetyl)(methyl)amino]acetic | hydrogen carbonate |
| | | acid | |
| Peroxyacetyl nitrate | Bicyclo[2.2.0]hexa-1(4),2,5- | 2-(1-Methylcyclobutyl)acetic | (2S)-3-Chlorosulfonyl-2- |
| | triene-2-carboxylic acid | Acid | methylpropanoic acid |
| cis-3-Chloroacrylicacid | 3-Chloro-2,2-difluoropropanoic | (+)-(1S,2R,4R)- | 2,4-Dimethylpenta-2,4- |
| | acid | Bicyclo[2.2.1]heptane-2- | dienoic acid |
| | | carboxylic acid | |
| Isotrigonelline | 3-Chlorocyclopentane-1- | 2-[(1R,2R,4S)-2- | Methylsulfanylmethyl |
| | carboxylic acid | Bicyclo[2.2.1]heptanyl]acetic | hydrogen carbonate |
| | | acid | |
| 1-Methyl-4- | 3- | 3-Aci-Nitropropionic acid | 4-Amino-2,3-dimethyl-4- |
| carboxypyridinium | Fluorocyclopentanecarboxylic | | oxobut-2-enoic acid |
| | acid | | |
| Methyl nitroacetate | 1-Chlorocyclobutane-1- | 2,2-Difluoropent-4-enoic Acid | Carboxy-(carboxymethyl)- |
| | carboxylic acid | | dimethylazanium |
| 2,2-Dichlorobutanoic acid | 3,4-Dichlorocyclopentane-1- | 4-Methyl-isothiazole-5- | 2,3,4,4,4-Pentafluorobut-2- |
| | carboxylic acid | carboxylic acid | enoic acid |
| 2-Fluoropropanedioic Acid | 4-Methoxy-4-methylhexanoic | 4-Hydroxy-2-oxobutanoic acid | 2,3,4-Trifluorobut-2-enoic |
| | acid | | acid |
| 4-Acetylbutyric acid | 2-Chloro-3-fluoropropanoic | [(R)-[(3R)-3-Carboxyoxaziridin- | 2-Propenoic acid, 3-(2- |
| | acid | 3-yl]-hydroxymethyl]sulfanium | propynyloxy)- |
| Chloropon | 2,2,4-Trichloro-3-oxobutanoic | 3,4-Dihydro-2H-pyrrole-2- | 4-Bromo-3-chloro-2,2,3- |
| | acid | carboxylate | trifluorobutanoic acid |
| Benzoic acid-alpha-13C | 2-(Chloroamino)isobutyric acid | 2,4-Pentadienoate | (5,6-Dihydro-1,4-oxathiin-3- |
| | | | yl)acetic acid |
| 1-Methyl-4-nitro-1H-pyrazole | Carboxypropionate | Hydrogen maleate | (2S)-2- |
| | | | [Acetyl(hydroxy)amino]propanoic |
| | | | acid |
| 2-Chlorobutyric acid | (E)-5-Chloropent-2-enoic acid | (2S,3S)-3-Hydroxy-2- | 2-Chloro-3-methoxyprop-2- |
| | | methylbutanoic acid | enoic acid |
| Hex-3-enoic acid | (E)-6-Oxohept-2-enoic acid | 3-(Carboxyamino)propanoic | 2-Nitroso-2-(1,3-thiazol-4- |
| | | acid | yl)acetic acid |
| 4- | 3-Isothiazoleacetic acid, 4- | (R)-1-Pyrroline-5-carboxylic | 4-Fluorooxybutanoic acid |
| Methylcyclohexanecarboxylic | chloro- | acid | |
| acid | | | |
| 4-Methylcyclohex-3-ene-1- | 3-Bromo-4-oxocyclopentane- | Glutaramate | 2- |
| carboxylic acid | 1-carboxylic acid | | (Nitrosomethyl)cyclopropane- |
| | | | 1-carboxylic acid |
| 3-Cyclohexene-1-carboxylic | 3-Methoxycarbonylbut-3- | 2-Amino-3-methyl-4- | (3-Chloro-2-methylbutan-2- |
| acid | enoate | oxopentanoic acid | yl) hydrogen carbonate |
| Pent-3-enoic acid | 2-(Isocyanatomethyl)prop-2- | trans-4- | 3-Fluoroacrylic acid |
| | enoic acid | Fluorocyclohexanecarboxylic | |
| | | Acid | |
| 4-Methyl-5-thiazoleacetic | (Z)-3-Cyclopropylbut-2-enoic | 2-Thioxo-1,3-dithiole-4- | Difluoroalanine |
| acid | acid | carboxylic acid | |
| Cyclohexylacetic acid | Cyanomethoxy-oxido- | 3-Thioxo-3H-1,2-dithiol-5- | Butanoic acid, 4-amino-2- |
| | oxophosphanium | carboxylic acid | bromo-4-oxo-, (2R)- |
| Acetic acid, 2- | Prop-2-enyl carbonate | 3-Methyl-4,5-dihydroisoxazole- | 2- |
| acetamidooxy- | | 5-carboxylic acid | (Sulfonylhydrazinylidene)acetic |
| | | | acid |
| Acetylpyruvic acid | Bicyclo[2.2.1]hept-4-ene-2- | (1R,2S)-2- | 2-Methyl-5-oxopent-4-enoic |
| | carboxylic acid | Methoxycarbonylcyclo- | acid |
| | | butanecarboxylic acid | |
| 4-Pentynoic acid | 2-(2-Bicyclo[2.2.1]hept-5- | 4-Nitrobutanenitrile | 2- |
| | enyl)acetic acid | | [Methanethioyl(me- |
| | | | thyl)amino]acetic |
| | | | acid |
| 4,4-Dimethylpent-2-enoic | 4-Oxo-2-sulfanylpentanoic | 2-(Methylaminooxy)acetic acid | 4-Oxohex-2-enoic acid |
| acid | acid | | |
| Dimethylpropiothetin | Tetrahydro-2H-thiopyran-4- | 2-(Ethylaminooxy)acetic acid | 2,2-Difluoro-3- |
| | carboxylic acid | | (fluoroamino)-3- |
| | | | oxopropanoic acid |
| 3-(Dimethyl-lambda~4~- | 2,2-Difluoro-3-oxopropanoic | N-Methylene glycine | 2,3,4-Trichlorobut-2-enoic |
| Sulfanyl)propanoic Acid | acid | | acid |
| 3-Methoxybutanoic acid | Oxepine-3-carboxylic acid | 2-Chloro-2,3,3,3- | 2,4-Pentadienoic acid, 4- |
| | | tetrafluoropropanoic acid | methyl-, (E)- |
| Nitraminoacetic acid | 1,2-Difluorocyclopropane-1- | (1 R,5S,6R)-2- | Iodoalanine |
| | carboxylic acid | Oxobicyclo[3.1.0]hexane-6- | |
| | | carboxylic acid | |
| 2,3-Dichloroisobutyric acid | Hydroxy-oxo- | (4R)-4,5-Dihydro-1,3-thiazole- | 1-(Aziridin-1- |
| | (sulfinatoamino)oxymethane | 4-carboxylic acid | yl)cyclopropane-1- |
| | | | carboxylic acid |
| 4-Mercaptobutyric acid | Cyclopropyl hydrogen | (1S,2R)-2- | (2R)-2-Chloro-2- |
| | carbonate | Ethenylcyclopropane-1- | (dichloroamino)propanoic |
| | | carboxylic acid | acid |
| N-Nitrososarcosine | 5-Oxohex-2-enoic acid | (1S,4S)-Bicyclo[2.2.1]hept-5- | 2-Deuteriobut-2-enedioic |
| | | ene-2-carboxylic acid | acid |
| 5-Hydroxypentanoic acid | Pyrimidin-5-yl hydrogen | 5-Amino-3,3-dideuterio-4- | 3-Fluoro-2- |
| | carbonate | oxopentanoic acid | (trifluoromethyl)prop-2- |
| | | | enoic acid |
| Butanedioic acid, 2,2- | 2-Methylcyclobutene-1- | (Propionyloxy)acetic acid | 2-(5-Methyl-1,3-thiazol-4- |
| dichloro- | carboxylic acid | | yl)acetic acid |
| 3- | 4-Methylphosphanylbutanoic | 4-Mercapto-4-oxobutanoic acid | 3-Aminosulfanylpropanoic |
| Methylenecyclobutanecarboxylic | acid | | acid |
| acid | | | |
| Chlorosuccinic acid | 2-(Oxiran-2-yl)ethanesulfonic | 2-Hydroxy-5-oxovaleric acid | [Carboxy(chloro)methyl]- |
| | acid | | trimethylazanium |
| 4-Chlorobut-2-enoic acid | 5-Chloro-6-oxoheptanoic acid | 2-Carboxypropyl-hydroxy- | 4-Diazobutanoic acid |
| | | oxophosphanium | |
| 4,4-Dichlorobut-2-enoic acid | 2-Methylidene-4-oxopentanoic | 4-Oxopentanoic acid | 2-Chloro-2,3- |
| | acid | hydrochloride | difluorobutanedioic acid |
| Cysteine, N-formyl-, L- | 3-Chloro-2-oxobutanoic acid | Nicotinic-d4 Acid | Ethoxymethyl hydrogen |
| | | | carbonate |
| 3-Chloroisoxazole-5- | 3-(Aminomethoxy)propanoic | 2,5-Dihydro-furan-2-carboxylic | Methylsulfonylmethyl |
| carboxylic acid | acid | acid | hydrogen carbonate |
| (2R-cis)-(3- | 2-(3,6-Dihydro-2H-pyran-6- | Maleic acid-2,3-d2 | 1,1-Difluoroethyl hydrogen |
| Methyloxiranyl)phosphonic | yl)acetic acid | | carbonate |
| acid | | | |
| 2-Butenedioic acid (2Z)-, 1- | 2- | (E)-(1,4-13C2)But-2-enedioic | 3-Bromopropyl hydrogen |
| (2-hydroxyethyl) ester | (Methylideneamino)oxyacetic | acid | carbonate |
| | acid | | |
| 4-Pyridineacetic acid | 2-Butylphosphanylideneacetic | Fumaric acid-2,3-d2 | 3-Ethyliminopropanoic acid |
| | acid | | |
| 3-Methyl-2H-azirine-2- | 1,3-Dioxolan-4-yl hydrogen | Maleic acid-2,3-13C2 | 4-Bromo-3-methoxybut-2- |
| carboxylic acid | carbonate | | enoic acid |
| 4-Cyanobutanoic acid | Oxan-4-yl hydrogen carbonate | 1,1,1,3,3,4,4,6,6,6- | 3-Phosphanylprop-2-enoic |
| | | Decadeuteriohexane-2,5-dione | acid |
| 2,3-Dichlorobut-2-enedioic | Cyclohex-2-en-1-yl hydrogen | 3-Oxabicyclo[3.1.0]hexane-6- | 2-Acetamidosulfanylacetic |
| acid | carbonate | carboxylic acid | acid |
| N-Ethyl-N-(3- | 1-Methoxypropan-2-yl | (1 R,5S,6s)-3- | 2,3-Dihydropyridine-5- |
| carboxypropyl)nitrosamine | hydrogen carbonate | Oxabicyclo[3.1.0]hexane-6- | carboxylic acid |
| | | carboxylic acid | |
| Ethyl hydrogen maleate | 3-Hydroperoxy-2- | 2-Deuteriobenzoic acid | 4-Ethoxybut-2-enoic acid |
| | methylpropanoic acid | | |
| 4,4-Dihydroxybut-2-enoic | 6-Oxo-tetrahydro-pyran-2- | 2,6-Dideuteriobenzoic acid | 3- |
| Acid | carboxylic acid | | (Hydroxymethylsulfanyl)propanoic |
| | | | acid |
| Nitroacetate | Acetamido hydrogen | 2-Cyclopropyl-2-oxoacetic acid | 3-Sulfanyl-2- |
| | carbonate | | sulfanylidenebutanoic acid |
| N-Methyl-N-(3- | Oxiran-2-yl hydrogen | Isonicotinic-d4 acid | N-Acetyl-3-chloro-L-alanine |
| carboxypropyl)nitrosamine | carbonate | | |
| Thiocyanatoacetic acid | Dimethylphosphorylimino(sul- | Pentanoic acid, 2-ethyl-4-oxo- | 4-Sulfanylbut-2-enoic acid |
| | fanylidene)methane | | |
| 4-Fluorobut-2-enoic acid | 2-[(1R,2S,4S)-2- | 4-Chlorocyclohex-3-ene-1- | 4-Hydroxypentan-2-yl |
| | Bicyclo[2.2.1]heptanyl]acetic | carboxylic acid | hydrogen carbonate |
| | acid | | |
| 3,4-Dichloroisothiazole-5- | 3-Fluorobicyclo[1.1.1]pentane- | (Z)-4-Methyl-2-pentenoic acid | 4-Chlorobutan-2-yl |
| carboxylic acid | 1-carboxylic acid | | hydrogen carbonate |
| 2-Chloro-2-methyl butyric | Propanoic acid, 2-[(1- | Isovaleric acid-1-13C | 2- |
| acid | methylethyl)nitrosoamino]- | | Formyloxyethylphosphonic |
| | | | acid |
| 3-(Dichloroamino)-3- | 3-Methoxypropane-1-sulfonate | Acetic acid, sulfo-, 1-methyl | 3-Butyldioxirane-3- |
| methylbutanoic acid | | ester | carboxylic acid |
| alpha, beta-Dichloroacrylic | (E)-3-Isocyanoprop-2-enoic | 2,4-Dimethylpent-4-enoic acid | (3R)-3-Amino-4- |
| acid | acid | | hydroperoxy-4-oxobutanoic |
| | | | acid |
| 4-Pentenoic acid | 3-Cyanobut-3-enoic acid | Trimethylsilylpropionic acid | 1,1-Dichloroethyl hydrogen |
| | | | carbonate |
| 3-Ethoxypropionic acid | 2-Chloro-2- | 2-Butynedioic acid-13C2 | 2-Methyl-3-(oxetan-2- |
| | (dichloroamino)propanoic acid | | yl)prop-2-enoic acid |
| (Z)-4-Methoxy-4-oxobut-2- | 2,3,3-Trifluoropropanoic acid | [(R)-2-Cyclohexenyl]acetic acid | Aminovinylglycine |
| enoic acid | | | |
| Succinic acid monoisopropyl | 2-Methyl-7- | (2E,5R)-5-Hydroxy-2-hexenoic | 4-Fluorobutyl hydrogen |
| ester | oxabicyclo[2.2.1]hept-5-ene-2- | acid | carbonate |
| | carboxylic acid | | |
| Pentafluoropropionic acid | 3,3-Dichloro-4- | 2-(2-Chloroethoxy)-2-oxoacetic | 2-(Oxolan-3- |
| | hydroxybutanoic acid | acid | ylsulfanyl)acetic acid |
| 2-Propanone, 1-nitro- | 3-Amino-3-cyanopropanoic | 1,3-Dithiole-4-carboxylic acid | [(2S)-4-Chloro-3-oxobutan- |
| | acid | | 2-yl]carbamic acid |
| 2,3-Dichloro-4-oxo-2- | Dichloroacetylacetic acid | cis-beta-Formylacrylic acid | [Hydroxy(hydroxymethyl)phos- |
| butenoic acid | | | phanyl]formic |
| | | | acid |
| Phenyl hydrogen carbonate | 3-Cyanopropanoate | 2-Deuteriopentanoic acid | Ethylsulfanylmethyl |
| | | | hydrogen carbonate |
| (1- | Carboxy ethenyl carbonate | (113C)Pentanoic acid | (1S,3S)-3-Hydroxy- |
| (Aminocar- | | | cyclopentanecarboxylic acid |
| bonyl)hydrazino)acetic | | | |
| acid | | | |
| 3-(2-Fluoroethoxy)propanoic | (2E)-3-Nitroacrylate | 2,2-Dideuteriopentanoic acid | 2-(2- |
| acid | | | Sulfanylethylamino)sulfanyl |
| | | | acetic acid |
| Tetrafluorosuccinic acid | 2-Chloro-2-methylpropanedioic | Pentanoic-4,4-D2 acid | 1,2-Dimethylcyclobutane-1- |
| | acid | | carboxylic acid |
| 2-Fluorophenylacetic acid | 2-Chloro-2-ethoxypropanoic | Pentanoic-5,5,5-D3 acid | Carboxy 2- |
| | acid | | [chloro(methyl)amino]acetate |
| Coumalic acid | 2-Chloro-3-methoxy-2-methyl- | 5-Hydroxy-1-methyl-1H- | Bromomethyl hydrogen |
| | 3-oxopropanoic acid | pyrazole-3-carboxylic acid | carbonate |
| 4-Methyl-3-pentenoic acid | Chloromethylcarbonate | (2S)-2-Acetamidobutanoic acid | 2-(Oxolan-3-ylidene)acetic |
| | | | acid |
| Cyclopropane-1,1- | 2,3,3,3-Tetrachloropropanoic | 2-Hydroxy-3-methoxypropanoic | 3-Chloro-2-fluoroprop-2- |
| dicarboxylic acid | acid | acid | enoic acid |
| beta-Hydroxyisovaleric acid | 3-(Aminosulfonyl)propanoic | Cyclopropanecarboxylic acid, | Aminoxyalanine |
| | acid | 2-ethenyl-, trans- | |
| (Ethylthio)acetic acid | (2-Methoxy-2- | 2-Ethenyl-2- | (2R)-2- |
| | oxoethyl)carbamic acid | methylcyclopropane-1- | (Aminooxyamino)propanoic |
| | | carboxylic acid | acid |
| 2,5-Dimethyl-3-furoic acid | [1-(Dimethylamino)-1- | 2-Prop-1-en-2-ylcyclopropane- | 4,4,4-Trifluoro-3- |
| | oxopropan-2-yl]carbamic acid | 1-carboxylic acid | methoxybut-2-enoic acid |
| Ethylsuccinic acid | Monomethylfumarate | (1R,2S,4R)-Bicyclo[2.2.1]hept- | 3-Sulfo-propionic acid |
| | | 5-ene-2-carboxylic acid | methyl ester |
| 1-Cyclohexene-1-carboxylic | 3- | (2R)-Bicyclo[2.2.1]hept-5-ene- | 3,4,5,6- |
| acid | (Hydroxyphosphinoyl)pyruvate | 2-carboxylic acid | Tetrahydropyridazine-3- |
| | | | carboxylic acid |
| 2,2-Difluorosuccinic acid | [(Z)-3-Carboxy-1-hydroxyprop- | (2S)-Bicyclo[2.2.1]hept-5-ene- | 4-Methyl-1- |
| | 2-enylidene]oxidanium | 2-carboxylic acid | phosphanylpiperidine-4- |
| | | | carboxylic acid |
| Flupropanate | 5,5-Dichlorovaleric acid | CID 12273926 | 3- |
| | | | (Nitrosomethyl)cyclobutane- |
| | | | 1-carboxylic acid |
| 2-Butenedioic acid (2Z)-, | 2-(1,3-Dioxolan-2-yl)acetic | Thiirane-2-carboxylic acid | 2-Bromo-3-fluoroprop-2- |
| mono(1-methylethyl) ester | acid | | enoic acid |
| 3-(2-Furyl)propanoic acid | 5-(Dimethylamino)-5- | (2S)-Thiirane-2-carboxylic acid | Oxalo acetate |
| | oxopentanoic acid | | |
| 4-Ethoxy-4-oxobutanoic acid | 4-Fluorothiophene-2- | Methyl (2Z)-4,4-dimethoxy-2- | Dihydroxyphosphanyloxy |
| | carboxylic acid | butenoate | hydrogen carbonate |
| Ethyl hydrogen malonate | 2-(Difluoroamino)-2,2- | 4-Chlorothiophene-2-carboxylic | (2S)-2- |
| | difluoroacetic acid | acid | [Chloro(ethyl)amino]propanoic |
| | | | acid |
| Benzoic acid-d5 | 2- | 2-Methyl-2- | 2-Methyl-4-oxopent-2-enoic |
| | (Sulfonylmethylamino)propanoic | carboxymethylcyclopentanone | acid |
| | acid | | |
| Cyclopentylacetic acid | (E)-4-(2-Methyloxiran-2-yl)but- | 3-Methylidene-4- | 5-Methylhexa-3,5-dienoic |
| | 2-enoic acid | oxocyclopentane-1-carboxylic | acid |
| | | acid | |
| 1,2-Dithiolane-3-carboxylic | 2-Ethenoxy-2-oxoacetic acid | Pentanoic acid, 4,4-dimethyl-5- | Nitromethyl hydrogen |
| acid | | oxo- | carbonate |
| [Hydroxy(methoxy)phos- | 1H-Diazepine-4-carboxylic | 1-Chloro-1-nitropropan-2-one | 3,4,4-Trifluoro-4- |
| phoryl]formic acid | acid | | hydroxybutanoic acid |
| 5-Methoxy-5-oxopentanoic | 2-Methylidene-4-oxohexanoic | 3-Hydroxy-2-methylpyridine-4- | 6-Bromohexa-2,4-dienoic |
| acid | acid | carboxylic acid | acid |
| Fumaraldehydic acid | 2-[(2-Methyloxiran-2- | 4-Chloro-4-pentenoic acid | 4-Cyanopent-2-enoic acid |
| | yl)methyl]prop-2-enoic acid | | |
| Dichloroisothiocyanatophosphine | (E)-2-Methyl-3-(oxetan-2- | 2-Propenoic acid, 2-ethoxy- | 4-Hydroperoxy-2- |
| | yl)prop-2-enoic acid | | methylbutanoic acid |
| 2-Ethoxy-2-oxoacetic acid | 3-Hydroxycyclopent-1-ene-1- | (R)-2-(5-Oxotetrahydrofuran-2- | 2-(3,4-Dihydro-2H-pyran-4- |
| | carboxylic acid | yl)acetic acid | yl)acetic acid |
| 5-Methyl-2- | 3-Methyl-2,4-dioxopentanoic | 3-Hydroxyisoxazole-5- | 2-(2- |
| thiophenecarboxylic acid | acid | carboxylic acid | Sulfanylidenepro- |
| | | | panoylamino)acetic |
| | | | acid |
| 4,4,4-Trichlorobutyric acid | Chloromethylpivalate | 2,5- | 4-Chloro-2-methylbut-2- |
| | | Dioxabicyclo[4.1,0]heptane-7- | enoic acid |
| | | carboxylic acid | |
| Butanoic acid, 4- | (2Z,4E)-5-Chloro-2,4- | 2,4,4,4-Tetrachlorobutyric acid | 3-Diazenylpropanoic acid |
| (dimethylamino)-4-oxo- | pentadienoic acid | | |
| 4-Bromobutyric acid | 1-Methyl-1H-1,2,3-triazole-4- | 6-Chloro-5-methylnicotinic acid | 2- |
| | carboxylic acid | | [Ethenyl(methoxy)amino]acetic |
| | | | acid |
| 2-(Furan-2-yl)acetic acid | (Z)-4-Methoxy-4-oxobut-2- | (Z)-3-Nitro-2-butenoic acid | 2-[2- |
| | enoate | ethyl ester | (Methylamino)acetyl]oxyacetic |
| | | | acid |
| Propanoic acid, 2- | 2-(2,2- | (2Z,5E)-Hepta-2,5-dienoic acid | 2-Cyanatoiminoacetic acid |
| (aminooxy)- | Dimethylhydrazinyl)acetic acid | | |
| N-Acetyl-beta-alanine | N-Ethylhydroxyglycine | 5-Methyl-4-hexenoic acid | (3R)-4-Hydroxy-3- |
| | | | methylbutanoic acid |
| Monoperoxysuccinic acid | Phosphono 2-fluoroacetate | 2-(2-Methylcyclopropyl)acetic | 3-Methyl-4-(methylamino)- |
| | | acid | 4-oxobut-2-enoic acid |
| Monomethyl succinate | Oxan-3-yl hydrogen carbonate | Isothiazole-4-carboxylic acid | 2,4-Hexadienoic acid, 2- |
| | | | chloro-, (Z,Z)- |
| (R)-(+)-Methylsuccinic acid | 3,4-Dihydro-2H-pyran-5-yl | 2-Oxocyclopentanecarboxylic | 2- |
| | hydrogen carbonate | acid | [Methyl(phosphanylcar- |
| | | | bonyl)amino]acetic acid |
| Pyrimidine-5-carboxylic acid | 2-[Chloro(ethenyl)amino]acetic | 2,2-Dimethyl-3-oxobutanoic | 2-Chloro-4-oxobut-2-enoic |
| | acid | acid | acid |
| 3-Hydroxy-2,2- | 3-Chloro-3,3-difluoropropionic | 2,2-Dideuterio-4,4- | (E)-4-Methoxybut-2-enoic |
| dimethylpropanoic acid | acid | dimethylpentanoic acid | acid |
| Bicyclo[2.2.1]hept-5-ene-2- | 3,3-Dichloro-3-fluoropropanoic | 3,3-Dideuterio-4,4- | 2-Methyl-3-(oxiran-2- |
| carboxylic acid | acid | dimethylpentanoic acid | yl)prop-2-enoic acid |
| 2-Acetoxypropanoic acid | 3-Chloro-3-fluoropropanoic | 2- | 3-Chloro-3-cyanoprop-2- |
| | acid | (Hydroxymethyl)cyclopropane- | enoic acid |
| | | 1-carboxylic acid | |
| Bicyclo[2.2.1]heptane-2- | 2-Chloro-2,2- | Dimethylcyclopropanecarboxylic | 2-Chloro-5-hydroxypent-2- |
| carboxylic acid | difluoroethanesulfonic acid | acid | enoic acid |
| 2-Norbornaneacetic acid | 3-Cyclopropyl-2-oxopropanoic | 4-Methyl-2-pentynoic acid | Furan-3-yl hydrogen |
| | acid | | carbonate |
| 6-Chloronicotinic acid | 2-(2-Oxopyrrolidin-3-yl)acetic | (Z)-2-Hexenoic acid | 4-Hydroperoxy-3-methyl-4- |
| | acid | | oxobut-2-enoic acid |
| Acetic acid, [[(1- | 2-Cyclopropylbut-3-enoic acid | 5-Sulfanylpent-3-enoic acid | 3-Isocyanato-2- |
| methylethylidene)amino]oxy] | | | methylpropanoic acid |
| 2-Acetamidoacrylic acid | 3-Cyclopropylbut-3-enoic acid | 1-Methylcyclopropene-3- | 4-Oxohexa-2,5-dienoic acid |
| | | carboxylic acid | |
| 3-(Trimethylsilyl)propionic | 4,5-Dimethyloxazole-2- | (E)-Pent-2-en-4-ynoic acid | 3-Ethoxy-2-fluoroacrylic |
| acid | carboxylic acid | | acid |
| N-Formyl-DL-alanine | (Z)-(2,3-13C2)But-2-enedioic | (Tert-Butylperoxy)acetic acid | 3-Chlorobutyl hydrogen |
| | acid | | carbonate |
| 2-Propanone, 1-(nitrooxy)- | 2-(2-Sulfanylidene-1,3-thiazol- | 3-Nitrobutan-2-one | [(2R)-2-Hydroxypropyl] |
| | 3-yl)propanoic acid | | dihydrogen phosphate |
| 1- | 2-Sulfanyl-1,3-thiazole-4- | 5-Methyl-2,5-dihydrothiophene- | Levulinic acid, nickel(II) salt |
| Methylcyclopropanecarboxylic | carboxylic acid | 2-carboxylic acid | |
| acid | | | |
| 4-Hydroxyiminopentanoic | 3,5-Dideuteriofuran-2- | (2R,5S)-5-Methyl-2,5- | (Z)-3-(Dimethylamino)prop- |
| acid | carboxylic acid | dihydrothiophene-2-carboxylic | 2-enoic acid |
| | | acid | |
| 4-Methoxy-2-methylene-4- | 2-Chloro-4-methoxybutanoic | 4,5-Dimethyl-2,5- | 2-Hydroxybut-2-enedioic |
| oxobutanoic acid | acid | dihydrothiophene-2-carboxylic | acid |
| | | acid | |
| Methiin | 5,5-Dichloro-2H-pyridine-3- | 2,2,3-Trimethylcyclopropane-1- | (2E)-2-Hydroxypenta-2,4- |
| | carboxylic acid | carboxylic acid | dienoate |
| (6r)-6-Methylcyclohex-3- | 3,4-Dichloro-3,4,4- | 2,2,3,3-Tetrafluoro-4-methoxy- | 4-Hydroxybenzoate |
| ene-1-carboxylic acid | trifluorobutanoic acid | 4-oxobutanoic acid | |
| (2R)-2-Formamidopropanoic | 3,3-Dichloro-4-cyanobutanoic | [(2-Methoxy-2- | 3-Hydroxybenzoate |
| acid | acid | oxoethyl)amino]phosphonic | |
| | | acid | |
| 3-Chloropivalic acid | 2,3-Dichloro-3- | 4-Oxohept-6-enoic acid | 3-Methylsalicylate |
| | cyclopropylpropanoic acid | | |
| Acetoxyacetic acid | 4-Fluorocyclohexa-1,3-diene- | 2- | 2-Butenedioic acid, 2- |
| | 1-carboxylic acid | (Methoxycarbonyl)cyclopropane- | hydroxy-, (E)- |
| | | 1-carboxylic acid | |
| trans-4-Bromo-2-butenoic | 4-Chlorocyclohexa-1,3-diene- | (1 R,2R)-Rel-2- | 2- |
| Acid | 1-carboxylic acid | (Methoxycarbonyl)cyclo- | Hydroxyethylenedicarboxylate |
| | | propanecarboxylic acid | |
| Thiazole-5-carboxylic acid | 2-Mercapto-2-methyl-succinic | (1R,2S)-2- | (2E)-2,3-Dihydroxybut-2- |
| | acid | (Methoxycarbonyl)cyclopropane- | enedioate |
| | | 1-carboxylic acid | |
| 3- | 2-(2-Sulfanylidene-1,3-thiazol- | Cyclohept-1-ene-1-carboxylic | 4-Hydroxy-1-methyl-5-oxo- |
| (Hydroxymethylphos- | 3-yl)acetic acid | acid | 2H-pyrrole-3-carboxylic acid |
| phinyl)propionic acid | | | |
| Hydroxymethylsarcosine | Propan-2-yl carbonate | 2,3-Dichloro-3-methylbutanoic | 3-Hydroxy-4- |
| | | acid | methylthiophene-2- |
| | | | carboxylic acid |
| 2-Pyridineacetic acid | 2-Aminotriazole-4-carboxylic | 2-Acetoxyethylphosphonic acid | 5-Hydroxypyridine-3- |
| | acid | | carboxylate |
| [(Methoxythioxomethyl)thio] | 2,5-Dioxopentanoate | (2R)-Oxane-2-carboxylic acid | 2-Hydroxyhexa-2,4- |
| acetic acid | | | dienoate |
| 2- | 3-Oxobutyl dihydrogen | 2-(Hydroxyamino)propanoic | (2Z)-2-Hydroxypenta-2,4- |
| Methylcyclohexanecarboxylic | phosphate | acid | dienoate |
| acid | | | |
| 2,3-Oxiranedicarboxylic acid | 2-(4-Methyl-1,3-oxazol-2- | 2- | 3-Diazo-2-oxopropanoic |
| | yl)acetic acid | Ethynylcyclopropanecarboxylic | acid |
| | | acid | |
| Tetrahydrofuran-2- | 2-Bromo-4-methoxy-butyric | Trifluoromethyl hydrogen | 2-(3-Methyloxetan-3- |
| carboxylic acid | acid | sulfate | YL)acetic acid |
| 3-Oxobutan-2-yl Nitrate | 2-Bromo-4-ethoxybutanoic | 4-Chloro-4-methylpentanoic | 2-(Oxetan-3-YL)acetic acid |
| | acid | acid | |
| N-Acetyl-L-alanine | Dicarboxyazaniumylideneazanide | (R)-2-Fluorobutyric acid | 2-(Chloromethyl)pyrimidine- |
| | | | 5-carboxylic acid |
| (2-Hydroxyethyl) hydrogen | 3-Hydroxypropyl hydrogen | 2-Fluorosuccinic acid | 2-Oxabicyclo[3.1.0]hex-3- |
| succinate | carbonate | | ene-6-carboxylic acid |
| 1-Cyclopentene-1-acetic | 3-Cyanobutanoic acid | 2,2-Dimethoxyacetic acid | 2-Chlorosulfonyl-2,2- |
| acid | | | difluoroacetic acid |
| 2-Hydroxypropyl nitrate | Carboxymethylisocyanate | Cyclopropanecarboxylic acid, | 4-Amino-4-oxo-2- |
| | | 1-(1-hydroxyethyl)- | sulfanylbutanoic acid |
| (Tert-Butylthio)acetic acid | 5-Chloro-5-oxopentanoic acid | 4-Hydroxypent-2-ynoic acid | 2- |
| | | | (Aminocarbamothioyl- |
| | | | sulfanyl)acetic |
| | | | acid |
| N-Carbamoyl-L-cysteine | 2,2,2-Trifluoroethanesulfonate | (3S)-3-Methyl-4-oxopentanoic | 2-Carbamothioyloxyacetic |
| | | acid | acid |
| 3-Chlorobut-2-ene-1-sulfonic | Prop-2-enoxy hydrogen | cis,cis-Muconic acid | (Carbamoylamino)oxy |
| Acid | carbonate | mononitrile | hydrogen carbonate |
| (R)-3-Hydroxybutyric acid | 2H-Pyrimidine-1-carboxylic | 2,5-Dihydrothiophene-2- | (2S)-2-Amino-3-(oxiran-2- |
| | acid | carboxylic acid | yl)propanoic acid |
| 2-Methoxypropanoic acid | 3-Carboxypropyl-hydroxy- | 2-(Cyclobuten-1-yl)acetic acid | (Z)-4-Hydroxy-2-pentenoic |
| | oxophosphanium | | acid |
| 4-Methoxybutanoic acid | 2,2-Difluoropentanoic acid | 3-(N-Hydroxycarbamoyl)-2- | (Z)-4-Ethenoxy-4-oxobut-2- |
| | | methylenepropionic acid | enoic acid |
| Glycidyl nitrate | Methyl(2-oxoethyl)carbamic | 4-Methoxy-2,2-dimethyl-4- | (Z)-6-Oxohex-3-enoic acid |
| | acid | oxobutanoic acid | |
| Oxirane-2-carboxylic acid | 3-Ethoxypropanoate | 4-Chlorocyclohexanecarboxylic | 2,4-Heptadienoic acid, |
| | | acid | (2E,4Z)- |
| (S)-3-Hydroxybutyric acid | 2-(Methanethioylamino)acetic | 2-Methyl-1,3-dithiane-2- | (1S,5R,6S)- |
| | acid | carboxylic acid | Bicyclo[3.1,0]hex-2-ene-6- |
| | | | carboxylic acid |
| 5-Chlorothiophene-2- | Butyl carbonate | 5-Chloro-4-methyl-2- | 3-Methyl-5-hydroxy-2- |
| carboxylic acid | | thiophenecarboxylic acid | pentenoic acid |
| Carboxymethyl | 2-Trimethylsilyloxyprop-2- | (1s,4r)-Bicyclo[2.2.1]heptane-2- | 3-Methylidenecyclohexane- |
| methanesulfonate | enoic acid | carboxylic acid | 1-carboxylic acid |
| (Z)-4-(Methylamino)-4- | 2-Chloro-2- | (1~{r},2~{s})-2- | 4-Formylpent-4-enoic acid |
| oxobut-2-enoic acid | nitrosulfanylacetamide | Methylcyclohexane-1- | |
| | | Carboxylic Acid | |
| Monofluoroacetylglycine | (Carboxyoxyamino) hydrogen | (1R,3R)-3-Methylcyclohexane- | Bicyclo[3.1.1]heptane-3- |
| | carbonate | 1-carboxylic acid | carboxylic acid |
| 3-Mercaptobenzoic acid | 1-Formylcyclopropane-1- | 3-Methylcyclohex-3-ene-1- | 2-(2-Methoxyethoxy)-2- |
| | carboxylic acid | carboxylic acid | oxoacetic acid |
| 4-Mercaptobenzoic acid | 2-Methyl-3,4-dihydro-2H- | 2,4-Cyclohexadiene-1- | (E)-5-Hydroxy-3- |
| | pyran-5-carboxylic acid | carboxylic acid | methylpent-3-enoic acid |
| 2-Fluoronicotinic acid | Carbamoyloxyacetic acid | (1S,3R,6R)-7- | 3-Nitrooxybutanoic acid |
| | | Oxabicyclo[4.1.0]heptane-3- | |
| | | carboxylic acid | |
| Glycine, N-(1-methylethyl)- | 2,3,4,5-Tetrahydropyridine-4- | 7-Oxabicyclo[4.1.0]heptane-3- | (2S)-2-Sulfanylpentanoic |
| N-nitroso- | carboxylic acid | carboxylic acid | acid |
| 2-Cyclopentene-1-acetic | 2H-Thiopyran-4-carboxylic | (1R,3R,6S)-7- | (2R)-3- |
| acid | acid | Oxabicyclo[4.1.0]heptane-3- | Methylidenecyclopropane- |
| | | carboxylic acid | 1,2-dicarboxylic acid |
| (R*,S*)-2,3-Dichlorosuccinic | 2-Cyclobutylideneacetic acid | (1R,3S,6S)-7- | 3-(3-Methyldiazirin-3- |
| acid | | Oxabicyclo[4.1.0]heptane-3- | yl)butanoic acid |
| | | carboxylic acid | |
| Glycine, N-(ethoxycarbonyl)- | 2-(Chloromethyl)-1,3- | 3-Methyl-7- | 5-Hydroxyoxane-3- |
| | dioxolane-4-carboxylic acid | oxabicyclo[4.1.0]heptane-3- | carboxylic acid |
| | | carboxylic acid | |
| 4-Methyl hydrogen L- | Carboxylatooxybenzene | 5-Methyl-2,5-dihydrofuran-2- | (1R,5S)- |
| aspartate | | carboxylic acid | Bicyclo[3.1.0]hexane-3- |
| | | | carboxylic acid |
| 2-Fluorohexanoic acid | 2-(5-Oxooxolan-3-yl)acetic | Glycidylethyl sulfone | 3,4-Dihydroxypentanoic |
| | acid | | acid |
| 3-Chlorobut-2-enoic acid | Methyl(3-oxopropyl)carbamic | 3-Acetylsulfanyl-2- | (5-Oxo-1,3-dioxolan-4- |
| | acid | chloropropanoic acid | yl)acetic acid |
| Chlorofluoroacetic acid | Ethoxy hydrogen carbonate | Butanoic acid, 3-mercapto-, | 3-Methyl-2,3- |
| | | (R)- | dihydrothiophene-5- |
| | | | carboxylic acid |
| N-Propionylglycine | 1,3-Thiazepine-7-carboxylic | 2-Chloro-3-sulfanylpropanoic | 5-Methyl-4,5-dihydro-furan- |
| | acid | acid | 3-carboxylic acid |
| 2-Methyl-1,3-thiazole-5- | 2-Methoxyethylformate | 2-Chloro-3-methyl-4- | 3-(Difluoroamino)propanoic |
| carboxylic acid | | nitropyridine | acid |
| 2-Methyl-4-nitropyridine | 3,4-Epoxycyclohexane-1- | 2,4-Dichlorobutanoic acid | (2R,3R)-2,3- |
| | carboxylate | | Dimethyloxirane-2- |
| | | | carboxylic acid |
| L-Allothreonine | 2-Methoxyacrylate | 3-(Acetyloxy)propanoic acid | (E)-3-Methyl-5-oxohex-2- |
| | | | enoic acid |
| O-Acetylserine | 3-(Dimethylamino)butanoic | 3-(Acetyloxy)butanoic acid | 4-Methylcyclohexa-1,5- |
| | acid | | diene-1-carboxylic acid |
| S-Methylcysteine sulfoxide | Chlorosulfanylformic acid | (3R)-3-(Acetyloxy)butanoic acid | 2-(2,2- |
| | | | Dimethylcyclopropyl)acetic |
| | | | acid |
| 2- | Tetrahydrofuranat | 2-(2-Chloroacetyl)oxyacetic | 2-Fluoro-3-methylbut-2- |
| Methylcyclopropanecarboxylic | | acid | enoic acid |
| acid | | | |
| N-Acryloylglycine | Ethanedioic acid, monoethyl | (Cyclohexa-1,4-dien-1-yl)acetic | 2,2-Dimethyl-3H-furan-4- |
| | ester | acid | carboxylic acid |
| 2-Fluorobut-2-enedioic acid | lododifluoroacetic acid | 2-Oxabicyclo[4.1.0]heptane-7- | 2-Chloro-2- |
| | | carboxylic acid | cyclopropylideneacetic acid |
| 3,5-Difluorobenzoic acid | 2H-Thiopyran-3-carboxylic | (2-Oxo-1,3-oxazolidin-3- | 3-Cyano-3,3- |
| | acid | yl)acetic acid | dimethylpropanoic acid |
| Hex-4-enoic acid | 5,6-Dihydro-2H-thiopyran-3- | 4-Amino-2,2,3,3-tetrafluoro-4- | (1s,3r)-3- |
| | carboxylate | oxobutanoic acid | Hydroxycyclohexane-1- |
| | | | carboxylic acid |
| 2,2-Dichloro-1- | 1,1-Dihydroxy-3,3- | 2,2-Dideuterio-3- | 4-Oxooxetane-2-carboxylic |
| methylcyclopropanecarboxylic | dimethylurea | hydroxybutanoic acid | acid |
| acid | | | |
| 2-Amino-4-methoxy-4- | 2-(5H-1,2-Oxazol-2-yl)acetic | 3-Methoxycarbonyldiazirine-3- | 2-Prop-2- |
| oxobutanoic acid | acid | carboxylic acid | enoylsulfanylacetic acid |
| 2-Oxo- | 2-Chloroacetoacetate | Diazirine-3,3-dicarboxylic acid | Cyclohepta-1,3-diene-1- |
| cyclopentanepropionic acid | | | carboxylic Acid |
| Propanoic acid, 3,3-dichloro- | alpha-Chloroacetoacetic acid | 2-{Bicyclo[3.1.0]hexan-2- | (3S)-4-Hydroxy-3- |
| 2,2-dimethyl- | | yl}acetic acid | methylbutanoic acid |
| 3-Methoxypropane-1- | Nitro hydrogen carbonate | 3-Methyl-4-cyanobutyric acid | Cyclohepta-1,3,6-triene-1- |
| sulfonic acid | | | carboxylic acid |
| 2-(Methylsulfonyl)ethyl | 2-Methoxyethylacetate | Bicyclo[2.2.0]hexane-1- | (2R,3S)-3-Methoxy-2- |
| carbonochloridate | | carboxylic acid | methylbutanoic acid |
| (R)-5-Oxotetrahydrofuran-2- | 2-(1,3-Oxazolidin-3-yl)acetic | 3-Cyclohexene-1-acetic acid | (3R)-3-Methylcyclohexane- |
| carboxylic acid | acid | | 1-carboxylic acid |
| Ethyl hydrogen carbonate | 6-Methylcyclohexa-2,4-diene- | (Z)-4-Methoxy-2-methyl-4- | (3S)-3-Methyl-4- |
| | 1-carboxylic acid | oxobut-2-enoic acid | oxohexanoic acid |
| (R)-2-Chlorosuccinic acid | 3-Sulfanylhexanoic acid | (E)-3-Methoxycarbonyl-2- | 1-Methyl-2-oxo-2,3-dihydro- |
| | | methylacrylic acid | 1H-imidazole-4-carboxylic |
| | | | acid |
| 4-Oxopent-2-enoic acid | 2,3,3-Trichloropropanoic acid | 5,5-Dichloro-4-pentenoic Acid | (2R,3R)-2-Methyloxirane- |
| | | | 2,3-dicarboxylic acid |
| 2,3-Dimercaptopropionic | 2,3,4-Trichlorobutanoic acid | 3-Carbamoylsulfanyl-propionic | (2S)-1-Acetylazetidine-2- |
| acid | | acid | carboxylic acid |
| 4-Methyl-pent-2-enoic acid | Neopentylacetate | (2S)-2-Chlorohexanoic acid | (1S,2R)-2- |
| | | | Chlorocyclopropane-1- |
| | | | carboxylic acid |
| 2- | N-Chloro-D-alanine | alpha-Chloroisocaproic acid | 2-Methylthiirane-2- |
| {[Dihydroxy(methyl)silyl]oxy} | | | carboxylic acid |
| propanoic acid | | | |
| 3- | 2-(Chlorosulfonyl)acetic acid | 2-Hydroxycyclopentylacetic | (1R,2R)-2- |
| Methylcyclohexanecarboxylic | | acid | Ethenylcyclopropane-1- |
| acid | | | carboxylic acid |
| 4-Hydroxypentanoic acid | 4-Hydroxypentanoate | trans-4-Hydroxy-4-methyl-2- | 1,4,6-Cycloheptatriene-1- |
| | | pentenoic acid | carboxylic acid |
| Valerate | Chlorofumarate | 5-Oxocyclohex-3-enecarboxylic | (2S)-2-Fluoro-3- |
| | | acid | methylbutanoic acid |
| Carboxysulfanylformic Acid | 4-Chloro-2- | 2-(Dimethoxymethyl)-2-methyl- | Bicyclo[3.1.1]heptane-1- |
| | methylidenebutanoic acid | 1-oxaspiro[2.2]pentane | carboxylic acid |
| Aziridine-1-propionic acid | 3-Tert-butyldioxirane-3- | (3S)-3-Hydroxypent-4-enoic | Pentanoic acid, 4- |
| | carboxylic acid | acid | mercapto-, (4S)- |
| 4,5-Dioxopentanoic acid | 2-(Chloromethoxy)-2-oxoacetic | 1-Methylcyclobutanecarboxylic | Nitrous acid carboxymethyl |
| | acid | acid | ester |
| 2-(Dimethylphosphoryl)-2- | Propan-2-ylperoxy hydrogen | 2- | 6-Methylpyridazine-4- |
| hydroxyacetic acid | carbonate | ((Methylsulfonyl)oxy)propanoic | carboxylic acid |
| | | acid | |
| 4-Chloro-3-oxobutyric acid | 5-Sulfanylidenepentanoic acid | (2R)-2- | (Hydroxymethylthio)acetic |
| | | (Methanesulfonyloxy)propionic | acid |
| | | acid | |
| 5-Fluoronicotinic acid | Propanedioic acid, dimethyl-, | 2-(3-Methylthiophen-2- | 2-Ethylsulfanyl-2-oxoacetic |
| | monoethyl ester | YL)acetic acid | acid |
| 5-Fluoropentanoic acid | Acetic acid, 2-(2-furanylthio)- | 5-Oxocyclohex-1-ene-1- | 2,4-Dimethylcyclobutane-1- |
| | | carboxylic acid | carboxylic acid |
| 3-(Methylsulfonyl)propanoic | 4-Methyl-2-methylidenepent-4- | 2-(Cyanomethylthio)acetic acid | 3-Fluoro-3-methylbutanoic |
| acid | enoic acid | | acid |
| 3- | 2-Ethenoxypropanoic acid | 1-Azidocyclopropane-1- | (E)-4-Methoxybut-3-enoic |
| Oxatricyclo[3.2.1.02,4]octane- | | carboxylic acid | acid |
| 6-carboxylic acid | | | |
| 3-(2-Oxotetrahydrofuran-3- | (Z)-2-Methyl-4-oxo-2- | 3-Methylcyclopent-1-ene-1- | (2S)-2-(2- |
| yl)propanoic acid | pentenoic acid | carboxylic acid | Oxohydrazinyl)propanoic |
| | | | acid |
| 5-Methylpyrazine-2- | 1-Hydroxy-1-oxo-2- | 5-Mercaptopyridine-3- | 1- |
| carboxylic Acid | (sulfinatoamino)ethane | carboxylic acid | Chlorocyclopropanepropanoic |
| | | | acid |
| 1-Formylcyclopropane-2- | 2-Carboxyethylphosphine | 2-(Methylsulfanyl)pyridine-4- | 1,4-Dioxane-2- |
| carboxylic acid | | carboxylic acid | aceticacid, (2R)- |
| beta-Fluoroasparagine | Pyridin-4-yl hydrogen | 4-Penten-2-ynoic acid | Tert-butyl |
| | carbonate | | cyclopropanecarboxylic |
| | | | acid |
| N-Nitroso-N-acetylglycine | Ethenoxy hydrogen carbonate | 4-Methyl-pent-4-en-2-ynoic | (3R,4S)-3,4- |
| | | acid | Dimethylcyclopentane-1- |
| | | | carboxylic acid |
| 2-Methylene-3- | (Z)-4-Chloropent-3-enoic acid | (2Z)-2,5-Hexadienoic acid | (1S,3S,6R)-7- |
| oxocyclopentaneacetic acid | | | Oxabicyclo[4.1.0]heptane- |
| | | | 3-carboxylic acid |
| 4-Methoxy-2,4- | 2-Methyloxetane-2-carboxylic | 2-(5-Hydroxycyclopent-2-en-1- | 2-[(1R,2R)-2- |
| dioxobutanoic acid | acid | yl)acetic acid | Hydroxycyclopentyl]acetic |
| | | | acid |
| Chlorotetrolic acid | 2-(1,4-Dioxin-2-yl)acetic acid | 2-[(1R,5R)-5- | 2-(1- |
| | | Hydroxycyclopent-2-en-1- | Hydroxycyclopropyl)acetic |
| | | yl]acetic acid | acid |
| 5-Fluoro-4-oxopentanoic | 2-[Acetyl(methyl)amino]prop-2- | 3-Methyl-1,3-cyclohexadiene-1- | (Z)-6-Hydroxyhex-3-enoic |
| acid | enoic acid | carboxylic acid | acid |
| N-Acetyl-D-alanine | 2-Phosphorosoacetic acid | 1-Methylcyclohexa-2,4-diene-1- | N-(2-Fluoroethyl)-N- |
| | | carboxylic acid | methyloxamic acid |
| 3-Fluoropropane-1-sulfonic | 4-(Hydroxyamino)-4- | 4,4-Dichlorobut-3-enoic acid | 5-Chloro-2-methyl-4- |
| Acid | oxobutanoate | | oxopentanoic acid |
| 3-Methoxypropanoic acid | 2-(Chlorooxyamino)acetic acid | 2- | Methyl 3-chloro-2- |
| | | [(Trifluoromethyl)sul- | nitropropanoate |
| | | fanyl]propanoic acid | |
| N-Acetyl-N- | 2-Ethylperoxy-2-oxoacetic acid | Pent-4-en-2-yl hydrogen | 2- |
| hydroxyaminoacetic acid | | carbonate | (Difluoromethyl)cyclopropane- |
| | | | 1-carboxylic acid |
| 3-(Trifluoromethyl)butyric | Carbonic acid allylethyl ester | 4,4-Dimethylpent-2-ynoic acid | (3R)-3-Sulfanylpentanoic |
| acid | | | acid |
| 1,2- | Chloro ethoxy acetic acid | 2-Methoxyethyl nitrate | 2-Methyl-2- |
| Cyclopropanedicarboxylic | | | [methyl(nitroso)amino]propanoic |
| acid | | | acid |
| 6-Methylnicotinic acid | 2-Acetamido-2-oxoacetic acid | 2-(2,2-Dichloro-1- | 2-(4-Methyl-1,3-dioxolan-4- |
| | | methylcyclopropyl)acetic acid | yl)acetic acid |
| 1- | Chloroacetoacetate | 3-Methyl-2,5-dihydrothiophene- | 3-Hydroxy-3- |
| Methylcyclopentanecarboxylic | | 2-carboxylic acid | methylcyclobutanecarboxylic |
| acid | | | acid |
| Cyclopropylacetic acid | 2-Oxo-2-(2-oxoazetidin-1- | 2-Azido-2-methylpropanoic | 3-Methyl-3-nitrosobutanoic |
| | yl)acetic acid | acid | acid |
| 2-Nitrocyclopropane-1- | Oxazepine-7-carboxylic acid | (1R,5S,6R)-Bicyclo[3.1.0]hex- | 3- |
| carboxylic acid | | 2-ene-6-carboxylic acid | [Formyl(methyl)amino]butanoic |
| | | | acid |
| 3-Pentynoic acid | Thiazepine-7-carboxylic acid | 3-Chloropent-4-enoic acid | (2R)-2- |
| | | | Methoxycarbonylcyclopropane- |
| | | | 1-carboxylic acid |
| Trifluoromethyl peroxynitrate | 2H-Thiazine-6-carboxylic acid | (E)-5-Chloropent-3-enoic acid | (2R)-7- |
| | | | Oxabicyclo[2.2.1]heptane- |
| | | | 2-carboxylic acid |
| 4,4,4-Trifluoro-3-methylbut- | 3-Chlorooxypropane-1-sulfonic | (E)-5-Bromopent-3-enoic acid | (E)-5-Fluoro-2-methylpent- |
| 2-enoic acid | acid | | 2-enoic acid |
| Thiophosphoenolpyruvate | 2-Ethyl-1-methylcyclopropane- | [(2S)-2-Hydroxypropyl] | 1-Cyclohexene-1-carboxylic |
| | 1-carboxylic acid | dihydrogen phosphate | acid, 5-methylene- |
| 6-Hydroxyisonicotinic acid | 2- | (1r)-3- | (4S)-4-Methyl-2-oxo-1,3- |
| N-oxide | [Ethyl(methylcarbamoyl)amino] | Oxocyclohexanecarboxylic | dioxolane-4-carboxylic acid |
| | acetic acid | Acid | |
| N-Nitrosarcosine | 2-(Aminomethyl)-pyridine-4- | (Z)-2-Chloropent-2-enoic acid | 2-Methyl-2-(1- |
| | carboxylic acid | | methylcyclopropyl)propanoic |
| | | | acid |
| Glycolic acid, methyl ester, | 4-Methyl-2H-pyrimidine-1- | 2-Chloro-3-methylbut-2-enoic | 2-Acetyl-2- |
| methanesulfonate | carboxylic acid | acid | methylcyclopropane-1- |
| | | | carboxylic acid |
| Hydroxyacetone phosphate | 2,3-Dihydroazete-4-carboxylic | 3,3-Difluoroacrylic acid | 5,5-Difluoropentanoic acid |
| | acid | | |
| Methylenecyclopropylacetic | 2-Carboxysulfanylacetic acid | 3-Bromo-4-oxopentanoic acid | (2 S)-2-Methyl-4- |
| acid | | | sulfanylidenepentanoic acid |
| 2-Methylacetoacetic acid | 2-Nitrosulfanylacetic acid | Glycone | (2S,3S)-3-Mercapto-2- |
| | | | methylbutanoic acid |
| (R)-2- | 2-Chlorosulfanylacetic acid | 2-Chloro-2-methylpent-4-enoic | (Z)-2-Hydroxy-4-oxohex-2- |
| (Dimethylamino)propanoic | | acid | enoic acid |
| acid | | | |
| Difluorooxaloacetate | Acetic acid, aminomercapto- | 2-Methoxycarbonyl-1- | 3-Methylthiirane-2- |
| | | methylcyclopropane-1- | carboxylic acid |
| | | carboxylic acid | |
| 2-Keto-4-mercaptobutyric | 2-Hydroxysulfanylacetic acid | 2,5-Dimethyloxolane-2- | (E)-5-Formyloxypent-3- |
| acid | | carboxylic acid | enoic acid |
| Bicyclo[3.1.0]hexane-6- | 2-lsocyanatosulfanylacetic | (E)-4-Oxohex-2-enoic acid | 3,3-Difluoro-2- |
| carboxylic acid | acid | | (fluoromethyl)prop-2-enoic |
| | | | acid |
| 3-(N-Nitroso-N- | 2-(3-Methyloxiran-2-yl)acetic | Ethylsulfanylformic acid | 2- |
| methylamino)propionic acid | acid | | (Methoxymethyl)cyclopropa |
| | | | ne-1-carboxylic acid |
| 4-Mercaptobutyrate | 3-(Ethoxycarbonyl)oxirane-2- | Propylsulfanylformic acid | 7-Oxabicyclo[4.1.0]hepta- |
| | carboxylate | | 2,4-diene-3-carboxylic acid |
| 5-Amino-2,5- | 2-(2H-Pyran-3-yl)acetic acid | 2-Methoxyethyl hydrogen | 3H-Dithiole-4-carboxylic |
| dioxopentanoate | | carbonate | acid |
| 3,4-Dichloro-5- | (E)-4-Isocyano-2-methylpent- | 2,2,2-Trichloroethyl hydrogen | (E)-5-Methoxy-4-oxopent-2- |
| isothiazolecarboxylate | 2-enoate | carbonate | enoic acid |
| N-(Mercaptoacetyl)glycine | 4-Oxobicyclo[3.1.0]hex-2-ene- | 2-Ethylcyclopropane-1- | (E)-3-(Chloromethyl)-4- |
| | 6-carboxylic acid | carboxylic acid | oxobut-2-enoic acid |
| N-Methacryloylglycine | 4-Hydroxy-5-sulfanyl pentanoic | (E)-2-Methyl-5-oxopent-2-enoic | 6-Oxooxane-3-carboxylic |
| | acid | acid | acid |
| L-Asparagine, N2- | 2-(2,2- | (E)-Hex-2-en-4-ynoic acid | 7-Oxabicyclo[4.1.0]hept-3- |
| methylene- | Dimethylhydrazinyl)propanoic | | ene-3-carboxylic acid |
| | acid | | |
| Difluoromethoxyacetic acid | 7-Oxa-3- | 2,3-Dichloro-2,3- | (2S)-2- |
| | azabicyclo[4.1.0]heptane-3- | difluoropropanoic acid | Propanoyloxypropanoic |
| | carboxylic acid | | acid |
| Dicarbonic acid | 2-Amino-3-(oxiren-2- | 2-Deuteriobutanedioic acid | 3-Cyclopropyl-3- |
| | yl)propanoic acid | | methylbutanoic acid |
| 4-Methylbenzoate | 2-(2,3-Dihydrofuran-3-yl)acetic | Succinic acid-2,2,3,3-d4 | 3-Oxabicyclo[3.1.0]hexane- |
| | acid | | 2-carboxylic acid |
| CID 154375 | 2-(Sulfamoylamino)acetic acid | Succinic acid-2,3-13C2 | (S)-2-Cyclohexene-1- |
| | | | carboxylic acid |
| 2-Chloro-3-methylbut-2- | Acetoxyglycolic acid | (113C)Butanedioic acid | 3-Methyl-2-oxo-3H-furan-5- |
| enedioic acid | | | carboxylic acid |
| Peroxynitric acid, | 3-Ethenoxypropanoic acid | Benzoic acid-d | 3- |
| chlorodifluoromethyl ester | | | (Methylideneamino)propanoic |
| | | | acid |
| 3-Azidopropanoic acid | Propoxyformic acid anion | Benzoic-1-13C acid | 4-Fluoro-3- |
| | | | (fluoromethyl)butanoic acid |
| Azidoacetic acid | Cyclohexylacetate | Benzoic-3,5-d2acid | 2-(2-Methylcyclopent-2-en- |
| | | | 1-yl)acetic acid |
| Methyl chloronitroacetate | 2-Methylpropyl carbonate | Benzoic Acid-13C6 | 2-Cyclopropoxyacetic acid |
| 2- | 3-Methanesulfonyl-2- | 4,4,4-Trifluoro-2-oxobutanoic | 1,2,3-Triazine-5-carboxylic |
| [Formyl(hydroxy)amino]propanoic | methylpropanoic acid | acid | acid |
| acid | | | |
| Succinate | 2-Methyl-4-oxo-3- | 3,3-Dideuterio-4-methoxy-4- | 4-Fluoro-3-methylbutanoic |
| | sulfanylpentanoic acid | oxobutanoic acid | acid |
| Sulfobetaine | 5-Chloro-2-methylidenehex-5- | 2,2,3,3-Tetradeuterio-4- | N-Methylidene-L-alanine |
| | enoic acid | methoxy-4-oxobutanoic acid | |
| Dimethylsulfonioacetic acid | (Carboxysulfanylamino)sul- | 3-(3-Oxo-1,2-thiazol-2- | 5-Oxazolecarboxylic acid, |
| | fanylformic acid | yl)propanoic acid | 2-methoxy- |
| 2-Hydroxyethylthioacetate | 4-Oxotetrahydrothiophene-3- | 3-Chlorocyclohexanecarboxylic | 6-Chloro-5- |
| | carboxylic acid | acid | methylpyrimidine-4- |
| | | | carboxylic acid |
| 3-Chloro-2-methyl propanoic | 2-Oxo-1,3,4-oxathiazinane-5- | (E)-4-Methyl-2,4-pentadienoic | 2,3-Dinitrosobutanoic acid |
| acid | carboxylic acid | acid | |
| Methoxyacetate | 2,6-Difluoropyridine-4- | (4S)-2-Sulfanylidene-1,3- | 4-Cyano-2-methylpent-2- |
| | carboxylic acid | thiazolidine-4-carboxylic acid | enoic acid |
| N-Chloroglycine | 3-Formyloxybutanoic acid | 3-(1,3-Dioxolan-2-yl)propanoic | 2,3-Dideuteriobut-2- |
| | | acid | enedioic acid |
| But-2-enedioate | 1,2,2,2-Tetrachloroethyl | 2-Carbamoylcyclopropane-1- | 2-(Methoxyamino)prop-2- |
| | hydrogen carbonate | carboxylic acid | enoic acid |
| beta-Alanine, N-ethyl-N- | 2-Amino-3- | (1R,2R)-2- | (2S)-6-Oxa-1- |
| nitroso- | (ethanethioylamino)propanoic | Carbamoylcyclopropane-1- | azabicyclo[3.1.0]hexane-2- |
| | acid | carboxylic acid | carboxylic acid |
| Chloroacetol phosphate | 3-Methoxy-2-methylpropanoic | 2-(Isoxazol-3-yl)acetic acid | Carbamoyl(fluoro)carbamic |
| | acid | | acid |
| 2,2,3,3-Tetradeuterio-3- | 2-Dimethylsulfoniopropanoate | 5-Isoxazoleacetic acid | 5-Amino-4-oxopent-2-enoic |
| trimethylsilylpropanoic acid | | | acid |
| (E)-3-(Methylthio)acrylic acid | 4-Chlorobutyrate | 2- | 2-(Dibromoamino)acetic |
| | | [(Methoxycarbonyl)amino]propanoic | acid |
| | | acid | |
| 2-Chloro-4-methylpentanoic | 3-Methylcyclohexane-1- | N-Carbomethoxy-L-alanine | 2-Chloro-2-methylpentanoic |
| acid | carboxylate | | acid |
| N-Ethyl-N-nitrosoglycine | 2-Norbornylacetate | 3-Formyloxypropanoic acid | 4-Bromooxy-4-oxobutanoic |
| | | | acid |
| (2-Methoxy-2- | 2-(Oxiran-2-yl)acetate | 3-Acetamido-2- | 5-Chloro-2-methyl-5- |
| oxoethyl)phosphonic acid | | sulfanylpropanoic acid | oxopentanoic acid |
| 3-(Methylamino)-3- | 4-Chloro-4-oxo-butyrate | Methacryloyloxyacetic acid | 3-Iminopentanoic acid |
| oxopropanoic acid | | | |
| 5-Hydroxyhexanoic acid | Sulfuric acid 3-methyl-3- | 2-Cyclopenta-1,4-dien-1- | 2,2-Dimethyl-3- |
| | butenyl ester | ylacetic acid | sulfanylidenepropanoic acid |
| Dimercaptosuccinic acid | 2-(2-Methylcyclopropyl)prop-2- | 1-Nitro-2-propanol acetate | 2-Chloro-2,3- |
| monomethyl ester | enoic acid | | dimethylbutanoic acid |
| Difluoromethoxydifluoroacetic | 2,2,2-Trichloroethyl carbonate | (2S)-4-Amino-2-hydroxy-4- | (1R,3R)-3- |
| acid | | oxobutanoic acid | Hydroxycyclopentanecarboxylic |
| | | | acid |
| 3-Chlorolevulinic acid | Carboxy methyl carbonate | 3-Cyclopropylbut-2-enoic acid | (2Z,4Z)-2-Hydroxyhexa-2,4- |
| | | | dienoate |
| 4-Hydroxypenta-2,4-dienoic | 2-(1-Methylcyclopropyl)prop-2- | 2-Methoxycarbonyl-2- | 1,3,4-Thiadiazol-2-yl |
| acid | enoic acid | methylcyclopropane-1- | dihydrogen phosphate |
| | | carboxylic acid | |
| Codopiloic acid | 3-Oxo-3- | (1R,2R)-2-Methoxycarbonyl-2- | Bicyclo[2.2.1]hept-1(6)-ene- |
| | (sulfanylamino)propanoic acid | methylcyclopropane-1- | 2-carboxylic acid |
| | | carboxylic acid | |
| (1R,5R,6S)-3- | 2-(Methylsulfonylmethyl)acrylic | 3-Fluoro-2,2-dimethylpropanoic | (2R,5S)-5-Chloro-1,3- |
| Methylbicyclo[3.1.0]hex-2- | acid | acid | oxathiolane-2-carboxylic |
| ene-6-carboxylic acid | | | acid |
| Bicyclo(3.1.0)hex-2-ene-6- | 3-Oxo-2-sulfanylbutanoic acid | 2- | Carbonochloridoylperoxy- |
| carboxylic acid, 3-methyl-, | | [Acetyl(methyl)amino]propanoic | methanedithioic acid |
| (1alpha,5alpha,6beta)- | | acid | |
| 5-Methylfuran-3-carboxylic | Isocyanatoacetate | N-Acetyl-N-methyl-L-alanine | 4-Methylsulfanyl-4- |
| Acid | | | sulfanylbutanoic acid |
| Cyclopropaneacetic acid, 2- | 4,5-Dihydrooxazole-4- | (E)-4-Chloropent-2-enoic acid | 3,3,4-Trichloro-4- |
| methylene-, (S)- | carboxylic acid | | hydroxybutanoic acid |
| 4-Hydroxypent-3-enoic acid | Oxazepane-4-carboxylic acid | 2-Sulfinoacetic acid | 3-(Dimethylamino)-3- |
| | | | sulfanylpropanoic acid |
| Cyclohexa-1,5-diene-1- | 2,2,4-Trifluoro-3-oxopentanoic | (E)-4-Chloro-2-hexenoic acid | 5-Chloro-5-hydroxypent-2- |
| carboxylic acid | acid | | enoic acid |
| (2R)-2-Amino-3- | 2,2-Difluoro-3-oxopentanoic | 4-Bromo-pent-4-enoic acid | 2,3-Dichloro-3- |
| (methylsulfinyl)propanoic | acid | | oxopropanoic acid |
| acid | | | |
| (3E)-Hexa-3,5-dienoic acid | 2,4-Difluoro-3-oxopentanoic | 2- | 2-(Dimethylaminooxy)prop- |
| | acid | [Ethyl(di- | 2-enoic acid |
| | | methyl)azaniumyl]acetate | |
| Propanedioic Acid, Dichloro- | 3,4,4,4-Tetrafluoro-2- | Ethyldimethyl(carboxy- | 3-Formyl-4-hydroxybutanoic |
| | methylidenebutanoic acid | methyl)aminium | acid |
| Perfluorovinylacetic acid | 5-Oxo-5-sulfanylpentanoic | 3-Azido-2-methylpropanoic | Pyrrolidin-1-ylsulfanylformic |
| | acid | acid | acid |
| 2-Nitrososulfanylacetic acid | (2-Methylpropan-2-yl)oxy | (2R)-3-Azido-2- | Bicyclo[3.1.0]hexa-1(6),2,4- |
| | carbonate | methylpropanoic acid | triene-6-carboxylic acid |
| 3-Hydroxy-2-oxobutanoic | 2-Chloromethylisonicotinic | 2-(2-Ethylcyclopropyl)acetic | 3,3-Dichlorobutanoic acid |
| acid | acid | acid | |
| 4-Hydroxybut-2-enoic acid | But-3-en-2-yl hydrogen | 3,4-Dimethylpent-4-enoic acid | 2-(1- |
| | carbonate | | Sulfanylethoxyimino)acetic |
| | | | acid |
| Dehydromethionine | 3,3-Difluoropropane-1- | 4-Chloro-3-mercaptobenzoic | 2,2-Difluoro-4- |
| | sulfonate | acid | nitrosobutanoic acid |
| 5-Chloro-4-oxopentanoic | 4,4,4-Trifluorobutane-2- | (R)-2-Amino-4-(methylamino)- | 3-Methyl-4-oxobut-3-enoic |
| acid | sulfonate | 4-oxobutanoic acid | acid |
| 3-Amino-4-oxo-pentanoic | 4,4,4-Trifluorobutane-2- | 3-Azabicyclo[3.1.0]hex-2-ene- | 4-Fluoro-2-methylbut-2- |
| Acid | sulfonic acid | 2-carboxylic acid | enoic acid |
| 2-Oxo-2H-pyran-6- | 2,2-Difluoro-2- | Oxirane-2,3-dicarboxylic acid | (E)-3-(2- |
| carboxylic acid | fluorosulfonylacetate | monoethyl ester | Oxoethylsulfanyl)prop-2- |
| | | | enoic acid |
| 4-Oxocyclohexanecarboxylic | 2-Acetoxy-acrylic acid | 3-Methanesulfinylpropanoic | 3-Hydroxy-3,3- |
| acid | | acid | bis(sulfanyl)propanoic acid |
| Methylbetaine | 3-Nitrobutanoic acid | 3-(Ethylsulfinyl)propanoic acid | 2-(1-Chloroethenoxy)acetic |
| | | | acid |
| Thioacetylthioglycolic acid | 2-Ethoxypropanoate | 3-(Methoxycarbonyl)oxirane-2- | 3-Phosphanylsulfanyl-3- |
| | | carboxylic acid | sulfanylpropanoic acid |
| 2-Deoxyglyceraldehyde 3- | 5-Hydroxyhexanoate | (2S,3R)-3- | 2-Cyclopropyl-3- |
| phosphate | | Methoxycarbonyloxirane-2- | sulfanylpropanoic acid |
| | | carboxylic acid | |
| (2S)-2-Amino-5- | 3-Oxocyclohexa-1,5-diene-1- | (S)-3-Hydroxy-3-methylvaleric | 2-Chlorooxolane-3- |
| oxopentanoic acid | carboxylic acid | acid | carboxylic acid |
| 2-Butenedioic acid, 2,3- | 1,2,2,3- | 5-Chloro-3-methyl pentanoic | 4-Oxo-4- |
| difluoro-, (Z)- | Tetramethylcyclopropane-1- | acid | (sulfanylamino)butanoic |
| | carboxylic acid | | acid |
| 3-(2- | Carboxyoxymethyl hydrogen | 3-(1- | 2- |
| Methylidenecyclopropyl)-2- | carbonate | Methylcyclopropyl)propanoic | (Hydroxyhydrazinylidene)acetic |
| oxopropanoic acid | | acid | acid |
| 4-Hydroxyhexanoic acid | (E)-3-Methyl-4-oxohex-2-enoic | Bicyclo[4.1.0]heptane-3- | 5,5-Dichloropenta-2,4- |
| | acid | carboxylic acid | dienoic acid |
| 2-Hydroxyisonicotinic acid | 4-Chloro-2-methyl-4- | (Z)-5-Chloro-2-methylhex-4- | 4-lsocyanatobut-2-enoic |
| N-oxide | oxobutanoic acid | enoic acid | acid |
| Spiropentaneacetic acid | (2S)-2- | (E)-3- | 2-Diazenyl-2- |
| | (Sulfinoamino)propanoic acid | (Trimethylazaniumyl)prop-2- | methylpropanoic acid |
| | | enoate | |
| Hydroxypyruvaldehyde | Trichloromethoxy hydrogen | 4-Methyl-4-nitrosopentanoic | 3,4-Dichlorobut-2-enoic |
| phosphate | carbonate | acid | acid |
| delta(3)-Thiazoline-4- | Butan-2-yl carbonate | 3-Hydroxy-3-oxopropane-1- | 2-Methyl-3-nitrosopropanoic |
| carboxylate | | sulfinate | acid |
| Phosphonatooxyformic acid | 2- | 4-Hydroxy-4-oxobutane-2- | 4-Ethenoxybut-3-enoic acid |
| | [[Carbonochloridoyl(methyl)amino]- | sulfinate | |
| | methylamino]acetic acid | | |
| 3-(3-Methyloxiran-2-yl)prop- | 1-Methoxyethyl hydrogen | 3-Methylcyclopentane-1- | 3H-Pyridin-1-ium-5- |
| 2-enoic acid | carbonate | carboxylic acid | carboxylic acid |
| (2R,3R)-2,3- | Acetic acid, [(2-oxo-1- | (1S,3R)-3-Methylcyclopentane- | 1,2-Oxazolidin-3-yl |
| Dimercaptosuccinic acid | azetidinyl)oxy]- | 1-carboxylic acid | hydrogen carbonate |
| 3-Nitro-2-butanol nitronate | 3-Methylbutyl hydrogen | (1S,3S)-3-Methylcyclopentane- | 4-Chloro-2-oxopent-4-enoic |
| | carbonate | 1-carboxylic acid | acid |
| 2-Methyl-2- | 2-Formylisonicotinic acid | 4,4,4-Trifluorobut-2-ynoic acid | 2,2-Difluoro-4- |
| (methylsulfinyl)propionic | | | hydroxybutanoic acid |
| acid | | | |
| Fluorohydroxyacetone | Monomethyl cyclopropane-1,1- | N-Methyl-N-(2- | 3-Chlorohex-2-enoic acid |
| phosphate | dicarboxylate | oxopropyl)nitramide | |
| 5-Methylthiophene-3- | 2-[1- | 2-Aminooxybutanedioic acid | (2S)-2-Amino-3-(oxiren-2- |
| carboxylic acid | (Dimethylamino)cyclopropyl]acetic | | yl)propanoic acid |
| | acid | | |
| 3,3- | (Methyldisulfanyl)formic acid | 3-Dihydroxyphosphanyl-2- | 4-Chloro-3- |
| Dimethylcyclobutanecarboxylie | | oxopropanoic acid | methylidenepent-4-enoic |
| acid | | | acid |
| Tetrahydropyran-4- | 3,3-Dimethyl-4- | 2-Acetoxybutanoic acid | Propylaminosulfanylformic |
| carboxylic acid | sulfanylidenepentanoic acid | | acid |
| 4-Methylcyclohex-1-ene-1- | 1-Aminopyrazole-4-carboxylic | 3-Methoxytetrafluoropropionic | 2-Bromo-4-(oxiran-2- |
| carboxylic acid | acid | acid | yl)butanoic acid |
| 6-Methylcyclohex-3-ene-1- | 3-Methoxycyclopentane-1- | 3-Bromo-2,2,3,3- | 2-(Ethenylamino)oxyacetic |
| carboxylic acid | carboxylic acid | tetrafluoropropanoic acid | acid |
| 2-Bromoisonicotinic acid | (Chloromethoxy)acetic acid | 5-Bromofuran-3-carboxylic acid | 2,3,3,3- |
| | | | Tetrakis(sulfanyl)propanoic |
| | | | acid |
| 2-Amino-3-methoxybutanoic | 3-Methyldioxetane-3- | (1R,6S)-6-Methylcyclohex-3- | 3-Fluoro-5-oxopent-4-enoic |
| acid | carboxylic acid | ene-1-carboxylic acid | acid |
| 2,2′-(Nitroimino)diacetonitrile | Thiazinessig | (R)-2-Fluoro-2-methyl-malonic | 3-Fluorooxy-2,2-dimethyl-3- |
| | | acid monoethyl ester | oxopropanoic acid |
| 4,4,4-Trichlorobut-2-enoic | 1-Oxo-1,3-thiazolidine-4- | 2-Fluoro-3-methoxy-2-methyl- | 4-Amino-4-hydroxybutanoic |
| acid | carboxylic acid | 3-oxopropanoic acid | acid |
| 2-Methyl-4-oxopentanoic | 2-(Oxiran-2-yl)butanoic acid | Phosphonic acid, [1- | 3-Iodo-2,4-dioxopentanoic |
| acid | | (acetylamino)ethyl]- | acid |
| 2-(Cyclohex-2-en-1-yl)acetic | 2- | 3-Chloro-3-methyl pentanoic | Carboxymethyl-dimethyl- |
| acid | [Ethenyl(formyl)amino]propanoic | acid | (trifluoromethyl)azanium |
| | acid | | |
| 3- | 3,3-Dimethylbutan-2-yl | 2- | 2-Bromo-4,4- |
| Oxocyclopentanecarboxylic | hydrogen carbonate | (Trifluoromethyl)cyclopropane- | dichlorobutanoic acid |
| acid | | 1-carboxylic acid | |
| 3- | 2-Methylidene-4- | trans-2- | 3-Oxo-2,2,4- |
| [Methyl(nitro)ami- | methylsulfinylbutanoic acid | (Trifluoromethyl)cyclopro- | tris(sulfanyl)butanoic acid |
| no]propanoic acid | | panecarboxylic acid | |
| 2-(Tetrahydrofuran-2- | 2-[Ethyl(sulfanyl)amino]acetic | Trichloro(nitroperoxy)methane | 2-(1,3-Dithiol-2-yl)acetic |
| yl)acetic acid | acid | | acid |
| n-(Dichloroacetyl)glycine | 2-Methyl-4-oxobut-3-enoic | 2-(3-Hydroxypyridin-2-yl)acetic | 4-Imino-2-methylpent-2- |
| | acid | acid | enoic acid |
| 3,5-Dibromo-4-oxopentanoic | 2-Chloro-2-methoxycarbonyl- | 2-Chlorocyclopropane-1- | 4-Chloro-2-methylpent-2- |
| acid | 1-cyclopropanecarboxylic acid | carboxylic acid | enoic acid |
| [(2- | 1-Chloro-2- | 2-Oxo-1,3-dithiolane-4- | 2-(Chloromethyl)but-2- |
| Chloroethyl)sulfanyl]acetic | fluorocyclopropanecarboxylic | carboxylic acid | enedioic acid |
| acid | acid | | |
| (1s,2s)-2- | ETHYLPropiolate | 3,6-Dihydro-2H-pyran-4- | 3- |
| Chlorocyclohexanecarboxylic | | carboxylic acid | Hydroxysulfanyloxypropanoic |
| acid | | | acid |
| N-Chloroacetylglycine | 1-Chloro-1,2- | 2-Fluoro-2-nitroacetic acid | (3S)-3-[(2S)-Oxiran-2- |
| | cyclopropanedicarboxylic acid | | yl]butanoic acid |
| Difluoro(nitro)acetic acid | 2-Methylidene-5- | 2-Bromo-4-methoxy-4- | 2,4,4-Trichlorobutanoic acid |
| | sulfanylidenepentanoic acid | oxobutanoic acid | |
| 4-Thiazoleacetic acid | 2-Chloroprop-2-enyl hydrogen | 2,3-Dihydrothiophene-3- | 2-(2- |
| | carbonate | carboxylic acid | Sulfanylacetyl)sulfanylacetic |
| | | | acid |
| 2-Chloroisonicotinic acid | 5-Chlorocyclohexa-1,5-diene- | (Z)-Tamarindienal | 3-Methyl-4-nitrosobutanoic |
| | 1-carboxylic acid | | acid |
| 2-Bromo-3-methoxybutanoic | 2-[1- | Carbamodithioic acid, (2- | 3-Sulfanyl-2- |
| acid | Hydroxyethyl(methyl)amino]acetic | hydroxyethyl)methyl- | sulfanylidenepropanoic acid |
| | acid | | |
| Cyclopentanecarboxylicacid, | 3-Acetylcyclopentane-1- | 2,3-Dimethyloxirane-2- | 7-Oxa-1- |
| 3-(hydroxyimino)- | carboxylic acid | carboxylic acid | azabicyclo[4.1.0]heptane-2- |
| | | | carboxylic acid |
| 4-(Dimethylamino)butanoic | 3,3-Difluoro-3- | (2R,3S)-2,3-Dimethyloxirane-2- | (3S)-3- |
| acid | fluorosulfonylpropanoic acid | carboxylic acid | Methoxycarbonyloxirane-2- |
| | | | carboxylic acid |
| 3-(Dimethylamino)propanoic | 3-Hydroxyamino-butyric acid | 2- | 2-(2- |
| acid | | Methanesulfonamidopropanoic | Chloroethenylamino)oxyacetic |
| | | acid | acid |
| n-Acryloylalanine | Carboxymethyl-formyl- | 2-Methylfuran-3-acetic acid | 1,4-Oxathiane-3-carboxylic |
| | dimethylazanium | | acid |
| 2,6-Dichloropyrimidine-4- | 2-Chloro-2,3,3- | Chlorofluoronitroacetic Acid | 2-Aminooxy-4-chlorobut-2- |
| carboxylic acid | trimethylbutanoic acid | | enoic acid |
| 3-(Chloromethyl)benzoic | 2-Formylsulfanylacetic acid | 2,2-Difluoro-3-methylbut-3- | Furan-3-ylsulfanylformic |
| acid | | enoic acid | acid |
| 6-Fluoronicotinic acid | 2-(1- | Butanoic acid, 2,4-dimercapto- | 3-Hydroxy-2,4- |
| | (Hydroxymethyl)cyclopropyl)acetic | | bis(sulfanyl)butanoic acid |
| | acid | | |
| 4-Fluoro-3-methylbenzoic | 3-Methyloxaziridine-3- | (E)-4-Amino-5-fluoropent-2- | 2-Aminoperoxyacetic acid |
| acid | carboxylic acid | enoic acid | |
| 3-Chloro-2-methylprop-2- | Carboxy propan-2-yl | [Carboxy(hydroxy)phos- | 5-Methoxypent-2-enoic acid |
| enoic acid | carbonate | phoryl]formic acid | |
| 2- | 2,2-Dihydroxyethyl hydrogen | 1- | 5-Fluorocyclohexa-1,5- |
| (Isopropylidene- | carbonate | (Carboxymethyl)tetrahydrothiophene- | diene-1-carboxylic acid |
| aminooxy)propionic | | 1-ium | |
| acid | | | |
| [Butan-2- | Oxolan-2-ylsulfanylformic acid | Ethyl hydrogen chloromalonate | 2-(Tetrathiolan-5-yl)acetic |
| yl(nitroso)amino]acetic acid | | | acid |
| [Tert- | 3-Fluorovaleric acid | 5,5-Difluoropent-4-enoic acid | 3- |
| butyl(nitroso)amino]acetic | | | Methylidenephosphanyl- |
| acid | | | propanoic acid |
| 3-Methyl-4-oxopentanoic | 3-Fluorocaproic acid | 1,1-Difluoro-2-methoxy-2- | 3-Methylsulfonylbutanoic |
| acid | | oxoethanesulfonic acid | acid |
| (Z)-3-Acetamidoprop-2- | 2,3-Dichlorovaleric acid | Methyl 4-carboxy-2- | 2-(Fluoromethyl)pent-2- |
| enoic acid | | hydroxybutanoate | enoic acid |
| (2r,3s)-2,3- | 4-Carboxyoxybutanoic acid | 2,2,3,3-Tetrafluoro-3- | 3-Methyl-5-oxopent-2-enoic |
| Dichlorobutanedioic acid | | methylsulfonylpropanoic acid | acid |
| 5-Chloronicotinic acid | 2-Fluorosulfonyloxypropanoic | 2-Chloro-3-ethoxy-2-methyl-3- | Bicyclo[3.1.0]hexa-1,3,5- |
| | acid | oxopropanoic acid | triene-2-carboxylic acid |
| 5,6-Dichloronicotinic acid | 3-Acetyl-3-butenoic acid | Propanoic acid, 2-(acetylthio)- | 3,3,4-Trifluoro-4- |
| | | | methylpentanoic acid |
| 2,3-Dihydroxybutanoic acid | 4-Azidopentanoic acid | Bicyclo[2.2.1]hepta-2,5-diene- | 3-Isocyanatobutanoic acid |
| | | 2-carboxylic acid | |
| 5-Oxotetrahydrofuran-2- | 3-Chloro-4-methylpentanoic | 2-(1-Methylcyclopenta-2,4- | Dithiocarboxyperoxy- |
| carboxylic acid | acid | dien-1-yl)acetic acid | methanedithioic acid |
| 4-(Hydroxyamino)-4- | 2,2-Dichloro-2- | (E)-3-(Ethylthio)acrylic acid | 2-Carboxysulfanyl-2- |
| oxobutanoic acid | cyclopropylacetic acid | | sulfanylacetic acid |
| Tricyclo[3.2.1.0~2,4~]oct-6- | 4-Oxobuta-2,3-dienoic acid | 2-Propenoic acid, 3-(ethylthio)- | (5-Methylpyrazin-2-yl) |
| ene-3-carboxylic acid | | | hydrogen carbonate |
| 5-Methylnicotinic acid | 4-Hydroxy-2-methylidene-4- | 2-(Dimethylcarbamoyl)acetic | 2- |
| | oxobutanoate | acid | (Cyanomethoxyimino)acetic |
| | | | acid |
| (2S)-Norbornane-2- | 2-(Oxiran-2-ylmethoxy)prop-2- | 2-Oxoazetidine-1-acetic acid | (1R,2S)-2- |
| carboxylic acid | enoic acid | | Ethylcyclopropylacetic acid |
| 2-Fluoro-4-methylpentanoic | 1-Methoxycyclopropane-1- | 2-Methoxycarbonylprop-2- | 4,4-Bis(sulfanyl)butanoic |
| acid | carboxylic acid | enoic acid | acid |
| 3- | 2-Methyl-3-oxo-2,3- | 3-Methyl-2-sulfanylbutanoic | 2-Azabicyclo[3.1.0]hexa- |
| [Fluoro(dimethyl)silyl]propanoic | dihydropyridazine-4-carboxylic | acid | 1,3,5-triene-6-carboxylic |
| acid | acid | | acid |
| 3-(Acetylthio)propanoic acid | 3-Methylsulfinyl-2-oxopropanal | (2R)-3-Methyl-2- | 2-(2- |
| | | sulfanylbutanoic acid | Bromoethenylamino)oxyacetic |
| | | | acid |
| 3-Cyanopropanoic acid | 5-Chloro-6-methylnicotinic acid | Butanoic acid, 2-mercapto-3- | 3-(1-Methyl-2- |
| | | methyl-, (2S)- | oxocyclopropyl)propanoic |
| | | | acid |
| 3-(Oxolan-2-yl)propanoic | 6-Methyl-7- | (Fluorosulfonyl)acetic acid | 1-Methyl-3H-1,2-thiazole-4- |
| acid | oxabicyclo[4.1.0]heptane-3- | | carboxylic acid |
| | carboxylic acid | | |
| 2,2-Dimethyl-3- | 4-Methyl-5H-1,3-thiazole-4- | 2-Methylpyrimidine-5- | 3H-Pyridin-1-ium-4- |
| sulfanylpropanoic acid | carboxylic acid | carboxylic acid | carboxylic acid |
| n-(2-Chloroethyl)-n- | 2-Methylcyclopropane-1- | 2-[(E)- | 3-Hydroxy-4-sulfanyl-2- |
| methylglycine | carboxylate | Ethylideneaminoloxyacetic acid | sulfanylidenebutanoic acid |
| Pyridazine-3-carboxylic acid | 3-Cyano-2-oxopropanoic acid | 2,2-Dichloro-3,3,3- | 5-Chlorohexa-3,5-dienoic |
| | | trifluoropropionic acid | acid |
| Bicyclo[3.1.0]hexane-3- | 3-Nitro-2-oxopropanoic acid | 2-Chloro-3,3,3- | 3-Methoxybut-3-enoic acid |
| carboxylic acid | | trifluoropropanoic acid | |
| 3-Methyl-1,2-thiazole-5- | 2-(Chlorosulfonylamino)acetic | 2-Bromo-3,3,3- | Cyclohexa-2,5-dien-1-yl |
| carboxylic acid | acid | trifluoropropanoic acid | hydrogen carbonate |
| Bicyclo[3.1.0]hex-2-ene-6- | 1,3-Oxathiolane-2-carboxylic | (S)-2-Fluorocaproic acid | 4-Chloro-2-methylpenta- |
| carboxylic acid | acid | | 2,4-dienoic acid |
| 2-Hydroxyisonicotinic acid | 4,4-Difluoropentanoic acid | 1-Chlorocyclohexanecarboxylic | Cyclopropylsulfanylformic |
| | | acid | acid |
| 2- | 3-Methoxy-3-methylbutanoic | 2-Acetyllactic acid | 1,3-Dioxan-5-yl hydrogen |
| (Methoxycarbonyl)cyclobutane- | acid | | carbonate |
| carboxylic acid | | | |
| Bicyclo[4.1.0]hept-3-ene-7- | 3-Ethenoxy-2- | 2-Hydroxy-acetoacetic acid | 3-Methoxy-2- |
| carboxylic acid | methylidenebutanoic acid | | sulfanylpropanoic acid |
| 5-Methoxypentanoic Acid | (E)-3,5-Difluoro-2- | 3,4-Dihydro-2H-pyran-5- | 2-Azabicyclo[2.2.0]hexa- |
| | methylidenepent-4-enoic acid | carboxylic acid | 1(6),2,4-triene-6-carboxylic |
| | | | acid |
| Cyclohept-3-ene-1- | 4,5-Difluoro-2- | (2S)-2-Fluoro-2- | (Carbamoylamino) |
| carboxylic acid | methylidenepentanoic acid | methylhexanoic acid | hydrogen carbonate |
| 5-Oxo-2H-furan-3-carboxylic | 3,4,4-Trifluoro-2- | 1-(Propan-2-yl)cyclopropane-1- | 3,6-Dihydro-2H-pyran-6- |
| acid | methylidenebutanoic acid | carboxylic acid | carboxylic acid |
| Bicyclo[4.1.0]heptane-7- | 3-Fluoro-2- | [1,1′-Bi(cyclopropane)]-1- | 2-(Azidomethyl)-1- |
| carboxylic acid | methylidenebutanoic acid | carboxylic acid | chlorocyclopropane-1- |
| | | | carboxylic acid |
| 2-Acetamido-2- | (Z)-3,4,5-Trifluoro-2- | 5-Methyl-3,5-hexadienoic acid | 2-[Tris(sulfanyl)methyl]prop- |
| sulfanylpropanoic acid | methylidenepent-4-enoic acid | | 2-enoic acid |
| 4-(Methylamino)-4- | Bicyclo[2.2.1]hept-3-ene-2- | 2-[(2-Methylpropan-2- | Carbonothioic acid, S-(2- |
| oxobutanoic acid | carboxylic acid | yl)oxyamino]propanoic acid | furanyl) ester |
| Cyclohept-4-enecarboxylic | 2,2,3,4,4,4-Hexafluorobutyric | (Carboxymethyl)diethylsulfonium | 5-Methyl-6H-1,3-thiazine-4- |
| acid | acid | | carboxylic acid |
| 3-Methyl-4-oxopent-2-enoic | 2-Formyloxyethanesulfonic | 2-Sulfanylhexanoic acid | 2-Fluorooxyacetic acid |
| acid | acid | | |
| 1,3-Cyclopentadiene-1- | 7-Thiabicyclo[2.2.1]hept-5- | (Z)-2,3-Difluoropropenoic acid | 2,5-Dioxopent-4-enoic acid |
| carboxylic acid, 4-methyl- | ene-2-carboxylic acid | | |
| Bicyclo[2.1.0]pent-2-ene-5- | 4-Cyanobutanoate | N-Chloro-L-alanine | Thiophen-2-ylsulfanylformic |
| carboxylic acid | | | acid |
| 1,4-Cyclohexadiene-1- | 2-(1-Hydroxyethoxy)acetic | 2-Chloroaminopropionic acid | 3,3-Dichloro-5- |
| carboxylic acid | acid | | hydroxypentanoic acid |
| 2-Cyclopentylideneacetic | 3-Mercapto-4-methyl-valeric | 3-Cyanopropylphosphonic acid | 2-(3-Methyl-4H-triazol-2- |
| Acid | acid | | yl)acetic acid |
| 4-Oxepincarboxylic acid | 3-Methyl-4-sulfanylbutanoic | 3,4-Hexadienoic acid | 5-Fluoro-2,4- |
| | acid | | dioxopentanoic acid |
| 2-Methyl-1,3-dioxolane-2- | Prop-1-ynyl hydrogen | 2-(3-Hydroxyureido)acetic acid | 5-Fluoro-5-oxopentanoic |
| carboxylic acid | carbonate | | acid |
| 3-Methyloxazinane-6- | Chloroethyl carbonate | 1-Methylcyclopenta-2,4-diene- | 2- |
| carboxylic acid | | 1-carboxylic acid | Thiophosphorosooxyacetic |
| | | | acid |
| 3-Methoxy-2-methyl-3- | 2-Chloroethyl hydrogen | 2,2,2-Trifluoroethyl nitrate | 2-(Ethoxyamino)prop-2- |
| oxopropanoic acid | carbonate | | enoic acid |
| S-(N,N- | 6-Fluoro-2- | 3,3- | 1-Chloroprop-2-enyl |
| Dimethylthiocar- | oxobicyclo[3.1.0]hexane-6- | Difluorocyclobutanecarboxylic | hydrogen carbonate |
| bamoyl)thioglycolic | carboxylic acid | acid | |
| Acid | | | |
| 3-Chloro-2-fluorobenzoic | 2- | 2-Fluoro-2-nitroacetic acid | 2-Prop-2-enoyloxyprop-2- |
| acid | Carbonochloridoylcyclopropane- | methyl ester | enoic acid |
| | 1-carboxylic acid | | |
| 3-(Dimethylamino)prop-2- | 3- | 2-Methyl-5-oxovaleric acid | 4-Formamidobut-2-enoic |
| enoic acid | Hydroxycyclobutanecarboxylic | | acid |
| | acid | | |
| 1,3-Dithiane-2-carboxylic | 3-Hydroxypyridine sulfate | 2,3-Dimethyl-5-oxopentanoic | 2-Bromo-3-methylbut-3- |
| acid | | acid | enoic acid |
| 2-Propenoic acid, 3- | (5-Chlorooxolan-2- | 2,3-Difluoropropanoic acid | 2-Ethenylsulfanylacetic acid |
| thiocyanato-, (Z)- | yl)phosphonic acid | | |
| 4,5-Dichlorothiophene-2- | 5-Methyloxazole-2-carboxylic | 3-Chloro-2-fluoropropanoic | 2- |
| carboxylic acid | acid | acid | Methoxycarbonyliminopropanoic |
| | | | acid |
| 2-(Acetylamino)butanoic | 2-(Dimethylamino)propanoate | 1-Hydroxypyrazole-4-carboxylic | 4-Cyano-2-methylbut-2- |
| acid | | acid | enoic acid |
| 3-(Dichloroamino)propanoic | Fluoro-beta-alanine | Thiopropionylmercapto-acetic | 3-Oxo-2,2- |
| acid | | acid | bis(sulfanyl)butanoic acid |
| 4-Methylsulfinylbutanoic | 2,3-Difluorobutanedioic acid | 3-Azidobutyric acid | 2-Bromo-1- |
| acid | | | chlorocyclopropane-1- |
| | | | carboxylic acid |
| 2-Bromobut-2-enedioic acid | 2- | 2-Bromo-3-chloro-succinic acid | (2S)-3-Nitrobutan-2-ol |
| | [Acetyl(methyl)amino]acetate | | |
| 2-Chloro-3-methylbutanoic | 2-Nitrosoprop-2-enoic acid | Thiomaleinsaure | 2- |
| acid | | | [Bis(phosphanyl- |
| | | | methyl)aminolacetic acid |
| 2- | 4,5-Dihydro-1,2-oxazole-5- | 2-Chloro-3,3-difluorobutanoic | 3-lmino-2- |
| [Methyl(nitroso)amino]propanoic | carboxylic acid | acid | methylidenebutanoic acid |
| acid | | | |
| 4-Bromo-3-methylbut-2- | 2-Carboxyoxypropanoic acid | 3-Chlorocyclobutanecarboxylic | 2-(Prop-1-en-2- |
| enoic acid | | acid | ylamino)oxypropanoic acid |
| 2- | 2-(Cyanomethylimino)acetic | (Z)-3-Chloro-4,4,4-trifluorobut- | 2-(Prop-1-en-2- |
| Bromocyclopropanecarboxylic | acid | 2-enoic acid | ylamino)oxyacetic acid |
| acid | | | |
| 2-Pentynoic acid | 3-Diazopropanoic acid | 4-Chloro-4-oxobutanoic acid | 2-Methylsulfanyloxyethyl |
| | | | hydrogen carbonate |
| 2-Hexynoic acid | 1,4,5,6-Tetrahydropyridazine- | (2E)-2-Methyl-4-oxo-2- | 4,4-Bis(sulfanyl)pentanoic |
| | 6-carboxylic acid | pentenoic acid | acid |
| 3-Bromoisoxazole-5- | 4-Amino-3-methoxybutanoic | (E)-2-Fluoro-4-methyl-2- | 2-Ethylidenecyclopropane- |
| carboxylic acid | acid | pentenoic acid | 1-carboxylic acid |
| Erythro-beta- | 2-Hydroxy-2-prop-2- | 1- | 2-(Oxolan-3-yl)-2- |
| Fluoroasparagine | enoyloxyacetic acid | (Methoxycarbonyl)cyclopro- | sulfanylacetic acid |
| | | panecarboxylic acid | |
| 2-Amino-3-fluoro-4- | 1,3,2-Diazaphospholidine-2- | (Cyclopent-3-en-1-yl)acetic | 2- |
| methoxy-4-oxobutanoic acid | carboxylic acid | acid | Dimethylphosphanylpropanoic |
| | | | acid |
| [Acetyl(methyl)amino] | 5-Oxo-4,5-dihydro-1H- | 4,5-Dimethylfuran-3-carboxylic | Carbonobromidoyl |
| methanesulfonate | imidazole-2-carboxylic acid | acid | hydrogen carbonate |
| 3-Ethoxybut-2-enoic acid | 2,2,3,3,4-Pentafluorobutanoic | 2-Chloro-3-fluoro-4- | 2-Oxo-4- |
| | acid | nitropyridine | (mercaptomethyl)butanoic |
| | | | acid |
| 3-Ethoxy-acrylic acid | 3-Ethenoxypropanoate | 3-Methoxy-2,2-dimethyl-3- | 4-Phosphanylpentanoic |
| | | oxopropanoic acid | acid |
| 2-Fluoroisonicotinic acid | 4-Mercapto-hexanoic acid | (2E)-2-Methoxyiminopropanoic | 4-Chloro-3,3- |
| | | acid | dimethylpentanoic acid |
| 2-(Formyloxy)propanoic acid | N-Propionylalanine | 4-Methoxy-3-methyl-4- | 2-(Carboxyoxyamino)acetic |
| | | oxobutanoic acid | acid |
| Propanoic acid, 2- | (2S)-2-Thionitrosopropanoic | 2-Carbamoyl-2,2- | 2-Sulfanyloxypropanoic |
| [(chloroacetyl)oxy]- | acid | dimethylacetic acid | acid |
| 2-Propanoyloxypropanoic | Fluoroalanine | 3,3-Difluoro-4-methoxy-4- | 4- |
| acid | | oxobutanoic acid | (Dimethylaminosulfanyl)butanoic |
| | | | acid |
| 2-(Acetyloxy)-2- | (3R)-3- | 3-Diazoniobenzoate | 2-[Bis(sulfanyl)amino]acetic |
| methylpropanoic acid | (Dimethylamino)butanoic acid | | acid |
| 2-(Thiazol-5-yl)acetic acid | 4-Methyl-5-oxo-L-proline | 2-Fluoromaleic acid | 2-(2,5-Dihydropyridin-3- |
| | | | yl)acetic acid |
| 2-Methyl-3- | (1 R,2S)-2-(2- | alpha-Iodofumaric acid | 4-Nitrosopentanoic acid |
| oxocyclopentane-1- | Bromoethyl)cyclopropane-1- | | |
| carboxylic acid | carboxylic acid | | |
| 3-Carbamoylcyclopentane- | (2S)-2-Nitrosopentanedioic | 2-Acetyllactate | 3-[(2R)-3-Oxothiolan-2- |
| 1-carboxylic acid | acid | | yl]propanoic acid |
| 1H-Triazirine-1-aceticacid | N-Methacryloylalanine | (2S)-2-Hydroxy-2-methyl-3- | 4-Amino-3-methyl-4-oxobut- |
| | | oxobutanoate | 2-enoic acid |
| 2- | 4-Amino-3-methylisothiazole- | (2S,4R)-2-Amino-4- | 4- |
| [Amino(ethyl)amino]propanoic | 5-carboxylic acid | hydroxypentanoic acid | [Methoxy(methyl)amino]but- |
| acid | | | 2-enoic acid |
| 4-Hydroxybut-2-ynoic acid | (2R)-2-Methyl-3- | 2-Methoxybut-3-enoic acid | 5,5-Difluoro-2-methylpent- |
| | sulfanylpropanoate | | 2-enoic acid |
| 3-Methylene-cyclopropane- | 3-Trimethylsilyl-propionate- | 2-Ethoxybut-3-enoic acid | 3- |
| 1,2-dicarboxylic acid | 2,2,3,3,-D4 | | (Methylaminosulfanyl)propanoic |
| | | | acid |
| 2,3-Difluorobenzoic acid | (2S)-2- | (4S)-4-Amino-2-pentenoic acid | Thiophen-3-yl hydrogen |
| | (Sulfinylamino)propanoic acid | | carbonate |
| 1- | [(2R)-1-Cyanopropan-2- | 3,8- | 5-Imino-4-oxopentanoic |
| (Dimethylamino)cyclopro | yl]carbamic acid | Dioxatricyclo[3.2.1.02,4]octane- | acid |
| panecarboxylic acid | | 6-carboxylic acid | |
| 1- | (2- | 2-(2-Oxooxolan-3-yl)acetic acid | 1,4-Dithiine-2-carboxylic |
| (Trimethylammonio)cyclo- | Dimethylphosphoryl- | | acid |
| propanecarboxylate | acetyl)oxidanium | | |
| 3-Sulfopropanoic acid | Carboxymethyl-methyl- | (E)-5-Oxohex-3-enoic acid | 3-(Oxiran-2-yl)prop-1-ene- |
| | sulfanylidenephosphanium | | 1-sulfonic acid |
| 1-Propanesulfonic acid, 3- | 2,2,2-Trifluoroethyl | 2- | Carboxy 3- |
| amino-3-oxo- | hydrogen carbonate | Methylenecyclohexane- | hydroxybutanoate |
| | | carboxylic acid | |
| 3-Methyl-3-butenoic acid | 2-Oxoethyl hydrogen | 3-(Hydroxymethyl)oxirane-2- | 3-Nitroprop-1-en-1-one |
| | carbonate | carboxylic acid | |
| 2-Carbamoyl-2,2- | Oxetan-3-yl hydrogen | 2-(Formamido)acrylic acid | 3-Chloro-5- |
| difluoroacetic acid | carbonate | | sulfanylpentanoic acid |
| 2-Butenoic acid, 4- | 2-Formyloxyacetic acid | (2Z)-2-Chloropenta-2,4-dienoic | (2S)-2-(2- |
| (dimethylamino)-4-oxo-, | | acid | Aminohydrazinyl)propanoic |
| (2Z)- | | | acid |
| 4-Methoxypentanoic acid | 4-Formyloxybutanoic acid | 1-Acetylcyclopropanecarboxylic | 5,5-Dichloropent-2-enoic |
| | | acid | acid |
| 2-Sulfopropanoic acid | 4-Nitroso-4-oxobutanoic acid | 5-Methylcyclohexa-1,5-diene-1- | (2S,3S)-3-Fluoro-2- |
| | | carboxylic acid | methylbutanoic acid |
| 1-Methoxy-1-oxo-2- | 3- | (Z)-3-Chloro-2-fluoroprop-2- | 4-Chlorobut-3-enoic acid |
| propanesulfonic acid | Methoxycyclobutanecarboxylic | enoic acid | |
| | acid | | |
| Tetrahydrothiophene-3- | 2,3,3-Trifluorooxirane-2- | Difluoromethylthio acetic acid | 4-Bromo-4-fluorobutanoic |
| carboxylic acid 1,1-dioxide | carboxylic acid | | acid |
| 3-Oxo-butane-1-sulfonic | Propanedioic acid, 2-methyl-, | (Z)-3-(Methylthio)acrylic acid | 2-Chloro-2-(oxiran-2- |
| acid | 1-methyl ester | | yl)acetic acid |
| 2-Nitramidopropanoic Acid | 2-Methyl-1,3-dioxolane-4- | 3-(3-Methyl-3H-diazirin-3- | 3H-Pyridin-1-ium-4- |
| | carboxylic acid | yl)propanoic acid | ylmethanesulfonic acid |
| «2- | 1H-Imidazole-1-acetic acid, | 2-Chloro-3-methoxypropionic | 2-Nitrosobut-2-enedioic |
| Oxopropylidene)amino)acetic | 2,3-dihydro-2-thioxo- | Acid | acid |
| acid | | | |
| 3-Nitroprop-2-enoic acid | 2-Methanethioylsulfanylacetic | 2- | 2-Ethyl-4-oxobut-2-enoic |
| | acid | Methoxycyclopropanecarboxylic | acid |
| | | acid | |
| D-Pyroglutamic acid | (2R)-2-Bromo-5- | 2-Acetyloxyethanethioic S-acid | 3-Oxobut-1-enylphosphonic |
| | sulfanylidenepentanoic acid | | acid |
| 2-Oxosuccinamic acid | (2S)-2-Bromo-5- | 4-Ethoxy-4-oxobut-2-ynoic acid | Azetidin-1-ylsulfanylformic |
| | sulfanylidenepentanoic acid | | acid |
| 5-Oxopentanoic acid | 4-Oxopentane-2-sulfonic acid | 1,2,2-Trichlorocyclopropane-1- | 3-Fluoro-2-oxopropane-1- |
| | | carboxylic acid | sulfonic acid |
| 2-Amino-4-oxopentanoate | 2- | (E)-4-Sulfanylbut-2-enoic acid | (2E)-Hexa-2,4-dienoic acid |
| | [Dimethylcarbamoyl(hy- | | |
| | droxy)amino]acetic acid | | |
| 3,4-Dihydro-2H-pyrrole-5- | 3- | 1- | 5,5,5-Trifluoropent-2-enoic |
| carboxylic acid | [Acetyl(hydroxy)amino]propanoic | Acetoxycyclopropanecarboxylic | acid |
| | acid | acid | |
| 1,2-Propanediol, 1- | 2-(2-Methyloxolan-3-yl)acetic | 4-Chloropentanoic acid | 4-Oxo-4-sulfanylbut-2-enoic |
| phosphate | acid | | acid |
| 3-Sulfanyl-2- | (4H-Pyran-4-ylidene)acetic | Methyl(2,2,2- | 4-Chloro-3-hydroxy-2- |
| (sulfanylmethyl)propanoic | acid | trifluoroethyl)sulfamic acid | oxobutanoic acid |
| acid | | | |
| 4-Oxoglutaramate | Tetrahydro-2H-pyran-3- | 4-Methoxy-4-oxobut-2-ynoic | 3-Chloro-2- |
| | ylacetic acid | acid | sulfanylpropanoic acid |
| 2-Amino-4-cyanobutanoic | N-Ethylidene-glycine | 2- | 2- |
| acid | | [(Methoxy- | [Carbamoyl(sulfanyl)amino] |
| | | carbonyl)(methyl)amino- | acetic acid |
| | | lacetic acid | |
| (2S)-2-Hydroxy-2-methyl-3- | Carboxymethoxymethyl- | 2-Cyanoethyl dihydrogen | 4,5-Bis(sulfanyl)pentanoic |
| oxobutanoic acid | ideneoxidanium | phosphite | acid |
| 6-Oxohexanoic acid | (2Z)-4-Hydroxypenta-2,4- | 1-Chloro-1-fluoro-1- | 2-[Bis(sulfanyl)methyl]prop- |
| | dienoic acid | nitropropan-2-one | 2-enoic acid |
| beta-Alanine betaine | 1-Dimethylphosphoryl-1- | 2,3,3-Trichloro-2,3- | 2-(2,5-Dihydro-1,2-oxazol- |
| | nitroethane | difluoropropanoic acid | 5-yl)acetic acid |
| 2-Tetrahydrothiopheneacetic | 2-Trimethylsilyloxypropanoic | 2,3-Dichloro-2,3,3- | 2-Isocyanato-2,2- |
| acid | acid | trifluoropropanoic acid | bis(sulfanyl)acetic acid |
| Tetrahydrothiophene-2- | 2-(4-Chloropyrimidin-5- | 2-Bromo-3-chloro-2,3,3- | 2-(2,5-Dihydro-1,2-oxazol- |
| carboxylic acid | yl)acetic acid | trifluoropropanoic acid | 3-yl)acetic acid |
| 5-N-Methyloxaluric acid | 4-Formyloxy-4-oxobutanoic | 3-Bromo-2-chloro-2,3,3- | 3-Ethylsulfonylprop-2-enoic |
| | acid | trifluoropropanoic acid | acid |
| Maleic acid | 5-Fluoro-4-hydroxypentanoic | 2,2,3-Trichloro-3,3- | 2-(3H-Pyridin-1-ium-5- |
| | acid | difluoropropanoic acid | yl)acetic acid |
| Fumaric acid | 2,2,3,3-Tetrafluoro-4- | 2,3,3-Trichloro-2- | 1-Chloro-2- |
| | fluorooxy-4-oxobutanoic acid | fluoropropanoic acid | methylcyclopropane-1- |
| | | | carboxylic acid |
| 2,3-Dihydrobenzoic acid | 2-Bromo-2-fluoropropanedioic | 2-Bromo-2,3-dichloro-3- | (2-Methylthiophen-3-yl) |
| | acid | fluoropropanoic acid | hydrogen carbonate |
| 3-Oxiran-2ylalanine | (2E)-2,4-Dimethylpenta-2,4- | 2,3,3-Trichloro-3- | 3-Methyl-2,3- |
| | dienoic acid | fluoropropanoic acid | bis(sulfanyl)butanoic acid |
| (3R)-3-Hydroxy-3-methyl-5- | 2-Methylimidazole-2-carboxylic | 3-Bromo-2-chloro-2- | (3-Oxopyrazolidin-1-yl) |
| oxopentanoic acid | acid | fluoropropanoic acid | hydrogen carbonate |
| (2R)-2- | 2,2,4-Trifluoro-3-oxobutanoic | 2,3-Dichloro-3,3-difluoro-2- | 5-Fluoro-5- |
| (Propanoylamino)propanoic | acid | methylpropanoic acid | hydroxypentanoic acid |
| acid | | | |
| Thiophosphonoformic acid | (Z)-3-Chloro-2-methylbut-2- | 5-Oxo-4,5-dihydrofuran-3- | Methyl N- |
| | enoic acid | carboxylic acid | phosphonooxycarbamate |
| N-(Methoxycarbonyl)glycine | alpha,beta-Dichloropropionate | Fluoroglycine | Phosphorosooxymethyl- |
| | | | phosphonic acid |
| Fluoro(phosphono)acetic | 2-Prop-2-enoyloxyacetate | 3,3,3-Trichloropropanoic acid | 5-Fluoro-2-methylpent-2- |
| acid | | | enoic acid |
| 2- | 2-[Tert- | 5-Thioxo-L-proline | 2,5-Dihydropyridine-4- |
| Dihydroxyphosphinothioylacetic | butyl(chloro)amino]acetic acid | | carboxylic acid |
| acid | | | |
| 3-Mercapto-valeric acid | 1-Chloro-piperidine-4- | 4-Methylpentanoic acid-1-13C | 4-Diazenylbutanoic acid |
| | carboxylic acid | | |
| 2- | 4-Nitrooxy-4-oxobutanoic acid | 4-Hydroxy-2-methyl-valeric | 4-Methyl-2-oxo-4-pentenoic |
| [Hydroxy(methyl)phosphoryl] | | acid | acid |
| acetic acid | | | |
| Isopropoxyacetic acid | 3-Aminooxybutanoic acid | N-(Cyanomethyl)glycine | 3,3-Difluoro-2- |
| | | | sulfanylpropanoic acid |
| 2-Iodoacetate | 2-Hydroxypropyl hydrogen | 3-Amino-2-methylpyridine-4- | (2-Amino-1-chloro-2- |
| | carbonate | carboxylic acid | oxoethyl) hydrogen |
| | | | carbonate |
| 3,4-Dichloro-2,2,3,4,4- | 2-(6-Oxabicyclo[3.1.1]heptan- | 2-(2,2- | 5-Aminooxypent-2-enoic |
| pentafluorobutanoic acid | 2-yl)acetic acid | Difluorocyclopropyl)acetic acid | acid |
| Butanedioic acid, ethyl | 1- | 3-(Difluoromethyl)benzoic acid | 4-Formyloxy-4-oxo-2- |
| methyl ester | ((Dimethylamino)methyl)cyclo- | | sulfanylbutanoic acid |
| | propanecarboxylic acid | | |
| Peroxynitric acid, | 2-Fluoro-5-oxooxolane-2- | 3-(Oxiran-2-YL)propanoic acid | (2R)-2-Amino-2-methyl-3- |
| dichlorofluoromethyl ester | carboxylic acid | | oxobutanoic acid |
| 3-Formamidopropanoic acid | 2-(3,4-Dihydropyridin-3- | Acetic acid, chloronitro- | 5-lodopent-4-enoic acid |
| | yl)acetic acid | | |
| 2,3-Dichlorobutanoic acid | 2-Ethylcycloprop-2-ene-1- | 2-(Hydroxymethyl)-2- | 1-Amino-2-(2- |
| | carboxylic acid | methylcyclopropane-1- | oxoethyl)cyclopropane-1- |
| | | carboxylic acid | carboxylic acid |
| 4-Hydroxy-2-methylpent-2- | 4,5-Dihydro-1,3-thiazole-5- | 2-Iodoisonicotinic acid | 4-Bromo-4-chlorobutanoic |
| enoic acid | carboxylic acid | | acid |
| 1,2- | 3,3,4-Trifluorobutanoic acid | 1-Methylcyclopent-3- | (4S)-4-Hydroxy-3-methyl-2- |
| Dimethylcyclopropanecarboxylic | | enecarboxylic acid | oxopentanoic acid |
| acid | | | |
| 3-Methoxymethoxybutyric | Poly(lactic acid-co-glycolic | 5-Methoxyhexanoic acid | 2-(Sulfanylmethyl)prop-2- |
| acid | acid) | | enoic acid |
| (Isopropylthio)acetic acid | 2-(Oxetan-2-ylmethyl)prop-2- | (2R)-2-Hydroxy-4-oxopentanoic | (2S)-1-Chloro-4- |
| | enoic acid | acid | oxopyrrolidine-2-carboxylic |
| | | | acid |
| 3-Methoxy-3-oxopropanoic | 2-[Tert- | 4-Methoxy-2-methylbutanoic | 2,2-Dichloro-2-(2- |
| acid | butyl(chloro)amino]propanoic | acid | chloroacetyl)oxyacetic acid |
| | acid | | |
| 4-Oxopentanethioic acid | 5,5-Difluoro-2- | 5-Methylcyclohex-3-ene-1- | 2-Methyl-2- |
| | methylidenepentanoic acid | carboxylic acid | (methylideneamino)propanoic |
| | | | acid |
| 4-Hydroxypent-2-enoic acid | Cycloprop-2-ene-1,2- | 2-Dithiocarboxysulfanylacetic | (1R,2S)-2-(Carboxymethyl)- |
| | dicarboxylic acid | acid | 1-methylcyclopropane-1- |
| | | | carboxylic acid |
| 2-Methyl-1,3-oxazole-4- | 2- | 2-Nitropropanoic acid | 2- |
| carboxylic acid | [Aminooxy(hydroxy)phos- | | Carbamoyloxysulfanylacetic |
| | phoryl]acetic acid | | acid |
| 3- | 2,4-Dioxoheptanoic acid | 2-Bromo-3-methoxypropanoic | Pyridin-3-ylsulfanylformic |
| [Acetyl(methyl)amino]propanoic | | acid | acid |
| acid | | | |
| 3-(Carboxymethyl)-1,2,3- | (E)-4,5-Dioxohex-2-enoic acid | Fumaraldehydic acid dimethyl | 2-Chloro-4-iodobutanoic |
| oxadiazol-3-ium-5-olate | | acetal | acid |
| 3-Methyloxirane-2- | Acetamidoglycine | Methyl 2-nitrooxypropanoate | 3- |
| carboxylic acid | | | (Dimethylaminosul- |
| | | | fanyl)propanoic acid |
| 2-Chloro-3-hydroxy-butyric | 2-Methyl-3-oxiranylpropionic | 3,4-Dichlorobutanoic acid | (Carbamothioylamino) |
| acid | acid | | hydrogen carbonate |
| 2- | 3-Hydroxybutyl hydrogen | (Z)-2-Fluoro-4,4-dimethylpent- | Ethyl-fluoro-methyl-(2- |
| (Methoxymethoxy)propanoic | carbonate | 2-enoic acid | sulfoethyl)azanium |
| acid | | | |
| Methyl 2-nitropropanoate | 3-Chlorooxy-3-oxopropanoic | 3-Methylcyclobutene-1- | Thiocyanatooxymethanedithioic |
| | acid | carboxylic acid | acid |
| Methyl 3-nitropropanoate | Cycloheptyl hydrogen | 2,2-Difluoro-1- | Hydroperoxyperoxyperoxy |
| | carbonate | methylcyclopropanecarboxylic | hydrogen carbonate |
| | | acid | |
| 1-Cyclopenteneacetic acid, | 2-Chloro-2- | (3-Carboxy-3- | Nitrooxymethanesulfonic |
| 5-oxo- | methylsulfanylacetic acid | oxopropyl)(hydroxy)oxophosphanium | acid |
| 4-Oxotetrahydro-2H-pyran- | 3,4,4-Trichlorobutanoic acid | 2-Chloro-2-fluoro-1- | Carboxyoxycarbonyl |
| 2-carboxylic acid | | methylcyclopropane-1- | formate |
| | | carboxylic acid | |
| 5-Hydroxyhex-2-enoic acid | (2,2-Dimethylcyclopropyl) | 2-Bromo-2-fluoro-1- | 2-[1,2- |
| | hydrogen carbonate | methylcyclopropane-1- | Bis(sulfanyl)ethylsulfanyl]acetic |
| | | carboxylic acid | acid |
| (2-Methyl-1,3-dioxolan-2- | 3-Formyl-2- | 2-Fluoro-1- | 2-(2- |
| yl)acetic acid | methylidenepentanoic acid | methylcyclopropane-1- | Hydroxyethylimino)acetic |
| | | carboxylic acid | acid |
| 1,2-Dithiane-3-carboxylic | Cyclobutylmethyl hydrogen | 2-Azidopropionic acid | 2-Methylidene-4- |
| acid | carbonate | | phosphanyloxybutanoic |
| | | | acid |
| 1,4-Dihydro-2- | 4-Hydroxy-3-methyl-2- | (R)-2-Azidopropanoic acid | (3R)-2-Amino-3- |
| methylbenzoic acid | sulfanylbutanoic acid | | methoxybutanoic acid |
| 2-Chlorohexanoic acid | 4-Hydroxy-2-sulfanylpentanoic | 2-Amino-3- | 2,4-Difluoro-4-oxobut-2- |
| | acid | methanesulfonylpropanoic acid | enoic acid |
| 2-Chloro-3-hydroxypropionic | 2-(Oxiran-2-yl)propanoic acid | 2-Acetoxymethyl-acrylic acid | 5-Hydroxy-3- |
| acid | | | sulfanylpentanoic acid |
| 1,2-Dimethyl-cyclopent-2- | 2-Oxobutane-1-sulfonic acid | 2-(Formyloxymethyl)prop-2- | 4-Oxopent-2-ynoic acid |
| enecarboxylic acid | | enoic acid | |
| 2-Methylidenecyclopropane- | (5-Oxooxolan-2-yl) hydrogen | 5,6-Dihydro-2H-pyran-3- | 3-Ethoxy-2-hydroxybutanoic |
| 1-carboxylic acid | carbonate | carboxylic acid | acid |
| 1-Methyl-1,2- | 1-Acetylaziridine-2-carboxylic | 2-Methylcyclohex-2-ene-1- | 3-Formyl-4-oxobutanoic |
| cyclopropanedicarboxylic | acid | carboxylic acid | acid |
| acid | | | |
| 6-Amino-6-oxohexanoic acid | 2-Methyl-2-sulfanylpent-4- | 2-Propylcyclopropane-1- | 3-Methoxysulfanylbutanoic |
| | enoic acid | carboxylic acid | acid |
| 4,5-Dihydrofuran-3- | 2-(2-Formylhydrazinyl)acetic | (1R,2R)-2-Propylcyclopropane- | 2-Methyl-3,3- |
| carboxylic acid | acid | 1-carboxylic acid | bis(sulfanyl)propanoic acid |
| 2-Butenoic acid, 4,4- | 3,3,3-Trifluoropropyl hydrogen | (E)-5-Hydroxypent-2-enoic acid | 2-(2-Methylthiolan-3- |
| dimethoxy-, methyl ester, | carbonate | | yl)acetic acid |
| (Z)- | | | |
| 2-(Trifluoromethyl)acrylic | 3-Methylazete-2-carboxylic | 4-Methyl-3-furancarboxylic acid | 3,3-Dichloro-2,4- |
| acid | acid | | dioxopentanoic acid |
| 1,3-Dimethyl-1H-pyrazole-5- | (E)-4-Fluoro-3-methylpent-2- | 2-Methylcyclopent-2-ene-1- | Piperidin-1-ylsulfanylformic |
| carboxylic acid | enoic acid | carboxylic acid | acid |
| 3-Methylisothiazole-4- | 4-(Difluoroamino)butanoic acid | 3-Bromo-3,3-difluoropropanoic | (R)-Methyl 2- |
| carboxylic acid | | acid | ((methylsulfonyl)oxy)propanoate |
| 6-Methoxynicotinic acid | 3-Chlorosulfanylpropanoic acid | (2E)-4-(Dimethylamino)but-2- | 2-Methylsulfanyloxyacetic |
| | | enoic acid | acid |
| 1-Methyl-6-oxo-1,6- | 2,2,3,4-Tetrafluorobut-3-enoic | 4-Methylidenecyclohexane-1- | 2-Oxobutyl carbonate |
| dihydropyridine-3-carboxylic | acid | carboxylic acid | |
| acid | | | |
| 1,2-Dithiane-4-carboxylic | 2-Nitrooxyethyl acetate | 4,4-Difluoro-3-butenoic acid | 4-Isothiocyanatobut-3-en-2- |
| acid | | | one |
| (2S)-5-Oxooxolane-2- | Thietane-3-carboxylic acid | 2-(2-Chloro-2- | 2-Imino-1,2lambda~4~- |
| carboxylic acid | | fluorocyclopropyl)acetic acid | oxathiolane-4-carboxylic |
| | | | acid |
| trans-3-Chloroacrylic acid | 2-(N- | 1-Methyl-2-oxopyrrolidine-3- | 3-Hexenal, 2,5-dioxo- |
| | Methylformamido)propanoic | carboxylic acid | |
| | acid | | |
| 4-Hexenoic acid | 2,3-Dichloro-4-nitropyridine | (E)-3-Cyanoacrylic acid | Propanoic acid, 2- |
| | | | (bromoimino)-(9CI) |
| 2,3-Dichloro-2-butenedioic | 2-(2-Ethenylcyclopropyl)acetic | 2-(Bicyclo[1.1.1]pentan-1- | 2- |
| acid | acid | yl)acetic acid | Methoxyethyl(methyl)carbamic |
| | | | acid |
| (2R)-2-Sulfanylbutanedioic | 5-Fluorocaproic acid | 4-Methoxy-4-oxo-2- | 2-Methyl-4-(oxiran-2-yl)but- |
| acid | | sulfanylbutanoic acid | 2-enoate |
| 3-Cyclopropylprop-2-ynoic | 3-Methoxybutane-2-sulfonic | N-Amino-N-nitronitramide | 5-Methylpyridazine-4- |
| acid | acid | | carboxylic acid |
| Bromofumaric acid | Methylsulfonyl N- | (Acryloyloxy)acetic acid | (3R,4R)-4-Hydroxy-3- |
| | ethylethanimidate | | methylpentanoic acid |
| 2,5-Hexadienoic acid | 4-Amino-4-oxobut-2-ynoic acid | (R)-2-(Tetrahydrofuran-3- | 2-Fluoro-2-methoxyacetic |
| | | YL)acetic acid | acid |
| 2-Butenoic acid, 2,3- | 2-Methyl-4-oxo-2- | (S)-2-(T etrahydrofuran-3- | 2,2-Difluoro-2-(oxan-4- |
| dichloro-, (2E)- | sulfanylpentanoic acid | YL)acetic acid | yl)acetic acid |
| 2,3-Dichloroisocrotonic acid | 4-Hydroperoxybutanoic acid | (Tetrahydrothiophen-3-yl)acetic | 4-Amino-3-iodo-4- |
| | | acid | oxobutanoic acid |
| 5-Bromopent-4-enoic acid | 2-(4-Sulfanylthiadiazol-5- | 4,5-Dichloropentanoic acid | (1-Methylcyclopentyl) |
| | yl)acetic acid | | hydrogen carbonate |
| 4-Methyl-2-pentenoic acid | (Z)-4-Methoxypent-3-enoic | 4-Methyl-5-oxo-2,5- | Sulfanylcarbonylsulfanylformic |
| | acid | dihydrofuran-3-carboxylic acid | acid |
| 3-Isoxazolecarboxylic acid, | 2,2-Difluoro-3,3- | (Tetrahydro-pyran-4-ylidene)- | (Iminomethoxy)acetic acid |
| 4,5-dihydro- | dimethylbutanedioic acid | acetic acid | |
| 2-Butenoic acid, 3-chloro-, | 2-Ethylsulfinyl-2- | 2-(3-Chloropropanoyloxy)acetic | Azidoacetate |
| (E)- | methylpropanoic acid | acid | |
| 2-Butenoic acid, 3-chloro- | 2-Methylsulfinylpropanoic acid | [1,3]Dithiolan-2-yl-acetic acid | (E)-4-Methoxy-3-methylbut- |
| | | | 2-enoic acid |
| 1-Methyl-1H-pyrazole-5- | 2-Bromo-3-sulfanylpropanoic | 3,3-Dimethyl-2-sulfanylbutanoic | 3-Fluoro-3-oxopropanoic |
| carboxylic acid | acid | acid | acid |
| 1-Methyl-1H-pyrazole-4- | 4-Chloro-3-methylbutanoic | S- | (E)-2-Methyl-5-sulfanylpent- |
| carboxylic acid | acid | Methoxymethylmercaptoacetic | 2-enoic acid |
| | | acid | |
| 5,5-Dichloro-4-oxopentanoic | 3-Isocyanato-3-methylbutanoic | 2-Chloro-3-methylisonicotinic | 1-Carboxypropan-2- |
| acid | acid | acid | yl(trimethyl)azanium |
| Sorbic acid | Allylmethyl carbonate | 3-Methoxy-2- | 3-(18F)Fluoranylbenzoic |
| | | methylidenebutanoic acid | acid |
| (Z)-2-Pentenoic acid | But-3-enyl hydrogen carbonate | (Z)-4-Chloro-2,2-dimethylbut-3- | 3- |
| | | enoic acid | (Hydroxymethoxy)propanoic |
| | | | acid |
| (Z)-3-Iodoacrylic acid | 2-Methyloxazole-5-carboxylic | 4,4-Dichloro-2,2-dimethylbut-3- | 5-Deuterio-5-oxopentanoic |
| | acid | enoic acid | acid |
| Nicotinic acid,[carboxyl-14C] | 4-Chloro-3-methyl-1,2- | 3-Fluoro-2,2-dimethylbutenoic | (1R,4R)-4-Methylcyclopent- |
| | thiazole-5-carboxylic acid | acid | 2-ene-1-carboxylic acid |
| (1S,2R,4S)- | Butanedioic acid, chloro-, | (Z)-4-Chloro-3-fluoro-2,2- | (Z)-4-(Deuterioamino)-4- |
| Bicyclo[2.2.1]hept-5-ene-2- | monomethyl ester | dimethylbut-3-enoic acid | oxobut-2-enoic acid |
| carboxylic acid | | | |
| (1R,2S)-Rel-Cyclopropane- | Carboxy 2-oxoacetate | (E)-4-Fluoro-2,2-dimethylbut-3- | 2-Methyl-3- |
| 1,2-dicarboxylic acid | | enoic acid | (phosphanyloxyamino)propanoic |
| | | | acid |
| 2-Chloro-4-nitropyridine | (E)-3-(Hydroxymethoxy)prop- | 4-Thiazolecarboxylic acid, 5- | (2R)-2-Methyl-3- |
| | 2-enoic acid | mercapto- | (phosphanyloxyamino)propanoic |
| | | | acid |
| 2,4-Dimethylthiazole-5- | 3- | 2-Chloro-2- | 3,4,5-Trideuteriofuran-2- |
| carboxylic acid | [Hydroxy(methyl)amino]propanoic | fluorocyclopropanecarboxylic | carboxylic acid |
| | acid | acid | |
| 3-Methylenecyclopropane- | 2-[(1S,2S)-2- | 6-Amino-4-ooxohexanoic acid | 4-Deuteriofuran-2- |
| trans-1,2-dicarboxylic acid | Ethylcyclopropyllacetic acid | | carboxylic acid |
| (R)-Cyclohex-3- | 2-Ethyl-4-hydroperoxybutanoic | 2-Cycloheptene-1-carboxylic | 3,4-Dideuteriofuran-2- |
| enecarboxylic acid | acid | acid | carboxylic acid |
| 5-Methoxyfuran-2-carboxylic | 2-Chloro-2- | (2R)-3-Methoxy-2- | 1,3,3,5,5-Pentadeuterio-4- |
| Acid | methylsulfonylacetic acid | methylpropanoic acid | oxocyclohexane-1- |
| | | | carboxylic acid |
| (4S)-4-Methyl-5- | 3- | Bromoglycine | 1,2,2,3,3,5,5,6,6- |
| oxohexanoic acid | [Formyl(methyl)amino]propanoic | | Nonadeuterio-4- |
| | acid | | oxocyclohexane-1- |
| | | | carboxylic acid |
| (4R)-4-Methyl-5- | 2-(3,4-Dimethyl-1,2-oxazol-5- | Propanedioic acid, 2-fluoro-, 1- | 2,2-Dideuterio-4- |
| oxohexanoic acid | yl)acetic acid | methyl ester | methylpentanoic acid |
| 3- | 3-Iminobutanoic acid | 2-(2-Methylthiolan-2-yl)acetic | 4-Methylpentanoic-D11 acid |
| Dimethylphosphorylpropanoic | | acid | |
| acid | | | |
| 4-Methylene-5-oxo-4,5- | (Carboxymethylamino)- | Aziridine-2,3-dicarboxylic acid | 3,3,4,5,5,5-Hexadeuterio-4- |
| dihydrofuran-3-carboxylic | hydroxy-oxophosphanium | monoethyl ester | (trideuteriomethyl)pentanoic |
| acid | | | acid |
| 2-(Furan-3-yl)acetic acid | 2H-Pyrrole-5-carboxylic acid | 4-Sulfanylpentanoic acid | 5-Bromo-5,5- |
| | | | dideuteriopentanoic acid |
| 4,5-Dimethylthiophene-3- | 4-Hydroxy-4-methylpentanoic | 2-Chloro-3- | 5-Bromopentanoic-3,3,4,4- |
| carboxylic acid | acid | (methylsulfanyl)propanoic acid | D4 acid |
| 5-Chlorothiophene-3- | (2E)-2-Cyano-2- | 2-(2-Sulfanylethoxy)acetic acid | 5-Bromo-2,2,3,3,4,4,5,5- |
| carboxylic acid | hydroxyiminoacetic acid | | octadeuteriopentanoic acid |
| 4-Fluorothiophene-3- | trans-3- | Dicarbonate | 5-Bromo-2,2- |
| carboxylic acid | Hydroxycyclohexanecarboxylic | | dideuteriopentanoic acid |
| | acid | | |
| 5-Fluorothiophene-3- | (1S,2S)-2-Acetylcyclopropane- | 3,4,4-Trifluoro-3-butenoic acid | 3,3-Dideuterio-3- |
| carboxylic Acid | 1-carboxylic acid | | sulfanylpropanoic acid |
| 2-Butenoic acid, 3-methoxy-, | (1S,2S)-1,2- | 2-(1,3,4-Thiadiazol-2-yl)acetic | 2,2,3,3-Tetradeuterio-3- |
| (2E)- | Dimethylcyclopropane-1- | acid | sulfanylpropanoic acid |
| | carboxylic acid | | |
| (Z)-3-Methoxybut-2-enoic | (Carbamoylsulfanyl)acetic acid | (1R,2S)-2-Acetylcyclopropane- | 2,2-Dideuterio-3- |
| acid | | 1-carboxylic acid | sulfanylpropanoic acid |
| 2-Sulfanylisonicotinic acid | 2- | 2-Ethoxypropanoic acid | 4,4-Dideuterio-3- |
| | (Trifluoromethylsulfinyl)acetic | | methyl(412C,1,2,3- |
| | acid | | 13C3)but-3-enoic acid |
| 2-Methoxyisonicotinic acid | 4,4,5,5,5-Pentafluoropentanoic | Bromoalanine | 2,2,3,3,4- |
| | acid | | Pentafluorobutanoate |
| 3-Ethyl-1-Methyl-1H- | Bicyclo[2.1.0]pentane-1- | N-Chloro-N-methylglycine | 1-Acetyl-1-methylaziridin-1- |
| Pyrazole-5-Carboxylic Acid | carboxylic acid | | ium-2-sulfonate |
| 3-Chloropicolinic acid | Methyl 2-nitrooxyacetate | (2S)-2-(Chloroamino)-3- | 1-Acetylaziridine-2- |
| | | hydroxypropanoic acid | sulfonate |
| 3,3-Dimethyl-4- | 1,3-Dimethyl-2-oxo-2,3- | N-Chloroglycylglycine | 2- |
| oxopentanoic acid | dihydro-1H-imidazole-4- | | Ethanethioylsulfanylpropanoic |
| | carboxylic acid | | acid |
| (1R,6S)- | 2,2,4-Trichlorobutanoic acid | 2-Carboxyethyl-methoxy- | 4-Cyano-2-oxobutanoic |
| Bicyclo[4.1.0]heptane-7- | | oxophosphanium | acid |
| carboxylic acid | | | |
| 3-Methylisoxazole-5- | Chloroiodoacetic Acid | 2-[[(E)-Hydrazinylidenemethyl]- | (S)-2-Azidopropanoic acid |
| carboxylic acid | | methylamino]acetic acid | |
| 3-Cyclopentene-1-carboxylic | 2,2,5,5,5-Pentafluoropentanoic | 4-Methoxycrotonic acid | 2,5-Dimethyl-4-oxohexanoic |
| acid | acid | | acid |
| (S)-3- | 2H-1,2,3-Triazole-2-acetic acid | 4,4,4-Trifluoro-3- | (1S,3R)-3- |
| Oxocyclopentanecarboxylic | | sulfanylbutanoic acid | Methylcyclohexane-1- |
| acid | | | carboxylic acid |
| (R)-3- | 2-Fluoranylpropanoate | 4-Fluoro-3-methylthiophene-2- | (3S)-2,3-Dihydroxybutanoic |
| Oxocyclopentanecarboxylic | | carboxylic acid | acid |
| acid | | | |
| (1R,2R,4S)- | 2H-Pyrrole-2-carboxylic acid | 2-(Trihydroxysilyl)ethane-1- | N-(2-Oxopropyl)carbamate |
| Bicyclo[2.2.1]heptane-2- | | sulfonic acid | |
| carboxylic acid | | | |
| (4-Methyl-furazan-3-yl)- | 4,4,4-Trifluorobutyl hydrogen | 4-(Aminooxy)butyric acid | 2-Oxopropylcarbamic acid |
| acetic acid | carbonate | | |
| 1,5-Dimethyl-1H-1,2,3- | 4-Fluorocyclohex-3-ene-1- | (2S)-2- | 2-Methoxy-3-nitroprop-1- |
| triazole-4-carboxylic acid | carboxylic acid | (Nitrosocarbamoylamino)pro | ene |
| | | panoic acid | |
| 1,5-Dimethyl-1H-pyrazole-4- | (E)-6-Oxohex-2-enoic acid | 3-Acetyloxirane-2-carboxylic | 4-Hydroxy-3-sulfanylpent-4- |
| carboxylic acid | | acid | enoic acid |
| 1,3-Dimethyl-1H-pyrazole-4- | (E)-5-Oxopent-2-enoic acid | 3-Bromo-but-3-enoic acid | 2-Phosphanyloxyprop-2- |
| carboxylic acid | | | enoic acid |
| 3- | 4-Oxobut-3-enoic acid | 2-(Acetyloxyamino)acetic acid | Ethoxy(difluoro)methane- |
| (Carbamothioylsulfanyl)pro- | | | sulfonate |
| panoic acid | | | |
| 4-Methyl-1,2,3-thiadiazole-5- | 3,3-Difluoro-1- | [Hydroxy(ethyl)phosphinyl]acetic | 3- |
| carboxylic acid | methylcyclobutanecarboxylic | acid | Methoxysulfonothioylpropanoic |
| | acid | | acid |
| 2-[(2S)-Oxan-2-yl]acetic acid | 3-Chloro-1,3- | 2-(2-Oxoethoxy)acetic acid | 2-Chloro-3H-pyrrole-5- |
| | dimethylcyclobutanecarboxylic | | carboxylic acid |
| | acid | | |
| (6-Oxopyridazin-1(6h)- | N-[(Oxiran-2-yl)methyl]glycine | Carboxy hydroxy carbonate | Tritio 3- |
| yl)acetic acid | | | methylsulfanylpropanoate |
| 5-Methylisoxazole-4- | 4-Fluoro-2-methylbutanoic | 4-Nitropentan-2-one | Tritio 3-sulfanylpropanoate |
| carboxylic acid | acid | | |
| 5-Methoxyoxazole-2- | 5-Thiazolecarboxylic acid, 2,3- | 4-Nitro-2-hexanone | 3- |
| carboxylic acid | dihydro-3,4-dimethyl-2-oxo- | | (Trioxidanylsulfanyl)propanoic |
| | | | acid |
| 2-Chloro-1,3-thiazole-5- | 2-Bromo-3- | Isocyanoacetic acid | Ethoxymethanesulfonate |
| carboxylic Acid | cyclopropylpropanoic acid | | |
| L-Cyclopropylglycine | 2- | 2-Cyclopropylideneacetic acid | 2-Acetyloxyethanesulfonate |
| | (Chloromethyldisulfanyl)acetic | | |
| | acid | | |
| 2-Cyclobutylacetic Acid | 2,2,4,4-Tetrachlorobutanoic | 5-Oxotetrahydrothiophene-2- | 2-Acetyloxy-1,1- |
| | acid | carboxylic acid | difluoroethanesulfonic acid |
| 2-[(1S,2S)-2- | 2,2-Difluoro-3-oxobutanoic | 6-Oxotetrahydro-2H-thiopyran- | 2,2-Difluoro-3- |
| Methylcyclopentyl]acetic | acid | 2-carboxylic acid | fluorooxypropanoate |
| acid | | | |
| 2-[(1R,2S)-2- | 3-Carbonoperoxoylbut-3-enoic | 2-(Aminooxy)ethanesulfonic | (1R)-3-Methylcyclohexane- |
| Methylcyclopentyl]acetic | acid | acid | 1-carboxylic acid |
| acid | | | |
| 3- | 3-Dimethylaminopropionate | 4-Methylenetetrahydrofuran-3- | (1S,2R)-2- |
| (Hydroxyphosphinyl)propionic | | acetic acid | Ethylcyclopropane-1- |
| acid | | | carboxylic acid |
| N-Carbamoyl-Alanine | 1,2-Dioxine-4-carboxylic acid | (S)-2-Hydroxy-4,4- | (1S,2S)-2- |
| | | difluorobutanoic acid | Ethenylcyclopropane-1- |
| | | | carboxylic acid |
| Sorbate | 2-(2,5-Dihydropyrrol-1- | 4-Bromo-4,4,3,3- | [2-(Methylamino)-2- |
| | yl)acetic acid | tetrafluorobutanoic acid | oxoethyl] carbonate |
| (2E,4Z)-2,4-Hexadienoic | 4-Phosphorosooxybutanoic | 2,2-Dimethyl-4-oxopentanoic | 2-(2-Aminohydrazinyl)acetic |
| acid | acid | acid | acid |
| N-Acetylglycinate | Ethoxycarbothioylsulfanyl- | (R)-2-Chloro-3-methylbutyric | 3-Methyl-1,1-dioxothietane- |
| | methanesulfonate | acid | 3-carboxylic acid |
| Cyanoacetate | 4,4-Difluoro-4-sulfanylbut-2- | Nitromethyl acetate | (1R,2R)-2- |
| | ynoate | | Methoxycarbonyl-1- |
| | | | methylcyclopropane-1- |
| | | | carboxylic acid |
| (1S,6R)-Bicyclo[4.1.0]hept- | 4-Oxo-4-sulfanylbut-2-ynoate | 3-Fluorobutyric acid | (Z)-2-Azaniumyl-3,4- |
| 3-ene-7-carboxylic acid | | | dideuterio-5- |
| | | | (dideuterioamino)-5- |
| | | | oxopent-3-enoate |
| Glycyl-L-alanine | 4-Oxo-4-sulfanylbut-2-ynoic | 2-(1-Methylcyclopropyl)acetic | 2-Fluoro-2- |
| | acid | acid | oxidoperoxysulfanylpropanoic |
| | | | acid |
| 1,3,5-Trithiane-2-carboxylic | (Z)-3-Methyl-4-oxopent-2- | 2-Methoxy-2,3,3- | 2-(Difluoromethoxy)acetate |
| Acid | enoate | trimethylcyclopropane-1- | |
| | | carboxylic acid | |
| Mono-Ethyl succinate | (2S)-2-[(2-Methylpropan-2- | 3-Iodo-2,2,3,3- | 5-Thiazolecarboxylic acid, |
| | yl)oxy]propanoic acid | tetrafluoropropanoic acid | 2,3-dihydro-2-thioxo- |
| (E)-3-Methoxy-2-butenoic | 2-Fluoro-2,3- | 2,2,3,3-Tetrachloropropanoic | 3-(Fluoroamino)-4- |
| acid | dimethylbutanedioic acid | acid | (methylamino)-4- |
| | | | oxobutanoic acid |
| 2,2,3,3,4,4- | [2- | 2-Chloro-2-fluoropropanedioic | 1-Deuteriocyclohexane-1- |
| Hexafluorobutanoic Acid | (Methoxymethoxy)acetyl]oxidanium | acid | carboxylic acid |
| Isoxazole-5-carboxylic acid | 2-Methylsulfinyloxyacetate | 3-Oxobutylphosphonic acid | 2-Methanethioylsulfanyl-2- |
| | | | methylpropanoic acid |
| Methyl 2- | 2-Methylsulfinyloxyacetic acid | 3,3,4-Trimethylpent-4-enoic | 5-Bromo-2,2,3,3- |
| phosphonatoacetate | | acid | tetradeuteriopentanoic acid |
| 2-Dimethylphosphorylacetic | 2- | 2-(Methylcarbamoyloxy)acetic | 3-Formyloxy-2- |
| Acid | (Hydroperoxymethyl)cyclopropane- | acid | hydroxypropanoic acid |
| | 1-carboxylic acid | | |
| 2- | 2-Propanimidoylsulfanylacetic | N,N-Dimethylhydroxyglycine | 3-Formyloxyoxirane-2- |
| [Amino(dimethyl)azaniumyl] | acid | | carboxylic acid |
| acetate | | | |
| Dichloromalealdehydic acid | 2,2-Difluoro-4-methyl-5- | 1-Nitro-1-fluoro-2-propanone | (2R)-5-Methoxyoxolane-2- |
| | oxopentanoic acid | | carboxylic acid |
| Succimer | 2,2-Difluoro-6-oxohexanoic | 3-Oxobutanedithioic acid | (2R,3S)-3-Methoxyoxolane- |
| | acid | | 2-carboxylic acid |
| 1- | 5-Hydroxy-2-oxopentanoic | (2S)-2-[Methyl(prop-2- | (R)-5- |
| Cyanocyclopropanecarboxylic | acid | enoyl)amino]propanoic acid | Methyltetrahydrofuran-2- |
| acid | | | carboxylic acid |
| 1- | (E)-(113C)But-2-enedioic acid | 3,5-Dichloro-4-oxo-pentanoic | 4-Oxopent-2-ynoate |
| Carboxycyclopropanecarboxamide | | acid | |
| 5-Chloro-2-methylpentanoic | 2-(2- | 2-Oxo-3-phosphopropanoic | (Z)-1-Hydroxy-1,4- |
| acid | Methylpropyl)cyclopropane-1- | acid | dioxopent-2-en-3-olate |
| | carboxylic acid | | |
| (R)-2-Methoxypropanoic | 1-Methylsulfanylethyl | 2-Prop-2-enoyloxypropanoic | (E)-5-Oxohex-3-enoate |
| Acid | hydrogen carbonate | acid | |
| (R)-(+)-2-Tetrahydrofuroic | 2-Ethenoxyethyl hydrogen | 2-(2-Methylprop-2- | 2-(Dithiolan-3-yl)acetate |
| acid | carbonate | enoyloxy)propanoic acid | |
| 4-Bromo-4,4-difluorobut-2- | N-Carbomethoxy-L-cysteine | Acetoxyacetaldehyd- | 4-Oxopentane-1-sulfonic |
| enoic acid | | dimethylacetal | acid |
| 4-Bromo-4,4- | 5-Oxo-1,2,4-triazole-3- | 2-Methyliminopropanoic acid | 2,2,3,3-Tetrafluoro-4- |
| difluorobutanoic acid | carboxylic acid | | oxopentanoic acid |
| 2-Fluoro-3-methylbenzoic | 2- | Propanoic acid, 2-methyl-3- | 3-[Methyl(prop-1-en-2- |
| acid | [Methyl(sulfamoyl)amino]acetic | (methylsulfonyl)-, (S)- | yl)amino]propanoic acid |
| | acid | | |
| 4-Fluoro-5-oxopyrrolidine-2- | 2-(2-Chloroprop-2- | 1-Mercapto-1- | 2,2-Difluoropropane-1- |
| carboxylic acid | enylsulfanyl)acetic acid | cyclopentanecarboxylic acid | sulfonate |
| 2,2-Difluoro-2- | 2-(2-Methylprop-2- | 3-Dimethylsulfonio-2- | 3-Acetyloxypropanoate |
| (fluorosulfonyl)acetic acid | enylsulfanyl)acetic acid | methylpropanoate | |
| 3-Trihydroxysilylpropanoic | 5-Chloro-5-hexenoic acid | (2S)-4-Ethoxy-2-hydroxy-4- | 2-Chloro-3-methyl-3- |
| Acid | | oxobutanoic acid | sulfanylbutanoic acid |
| 3-Cyclopropylpropanoic Acid | 2-(4-Methyl-1,3-thiazol-3-ium- | 4-Methylisoxazole-5-carboxylic | 4-Chloro-5- |
| | 3-yl)acetic acid | acid | sulfanylpentanoic acid |
| 3-Oxocyclohexanecarboxylic | 3-Formyl-3-methylButanoic | 2-Nitrooxyacetic acid | (2S)-4-Amino-2-methyl-4- |
| acid | acid | | oxobutanoic acid |
| 3-(2-Thiazolyl)propionic acid | 2-(Dioxiran-3-yl)acetic acid | 2-(Nitrooxy)propanoic acid | 2-Acetyloxy-1,1- |
| | | | difluoroethanesulfonate |
| Pyridazine-4-carboxylic Acid | 2,2,4,4,4-Pentafluorobutanoic | [(2- | 2- |
| | acid | Chloroacetyl)ami- | [Methyl(trimethylsilyl)amino] |
| | | no]methylphosphonic | acetic acid |
| | | acid | |
| 2-Methyl-4,5-dihydro-1,3- | 2,4,4,4-Tetrafluorobutanoic | Thiocarbamoylthioacetic acid | 3-Formyloxy-2- |
| thiazole-4-carboxylic Acid | acid | | sulfanylpropanoic acid |
| 2-Chloro-3- | (2S,4S)-4-Methyl-5- | Cyclohexylcarbonate | 5-Bromo-2,2,4,4- |
| hydroxyisonicotinic acid | oxotetrahydrofuran-2- | | tetradeuteriopentanoic acid |
| | carboxylic acid | | |
| 2-Cyanoisonicotinic acid | (2S,4R)-4-Methyl-5- | Cyclopentyl hydrogen | 2,3,4,6-Tetradeuterio-5- |
| | oxotetrahydrofuran-2- | carbonate | fluorobenzoic acid |
| | carboxylic acid | | |
| 3-Fluoro-2-iodopyridine-4- | 4-Methylbicyclo[3.1.0]hex-2- | 4,4-Dimethyl-3-oxopentanoate | 2,2-Dideuterio-5- |
| carboxylic acid | ene-6-carboxylic acid | | hydroxypentanoic acid |
| 2-Methylisonicotinic acid | 2-Phosphoglycolate | 2,5-Dichlorovaleric acid | 2-(2-Oxoethylamino)acetate |
| 2-Fluoro-4-nitropyridine | [2-(Hydroxyamino)-2-oxoethyl] | Dichloroacetic acid-2-13C | (2S)-2-(Deuterioamino)-3- |
| | phosphate | | hydroxybutanoic acid |
| 4-Fluoronicotinic acid | [11C]Glycylsarcosine | Dideuterio (E)-2,3- | (Z)-3-Formyloxyprop-2- |
| | | dideuteriobut-2-enedioate | enoic acid |
| 2-Bromothiazole-5- | N-(Ethoxycarbonothioyl)-beta- | Succinic acid-d6 | 3-Formyloxybut-3-enoic |
| carboxylic acid | alanine | | acid |
| 4,5-Dimethylthiophene-2- | (E)-2,3-Dichloroacrylic acid | 3-Hydroxy(1,3-13C2)butanoic | 3- |
| carboxylic acid | | acid | [Formamido(methyl)amino] |
| | | | propanoic acid |
| Mucochloric acid | 4-(Methylaminooxy)-4- | 4-Fluorobenzoic acid-alpha- | Fluoromethoxymethanesulfonic |
| | oxobutanoic acid | 13C-2,3,5,6-d4 | acid |
| Tetrahydropyranyl-4-acetic | (2S)-4-Amino-2-(chloroamino)- | (1,2-13C2)Butanedioic acid | (3S)-3-Formyloxy-3- |
| acid | 4-oxobutanoic acid | | hydroxypropanoic acid |
| 3- | (S)-2,4-Dimethyl-4-pentenoic | Succinic acid-13C4 | 2-Methyl-5- |
| (Dimethoxyphosphoryl)propanoic | acid | | sulfanylidenehexanoic acid |
| acid | | | |
| 2-Methyl-4,4,4- | (3S)-5-Oxopyrrolidine-3- | 3-Hydroxy(413C)butanoic acid | 2,2,3,3,4,5,5,5- |
| trifluorobutyric acid | carboxylic acid | | Octadeuterio-4- |
| | | | methylpentanoic acid |
| 4,4,4-Trifluorobutyric Acid | 3-(Cyclopropen-1-yl)propanoic | 4-Cyclopropyl-4-oxobutyric acid | 3- |
| | acid | | Thiophosphorosopropanoic |
| | | | acid |
| 3,3,3-Trifluoropropionic acid | 2-[(2R)-Oxiran-2-yl]butanoic | Benzoic acid-13C7 | 2- |
| | acid | | (Formyloxymethoxy)acetic |
| | | | acid |
| 3-Fluoro-5-methylbenzoic | 2-[(2S)-Oxiran-2-yl]butanoic | 3,3-Difluoropropanoic acid | Tritio 3-methylbut-3-enoate |
| acid | acid | | |
| 4,4,4-Trifluorobut-2-enoic | (2R)-2-Amino-4- | Hydroxycarbonyl hydrogen | (S)-3,3- |
| acid | oxopentanoate | carbonate | Difluorocyclopentanecarboxylic |
| | | | acid |
| 5,5,5-Trifluoropentanoic | 2-Azaniumyl-4-oxopentanoate | [(Ethylsulfonyl)amino]acetic | 4-Formyloxybut-3-enoic |
| Acid | | acid | acid |
| 4,5,5-Trifluoropent-4-enoic | Methylenecyclopropylpyruvate | (3S)-3-(Acetylamino)butanoic | 3-Formyloxyprop-2-ynoic |
| Acid | | acid | acid |
| 2-Bromo-2,3,3,3- | (S)-4-Hydroxy-2-oxopentanoic | 6-Chloropyrimidine-4- | (E)-3-Formyloxy-2- |
| tetrafluoropropanoic acid | acid | carboxylic acid | methylprop-2-enoic acid |
| 3-Chlorotetrafluoropropionic | 4-Methoxy-2,4-dioxobutanoate | 3-Methylphosphanylpropanoic | (2-Mercaptoethylthio)acetic |
| acid | | acid | acid |
| 2,3,3,3-Tetrafluoropropanoic | 2-Azaniumyl-3- | O-Acetyl-L-Threonine | 6-Deuteriopyridine-3- |
| Acid | methylsulfinylpropanoate | | carboxylic acid |
| 2-Chloro-3-fluoroisonicotinic | [(Cyclopropylmethyl)thio]acetic | (113C)But-2-ynedioic acid | 5-Deuteriopyridine-3- |
| acid | acid | | carboxylic acid |
| 2,2- | 3,5-Dimethyl-4,5-dihydro- | 3-Ketopentanoate | 2- |
| Difluorocyclopropanecarboxylic | isoxazole-5-carboxylic acid | | (Formyloxymethyldiazenyl)acetic |
| acid | | | acid |
| 1-Hydroxy-1-oxo-1lambda5- | 4-Oxopentylphosphonic acid | 3-Carboxy-2-sulfidopropanoate | 2-(2-Methyl-2- |
| phosphetane-3-carboxylic | | | nitropropyl)oxirane |
| acid | | | |
| 4-Methylthiophene-2- | (2R,3R)-2-Deuterio-3- | 1,2-Dicarboxyethanethiolate | 6-Methyl-2,3,4,5- |
| carboxylic acid | fluorobutanedioic acid | | tetrahydropyridine-4- |
| | | | carboxylic acid |
| 2,2-Dichlorocyclopropane-1- | 2-Deuterio-4-oxopentanoic | 3-Carboxy-3- | 6-Methyl-2,3,4,5- |
| carboxylic acid | acid | mercaptopropanoate | tetrahydropyridine-4- |
| | | | carboxylate |
| Chloroacetyl-D-alanine | beta-Sulfinylpyruvate | 5-Methyl-2-oxo-1,3-dioxane-5- | 2-Methyl-4,5-dihydro-3H- |
| | | carboxylic acid | pyridin-2-ylium-4-carboxylic |
| | | | acid |
| (2S)-2-Chloro-3,3- | Phosphonemycin | (3S)-3-Hydroxy-4-oxopentanoic | 2,3-Dideuterio-4- |
| dimethylbutanoic acid | | acid | oxohexanoic acid |
| 4-Methyl-5-oxohexanoic | (S)-4-Hydroxy-2- | 5-Chloro-2-oxopent-4-enoate | (1S)-3- |
| acid | oxopentanoate | | Methylidenecyclopentane- |
| | | | 1-carboxylic acid |
| 2-Methyl-3-sulfinopropanoic | 2-Azaniumyl-5-oxopentanoate | (3S)-2,3- | 4-Methylcyclopenta-1,3- |
| acid | | Bis(sulfanyl)butanedioic acid | diene-1-carboxylate |
| 2,2,2-Trifluoroethanesulfonic | 3-Acetyloxy-2- | Tetrahydro-2H-pyran-3- | 2-(4H-Triazol-5-yl)acetic |
| acid | azaniumylpropanoate | carboxylic acid | acid |
| 4-Fluorobenzoate | 1-Methyl-6-oxopiperidine-3- | N-(Methoxyacetyl)glycine | (Z)-5-Methyl-4-oxohex-2- |
| | carboxylic acid | | enoic acid |
| 3-Fluorobenzoate | (4S)-2-Methyl-4,5-dihydro-1,3- | 2- | 5-Deuterio-1,3-thiazole-4- |
| | thiazole-4-carboxylic acid | [(Methylcarbamoyl)amino]acetic | carboxylic acid |
| | | acid | |
| 2,3,4,4-Tetrachloro-3- | 4-Chloro-3-hydroxyisothiazole- | 2-[(2,2,2- | 4-Deuterio-2-methyl-1,3- |
| butenoic acid | 5-carboxylic acid | Trifluoroethyl)sulfanyl]acetic | thiazole-5-carboxylic acid |
| | | acid | |
| 2- | (3R)-5-Oxopyrrolidine-3- | 2-(1 H-Pyrazol-1-yl)propanoic | 2- |
| (Propanethioylamino)acetic | carboxylic acid | acid | (Carbonofluoridoylamino)acetate |
| acid | | | |
| Isoxazole-4-carboxylic acid | (1S,2S,4S)-Bicyclo[2.2.1]hept- | 2-Isopropoxypropanoic acid | 2- |
| | 5-en-2-ylacetic acid | | (Carbonofluoridoylamino)acetic |
| | | | acid |
| 3-Chlorobenzoate | N-Ethyl-N-methyl-D-alanine | 3-Ethoxy-2-methylpropanoic | 2,3,3-Trifluoro-3- |
| | | acid | sulfopropanoic acid |
| 4-Oxo-4-sulfanyloxybutanoic | (2R)-2-Amino-5-oxohexanoic | (1R,4S)-Bicyclo[2.2.1]heptane- | 2,2-Dideuterio-2- |
| acid | acid | 2-carboxylic acid | (trideuteriomethoxy)acetic |
| | | | acid |
| 3-Sulfinopropionic acid | (2S)-2-(2- | [(1s)-1-Fluoro-2- | 2- |
| | Methoxyethoxy)propanoic acid | (Hydroxyamino)-2- | (Trideuteriomethoxy)acetic |
| | | Oxoethyl]phosphonic Acid | acid |
| 3-Amino-2-chloro-3- | (2R)-2-(2- | 2-(1,3,2-Dithiazol-4-yl)acetic | 3-Oxidooxybut-3-enoate |
| oxopropionic acid | Methoxyethoxy)propanoic acid | acid | |
| 2-(2-Oxopyrrolidin-1- | (2S)-2-Ethoxypropanoic acid | 2-Fluoro-3-oxoButanoic acid | 3-Oxidooxybut-3-enoic acid |
| yl)propanoic acid | | | |
| 2-Chloro-1- | (2S)-2-Cyclopropylpropanoic | (2E)-2-Hydrazinylideneacetic | (E)-4-Cyanobut-3-enoate |
| methylcyclopropanecarboxylic | acid | acid | |
| acid | | | |
| 4-Oxo-5-hexenoic Acid | (2R)-2-Cyclopropylpropanoic | Acetoxy carboxylic acid | 3-Cyanatopropanoate |
| | acid | | |
| Hydroxyaspartic acid | 3-Methylisothiazole-4- | 3-(3-Ethyloxiran-2-yl)propanoic | Bicyclo[2.1.1]hex-2-ene-2- |
| | carboxylate | acid | carboxylic acid |
| 2-Butenoic acid, 3-bromo-2- | 5,5,5-Trifluoro-4- | 2,3,3,3-Tetrachloro-2- | 6-Deuterio-5-oxohexanoic |
| chloro-4-oxo- | oxopentanoate | methylpropanoic acid | acid |
| 2-Thioxothiazolidine-4- | 2-(Chloromethyl)-4- | 3-Formyl-crotonic acid | 4-Deuterio-3-oxobutanoic |
| carboxylic acid | nitropyridine | | acid |
| 1H-Imidazole-4-carboxylic | Trisnorlipoic acid | 4-Methoxy-3-methyl butanoic | 2-Oxo-2- |
| acid, 2,3-dihydro-3-methyl- | | acid | (sulfanylmethylphosphanyl) |
| 2-thioxo- | | | acetic acid |
| 3-(Trimethylsilyl)(2,2,3,3- | 2-[[(2R)-2- | Oxalic acid 1-(2-oxo-2- | (2R,3R)-3-Methoxy-2- |
| 2H4)propionic (2H)acid | Chloropropanoyl]amino]acetic | hydroxyethyl) ester | methylbutanoic acid |
| | acid | | |
| Raphanusamic acid | 2-[[(2S)-2- | Carbonic acid 1- | 1-Phosphanylazetidine-3- |
| | Chloropropanoyl]amino]acetic | methylenepropyl ester | carboxylic acid |
| | acid | | |
| (Z)-2-Chloro-3- | Methoxycarbonyloxy-acetic | Prop-1-en-2-yl hydrogen | (3R)-1- |
| (chloromethyl)-4- | acid | carbonate | Phosphanylpyrrolidine-3- |
| oxobutenoic acid | | | carboxylic acid |
| (Z)-2-Chloro-3-methyl-4- | 2-(5H-Tetrazol-5-yl)acetic acid | Prop-2-ynyl hydrogen | (3S)-1- |
| oxobutenoic acid | | carbonate | Phosphanylpyrrolidine-3- |
| | | | carboxylic acid |
| 4-Hydroxybutanoate | 2-[(3S)-Oxan-3-yl]acetic acid | 2-Carboxyoxyacetic acid | 1-Phosphanylpyrrolidine-3- |
| | | | carboxylic acid |
| Thioasparagine | 2-[(3R)-Oxan-3-yl]acetic acid | 3,3-Difluorohex-5-enoic acid | (3R)-3- |
| | | | Hydroperoxybutanoic acid |
| 2,3-Difluorofumaric acid | 2-(4-Methylpyridin-3-yl)acetic | 2H-Thiopyran-6-carboxylic acid | 1,2,2,3,3,4,4- |
| | acid | | Heptadeuteriocyclohexane- |
| | | | 1-carboxylic acid |
| Hydroxylamine, O-acetyl-N- | 4-Methyl-1H-pyrazole-5- | Thiazinane-4-carboxylic acid | 3-Formyloxy-3- |
| nitro- | carboxylate | | hydroxypropanoic acid |
| Gonyauline | 2-Chloro-1,3-thiazole-5- | 2-(Sulfonylamino)acetic acid | 5-Methyl-2H-pyrrole-3- |
| | carboxylate | | carboxylic acid |
| Magnesium 4-oxopentanoic | (1R,2S)-2- | Ethoxymethanesulfonic acid | 1,3-Thiazol-2- |
| acid | Ethoxycarbonylcyclopropane- | | ylmethanesulfonate |
| | 1-carboxylic acid | | |
| (2-Oxopyrrolidin-1-yl)acetic | 1-Vinyl-1H-pyrazole-4- | Carbonic acid monoisobutyl | (2R)-2-Methyl-5- |
| acid | carboxylic acid | ester | oxohexanoic acid |
| N-(Methylsulfonyl)glycine | 2-Cyclopentyl-2,2- | 4-Cyano-4-oxobutanoic acid | 2-(Tritiomethyl)butanedioic |
| | difluoroacetic acid | | acid |
| 5-Oxothiolane-3-carboxylic | S-Cyano-L-cysteine | Phenoxysulfanylformic acid | 4-Deuterio-3- |
| acid | | | nitrosobutanoic acid |
| (Tetrahydro-pyran-2-yl)- | (1R,2R)-2- | 2-(2,3-Dihydro-1,2-oxazol-5- | (E)-3-Methyl-4-oxobut-2- |
| acetic acid | Ethoxycyclopropane-1- | yl)acetic acid | enoate |
| | carboxylic acid | | |
| 4-Hydroxy-4-methylpent-2- | 2-(Trifluoromethoxy)acetic acid | 3-(Chloromethyl)-3- | 2-Tritiobenzoic acid |
| ynoic acid | | hydroxycyclobutene-1- | |
| | | carboxylic acid | |
| 2-Methyltetrahydrofuran-2- | 3-Chloro-2,2-dimethylbut-3- | 2-(Methylideneamino)acetate | CID 58616147 |
| carboxylic acid | enoic acid | | |
| (s)-2-Mercaptosuccinic acid | (R)-6-Oxopiperidine-2- | Oxiran-2-ylmethyl hydrogen | 2- |
| | carboxylic acid | carbonate | Oxidoperoxysulfanylacetate |
| 2-(Carboxyamino)propanoic | (S)-Tetrahydro-2H-pyran-3- | Sulfuric acid 2-hydroxyethyl | 2-(Trioxidanylsulfanyl)acetic |
| acid | carboxylic acid | ester | acid |
| Carboxymethyl sulfite | 6-Fluoro-5-methylpyridine-3- | (E)-4-Chlorobut-2-enoate | 2,3,4-Trideuteriopentanoic |
| | carboxylate | | acid |
| 4-Iodobutyric acid | (1R,2R)-2-Nitrocyclopropane- | 1,2,2-Trichloroethoxy hydrogen | (2R,3S)-3-Methyloxirane-2- |
| | 1-carboxylic acid | carbonate | carboxylate |
| [(Trifluoromethyl)thio]acetic | (3R)-3-Amino-4-oxopentanoic | 3,4-Dimethyl-1,2-thiazole-5- | 2-Methyl-3H-pyrazol-2-ium- |
| acid | acid | carboxylic acid | 4-carboxylic acid |
| 6-Methylsulfanylpyrimidine- | (3S)-3-Amino-4-oxopentanoic | 2-Oxopropyl hydrogen | (2S)-4-Hydroxy-2-methyl-4- |
| 4-carboxylic Acid | acid | carbonate | oxobutanoate |
| 1-Methyl-2-cyclohexene-1- | (S)-Tetrahydrofuran-3- | 1H-Diazepine-7-carboxylic acid | 2,2-Dideuterio-3- |
| carboxylic acid | carboxylic acid | | (dideuteriomethyl)butanedioic |
| | | | acid |
| Trifluoromethoxyformic Acid | 4-(Methylamino)-4- | 3H-Dioxepine-6-carboxylic acid | 2,2,3,3-Tetrafluoro-4- |
| | oxobutanoate | | (methylamino)-4- |
| | | | oxobutanoic acid |
| 3-Hydroxybutyrate | 2-[2- | 2- | 2-(4-Methyltetrahydro-2H- |
| | Hydroxyethyl(me- | [Chloro(hydroxy)phos- | pyran-4-yl)acetic acid |
| | thyl)azaniumyl]acetate | phoryl]oxyprop- | |
| | | 2-enoic acid | |
| Bicyclo[2.2.1]hept-2-ene-5- | (2S)-2-Propan-2- | 3-Fluoro-2- | 2-Methylcyclopropene-1- |
| carboxylate | yloxypropanoic acid | (fluoromethyl)propanoic acid | carboxylic acid |
| 2-(2-Oxocyclopentyl)acetic | (R)-Tetrahydro-2H-pyran-3- | 3,4-Difluorobutanoic acid | 3- |
| Acid | carboxylic acid | | [Dichloro(methyl)silyl]propanoic |
| | | | acid |
| 5-Chloro-6-fluoronicotinic | 4-Hydroxy-5-methylfuran-3- | 3-Chloro-2- | (E)-4-Methoxy-2,3-dimethyl- |
| acid | carboxylic acid | (chloromethyl)propanoic acid | 4-oxobut-2-enoic acid |
| Hydrogen succinate | 3-Deuterio-4-oxopentanoic | 2,2-Bis(sulfanyl)butanedioic | (1R,2R)-2-(1- |
| | acid | acid | Hydroxyethyl)cyclobutane- |
| | | | 1-carboxylic acid |
| 2-(1H-Pyrazol-1-Yl)Acetic | (2S)-2,3-Dimethyl-2- | 2-Oxopropyl phosphate | 3-(Deuteriomethyl)-4- |
| Acid | sulfanylbutanoic acid | | methoxy-4-oxobutanoic |
| | | | acid |
| Pyrazine-2-carboxylate | 2-(2-Oxooxazolidin-3- | 3-Amino-5-fluoro-4- | (2S)-2- |
| | yl)propanoic acid | oxopentanoic acid | (Phosphanylamino)propanoic |
| | | | acid |
| 1-Methoxypyridin-1-ium-3- | 3-(1,3-Thiazol-4-yl)propanoic | 2-Sulfanylpent-4-enoic acid | 1,2,2,2- |
| carboxylic acid | acid | | Tetrafluoroethanesulfonate |
| 2-Methyloxane-4-carboxylic | 2- | 2H-Pyran-5-carboxylic acid | [Ethyl(methyl)amino] |
| Acid | [Cyclopropyl(methyl)amino]acetic | | hydrogen sulfate |
| | acid | | |
| 2-(Methylsulfonyl)acetic acid | 2-[Methyl(2-methylprop-2- | 2,5-Dioxohexanoic acid | 5-Amino-2-methyl-5- |
| | enyl)amino]acetic acid | | sulfanylidenepentanoic acid |
| 3-Trimethylsilylpropanoate | 2-Oxabicyclo[3.1.0]hexane-6- | 2-Cyclohexa-1,3-dien-1- | 2-Ethoxyethanesulfonate |
| | carboxylic acid | ylacetic acid | |
| 2,4-Dimethyl- | 2-Ethoxycyclopropane-1- | 3,4-Dihydrophenylacetic acid | (Z)-3-Nitroprop-2-enoic acid |
| cyclohexanecarboxylic acid | carboxylic acid | | |
| 2- | (2R)-2-Chloro-3,3- | 3-Methyl-1,1-dioxothiaziridine- | 3-Oxobutyl nitrate |
| (Dithiocarboxyamino)acetic | dimethylbutanoic acid | 3-carboxylic acid | |
| acid | | | |
| 2-Cyclopropyl-2- | Oxiran-2-ylmethyl hydrogen | 4-Fluoro-3-oxobutanoic acid | Methyl-(S)-3-hydroxybutyric |
| methylcyclopropane-1- | sulfate | | acid |
| carboxylic acid | | | |
| 4-Oxohexanoic acid | 2-Nitroso-4- | 5-Sulfanylidenecyclohexa-1,3- | 2-Ethanethioylsulfanyl-2- |
| | isothiazolidinecarboxylic acid | diene-1-carboxylic acid | methylpropanoic acid |
| Monomethyl malonate | 2-Chlorooxazole-4-carboxylic | 2-(Hydroperoxy)propionic acid | 2-Carbamothioylsulfanyl-2- |
| | acid | | methylpropanoic acid |
| 4-Methyl-5-oxotetrahydro-3- | 3-Azidopropyl hydrogen | 5-Amino-2-fluoro-5- | Ethanethioylsulfanylformic |
| furancarboxylic acid | carbonate | oxopentanoic acid | acid |
| 2-Chloro-3,3- | 2,3-Difluorocyclohexane-1- | Carbonic acid chloromethyl | 4-Hydroxy-3- |
| dimethylbutanoic acid | carboxylic acid | ester | methylpentanoate |
| (5-Sulfanyl-1H-tetrazol-1- | 2-Thioxo1,3-thiazolidine-4- | Phosphonooxymethyl acetate | Phosphinine-2-carboxylic |
| yl)acetate | carboxylate | | acid |
| Isonicotinate | 2-(2,2-Difluoro-3- | 2-(4,5-Dihydro-1,3-thiazol-4- | (Z)-2,3,4,4,4- |
| | methylidenecyclopropyl)acetic | yl)acetic acid | Pentafluorobut-2-enoate |
| | acid | | |
| 2- | 1,4-Dioxane-2-aceticacid,(2S)- | 2H-Pyran-3-carboxylic acid | 4-Oxocyclopent-2- |
| [Carbamothioyl(me- | | | enecarboxylic acid |
| thyl)aminolacetic | | | |
| acid | | | |
| 3,3-Dichloro-2- | 3-Nitrooxy-propionic acid | Morpholin-4-yl hydrogen | 2-(2-Methylcyclopropen-1- |
| fluoropropanoic acid | | carbonate | yl)acetic acid |
| 2- | 2-Nitrooxy-ethanesulfonic acid | 2-Chloro-3-methoxy-3- | (Z)-3-Cyanoacrylic acid |
| (Carbamoylamino)butanoic | | oxopropanoic acid | |
| Acid | | | |
| 2-(3-Methylisoxazol-5- | (E)-3-Deuteriohex-2-enoic acid | 3- | (Z)-2,3-Dichloro-3- |
| yl)acetic acid | | (Ethyl(methyl)amino)propanoic | methoxyprop-2-enoic acid |
| | | acid | |
| Carboxymethyl | DL-Alanyl-l-alanine | 3,4-Dimethoxybutanoic acid | 4-Oxopentanoic acid; silver |
| methanethiosulfonate | | | |
| Acetylenedicarboxylate | 3-Bromo-2,2,3- | 7-Oxabicyclo[2.2.1]hept-5-en- | 2-Cyclopropyl-2- |
| | trifluoropropanoic acid | 2-yl hydrogen carbonate | (phosphanylamino)acetic |
| | | | acid |
| 2-(Tetrahydrofuran-3- | 2-Chloro-3-nitropropanoic acid | 5,6-Dimethylpyridine-3- | 3-Methylsulfanyl-4- |
| yl)acetic acid | | carboxylic acid | oxopentanoic acid |
| 4-Methylpentanoate | 4-(Dibromoamino)butanoic | 2-Vinyl-isonicotinic acid | N-(Nitromethyl)acetamide |
| | acid | | |
| 5-Nitro-2-pentanone | 2-[Bromo(chloro)amino]acetic | Dichloromalonate | 2,2-Difluoro-2- |
| | acid | | (trioxidanylsulfanyl)acetic |
| | | | acid |
| Bicyclo[2.2.1]heptane-3- | 2-[Bromo(chloro)amino]-2- | 2-(Thian-4-yl)acetic acid | (1-Carboxy-3-oxobutan-2- |
| carboxylate | methylpropanoic acid | | yl)azanium |
| 2,2,3,3,4,4,4- | 4- | [Hydroperoxy(hydroxy)phosphoryl] | 2-Methyl-2- |
| Heptafluorobutanoate | [Bromo(chloro)amino]butanoic | hydrogen carbonate | oxidoperoxysulfanylpropanoic |
| | acid | | acid |
| 2-Hydroxy-2- | Nicotinic acid-13C6 | Furan-2-ylmethyl hydrogen | 3-Methylperoxypropanoic |
| oxoethanesulfonate | | carbonate | acid |
| 2-(2- | N-Nitroso-N-methyl-4- | 4-Methoxy-2- | (2R)-2- |
| Methylcyclopentyl)acetic | aminobutyric Acid-d3 | methylidenehexanoic acid | [Acetyl(methyl)amino]propanoic |
| Acid | | | acid |
| 4-Chlorobenzoate | N-Nitroso-N-(methyl-d3)-3- | 4-Methoxy-3-methyl-2,4- | 1-Ethoxy-2-nitroethenolate |
| | aminopropionic Acid | dioxobutanoic acid | |
| Spiro[2.2]pentane-1- | N-Nitrososarcosine-d3 | 2- | 2,3,3,3-Tetrafluoro-2- |
| carboxylic Acid | | [Methyl(methylsulfanyl)amino]acetic | fluorooxypropanoic acid |
| | | acid | |
| 2-Butenoic acid, 3,4,4,4- | 5-Methyl-1,3,4-thiadiazole-2- | 2,4-Pentadiynoic acid | Dihydroxy-oxo-(oxolan-3- |
| tetrachloro- | carboxylic acid | | ylmethylidene)-lambda6- |
| | | | sulfane |
| Hexa-2,4-dienoate | (2R)-1-(Chloroacetyl)azetidine- | 2-(Oxiran-2-ylmethyl)prop-2- | 2- |
| | 2-carboxylic acid | enoic acid | [Ethylidene(me- |
| | | | thyl)azaniumyl]acetate |
| 4-Hexynoic acid | (1R,2R)-2- | (E)-3,4-Dichlorobut-3-enoic | 3-Hydroperoxy-2-oxobut-3- |
| | (Chlorocarbonyl)cyclopropane- | acid | enoic acid |
| | 1-carboxylic acid | | |
| 2-Sulfidobutanedioate | 1- | 4,4-Dichlorobutanoic acid | (E)-3-Methyl-4-oxopent-2- |
| | (Chlorocarbonyl)cyclopropane | | enoate |
| | carboxylic acid | | |
| 3-Carboxyprop-2-ynoate | (1R,2S)-2- | 3,4-Dichloro-4,4- | 2- |
| | (Chlorocarbonyl)cyclobutane- | difluorobutanoic acid | Oxidoperoxyperoxyacetate |
| | 1-carboxylic acid | | |
| 4-Methoxy-2-methyl-4- | 3-Formyl-1-methyl-1H- | Phosphorosooxymethyl | 2-(Trioxidanylperoxy)acetic |
| oxobutanoic acid | Pyrazole-5-carboxylic acid | hydrogen carbonate | acid |
| Acetyl sulfite | 3-Methoxy-1-methyl-1H- | 3-Chloro-4-methoxy-4- | 2-Methoxy-4-oxopent-2- |
| | pyrazole-5-carboxylic acid | oxobutanoic acid | enoic acid |
| 1,3-Dioxane-5-carboxylic | (2S,4S)-4-(Fluoromethyl)-5- | Carbamoyl hydrogen carbonate | 2-Phosphanylcyclopentane- |
| Acid | oxopyrrolidine-2-carboxylic | | 1-carboxylic acid |
| | acid | | |
| 3-(Methoxycarbonyl)but-3- | (4S)-3-Nitroso-1,3-thiazolidine- | 3-Methyl-4- | 2- |
| enoic acid | 4-carboxylic acid | oxocyclohexanecarboxylic acid | [Deuteriomethyl(nitroso)amino- |
| | | | lacetic acid |
| 3-Amino-4- | N-Bromo-N-methylglycine | 2-Prop-1-en-2-yloxyacetic acid | 3-[2-(Oxiran-2- |
| hydroxypentanoic acid | | | yl)ethoxy]propanoic acid |
| 3-Chloro-4-methylthiophene- | (2S)-1-Hydroxy-5- | Acetyloxymethanesulfonic acid | (E)-3-Hydroxy-4-oxobut-2- |
| 2-carboxylic acid | oxopyrrolidine-2-carboxylic | | enoic acid |
| | acid | | |
| 2-Amino-3- | 2- | Carbonic acid sec-butyl ester | (Z)-(113C)But-2-enedioic |
| (dimethylcarbamoyl)propanoic | (Methylcarbamoyl)cyclopropane- | | acid |
| acid | 1-carboxylic acid | | |
| 2- | 2- | 2-(1-Hydroxyethylamino)acetic | 3- |
| [Carboxy(hydroxy)amino]acetic | (Ethylcarbamoyl)cyclopropane- | acid | ((15N)Azanylidynemethyl)prop- |
| acid | 1-carboxylic acid | | 2-ynoic acid |
| 5,6-Dihydro-1,4-dioxine-2- | (2S,3S)-3- | 3-Oxopropyl hydrogen sulfate | (Z)-2,3- |
| carboxylic acid | Methoxycarbonyloxirane-2- | | Dideuterio(113C)but-2- |
| | carboxylic acid | | enedioic acid |
| Tetrahydrofuran-3- | (1S,5S,6S)-6-Fluoro-2- | 1,4-Dioxine-2-carboxylic acid | 2,2,3,3- |
| carboxylic acid | oxobicyclo[3.1.0]hexane-6- | | Tetradeuterio(113C)butanedioic |
| | carboxylic acid | | acid |
| 4-Hydroxy-4-oxobut-2- | 2-Methyl-1,4-oxathiine-3- | 2-(Sulfanylamino)propanoic | (E)-2,3- |
| enoate | carboxylic acid | acid | Dideuterio(113C)but-2- |
| | | | enedioic acid |
| 2-[[2- | (2R,3S)-3- | 1,2,2-Trichloroethyl hydrogen | 2-Acetyl-2- |
| (Methylamino)acetyl]amino] | Ethoxycarbonyloxirane-2- | carbonate | aminocyclopropane-1- |
| propanoic acid | carboxylic acid | | carboxylic acid |
| 2-Cyclopenta-1,3-dien-1- | 5-Methyl-4-oxothiolane-2- | 4,5-Dioxopentanoate | 2,2,3,3-Tetrafluoro-3- |
| ylacetic acid | carboxylic acid | | sulfanylpropanoic acid |
| (2,2,2-Trifluoroethoxy)acetic | 3-Nitrobut-3-en-2-one | 1-Cyanoethyl dihydrogen | 2,3,3,3-Tetrafluoro-2- |
| acid | | phosphate | sulfanylpropanoic acid |
| Methylsuccinate | (3R)-3-Nitrobutan-2-one | Propane-1,2-diol 1-phosphate | 2,4-Dimethyloxetane-2- |
| | | | carboxylic acid |
| 2-(2-Oxo-1,3-thiazolidin-3- | (E)-2-Amino-4-oxopent-2- | 2-(1,2,3-Thiadiazol-4-yl)acetic | 2-(2- |
| yl)acetic Acid | enoic acid | acid | Methoxyethoxyamino)acetic |
| | | | acid |
| 2-Acetylsulfanyl-2- | (2R)-2-Methyl-4-oxopentanoic | 2,2,3-Trimethyl-4-oxopentanoic | (2R)-2,4-Dimethylpent-4- |
| methylpropanoic acid | acid | acid | enoic acid |
| Pent-4-enoate | 3,4-Dioxopentanoic acid | 3-Methyliminopropanoic acid | (Z)-5-Fluorohex-4-enoic |
| | | | acid |
| 4-Oxo-2-(2- | (3R)-3-Methyl-4-oxopentanoic | 2-(Dichloromethyl)prop-2-enoic | [Cyclohexyl(hydroxy)methyl- |
| oxoethyl)butanoic Acid | acid | acid | ideneloxidanium |
| 2,2-Difluoro-2- | 1-(Nitroperoxy)propan-2-one | Carboxyphosphanylformic acid | 2- |
| (trifluoromethoxy)acetic Acid | | | (Trioxidanylsulfanyl)propanoic |
| | | | acid |
| (4-Oxo-thiazolidin-3-yl)- | (E)-3-Ethyl-4-oxopent-2-enoic | 2-Pyrimidinecarboxylic acid, | 3-Methyl-3H-pyrazole-5- |
| acetic acid | acid | 3,4-dihydro-4-oxo- | carboxylic acid |
| 4-Oxopentanoate | (2S)-2- | 2-(Fluoromethoxy)prop-2-enoic | (1- |
| | (Methoxyamino)propanoic acid | acid | Phosphanylethylideneamino) |
| | | | methanesulfonate |
| Isothiazole-5-carboxylic acid | N-(Acetyloxy)-L-alanine | 2-Hydroxypropan-2-yl | 2-(3H-Pyrrol-5-yl)acetic acid |
| | | hydrogen carbonate | |
| 3,4,4-Trichloro-3-butenoic | (2S)-2- | 6-Fluoro-4- | 2,2-Dichloro-2- |
| acid | [Formyl(methyl)amino]propanoic | oxobicyclo[3.1.0]hex-2-ene-6- | dihydroxyphosphinothioylacetic |
| | acid | carboxylic acid | acid |
| 1,4-Dioxane-2-carboxylic | 4-Methyl-1-oxodithiolane-4- | (Z)-3-Methoxypent-2-enoic acid | 2-Chloro-2- |
| Acid | carboxylic acid | | dihydroxyphosphinothioylacetic |
| | | | acid |
| 3-Oxocyclohexene-1- | (1R,3R)-3- | 2- | 2-Prop-2- |
| carboxylic Acid | (Hydroxymethyl)cyclopentane- | Hydroxycyclopropanecarboxylic | enoyloxycyclopropane-1- |
| | 1-carboxylic acid | acid | carboxylic acid |
| 2-Methylcyclohexane-1- | N-Methyl-N-(2- | 1,1,2,2-Tetrafluoro-2- | Acetyloxymethanesulfonate |
| carboxylate | methylpropanoyl)-L-alanine | methoxyethanesulfonate | |
| [(2- | (2S)-2-[(2-Chloroacetyl)- | 2-(2-Sulfanylidene-1,3-oxazol- | 2,2-Dideuterio-2-thiophen- |
| Ammoniopropanoyl)amino]acetate | methylaminolpropanoic acid | 3-yl)acetic acid | 2-ylacetic acid |
| 4-Amino-2-azaniumyl-4- | (R)-1-Pyrroline-5-carboxylate | 2- | 3-Fluoro-1-methylpyrazole- |
| oxobutanoate | | (Methylcarbamothioylsulfanyl)acetic | 4-carboxylic acid |
| | | acid | |
| 2- | 2-[2- | 3- | 2,2-Difluoro-2- |
| Methoxyethoxymethanedithioic | (Sulfanylmethyl)cyclopropyl]acetic | ((Imino(mercapto)methyl)ami- | fluoroperoxysulfanylacetic |
| Acid | acid | no)propanoic acid | acid |
| Maleamic acid | 3-Methyl-2-oxo-2,3-dihydro- | 4-[Hydroxy(methyl)amino]-4- | 2,3,5,6-Tetradeuterio-4- |
| | 1H-imidazole-4-carboxylic acid | oxobutanoic acid | fluorobenzoic acid |
| Glutaconic acid | (S)-2-Fluoro-4- | 2-Hydroxyethyl hydrogen | 1-Methylsulfonylaziridine-2- |
| | methylpentanoic acid | carbonate | carboxylate |
| 3-Nitroacrylate | Valeric-d9 acid | 7-Oxabicyclo[4.1.0]hept-2-ene- | (2E)-Hexa-2,5-dienoate |
| | | 3-carboxylic acid | |
| (Z)-Acetylacrylic acid | 2-[Hydroxy(propan-2- | 3-Ethoxy-2-methyl-acrylic acid | 2-(1,5-Dimethyl-1H-pyrazol- |
| | yl)phosphoryl]acetic acid | | 4-yl)acetic acid |
| 4-Methylpent-4-enoic acid | (S)-2-Mercaptobutanoic acid | 3-Methylbut-3-enoate | (1R,5S,6R)-3- |
| | | | Azabicyclo[3.1.0]hex-2-ene- |
| | | | 6-carboxylic acid |
| 4,4-Dimethyl-2-pentenoic | 2-Methyl-4,5-dihydrooxazole- | 3-Amino-2-fluoropyridine-4- | 2-[1- |
| acid | 4-carboxylic acid | carboxylic acid | (Sulfidomethyl)cyclopropyl] |
| | | | acetate |
| 4,4-Dimethyl-2Z-pentenoic | 4-Methyloxazole-2-carboxylic | 4-Chloro-2-oxobutanoic acid | 3-Nitrosooxy-4-oxobutanoic |
| acid | acid | | acid |
| 3-Pentenoic acid | (1R,2S)-2- | 3-Cyano-3-oxopropanoic acid | 2-Chloro-2- |
| | Fluorocyclopropane-1- | | oxoethanesulfonate |
| | carboxylic acid | | |
| 2-Hexenoic acid | Nicotinic Acid-d1 | (Z)-2,4,4-Trichlorobut-2-enoic | 2- |
| | | acid | Dimethylphosphoryloxyacetic |
| | | | acid |
| 4-Oxoheptanoic acid | Nicotinic Acid-d3 (major) | Ethyl 2-carboxyoxypropanoate | 3-(2- |
| | | | Methylcyclopropyl)propanoic |
| | | | acid |
| Chlorofumaric acid | 3-Pyridylacetic Acid-d6 | Methyl 2-carboxyoxyacetate | 4-Methoxy-4- |
| | | | methylpentanoic acid |
| 2-Chloro-3-methyl-cis- | 5-Chloro-4- | 3-Mercaptobutanoate | 5-Deuterio-2-methyl-1,3- |
| butenedioic acid | (chloromethyl)thiophene-2- | | oxazole-4-carboxylic acid |
| | carboxylic acid | | |
| 1-Methylcyclopentane-1- | Carboxymethoxy-dihydroxy- | 3-Methyl-4-oxo-2- | (2R)-2- |
| carboxylate | methoxyphosphanium | sulfanylpentanoic acid | [(Methoxycarbonyl)(methyl) |
| | | | amino]propanoic acid |
| Maleate | 3- | 2-Deuterio-2- | (2S)-2- |
| | Dioxidoazaniumylidenepropanoate | trimethylsilylpropanoic acid | [(Methoxycarbonyl)(methyl) |
| | | | amino]propanoic acid |
| Glutamyl group | (2S)-2-Amino-3-[(2R)-oxiran-2- | But-3-ynyl hydrogen carbonate | 2-(1,3-Difluoropropan-2- |
| | yl]propanoic acid | | yloxy)acetic acid |
| 5-Oxo-L-norleucine | 4,4-Difluoro-but-2-enoic acid | 2-Chlorooxyacetic acid | 4-Oxopentyl hydrogen |
| | | | carbonate |
| 3,5-Hexadienoic acid | 2-Thiabicyclo[3.1.0]hex-3-ene- | N-Ethyl-N-methylglycine | (2S)-2-Amino-3-deuterio-3- |
| | 6-carboxylic acid | | hydroxybutanoic acid |
| 4-Oxoisocrotonic acid | (2S)-2-Oxidobutanedioate | Carboxy(hydroxy)carbamic | 3- |
| | | acid | (Phosphanylideneamino)pro- |
| | | | panoic acid |
| 4-Methylpyrazole-3- | (2S)-2-Ammonio-5- | 3,3-Dimethylbutyl hydrogen | 2-(1- |
| carboxylic acid | oxopentanoate | carbonate | Acetoxycyclopropyl)acetic |
| | | | acid |
| (E)-3-Methylsulfonylprop-2- | 2,2-Dideuterio-4- | 1-Fluoroethyl hydrogen | 3,7- |
| enoic Acid | hydroxybutanoic acid | carbonate | Dioxabicyclo[4.1.0]heptane- |
| | | | 4-carboxylate |
| (E)-5,5-Dichloropent-2-enoic | 3,3-Dideuterio-4- | 1-Oxopyrrolidin-1-ium-2- | 3,7- |
| Acid | hydroxybutanoic acid | carboxylic acid | Dioxabicyclo[4.1.0]heptane- |
| | | | 4-carboxylic acid |
| (S)-2-Chloro-3-methylbutyric | 2,2,3,3-Tetradeuterio-4- | 4-Methoxy-3-oxobutanoic acid | 2,2-Difluoro-4- |
| acid | hydroxybutanoic acid | | methylpentanoic acid |
| (R)-2-Chloropentanoic acid | 4-Chlorobenzoic acid-(phenyl- | 2,2-Dimethylpropyl hydrogen | 2-Methyl-2H-pyrrole-5- |
| | 13C6) | carbonate | carboxylic acid |
| (2R)-2-Acetyloxypropanoic | 2,2,3,3,4,4-Hexadeuterio-4- | N,N-Dichloroglycine | (z)-4-(Dimethylamino)but-2- |
| acid | hydroxybutanoic acid | | enoic acid |
| 2-Sulfanylbutanedioate | (E)-5-Bromo-4-oxopent-2- | 2-[1- | 2,2-Difluoro-2- |
| | enoic acid | Methoxyethyl(methyl)ami- | fluorooxyethanesulfonic |
| | | no]propanoic acid | acid |
| Monomethyl maleate | 5-Chloro-4-hydroxy-2- | 3-Methylbutan-2-yl carbonate | Oxane-3-carboxylate |
| | oxovalerate | | |
| (Z)-4,4,4-Trichlorobut-2- | 2h-Imidazol-4-Ylacetic Acid | 3-Methylbutan-2-yl hydrogen | (1S,2S)-2-Ethenyl-1- |
| enoic acid | | carbonate | methylcyclopropane-1- |
| | | | carboxylic acid |
| 4-(Hydroxyimino)valeric acid | (Z)-3-Bromo-4-methoxy-4-oxo- | 5-Oxopyrazole-3-carboxylic | 4-Methoxy-2-methyl-4- |
| | 2-butenoic acid | acid | oxobutanoate |
| N-Methylmaleamic acid | 2-(1-Methyl-1H-pyrazol-5- | 3,3,3-Trifluoro-2- | 4-Oxo-2-tritiopentanoic acid |
| | yl)acetic acid | methoxypropanoic acid | |
| cis-3-Hexenoic acid | trans-2- | 2-(Aziridin-1-yl)propanoic acid | 2-Ethyl-4-hydroxy-4- |
| | (Trifluoromethyl)cyclopropane- | | oxobutan-1-olate |
| | 1-carboxylic acid | | |
| (Z)-2,3-Dichloroacrylic acid | 1-Methyl-5-oxo-4,5-dihydro- | Aziridine-1,2-dicarboxylic acid | (1S)-2-(18F)Fluoranyl-1- |
| | 1H-pyrazole-3-carboxylic acid | | methylcyclobutane-1- |
| | | | carboxylic acid |
| (E)-3-Chloro-2-methylprop- | 2,2- | Hydroperoxyacetic acid | (Z)-4-Oxohex-2-enoic acid |
| 2-enoic acid | Difluorocyclobutanecarboxylic | | |
| | acid | | |
| CID 5356531 | Fumaric acid amide | 2-(3-Fluoro-4-methylthiophen- | 4-Oxopentan-2- |
| | | 2-yl)acetic acid | ylphosphonic acid |
| Ethyl fumarate | (2S,3S)-2-Bromo-3- | 2-(1,4-Dioxan-2-yl)acetic acid | 3-(Dioxiran-3-ylidene)-3- |
| | methoxybutanoic acid | | hydroxypropanoic acid |
| (2E)-4-Hydroxy-2-methyl-2- | (2R)-2-[(2S)-2- | Ethoxy hydrogen sulfate | 2-(2-Oxo-1H-imidazol-3- |
| pentenoic acid | Hydroxypropanoyl]oxypropanoic | | yl)acetic acid |
| | acid | | |
| 3-Hexene-2,5-dione | Lactic acid lactate, D- | Acetyloxycarbamic acid | (2S)-2- |
| | | | Methylsulfanylcyclopropane- |
| | | | 1-carboxylic acid |
| 3-Acetylacrylic acid | Chloropyruvate | 3,3-Dichloro-2-methylpropanoic | 2- |
| | | acid | (Phosphanylamino)oxyacetic |
| | | | acid |
| trans-4-Hydroxypent-2-enoic | Pentanoic acid, 4-hydroxy-, | 3-Methyl-3-(oxiran-2- | (Z)-4-Amino-2-hydroxy-4- |
| acid | (S)- | yl)butanoic acid | oxobut-2-enoic acid |
| 3-Methyl-4-oxo-2-pentenoic | (4R)-4-Hydroxypentanoic acid | Cyclopropylcyanoacetic acid | 2-Phosphanyl-3H-pyrrole-4- |
| acid | | | carboxylic acid |
| Fumaramic acid | (2R)-3-Ethoxy-2- | 2-(2,2- | 3-Azido-3-methyl butanoic |
| | methylpropanoic acid | Dichlorocyclopropyl)acetic acid | acid |
| Acrylic acid, 3-(1- | (2S)-3-Methoxy-2- | 4-Chloro-2- | 1-(2-Methoxy-2- |
| methylcyclopropyl)-, E | methylpropanoic acid | methylidenepentanoic acid | oxoethyl)cyclopropane-1- |
| | | | carboxylic acid |
| 2-Butenoic acid, 4- | (1R,2R)-2- | Cyanomethyl hydrogen | 5-Hydroxy-5-oxido-2- |
| (methylamino)-4-oxo-, (Z)- | (Methoxycarbonyl)cyclopropane- | carbonate | oxopentanoate |
| | 1-carboxylate | | |
| 5-Hydroxy-2-hexenoic Acid | (1S,2S)-2- | 2-Cyano-3-hydroxybutanoic | 2H-Azirin-1-ium-1,2- |
| | (Methoxycarbonyl)cyclopropane- | acid | dicarboxylic acid |
| | 1-carboxylate | | |
| Monomethyl fumarate | (1R,5S)-6- | 4-Hydroxy-3,3-dimethyl-butyric | 2-Methylazirin-1-ium-1,2- |
| | Oxabicyclo[3.1.0]hexane-3- | acid | dicarboxylic acid |
| | carboxylic acid | | |
| cis-Pentenedioic acid | 3-Fluoro-2-methylisonicotinic | 2-Hydroxy-2- | 2-Carbamoyl-2H-azirin-1- |
| | acid | oxoethanesulfinate | ium-1-carboxylic acid |
| 2-Butenoic acid, 4,4- | 2- | Oxolan-2-ylmethyl hydrogen | (S)-5,5,5-Trifluoro-3- |
| dimethoxy-, methyl ester | (Methylsulfonimidoyl)ethyl- | carbonate | methylpentanoic acid |
| | phosphonic acid | | |
| 3-Methoxymethacrylic acid | 2- | 3-Methoxypropyl hydrogen | 4-Methoxy-4-oxo-2- |
| | (Dimethylcarbamoyl)cyclopropane- | carbonate | tritiobutanoic acid |
| | 1-carboxylic acid | | |
| 2-Propenoic acid, 3- | 3-Methyl-cyclobutaneacetic | 2-Isocyanatopropanoic acid | 4-(Methylamino)-4-oxo-2- |
| thiocyanato- | acid | | tritiobutanoic acid |
| 3-Ethoxycrotonic acid | 4-Oxo-5-sulfanylpentanoic | 2-Methylprop-2-enyl hydrogen | 2-Fluoro-2- |
| | acid | carbonate | (fluoromethoxy)acetic acid |
| Fluorofumaric acid | 3-(N- | Oxolan-3-yl hydrogen | 4-Ethyliminobutanoate |
| | Hydroxyformamido)Propanoic | carbonate | |
| | Acid | | |
| (2Z)-6-Methylhepta-2,6- | 4-(N- | 2,3-Difluoro-3-oxopropanoic | 4- |
| dienoic acid | Hydroxyformamido)Butanoic | acid | (Ethylideneamino)butanoate |
| | Acid | | |
| cis-Hex-4-enoic acid | 4-(Hydroxyamino)Pentanoic | 3-Ethoxy-3-iminopropanoic | (1S)-3-Methylidene-4- |
| | Acid | acid | oxocyclopentane-1- |
| | | | carboxylic acid |
| (Z)-4-(Hydroxyamino)-4- | Nitrosoperoxycarbonic acid | 5-Chlorohexanoic acid | 2-Methyliminobut-3-enoic |
| oxobut-2-enoic acid | | | acid |
| 2-Thiophosphorosoacetic | Nitrosoperoxycarbonate | (2S,3R)-3-Methyl-4- | (2S)-Oxirane-2,3- |
| acid | | oxoazetidine-2-carboxylic acid | dicarboxylic acid |
| 2,4-Dioxopentanoate | 2-Hexenoic acid, 5-oxo- | (2S)-2- | Deuterio 3-oxobutanoate |
| | | [Deuterio(fluoro)amino]propanoic | |
| | | acid | |
| 5-Hydroxypentanoate | (Z)-3-Bromo-4-methoxy-4- | (2S)-2-[(2- | 4-Hydroxy-4-oxobutan-1- |
| | oxobut-2-enoic acid | Deuterioacetyl)amino]propanoic | olate |
| | | acid | |
| 2-Methylidenebutanedioate | (2,4- | (2R)-2-[(2- | 2,2-Difluoro-2- |
| | Cyclopentadienylidene)acetic | Deuterioacetyl)amino]-3- | oxidoperoxysulfanylacetic |
| | acid | sulfanylpropanoic acid | acid |
| 5-Amino-4,5- | 4-Methoxy-4-oxobut-2-enoate | (R)-4-Chloro-3-hydroxybutyric | Furan-3-yl sulfate |
| dioxopentanoate | | acid | |
| (2S)-2-Amino-3- | 2-Cyano-2- | 2-Deuterio-3- | 2,2-Dimethyl-3- |
| oxobutanoate | (methoxyimino)acetic acid | trimethylsilylpropanoic acid | methylsulfinyl propanoic |
| | | | acid |
| 4- | 2-(5-Fluoropyridin-3-yl)acetic | (3R)-4-Chloro-3- | Nitromethyl |
| Oxocyclohexanecarboxylate | acid | hydroxybutanoate | carbonochloridate |
| 6-Hydroxyhexanoate | (E)-3-Cyclobutylacrylic acid | (3S)-2-Oxooxolane-3- | (Z)-2-Fluoro-5-hydroxypent- |
| | | carboxylic acid | 2-enoic acid |
| Fumarate | 2-(2-Fluoropyridin-3-YL)acetic | 3-Ketocyclopentanecarboxylate | 4-Phosphanyloxybutanoic |
| | acid | | acid |
| Maleic acid monoamide | 2-(3,3- | 3-Chloro-2- | Pentanoic-3,3-d2 acid(9CI) |
| | Difluorocyclopentyl)acetic acid | methylidenebutanoic acid | |
| (2R)-2,4-Diamino-4- | 3,3- | Butoxy hydrogen carbonate | 2- |
| oxobutanoate | Difluorocyclopentanecarboxylic | | [Methyl(phosphanyl)amino] |
| | acid | | propanoic acid |
| (1S)-3-Amino-1-carboxy-3- | 4,4-Dimethoxy-but-2-enoic | 4-Fluoro-2,3- | (Z)-2-Methoxy-4-oxopent-2- |
| oxopropan-1-aminium | acid | bis(fluoromethyl)but-2-enoic | enoic acid |
| | | acid | |
| (2S)-2-Amino-4- | 2,3,3,3-Tetrafluoro-2- | 2-Ethenoxyethylphosphonic | (2S)-2-Methyl-3- |
| oxobutanoate | methylpropanoic acid | acid | methylsulfinylpropanoic |
| | | | acid |
| cis-beta,gamma-Penteneoic | 4,4,4-Trifluoro-2-methylbut-2- | Nitroalanine | 2- |
| acid | enoic acid | | [Acetyl(methyl)amino]propanoate |
| 4,4,4-Trifluoro-3-methyl-2- | 3-Hydroxyisothiazole-5- | (3S)-3-(Methylamino)-4- | 3-(Ethylideneamino)-2- |
| butenoic acid | carboxylic acid | oxobutanoic acid | methylpropanoic acid |
| (E)-4-(Dimethylamino)-4- | 3-Mercaptovalerate | Carboxycysteine | Tritio tritiooxycarbonyl |
| oxobut-2-enoic acid | | | carbonate |
| 4-Hydroxyimino-valeric acid | (E)-3-Cyclopropylbut-2-enoic | (3S)-3-Amino-4- | (Z)-3,4-Dichlorobut-3-enoic |
| | acid | hydroxypentanoic acid | acid |
| L-Alanyl-L-alanine | 2-Ethynylisonicotinic acid | 3-Chlorobutan-2-yl hydrogen | 2-[2- |
| | | carbonate | [Deuterio(tritio)me- |
| | | | thoxy]ethoxy]acetic |
| | | | acid |
| Alanyllactate | 3-Methoxy-2-propenoic acid | Dioxolane-3-carboxylic acid | 4- |
| | | | [Deuterio(tritio)me- |
| | | | thoxy]butanoic |
| | | | acid |
| N,N-Dimethyl-L-Alanine | 5,5-Difluorohexanoic acid | Nitroperoxynitrate | 2-(2-Methyl-2H-pyrrol-3- |
| | | | yl)acetic acid |
| N-Carboxyalanine | (E)-5-Methyl-hex-2-enoic acid | 4-Fluoro-2- | (2R)-2- |
| | | methylidenebutanoic acid | (Methoxyamino)propanoic |
| | | | acid |
| (S)-2-Methoxypropanoic | 1-Chlorobutyl hydrogen | 2-Methyl-4-oxo-butyric acid | (2R)-5- |
| acid | carbonate | | Sulfanylidenepyrrolidine-2- |
| | | | carboxylic acid |
| (3R,4R)-3-Amino-4- | CID 53426360 | 3-(Oxan-4-yl)propanoic acid | 3-(114C)Methylbenzoic acid |
| hydroxypentanoic acid | | | |
| 3-Ethoxyacrylic acid | 6-Chlorohex-2-ynoic acid | Tricarbonic acid | Methylaminophosphanylformic |
| | | | acid |
| 4,4,4-Trifluorocrotonic acid | Fluorosuccinate | 2- | (3S)-3-Methyl-4- |
| | | (Dimethylphosphorylamino)acetic | oxobutanoic acid |
| | | acid | |
| Chloroacetyl-l-alanine | 2-Ethyl-4,4,4-trifluorobut-2- | 2-(2-Methoxypropoxy)acetic | (1S)-3- |
| | enoic acid | acid | Hydroxycyclopentane-1- |
| | | | carboxylic acid |
| Methyl 3- | 2-Bromo-3-methylisonicotinic | [1- | (Z)-4-Hydroperoxybut-2- |
| (methylsulfonyl)propanoate | acid | (Mercaptomethyl)cyclopropyl]acetate | enoic acid |
| (E)-3-(Dimethylamino)acrylic | 2-Isothiocyanatopropanoic | 2-[(2-Methylpropan-2- | (E)-4-Hydroperoxy-2- |
| acid | acid | yl)oxy]propanoic acid | methylbut-2-enoic acid |
| (E)-4,4-Dihydroxybut-2- | 3-Isothiocyanatobutanoic acid | Carbonic acid, monobutyl ester | (Z)-2,3-Dichloro-3- |
| enoic acid | | | hydroxyprop-2-enoic acid |
| Monoethyl fumarate | Butanedioic acid, hydroperoxy- | 2-Oxidobenzoate | 1-Deuteriohexane-2,5-dione |
| 4,4,4-Trichloro-crotonic acid | 2,2-Dichloro-2- | Carboxyoxy hydroxy carbonate | (2R,3S)-2,3-Dimethyl-4- |
| | (dichloroamino)acetic acid | | oxopentanoic acid |
| (2-Hydroxyethyl) hydrogen | 4,4-Dichloro-4-fluorobutanoic | 3,4-Dihydro-2H-thiopyran-2- | 6-Tritiohex-2-enoic acid |
| fumarate | acid | carboxylic acid | |
| Monoisopropyl Fumarate | 3-Cyanopropenoic acid | 3-Fluorocyclobutanecarboxylic | 3-(2-Oxopropoxy)propanoic |
| | | acid | acid |
| (2E)-2- | 2-Propenoic acid, 3-nitro-, | 2-Methyl-3-phosphanylbut-3- | 2-Deuterio-2-methyl-3- |
| (Methylhydrazinylidene)propanoic | methyl ester | enoic acid | oxobutanoic acid |
| acid | | | |
| (Z)-3,4,4,4-Tetrachlorobut-2- | Methyl phosphonopropanoate | (E)-4-Methylperoxybut-2- | 4-Hydroperoxypent-4-enoic |
| enoic acid | | enoate | acid |
| 3-Hydroxyimino- | 2- | (E)-4-Methylperoxybut-2-enoic | 2-(2- |
| cyclopentanecarboxylic acid | [Methane- | acid | Methoxypropanoyloxy)acetic |
| | hydrazonoyl(methyl)amino- | | acid |
| | lacetic acid | | |
| 4-Hydroxycrotonic acid | 2-Hydroperoxybut-2-enedioic | 2-Methyl-2- | 4-Hydroxy-1-methoxy-4- |
| | acid | (phosphanylamino)propanoic | oxobut-1-en-1-olate |
| | | acid | |
| Hydrogen fumarate | 4-Ethyl-5-oxooxolane-2- | 4-Methylcyclopenta-1,4-diene- | (1S,2S)-2-(2-Methoxy-2- |
| | carboxylic acid | 1-carboxylic acid | oxoethyl)cyclopropane-1- |
| | | | carboxylic acid |
| (S)-(−)-2-Acetoxypropionic | 3,3- | 2,2-Dichloro-2-deuterioacetic | 2- |
| acid | Dichlorocyclobutanecarboxylic | acid | [Methyl(phosphanyloxy)ami |
| | acid | | no]acetic acid |
| (2E)-2- | 2-Carboxyethyl | 2- | Tritio 4-methylpentanoate |
| Hydrazinylidenepropanoic | methanethiosulfonate | [[Hydroxy(methyl)phosphoryl]- | |
| Acid | | methylamino]propanoic acid | |
| (Hydroxyphosphinyl)pyruvic | 2-Fluoro-2-methylbutanoate | 3-[Hydroxy(methyl)phosphoryl]- | Potassium; carbanide; 4- |
| acid | | 2-methylpropanoic acid | oxopentanoic acid |
| Carboxymethyl- | 3-Fluoro-5-carboxypyridine | 3-(Methylamino)-4- | (2S)-4-Amino-4-oxo-2- |
| (hydroxymethyl)- | | oxopentanoic acid | (phosphanylamino)butanoic |
| oxophosphanium | | | acid |
| L-Alanine, N-formyl-N- | 4,4-Difluoro-2-methylbutanoic | (E)-4-Hydroperoxybut-2-enoic | 2- |
| hydroxy- | acid | acid | [(Methylsulfamoyl)amino]acetic |
| | | | acid |
| 2-Carboxyethyl-hydroxy- | 4-Aminooxy-4-oxobut-2-enoic | 3-Chloro-2- | 2-Chloro-4- |
| oxophosphanium | acid | (dimethylamino)propanoic acid | hydroperoxybutanoic acid |
| (2E)-2-(2- | 2-Ethoxy-2-sulfanylacetic acid | 2-Methoxy-4-oxopentanoic acid | 2-Bromo-4- |
| Methylcyclohexylidene)acetic | | | hydroperoxybutanoic acid |
| acid | | | |
| (E)-4-Bromobut-3-enoic acid | (Ethoxyimino)acetic acid | 3-Methoxy-4-oxopentanoic acid | (E)-3-Formyloxyprop-2- |
| | | | enoic acid |
| 3-Ethoxyisocrotonic acid | 2-Amino-5-fluoro-4- | 3-Methanesulfinyl-2- | (Z)-4-Aminooxy-4-oxobut-2- |
| | oxopentanoic acid | methylpropanoic acid | enoic acid |
| Hydroxy-(2-methoxyethoxy)- | 3-Cyanobut-2-enoic acid | 2- | (Z)-3-(Oxidoamino)prop-2- |
| oxophosphanium | | (Methylideneamino)propanoic | enoic acid |
| | | acid | |
| (R)-4-Methoxy-2-methyl-4- | 3-Aminooxy-2- | 5-Fluoro-2- | 2- |
| oxobutanoic acid | methylpropanoic acid | methylidenepentanoic acid | Oxidoperoxysulfanylacetic |
| | | | acid |
| 3-Hydroxy-2,3- | (2S)-4-Methoxy-2- | 4-Methylpent-4-enoate | 4-Hydroxyiminobutanoic |
| dioxopropane-1-sulfinate | methylbutanoic acid | | acid |
| (5Z)-5-Hydroxyimino-4- | (1R)-2- | Acetonbisulfit | 2- |
| oxopentanoic acid | Propylidenecyclopropane-1- | | (Methylperoxyamino)propanoic |
| | carboxylic acid | | acid |
| (Pyridazin-3-yloxy)acetic | 2-Fluorocyclohexa-1,3-diene- | Carboxyperoxy hydrogen | 2-Bromo-3-methyl-4-oxo-2- |
| acid | 1-carboxylic acid | carbonate | pentenoic acid |
| Pyruvatoxime | 3-Formamidoprop-2-enoic acid | 2-Acetamidopropanoate | (1S,3S)-3- |
| | | | Methoxycyclopentane-1- |
| | | | carboxylic acid |
| 5-Oxohexanoate | 4-Chloro-4-oxobut-2-enoic | 2-(Chlorosulfonyl)propanoic | 2-Methyl-4- |
| | acid | acid | (phosphanylamino)butanoic |
| | | | acid |
| 3-Chlorobut-3-enoic acid | 2-[Acetyl(methyl)amino]-2- | 5-Methyloxolane-2-carboxylic | 2-[Methyl(2-methylprop-2- |
| | sulfanylideneacetic acid | acid | enoyl)amino]acetic acid |
| Exo-Bicyclo(2.2.1)hept-5- | 3-Hydroperoxyprop-2-enoic | 3,3,4,4-Tetrafluoro-2- | (4S)-Bicyclo[2.2.1]hept-5- |
| ene-2-carboxylic acid | acid | methylidenepentanoic acid | ene-2-carboxylic acid |
| gamma-Chlorocrotonic acid | 2-Methyl-4-oxobut-2-enoic | 2-Methylidene-4- | 5-Fluoro-4-methylnicotinic |
| | acid | sulfanylidenebutanoic acid | acid |
| 4,4-Dichloro-2-butenoic acid | 3- | Piperidin-1-yl hydrogen | 2-Formyloxy-2-oxoacetic |
| | (Ethanethioylamino)propanoic | carbonate | acid |
| | acid | | |
| (Z)-3-Heptenoic acid | 2-(2-Methoxyethoxy)prop-2- | 2-Bromo-3-oxobutanoic acid | 3-(Methoxyamino)propanoic |
| | enoic acid | | acid |
| (E)-4-Fluorobut-2-enoic Acid | (2S)-Aziridine-1,2-dicarboxylic | (E)-4-Hydroxy-3-methyl-2- | 3- |
| | acid | pentenoic acid | [Methoxycarbonyl(methyl)ami- |
| | | | no]propanoic acid |
| 4-Bromocrotonic acid | 3-Chloro-4-chlorooxy-4- | (Z)-4-Chloro-3-methylbut-2- | 3-[Formyl(methyl)amino]-2- |
| | oxobutanoic acid | enoic acid | methylpropanoic acid |
| 2-Chloromaleic acid | 2,3-Dichloro-4-methoxy-4- | (Z)-4-(Dimethylamino)-4- | 2-[1- |
| | oxobut-2-enoic acid | oxobut-2-enoic acid | Cyanoethyl(methyl)amino]acetic |
| | | | acid |
| (2E,5E)-2,5-Heptadienoic | 2-Iodobut-2-enedioic acid | 2-Chloro-2,3,3-trifluorosuccinic | 2-Cyclopropylcyclopropane- |
| acid | | acid | 1-carboxylic acid |
| 4,5-Oxohexenoate | Trimethyl(sulfooxy)azanium | 2,3-Difluoro-2-methylpropanoic | (E)-4-Propan-2-yloxybut-2- |
| | | acid | enoic acid |
| 3-Cyclopropylprop-2-enoic | 2-Butenoic acid, 4-hydroxy-3- | 2-Fluoro-2-methyl-pent-4-enoic | 2-Methyl-2-(propan-2- |
| acid | methyl- | acid | yl)cyclopropane-1- |
| | | | carboxylic acid |
| 3-(Methylsulfanyl)prop-2- | 2-Methylidene-5- | Carboxyoxycarbamic acid | 2-Ethyl-2- |
| enoic acid | sulfanylpentanoic acid | | methylcyclopropane-1- |
| | | | carboxylic acid |
| (E)-2-Sulfanylbut-2-enedioic | 4-Methoxy-3-methyl-4-oxobut- | 2,3-Dimethylisonicotinic acid | 3-Methyloxane-3-carboxylic |
| acid | 2-enoic acid | | acid |
| 2,4-Pentadienoic acid, 4- | 2-Nitroethyl hydrogen | 3-Oxopropylcarbamic acid | 3- |
| hydroxy- | carbonate | | (Trifluoromethoxy)propanoic |
| | | | acid |
| (Z)-4-Hydroxypent-3-enoic | 3-Cyclopropyliminopropanoic | 3-Methylcyclopent-2-ene-1- | (2Z)-2-(Oxolan-3- |
| Acid | acid | carboxylic acid | ylidene)acetic acid |
| 4,5-Epoxy-2-hexenoic acid | (2R)-2-(Chloroamino)-3- | 2-Ethoxyethanesulfonic acid | 2-Formamidooxyacetic acid |
| | sulfanylpropanoic acid | | |
| 1,2-Dithiolane-4-carboxylic | 3-Methylcyclohexa-1,5-diene- | 2H-Thiopyran-5-carboxylic acid | Spiro[2.3]hexane-5- |
| acid, 1-oxide | 1-carboxylic acid | | carboxylic acid |
| Vinyl hydrogen succinate | 6-Oxo-2,3-dihydropyran-3- | 2-Sulfanyl-2-(1,3-thiazol-4- | 2-[1- |
| | carboxylic acid | yl)acetic acid | (Methoxymethyl)cyclopropyl |
| | | | lacetic acid |
| N-Vinyloxycarbonyl-L- | Pyrazin-2-yl hydrogen | 5-Sulfanylidene-4,5-dihydro- | 5-Methoxy-4-oxopentanoic |
| alanine | carbonate | 1,3,4-oxadiazole-2-carboxylic | acid |
| | | acid | |
| (2S,3S)-Oxirane-2,3- | 3,4,4-Trichloro-2- | 4-Chloro-5-methyl-2- | 3-Cycloprop-2-en-1- |
| dicarboxylic acid | methylidenebutanoic acid | thiophenecarboxylic acid | ylpropanoic acid |
| 2-Cyclopenta-2,4-dien-1- | Thiazinane-3-carboxylic acid | 5-Chloro-4-methylthiophene-3- | 2-Cycloprop-2-en-1-ylacetic |
| ylacetic acid | | carboxylic acid | acid |
| 1-Propyl-1H-pyrazole-4- | 3-(Chloromethyl)-4- | 5-Chlorofuran-3-carboxylic acid | 2-(Cyclopropen-1-yl)acetic |
| carboxylic acid | hydroxybutanoic acid | | acid |
| N-Methyl-N- | (2R)-2-Bromo-3- | 2,2,3,3- | (5-Methyl-1,3,4-oxadiazol- |
| (methylsulfonyl)glycine | cyclopropylpropanoic acid | Tetrakis(sulfanyl)propanoic | 2-yl) hydrogen carbonate |
| | | acid | |
| (Z)-2-Hydroxy-4-oxopent-2- | 2-(3-Methyl-1,2-oxazol-4- | 4-Cyano-2-methylbutanoic acid | Pyridazin-4-yl hydrogen |
| enoic acid | yl)acetic acid | | carbonate |
| 2-[(2R)-Oxan-2-yl]acetic | (1R,5S)-Bicyclo[3.2.0]heptane- | Carboxyoxy methanesulfonate | 2-Methylbicyclo[1.1.0]but- |
| acid | 3-carboxylic acid | | 1(3)-ene-2-carboxylic acid |
| (1R,3S,4S)- | 1-Chlorobutan-2-yl hydrogen | 2H-Oxazine-3-carboxylic acid | 2,2- |
| Bicyclo[2.2.1]heptane-3- | carbonate | | Bis(fluoromethyl)cyclopropane- |
| carboxylic acid | | | 1-carboxylic acid |
| Fosfomicina | 2-Bromo-4-methylpent-4-enoic | 4-(Vinyloxy)butyric acid | 3-Methyl-2H-pyridine-3- |
| | acid | | carboxylic acid |
| 3-Aci-nitropropanoic acid | 1,1,1-Trifluoropropan-2-yl | (E)-3-Propan-2-yloxyprop-2- | (2R,3S)-3-Methyloxolane-2- |
| | hydrogen carbonate | enoic acid | carboxylic acid |
| 3,3-Dichloro-propanoic acid | 2,2,3-Trifluoro-3- | 4-Thiazolecarboxylic acid, 2- | (1R,2R)-2- |
| | hydroxyhexanoic acid | methoxy- | (Bromomethyl)cyclopropane- |
| | | | 1-carboxylic acid |
| (2Z)-2- | 2-Methyl-3- | (E)-4-Chloro-3-methoxybut-2- | (3S)-3- |
| Hydrazinylidenepropanoic | (methyldiazenyl)propanoic | enoic acid | Hydroxycyclohexane-1- |
| acid | acid | | carboxylic acid |
| (1S,2S)-Cyclopropane-1,2- | 3-(1,3-Dioxolan-2-yl)-2,2- | 2-Nitro-2,2-bis(sulfanyl)acetic | (1S)-2-Methylcyclopropane- |
| dicarboxylic acid | difluoropropanoic acid | acid | 1-carboxylic acid |
| 5-Methylthiophene-2- | 3,3-Dideuterio-2- | 3-Bromooxy-3-oxopropanoic | (2S)-2-(Pyrazol-1- |
| carboxylate | (trideuteriomethyl)prop-2-enoic | acid | ylamino)propanoic acid |
| | acid | | |
| Mono-Methyl Succinate | Tritio 2-methylprop-2-enoate | 2-Phosphooxypropanoic acid | 5-Oxa-thiomorpholine-3- |
| | | | carboxylic acid |
| (2S)-2-(Propan-2- | Carbamoyl-(carboxymethyl)- | 2-Methyl-3H-thiophene-2- | 3-Cyanooxirene-2- |
| ylideneamino)oxypropanoic | dimethylazanium | carboxylic acid | carboxylic acid |
| acid | | | |
| (E)-4-Oxopent-2-enoate | 2-Sulfanyl-2- | (E)-5-Hydroxypent-3-enoic acid | 2-Fluoro-2-(1- |
| | sulfanyloxypropanoic acid | | fluorocyclopropyl)cycloprop |
| | | | ane-1-carboxylic acid |
| Pent-2-enedioate | 3-Chloropent-2-enoic acid | 2- | (3-Methyl-1,2-oxazol-4-yl) |
| | | [Carboxymethyl(fluoro)amino]acetic | hydrogen carbonate |
| | | acid | |
| 6-Chloropyridine-3- | 4-Amino-2-methyl-4-oxobut-2- | (Z)-2-Chloro-3-methoxybut-2- | 3,4-Dimethylcyclopentane- |
| carboxylate | enoic acid | enoic acid | 1-carboxylic acid |
| 1-Methylcyclohexane-1- | 4-Amino-2-fluoro-4-oxobut-2- | 3-Fluorooxycarbonylbut-3- | 3-Cyclopropylidene-3- |
| carboxylate | enoic acid | enoic acid | hydroxy-2-oxopropanoic |
| | | | acid |
| 4-Methylidene-5-oxofuran-3- | 4-Chloro-3,4,4-trifluorobut-2- | 2-(Chloromethyl)butanedioic | (2S)-3-Methyl-1- |
| carboxylate | enoic acid | acid | phosphanylpyrrolidine-2- |
| | | | carboxylic acid |
| m-Methylbenzoate | Carboxyoxymethylacetate | 2,2-Dichloroethyl hydrogen | (4R)-4-Methyl-3,4-dihydro- |
| | | carbonate | 2H-pyrrole-5-carboxylic acid |
| 3-(Chloromethyl)benzoate | 2-1(2- | 4,5-Dihydrofuran-2-carboxylic | (3R)-3-Methyl-1- |
| | Aminooxyacetyl)amino]acetic | acid | phosphanylpyrrolidine-2- |
| | acid | | carboxylic acid |
| 2-Cyclopentylacetate | 2,6-Dioxohexanoic acid | 1-(Furan-2-yl)cyclopropane-1- | (3S)-3-Methyl-1- |
| | | carboxylic acid | phosphanylpyrrolidine-2- |
| | | | carboxylic acid |
| (1R,2R)-Cyclopropane-1,2- | 2-Cyanoethyl hydrogen | Acetoamidocyanoacetate | (2S,3R)-3-Methyl-1- |
| dicarboxylic acid | carbonate | | phosphanylpyrrolidine-2- |
| | | | carboxylic acid |
| (S)-(−)-Methylsuccinic acid | 3-Methyldioxirane-3-carboxylic | 5-Methyloxazole-4-acetic Acid | 4H-Azepine-3-carboxylic |
| | acid | | acid |
| 6-Methylnicotinate | 5-Hydroxypent-2-enoic acid | 5-Aminofuran-3-carboxylic acid | 3,4-Dihydro-2H-azepine-3- |
| | | | carboxylic acid |
| 3-Sulfidobenzoate | 4-(2-Methyloxiran-2-yl)but-2- | [2-(Dimethylamino)-2- | 5H-Diazepine-4-carboxylic |
| | enoic acid | oxoethyllphosphonic acid | acid |
| 3-Acetamidopropanoate | 5-Iminopentanoic acid | 2,3,3,4,4,4-Hexafluorobutanoic | 5,6-Dihydro-4H-diazepine- |
| | | acid | 4-carboxylic acid |
| 2-[(1S)-Cyclopent-2-en-1- | 2-(Methyldiazenyl)propanoic | 2-Methyloxirane-2,3- | (6S)-2- |
| yl]acetic acid | acid | dicarboxylic acid | Oxobicyclo[3.1.0]hexane-6- |
| | | | carboxylic acid |
| 2-[(1R)-Cyclopent-2-en-1- | [[2-(Hydroxyamino)-2- | (Sulfanylamino)sulfanylformic | 2-(1,3-Oxathiolan-2- |
| yl]acetic acid | oxoethyl]amino]phosphonic | acid | yl)acetic acid |
| | acid | | |
| 2,3-Difluorobenzoate | 4-Ethoxybut-2-ynoic acid | 2-Isocyanatoethanesulfonic | 1,3-Thiazol-4-yl hydrogen |
| | | acid | carbonate |
| Acetoacetate | 2-Oxo-1,3-dihydropyrrole-4- | Carboxymethyl-hydroxy- | 2-(2- |
| | carboxylic acid | oxophosphanium | Methylidenecyclopropyl)propanoic |
| | | | acid |
| 2- | 1-Fluoropropyl hydrogen | [(Trimethylsilyl)oxy]acetic | 2-Methyl-5H-1,3-thiazole-2- |
| [Carbamoyl(methyl)amino]acetate | carbonate | acid | carboxylic acid |
| (R)-3-Hydroxybutyrate | 3,3- | Tetrahydro-2H-thiopyran-2- | 1,3-Oxazepane-4- |
| | Difluorocyclohexanecarboxylic | carboxylic acid | carboxylic acid |
| | acid | | |
| 3-Nitropropanoate | (3R)-2,2,3- | Tetrahydro-2H-thiopyran-3- | 2H-1,4-Thiazine-3- |
| | Trimethylcyclopropane-1- | carboxylic acid | carboxylic acid |
| | carboxylic acid | | |
| 4-Amino-4-oxobut-2-enoate | 5-Aminooxy-5-oxopentanoic | 3- | 4-(113C)Methylbenzoic acid |
| | acid | [Ethyl(hydroxy)phos- | |
| | | phoryl]propanoic | |
| | | acid | |
| 3- | (2R)-2- | 4-Methoxy-2-sulfanylbutanoic | CID 66995527 |
| (Carbamoylamino)propanoate | (Fluoroamino)propanoic acid | acid | |
| (S)-3-Hydroxybutyrate | Deuterio (2S)-2- | 6-Chloro-2-methylpyrimidine-4- | Oxazepane-6-carboxylic |
| | (fluoroamino)propanoate | carboxylic acid | acid |
| 1H-Pyrazole-5-carboxylate | 2-Methyl-3-(3-methyloxiran-2- | 2-(1H-1,2,3-Triazol-1-yl)acetic | (1S)-2-Chloro-2- |
| | yl)prop-2-enoic acid | acid | fluorocyclopropane-1- |
| | | | carboxylic acid |
| 1-Methyl-1H-pyrazole-4- | (3R)-3-Amino-4-oxobutanoic | 4-Cyano-2-hydroxybutanoic | (1S)-2-Fluorocyclopropane- |
| carboxylate | acid | acid | 1-carboxylic acid |
| 5-Methyl-1,2-oxazole-4- | (1S)-Cyclopropane-1,2- | Acetyl-(carboxymethyl)- | [(3R)-Oxolan-3-yl] hydrogen |
| carboxylate | dicarboxylic acid | dimethylazanium | carbonate |
| Pyrimidine-5-carboxylate | 3-Hydroxyprop-1- | 4-Bromo-5-oxopentanoic acid | 1-Chloro-3- |
| | enylphosphonic acid | | methylidenecyclobutane-1- |
| | | | carboxylic acid |
| (2R)-4-Amino-2-ammonio-4- | (3S)-3-Cyano-3- | 2,2,3,3-Tetrafluoro-3- | (5-Chloro-1-methyl-1H- |
| oxobutanoate | (hydroxyamino)propanoic acid | fluorosulfonylpropanoic acid | pyrazol-4-yl)acetic acid |
| 3- | 2,3-Difluorobutanoic acid | 3- | 2-Oxo-1,3-dioxane-4- |
| (Methylsulfanyl)propanoate | | Carbonochloridoylsul- | carboxylic acid |
| | | fanylpropanoic acid | |
| 3-Chloropropanoate | 3-(Dimethylamino)-2- | (E)-2-Sulfanylhex-4-enoic acid | 3,4-Dihydro-2H-pyran-3- |
| | isocyanoprop-2-enoic acid | | carboxylic acid |
| Oxane-4-carboxylate | (2R,5R)-5- | 2-Chlorocyclohex-2-ene-1- | 3-Fluoro-4- |
| | (Sulfanylmethyl)thiolane-2- | carboxylic acid | hydroxycyclopentane-1- |
| | carboxylic acid | | carboxylic acid |
| (2S)-2-[[(2S)-2- | 2-[Methyl(2- | 3-Chlorocyclohexene-1- | 1,3-Oxathiane-5-carboxylic |
| Azaniumylpropanoyl]amino] | oxoethyl)amino]acetic acid | carboxylic acid | acid |
| propanoate | | | |
| 2-Acetamido-2-propenoate | 2-Oxaldehydoyloxyacetic acid | 2-Fluoro-3-sulfanyl propanoic | 2-(2- |
| | | acid | Methylcyclopropyl)propanoic |
| | | | acid |
| 3-Bromopropanoate | 2-(1- | 3-Methyl-4-oxoazetidine-2- | 1,3-Oxathiolane-4- |
| | Fluoroethylideneamino)acetic | carboxylic acid | carboxylic acid |
| | acid | | |
| Trichloroacrylate | 3,4-Dihydropyridine-5- | 2,2,3-Trifluorosuccinic acid | 2-(Oxan-3-yloxy)acetic acid |
| | carboxylic acid | | |
| 3-Bromomethylpropionate | 3-Formamidobut-2-enoic acid | 2,3,4,4-Tetrachlorobutanoic | 2-Fluoro-3- |
| | | acid | methylisonicotinic acid |
| 3-Bromopropylacetate | 5-Oxaproline | Pyridine-3-carbodithioic acid | 1-Chloropyrrole-3- |
| | | | carboxylic acid |
| 5-Chloronicotinate | 4-Methoxypent-3-enoic acid | 2-Hydroxy-3-methoxy-2- | 3-Hydroxy-4- |
| | | methyl-3-oxopropanoic acid | methylcyclopentane-1- |
| | | | carboxylic acid |
| But-2-ynoate | 5-Hydroxy-2-methylpent-2- | Prop-2-enylsulfanylformic acid | 2-Methyl-4-oxo-3H-pyran-2- |
| | enoic acid | | carboxylic acid |
| Succinamate | 1-Cyclopropylethyl hydrogen | 2,2,3,3-Tetrafluorobutanoic | (4-Methylthiophen-2-yl) |
| | carbonate | acid | hydrogen carbonate |
| Butanedioic acid, | 1-Chloropropan-2-yl hydrogen | Hydroxy-oxo- | 2-(2-Oxopyrrolidin-1- |
| methylene-, 4-methyl ester | carbonate | (phosphonomethyl)phosphanium | yl)oxyacetic acid |
| beta-Alanyl-L-alanine | 2-Chlorobutan-2-yl hydrogen | 3-Trichlorosilylpropanoic acid | 3-(1-Bromocycloprop-2-en- |
| | carbonate | | 1-yl)propanoic acid |
| (1S,2S)-2- | (1-Chloro-2-methylpropyl) | 2-Trichlorosilylacetic acid | (3S)-3- |
| Methylcyclopropane-1- | hydrogen carbonate | | Hydroxycyclopentane-1- |
| carboxylic acid | | | carboxylic acid |
| (1S,2R)-2- | 3- | 2-Fluoro-2-iodo-1- | 1-Chloro-5-methylpyrrole-2- |
| Methylcyclopropane-1- | Dihydroxyphosphinothioylpropanoic | methylcyclopropane-1- | carboxylic acid |
| carboxylic acid | acid | carboxylic acid | |
| cis-2- | Fluoromethyl hydrogen | 2-Fluoro-2-iodocyclopropane-1- | 1,3-Oxazol-4-yl hydrogen |
| Methylcyclopropanecarboxylic | carbonate | carboxylic acid | carbonate |
| acid | | | |
| trans-2- | 4-Chloro-3-methoxybut-2- | 2-(Disulfanyl)acetic acid | 1- |
| Methylcyclopropanecarboxylic | enoic acid | | [(Nitrooxy)methyl]cyclopropane- |
| acid | | | 1-carboxylic acid |
| Butanedioic acid, ethyl-, (S)- | 3-Propanoyloxypropanoic acid | 2-Bromo-3,3- | (1S,2S)-2- |
| | | dimethoxypropanoic acid | (Methoxymethyl)cyclopropane- |
| | | | 1-carboxylic acid |
| (E)-Hex-2-enoate | (2S,3S)-3-Carbamoyloxirane- | 2-(Methylsulfonyl)propanoic | Pyridazin-3-yl hydrogen |
| | 2-carboxylic acid | acid | carbonate |
| 2-Ethoxyacetate | 2-Chlorooxyiminoacetic acid | Thiepine-2-carboxylic acid | 2-Methyl-2-[(Z)-prop-1- |
| | | | enyl]cyclopropane-1- |
| | | | carboxylic acid |
| Pent-4-ynoate | 4-Chloro-2,2-dimethylbut-3- | Carbonic acid dichloromethyl | (1R,2S)-2- |
| | enoic acid | ester | Propanoylcyclopropane-1- |
| | | | carboxylic acid |
| (S)-2-Chlorobutyric Acid | Hexa-2,3,4-trienoic acid | 2-Hydroxyphosphanylacetic | (1S,2R)-2- |
| | | acid | Acetylcyclopropane-1- |
| | | | carboxylic acid |
| (S)-1-Methyl-2,2- | 2-Methyl-1,3-oxathiane-4- | 2-(2-Chloro-2-oxoethoxy)acetic | (6S)-2- |
| dichlorocyclopropanecarboxylic | carboxylic acid | acid | Oxabicyclo[3.1.0]hexane-6- |
| acid | | | carboxylic acid |
| 4,4,4-Trifluorobutanoate | 2- | 2-Cyanatoacetic acid | [(1S)-2,2- |
| | (Methoxysulfinylamino)propanoic | | Dimethylcyclopropyl] |
| | acid | | hydrogen carbonate |
| L-Alanine, N-(N- | 2-(2-Fluoroethoxyimino)acetic | 2-[Chloro(hydroxy)amino]acetic | 5-Oxo-1,2-dihydropyrrole-3- |
| methylglycyl)- | acid | acid | carboxylic acid |
| 2-Methylsulfonylacetate | 2-Methyl-4-oxohexa-2,5- | (Ethylsulfinyl)acetic acid | 4-Oxa-1- |
| | dienoic acid | | azabicyclo[3.2.0]hept-2-en- |
| | | | 2-yl hydrogen carbonate |
| Trifluoromethylacetate | 2-Amino-5- | 3-Propan-2-ylsulfinylpropanoic | 1,4-Thiazepine-7-carboxylic |
| | phosphanylpentanoic acid | acid | acid |
| (R)-4,4,4-Trifluoro-3- | 3-(Ethylideneamino)propanoic | 3-(Propane-1-sulfinyl)-propionic | 2-Acetyl-1- |
| methylbutanoic acid | acid | acid | methylcyclopropane-1- |
| | | | carboxylic acid |
| 2-(Trifluoromethyl)prop-2- | 3-Nitrososulfanylbutanoic acid | 2-Thionitrosoacetic acid | (5-Methyl-1,3-dioxan-5-yl) |
| enoate | | | hydrogen carbonate |
| (2R)-5-Oxopyrrolidine-2- | 3-Furancarboxylic acid, 4- | 2-(4,5-Dihydro-1,2-oxazol-5- | (6-Methylpyrazin-2-yl) |
| carboxylate | hydroxy- | yl)acetic acid | hydrogen carbonate |
| (3S)-1-Methyl-5- | 2-Chloro-3-(oxiran-2- | 2-Furanacetic acid, 3-methyl- | 2-Methyl-3,4- |
| oxopyrrolidine-3-carboxylic | yl)propanoic acid | | dihydropyridine-5-carboxylic |
| acid | | | acid |
| (3R)-1-Methyl-5- | 3- | 3-Fluoroenanthic acid | 7-Oxabicyclo[2.2.1]heptan- |
| oxopyrrolidine-3-carboxylic | [Carbamoyl(methyl)amino]propanoic | | 2-yl hydrogen carbonate |
| acid | acid | | |
| 5-Azaniumyl-4- | 3-Ethoxypropyl hydrogen | 2-(2-Fluoroethoxy)acetic acid | (R)-3,3- |
| oxopentanoate | carbonate | | Difluorocyclopentanecarboxylic |
| | | | acid |
| (2S,3S)-2,3- | 2-Ethylperoxypropanoic acid | 2-(2-Oxoazetidin-1- | 1-Phosphanylpyrrole-3- |
| Dimercaptobutanedioic acid | | yl)propanoic acid | carboxylic acid |
| (4R)-4-Hydroxyheptanoic | 2-Iodoethyl hydrogen | 1,3-Dioxolan-4-ylmethyl | 1- |
| acid | carbonate | carbonochloridate | [(Carbamoylamino)methyl]cyclo- |
| | | | propane-1-carboxylic acid |
| 3-Mercaptopropionate | 2-Methyl-3-(3-methyloxiren-2- | 2-Hydroxyethyl hydrogen | 2-(3-Oxocyclobutyl)acetic |
| | yl)prop-2-enoic acid | oxalate | acid |
| (2R)-2-Sulfanyl propanoic | 2-Oxohex-3-enedial | 4-Amino-3,4-dioxobutanoic | 2,3-Dihydropyridine-4- |
| acid | | acid | carboxylic acid |
| Cyclohexene-1-carboxylate | 4-Methylsulfanylbut-2-enoic | 4-Chloro-4,4-difluorobutyric | 1-Chloro-4- |
| | acid | acid | fluorocyclohexane-1- |
| | | | carboxylic acid |
| Cycloheptanecarboxylate | 6-Oxa-1- | 2- | 1,3-Dichlorocyclopentane- |
| | azabicyclo[3.1.0]hexane-2- | Cyanocyclopropanecarboxylic | 1-carboxylic acid |
| | carboxylic acid | acid | |
| (S)-(−)-3- | 2-(2-Sulfanylacetyl)oxyacetic | 2-(5-Methyl-2,3-dihydrofuran-3- | 1,3-Dichlorocyclobutane-1- |
| Cyclohexenecarboxylic acid | acid | yl)acetic acid | carboxylic acid |
| 2-(2-Oxopyrrolidin-1- | 5-Chlorohex-2-enoic acid | 2-(Dimethylamino)ethyl | 1-Chloro-3- |
| yl)acetate | | hydrogen carbonate | fluorocyclopentane-1- |
| | | | carboxylic acid |
| (5S)-5-Hydroxyhexanoic | [Acetyl(methyl)amino]phosphonic | 2-(2,2,2-Trichloroethoxy)acetic | 2- |
| acid | acid | acid | (18F)Fluoranylcyclopropane- |
| | | | 1-carboxylic acid |
| (5R)-5-Hydroxyhexanoic | 2-Methoxy-4-oxobutanoic acid | 5-Oxazolecarboxylic acid, 2- | 3- |
| acid | | (chloromethyl)- | (18F)Fluoranylcyclobutane- |
| | | | 1-carboxylic acid |
| (Z)-3-Acetamidobut-2-enoic | 4-Methylidenecyclohexa-1,5- | 1-Hydroxypropyl hydrogen | 2-Oxopyran-4-carboxylic |
| acid | diene-1-carboxylic acid | carbonate | acid |
| (2S)-5-Oxo-2- | 3-Nitrosopropanoic acid | 3-Formamido-2- | (4-Oxo-3H-pyridin-5-yl) |
| oxolanecarboxylate | | hydroxypropanoic acid | hydrogen carbonate |
| (S)-4,4,4-Trifluoro-3- | 4-Chloro-1,2-thiazole-3- | 3-Trimethylsilylbutanoic acid | 4-Phosphanylcyclopenta- |
| methylbutanoic acid | carboxylic acid | | 1,3-diene-1-carboxylic acid |
| (1S)-2,2- | 2,3-Dimethyl-4-oxopent-2- | 2-(Methoxyamino)acetic acid | 5-Methylidene-4H- |
| Difluorocyclopropane-1- | enoic acid | | pyridazine-6-carboxylic acid |
| carboxylic acid | | | |
| (2R,3R)-Oxirane-2,3- | 5-Methyl-3,4-dihydropyrazole- | 2-(1,2-Oxazolidin-5-yl)acetic | 2-(4-Iodo-3-methyl-1,2- |
| dicarboxylate | 5-carboxylic acid | acid | oxazol-5-yl)acetic acid |
| (2R,4S)-4-Fluoro-5- | Fluorothreonine | 3,3,4-Trifluoro-2- | 2-Prop-1-enylcyclopropane- |
| oxopyrrolidine-2-carboxylic | | methylidenebutanoic acid | 1-carboxylic acid |
| acid | | | |
| (2S,4S)-4-Fluoro-5- | 3-lodopropyl hydrogen | (2-Methylpropan-2-yl)oxy | 2-(3-Methylideneoxolan-2- |
| oxopyrrolidine-2-carboxylic | carbonate | hydrogen carbonate | yl)acetic acid |
| acid | | | |
| (2R)-2-Methyloxolane-2- | 4-(Carbamothioylamino)-4- | Carboxy 2-methylprop-2- | (1S)-1-Chloro-2,2- |
| carboxylic acid | oxobut-2-enoic acid | enoate | dimethylcyclopropane-1- |
| | | | carboxylic acid |
| (2S)-2-Methyloxolane-2- | 2,3,4,4-Tetrachloro-2-butenoic | Oxiranepropanoic acid, 3- | (1,3-Dimethylpyrazol-4-yl) |
| carboxylic acid | acid | methyl-, trans- | hydrogen carbonate |
| 2-[(2R)-Oxolan-2-yl]acetic | 2- | 3-Chloro-2,2-dimethyl-3- | (2S)-2- |
| acid | [Ethyl(methyl)phosphanyl]acetic | oxopropanoic acid | Methoxycarbonylcyclopropane- |
| | acid | | 1-carboxylic acid |
| 2-[(2S)-Oxolan-2-yl]acetic | [3-(2-Methylprop-2- | Nitrosulfone | 2,5-Dimethyl-4H-1,3- |
| acid | enyl)dioxiran-3-yl] hydrogen | | oxazole-5-carboxylic acid |
| | carbonate | | |
| 2-Methylfumarate | 2- | 3-Sulfanylidenebutanoic acid | 2H-1,4-Thiazine-2- |
| | [Methoxysulfinyl(methyl)amino] | | carboxylic acid |
| | propanoic acid | | |
| 3-Chloroacrylate | 4-Methoxyoxetane-2- | Phosphomethylphosphonic | 2-Propanoylcyclopropane- |
| | carboxylic acid | acid | 1-carboxylic acid |
| (Z)-3-Chloroprop-2-enoate | 3-Chloro-3-methyl-4- | 2-(5-Mercapto-5- | 2,3-Dimethylcyclobutane-1- |
| | oxobutanoic acid | tetrazolyl)acetic acid | carboxylic acid |
| (E)-4,4,4-Trifluorobut-2- | 4-Methoxy-2-oxobut-3-enoic | 4-Formylcyclopent-2-ene-1- | 2-Cyano-2- |
| enoate | acid | carboxylic acid | methylcyclopropane-1- |
| | | | carboxylic acid |
| Glycylcysteine | 3-Acetyloxybut-2-enoic acid | 2- | 2-Ethyl-3- |
| | | (Dimethylcarbamoyloxy)acetic | methylcyclopropane-1- |
| | | acid | carboxylic acid |
| (2R)-2-(Propan-2- | (2S)-2-Acetyloxy-3- | Dithiine-4-carboxylic acid | 4-Chloro-1,3-oxazole-2- |
| ylideneamino)oxypropanoic | chloropropanoic acid | | carboxylic acid |
| acid | | | |
| (R)-4,4,4-Trifluoro-2- | 2-(Propyldiazenyl)propanoic | (3-Propyldioxiran-3-yl) | 1-Chloropyrazole-4- |
| methylbutanoic acid | acid | hydrogen carbonate | carboxylic acid |
| 2-Furanpropanoic acid, | 2-(2-Fluorothiophen-3-yl)acetic | 2-(3-Chloropropoxy)acetic acid | 3,5-Dimethyl-2,4- |
| tetrahydro-, (2R)- | acid | | dihydropyrimidine-5- |
| | | | carboxylic acid |
| Acetyl acrylic acid | 3- | Acetic acid, fluorophosphono- | (6S)-2- |
| | [Ethyl(formyl)amino]propanoic | | Thiabicyclo[3.1.0]hex-3- |
| | acid | | ene-6-carboxylic acid |
| 4-Oxobutanoate | 1-(2- | 4-Hydroxybutyl hydrogen | (6S)-4- |
| | Aminoacetyl)oxycyclopropane- | carbonate | Oxobicyclo[3.1.0]hex-2- |
| | 1-carboxylic acid | | ene-6-carboxylic acid |
| N-Carboxyglycine | 4-Diazo-3-oxobutanoic acid | 2-Aminooxyprop-2-enoic acid | (6S)-4-Oxo-2- |
| | | | thiabicyclo[3.1.0]hexane-6- |
| | | | carboxylic acid |
| 1H-Pyrrole-2-carboxylic | [(1S)-1-Carboxyethyl]- | 5-Chloro-2,2-dimethyl-4- | (4S,6S)-4-Hydroxy-2- |
| acid, 4,5-dihydro-5-oxo- | trimethylazanium | oxopentanoic acid | thiabicyclo[3.1.0]hexane-6- |
| | | | carboxylic acid |
| 3-Fluoro-cis,cis-muconate | 4-Ethoxypent-2-enoic acid | 2-Methyl-2-fluoromalonic acid | 2,5-Dihydrothiazepine-4- |
| | | | carboxylic acid |
| 5-Oxopentanoate | 3-Formamidobutanoic acid | 3-Methyl-4-oxopentanoate | (2-Methylfuran-3-yl) |
| | | | hydrogen carbonate |
| (1S,2S)-2- | 2-[Fluoro(methyl)amino]-2- | 7-Oxa-3- | Oxolan-3-ylmethyl |
| Fluorocyclopropanecarboxylic | methylpropanoic acid | azabicyclo[4.1.0]heptane-4- | hydrogen carbonate |
| acid | | carboxylic acid | |
| 2-[(2S)-Oxiran-2-yl]acetic | (4E)-5-Bromopent-4-enoic acid | 2-Ethoxyethyl hydrogen | 3-(3-Methyloxetan-3- |
| acid | | carbonate | yl)propanoic acid |
| 1- | 3-Nitrobut-2-enoic acid | 4-Cyclopropylbutanoic acid | (1R,5S)-3- |
| (Mercaptomethyl)cyclopro- | | | Oxabicyclo[3.1.0]hexane-2- |
| paneacetic Acid | | | carboxylic acid |
| 3-Nitrooxybut-3-enoic acid | 2-[(5S)-3,4-Dimethyl-4,5- | 3-Isocyanatopropanoic acid | (3R,5S)-5-Hydroxyoxane-3- |
| | dihydro-1,2-oxazol-5-yl]acetic | | carboxylic acid |
| | acid | | |
| (S)-Chlorosuccinic acid | 2-Cyclopropylethyl hydrogen | 4-Isocyanatobutanoic acid | cis-5- |
| | carbonate | | Hydroxytetrahydropyran-3- |
| | | | carboxylic acid |
| 3-Chloro-5-isoxazoleacetic | 2-Acetyloxy-2-chloroacetic | 3-Methyl-2-oxopyrimidine-4- | 5-Oxooxane-3-carboxylic |
| acid | acid | carboxylic acid | acid |
| 4-(Bromoamino)-4- | 4-Iodobut-2-enoic acid | (Z)-2-Fluoropent-2-enoic acid | (5-Chloro-2H-triazol-4-yl) |
| oxobutanoic acid | | | dihydrogen phosphate |
| Peroxydicarbonic acid | 5-Sulfanylidenepent-2-enoic | 4,4-Difluoro-2- | 1-Oxo-1lambda~4~-thiane- |
| | acid | methylidenebutanoic acid | 4-carboxylic acid |
| Ethenyl hydrogen carbonate | 1,4-Dioxaspiro[2.2]pentane-2- | 1-Chloroethyl hydrogen | 1-Prop-2- |
| | carboxylic acid | carbonate | enoylcyclopropane-1- |
| | | | carboxylic acid |
| 4-Dimethylsulfoniobutanoate | (1R,2R)-2-Acetylcyclopropane- | 2-Nitroprop-2-enoic acid | (1-Methylcyclopropyl) |
| | 1-carboxylic acid | | hydrogen carbonate |
| 4-(Dimethylsulfonio)butyric | 3-Prop-2-enoxyprop-2-enoic | 3-Bromo-2H-pyridine-3- | 2-(1-Methylcyclohexa-2,4- |
| acid anion | acid | carboxylic acid | dien-1-yl)acetic acid |
| 2-Dimethylsulfonio-2- | Phosphorososulfanylformic | Sodium; 4-hydroxy-but-2- | 2-(2- |
| methylpropanoate | acid | enoate | Bicyclo[2.1.1]hexanyl)acetic |
| | | | acid |
| 2-Methoxy-2- | 3-Fluoro-2-methyl propanoic | 3,3-Difluoro-2,2- | 1,3-Dioxepine-5-carboxylic |
| methylpropanoic acid | acid | dimethylbutanoic acid | acid |
| Propanoic acid, 3- | (2S)-2-(But-2- | 3-Chloro-2-methylbutanoic acid | 2,5-Dihydrooxazepine-4- |
| (nitrosothio)- | enoylamino)propanoic acid | | carboxylic acid |
| 3-Formyloxy-3- | 2-(Cyanomethylidene)butanoic | 3-Chloro-2,2-dimethyl butanoic | 4,5-Dihydrooxazepine-4- |
| methylbutanoic acid | acid | acid | carboxylic acid |
| (3,3-Difluoro-2- | 4-Nitrosobutanoic acid | 2-Ethenoxyacetic acid | (4-Methyl-1,3-thiazol-5-yl) |
| hydroxypropyl) dihydrogen | | | hydrogen carbonate |
| phosphate | | | |
| 2-Methylidene-4- | But-2-enyl hydrogen carbonate | Thiophen-2-yl hydrogen | 2,5-Dimethyl-2H-pyrrole-3- |
| oxobutanoic acid | | carbonate | carboxylic acid |
| 2-(Oxiran-2-yl)acetic Acid | (Methoxycarbonylamino)methane- | (3-Methylthiophen-2-yl) | Oxathiinecarboxylic |
| | sulfonic acid | hydrogen carbonate | |
| 4-Cyano-3-hydroxybutanoic | 3-Methoxybutyl hydrogen | 2-Phosphanyloxypropanoic | 1- |
| acid | carbonate | acid | (Difluoromethyl)cyclopro- |
| | | | panecarboxylic |
| | | | acid |
| 3-Methyloxirane-2-sulfonic | 2-Oxo-1,3-dioxolane-4- | 2-Phosphanyloxyacetic acid | (2S)-5-Methoxy-3,4- |
| acid | carboxylic acid | | dihydro-2H-pyrrole-2- |
| | | | carboxylic acid |
| 5-Oxo-3,4-dihydropyrrole-2- | 2-[Fluoro(methyl)amino]acetic | 3-Phosphanyloxybutanoic acid | trans-2- |
| carboxylic acid | acid | | Cyanocyclopropane-1- |
| | | | carboxylic acid |
| 3-Mercaptobutanoic acid | 2-Fluoro-4,4-dimethylpent-2- | 3-Phosphanyloxypropanoic | 2-(3,4-Dihydropyridin-5- |
| | enoic acid | acid | yl)acetic acid |
| (3-Carboxy-3-oxopropyl)- | Carboxy propyl carbonate | 4,4,4-Trifluoro-2- | [(2R)-Oxolan-2-yl] hydrogen |
| methyl-oxophosphanium | | methylidenebutanoic acid | carbonate |
| 3-Fluoro-2-oxobutanoic acid | 2,2,3-Trichlorobut-3-enoic acid | 2-Chloro-2- | 2-(5-Oxo-1,3-dioxolan-4- |
| | | sulfanyloxypropanoic acid | ylidene)acetic acid |
| 5-Amino-4- | 2-Methylsulfanylethyl | (E)-4-Chloro-2-methylpent-2- | 6-Bicyclo[3.1.0]hexanyl |
| oxo(113C)pentanoic acid | hydrogen carbonate | enoic acid | hydrogen carbonate |
| (1R,2R)-2- | 2-Cyclopropyl-2- | 5,6,6-Trifluorohexanoic acid | 3,4-Dihydro-2H-pyran-6-yl |
| Fluorocyclopropanecarboxylic | methylpropanoic acid | | hydrogen carbonate |
| acid | | | |
| (S)-2- | Propan-2-ylsulfanylformic acid | 2-(2,2- | 2-Oxidooxadiazol-2-ium-4- |
| (Methoxycarbonylamino)butanoic | | Dichloroethenyl)cyclopropane- | carboxylic acid |
| acid | | 1-carboxylic acid | |
| 2-(Dithiolan-4-yl)acetic acid | 6-Hydroxyhex-2-enoic acid | 2-Isocyanopropanoic acid | 2-(3-Methylpyrazol-3- |
| | | | yl)acetic acid |
| beta-Methoxyacrylic acid | 5-Chloropent-3-enoic acid | (3-Methyloxiran-2-yl)methyl | 1-Oxo-3,6-dihydro-2H-1,4- |
| | | dihydrogen phosphate | thiazine-5-carboxylic acid |
| (3R)-3-Hydroxy-4-[(2S)- | 5-Cyanopenta-2,4-dienoic acid | 3-Fluorobut-3-enoic acid | 1,2-Difluorocyclobutane-1- |
| oxiran-2-yl]butanoic acid | | | carboxylic acid |
| (R)-Tetrahydro-2H- | 2,5-Dimethyl-1,3-dioxane-5- | 1,2-Dioxine-3-carboxylic acid | 2-(Oxetan-3-ylmethyl)prop- |
| thiopyran-3-carboxylic acid | carboxylic acid | | 2-enoic acid |
| 2-(Carbamoylamino)-3- | 3-(Chloromethyl)pentanoic | 3-(Dimethylphosphinyl)-2- | 2-Methyl-3-(oxetan-3- |
| sulfanylpropanoic acid | acid | methylpropionic acid | yl)prop-2-enoic acid |
| 4,4,4-Trifluoro-2,2- | (2,2-Dichloro-1- | 5-Methyl-1,3,4-oxadiazole-2- | 6-Methyloxazinane-3- |
| dimethylbutanoic acid | methylcyclopropyl) hydrogen | carboxylic acid | carboxylic acid |
| | carbonate | | |
| 5-Hydroxy-4-oxopentanoic | 4-Aminooxybut-2-enoic acid | Malonamate | 2-(Oxetan-2-yl)prop-2-enoic |
| acid | | | acid |
| 4- | Cyclobutyl hydrogen | 2-(4,5-Dihydrotriazol-1-yl)acetic | 3-(Oxetan-2-yl)prop-2-enoic |
| [Hydroxy(methyl)phos- | carbonate | acid | acid |
| phoryl] butanoic | | | |
| acid | | | |
| trans-2- | 2-[Chloro(difluoro)methyl]prop- | 4-Isocyano-2- | (1S)-1,2,2- |
| Fluorocyclopropane- | 2-enoic acid | methylidenebutanoate | Trimethylcyclopropane-1- |
| carboxylic | | | carboxylic acid |
| acid | | | |
| 4-(Hydroxyamino)butanoic | 2-Fluoro-3-methylbut-2- | 4-Isocyano-2- | (2E)-2-(2- |
| Acid | enedioic acid | methylidenebutanoic acid | Oxocyclopentylidene)acetic |
| | | | acid |
| 2,2-Difluoro-2- | Cyclopropylmethyl hydrogen | 3-Hydroperoxy-3-oxopropanoic | (E)-2-(2- |
| methoxyacetic acid | carbonate | acid | Oxocyclopentylidene)acetic |
| | | | acid |
| 2-Hydroxy-4-oxopentanoic | 2,5-Dihydropyridine-3- | 2-(Propan-2-ylamino)oxyacetic | 1-[(1R)-1- |
| acid | carboxylic acid | acid | Hydroxypropyl]cyclopropane- |
| | | | 1-carboxylic acid |
| N-Hydroxy-5- | Hexa-2,5-dienoic acid | 3-Carbamoylbut-3-enoic acid | (2S)-2-Fluoro-3- |
| aminopentanoic acid | | | oxopiperidine-1-carboxylic |
| | | | acid |
| 5-Cyano-4-oxopentanoic | N-(2,3-Dioxopropyl)acetamide | Penta-2,3,4-trienoic acid | 2-Azabicyclo[3.1.0]hexa- |
| acid | | | 1,3,5-triene-4-carboxylic |
| | | | acid |
| 2- | 4-Cyano-2- | 4-Chloro-3-methoxybutanoic | (3-Chlorothiophen-2-yl) |
| Fluorocyclopropanecarboxylic | methylidenepentanoic acid | acid | hydrogen carbonate |
| acid | | | |
| 3-(Hydroxyamino)propanoic | 2-Butenoic acid, 4-amino-2,3- | 3-(Chloromethyl)cyclopentane- | 2-Oxooxane-4-carboxylic |
| Acid | dichloro-4-oxo-, (Z)- | 1-carboxylic acid | acid |
| 4,5-Dihydro-4- | 3-(3- | Carboxy formate | 1,3-Oxazepine-2-carboxylic |
| thiazolecarboxylic acid | Oxopropylsulfanyl)propanoic | | acid |
| | acid | | |
| Difluoromalonic acid | Carboxy 2-hydroxypropanoate | 1,1,2-Trichloroethyl hydrogen | 2-Oxo-3H-furan-5- |
| | | carbonate | carboxylic acid |
| 4-Carboxyperoxybutyric acid | Ethyl 2-carboxyoxyacetate | 3,3,4,4-Tetrachlorobutanoic | (4S)-4- |
| | | acid | Hydroxycyclopentene-1- |
| | | | carboxylic acid |
| 2-Propenoic acid, 3,3- | 1,3-Dimethylcyclobutane-1- | 2-Sulfamoylpropanoic acid | 4-Hydroxycyclopentene-1- |
| difluoro-2-(trifluoromethyl)- | carboxylic acid | | carboxylic acid |
| (2S)-2-(2,3-Dioxoaziridin-1- | 2-Hydroxy-1,3-oxazole-5- | 2-Ethyl-2-methyl-3-oxobutanoic | (5-Chloro-1-methylpyrazol- |
| yl)propanoic acid | carboxylic acid | acid | 4-yl) hydrogen carbonate |
| (2Z)-3-Cyclopropyl-2- | 3,3-Difluoro-2-oxopropanoic | Carboxy ethaneperoxoate | Phosphinane-4-carboxylic |
| propenoic acid | acid | | acid |
| (S)-2-Amino-4-cyanobutyric | 3-Methylidenecyclohexa-1,5- | 2-(Dioxolan-3-yl)acetic acid | 4,5-Difluoronicotinic acid |
| acid | diene-1-carboxylic acid | | |
| (1s,2r)-2-Chloro-2- | 4-Hydroperoxy-4-oxobut-2- | 3-Butenoic acid, 3- | 2-(4-Methyl-1,2-oxazol-3- |
| fluorocyclopropanecarboxylic | enoic acid | (trifluoromethyl)- | yl)acetic acid |
| acid | | | |
| 4-(Chloroamino)-4- | 2-Methyl-5-oxohex-2-enoic | Methyl 2,2-difluorosuccinate | (1R)-1-Chloro-2,2- |
| oxobutanoic acid | acid | | dimethylcyclopropane-1- |
| | | | carboxylic acid |
| (3S)-3-Chloro-4-methoxy-4- | 3H-Azepine-6-carboxylic acid | 2-Acetamido-3-chloropropanoic | 2-Cyanoethenyl hydrogen |
| oxobutanoic acid | | acid | carbonate |
| (RS)- | 5-Hydroxypent-3-enoic acid | 4-Methyl-3-oxopent-4-ene-1- | (5R)-3- |
| (Methylenecyclopropyl)acetic | | sulfonic acid | Oxabicyclo[3.1.0]hexane-6- |
| acid | | | carboxylic acid |
| 5-Amino-4-hydroxy-valeric | Carboxyethylphosphoramide | 3-Methyl-5-oxopentanoic acid | 2-(2,3-Dihydropyridin-2- |
| acid | | | yl)acetic acid |
| 3-Carbamoyl-2- | Carboxyoxy ethyl carbonate | 4-Chloro-2,2-dimethyl-3- | 5-Hydroxyfuran-3- |
| methylpropanoic acid | | oxobutanoic acid | carboxylic acid |
| 2-Oxobicyclo[3.1.0]hexane- | 3-Methyliminobutanoic acid | 2-Methylpyran-2-carboxylic | 4-Methoxyfuran-3- |
| 6-carboxylic acid | | acid | carboxylic acid |
| 4-(Dichloroamino)butanoic | 2-(2,2- | 3,3-Difluoro-2,2- | [(2R)-5-Oxooxolan-2-yl] |
| acid | Difluoroethenyl)cyclopropane- | dimethylpropanoic acid | hydrogen carbonate |
| | 1-carboxylic acid | | |
| (R)-4-Cyano-3- | 3-Aminooxy-3-oxopropanoic | 2-Formyloxybutanoic acid | Carbonic acid 2,4- |
| hydroxybutyric acid | acid | | cyclohexadienyl ester |
| 3-Chloropentanoic Acid | 2-Amino-3-methoxy-2-methyl- | 2-(Trichloromethyl)prop-2-enoic | 2,5-Dihydrofuran-2-yl |
| | 3-oxopropanoic acid | acid | hydrogen carbonate |
| 5,6-Dihydro-2H-thiopyran-3- | Carboxy(sulfanyl)carbamic | 4-Methyl-5-oxooxolane-2- | 2-Oxo-1,3-dioxane-5- |
| carboxylic Acid | acid | carboxylic acid | carboxylic acid |
| Succinic acid-1,4-13C2 | 2,2-Dichloro-3-(oxiran-2- | 4-Methyl-5-oxo-pyrrolidine-2- | (1S,2S)-1,2- |
| | yl)propanoic acid | carboxylic acid | Difluorocyclobutane-1- |
| | | | carboxylic acid |
| 2-(2,3-Dioxoaziridin-1- | 2-Acetyloxyiminoacetic acid | (E)-5-Methoxypent-2-enoic acid | (4-Chlorothiophen-2-yl) |
| yl)acetic acid | | | hydrogen carbonate |
| (E)-3-(Diethylamino)prop-2- | 3-Bromo-2- | 3-Disulfanylpropanoic Acid | (1R)-1,2- |
| enoic acid | methoxyiminopropanoic acid | | Dimethylcyclopropane-1- |
| | | | carboxylic acid |
| (1S,6S)-7- | 2-Oxo-3- | 1- | (1S)-1,2- |
| Oxabicyclo[4.1.0]heptane-3- | cyclopropanepropionic acid | Carboxyethyl(diethyl)sulfanium | Dimethylcyclopropane-1- |
| carboxylic acid | | | carboxylic acid |
| 2-(Glycyloxy)acetic acid | N-Methyl-1-nitropropan-2- | Acetaldehydbisulfit | 2-(2-Methyl-4,5-dihydro-1,3- |
| | imine | | thiazol-5-yl)acetic acid |
| 3-Hydroxy-4-oxopentanoic | 3-Methyl-1,2-dioxobut-3-ene- | 2-(2-Hydroxyethoxy)propanoic | 4H-1,3,2,4-Dioxadiazine-6- |
| acid | 1-sulfonic acid | acid | carboxylic acid |
| Benzoic acid-4-13C | (1-Chloro-2-methylpropan-2-yl) | 3-Methyl-4-oxobutanoic acid | 7H-1,4-Oxazepine-4- |
| | hydrogen carbonate | | carboxylic acid |
| 3,3-Dimethoxypropanoic | 3-(Carboxyamino)-3- | 2-Iodothiazole-5-carboxylic | Cyclopent-2-en-1-yl |
| Acid | fluoropropanoic acid | acid | hydrogen carbonate |
| (1S,6R)-7- | 5-Chloropent-2-enoic acid | 2-Fluorothiazole-5-carboxylic | (2Z)-2- |
| Oxabicyclo[4.1.0]heptane-3- | | acid | Propylidenecyclopropane-1- |
| carboxylic acid | | | carboxylic acid |
| 3-Hydroxy-4-oxobutanoic | 2-Thiothenoic acid | 2-Fluoro-4-methyl-1,3-thiazole- | 2-Chloro-2- |
| acid | | 5-carboxylic acid | (chloromethyl)cyclopropane- |
| | | | 1-carboxylic acid |
| 3- | 3-(Methanesulfonyl)prop-2- | 3-(Aziridin-1-yl)butanoic acid | 3-Methyl-4-oxofuran-2- |
| Methylbicyclo[1.1.1]pentane- | enoic acid | | carboxylic acid |
| 1-carboxylic acid | | | |
| (E)-4-Hydroxy-2-hexenoic | 3-Formyloxy-2,2- | 2-[Ethyl(methyl)amino]-2- | Oxazepine-5-carboxylic |
| acid | dimethylpropanoic acid | oxoacetic acid | acid |
| 4-Methoxy-2- | Acetyl(ethyl)carbamodithioic | 2-(2H-Pyran-5-yl)acetic acid | 1,3-Oxazepine-5-carboxylic |
| methylidenebutanoic acid | acid | | acid |
| 1,2,2,3,3,4,4,5,5,6,6- | (Carboxydisulfanyl)formic acid | 2,2-Dichloro-3- | 2,3,4,5-Tetrahydrooxepine- |
| Undecadeuteriocyclohexane- | | methylcyclopropane-1- | 6-carboxylic acid |
| 1-carboxylic acid | | carboxylic acid | |
| 3- | (1S,3R)-2,2-Dichloro-3- | 2-Methylidene-5-oxopentanoic | (2,5-Dimethylfuran-3-yl) |
| Chlorobicyclo[1.1.1]pentane- | methylcyclopropane-1- | acid | hydrogen carbonate |
| 1-carboxylic Acid | carboxylic acid | | |
| 2-Ethyl-4,4,4- | 4-Chlorohex-2-enoic acid | 3-Oxocyclohexanecarboxylate | 6H-1,3-Oxazine-4- |
| trifluorobutanoic acid | | | carboxylic acid |
| 3-Hydroxybut-3-enoic Acid | 3-Butenoic acid, 4-methoxy- | 3,3-Difluoro-2- | Cyclopent-3-en-1-yl |
| | | methylidenebutanoic acid | hydrogen carbonate |
| 5-Amino-4- | 2-(1,5-Dihydrotriazol-2- | 3,4-Difluoro-2- | 1,3-Dioxolan-2-yl hydrogen |
| (18O)oxidanylidene(113C)p | yl)acetic acid | methylidenebutanoic acid | carbonate |
| entan(18O2)oic acid | | | |
| 1- | (3S)-3-Methylcyclopentane-1- | 3,3-Dichloro-2- | (2-Methyloxolan-2-yl) |
| Methylbicyclo[3.1.0]hexane- | carboxylic acid | methylidenebutanoic acid | hydrogen carbonate |
| 6-carboxylic Acid | | | |
| 2-Ethenoxyprop-2-enoic | 3-Deuterio-2,3-difluoroprop-2- | 3,4-Dichloro-2- | (5-Methylfuran-3-yl) |
| acid | enoic acid | methylidenebutanoic acid | hydrogen carbonate |
| 3,3-Difluorohexanoic Acid | 2,3-Difluoroprop-2-enoic acid | 4-Aminooxy-3-chlorobutanoic | 3-Chloroazete-2-carboxylic |
| | | acid | acid |
| 2-Methyl-2-butenedioic acid | 2-Nitrosocyclopropane-1- | 1- | (E)-3-(1- |
| 4-ethylester | carboxylic acid | Ethenoxycarbonylcyclopropane- | Chlorocyclopropyl)prop-2- |
| | | 1-carboxylic acid | enoic acid |
| (1-Nitroazetidin-3-yl) acetate | 3-Acetyloxy-2-oxopropanoic | 2,2,3-Trifluoro-3- | (1R,5R,6R)-6-Fluoro-2- |
| | acid | hydroxypropanoic acid | oxobicyclo[3.1.0]hexane-6- |
| | | | carboxylic acid |
| Phosphonic acid 2- | Monothioglycine | Citraconamic | (1R,5S,6S)-4- |
| hydroxyethyl ester | | | Oxobicyclo[3.1.0]hex-2- |
| | | | ene-6-carboxylic acid |
| 5-Amino-4- | 6-Oxohex-2-enoic acid | 2-Phosphanylbutanedioic acid | (1R,3S)-3- |
| oxo(413C)pentanoic acid | | | Methylcyclopentane-1- |
| | | | carboxylic acid |
| 2,6-Difluoronicotinic acid | (3-Methyldioxetan-3-yl) | 2-(2-Methylaziridin-1- | 2-(2- |
| | hydrogen carbonate | yl)propanoic acid | Cyanocyclopropyl)acetic |
| | | | acid |
| 5-Amino-4-oxo(2,3- | 4-Methoxy-2,3-dimethyl-4- | 3-Methyl-4-oxohexanoic acid | 4,5-Dihydro-1,3-thiazol-4-yl |
| 13C2)pentanoic acid | oxobut-2-enoic acid | | hydrogen carbonate |
| 2- | (2R)-1,3-Oxathiolane-2- | 4-Sulfanylbutyl hydrogen | 2-(Oxetan-2-yl)acetic acid |
| [[Amino(methyl)carba- | carboxylic acid | carbonate | |
| mothioyl]amino]acetic | | | |
| acid | | | |
| 2,2-Dideuteriopent-4-enoic | 2-Phosphanylidenebutanoic | 4-Oxobutane-1-sulfonic acid | 2-(1 -Chlorocyclohexa-2,4- |
| acid | acid | | dien-1 -yl)acetic acid |
| (1R,5S)- | 2-Bromo-4-oxopentanoic acid | Carboxy sulfite | (4-Methyl-1,3-oxazol-5-yl) |
| Bicyclo[3.1.0]hexane-6- | | | hydrogen carbonate |
| carboxylic acid | | | |
| (3S)-3-Bromo-3- | 3-Methoxypent-2-enoic acid | 2-(Bromomethyl)cyclopropane- | 2-[(1S)-2- |
| carboxypropionic acid | | 1-carboxylic acid | Ethylcyclopropyllacetic acid |
| methyl ester | | | |
| 2-(3-Methyl-4,5-dihydro-1,2- | 2-Butenoic acid, 3,4,4-trifluoro- | 4-Iminopentanoic acid | 3-(3,4-Dihydropyrazol-2- |
| oxazol-5-yl)acetic Acid | | | yl)propanoic acid |
| 2- | (2S)-2- | 2-Bromoethyl hydrogen | 2H-Triazol-4-yl hydrogen |
| (Phosphorosoamino)acetic | (Dichloroamino)propanoic acid | carbonate | carbonate |
| acid | | | |
| 2,2-Difluorohexanoic Acid | 2H-1,4-Thiazine-6-carboxylic | 4-Aminooxy-4-oxobutanoic acid | 3-(1- |
| | acid | | Hydroxycyclopropyl)propanoic |
| | | | acid |
| 3-Thiopheneacetic acid, 2- | 4-Chloro-3-methylbut-2-enoic | 3,4-Dimethylthiophene-2- | (2S)-5-Methylideneoxolane- |
| chloro- | acid | carboxylic acid | 2-carboxylic acid |
| 2,2-Difluoro-3-hydroxy-3- | Acetic acid, (methoxyimino)- | 3-Thionitrosopropanoic acid | 3- |
| methylbutanoic acid | | | Methanehydrazonoylsulfanylprop- |
| | | | 2-enoic acid |
| 3-Methylbutyric-2,2-d2 acid | 5-Methyl-4-oxohexa-2,5- | 3-Cyclopropyloxirane-2- | (6-Methylpyridin-3-yl) |
| | dienoic acid | carboxylic acid | hydrogen carbonate |
| (3R)-3-Hydroxypent-4-enoic | 2-Chloro-3-cyanoprop-2-enoic | 2-Carboxyoxy-2,2- | 5-Methylidene-2H-furan-3- |
| acid | acid | difluoroacetic acid | carboxylic acid |
| 3-Nitroacrylic acid methyl | Mercaptoproline | 2-(Triazin-4-yl)acetic acid | 2-Methylidene-3H-furan-4- |
| ester | | | carboxylic acid |
| (1R,4R)-Bicyclo[2.2.1]hept- | 4-Fluoro-2,2-dimethylbut-3- | [Carboxy(fluoro)methyl]- | 6-Thiabicyclo[3.2.1]octa- |
| 5-ene-2-carboxylic acid | enoic acid | trimethylazanium | 1(8),2,4-triene-7-carboxylic |
| | | | acid |
| (1S,4R)-4- | 2-Ethenylbut-2-enedioic acid | 2-Methyl-2-nitrosopropanoic | 4,5-Dimethyl-2- |
| Methoxycarbonylcyclobut-2- | | acid | protiothiophene-3- |
| ene-1-carboxylic acid | | | carboxylic acid |
| 2-(1,2-Dithiolan-3-YL)acetic | 2,2,3-Trifluorobutanoic acid | 4-Hydroxy-3-methyl pentanoic | (1S)-2- |
| acid | | acid | Ethenylcyclopropane-1- |
| | | | carboxylic acid |
| 3-Formylpentanoic acid | 4-Aminooxy-3-methyl-4- | 1,3-Dithietane-2-carboxylic acid | 3-Methyl-2,3-dihydrofuran- |
| | oxobut-2-enoic acid | | 2-carboxylic acid |
| (1S)-4-Methyl-cyclohex-3- | 4-Chlorobutyl hydrogen | 2-(Isothiazol-3-YL)acetic acid | (1S)-2-Ethylcyclopropane- |
| enecarboxylic acid | carbonate | | 1-carboxylic acid |
| 1-Nitro-3,3-dimethoxy-1- | 4-Methylperoxy-4-oxobut-2- | 2-Bromo-succinamic acid | (2S)-2- |
| propene | enoic acid | | Ethenylcyclopropane-1- |
| | | | carboxylic acid |
| Mercaptomethyl-succinic | 2-(Disulfanyl)pyridine-4- | 2-Sulfinylacetic acid | 2-(2,3-Dihydrothiophen-3- |
| acid | carboxylic acid | | yl)acetic acid |
| 3,4,5-Trimethylthiophene-2- | 3-Methoxyprop-2-ynoic acid | 2-Sulfonylacetic acid | (3S)-2-Chloro-3-methyl-2,3- |
| carboxylic acid | | | dihydrothiophene-5- |
| | | | carboxylic acid |
| (18O2)Benzoic acid | 5-Bromopent-3-enoic acid | 2-(Dioxiran-3-yl)propan-2-yl | 2-(2,2,3- |
| | | hydrogen carbonate | Trimethylcyclopropyl)acetic |
| | | | acid |
| Butanedioic acid, 2-methyl-, | 6-Hydroxy-4-oxohexanoic acid | 3-(2-Sulfanylethoxy)propanoic | 6-Methylidenecyclohexa- |
| 1-methyl ester, (2R)- | | acid | 2,4-diene-1-carboxylic acid |
| 5-Sulfanylpentanoic Acid | 2-Hydrazinyloxy-2-oxoacetic | 5-Methoxy-1,2-oxazole-3- | Acetyloxymethylphosphonic |
| | acid | carboxylic acid | acid |
| 3,5-Dimethyl-4-oxo-4H- | 4-Methoxy-2-methylbut-2- | Ethylchloropropionate | 5-Fluoro-2-methyl pentanoic |
| pyran-2-carboxylic acid | enoic acid | | acid |
| 4-Bromo-3-chloro-3,4,4- | 6-Bromohex-2-enoic acid | (2E)-Bromohexenoic acid | 4-Cyclopropylidenebutanoic |
| trifluorobutanoic acid | | | acid |
| 2-(Oxiran-2-yl)ethyl nitrate | 2-(Disulfanyl)-4-nitropyridine | Cyclopropanecarboxylic acid, | Cyclohepten-1-yl hydrogen |
| | | 1-(acetylmethylamino)- | carbonate |
| 2-(2-Chloroethoxy)acetic | 4-Hydroperoxybut-2-enoic acid | Monomethyl (1RS,2RS)-1,2- | (1S,3R)-2,2,3- |
| Acid | | cyclopropanedicarboxylate | Trimethylcyclopropane-1- |
| | | | carboxylic acid |
| (2S,3R)-3- | 4-Oxocyclohexene-1- | 2,3-Dihydropyridine-3- | 1-[(Z)-1,2- |
| (Hydroxymethyl)oxirane-2- | carboxylic acid | carboxylic acid | Difluoroethenyl]cyclopropane- |
| carboxylic acid | | | 1-carboxylic acid |
| (S)-2-(Acetylthio)propanoic | (2S)-4-Ethoxy-2-methyl-4- | 4-Hydroxy-2-sulfanylbutanoic | 3-Propan-2-ylthiirene-2- |
| acid | oxobutanoic acid | acid | carboxylic acid |
| 3-(2-Methyl-1,3-dioxolan-2- | 3-Acetyloxy-2-methylprop-2- | [Hydroperoxy(hydroxy)phospho | 2-Cyano-3- |
| yl)propanoic Acid | enoic acid | ryl]formic acid | cyclopropylacrylic acid |
| 3-(2- | 2-Nitrosopropanoic acid | 1,2,2-Trimethylcyclopropane-1- | 2-(3-Fluorothiophen-2- |
| Sulfanylethylsulfanyl)propanoic | | carboxylic acid | yl)acetic acid |
| acid | | | |
| 3-Cyano-2-methyl propanoic | Butanoic acid, 4-amino-3,3- | 3-(Trifluoromethyl)oxirane-2- | [(2S)-2-Methyloxolan-2-yl] |
| acid | dimethyl-4-oxo- | carboxylic acid | hydrogen carbonate |
| (E)-1-Ethoxy-2-nitroethene | 3-[Deuteriomethyl-methyl- | 2-Methylsulfonylprop-2-enoic | [(2R)-2-Methyloxolan-2-yl] |
| | (trideuteriomethyl)silyl]propanoic | acid | hydrogen carbonate |
| | acid | | |
| CID 10942411 | Deuterio 3- | 2-(Acetyloxyamino)-2-oxoacetic | (2,5-Dichlorothiophen-3-yl) |
| | trimethylsilylpropanoate | acid | hydrogen carbonate |
| (S)-2-Methyl-4-oxovaleric | 2-[(2R)-Oxiran-2-yl]propanoic | [Hydroxy(hydroxy- | 1-Chlorocyclopent-3-ene-1- |
| acid | acid | phosphanyl)phosphanyl]formic | carboxylic acid |
| | | acid | |
| 2-Cyclohexa-2,4-dien-1- | Isothiocyanato(methylsulfinyl) | 3-Methoxybutanoate | (1S,3R)-3- |
| ylacetic acid | methane | | Methoxycyclopentane-1- |
| | | | carboxylic acid |
| 2-Propenoic acid, 2- | N-Methyl-1- | 2H-Pyran-4-carboxylic acid | N-Cyanomethylglycinate |
| (trimethylsilyl)- | methylsulfonylpropan-2-imine | | |
| Carbonic acid allyl ester | 3-Methyl-4-oxobut-2-enoic | [Tert-butyl(dimethyl)silyl]formic | 2-Bromo-3-fluoroisonicotinic |
| | acid | acid | acid |
| 4-Methyl-5-oxopentanoic | 4-Cyanobut-2-enoic acid | 2-Methyl-5-sulfanylpentanoic | 5-Bromo-2,2,5,5- |
| acid | | acid | tetradeuteriopentanoic acid |
| 2-[Acetyl(ethyl)amino]acetic | Amino carboxy carbonate | 2-(2,2- | 3,4,5-Trideuteriobenzoic |
| acid | | Dimethylpropanoyloxy)acetic | acid |
| | | acid | |
| 2-(3-Chloropropyl)propenoic | (2S)-2-Amino-3- | 2-(Dioxan-4-yl)acetic acid | 3-Hydroxy(1,2,3,4- |
| acid | formyloxypropanoic acid | | 13C4)butanoic acid |
| (E)-3-Fluoroprop-2-enoic | 3-Carbamoyl-3- | 1,3-Thiazol-5-yl hydrogen | 2-Acetamido-3,3,3- |
| acid | methylpropanoic acid | carbonate | trideuteriopropanoic acid |
| 5-Oxocyclohex-2-ene-1- | 3-Fluoro-4-methoxy-4-oxobut- | 2,2-Dichloro-3-oxobutanoic | Valeric acid-3,4,5-13C3 |
| carboxylic Acid | 2-enoic acid | acid | |
| 2-[(1 R,2S)-2- | 2-Cyclopropyliminopropanoic | 2-(1-Methylcyclopentyl)acetic | 2-Acetamido-2- |
| Hydroxycyclopentyl]acetic | acid | acid | deuteriopropanoic acid |
| acid | | | |
| Cyclohex-2-ene-1-carboxylic | Carboxy cyclopropene-1- | 4-Isocyanatopent-4-enoic acid | (1,2,3,4,5,6- |
| Acid | carboxylate | | 12C6)Cyclohexatriene- |
| | | | carboxylic acid |
| N-Acetyl-N-methylglycine | 3-(2- | 1,2-Dimethylpyridin-1-ium-3- | O-Toluic-D7 acid |
| | Chloroacetyl)oxypropanoic | carboxylate | |
| | acid | | |
| Cyclohepta-1,3,5-triene-1- | 3-Methoxybutane-1-sulfonic | 2-Formamidoethanesulfonic | Pentanedioic acid, 3-amino-, |
| carboxylic Acid | acid | acid | monomethyl ester |
| (1S,2R)-2- | 5-Oxopent-4-enoic acid | 1-Methoxypyrrole-3-carboxylic | 4-Pentenoic acid, 5-chloro-, |
| (Methoxycarbonyl)cyclo- | | acid | (E)- |
| propanecarboxylic acid | | | |
| (R)-2,2- | 5-Oxopent-3-enoic acid | Propan-2-yloxy hydrogen | S-[2-(Carboxyoxy)ethyl] |
| Dimethylcyclopropane- | | carbonate | ethanethioate |
| carboxylic acid | | | |
| (Z)-4-Hydroperoxy-4-oxobut- | (3S)-4-Chloro-3-(chloroamino)- | 2-[[(2R)-2- | 2-Propenoic acid, 2- |
| 2-enoic acid | 4-oxobutanoic acid | Azanylpropanoyl]amino]propanoic | phosphono-, 1-methyl ester |
| | | acid | |
| 3-Bromo-3-fluoropropanoic | 2-Chloro-4-oxobutanoic acid | (E)-5-Hydroxy-2-methylpent-2- | Butanal, 4-ethoxy-2-oxo- |
| acid | | enoic acid | |
| 6-Chloro-2-hexenoic acid | 2-(2-Hydroxycyclopropyl)prop- | 2-[(2- | Butanedioic acid, bromo-, |
| | 2-enoic acid | Methoxyethyl)sulfanyl]acetic | 4-methyl ester |
| | | acid | |
| 2-Propenoic acid, 2- | 2-Methyl-2- | (1-Fluoro-2- | Butanedioic acid, bromo-, |
| methoxy- | (114C)methyl propanedioic | oxopropyl)phosphonic acid | 1-methyl ester |
| | acid | | |
| 2-(1-Methylcyclopent-2-en- | (2S)-2- | 5,6-Dihydro-1,4-dithiin-2- | 2-Pentenoic acid, 2-fluoro- |
| 1-yl)acetic acid | (Methylsulfanylamino)propanoic | carboxylic acid | 4-methyl-, (E)- |
| | acid | | |
| 3-Butenoic acid, 2,3- | 2-Propenoic acid, 3- | 4-Bromo-4-oxobutanoic acid | 2-Butenoic acid, 3-hydroxy- |
| dimethyl- | (trimethylsilyl)-, (Z)- | | 4-oxo-, (Z)- |
| (R)-2-Fluorocaproic acid | 3,4-Dihydro-2H-pyrrole-3- | 4H-Pyran-3-carboxylic acid | Thiiranemethanesulfonic |
| | carboxylic acid | | acid |
| 2,3-Dichloro-2- | Lactoyllactic acid | Cyclohex-3-en-1-yl hydrogen | 2,4-Pentadienoic acid, 5- |
| fluoropropanoic acid | | carbonate | hydroxy-, (2E,4E)- |
| (S)-2-Amino-4-oxopentanoic | 3-Nitropropionamide | 3H-Dithiole-3-carboxylic acid | Ethenediazonium, 2- |
| acid | | | carboxy- |
| (Z)-2-Fluorohex-2-enoic acid | 1-(Dihydroxyamino)propan-2- | 2,3,4,5-Tetrahydropyridine-3- | 2,4-Pentadienoic acid, 5- |
| | one | carboxylic acid | iodo-, (Z,E)- |
| (S)-2-Fluoropropanoic acid | 4,5,6,7-Tetrahydro-3H- | 2-(1-Sulfanylcyclopentyl)acetic | 2-Chloro-3-iodopropanoic |
| | diazepine-3-carboxylic acid | acid | acid |
| (R)-4-Methylcyclohex-3- | 3-Isocyanatoprop-2-enoic acid | 2,2,2-Trifluoroethylphosphonic | [(Nitroperoxy)sulfonyl]methane |
| enecarboxylic acid | | acid | |
| 2,2-Difluoro-4-iodobutanoic | 4-Hydroperoxy-2-methyl-4- | 2-Methylidene-5,6- | 3-(Ethanesulfinyl)but-2- |
| acid | oxobut-2-enoic acid | dioxohexanoic acid | enoic acid |
| Cyclopropylmethanesulfonic | 4-Methoxy-2-methylpentanoic | 2-Isocyanatoprop-2-enoic acid | 3-Sulfanylprop-2-enoic acid |
| acid | acid | | |
| 2-Hydroxybutyl hydrogen | 4-Methylidene-5-oxooxolane- | 2-Nitroso-3-oxobutanoic acid | (3- |
| carbonate | 2-carboxylic acid | | Methoxybutyl)phosphonic |
| | | | acid |
| (2-Hydroxy-2-methylpropyl) | 4-Methoxy-3-methylbut-2- | (Z)-2-Fluorobut-2-enedioate | 5-Nitrilo-D-norvaline |
| hydrogen carbonate | enoic acid | | |
| 4-Oxobutylphosphonic acid | 3-Formyloxyprop-2-enoic acid | 2-Aminooxy-2-methyl pentanoic | 3-(Nitrosooxy)butanoic acid |
| | | acid | |
| 1-Hydroxy-2- | 3-Nitrosobutanoic acid | Oxalurate | 3,4-Dimethylpenta-2,4- |
| [methyl(sulfinato)amino]-1- | | | dienoic acid |
| oxoethane | | | |
| 2-Amino-3- | Carboxymethoxy(tri- | 2-(Ethylsulfanyl)-2-fluoroacetic | 3-Hydroperoxy-3- |
| formyloxypropanoic acid | hydroxy)phosphanium | acid | methylbutanoic acid |
| Acetyl(methyl)carbamic acid | 2-(Oxolan-3-yl)propanoic acid | (E)-2,3,4,4-Tetrachlorobut-2- | 3,3-Dichloroprop-1-ene-1- |
| | | enoic acid | sulfonic acid |
| alpha,beta,beta-Trichloro- | 4-Fluoro-2,2-dimethylbutanoic | 1-Bromo-2,2- | 3-(Hydroxyimino)propanoic |
| isobutyric acid | acid | dichlorocyclopropane-1- | acid |
| | | carboxylic acid | |
| 2-(2- | 2-Bromo-5-chloropentanoic | 2,3-Dichlorocyclopropane-1- | 4-(Hydroxysulfanyl)butanoic |
| Iodoethyl)cyclopropane-1- | acid | carboxylic acid | acid |
| carboxylic acid | | | |
| 2-(2- | 2-[1- | 3-Isothiocyanatopropanoic | (2-Hydroxyoxiran-2- |
| Chloroethyl)cyclopropane-1- | (Trifluoromethyl)cyclo- | acid | yl)acetic acid |
| carboxylic acid | propyl]acetic acid | | |
| (E)-2,3,4,4,4- | 4-Oxazolecarboxylic acid, 2- | 3-(2,2- | (2S)-2- |
| Pentachlorobut-2-enoic acid | formyl- | Dimethylhydrazinyl)propanoic | [Ethyl(nitroso)amino]propanoic |
| | | acid | acid |
| 4-Oxazoleacetic acid | 2-(1- | 2,5-Dimethyloxolane-3- | 2,4-Dihydroxypent-2-enoic |
| | Cyclopropylcyclopropyl)acetic | carboxylic acid | acid |
| | acid | | |
| 2,2-Difluorobut-3-enoic acid | 2-(Thietan-3-yl)acetic acid | 2-Isothiocyanatooxyacetic acid | [(1R)-Cyclohex-3-en-1- |
| | | | yllacetic acid |
| 4-Chloro-3-methyl-4- | 6-Methylbicyclo[3.1.0]hexane- | 4-Methoxy-4-oxo-3- | 3- |
| oxobutanoic acid | 3-carboxylic acid | sulfanylbutanoate | (Methoxycarbonyl)bi- |
| | | | cyclo[1.1.0]butane- |
| | | | 1-carboxylate |
| 2-(Cyclopropylmethyl)prop- | 4-Isocyanobutanoic acid | 4-Methoxy-4-oxo-3- | 4-Fluoro-3-methylpent-2- |
| 2-enoic acid | | sulfanylbutanoic acid | enoic acid |
| 2-(4-Oxothiolan-3-yl)acetic | 2-(5-Chloro-1,3-thiazol-4- | 3-Sulfonylpropanoic acid | 4-Methoxy-3-methyl-4- |
| acid | yl)acetic acid | | oxobut-2-enoate |
| 5-Isothiazoleacetic acid | 3-Isocyano-3-methylbutanoic | 3-Isocyanopropanoic acid | 3,4-Dimethylcyclopent-1- |
| | acid | | ene-1-carboxylic acid |
| 2-(Cyanomethoxy)acetic | 3-(1,2- | 3-(Acetyloxy)-2- | (2- |
| acid | Dimethylcyclopropyl)propanoic | methylpropanoic acid | Methoxyethoxy)(oxo)acetate |
| | acid | | |
| 4-Cyano-2- | 1- | 2-Pyrazol-1-yloxyacetic acid | Thiirane-2,3-dicarboxylic |
| methylidenebutanoic acid | (Fluoromethyl)cyclopropane- | | acid |
| | carboxylic acid | | |
| 2-Chlorobut-3-enoate | 2-Cyclopropyl-2-fluoroacetic | 2-(3-Methylcyclopent-2-en-1- | Hex-4-EN-2-ynoic acid |
| | acid | yl)acetic acid | |
| Nitro 2-oxopropanoate | 3-Cyclopropyl-2,2- | 2,2-Dichloro-2-methoxyacetic | 5-Methyl-1-oxo-2,3- |
| | difluoropropanoic acid | acid | dihydrothiophene-4- |
| | | | carboxylic acid |
| 2-Chloro-3- | 2-Cyclopropyl-2,2- | 4-Oxobut-2-ynoic acid | 1-Oxo-3,4-dihydro-2H- |
| methylidenebutanedioic acid | difluoroacetic acid | | thiopyran-5-carboxylic acid |
| 6-Oxabicyclo[3.1.1[heptane- | 4-Fluorovaleric acid | 1-Nitrosoazetidine-3-carboxylic | 6-Oxo-1,4,5,6- |
| 2-carboxylic acid | | acid | tetrahydropyrimidine-4- |
| | | | carboxylic acid |
| 2- | 2-(1- | 2,2-Dimethyl-3-(methylamino)- | 3-Sulfanylcyclopentane-1- |
| Iodocyclopropanecarboxylic | Methoxycyclopropyl)acetic | 3-oxopropanoic acid | carboxylic acid |
| acid | acid | | |
| 1- | 2-(2,3-Dihydrofuran-5-yl)acetic | Penta-3,4-dienoic acid | 2-Bromo-2- |
| Acetamidocyclopropane- | acid | | hydroxyiminoacetic acid |
| carboxylic acid | | | |
| 5-Chloro-hex-4-enoic acid | 2-Cyclopropyloxypropanoic | 1-Ethoxyethyl hydrogen | 4,5-Dioxohex-2-enoic acid |
| | acid | carbonate | |
| 2-Acetyloxy-2-aminoacetic | 4-Oxopentanoic acid | 2-Bromo 5-hydroxyvaleric acid | 1,2-Oxazinane-6-carboxylic |
| acid | | | acid |
| 2-Methylsulfonylethyl | Butanoic acid; 4-oxopentanoic | 2-(Oxiran-2-yl)ethylphosphonic | 2-Hydrazinylidenepropanoic |
| hydrogen carbonate | acid | acid | acid |
| 1-Chloro-2,3- | Calcium; 4-oxopentanoic | 4-Methylphosphanyl-2- | (1R)-2- |
| dioxocyclopropane-1- | acid; hydrate | oxobutanoic acid | (Trifluoromethyl)cyclopropane- |
| carboxylic acid | | | 1-carboxylic acid |
| 2,4-Dioxohex-5-enoic acid | Copper; 4-oxopentanoic acid | 3-Oxo-4-sulfanylbutanoic acid | 1-(Methyl-D3)-4-nitro-1H- |
| | | | pyrazole |
| 2,2-Difluoroglutaric acid 1- | (2S,3S)-2,4-Dichloro-3- | Oxirane-2-butanoic acid | 4-Oxo(3,4,5- |
| methyl ester | hydroxybutanoic acid | | 13C3)pentanoic acid |
| 3-(2- | Acetic acid; 4-oxopentanoic | 4-Hydroxy-5-chloropentanoic | 5-Hydroxyisoxazole-3- |
| Oxoethylsulfanyl)propanoic | acid | acid | carboxylic acid |
| acid | | | |
| 3-Ethenoxybutanoic acid | Acetic acid; 4-oxopentanoic | 2,2,4,4,4-Pentafluoro-3- | 5-Chloro-4-fluoronicotinic |
| | acid | oxobutanoic acid | acid |
| Furan-2-yl hydrogen | 4-Oxopentanoic acid; propan- | N-(Chlorocarbonyl)-N- | 2- |
| carbonate | 2-one | methylGlycine | Methylsulfanylcyclopropane- |
| | | | 1-carboxylic acid |
| 2,5-Dichloro-3,3- | 4-Oxopentanoic acid; hydrate | 2-Methylpropoxy hydrogen | 2,3-Dichloro-3- |
| dimethylpentanoic acid | | carbonate | methoxyprop-2-enoic acid |
| 4,4,4-Trichloro-2- | Methoxymethane; 4- | 2-Hydroxypropyl hydrogen | 2-Fluoro-5-hydroxypent-2- |
| oxobutanoic acid | oxopentanoic acid | sulfite | enoic acid |
| 4-Ethylsulfinylbutanoic acid | (1S,2S)-2- | 1-(2- | 2-Bromo-3-methyl-4- |
| | (Ethoxymethyl)cyclopropane- | Methylpropyl)cyclopropane-1- | oxopent-2-enoic acid |
| | 1-carboxylic acid | carboxylic acid | |
| Carboxymethoxy-hydroxy- | (1S,2R)-2-[(E)-Prop-1- | Nitrooxyacetamide | 3-Hydroxy-3- |
| oxophosphanium | enyl]cyclopropane-1-carboxylic | | tritiocyclopentene-1- |
| | acid | | carboxylic acid |
| 2-Formyl-3- | 3- | 4-Oxobutane-2-sulfonic acid | 3-(Oxiran-2-yl)prop-2-enoic |
| methylcyclopropane-1- | Methanethioylsulfanylpropanoic | | acid |
| carboxylic acid | acid | | |
| 3-Formylcyclopentane-1- | 4-Methoxy-4-oxobutane-2- | 2-Methoxypropyl dihydrogen | 5-Methyl-4-oxohex-2-enoic |
| carboxylic acid | sulfonic acid | phosphate | acid |
| 2- | 4,4-Difluorobutyl hydrogen | 1-(2,2- | 4-Sulfanylpent-2-enoic acid |
| Chlorosulfinyloxypropanoic | carbonate | Difluoroethenyl)cyclopropane- | |
| acid | | 1-carboxylic acid | |
| 2- | 6-Oxo-2,3-dihydropyran-2- | 2-Propa-1,2- | 3-(1,1,1,2- |
| Dimethylphosphorylethyl- | carboxylic acid | dienylcyclopropane-1- | Tetramethylhydrazin-1-lum- |
| phosphonic acid | | carboxylic acid | 2-YI)propanoate |
| Phosphorosomethyl phosphonic | 2,2-Dichloro-4,4-difluoro-3- | 3-Chlorocaproic acid | 3-Chloro-4,4,4-trifluorobut- |
| acid | oxobutanoic acid | | 2-enoic acid |
| Propanedioic acid, 2,2- | Nitro 2-bromoethaneperoxoate | 2-Methyl-4- | (E)-2-Cyano-3- |
| difluoro-, 1-ethyl ester | | sulfanylidenepentanoic acid | cyclopropylprop-2-enoic |
| | | | acid |
| 2-(2-Methylimidazol-2- | 5-Methyltetrazole-5-carboxylic | 5-Methylidenecyclohexa-1,3- | 3,4-Dichlorobut-3-enoic |
| yl)acetic acid | acid | diene-1-carboxylic acid | acid |
| 2-Mercapto-2,3- | 5-Methyl-2,5-dihydropyridine- | 2,3-Dihydrofuran-2-carboxylic | Isoprenylacetate |
| dimethylbutanoic acid | 3-carboxylic acid | acid | |
| 2-Methyl-2-sulfanylbutanoic | 3-Fluoro-2-tritiobutanoic acid | 4-Chlorocaproic acid | 4-Nitropent-3-enoic acid |
| acid | | | |
| 3-Carbamoyloxirane-2- | 2-Methyl-4-sulfanylpent-2- | 2-Fluoro-3,3-dimethyl butanoic | 4-Chloropent-3-enoic acid |
| carboxylic acid | enoic acid | acid | |
| (Z)-3-Chloropent-2-enoic | 2-Sulfanylidenepyran-4- | 3-Chloro-3-methylbutanoic acid | 3-Methyl-4-oxo-2-hexenoic |
| acid | carboxylic acid | | acid |
| 3-Amino-3- | 3-(3-Methylcyclopropen-1- | 1-Ethoxyaziridine-2-carboxylic | 2-(Methoxyimino)acetate |
| sulfanylidenepropanoic acid | yl)propanoic acid | acid | |
| cis-3-Carboxycyclobutyl | 1-[(2S)-Oxiran-2- | 1-Methoxyaziridine-2- | 2-Oxo-3-diazopropionate |
| azide | yljethylcarbamic acid | carboxylic acid | |
| 1-Aziridinecarboxylic acid, 2- | Sulfamoyl hydrogen carbonate | 2-(2- | 2-(4-Methylthiophen-3- |
| (aminocarbonyl)- | | Chloroethynyl)cyclopropane-1- | yl)acetic acid |
| | | carboxylic acid | |
| 3-Ethoxybutanoic acid | 1,4-Oxathiine-3-carboxylic acid | [1- | 3,4,4,4-Tetrafluorobut-2- |
| | | (Acetyloxy)ethenyl]phosphonic | enoic acid |
| | | acid | |
| 2-Amino-2-ethoxyacetic acid | 4-Imino-2-oxopentanoic acid | 5-Methyl-4-oxofuran-2- | 3-(Hydroxymethoxy)prop-2- |
| | | carboxylic acid | enoic acid |
| 4-Oxocyclohexa-1,5-diene- | Carboxyphosphanyl(trimethyl) | 5-Hydroxy-2-oxohexanoic acid | 6-Methyl-2,3,4,5- |
| 1-carboxylic acid | azanium | | tetrahydropyridine-3- |
| | | | carboxylic acid |
| 2,3,3-Trifluoro-2- | 2-[(Z)- | 2,2-Difluoro-3-fluorooxy-3- | 2-Methoxycarbonyl-3- |
| methylpropanoic acid | Ethylideneamino]oxyacetic | oxopropanoic acid | methylcyclopropane-1- |
| | acid | | carboxylic acid |
| 3-Methoxy-2-oxopropanoic | 3-Cyano-3-hydroxypropanoic | 2,2,3,3-Tetrafluoropropyl | 4,4-Difluorobut-2-enoic acid |
| acid | acid | hydrogen carbonate | |
| 5-Oxo-2-sulfanylhexanoic | Hexane-2,5-di(18O)one | 4-Chlorooxolane-2-carboxylic | 5-Methyloxolane-3- |
| acid | | acid | carboxylic acid |
| 2-Hydroxy-4-oxopentanoate | 2- | 3-Methyloxolane-2-carboxylic | (E)-4,4-Difluoropent-2-enoic |
| | [Ethenoxy(methyl)ami- | acid | acid |
| | no]propanoic acid | | |
| Tert-butylperoxy hydrogen | 2-Oxo-2-(2- | Cyclohepta-3,5-diene-1- | Rac-(1R,2S)-2- |
| carbonate | sulfanylethoxy)acetic acid | carboxylic acid | Propylcyclopropanecarboxylic |
| | | | acid |
| 2-Chloro-4-oxopentanoic | 5-Iminopent-2-enoic acid | 2-Hydroxy-2-sulfonylacetic acid | 4,4-Dichloro-3- |
| acid | | | methylbutanoic acid |
| 2-Chloro-2,4- | 2- | Bicyclo[3.1.0]hexa-1(6),2,4- | 1-Hydroxyethylideneacetate |
| dimethylpentanoic acid | (Ethylideneamino)cyclopropane- | triene-3-carboxylic acid | |
| | 1-carboxylic acid | | |
| Carbonochloridoyl(me- | 1-Acetyloxyethanesulfonate | 6-Mercapto-4-oxohexanoic acid | 2-Oxidoiminopropanoic acid |
| thyl)carbamic acid | | | |
| 2-Ethoxy-2,2-difluoroacetic | 2-Chloropent-4-ynoic acid | 4-Isothiazoleacetic acid | 3-Hydroxyiminobutanoic |
| acid | | | acid |
| 2-(3,4-Dihydro-2H-pyrrol-5- | 3-Hydroxy-3- | 5-Phosphanylpentanoic acid | 3-Nitroprop-2-enamide |
| yl)acetic acid | methylcyclopentene-1- | | |
| | carboxylic acid | | |
| 3-Chloro-2,2,3- | 2-Methyl-4-methyliminobut-2- | (E)-4-Ethoxybut-2-enoic acid | 4-Chloropenta-2,4-dienoic |
| trifluoropropanoic acid | enoic acid | | acid |
| 2-Hydrazinyloxyacetic acid | (E)-4-(Hydroxyamino)-3- | 2,2,3-Trifluoropropanoic acid | 4-Methyl-3,4-dihydro-2H- |
| | methyl-4-oxobut-2-enoic acid | | pyrrole-2-carboxylic acid |
| 2-(2-Oxopropoxy)propanoic | 4H-1,3-Thiazine-6-carboxylic | 2-(2-Oxopropoxy)acetic acid | (Difluoromethylideneamino) |
| acid | acid | | hydrogen sulfate |
| 2-Chloropent-4-enoic acid | (2S)-2-Methyl-4-oxo-4- | 2- | 2-Methyl-5-oxopent-2-enoic |
| | phosphanyloxybutanoic acid | (Phosphanylideneamino)propanoic | acid |
| | | acid | |
| 5,5,5-Trifluoro-4- | 2-Methyl-2,3-dihydropyridine- | 1-Acetyl-2-methylaziridine-2- | (1R,2R)-2- |
| oxopentanoic acid | 5-carboxylic acid | carboxylic acid | (Fluoromethyl)cyclopropane- |
| | | | 1-carboxylic acid |
| 2-(2-Oxohydrazinyl)acetic | (2S)-2- | 2- | 4-Methoxy-2-methylpent-2- |
| acid | Carbonochloridoyloxypropanoic | [Acetyl(me- | enoic acid |
| | acid | thyl)amino]ethanesulfonate | |
| 2-Bromo-4,4,4- | 5-Chloro-4,5-dioxopentanoic | 5,5-Dimethoxy-3- | Trifluoromethylsulfinylformic |
| trichlorobutanoic acid | acid | sulfanylpentan-2-one | acid |
| 3,5-Dimethyl-3,4- | 2-[Ethenyl(methyl)amino]acetic | 3,6-Dihydro-2H-1,4-oxazine-5- | (1R,4S)-4-Methylcyclopent- |
| dihydropyrazole-5-carboxylic | acid | carboxylic acid | 2-ene-1-carboxylic acid |
| acid | | | |
| 4-Sulfanylcyclohexane-1- | 3- | Dihydroxyphosphanyloxy | 2-Aminooxyacetic acid |
| carboxylic acid | [Dihydroxy(methyl)silyl]propanoic | dihydrogen phosphite | |
| | acid | | |
| 1,4-Dithiane-2-carboxylic | 3-Hydroperoxy-4-oxobutanoic | 1-Methoxypropyl hydrogen | 4-Oxidopent-4-enoate |
| acid | acid | carbonate | |
| 3-Hydroperoxypropanoic | trans-2- | 4-Chloro-2-methylpentanoic | 2- |
| acid | (Difluoromethyl)cyclopro- | acid | (Phosphanylmethyl)butanoic |
| | panecarboxylic | | acid |
| | acid | | |
| 5-Methyl-2,4-dioxohexanoic | 3-Diazenyl-4,4,4- | Methylsulfonyloxymethanesulfonic | Nitrosomethyl hydrogen |
| acid | trifluorobutanoic acid | acid | carbonate |
| 3-Cyclopropylbutanoic acid | 2,3- | 3-Methyloxirene-2-carboxylic | 5-Phosphanyloxypenta- |
| | Dideuterio(113C)butanedioic | acid | enoic acid |
| | acid | | |
| 3-Cyano-2- | 2- | 1-Sulfanylethyl hydrogen | 2- |
| sulfanylpropanoic acid | (Ethylidenehydrazinylidene)acetic | carbonate | Ethanimidoylcyclopropane- |
| | acid | | 1-carboxylic acid |
| Isocyano hydrogen | 1-Aminooxycyclopropane-1- | 6-Chloropyridazine-4- | (2S)-2- |
| carbonate | carboxylic acid | carboxylic acid | Carbonofluoridoyloxypropanoic |
| | | | acid |
| 2,3,3-Trichloro-butyric acid | 2,4,4,4-Tetrafluorobut-2-enoic | 4,4-Difluorobutanoate | 1,1,1-Trideuteriohexane- |
| | acid | | 2,5-dione |
| 2-Methyl-2h-1,2,3-triazole-4- | 2,2,3,3-Tetradeuterio-3- | 4,4-Difluorobutanoic acid | 2,5-Dihydro-1,2-oxazol-3-yl |
| carboxylic acid | [deuteriomethyl-methyl- | | hydrogen carbonate |
| | (trideuteriomethyl)silyl]propanoic | | |
| | acid | | |
| 4-Methylthietane-2- | Carboxymethyl- | 3-Azido-2,2-dimethyl propanoic | 2-Methyl-2-(methyl- |
| carboxylic acid | methoxycarbonyl- | acid | methylidene-oxo-lambda6- |
| | dimethylazanium | | sulfanyl)propanoic acid |
| 3-Pyridazineacetic acid | 5-Hydroperoxypent-2-enoic | 2-Chloro-4- | 4-(Deuterioamino)-4- |
| | acid | methylsulfanylbutanoic acid | oxobut-2-enoic acid |
| 3-Methyl-1- | 3-Aminooxy-2-methylprop-2- | 2-Amino-5-chloro-4- | Nitro 2-diazoacetate |
| sulfanylpyrrolidine-2- | enoic acid | oxopentanoate | |
| carboxylic acid | | | |
| 5-Amino-5- | 2-[(2S)-4-Oxooxetan-2- | 2-[Ethyl(hydroxy)amino]-2- | 3,6-Dioxohexanoic acid |
| sulfanylidenepentanoic acid | yllacetic acid | oxoacetic acid | |
| 2-Isocyano-2- | 2- | (2-Hydroxycyclopentyl) | cis-2-Trimethylsilyl- |
| methylpropanoic acid | [Methoxy(methyl)amino]acetic | hydrogen carbonate | cyclopropane-1-carboxylic |
| | acid | | acid |
| 3-Cyano-2- | 4-Oxo-4-phosphanylbutanoic | 2-Amino-2-sulfinoacetic acid | 3- |
| hydroxypropanoic acid | acid | | (Oxomethylidene)pentanoic |
| | | | acid |
| Thiadiazol-5-yl hydrogen | [Amino(hydroxymethyl)phos- | 2-(1- | 3-Chloro-3-sulfanylbutanoic |
| carbonate | phanyl]formic acid | Hydroperoxyethenyl- | acid |
| | | sulfanyl)acetic | |
| | | acid | |
| Carboxyperoxy formate | 3-(Triaziridinyl)propanoic acid | 3-Hydroxy-4- | 2,2,3,3- |
| | | methylcyclopentene-1- | Tetrafluoropentanoic acid |
| | | carboxylic acid | |
| 4-Ethoxy-2-sulfanylbutanoic | 2-[Ethynyl(methyl)amino]acetic | Methoxy-oxo- | 3,6-Dihydronicotinate |
| acid | acid | phosphonooxyphosphanium | |
| 2,2-Difluoro-3- | 2,2,3,3,4-Pentafluoropentanoic | O-Methyl-d-threonine | 2-(Carboxyethoxy)propanal |
| methylbutanoic acid | acid | | |
| 2-Methyl-4-oxopentanoate | 2-(2-Diazenylethylimino)acetic | 2-Hydroxymethyl-4- | Methane; 4-oxopentanoic |
| | acid | oxobutanoate | acid |
| 1,2,3- | 2-(2-Cyanopropan-2- | 2-Carbamoyloxypropanoic acid | 2-Ethylphosphanylacetic |
| Trimethylcyclopropane-1- | ylsulfanyl)acetic acid | | acid |
| carboxylic acid | | | |
| 2- | 5-Fluoro-2-methylidene-4- | (2R)-2-(Methylsulfanylamino)- | 2H-Thiazine-3-carbo xylic |
| Carboxyethyl(methyl)phosphinate | oxopentanoic acid | 3-sulfanylpropanoic acid | acid |
| (2E)-4-Chloro-2- | 2,2,3,3,4-Pentadeuterio-4- | 2-Methylidene-3-oxobutanoic | 4-Ethoxybutanoic acid |
| methylpenta-2,4-dienoic | oxobutanoic acid | acid | |
| acid | | | |
| 2- | 4-Hydroxy-4-methoxybut-2- | (2S,4R)-2,4- | 5-Oxazoleacetic acid |
| (Phosphanylideneamino)acetic | enoic acid | Dihydroxypentanoic acid | |
| acid | | | |
| 2,5-Dimethyltriazole-4- | 3-Hydroxy-3- | (3-Methyl-2-oxobut-3-enyl) | 2-Hydroperoxy-2- |
| carboxylic acid | methylcyclobutene-1- | dihydrogen phosphate | methoxyacetic acid |
| | carboxylic acid | | |
| (2S)-2-Isocyanatopropanoic | 2-(2-Oxoethyl)cyclopropane-1- | 3- | 2,3-Dichloro-3,3- |
| acid | carboxylic acid | [Formyl(methoxy)amino]propanoic | difluoropropanoic acid |
| | | acid | |
| (R)-Tetrahydrofuran-3- | Carboxy N- | Difluoro(methoxycarbonyl)methane- | Methanol; 4-oxopentanoic |
| carboxylic acid | methoxymethanimidate | sulfonate | acid |
| 2-(Hydroperoxyamino)acetic | 5-Methyl-2H-1,2-oxazole-5- | 1,2-Dimethylaziridine-2- | 3-Methyl-4-oxo-3- |
| acid | carboxylic acid | carboxylic acid | sulfanylpentanoic acid |
| 1,3-Dithiane-5-carboxylic | Prop-1-enylphosphanylformic | 4-Methoxy-2-(methylamino)-4- | 2- |
| acid | acid | oxobutanoic acid | [Ethenyl(ethyl)amino]acetic |
| | | | acid |
| 3,3-Bis(sulfanyl)propanoic | 4-Deuterio-2-methyl-3- | (E)-4-Oxidooxybut-2-enoate | Cyclopenta-1,3-dien-1-yl |
| acid | oxobutanoic acid | | hydrogen carbonate |
| 2-Bromo-5-oxopentanoic | 3-Formylsulfanyl-2- | 2-(1-Propan-2- | 4-Methoxy-4-oxo-2,2- |
| acid | methylpropanoic acid | ylcyclopropyl)acetic acid | bis(sulfanyl)butanoic acid |
| Phosphinoglycine | Ethane; 4-oxopentanoic acid | 4-Bromo-2-methylimino-3- | 2-(4-Oxodioxolan-3- |
| | | oxobutanoic acid | ylidene)acetic acid |
| 2- | 2,3-Dideuterio(113C)but-2- | Hydroxyphosphanyloxycarbonyl- | (6-Deuteriocyclohex-3-en-1- |
| Hydroperoxyethanesulfonic | enedioic acid | phosphanylformic acid | yl) hydrogen carbonate |
| acid | | | |
| 2-Hydroperoxyprop-2-enoic | 3,6-Dihydropyridazine-4- | 2-(Methylperoxymethoxy)acetic | 2-Deuterio-5- |
| acid | carboxylic acid | acid | hydroxypentanoic acid |
| 3-Hydroperoxybut-3-enoic | Dithiolan-4-yl hydrogen | 2- | 3-(Hydroxymethyl)-5- |
| acid | carbonate | Methoxycarbonyloxypropanoic | oxopentanoic acid |
| | | acid | |
| 4-Hydroperoxybut-2-ynoic | 1-Nitrooxyethyl hydrogen | Carboxymethyl-methyl- | 2,5-Dihydro-1,3-oxazole-4- |
| acid | carbonate | oxophosphanium | carboxylic acid |
| 2-Methyl-4-(methylamino)-4- | 2-Formylsulfanylbutanoic acid | 2-Acetyl- | Oxalonitrat |
| oxobutanoate | | cyclopropanecarboxylic acid | |
| 2-(2,3-Dihydrothiophen-5- | 2-(Dioxiran-3-yl)-2-oxoacetic | 3- | 3-Hydroxy-2-tritiobutanoic |
| yl)acetic acid | acid | (Methylaminomethoxy)propanoic | acid |
| | | acid | |
| 2-(3-Oxo-1,2-thiazolidin-2- | 1,2-Dioxo-1,3-thiazolidine-4- | 4-Fluorobut-2-ynoic acid | 5-Chloro-2-methylhexa-2,5- |
| yl)acetic acid | carboxylic acid | | dienoic acid |
| 4-Aminooxy-2-methylidene- | 2H-1,3-Thiazol-3-yl hydrogen | 1-Methylsulfonylaziridine-2- | 3-Ethoxy-3- |
| 4-oxobutanoic acid | carbonate | carboxylic acid | sulfanylpropanoic acid |
| 2-Carboxyoxy-2-oxoacetic | Deuterio 4-fluorobenzoate | 2-Oxobutyl hydrogen sulfate | 1-Methyl-2,3-dihydropyridin- |
| acid | | | 1-ium-4-carboxylic acid |
| 2-Methanidyloxyacetic acid | 3-Deuteriohex-2-enoic acid | 2-(1-Hydroperoxyethoxy)-2- | 4-Oxobut-1-enylphosphonic |
| | | oxoacetate | acid |
| 3-(2-Methyl-3H-pyrrol-3- | 3-Chloro-2-methylbut-3-enoic | 2-[Ethyl(methyl)amino]acetate | 2-(Acetylamino)-propionic |
| yl)propanoic acid | acid | | acid anion |
| 3-Amino-4-methoxy-2- | (2S)-5-Methyl-3,4-dihydro-2H- | 2-Oxo-3-phosphanylpropanoic | 4-Chloro-4-nitrosobutanoic |
| methyl-4-oxobutanoic acid | pyrrole-2-carboxylic acid | acid | acid |
| 2-Formyliminopropanoic | (113C)But-2-enedioic acid | 2-(Phosphanylamino)propanoic | 2-(2- |
| acid | | acid | Nitrosohydrazinyl)acetic |
| | | | acid |
| (Z)-4-Hydroperoxy-2- | (3S)-3-Fluoro-4- | 3-Mercaptoacrylic acid | 3-Iminocyclohexane-1- |
| methylbut-2-enoic acid | hydroxycyclopentane-1- | | carboxylic acid |
| | carboxylic acid | | |
| (R)-3,4-Epoxybutyrate | 4-Methylcyclohexa-1,3-diene- | Hexanoic acid, 5-mercapto- | 3-Carbonochloridoyloxy-2- |
| | 1-carboxylic acid | | methylprop-2-enoic acid |
| 4-Hydroxy-2-methyl-4- | 2-Methylphosphirane-1- | (Z,2S)-3,4-Dichloro-2- | 3- |
| oxobutanoate | carboxylic acid | (sulfanylmethyl)but-3-enoic | Phosphanyliminophosphanylprop- |
| | | acid | 2-enoic acid |
| 2-(Ethoxyamino)propanoic | (2S)-2-(Difluoroamino)-2- | 2-Amino-4-hydroxybutyrate | 2H-1,4-Diazepine-5- |
| acid | fluoropropanoic acid | | carboxylic acid |
| 2-Methoxyethyl sulfate | 4-Ethoxybut-3-enoic acid | 2-[Acetyl(ethenyl)amino]acetic | (2S)-2-(Aminooxyamino)-3- |
| | | acid | hydroxypropanoic acid |
| 2-Acetyloxyethanesulfonic | 3-Chloro-2-sulfanylbutanoic | 2-(Disulfanyl)propanoic acid | 3-(Azet-2-yl)propanoic acid |
| acid | acid | | |
| 2- | (2-Methylpyrrolidin-1-yl) | Butanedioic acid, 2,3- | 4-Chloro-2-methyl-4- |
| [Dihydroxy(methyl)silyl]acetic | hydrogen carbonate | dimercapto-, monomethyl ester | oxobut-2-enoic acid |
| acid | | | |
| 4-Methoxy-2-oxobutanal | 6-Deuteriohex-2-ynoic acid | [2-(Oxidoamino)-2-oxoethyl] | 3,3-Dichloropent-4-enoic |
| | | phosphate | acid |
| (Dimethyl phosphino)acetic | 3-Hydroxycyclobutene-1- | 5,5,5-Trifluoropentanoate | (Carboxymethylamino)- |
| acid | carboxylic acid | | methoxy-oxoazanium |
| 4-Iminobutanoic acid | 3-(Methoxyamino)-2- | 4-(2-Oxoethoxy)but-2-ynoic | 2-Methylcyclobuta-1,3- |
| | methylprop-2-enoic acid | acid | diene-1-carboxylic acid |
| 2- | 2-Fluoro-2-methyl-3- | 1-Methoxy-1-oxopropane-2- | (2R)-2-Methoxycarbonyl-2- |
| [Methyl(phosphanyl- | oxobutanoic acid | sulfonate | methylcyclopropane-1- |
| methyl)amino]acetic acid | | | carboxylic acid |
| 2-[Hydroxy(methyl)amino]-2- | 2-Azido-2-sulfanylacetic acid | 3-Fluoro-2- | Difluoromethylsulfanylphosphonic |
| oxoacetic acid | | oxobicyclo[3.1.0]hexane-6- | acid |
| | | carboxylic acid | |
| Carboxyoxy-hydroxy- | Formamidosulfanylformic acid | 2-[Dimethyl(2- | (2S)-2- |
| oxophosphanium | | oxopropyl)azaniumyl]acetate | [Acetyl(sulfanyl)amino]propanoic |
| | | | acid |
| 2,4-Dimethylcyclopentane-1- | 2-(Chloromethoxy)propanoic | 2-Hydroxypropyl sulfite | 4-Nitroso-2-oxobutanoic |
| carboxylic acid | acid | | acid |
| 3-Oxidopentanoate | 4-Hydroxysulfanyl-4- | 2-Methyl-2- | 3-Ethyliminobutanoic acid |
| | oxobutanoic acid | [methyl(phosphanyl)amino]propanoic | |
| | | acid | |
| 2H-Pyrrole-4-carboxylic acid | | | |

TABLE 5
Analogs of acrylic acid

| | | | |
|---|---|---|---|
| 2-Oxobutanoic acid | Acetic acid-1-13C,d4 | 3-Fluoro-2-oxopropanoate | Oxomethylidene(oxoniocarbonyl) |
| | | | oxidanium |
| 3-Mercaptopyruvic acid | Propionic-2,2-d2 acid-d | Bromochlorofluoroacetic acid | Carboxy(oxomethylidene)oxidanium |
| Acetate | Dichloroacetic acid-d2 | [Methylthio]acetate | 2-(Dioxiran-3-yl)acetic acid |
| Acetic acid | Dichloroacetic acid-2- | (2R)-3-Amino-2- | 2-(18F)Fluoranylpropanoic acid |
| | 13C | methylpropanoate | |
| Butyric acid | Acetic acid-1802 | (R)-2-Chlorobutyric Acid | But-2-enoate |
| Aminooxyacetic acid | (1,2,3,4-13C4)Butanoic | 2-Thiophosphorosoacetic acid | 3,3,3-Trideuterio-2- |
| | acid | | methylpropanoic acid |
| Chloroacetic acid | Chloroacetic acid-1-13C | Propynoate | Cycloprop-2-ene carboxylic acid |
| N,N-Dimethylglycine | Chloroacetic acid-2-13C | (2E)-2-Hydrazinylidenepropanoic | Butanoic acid, 2-fluoro-, (S)- |
| | | Acid | |
| Glyoxylic acid | 2,2,2-Trifluoroacetic | 2-Aminooxy-2-oxoacetic acid | 2-(18F)Fluoranyl-2- |
| | acid | | methylpropanoic acid |
| Propionic acid | Butyric acid-1,2-13C2 | 2-Methylpropanedithioic acid | 2-[Bromo(chloro)amino]acetic |
| | | | acid |
| Pyruvic acid | (1,2-13C2)Propanoic | 3,3-Dichloro-propanoic acid | 2-Oxo(1,2-13C2)propanoic acid |
| | acid | | |
| Thioglycolic acid | (2,3-13C2)Propanoic | 2-Tritioacetic acid | (S)-2-Methyl-3-oxopropanoate |
| | acid | | |
| Methacrylic acid | (1,2,3-13C3)Prop-2- | (2Z)-2-Hydrazinylidenepropanoic | (1R,2S)-2-Fluorocyclopropane-1- |
| | enoic acid | acid | carboxylic acid |
| Fluoroacetate | Butyric acid-d8 | Pivalate | (2S)-2-Oxidopropanoate |
| Fluoroacetic acid | Thioglycolate(2-) | (2S)-2-Methylbutanoate | Nitrosoperoxycarbonic acid |
| Iodoacetic acid | Iodobutyrate | 3-Butenoate | Nitrosoperoxycarbonate |
| Bromoacetate | Hydroxy(oxo)methanes | (E)-2-Methylbut-2-enoate | 2-Fluoro-but-2-enoic acid |
| | ulfinate | | |
| Bromoacetic acid | Sulfinoformic acid | (R)-(+)-2-Bromopropionic acid | Prop-2-enoic acid; ZINC |
| Pivalic acid | Sulfanyl hydrogen | 3-Chloropropanoate | Prop-2-enoic acid; chloride |
| | carbonate | | |
| 2,2-Dichloropropionic acid | 2- | Cyclopropanecarboxylate | 3-Fluoro-2-methylprop-2-enoic |
| | (Hydroperoxy)propionic | | acid |
| | acid | | |
| Trifluoroacetic acid | Carbonic acid | 2-Chloroacrylate | 2-Chloro-3-fluoroprop-2-enoic |
| | chloromethyl ester | | acid |
| 3-Mercaptopropionic acid | Hydroperoxy hydrogen | 3-Bromopropanoate | 3,3-Dideuterio-2- |
| | carbonate | | (trideuteriomethyl)prop-2-enoic |
| | | | acid |
| Methyl vinyl ketone | Carbonofluoridic acid | 2-Bromo-2-methylpropanoate | Tritio 2-methylprop-2-enoate |
| Isobutyric acid | Chloro hydrogen | But-2-ynoate | 2-(Deuteriomethyl)prop-2-enoic |
| | carbonate | | acid |
| Dichloroacetic acid | Fluoro hydrogen | (1S,2S)-2-Methylcyclopropane- | 3-Methyldioxirane-3-carboxylic |
| | carbonate | 1-carboxylic acid | acid |
| 3-Chloropropionic acid | Phosphorosoformic acid | (1S,2R)-2-Methylcyclopropane- | Deuterio (2S)-2- |
| | | 1-carboxylic acid | (fluoroamino)propanoate |
| 3-lodopropionic acid | 2-Hydroxypropan-2-yl | cis-2- | 2,3-Difluorobutanoic acid |
| | hydrogen carbonate | Methylcyclopropanecarboxylic | |
| | | acid | |
| Difluoroacetic acid | 2-Chlorooxyacetic acid | trans-2- | Dioxirane-3-carboxylic acid |
| | | Methylcyclopropanecarboxylic | |
| | | acid | |
| 2-Fluorobutyric acid | N,N-Dichloroglycine | (S)-2-Chloropropanoate | Fluoromethyl hydrogen carbonate |
| 3-Fluoropropanoic acid | Hydroperoxyacetic acid | 2,2-Bis(fluoranyl)propanoate | 2-Chlorooxyiminoacetic acid |
| Propiolic acid | N-Hydroxy-L-alanine | Trifluoromethylacetate | 3-Fluoro-2-methylpropanoic acid |
| Isovaleric acid | Thioxoacetic acid | Dioxido-oxo-propan-2-yl- | 2-Chloro-2-deuterio-2-fluoroacetic |
| | | | acid |
| 3,3-Dimethylacrylic acid | 3-Chloro-3- | 2-Fluoroacrylate | 2-Fluorobut-3-enoic acid |
| | oxopropanoate | | |
| 2,3-Dichloropropionic acid | 2,2-Dichloro-2- | 3-Mercaptopropionate | 2-Chloroiminoacetic acid |
| | deuterioacetic acid | | |
| 3-Bromopropionic acid | 3-Deuteriopropanoic | (2R)-2-Sulfanylpropanoic acid | 2-Oxo-3-tritiopropanoic acid |
| | acid | | |
| 1,1-Dichloro-1-nitroethane | 2-Phosphanylacetate | 3-Chloroacrylate | Monothioglycine |
| 2-Bromopropionic acid | Phosphanylacetic acid | (Z)-3-Chloroprop-2-enoate | Acetic acid, (methoxyimino)- |
| 2-Chloropropionic acid | 2-(Fluoromethyl)prop-2- | 4-Oxobutanoate | 2-Hydrazinyloxy-2-oxoacetic acid |
| | enoic acid | | |
| 2-Chloroacrylic acid | (Sulfanylamino)sulfanylformic | Isocrotonate | Tritio acetate |
| | acid | | |
| Methoxyacetic acid | Methoxy hydrogen | 1-Fluorocyclopropanecarboxylic | 2-Chloro-2-nitrosoacetic acid |
| | carbonate | acid | |
| Dibromoacetic acid | Carboxylatomethylium | (1S,2S)-2- | 2-Diazenylpropanoic acid |
| | | Fluorocyclopropanecarboxylic | |
| | | acid | |
| 3,3-Dichloroacrylic acid | 2-Fluoro-3- | Carbonocyanidic Acid | Methylsulfanylmethyl hydrogen |
| | sulfanylpropanoic acid | | carbonate |
| Propane, 1,1-dimethoxy-2- | Methyl hydrogen | Butyric acid-1-13C | Difluoroalanine |
| methyl- | phosphate | | |
| Cyclopropanecarboxylic | 2-(Disulfanyl)acetic acid | Ethenyl hydrogen carbonate | Iodoalanine |
| acid | | | |
| 2-Propene-1-sulfonic acid | Hydroxyphosphanylformic | Pyruvic-2-13C acid | (214C)Propanoic acid |
| | acid | | |
| N-Hydroxyglycine | 2- | Propionic acid-13C3 | Bromomethyl hydrogen carbonate |
| | Hydroxyphosphanylacetic | | |
| | acid | | |
| Cyclobutanecarboxylic | 2- | 2-Oxo(313C)propanoic acid | Aminoxyalanine |
| acid | [Chloro(hydroxy)amino] | | |
| | acetic acid | | |
| 2-Chlorobutyric acid | Iodo hydrogen | 2-Oxo(2,3-13C2)propanoic acid | 2-Bromo-3-fluoroprop-2-enoic |
| | carbonate | | acid |
| Acrylate | 2-Thionitrosoacetic acid | Pyruvic acid-13C3 | 3-Bromo-2-fluoroprop-2-enoic |
| | | | acid |
| Dichloroacetate | Carboxynitrite | 3-Fluoro-2-oxobutanoic acid | Acrylic acid, calcium salt |
| 3-Butenoic acid | 2-Bromo-2-oxoacetic | (1R,2R)-2- | 1-Hydroxyprop-1-en-1-olate |
| | acid | Fluorocyclopropanecarboxylic | |
| | | acid | |
| 3-Methyl-2H-azirine-2- | 2-(Methoxyamino)acetic | trans-2- | 3-Hydroxy-3-oxoprop-1-en-2-olate |
| carboxylic acid | acid | Fluorocyclopropanecarboxylic | |
| | | acid | |
| 2-Hydroxyacrylic acid | 2-Aminooxyprop-2- | 2,2-Difluoro-2-methoxyacetic | (1S,2R)-2-Chlorocyclopropane-1- |
| | enoic acid | acid | carboxylic acid |
| 3-Iodoprop-2-enoic acid | 2- | 2-Fluorocyclopropanecarboxylic | 2-Methylthiirane-2-carboxylic acid |
| | Chlorosulfanylpropanoic | acid | |
| | acid | | |
| 2-Mercaptopropionic acid | Iodomethyl hydrogen | Acetic acid-1-13C | 2-(Hydroxyamino)-2- |
| | carbonate | | sulfanylideneacetic acid |
| 2-Propenoic acid, polymer | 1-Chloroethyl hydrogen | Pyruvic acid-1-13C | 3-Methylthiirane-2-carboxylic acid |
| with ethene | carbonate | | |
| Chlorodifluoroacetic acid | Oxaziridine-3-carboxylic | Propanedithioic Acid | N-Methylidene-L-alanine |
| | acid | | |
| Dichlorofluoroacetic acid | 2-Phosphanyloxyacetic | 2-Oxo(413C)butanoic acid | 2-Bromo-2-iodoacetic acid |
| | acid | | |
| Bromonitromethane | Carboxy-hydroxy- | (2R)-2-Methyloxirane-2- | Deuterio 2,2,2-trideuterioacetate |
| | oxophosphanium | carboxylic acid | |
| 2-Methy-1-nitropropane | 2-Isocyanopropanoic | (R)-Oxiranecarboxylic acid | 2,2-Difluoro-2-sulfanylacetic acid |
| | acid | | |
| Deuterotrifluoroacetic acid | Water acrylate | Isobutyric-d7 acid | Chlorosulfinylformic acid |
| Propanethioic acid | 3-Fluorobut-3-enoic acid | Bromoacetic-13c2 acid | 2-Fluorooxyacetic acid |
| 2-Bromo-2- | Phosphoformic acid | Propanoic acid-3,3,3-d3 | 2-Iodo-2-oxoacetic acid |
| methylpropanoic acid | | | |
| (Methylthio)acetic acid | Carboxy formate | 2-(113C)Methylprop-2-enoic acid | Tritio 3-methylbutanoate |
| Propanoic acid, 2- | 2-Phosphanylprop-2- | Bromoacetic acid-1-13C | Phosphanyl hydrogen carbonate |
| (aminooxy)- | enoic acid | | |
| Monomethyl carbonate | 2-(Difluoromethyl)prop- | Bromoacetic acid-2-13C | Methyl carbonotrithioate |
| | 2-enoic acid | | |
| Propane-2-sulphonic acid | Methylsulfanylformic | 2-Chloro-3,3-difluoropropenoic | Prop-2-enethioate |
| | acid | acid | |
| 2-Bromoacrylic acid | 2-Sulfonylacetic acid | 3-Methylbutyric-2,2-d2 acid | Tritio propanoate |
| Ammonium acrylate | Bicyclo[1.1.0]butane-1- | 3-Bromo-3-fluoropropanoic acid | 3,3-Dideuterio-3- |
| | carboxylic acid | | sulfanylpropanoic acid |
| Trifluoroacetate | 1-Hydroxyaziridine-2- | (2R)-2-Fluoropropanoic acid | 2,2,3,3-Tetradeuterio-3- |
| | carboxylic acid | | sulfanylpropanoic acid |
| Methacrylate | Aziridine-1-sulfonic acid | 2-Propenoic acid, 2-methoxy- | 2,2-Dideuterio-3- |
| | | | sulfanylpropanoic acid |
| (2R)-2-Bromo-2- | 2,2,3-Trifluoropropanoic | (S)-2-Fluoropropanoic acid | (3R)-3,4,4,4-Tetradeuterio-3- |
| chloroacetic acid | acid | | methyl(412C,1,2,3-13C3)butanoic |
| | | | acid |
| 2-Methoxypropanoic acid | 2- | Formic acid, (thiocarboxy)- | Deuterio 2-bromo-2,2- |
| | lodocyclopropanecarboxylic | | dideuterioacetate |
| | acid | | |
| Oxirane-2-carboxylic acid | 2-Phosphanyl propanoic | Deuterio 2-chloroacetate | Deuterio 2,2-dideuterioacetate |
| | acid | | |
| Chlorofluoroacetic acid | Bromoformic acid | 2-Methyloxirane-2-carboxylic | S-Tritio propanethioate |
| | | Acid | |
| 2- | 2-Fluoro-2-oxoacetic | Acetic acid-13C2 | (Z)-3-Hydroxyacrylic acid |
| Methylcyclopropanecarboxylic | acid | | |
| acid | | | |
| Propionate | Hydrazinyl hydrogen | 3,3-Difluorobutanoic Acid | 2-Chloro-2-deuteriopropanoic |
| | carbonate | | acid |
| Butyrate | 1-Cyclopropene-1- | Propanoic acid, 2-chloro-2- | 4-Tritiobutanoic acid |
| | carboxylic acid | fluoro- | |
| Ethyl hydrogen carbonate | 2-Hydrazinyloxyacetic | Oxalochloride | 2-Bromo-2,2-ditritioacetic acid |
| | acid | | |
| Pyruvate | Isocyano hydrogen | Jodameisensaure | 2-Methylpropan(18O2)oate |
| | carbonate | | |
| 2-Nitropropane nitronate | 2-Methylprop-2-enoic | Iodomethylphosphonic Acid | Tritio 3-sulfanylpropanoate |
| | acid | | |
| (S)-2-Chloropropionic acid | 2- | 1-Propene, 1,1-dimethoxy- | 3,3,3-Trideuterio-2,2- |
| | (Phosphanylideneamino)acetic | | dimethylpropanoic acid |
| | acid | | |
| 2,3-Dimercaptopropionic | Phosphinoglycine | Deuterio 2-methylprop-2-enoate | Prop-2-enoic acid; vanadium |
| acid | | | |
| Iodonitromethane | 2-Hydroperoxyprop-2- | (313C)Propanoic acid | 2-Oxidoprop-2-enoate |
| | enoic acid | | |
| (1-14C)Pyruvate | 2-Iodoprop-2-enoic acid | 2-Bromo-2-fluoropropanoic acid | 3,3,3-Trideuterio-2-methyl-2- |
| | | | (trideuteriomethyl)propanoic acid |
| Acetic acid-C,C,C-d3 | 2,2,3,3- | Nitroethyne | Chloroacetic acid-d3 |
| | Tetradeuteriopropanoic | | |
| | acid | | |
| 3-Butynoic acid | 2-Fluoro-2- | 2-Chloro-2,2-dideuterioacetic | 2,3,3,3-Tetradeuterio-2- |
| | phosphanylacetic acid | acid | methylpropanoic acid |
| 2-Propenoic acid, 2- | 2- | 3-Chloro-3-Oxopropanoic Acid | (2S)-2-(18F)Fluoranylpropanoic |
| mercapto- | [Hydroxy(methyl)amino]- | | acid |
| | 2-oxoacetic acid | | |
| 2-Iodopropanoic acid | Fluorooxymethanesulfonic | Isovaleric acid-1-13C | (2R)-2-(18F)Fluoranylpropanoic |
| | acid | | acid |
| N-Chloroglycine | Methylphosphanylformic | Butanoic-2,2-d2 acid(9CI) | 2-Oxidoacetate |
| | acid | | |
| Chlorocarbonic acid | Propanoic acid | Butyric acid-2-13C | [Hydroxy(methoxy)methylidene]oxidanium |
| Acetic acid C-14 | 4-Deuteriobutanoic acid | (413C)Butanoic acid | Hydroxy(prop-2-enoato-O)ZINC |
| 2-Methylpropanoate | 3-Mercaptoacrylic acid | Butyric acid-4,4,4-d3 | Prop-2-enoic acid; ZINC |
| Carbonoperoxoic acid | 3-Fluorodioxirane-3- | Butyric-d7 acid | Tritio butanoate |
| | carboxylic acid | | |
| Isopropylphosphonic acid | 2-Diazenylacetic acid | Propanoic acid-1-13C | CID 59032882 |
| 2-Fluoropropionic acid | 2,3-Butadienoic acid | 2-Deuteriopropanoic acid | Deuterio 2- |
| | anion | | (trideuteriomethyl)prop-2-enoate |
| n-Hydroxy-n-methylglycine | Carbonochloridate | Deuterio propanoate | 2-(Trideuteriomethyl)prop-2-enoic |
| | | | acid |
| 2-Bromo-3-fluoropropionic | Ethoxyformic acid anion | 2-Tritiopropanoic acid | Prop-2-enoic acid; rhenium |
| acid | | | |
| 2- | Bromo hydrogen | Propanoic acid-2,2-d2 | 2,2,3,3,3-Pentadeuteriopropanoic |
| Bromocyclopropanecarboxylic | carbonate | | acid |
| acid | | | |
| 3-Methyl-3-butenoic acid | Methylphosphinoacetic | Acetic acid-2-13C | 2-Methyl(113C)prop-2-enoic acid |
| | acid | | |
| 1- | Methylphosphinopropionic | 2-Deuterioacetic acid | Tritio methylsulfanylformate |
| Hydroxyethylideneoxidanium | acid | | |
| (S)-3-Amino-2- | Methoxymethyl | Acetic acid-2-13C,2,2,2-d3 | Propan-2-yloxymethanethioate |
| methylpropanoic acid | hydrogen carbonate | | |
| CID 450346 | 2-(Aziridin-1-yl)acetic | 2,2,2-Tritritioacetic acid | 3,3,3-Trideuterio-2-oxo(1,2,3- |
| | acid | | 13C3)propanoic acid |
| CID 450347 | 2-Fluoroethyl hydrogen | Bromoacetic acid-d3 | Prop-2-enoic acid; titanium |
| | carbonate | | |
| CID 450348 | Fluoromethylsulfate | 2-Deuterio-2-methyl propanoic | Prop-2-enoic acid; tungsten |
| | | acid | |
| Acetic acid C-11 | 1-Bromoethenesulfonic | 2-Methyl-d3-propionic-3,3,3-d3 | Prop-2-enoic acid; rutherfordium |
| | acid | acid | |
| Fluoroacetic acid F-18 | 2-Chloro-3- | Isobutyric acid-1-13C | Prop-2-enoic acid; yttrium |
| | fluoropropanoic acid | | |
| Thiophosphonoformic acid | Phosphoroso hydrogen | Acetic Acid-13C2, D3 | 2-Deuterio-3-methylbutanoic acid |
| | carbonate | | |
| Methylphosphinoformic | Oxirenecarboxylic acid | Thiirane-2-carboxylic acid | 2-Deuterio-2-oxoacetate |
| acid | | | |
| Sodium isopropyl sulfate | Propan-2-yl carbonate | (2S)-Thiirane-2-carboxylic acid | Methylaminophosphanylformic |
| | | | acid |
| Chloroacetate | 2-Bromo-2- | Amino(sulfanylidene)acetic acid | 2-Deuterio-2,2-difluoroacetic acid |
| | hydroxyacetic acid | | |
| 2-Iodoacetate | 2-Methoxyacrylate | 2-Bromoacetyl cyanide | 2-Deuterio-2-fluoro-2- |
| | | | phosphanylacetic acid |
| Bromochloroacetic acid | Phosphanylformate | 3,3,3-Trideuterio-2- | Tritio (E)-2,3-ditritiobut-2-enoate |
| | | (trideuterio(113C)methyl)(313C) | |
| | | propanoic acid | |
| Monomethyl | Chlorosulfanylformic | (Bromomethyl)phosphonic acid | Tritio 2-methylpropanoate |
| carbonotrithioate | acid | | |
| (E)-3-Iodoacrylic acid | Iododifluoroacetic acid | 2-(Hydroxyamino)propanoic acid | 1-Hydroxypropylideneoxidanium |
| (S)-(−)-2-Bromopropionic | Carbonocyanidate | (213C)Propanoic acid | Prop-2-enoic acid yttrium |
| acid | | | |
| (S)-2-Mercaptopropanoic | Chlorooxoacetate | Prop-2-enoic acid | Carboxyethanolate |
| acid | | | |
| 2-Butenoic acid, 3-chloro- | Propanedithioate | (2R)-3-Chloro-2-methyl propanoic | Deuterio carbonochloridate |
| | | acid | |
| Isocrotonic acid | 2- | 3,3-Difluoroacrylic acid | 2-Iodoacetic acid |
| | Carboxyethyl phosphine | | |
| cis-3-Chloroacrylic acid | Aminophosphanylformic | Glycone | Bromoacetic acid-1802 |
| | acid | | |
| (Z)-3-Bromoacrylic acid | 2-Phosphorosoacetic | Ethylsulfanylformic acid | (313C)Butanoic acid |
| | acid | | |
| (Z)-3-Iodoacrylic acid | 2-Sulfanylbutanoate | Carbonic acid isopropyl ester | 2-Bromo-2-chloroacetic acid |
| 2- | 2-Bromosulfanylacetic | Deuterio 3,3-dideuterio-2- | 2,2-Dichloroacetic acid |
| [Amino(dimethyl)azaniumyl] | acid | (trideuteriomethyl)prop-2-enoate | |
| acetate | | | |
| Acetic acid-D | 2-Chlorosulfanylacetic | Acrylic acid-1-13C | 2-Iodoacetic acid |
| | acid | | |
| (2H3)Acetic (2H)acid | Acetic acid, | Acrylic acid-d4 | CID 71309200 |
| | aminomercapto- | | |
| Deuterio 2,2,3,3,3- | 2-Hydroxysulfanylacetic | Glycine-2-t | Bromoacetic acid-1-13C,1802 |
| pentadeuteriopropanoate | acid | | |
| (R)-(+)-2-Chloropropionic | Isocyanoacetate | 2-Sulfinoacetic acid | 2-Chloro(1,2,3-13C3)propanoic |
| acid | | | acid |
| 3,3,3-Trifluoropropionic | 2-Methylbut-3-ynoic | 2-Chlorocyclopropane-1- | Iodoacetic acid-1-13C |
| acid | acid | carboxylic acid | |
| Bromofluoroacetic acid | (Methyldisulfanyl)formic | Bromomethylidene(dioxido)azanium | 2-Chloroacetic acid |
| | acid | | |
| Fluoroiodoacetic acid | Prop-2-enoic | 2,3-Difluoropropanoic acid | Eisenakrylat |
| | acid; hydrochloride | | |
| 2-Fluoroacrylic acid | 3-Methyloxaziridine-3- | (Z)-3-Chloro-2-fluoroprop-2- | Prop-2-enoic acid; silver |
| | carboxylic acid | enoic acid | |
| 2,2-Difluoropropionic acid | N-Propan-2- | Phosphanecarboxylic acid | Chromium; prop-2-enoic acid |
| | ylcarbamothioate | | |
| 2-Fluoroisobutyric acid | 2-Methylcyclopropane- | Fluoroglycine | Ethene; prop-2-enoic acid |
| | 1-carboxylate | | |
| 2,2-Bis(sulfanyl)acetic acid | 2-Chloroethyl hydrogen | 2-Bromopropanoate | Propa-1,2-diene; prop-2-enoic |
| | carbonate | | acid |
| Propanoyloxidanium | 2-Nitrosoprop-2-enoic | 2-Chloranylpropanoate | Carbon monoxide; ethene; prop-2- |
| | acid | | enoic acid |
| Aziridine-2-carboxylate | Carboxymethylphosphorane | 2-Propenethioic S-acid | Diazenyl hydrogen carbonate |
| Trifluoromethoxyformic | 2-Deuterioprop-2-enoic | Diiodoacetic acid | Methylamino hydrogen carbonate |
| Acid | acid | | |
| Dihydroxyphosphanylformic | 2,3,3-Trideuterioprop-2- | 2-Deuterio-2-oxoacetic acid | Deuterio 2-fluoroprop-2-enoate |
| Acid | enoic acid | | |
| Isopropylacetate | alpha,beta- | Bromoglycine | Deuterio 2-iodoprop-2-enoate |
| | Dichloropropionate | | |
| Difluoroacetate | Aminosulfanylformic | Prop-2-enedithioic acid | Deuterio 2,2-dimethylpropanoate |
| | acid | | |
| Glyoxylate | Thietane-3-carboxylic | 3,3-Dideuterio-2-fluoroprop-2- | Deuterio 2-chloroprop-2-enoate |
| | acid | enoic acid | |
| 2-Chloro-2,2- | Prop-2-enoate; prop-2- | 3-Bromo-but-3-enoic acid | 2-Tritiobutanoic acid |
| difluoroacetate | enoic acid | | |
| Chloromethanesulfonate | Methylamino | 2-(Methylamino)-2- | Deuterio 2,2-dideuterioacetate |
| | dihydrogen phosphate | sulfanylideneacetic acid | |
| Bromomethanesulfonate | 3,3,3-Trideuterio-2,2- | Isocyanoacetic acid | 2-Chloro-2-diazenylacetic acid |
| | bis(trideuteriomethyl)propanoic | | |
| | acid | | |
| Ammonia bicarbonate | Chloroiodoacetic Acid | Deuterio 3,3-dideuterio-2- | Deuterio 2-bromoprop-2-enoate |
| | | fluoroprop-2-enoate | |
| (2,2,2- | Hydroxysulfanylformic | 3-Fluorobutyric acid | Carbon dioxide; prop-2-enoic acid |
| Trifluoroacetyl)oxidanium | acid | | |
| Methoxyformate | Disulfanylformic acid | 2-Mercaptopropionate | 2-Aminooxyacetic acid |
| Methylsulfate | 2-Fluoranylpropanoate | 2-Oxidopropanoate | Acryloyloxysilver |
| 3-Methylbut-2-enoate | 4-Oxobut-3-enoic acid | Dioxidan-2-idecarboxylate | Prop-2-enoic acid; hydrate |
| Mercaptoacetate | But-3-ynoate | But-3-enedithioic acid | Copper; prop-2-enoic acid |
| Sodium; prop-2-enoic | Manganese; prop-2- | 2-Bromopropionic-1-13C acid | Prop-2-enoic |
| acid; hydroxide; hydrate | enoic acid | | acid; hydrate; hydrochloride |
| Cobalt; prop-2-enoic acid | | | |

TABLE 6
Analogs of 2-bromooctanoic acid.

| | | | |
|---|---|---|---|
| DL-Ethionine | 2-Bromo-2-methyloctanoic | 2,2-Dichlorohept-6-enoic acid | 2-Methylocta-2,6-dienoic acid |
| | acid | | |
| 2-Methylheptanoic acid | 2-Bromo-8- | 2-Bromo-6-chlorohexanoic acid | 2,2-Dibromooctanoic acid |
| | methylnonanoic acid | | |
| 2-Bromoheptanoic acid | 5-Bromotridecanoic acid | 2-[(4-Methylphenyl)methyl]prop- | 2-Methylocta-2,4,6-trienoic |
| | | 2-enoic acid | acid |
| Undecanoic acid, 11-bromo- | 2,3-Dibromoundecanoic | (2E)-3-Methylhepta-2,6-dienoic | 2,3-Dimethyloct-2-enoic acid |
| | acid | acid | |
| 2-Isopropyl-5-methylhexanoic | 2-Methyl-2- | (R)-2-Methyl-2-aminooctanoic | 2-Methylidene-5-prop-2- |
| acid | sulfanyloctanoic acid | acid | enoxypentanoic acid |
| 2-Octynoic acid | 2,5-Dimethylhexanoic acid | 2-Amino-2-ethyloctanoic acid | 3-Hydroxy-2- |
| | | | methylideneoctanoic acid |
| 3-Nitronon-2-ene | (2E)-3-Methylocta-2,7- | 2-Iodohept-6-enoic acid | 2-Nitrosooctanoic acid |
| | dienoic acid | | |
| 2-Nitrooct-2-ene | 2-Bromotridecanoic acid | Methylhexyl sulfone | 2-Cyanoheptanoic acid |
| 8-Nonynoic acid | 6-Chloro-2-methyl-6- | (2E,6E)-3-Methylocta-2,6- | 3-Methyl-4-oxo-4- |
| | oxohexanoic acid | dienoic acid | propoxybut-2-enoic acid |
| 8-Nonenoic acid | 3-(4- | 2,2-Dimethylhept-6-ynoic acid | 3-Pentyldioxirane-3- |
| | Ethylcyclohexyl)propanoic | | carboxylic acid |
| | acid | | |
| 2-Bromotetradecanoic acid | 2-Bromo-3- | 3-Butoxy-2-methylpropanoic | (2S)-2-Ethyloctanoic acid |
| | propoxypropanoic acid | acid | |
| 2-Bromododecanoic acid | Heptan-2-yl hydrogen | 3-Chlorooctanoic acid | 2-Propylpent-3-ynoic acid |
| | carbonate | | |
| 2-Heptynoic acid | (E)-2-Methyloct-3-enoic | 2-Bromo-5- | Oct-4-ynoic acid |
| | acid | carbomethoxypentanoic acid | |
| (R)-2-Ethylhexanoic acid | 3-Ethylheptanoate | 2-Fluorooctanoic acid | 2-Hydroxy-5- |
| | | | methylsulfanylpentanoic acid |
| 2-Bromohexadecanoic acid | 2,2,8-Trichlorooctanoic | 3-Fluorononanoic acid | 6-Chloro-2-methylhepta- |
| | acid | | 2,4,6-trienoic acid |
| (Butylthio)acetic acid | Pentoxy hydrogen | 3-Pentyloxirane-2-carboxylic | 2-(1,1-Ditritioethyl)- |
| | carbonate | acid | 2,3,3,4,4,5,5,6,6,6- |
| | | | decatritiohexanoic acid |
| 2-Ethyloctanoic acid | alpha-Hydroxycaprylate | (2R,3S)-3-Pentyloxirane-2- | 2-(But-2- |
| | | carboxylic acid | ynyldiazenyl)propanoic acid |
| (2S)-2-Bromooctanoic acid | 2-Sulfanylheptanoic acid | 2,2-Difluoroheptanoic acid | 3-Propylsulfanyl pentanoic |
| | | | acid |
| Cyclopropanecarboxylic acid, | 2-(Pentylsulfanyl)acetic | 2-Bromodecanedioic acid | 2,2-Bis(sulfanyl)hexanoic |
| 2-pentyl-, (1R,2R)-rel- | acid | | acid |
| IAAPVNQZSBLWKH- | Trimethylsilylheptanoic | 2-[(4-Fluorophenyl)methyl]prop- | 7-Chloro-2-methylhept-2- |
| UHFFFAOYSA-N | acid | 2-enoic acid | enoic acid |
| 2-Bromostearic acid | (E)-2,6-Dimethyloct-5- | 7-Bromononanoic acid | 7-Methyl-2-nitrosooctanoic |
| | enoic acid | | acid |
| 2-Bromodecanoic acid | 2-Methylidene-5- | (E)-3-Methyloct-4-enoic acid | 2,5-Diiodopentanoic acid |
| | methylsulfanylpentanoic | | |
| | acid | | |
| 2-Bromononanoic acid | 2-Methylhexanoate | 2-Bromononanedioic acid | (3R)-3-[(2S,3S)-3- |
| | | | Propyloxiran-2-yl]butanoic |
| | | | acid |
| 2-Bromoundecanoic acid | 2-Bromoheptadecanoic | 7-Bromo-2,2-dichloroheptanoic | 7-Chloro-2-methylhepta-2,5- |
| | acid | acid | dienoic acid |
| 9,10-Dibromohexadecanoic | 3-Bromooctadecanoic acid | 2E,7-Octadienoic acid | 2-Hex-2-ynoxyacetic acid |
| acid | | | |
| 10-Bromodecanoic acid | 2,3-Dibromooctadecanoic | Hept-1-ynylphosphonic acid | 4-Ethylsulfanyl-2-methylbut- |
| | acid | | 2-enoic acid |
| 12-Bromododecanoic acid | 3-Bromoicosanoic acid | (E)-4-Methyl-2-octenoic acid | 3-(2- |
| | | | Deuteriopropanoylsulfanyl)- |
| | | | 2-methylpropanoic acid |
| S-Propylmercaptocysteine | 6-Iodo-2-methylhexanoic | 2-Bromooctanedioic acid | 3-(3-Bromophenyl)-2- |
| | acid | | methylpropanoic acid |
| 2-Bromo-5,5- | 2- | 2-[2-(Methylthio)ethylthio]acetic | 4-Methyloct-2-enoic acid |
| dimethylhexanoic acid | (Hydroxymethyl)heptanoic | acid | |
| | acid | | |
| Dihomomethionine | 15-Bromohexadecanoic | (E)-2-Methyloct-6-enoic acid | 3-Methylnon-4-en-2-one |
| | acid | | |
| 5-Methoxy-2-methyl | 1-Hexylcyclopropane-1- | (2E,4E,6E)-2-Methylocta-2,4,6- | 2-(Prop-2-enoxyamino)but-2- |
| pentanoic acid | carboxylic acid | trienoic acid | enoic acid |
| 10,11-Dibromoundecanoic | 3,3-Dimethyl-2- | 2-Methyl-2-octenoic acid | 2,2,3-Trifluorooctanoic acid |
| acid | methylideneheptanoic acid | | |
| 2,7-Dibromooctanedioic acid | (E)-5-Ethylsulfanyl-2- | 2-Methylnon-8-enoic acid | 1-(5,5-Dimethylhexyl)-2- |
| | methylpent-2-enoic acid | | methylcyclopropane-1- |
| | | | carboxylic acid |
| 3-(Ethyldisulfanyl)alanine | (2E,4E,6E)-3-Methylocta- | 2-Methyloct-7-enoic acid | 2,7-Dimethyloct-3-enoic acid |
| | 2,4,6-trienoic acid | | |
| 2-Amino-2-methyl-4- | 2-(4- | (E)-2,3,5-Trimethylhex-2-enoic | 2-Methyl-5- |
| propylsulfanylbutanoic acid | Ethylcyclohexyl)propanoic | acid | methylsulfanylpentanoic acid |
| | acid | | |
| 2-Bromo-3-fluoroheptanoic | (4E)-3-Methylocta-4,7- | (Z)-2-Propylhept-2-enoic acid | 7-Fluoro-2-methylhept-2- |
| acid | dienoic acid | | enoic acid |
| 2,6-Dibromohexanoic acid | 3-Bromoheptanoic acid | (E)-6-Ethyl-2-methyloct-2-enoic | 2-[(4- |
| | | acid | Iodophenyl)methyl]prop-2- |
| | | | enoic acid |
| 2-Octanesulfonic acid | 2-Aminoheptanoate | 3-Carboxybut-3-enyl-ethyl- | 6,6-Difluoro-2-methylhex-2- |
| | | dimethylazanium | enoic acid |
| 2,4-Dimethyloct-2-enoic acid | 3-Bromodecanoic acid | 2,7-Dimethyloctanoic acid | 5,5,6,6-Tetrafluoro-2- |
| | | | methylhex-2-enoic acid |
| 3-(Ethyldisulfanyl)-l-alanine | 3-Bromononanoic acid | 8-Chloro-2-methylideneoctanoic | 1-Chloro-4- |
| | | acid | propylcyclohexane-1- |
| | | | carboxylic acid |
| 3-Methyloct-6-enoic acid | 3-Bromoundecanoic acid | 4-(2-Chloroethoxy)-2- | 2-(6-Methoxypyridin-3-yl)but- |
| | | methylidenebutanoic acid | 2-enoic acid |
| 2,11-Dibromododecanedioic | 3-Bromooctanoic acid | Benzenepropanoic acid, 4- | 2-Pentylcyclopropene-1- |
| acid | | bromo-alpha-methylene- | carboxylic acid |
| Undecanoic acid, 10-bromo- | Heptane-2-carboxylate | 2-Methoxyheptanoic acid | 7-Bromo-2-nitrosoheptanoic |
| | | | acid |
| 13-Bromotetradecanoic acid | (E)-2,3-Dimethyloct-2- | 1-(2-Methylbutan-2- | (E)-7-Fluoro-2-methylhept-2- |
| | enoic acid | ylperoxy)prop-2-enyl hydrogen | enoic acid |
| | | carbonate | |
| 14-Bromopentadecanoic acid | (Carbonic acid hexyl)anion | 9-Bromooctadecanoic acid | 3-Amino-2-methyloctanoic |
| | | | acid |
| 9-Bromononanoic acid | Carboxyheptal | 9-Bromododecanoic acid | (Z)-2-Methylnon-4-enoic acid |
| 8-Bromooctanoic acid | Butyl carboxy carbonate | 2-(2,2-Dichloroethyl)hexanoic | (E)-2-Methyl-5- |
| | | acid | (trimethylazaniumyl)pent-2- |
| | | | enoate |
| 15-Bromopentadecanoic acid | (R)-2-Amino-3-(2- | 3-(5-Methylhexyl)dioxirane-3- | 9-Bromo-8-oxononanoic acid |
| | propynylthio)propanoic | carboxylic acid | |
| | Acid | | |
| 4,6-Octadienoic acid | (2E,4E,6Z)-3,7-Dimethyl- | 6-Bromoheptanoic acid | (2S)-5,5-Difluoro-2- |
| | 8-oxoocta-2,4,6-trienoic | | methylheptanoic acid |
| | acid | | |
| (2R)-2-Bromo-3-(4- | 2-Pentylcyclopropane-1- | (E)-2,2-Dimethyloct-3-enoic acid | FCDKDIKSBBITRR- |
| fluorophenyl)propanoic acid | carboxylic acid | | UHFFFAOYSA-N |
| (S)-2-Aminooctanoic acid | (2R)-2- | 2-(Sulfanylmethyl)hexanoic acid | 3,3-Difluoro-2-[(2R)-2- |
| | (Butylsulfanylamino)-3- | | fluoropropyl]pentanoic acid |
| | sulfanylpropanoic acid | | |
| 2,2-Dichlorooctanoic Acid | (2R)-3-Cyclohexyl-2- | (E)-4-Iodo-2-methyloct-2-enoic | (4R)-4-Fluoro-2- |
| | methylpropanoic acid | acid | propylpentanoic acid |
| Hexane-1-sulfonate | 5-Bromoheptanoic acid | 2-(Butylsulfanylamino)-3- | (2S)-2-Bromoheptanoic acid |
| | | sulfanylpropanoic acid | |
| Heptane-1-sulfonate | 2-Methyl-3-(2-methylprop- | 6-Bromo-2,3-dimethylhexanoic | (2R)-2-Ethylheptanoic acid |
| | 2-enoxy)propanoic acid | acid | |
| 9-Bromodecanoic acid | 2-Methylidene-4- | 2-Fluoroheptanoic acid | (2S)-2-Methylnon-8-enoic |
| | propoxybutanoic acid | | acid |
| 2-Pentyl-3-butenoic acid | 2-Methyl-3- | (E)-2-Methyldec-8-enoic acid | (E)-2,6-Dimethyloct-6-enoic |
| | pentyliminobutanoic acid | | acid |
| 3-Methylheptanoic acid | 6-Chloro-2-ethyl-6- | Hexyl hydrogen carbonate | 2,6-Dimethylhept-6-enoate |
| | oxohexanoic acid | | |
| (Z)-3-Octenoic acid | 3,8-Dibromooctanoic acid | 14-Bromotetradecanoic acid | 2,6-Dimethylhept-6-enoic |
| | | | acid |
| 3-Octenoic acid | (2E)-3,7-Dimethylocta-2,7- | 3-(Ethyldisulfanyl)butanoic acid | LJHGUZODPZQEIO- |
| | dienoic acid | | UHFFFAOYSA-N |
| 6E-Octenoic acid | 6-Ethylsulfanyl-2- | 2-Fluoro-2-methyloctanoic acid | 2-Azaniumylheptanoate |
| | methylidenehexanoic acid | | |
| (R)-2-Hydroxycaprylic acid | 5-Methoxy-2- | (E)-2-(Butylamino)but-2-enoic | 5-Iodo-2,2-dimethyl pentanoic |
| | methylideneheptanoic acid | acid | acid |
| 11-Bromododecanoic acid | 3-Bromodocosanoic acid | 4-Bromodecanoic acid | 2,2-Dimethyl-4- |
| | | | methylsulfanylbutanoic acid |
| 12-Bromo-octadecanoic acid | (E)-3-(4-Bromophenyl)but- | 2-(But-3-ynylthio)acetic acid | (E)-2-Methyl-4-prop-2- |
| | 2-enoic acid | | enoxybut-2-enoic acid |
| (R)-2-Aminoheptanoic acid | 3-[(E)-But-2- | 2-But-3-ynylsulfanylpropanoic | 2-[1-(3- |
| | enyl]sulfanyl propanoic | acid | Bromopropyl)cyclopropyl]propanoic |
| | acid | | acid |
| (Z)-4-Ethyl-2-methyl-2- | (3E)-4-Methyl-3-nonen-2- | 2-Methylhept-6-ynoic acid | 3-(3-Iodophenyl)-2- |
| octenoic acid | one | | methylpropanoic acid |
| (Z)-3-Methyl-2-octenoic acid | N- | 2,2-Bis(sulfanyl)octanoic acid | 3-(4-Bromophenyl)but-2- |
| | Hydroxydihomomethionine | | enoic acid |
| 2,4,6-Octatrienoic acid | D-Homomethionine | 6-Bromo-2-ethylhexanoic acid | 1-(5- |
| | | | Iodopentyl)cyclopropane-1- |
| | | | carboxylic acid |
| (E)-3-(2,5-Dichlorothiophen- | (2S)-2-Aminooct-7-ynoic | 2-Phosphanyloxyoctanoic acid | 5-Pentyl-1,3,4-oxadiazole-2- |
| 3-yl)-2-methylprop-2-enoic | acid | | carboxylic acid |
| acid | | | |
| 3-Methyl-2-octenoic acid | 2-Azaniumyloctanoate | 3-Methyl-2- | 2-(4-Ethenylphenyl)but-3- |
| | | methylideneheptanoic acid | enoic acid |
| (Z)-3-Iodo-2-octenoic acid | 2-Azaniumyl-5- | 2-(2-Sulfanylethyl)octanoic acid | 1-(5- |
| | methylsulfanylpentanoate | | Chloropentyl)cyclopropane- |
| | | | 1-carboxylic acid |
| 3-(4-Bromophenyl)butanoic | 3-(3-Butenylthio)alanine | 5-Ethoxy-2-methylhexanoic acid | 3-(4-Iodophenyl)butanoic |
| acid | | | acid |
| (E)-3-Methyloct-6-enoic acid | (S)-2-Hydroxymethyl- | 6-Bromodecanoic acid | Octanoic acid-7-13C |
| | hexanoic acid | | |
| (E)-2-Nitrooct-2-ene | (R)-3-(4- | Hex-5-enyl hydrogen carbonate | (1,2,3,4,5,6,7,8- |
| | Fluorophenyl)butanoic | | 13C8)Octanoic acid |
| | acid | | |
| 6-Heptenoate | (S)-Butyl-D-Cys | 2-Sulfanyloctanoic acid | (213C)Octanoic acid |
| (2S)-2-Hydroxyoctanoic acid | (3S)-3-(4- | 2-(Sulfanylmethyl)heptanoic | (5,6,7,8-13C4)Octanoic acid |
| | Bromophenyl)butanoic | acid | |
| | acid | | |
| Hexyl-dioxido-oxo-lambda5- | (3R)-3-(4- | 2-Methyl-4-(2- | 2-Ethylhexanoic-d15 acid |
| phosphane | Bromophenyl)butanoic | oxoethylsulfanyl)butanoic acid | |
| | acid | | |
| (R)-2-Methylheptanoic acid | 2-(Dimethylamino)octanoic | 6-Bromoicosanoic acid | 3,7-Octadienoic acid |
| | acid | | |
| 4-(5-Bromothiophen-2- | 2-Butylsulfanyl butanoic | 2-Fluoro-4-propoxybutanoic acid | 3-Methyloct-4-enoic acid |
| yl)butanoic Acid | acid | | |
| 3-Bromohexadecanoic acid | 2-(Aminomethyl)heptanoic | (Z)-2-Chloro-3-(4- | 3-Methyloct-4-ynoic acid |
| | acid | chlorophenyl)but-2-enoic acid | |
| alpha-Pentylacrylic Acid | 2- | 1-Sulfanylhexane-1-sulfonic acid | Acetic acid, |
| | (Butylazaniumylidynemethyl)prop- | | (butylcyclopropylidene)- |
| | 2-enoate | | |
| 2-(Propan-2-yl)hex-5-enoic | (2S)-2-Amino-3- | 2-Iodo-5-propylbenzoic acid | 2,2-Dibromohexadecanoic |
| acid | (ethyldisulfanyl)propanoic | | acid |
| | acid | | |
| 2-Bromo-1-octanol | 3- | 2,8-Dibromooctanoic acid | Tetradecanoic acid, dibromo- |
| | (Ethylhydroxyphosphinyl)- | | |
| | 2-methylpropionic acid | | |
| 3-Fluorocaprylic acid | 2-Ammonio-6- | Octa-2,4,6-trienoic acid | Tetradecanoic acid, |
| | (methylsulfanyl)hexanoate | | tetrabromo- |
| 3-Bromononan-2-one | 4-Methyloct-2-ynoic acid | 6-Bromo-2-methylhexanoic acid | Nonanoic acid, 2,3-dibromo- |
| (R)-2-Amino-2-ethyloctanoic | 2-Methylhept-2-enoic acid | 4-Bromoheptanoic acid | 6-Heptenoic acid, 2- |
| acid | | | ethylidene- |
| 6-Methyl-2-heptenoic acid | 2,6-Heptadienoic acid, 3- | 2-Bromohenicosanoic acid | 5,8-Dibromooctanoic acid |
| | methyl-, (E)- | | |
| 1-Octanol, 2-iodo- | 2,2-Difluorooctanoate | 20-Bromohenicosanoic acid | 6-Heptenoic acid, 2-amino-, |
| | | | (2R)- |
| Dodecanedioic acid, 2-bromo- | 7-Bromooctanoic acid | 7-Iodo-2-methylheptanoic acid | 3-Methyloct-2-en-6-ynoic |
| | | | acid |
| 2-Hydroxy-2-methyloctanoic | 2-Methylnon-3-enoic acid | 2-Ethyl-5-iodopentanoic acid | 8,9-Dibromononanoic acid |
| acid | | | |
| (2E,4E,6S)-6-Methyl-2,4- | Butyl dicarbonate | 7-Bromo-3-methylheptanoic acid | 2-Methylnon-4-en-8-ynoic |
| octadienoic acid | | | acid |
| 2-Chlorooctanoic Acid | 3-Methyl-2-heptenoic acid | 7-Bromo-2-methylheptanoic acid | 2-Methylocta-2,7-dienoic acid |
| 2-Bromoheptanal | 3,7-Dimethyloct-2-enoic | 5-Bromononanedioic acid | 3-Methylnon-4-ynal |
| | acid | | |
| Hexyl(methyl)carbamodithioic | Hexyl(hydroxy)carbamic | 2-Bromoheptanedioic acid | 2,6-Dimethyloct-6-enoic acid |
| acid | acid | | |
| Propanoic acid, 2-(4- | 2-Methylideneocta-4,6- | 2-Bromoundecanedioic acid | 4-(Methyldithio)pentanoic |
| ethylcyclohexylidene)- | dienoic acid | | acid |
| (2S)-2-Fluoroheptanoic acid | (2S)-2-Fluoro-2- | 2-(3-Bromopropylsulfanyl)acetic | 2-Methyloct-7-ynoic acid |
| | methylheptanoic acid | acid | |
| (E)-7-Bromohept-2-enoic acid | 5-Ethylsulfanylhex-2-enoic | 6-Methyl-2-sulfanylheptanoic | 2-Methyloct-4-enoic acid |
| | acid | acid | |
| 2-Bromooctanal | Octa-4,7-dienoic acid | (2Z)-2-Ethylideneheptanoic acid | Hex-1-enyl hydrogen |
| | | | carbonate |
| (R)-2-Bromooctanoic acid | 3,6-Dimethylhept-2-enoic | 2-Propyl-2-sulfanyloctanoic acid | 3-Prop-2-enylsulfanylprop-2- |
| | acid | | enoic acid |
| (S)-2-Methylhept-6-enoic acid | 2-Ethylhex-4-enoic acid | 2-Isocyanohexanoic acid | 2-Methyl-4-prop-2-enoxybut- |
| | | | 2-enoic acid |
| (Z)-2-Bromo-2-octenoic acid | 2-Nitrosoheptanoic acid | (2R)-2-Bromo-3- | 2,3-Dimethylhex-5-ynoic acid |
| | | propoxypropanoic acid | |
| (R)-2-Bromohexadecanoic | 3-Methylocta-2,7-dienoic | 3-Allylsulfanyl-2-methyl- | 6-Bromohexadecanoic acid |
| acid | acid | propanoic acid | |
| 2-Bromooctanoyl Chloride | 2-(Propan-2-yl)heptanoic | (E)-7-Hydroxy-2-methylhept-2- | 5,6-Dibromodecanoic acid |
| | acid | enoic acid | |
| (R)-2-Methyloctanoic acid | Octa-2,6-dienoic acid | Oct-2-ene-2-carboxylic acid | 6-Bromooctanoic acid |
| (2S)-2-Methyl-7- | Pentylsulfanylformic acid | 5-(Methylthio)Pentanoic acid | (2R)-2-Bromoheptanoic acid |
| bromoheptanoic acid | | | |
| Tridecanoic acid, 13-bromo- | 3-Butylsulfanylprop-2- | (Z)-2-Prop-2-enylpent-3-enoic | 4-Bromooctanoic acid |
| | enoic acid | acid | |
| 3-Butylsulfanyl-butan-2-one | 1-Heptene, 1-nitro-, (1E)- | cis-2- | 2,13- |
| | | Pentylcyclopropanecarboxylic | Dibromotetradecanedioic |
| | | acid | acid |
| (2S)-2-Amino-2- | 2,3-Dibromooctanoic acid | [(E)-Hex-1-enyl] hydrogen | (6S)-6-Bromoheptanoic acid |
| methyloctanoic acid | | carbonate | |
| (S)-2-Bromohexadecanoic | 7-Bromohepta-2,4-dienoic | 2-Amino-3-prop-2-ynylsulfanyl- | 2-Bromooctanoic acid; ethane |
| acid | acid | propionic acid | |
| alpha-Bromooctanonitrile | 2-Butoxybut-3-enoic acid | 3-Prop-2-enylsulfanyl-2- | 4-Bromononadecanoic acid |
| | | (sulfanylamino)propanoic acid | |
| Bromlignocerinsaure | 3,5-Dimethylocta-2,6- | 5-Hydroxy-4-methyl-5- | 6-Bromoundecanoic acid |
| | dienoic acid | oxopentane-1-sulfinate | |
| 2,2-Difluoro-5-hexenoic acid | 2-Chloro-3-(4- | 2-Oxooctanoate | 2,10-Dibromoundecanedioic |
| | chlorophenyl)but-2-enoic | | acid |
| | acid | | |
| (2S)-Methyloctanoic acid | 4-(2,2- | 2-Methoxyoctanoic acid | (2S)-2-Bromo-7-methoxy-7- |
| | Dimethylhydrazinyl)-2- | | oxoheptanoic acid |
| | methylbutanoic acid | | |
| 2-Amino-4- | 2-Carboxy-N-propylprop- | 2-Ethoxyoctanoic acid | (2S)-2-Bromotetracosanoic |
| (methylsulfanylmethyl- | 2-enenitrilium | | acid |
| sulfanyl) butanoic acid | | | |
| 2-Amino-4-prop-2- | (R)-2-Bromodecanoic acid | 6-Methyl-2-propylheptanoic acid | Chloro 2-bromooctanoate |
| enylsulfanylbutanoic acid | | | |
| (2R)-2,6-Dimethylheptanoic | (S)-2-Bromodecanoic acid | 2-Bromo-7-methoxy-7- | 2-Bromooctanoic |
| acid | | oxoheptanoic acid | acid; hydrochloride |
| (E)-2-Methyl-4-octenoic acid | (2R)-2-Fluoro-2- | (E)-3,4,4-Trimethyloct-2-enoic | 2-Bromooctadecanoic |
| | methyloctanoic acid | acid | acid; hydrobromide |
| 2-Methyl-2-heptene-6-ynoic | 2-Methylidenenon-8-enoic | (E)-3,6-Dimethylhept-2-enoic | 7-Bromooctadecanoic |
| acid | acid | acid | acid; methane |
| 2-Ethynylheptanoic acid | (S)-2-Methylnonanoic acid | 13-Bromodocosanoic acid | 7-Bromooctadecanoic acid |
| Octanoic acid, 3-hydroxy-2- | (2R)-2-Chlorooctanoic | 12-Bromodocosanoic acid | 10-Bromohexadecanoic acid |
| methyl- | acid | | |
| 3,6-Dibromo-hexanoic acid | 2-Octenoic acid, 2-bromo- | 8-Bromooctadecanoic acid | 2-Bromooctadecanoic |
| | | | acid; calcium |
| (Z)-4-Nonenoic acid | 7-Bromomyristic acid | 1-Hexylcyclobutane-1-carboxylic | 7-Bromo-2-methylhept-2- |
| | | acid | enoic acid |
| 3-Nitrononane | 3-Cyclohexyl-2- | (2E)-2,6-Dimethylhepta-2,6- | 3-Methoxycarbonyloxy-2- |
| | methylprop-2-enoic acid | dienoic acid | methylpropanoic acid |
| 2-(Methylamino)octanoic acid | (S)-3-Fluorononanoic acid | 8-Bromodecanoic acid | 2,3-Dimethylocta-2,4,6- |
| | | | trienoic acid |
| 2-(Prop-2-en-1- | 7-Bromohept-2-enoic acid | 2-(3- | 2-(Deuterioamino)octanoic |
| ylsulfanyl)propanoic acid | | Chloropropylsulfanylmethylsulfanyl)acetic | acid |
| | | acid | |
| 2-[(E)-But-2- | 2-Ethenylsulfonyl-2- | 2-Pentylsulfanylpropanoic acid | (R)-2-Methylhept-6-enoic |
| enyl]sulfanylpropanoic acid | methylbutane | | acid |
| 2-Prop-2- | 2-(Prop-1-EN-2- | 2-Ethyl-6-heptenoic acid | 2- |
| ynylsulfanylpropanoic acid | YL)hexanoic acid | | (Butoxymethylidene)butanoic |
| | | | acid |
| (3E)-3,7-Octadienoic acid | Hept-1-ene-1-sulfonic acid | 6-Bromo-2-chlorohexanoic acid | 3-Bromo-2- |
| | | | (propoxyamino)prop-2-enoic |
| | | | acid |
| 2,7-Dichloroheptanoic acid | 5-Bromo-6-oxoheptanoic | 5-Bromooctanoic acid | 2-Fluoro-4-methyloctanoic |
| | acid | | acid |
| 2-Chloroheptanoic acid | (2R)-2- | 1-Butylcyclopropane-1- | 2-Methyl-5-(2-methyloxiran- |
| | Bromotetracosanoic acid | carboxylic acid | 2-yl)pent-2-enoic acid |
| 3-Octynoic acid | 7-Iodo-2- | 8-Bromo-2-diazo-3-oxooctanoic | 5-Ethyl-2-methylidenehepta- |
| | methylideneheptanoic acid | acid | 3,5-dienoic acid |
| (4E)-Octa-4,7-dienoic acid | 2,3,4-Trifluorohepta-2,4- | Deuterio 2,3,3,4,4,5,5,6,6,6- | (2S)-2-Chloro-3-(2- |
| | dienoic acid | decadeuterio-2-(1,1,2,2- | methylsulfanylethylsulfanyl)propanoic |
| | | tetradeuterioethyl)hexanoate | acid |
| (2E,6E)-2,6-Octadienoic acid | 2-Cyanooct-2-enoic acid | 2,2-Difluoro-3- | 2,5,5-Trimethylhept-2-enoic |
| | | propylsulfanylpropanoic acid | acid |
| (E)-2-Ethylhex-4-enoic acid | 2,2-Dimethyl-3-octenoic | 3-[[(Z)-But-2-enylidene]amino]- | 2,2,3,3,4,4,5,5- |
| | acid | 2-methylpropanoic acid | Octadeuteriooctanoic acid |
| 2-(p-Chlorobenzyl)acrylic | 3-Hexyldioxirane-3- | 10-Bromooctadecanoic acid | (6S)-2,6-Dimethylocta-2,7- |
| acid | carboxylic acid | | dienoic acid |
| 2-Chloro-2-ethylhexanoic acid | 2-Ethylhept-2-enoic acid | SDCUZZNMYRHPKB- | 3-Bromo-2- |
| | | UHFFFAOYSA-N | (ethoxyamino)prop-2-enoic |
| | | | acid |
| 6-Heptenoic acid, 2-methyl- | 3-Methylocta-2,4,6-trienoic | ZNMJIMWVHNXQJZ- | 3-Methyloct-2-en-2-yl |
| | acid | UHFFFAOYSA-N | formate |
| Octanoic acid, 2-ethynyl- | (3R)-3-Hydroxy-7-octenoic | AFIBKBGBUJQOHM- | 2-Methyl-3-[[(Z)-pent-2- |
| | acid | UHFFFAOYSA-N | enylidene]amino]propanoic |
| | | | acid |
| 11,12-Dibromododecanoic | 7-Fluoro-2- | QTBGWVMNSNFAKI- | (2S)-2-Bromo-3-(2- |
| acid | methylideneheptanoic acid | UHFFFAOYSA-M | methylsulfanylethylsulfanyl)propanoic |
| | | | acid |
| 2-Bromoicosanoic acid | 2,5,6-Trimethylhepta-2,6- | FCWILHQRLMWXPK- | 2,2-Dimethylnon-3-enoic acid |
| | dienoic acid | UHFFFAOYSA-N | |
| Butylsulfanylformic acid | (2R)-2-Fluorooctanoic acid | KGRHZIASHRXWFD- | |
| | | UHFFFAOYSA-N | |
| Nonadecanoic acid, 2-bromo- | (S)-2-Fluorooctanoic acid | 2-Bromopentadecanoic acid | (2R)-2-Fluoroheptanoic acid |
| Monobrombehensaure | 3,4-Dimethyloct-2-enoic | 2-(4-Vinylphenyl)propionic acid | 3-Butanoyloxy-2- |
| | acid | | methylpropanoic acid |

In certain instances, the LPS synthesis inhibitor (e.g., core oligosaccharide synthesis inhibitor, e.g., L-Heptoses synthesis inhibitor) is a sugar. For example, the sugar may be ADP-2-fluoroheptose (AFH). Alternatively, the sugar may be 2-aryl-5-methyl-4-(5-aryl-furan-2-yl-methylene)-2,4-dihydro-pyrazol-3-ones (DHPO). In some instances, the sugar is AFH and DHPO. In some instances, the sugar is a structural analog of ADP-beta-L-glycero-D-manno-heptopyranose. For example, the sugar may be one or more compounds in Table 7. In some instances, the sugar is ADP-2-deoxy-2-fluoro-heptose. In some instances, the LPS inhibitor is a fullerene hexa-adducts bearing 12 copies of peripheral sugars displaying the mannopyranose core structure of bacterial l,d-heptoside.

TABLE 7
Analogs of ADP-beta-L-glycero-D-manno-heptopyranose

| Compound | |
|---|---|
| Number | IUPAC Name |
| 20 | (4aR,6R,7R)-6-(6-aminopurin-9-yl)-2-hydroxy-2-oxo-4a,6,7,7a-tetrahydro- |
| | 4H-furo[3,2-d][1,3,2]dioxaphosphinin-7-ol |
| 21 | (2R,4aR,6R,7R,7aS)-6-(6-aminopurin-9-yl)-2-methoxy-2-oxo-4a,6,7,7a- |
| | tetrahydro-4H-furo[3,2-d][1,3,2]dioxaphosphinin-7-ol |
| 22 | (2S,4aR,6R,7R,7aS)-6-(6-aminopurin-9-yl)-2-methoxy-2-oxo-4a,6,7,7a- |
| | tetrahydro-4H-furo[3,2-d][1,3,2]dioxaphosphinin-7-ol |
| 23 | (2R,4aR,6R,7R,7aS)-6-(6-aminopurin-9-yl)-2-ethoxy-2-oxo-4a,6,7,7a- |
| | tetrahydro-4H-furo[3,2-d][1,3,2]dioxaphosphinin-7-ol |
| 24 | (2S,4aR,6R,7R,7aS)-6-(6-aminopurin-9-yl)-2-ethoxy-2-oxo-4a,6,7,7a- |
| | tetrahydro-4H-furo[3,2-d][1,3,2]dioxaphosphinin-7-ol |
| 25 | (4aR,6R,7R,7aS)-6-(6-amino-2-butylpurin-9-yl)-2-hydroxy-2-oxo- |
| | 4a,6,7,7a-tetrahydro-4H-furo[3,2-d][1,3,2]dioxaphosphinin-7-ol |
| 26 | (4aR,7R,7aS)-6-(6-aminopurin-9-yl)-2-oxido-2-oxo-4a,6,7,7a-tetrahydro- |
| | 4H-furo[3,2-d][1,3,2]dioxaphosphinin-7-ol |
| 27 | (4aR,6R)-6-(6-aminopurin-9-yl)-2-hydroxy-2-oxo-4a,6,7,7a-tetrahydro-4H- |
| | furo[3,2-d][1,3,2]dioxaphosphinin-7-ol |
| 28 | (4aR,6R,7R,7aS)-6-(6-aminopurin-9-yl)-2-methoxy-2-oxo-4a,6,7,7a- |
| | tetrahydro-4H-furo[3,2-d][1,3,2]dioxaphosphinin-7-ol |
| 29 | (4aR,6R,7R,7aS)-6-(6-aminopurin-9-yl)-2-oxido-2-oxo-4a,6,7,7a- |
| | tetrahydro-4H-furo[3,2-d][1,3,2]dioxaphosphinin-7-ol |
| 30 | (4aR,6R,7aR)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 31 | (4aS,6S,7R,7aR)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 32 | (4aS,6R,7S,7aR)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 33 | (4aR,6R,7S,7aS)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 34 | 6-(6-aminopurin-9-yl)-2-ethoxy-2-oxo-4a,6,7,7a-tetrahydro-4H-furo[3,2- |
| | d][1,3,2]dioxaphosphinin-7-ol |
| 35 | (4aS,6S,7R,7aS)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 36 | 6-(6-aminopurin-9-yl)-2-methoxy-2-oxo-4a,6,7,7a-tetrahydro-4H-furo[3,2- |
| | d][1,3,2]dioxaphosphinin-7-ol |
| 37 | (4aR,6R,7R,7aS)-6-(6-aminopurin-9-yl)-2-hydroxy-2-oxo-4a,6,7,7a- |
| | tetrahydro-4H-furo[3,2-d][1,3,2]dioxaphosphinin-7-ol |
| 38 | 6-(6-aminopurin-9-yl)-2-hydroxy-2-oxo-4a,6,7,7a-tetrahydro-4H-furo[3,2- |
| | d][1,3,2]dioxaphosphinin-7-ol |

In another example, undecaprenyl-pyrophosphate (UPP) is a 55-carbon polyisoprenoid lipid carrier that is required to transport peptidoglycan precursors across the cell membrane during bacterial peptidoglycan synthesis. Undecaprenyl pyrophosphate phosphatases (Upp-Pases, e.g., UppP or bcrC) are required for the synthesis and recycling of UPP. Accordingly, in some instances, the bacterial colonization-disrupting agent is an inhibitor of a Upp-Pase, e.g., a UppP inhibitor. In some instances, the UppP inhibitor is bacitracin, tripropeptin C (TPPC), a lipophilic hydroxyalkyl phosphonic acid, or a series of benzoic acids and phenylphosphonic acids.

In some instances, the bacterial colonization-disrupting agent alters the motility of the bacterial cell by, for example, targeting the function (e.g., rotation) of flagella. Accordingly, in some instances, the bacterial colonization-disrupting agent is a flagellar function inhibitor. In some instances, the flagellar function inhibitor is cellulose.

The bacterial colonization-disrupting agent may be used in a composition containing a single agent or may be used in a composition containing a mixture of different bacterial colonization-disrupting agents. The composition including the bacterial colonization-disrupting agent may include any number or type of bacterial colonization-disrupting agents, such as at least about any one of 1 bacterial colonization-disrupting agent, 2, 3, 4, 5, 10, 15, 20, or more bacterial colonization-disrupting agents.

The bacterial colonization-disrupting agent may be formulated in a composition for any of the uses described herein. A suitable concentration of each bacterial colonization-disrupting agent in the composition depends on factors such as efficacy, stability of the bacterial colonization-disrupting agent, number of distinct bacterial colonization-disrupting agents, the formulation, and methods of application of the composition. Exemplary formulations and compositions including bacterial colonization-disrupting agents are described in the section entitled “Formulations and Compositions.”

ii. Screening Methods to Identify Bacterial Colonization-Disrupting Agents

Included herein is a screening assay for identifying bacterial colonization-disrupting agents that are effective to inhibit colonization of bacteria in an insect and thereby decrease the insect's fitness. The screening assay involves identifying a bacterial colonization-disrupting agent by (a) exposing a target insect to one or more agents; and (b) identifying an agent that (i) decreases the fitness of the target insect, and (ii) inhibits colonization of a bacterium in the gut of the target insect.

Host fitness may be measured by any parameters described herein, including, but not limited to, measurements of reproductive rate, lifespan, mobility, fecundity, body weight, metabolic rate or activity, or survival in comparison to an insect to which the candidate agent has not been administered. The decrease in fitness may be compared to a predetermined threshold or a reference level. For example, the decrease in fitness (e.g., overall survival) may be a decrease of about 2%, 5%, 10%, 20%, 30%, 40%, 50%, 60%, 70%, 80%, 90%, 100%, or more than 100% relative to a reference level (e.g., untreated insect).

Inhibition of bacterial colonization can be measured by a number of methods known in the art, including in vitro or in vivo assays. Changes to colonization of bacteria in the insect as a consequence of the agent may be determined by methods including, but not limited to, polymerase chain reaction (PCR), quantitative PCR, real-time PCR, flow cytometry, microarray, fluorescence microscopy, transmission electron microscopy, fluorescence in situ hybridization (e.g., FISH), and DNA sequencing. The decrease in colonization may be compared to a predetermined threshold or a reference level. For example, the decrease in colonization may be a decrease of about 2%, 5%, 10%, 20%, 30%, 40%, 50%, 60%, 70%, 80%, 90%, 100%, or more than 100% relative to a reference level (e.g., untreated bacteria).

### III. Target Bacteria

The bacteria targeted by the bacterial colonization-disrupting agent described herein may include any bacteria resident in the gut of the host, or a cell or organ therein, including, but not limited to, any bacteria described herein. Bacteria resident in the host may include, for example, symbiotic (e.g., endosymbiotic microorganisms that provide beneficial nutrients or enzymes to the host) pathogenic bacteria, or commensal microorganisms. An endosymbiotic microorganism may be a primary endosymbiont or a secondary endosymbiont. A symbiotic bacteria may be an obligate symbiont of the host or a facultative symbiont of the host.

Microorganisms resident in the host may be acquired by any mode of transmission, including vertical, horizontal, or multiple origins of transmission. Transmission modes of insect symbionts includes environmental determination, coprophagy, smearing of brood cell or egg surface, social acquisition, capsule transmission or infection via jelly-like secretions. Some symbionts, like gut symbionts, are horizontally acquired from the environment in each generation. For example, the bean bug, Riptortus pedestris (Hemiptera: Alydidae), harbors a specific gut symbiont of the genus Burkholderia, which is acquired orally from the environment by second-instar nymphs. Bean bugs have a specialized symbiotic organ (crypts) in a posterior midgut fourth region (M4) to host the symbionts.

Exemplary bacteria that may be targeted in accordance with the methods and compositions provided herein, include, but are not limited to, Xenorhabdus spp, Photorhabdus spp, Candidatus spp, Pantoea spp, Buchnera spp, Blattabacterium spp, Baumania spp, Wigglesworthia spp, Wolbachia spp, Rickettsia spp, Orientia spp, Sodalis spp, Burkholderia spp, Cupriavidus spp, Frankia spp, Snirhizobium spp, Streptococcus spp, Wolinella spp, Xylella spp (e.g., Xylella fastidiosa), Erwinia spp, Agrobacterium spp, Bacillus spp, Commensalibacter spp. (e.g., Commensalibacter intestine), Paenibacillus spp, Streptomyces spp, Micrococcus spp, Corynebacterium spp, Acetobacter spp (e.g., Acetobacter pomorum), Cyanobacteria spp, Salmonella spp, Rhodococcus spp, Pseudomonas spp, Lactobacillus spp (e.g., Lactobacillus plantarum), Lysobacter spp., Herbaspirillum spp., Enterococcus spp, Gluconobacter spp. (e.g., Gluconobacter morbifer), Alcaligenes spp, Hamiltonella spp., Klebsiella spp, Paenibacillus spp, Serratia spp., Arthrobacter spp, Azotobacter spp., Corynebacterium spp, Brevibacterium spp, Regiella spp. (e.g., Regiellan insecticola), Thermus spp, Pseudomonas spp, Clostridium spp, Mortierella spp. (e.g., Mortierella elongata), or Escherichia spp.

Non-limiting examples of bacteria that may be targeted by the methods and compositions provided herein are shown in Table 8. In some instances, the 16S rRNA sequence of the bacteria targeted by the bacterial colonization-disrupting agent has at least 50%, 60%, 70%, 80%, 85%, 90%, 95%, 97%, 99%, 99.9%, or 100% identity with a sequence listed in Table 8.

TABLE 8
Examples of Target Bacteria and Host Insects

| Primary endosymbiont | Host | Location | 16S rRNA |
|---|---|---|---|
| Gamma proteobacteria | | | |
| Carsonella ruddii | Psyllids | bacteriocytes | TATCCAGCCACAGGTTCCCCTA |
| | (Psylloidea) | | CAGCTACCTTGTTACGACTTCA |
| | | | CCCCAGTTACAAATCATACCGTT |
| | | | GTAATAGTAAAATTACTTATGAT |
| | | | ACAATTTACTTCCATGGTGTGAC |
| | | | GGGCGGTGTGTACAAGGCTCG |
| | | | AGAACGTATTCACCGTAACATTC |
| | | | TGATTTACGATTACTAGCGATTC |
| | | | CAACTTCATGAAATCGAGTTACA |
| | | | GATTTCAATCCGAACTAAGAATA |
| | | | TTTTTTAAGATTAGCATTATGTT |
| | | | GCCATATAGCATATAACTTTTTG |
| | | | TAATACTCATTGTAGCACGTGTG |
| | | | TAGCCCTACTTATAAGGGCCAT |
| | | | GATGACTTGACGTCGTCCTCAC |
| | | | CTTCCTCCAATTTATCATTGGCA |
| | | | GTTTCTTATTAGTTCTAATATATT |
| | | | TTTAGTAAAATAAGATAAGGGTT |
| | | | GCGCTCGTTATAGGACTTAACC |
| | | | CAACATTTCACAACACGAGCTG |
| | | | ACGACAGCCATGCAGCACCTGT |
| | | | CTCAAAGCTAAAAAAGCTTTATT |
| | | | ATTTCTAATAAATTCTTTGGATG |
| | | | TCAAAAGTAGGTAAGATTTTTCG |
| | | | TGTTGTATCGAATTAAACCACAT |
| | | | GCTCCACCGCTTGTGCGAGCCC |
| | | | CCGTCAATTCATTTGAGTTTTAA |
| | | | CCTTGCGGTCGTAATCCCCAGG |
| | | | CGGTCAACTTAACGCGTTAGCT |
| | | | TTTTCACTAAAAATATATAACTTT |
| | | | TTTTCATAAAACAAAATTACAATT |
| | | | ATAATATTTAATAAATAGTTGAC |
| | | | ATCGTTTACTGCATGGACTACC |
| | | | AGGGTATCTAATCCTGTTTGCTC |
| | | | CCCATGCTTTCGTGTATTAGTGT |
| | | | CAGTATTAAAATAGAAATACGCC |
| | | | TTCGCCACTAGTATTCTTTCAGA |
| | | | TATCTAAGCATTTCACTGCTACT |
| | | | CCTGAAATTCTAATTTCTTCTTTT |
| | | | ATACTCAAGTTTATAAGTATTAA |
| | | | TTTCAATATTAAATTACTTTAATA |
| | | | AATTTAAAAATTAATTTTTAAAAA |
| | | | CAACCTGCACACCCTTTACGCC |
| | | | CAATAATTCCGATTAACGCTTGC |
| | | | ACCCCTCGTATTACCGCGGCTG |
| | | | CTGGCACGAAGTTAGCCGGTGC |
| | | | TTCTTTTACAAATAACGTCAAAG |
| | | | ATAATATTTTTTTATTATAAAATC |
| | | | TCTTCTTACTTTGTTGAAAGTGT |
| | | | TTTACAACCCTAAGGCCTTCTTC |
| | | | ACACACGCGATATAGCTGGATC |
| | | | AAGCTTTCGCTCATTGTCCAATA |
| | | | TCCCCCACTGCTGCCTTCCGTA |
| | | | AAAGTTTGGGCCGTGTCTCAGT |
| | | | CCCAATGTGGTTGTTCATCCTCT |
| | | | AAGATCAACTACGAATCATAGTC |
| | | | TTGTTAAGCTTTTACTTTAACAA |
| | | | CTAACTAATTCGATATAAGCTCT |
| | | | TCTATTAGCGAACGACATTCTC |
| | | | GTTCTTTATCCATTAGGATACAT |
| | | | ATTGAATTACTATACATTTCTATA |
| | | | TACTTTTCTAATACTAATAGGTA |
| | | | GATTCTTATATATTACTCACCCG |
| | | | TTCGCTGCTAATTATTTTTTTAAT |
| | | | AATTCGCACAACTTGCATGTGTT |
| | | | AAGCTTATCGCTAGCGTTCAAT |
| | | | CTGAGCTATGATCAAACTCA |
| | | | (SEQ ID NO: 9) |
| Candidatus Portiera | whiteflyes | bacteriocytes | AAGAGTTTGATCATGGCTCAGA |
| aleyrodidarum BT-B | (Aleyrodoidea) | | TTGAACGCTAGCGGCAGACATA |
| | | | ACACATGCAAGTCGAGCGGCAT |
| | | | CATACAGGTTGGCAAGCGGCG |
| | | | CACGGGTGAGTAATACATGTAA |
| | | | ATATACCTAAAAGTGGGGAATA |
| | | | ACGTACGGAAACGTACGCTAAT |
| | | | ACCGCATAATTATTACGAGATAA |
| | | | AGCAGGGGCTTGATAAAAAAAA |
| | | | TCAACCTTGCGCTTTTAGAAAAT |
| | | | TACATGCCGGATTAGCTAGTTG |
| | | | GTAGAGTAAAAGCCTACCAAGG |
| | | | TAACGATCCGTAGCTGGTCTGA |
| | | | GAGGATGATCAGCCACACTGGG |
| | | | ACTGAGAAAAGGCCCAGACTCC |
| | | | TACGGGAGGCAGCAGTGGGGA |
| | | | ATATTGGACAATGGGGGGAACC |
| | | | CTGATCCAGTCATGCCGCGTGT |
| | | | GTGAAGAAGGCCTTTGGGTTGT |
| | | | AAAGCACTTTCAGCGAAGAAGA |
| | | | AAAGTTAGAAAATAAAAAGTTAT |
| | | | AACTATGACGGTACTCGCAGAA |
| | | | GAAGCACCGGCTAACTCCGTGC |
| | | | CAGCAGCCGCGGTAAGACGGA |
| | | | GGGTGCAAGCGTTAATCAGAAT |
| | | | TACTGGGCGTAAAGGGCATGTA |
| | | | GGTGGTTTGTTAAGCTTTATGTG |
| | | | AAAGCCCTATGCTTAACATAGG |
| | | | AACGGAATAAAGAACTGACAAA |
| | | | CTAGAGTGCAGAAGAGGAAGGT |
| | | | AGAATTCCCGGTGTAGCGGTGA |
| | | | AATGCGTAGATATCTGGAGGAA |
| | | | TACCAGTTGCGAAGGCGACCTT |
| | | | CTGGGCTGACACTGACACTGAG |
| | | | ATGCGAAAGCGTGGGGAGCAA |
| | | | ACAGGATTAGATACCCTGGTAG |
| | | | TCCACGCTGTAAACGATATCAA |
| | | | CTAGCCGTTGGATTCTTAAAGA |
| | | | ATTTTGTGGCGTAGCTAACGCG |
| | | | ATAAGTTGATCGCCTGGGGAGT |
| | | | ACGGTCGCAAGGCTAAAACTCA |
| | | | AATGAATTGACGGGGGCCCGCA |
| | | | CAAGCGGTGGAGCATGTGGTTT |
| | | | AATTCGATGCAACGCGCAAAAC |
| | | | CTTACCTACTCTTGACATCCAAA |
| | | | GTACTTTCCAGAGATGGAAGGG |
| | | | TGCCTTAGGGAACTTTGAGACA |
| | | | GGTGCTGCATGGCTGTCGTCAG |
| | | | CTCGTGTTGTGAAATGTTGGGT |
| | | | TAAGTCCCGTAACGAGCGCAAC |
| | | | CCTTGTCCTTAGTTGCCAACGC |
| | | | ATAAGGCGGGAACTTTAAGGAG |
| | | | ACTGCTGGTGATAAACCGGAGG |
| | | | AAGGTGGGGACGACGTCAAGT |
| | | | CATCATGGCCCTTAAGAGTAGG |
| | | | GCAACACACGTGCTACAATGGC |
| | | | AAAAACAAAGGGTCGCAAAATG |
| | | | GTAACATGAAGCTAATCCCAAA |
| | | | AAAATTGTCTTAGTTCGGATTGG |
| | | | AGTCTGAAACTCGACTCCATAA |
| | | | AGTCGGAATCGCTAGTAATCGT |
| | | | GAATCAGAATGTCACGGTGAAT |
| | | | ACGTTCTCGGGCCTTGTACACA |
| | | | CCGCCCGTCACACCATGGAAGT |
| | | | GAAATGCACCAGAAGTGGCAAG |
| | | | TTTAACCAAAAAACAGGAGAAC |
| | | | AGTCACTACGGTGTGGTTCATG |
| | | | ACTGGGGTGAAGTCGTAACAAG |
| | | | GTAGCTGTAGGGGAACCTGTGG |
| | | | CTGGATCACCTCCTTAA |
| | | | (SEQ ID NO: 10) |
| Buchnera aphidicola str. | Aphids | bacteriocytes | AGAGTTTGATCATGGCTCAGAT |
| APS (Acyrthosiphon | (Aphidoidea) | | TGAACGCTGGCGGCAAGCCTAA |
| pisum) | | | CACATGCAAGTCGAGCGGCAG |
| | | | CGAGAAGAGAGCTTGCTCTCTT |
| | | | TGTCGGCAAGCGGCAAACGGG |
| | | | TGAGTAATATCTGGGGATCTAC |
| | | | CCAAAAGAGGGGGATAACTACT |
| | | | AGAAATGGTAGCTAATACCGCA |
| | | | TAATGTTGAAAAACCAAAGTGG |
| | | | GGGACCTTTTGGCCTCATGCTT |
| | | | TTGGATGAACCCAGACGAGATT |
| | | | AGCTTGTTGGTAGAGTAATAGC |
| | | | CTACCAAGGCAACGATCTCTAG |
| | | | CTGGTCTGAGAGGATAACCAGC |
| | | | CACACTGGAACTGAGACACGGT |
| | | | CCAGACTCCTACGGGAGGCAG |
| | | | CAGTGGGGAATATTGCACAATG |
| | | | GGCGAAAGCCTGATGCAGCTAT |
| | | | GCCGCGTGTATGAAGAAGGCCT |
| | | | TAGGGTTGTAAAGTACTTTCAG |
| | | | CGGGGAGGAAAAAAATAAAACT |
| | | | AATAATTTTATTTCGTGACGTTA |
| | | | CCCGCAGAAGAAGCACCGGCT |
| | | | AACTCCGTGCCAGCAGCCGCG |
| | | | GTAATACGGAGGGTGCAAGCGT |
| | | | TAATCAGAATTACTGGGCGTAA |
| | | | AGAGCGCGTAGGTGGTTTTTTA |
| | | | AGTCAGGTGTGAAATCCCTAGG |
| | | | CTCAACCTAGGAACTGCATTTG |
| | | | AAACTGGAAAACTAGAGTTTCG |
| | | | TAGAGGGAGGTAGAATTCTAGG |
| | | | TGTAGCGGTGAAATGCGTAGAT |
| | | | ATCTGGAGGAATACCCGTGGCG |
| | | | AAAGCGGCCTCCTAAACGAAAA |
| | | | CTGACACTGAGGCGCGAAAGC |
| | | | GTGGGGAGCAAACAGGATTAGA |
| | | | TACCCTGGTAGTCCATGCCGTA |
| | | | AACGATGTCGACTTGGAGGTTG |
| | | | TTTCCAAGAGAAGTGACTTCCG |
| | | | AAGCTAACGCATTAAGTCGACC |
| | | | GCCTGGGGAGTACGGCCGCAA |
| | | | GGCTAAAACTCAAATGAATTGA |
| | | | CGGGGGCCCGCACAAGCGGTG |
| | | | GAGCATGTGGTTTAATTCGATG |
| | | | CAACGCGAAAAACCTTACCTGG |
| | | | TCTTGACATCCACAGAATTCTTT |
| | | | AGAAATAAAGAAGTGCCTTCGG |
| | | | GAGCTGTGAGACAGGTGCTGCA |
| | | | TGGCTGTCGTCAGCTCGTGTTG |
| | | | TGAAATGTTGGGTTAAGTCCCG |
| | | | CAACGAGCGCAACCCTTATCCC |
| | | | CTGTTGCCAGCGGTTCGGCCG |
| | | | GGAACTCAGAGGAGACTGCCG |
| | | | GTTATAAACCGGAGGAAGGTGG |
| | | | GGACGACGTCAAGTCATCATGG |
| | | | CCCTTACGACCAGGGCTACACA |
| | | | CGTGCTACAATGGTTTATACAAA |
| | | | GAGAAGCAAATCTGCAAAGACA |
| | | | AGCAAACCTCATAAAGTAAATC |
| | | | GTAGTCCGGACTGGAGTCTGCA |
| | | | ACTCGACTCCACGAAGTCGGAA |
| | | | TCGCTAGTAATCGTGGATCAGA |
| | | | ATGCCACGGTGAATACGTTCCC |
| | | | GGGCCTTGTACACACCGCCCGT |
| | | | CACACCATGGGAGTGGGTTGCA |
| | | | AAAGAAGCAGGTATCCTAACCC |
| | | | TTTAAAAGGAAGGCGCTTACCA |
| | | | CTTTGTGATTCATGACTGGGGT |
| | | | GAAGTCGTAACAAGGTAACCGT |
| | | | AGGGGAACCTGCGGTTGGATCA |
| | | | CCTCCTT (SEQ ID NO: 11) |
| Buchnera aphidicola str. | Aphids | bacteriocytes | AAACTGAAGAGTTTGATCATGG |
| Sg (Schizaphis | (Aphidoidea) | | CTCAGATTGAACGCTGGCGGCA |
| graminum) | | | AGCCTAACACATGCAAGTCGAG |
| | | | CGGCAGCGAAAAGAAAGCTTGC |
| | | | TTTCTTGTCGGCGAGCGGCAAA |
| | | | CGGGTGAGTAATATCTGGGGAT |
| | | | CTGCCCAAAAGAGGGGGATAAC |
| | | | TACTAGAAATGGTAGCTAATACC |
| | | | GCATAAAGTTGAAAAACCAAAG |
| | | | TGGGGGACCTTTTTTAAAGGCC |
| | | | TCATGCTTTTGGATGAACCCAG |
| | | | ACGAGATTAGCTTGTTGGTAAG |
| | | | GTAAAAGCTTACCAAGGCAACG |
| | | | ATCTCTAGCTGGTCTGAGAGGA |
| | | | TAACCAGCCACACTGGAACTGA |
| | | | GACACGGTCCAGACTCCTACGG |
| | | | GAGGCAGCAGTGGGGAATATTG |
| | | | CACAATGGGCGAAAGCCTGATG |
| | | | CAGCTATGCCGCGTGTATGAAG |
| | | | AAGGCCTTAGGGTTGTAAAGTA |
| | | | CTTTCAGCGGGGAGGAAAAAAT |
| | | | TAAAACTAATAATTTTATTTTGTG |
| | | | ACGTTACCCGCAGAAGAAGCAC |
| | | | CGGCTAACTCCGTGCCAGCAGC |
| | | | CGCGGTAATACGGAGGGTGCG |
| | | | AGCGTTAATCAGAATTACTGGG |
| | | | CGTAAAGAGCACGTAGGTGGTT |
| | | | TTTTAAGTCAGATGTGAAATCCC |
| | | | TAGGCTTAACCTAGGAACTGCA |
| | | | TTTGAAACTGAAATGCTAGAGTA |
| | | | TCGTAGAGGGAGGTAGAATTCT |
| | | | AGGTGTAGCGGTGAAATGCGTA |
| | | | GATATCTGGAGGAATACCCGTG |
| | | | GCGAAAGCGGCCTCCTAAACGA |
| | | | ATACTGACACTGAGGTGCGAAA |
| | | | GCGTGGGGAGCAAACAGGATTA |
| | | | GATACCCTGGTAGTCCATGCCG |
| | | | TAAACGATGTCGACTTGGAGGT |
| | | | TGTTTCCAAGAGAAGTGACTTC |
| | | | CGAAGCTAACGCGTTAAGTCGA |
| | | | CCGCCTGGGGAGTACGGCCGC |
| | | | AAGGCTAAAACTCAAATGAATTG |
| | | | ACGGGGGCCCGCACAAGCGGT |
| | | | GGAGCATGTGGTTTAATTCGAT |
| | | | GCAACGCGAAAAACCTTACCTG |
| | | | GTCTTGACATCCACAGAATTTTT |
| | | | TAGAAATAAAAAAGTGCCTTCG |
| | | | GGAACTGTGAGACAGGTGCTGC |
| | | | ATGGCTGTCGTCAGCTCGTGTT |
| | | | GTGAAATGTTGGGTTAAGTCCC |
| | | | GCAACGAGCGCAACCCTTATCC |
| | | | CCTGTTGCCAGCGGTTCGGCC |
| | | | GGGAACTCAGAGGAGACTGCC |
| | | | GGTTATAAACCGGAGGAAGGTG |
| | | | GGGACGACGTCAAGTCATCATG |
| | | | GCCCTTACGACCAGGGCTACAC |
| | | | ACGTGCTACAATGGTTTATACAA |
| | | | AGAGAAGCAAATCTGTAAAGAC |
| | | | AAGCAAACCTCATAAAGTAAATC |
| | | | GTAGTCCGGACTGGAGTCTGCA |
| | | | ACTCGACTCCACGAAGTCGGAA |
| | | | TCGCTAGTAATCGTGGATCAGA |
| | | | ATGCCACGGTGAATACGTTCCC |
| | | | GGGCCTTGTACACACCGCCCGT |
| | | | CACACCATGGGAGTGGGTTGCA |
| | | | AAAGAAGCAGATTTCCTAACCA |
| | | | CGAAAGTGGAAGGCGTCTACCA |
| | | | CTTTGTGATTCATGACTGGGGT |
| | | | GAAGTCGTAACAAGGTAACCGT |
| | | | AGGGGAACCTGCGGTTGGATCA |
| | | | CCTCCTTA (SEQ ID NO: 12) |
| Buchnera aphidicola str. | Aphids | bacteriocytes | ACTTAAAATTGAAGAGTTTGATC |
| Bp (Baizongia pistaciae) | (Aphidoidea) | | ATGGCTCAGATTGAACGCTGGC |
| | | | GGCAAGCTTAACACATGCAAGT |
| | | | CGAGCGGCATCGAAGAAAAGTT |
| | | | TACTTTTCTGGCGGCGAGCGGC |
| | | | AAACGGGTGAGTAACATCTGGG |
| | | | GATCTACCTAAAAGAGGGGGAC |
| | | | AACCATTGGAAACGATGGCTAA |
| | | | TACCGCATAATGTTTTTAAATAA |
| | | | ACCAAAGTAGGGGACTAAAATT |
| | | | TTTAGCCTTATGCTTTTAGATGA |
| | | | ACCCAGACGAGATTAGCTTGAT |
| | | | GGTAAGGTAATGGCTTACCAAG |
| | | | GCGACGATCTCTAGCTGGTCTG |
| | | | AGAGGATAACCAGCCACACTGG |
| | | | AACTGAGATACGGTCCAGACTC |
| | | | CTACGGGAGGCAGCAGTGGGG |
| | | | AATATTGCACAATGGGCTAAAG |
| | | | CCTGATGCAGCTATGCCGCGTG |
| | | | TATGAAGAAGGCCTTAGGGTTG |
| | | | TAAAGTACTTTCAGCGGGGAGG |
| | | | AAAGAATTATGTCTAATATACAT |
| | | | ATTTTGTGACGTTACCCGAAGA |
| | | | AGAAGCACCGGCTAACTCCGTG |
| | | | CCAGCAGCCGCGGTAATACGG |
| | | | AGGGTGCGAGCGTTAATCAGAA |
| | | | TTACTGGGCGTAAAGAGCACGT |
| | | | AGGCGGTTTATTAAGTCAGATG |
| | | | TGAAATCCCTAGGCTTAACTTAG |
| | | | GAACTGCATTTGAAACTAATAGA |
| | | | CTAGAGTCTCATAGAGGGAGGT |
| | | | AGAATTCTAGGTGTAGCGGTGA |
| | | | AATGCGTAGATATCTAGAGGAA |
| | | | TACCCGTGGCGAAAGCGACCTC |
| | | | CTAAATGAAAACTGACGCTGAG |
| | | | GTGCGAAAGCGTGGGGAGCAA |
| | | | ACAGGATTAGATACCCTGGTAG |
| | | | TCCATGCTGTAAACGATGTCGA |
| | | | CTTGGAGGTTGTTTCCTAGAGA |
| | | | AGTGGCTTCCGAAGCTAACGCA |
| | | | TTAAGTCGACCGCCTGGGGAGT |
| | | | ACGGTCGCAAGGCTAAAACTCA |
| | | | AATGAATTGACGGGGGCCCGCA |
| | | | CAAGCGGTGGAGCATGTGGTTT |
| | | | AATTCGATGCAACGCGAAGAAC |
| | | | CTTACCTGGTCTTGACATCCATA |
| | | | GAATTTTTTAGAGATAAAAGAGT |
| | | | GCCTTAGGGAACTATGAGACAG |
| | | | GTGCTGCATGGCTGTCGTCAGC |
| | | | TCGTGTTGTGAAATGTTGGGTT |
| | | | AAGTCCCGCAACGAGCGCAACC |
| | | | CCTATCCTTTGTTGCCATCAGGT |
| | | | TATGCTGGGAACTCAGAGGAGA |
| | | | CTGCCGGTTATAAACCGGAGGA |
| | | | AGGTGGGGATGACGTCAAGTCA |
| | | | TCATGGCCCTTACGACCAGGGC |
| | | | TACACACGTGCTACAATGGOAT |
| | | | ATACAAAGAGATGCAACTCTGC |
| | | | GAAGATAAGCAAACCTCATAAA |
| | | | GTATGTCGTAGTCCGGACTGGA |
| | | | GTCTGCAACTCGACTCCACGAA |
| | | | GTAGGAATCGCTAGTAATCGTG |
| | | | GATCAGAATGCCACGGTGAATA |
| | | | CGTTCCCGGGCCTTGTACACAC |
| | | | CGCCCGTCACACCATGGGAGT |
| | | | GGGTTGCAAAAGAAGCAGGTAG |
| | | | CTTAACCAGATTATTTTATTGGA |
| | | | GGGCGCTTACCACTTTGTGATT |
| | | | CATGACTGGGGTGAAGTCGTAA |
| | | | CAAGGTAACCGTAGGGGAACCT |
| | | | GCGGTTGGATCACCTCCTTA |
| | | | (SEQ ID NO: 37) |
| Buchnera aphidicola BCc | Aphids | bacteriocytes | ATGAGATCATTAATATATAAAAA |
| | (Aphidoidea) | | TCATGTTCCAATTAAAAAATTAG |
| | | | GACAAAATTTTTTACAGAATAAA |
| | | | GAAATTATTAATCAGATAATTAA |
| | | | TTTAATAAATATTAATAAAAATGA |
| | | | TAATATTATTGAAATAGGATCAG |
| | | | GATTAGGAGCGTTAACTTTTCCT |
| | | | ATTTGTAGAATCATTAAAAAAAT |
| | | | GATAGTATTAGAAATTGATGAAG |
| | | | ATCTTGTGTTTTTTTTAACTCAAA |
| | | | GTTTATTTATTAAAAAATTACAAA |
| | | | TTATAATTGCTGATATTATAAAAT |
| | | | TTGATTTTTGTTGTTTTTTTTCTT |
| | | | TACAGAAATATAAAAAATATAGG |
| | | | TTTATTGGTAATTTACCATATAAT |
| | | | ATTGCTACTATATTTTTTTTAAAA |
| | | | ACAATTAAATTTCTTTATAATATA |
| | | | ATTGATATGCATTTTATGTTTCA |
| | | | AAAAGAAGTAGCAAAGAGATTA |
| | | | TTAGCTACTCCTGGTACTAAAGA |
| | | | ATATGGTAGATTAAGTATTATTG |
| | | | CACAATATTTTTATAAGATAGAA |
| | | | ACTGTTATTAATGTTAATAAATTT |
| | | | AATTTTTTTCCTACTCCTAAAGT |
| | | | AGATTCTACTTTTTTACGATTTA |
| | | | CTCCTAAATATTTTAATAGTAAA |
| | | | TATAAAATAGATAAACATTTTTCT |
| | | | GTTTTAGAATTAATTACTAGATT |
| | | | TTCTTTTCAACATAGAAGAAAAT |
| | | | TTTTAAATAATAATTTAATATCTT |
| | | | TATTTTCTACAAAAGAATTAATTT |
| | | | CTTTAGATATTGATCCATATTCA |
| | | | AGAGCAGAAAATGTTTCTTTAAT |
| | | | TCAATATTGTAAATTAATGAAAT |
| | | | ATTATTTGAAAAGAAAAATTTTAT |
| | | | GTTTAGATTAA (SEQ ID NO: 13) |
| Buchnera aphidicola | Aphids | bacteriocytes | TTATCTTATTTCACATATACGTA |
| (Cinara tujafilina) | (Aphidoidea) | | ATATTGCGCTGCGTGCACGAGG |
| | | | ATTTTTTTGAATTTCAGATATATT |
| | | | TGGTTTAATACGTTTAATAAAAC |
| | | | GTATTTTTTTTTTTATTTTTCTTA |
| | | | TTTGCAATTCAGTAATAGGAAGT |
| | | | TTTTTAGGTATATTTGGATAATT |
| | | | ACTGTAATTCTTAATAAAGTTTTT |
| | | | TACAATCCTATCTTCAATAGAAT |
| | | | GAAAACTAATAATAGCAATTTTT |
| | | | GATCCGGAATGTAATATGTTAAT |
| | | | AATAATTTTTAATATTTTATGTAA |
| | | | TTCATTTATTTCTTGGTTAATATA |
| | | | TATTCGAAAAGCTTGAAATGTTC |
| | | | TCGTAGCTGGATGTTTAAATTTG |
| | | | TCATATTTTGGGATTGATTTTTTT |
| | | | ATGATTTGAACTAACTCTAACGT |
| | | | GCTTGTTATGGTTTTTTTTTTTAT |
| | | | TTGTAATATGATGGCTCGGGAT |
| | | | ATTTTTTTTGCGTATTTTTCTTCG |
| | | | CCAAAATTTTTTATTACCTGTTC |
| | | | TATTGTTTTTTGGTTTGTTTTTTT |
| | | | TAACCATTGACTAACTGATATTC |
| | | | CAGATTTAGGGTTCATACGCAT |
| | | | ATCTAAAGGTCCATCATTCATAA |
| | | | ATGAAAATCCTCGGATACTAGA |
| | | | ATTTAACTGTATTGAAGAAATAC |
| | | | CTAAATCTAATAATATTCCATCT |
| | | | ATTTTATCTCTATTTTTTTCTTTT |
| | | | TTTAATATTTTTTCAATATTAGAA |
| | | | AATTTACCTAAAAATATTTTAAAT |
| | | | CGCGAATCTTTTATTTTTTTTCC |
| | | | GATTTTTATAGATTGTGGGTCTT |
| | | | GATCAATACTATATAACTTTCCA |
| | | | TTAACCCCTAATTCTTGAAGAAT |
| | | | TGCTTTTGAATGACCACCACCT |
| | | | CCAAATGTACAATCAACATATGT |
| | | | ACCGTCTTTTTTTATTTTTAAGTA |
| | | | TTGTATGATTTCTTTTGTTAAAA |
| | | | CAGGTTTATGAATCAT |
| | | | (SEQ ID NO: 14) |
| Buchnera aphidicola str. | Aphids | bacteriocytes | ATGAAAAGTATAAAAACTTTTAA |
| G002 (Myzus persicae) | (Aphidoidea) | | AAAACACTTTCCTGTGAAAAAAT |
| | | | ATGGACAAAATTTTCTTATTAAT |
| | | | AAAGAGATCATAAAAAATATTGT |
| | | | TAAAAAAATTAATCCAAATATAG |
| | | | AACAAACATTAGTAGAAATCGG |
| | | | ACCAGGATTAGCTGCATTAACT |
| | | | GAGCCCATATCTCAGTTATTAAA |
| | | | AGAGTTAATAGTTATTGAAATAG |
| | | | ACTGTAATCTATTATATTTTTTAA |
| | | | AAAAACAACCATTTTATTCAAAA |
| | | | TTAATAGTTTTTTGTCAAGATGC |
| | | | TTTAAACTTTAATTATACAAATTT |
| | | | ATTTTATAAAAAAAATAAATTAAT |
| | | | TCGTATTTTTGGTAATTTACCAT |
| | | | ATAATATCTCTACATCTTTAATTA |
| | | | TTTTTTTATTTCAACACATTAGA |
| | | | GTAATTCAAGATATGAATTTTAT |
| | | | GCTTCAAAAAGAAGTTGCTGCA |
| | | | AGATTAATTGCATTACCTGGAAA |
| | | | TAAATATTACGGTCGTTTGAGCA |
| | | | TTATATCTCAATATTATTGTGATA |
| | | | TCAAAATTTTATTAAATGTTGCT |
| | | | CCTGAAGATTTTTGGCCTATTCC |
| | | | GAGAGTTCATTCTATATTTGTAA |
| | | | ATTTAACACCTCATCATAATTCT |
| | | | CCTTATTTTGTTTATGATATTAAT |
| | | | ATTTTAAGCCTTATTACAAATAA |
| | | | GGCTTTCCAAAATAGAAGAAAA |
| | | | ATATTACGTCATAGTTTAAAAAA |
| | | | TTTATTTTCTGAAACAACTTTATT |
| | | | AAATTTAGATATTAATCCCAGAT |
| | | | TAAGAGCTGAAAATATTTCTGTT |
| | | | TTTCAGTATTGTCAATTAGCTAA |
| | | | TTATTTGTATAAAAAAAATTATAC |
| | | | TAAAAAAAATTAA |
| | | | (SEQ ID NO: 15) |
| Buchnera aphidicola str. | Aphids | bacteriocytes | ATTATAAAAAATTTTAAAAAACAT |
| Ak (Acyrthosiphon | (Aphidoidea) | | TTTCCTTTAAAAAGGTATGGACA |
| kondoi) | | | AAATTTTCTTGTCAATACAAAAA |
| | | | CTATTCAAAAGATAATTAATATA |
| | | | ATTAATCCAAACACCAAACAAAC |
| | | | ATTAGTGGAAATTGGACCTGGA |
| | | | TTAGCTGCATTAACAAAACCAAT |
| | | | TTGTCAATTATTAGAAGAATTAA |
| | | | TTGTTATTGAAATAGATCCTAAT |
| | | | TTATTGTTTTTATTAAAAAAACGT |
| | | | TCATTTTATTCAAAATTAACAGTT |
| | | | TTTTATCAAGACGCTTTAAATTT |
| | | | CAATTATACAGATTTGTTTTATA |
| | | | AGAAAAATCAATTAATTCGTGTT |
| | | | TTTGGAAACTTGCCATATAATAT |
| | | | TTCTACATCTTTAATTATTTCTTT |
| | | | ATTCAATCATATTAAAGTTATTC |
| | | | AAGATATGAATTTTATGTTACAG |
| | | | AAAGAGGTTGCTGAAAGATTAA |
| | | | TTTCTATTCCTGGAAATAAATCT |
| | | | TATGGCCGTTTAAGCATTATTTC |
| | | | TCAGTATTATTGTAAAATTAAAA |
| | | | TATTATTAAATGTTGTACCTGAA |
| | | | GATTTTCGACCTATACCGAAAGT |
| | | | GCATTCTGTTTTTATCAATTTAA |
| | | | CTCCTCATACCAATTCTCCATAT |
| | | | TTTGTTTATGATACAAATATCCT |
| | | | CAGTTCTATCACAAGAAATGCTT |
| | | | TTCAAAATAGAAGGAAAATTTTG |
| | | | CGTCATAGTTTAAAAAATTTATT |
| | | | TTCTGAAAAAGAACTAATTCAAT |
| | | | TAGAAATTAATCCAAATTTACGA |
| | | | GCTGAAAATATTTCTATCTTTCA |
| | | | GTATTGTCAATTAGCTGATTATT |
| | | | TATATAAAAAATTAAATAATCTTG |
| | | | TAAAAATCAATTAA |
| | | | (SEQ ID NO: 16) |
| Buchnera aphidicola str. | Aphids | bacteriocytes | ATGATACTAAATAAATATAAAAA |
| Ua (Uroleucon | (Aphidoidea) | | ATTTATTCCTTTAAAAAGATACG |
| ambrosiae) | | | GACAAAATTTTCTTGTAAATAGA |
| | | | GAAATAATCAAAAATATTATCAA |
| | | | AATAATTAATCCTAAAAAAACGC |
| | | | AAACATTATTAGAAATTGGACCG |
| | | | GGTTTAGGTGCGTTAACAAAAC |
| | | | CTATTTGTGAATTTTTAAATGAA |
| | | | CTTATCGTCATTGAAATAGATCC |
| | | | TAATATATTATCTTTTTTAAAGAA |
| | | | ATGTATATTTTTTGATAAATTAAA |
| | | | AATATATTGTCATAATGCTTTAG |
| | | | ATTTTAATTATAAAAATATATTCT |
| | | | ATAAAAAAAGTCAATTAATTCGT |
| | | | ATTTTTGGAAATTTACCATATAA |
| | | | TATTTCTACATCTTTAATAATATA |
| | | | TTTATTTCGGAATATTGATATTAT |
| | | | TCAAGATATGAATTTTATGTTAC |
| | | | AACAAGAAGTGGCTAAAAGATT |
| | | | AGTTGCTATTCCTGGTGAAAAA |
| | | | CTTTATGGTCGTTTAAGTATTAT |
| | | | ATCTCAATATTATTGTAATATTAA |
| | | | AATATTATTACATATTCGACCTG |
| | | | AAAATTTTCAACCTATTCCTAAA |
| | | | GTTAATTCAATGTTTGTAAATTT |
| | | | AACTCCGCATATTCATTCTCCTT |
| | | | ATTTTGTTTATGATATTAATTTAT |
| | | | TAACTAGTATTACAAAACATGCT |
| | | | TTTCAACATAGAAGAAAAATATT |
| | | | GCGTCATAGTTTAAGAAATTTTT |
| | | | TTTCTGAGCAAGATTTAATTCAT |
| | | | TTAGAAATTAATCCAAATTTAAG |
| | | | AGCTGAAAATGTTTCTATTATTC |
| | | | AATATTGTCAATTGGCTAATAAT |
| | | | TTATATAAAAAACATAAACAGTT |
| | | | TATTAATAATTAA |
| | | | (SEQ ID NO: 17) |
| Buchnera aphidicola | Aphids | bacteriocytes | ATGAAAAAGCATATTCCTATAAA |
| (Aphis glycines) | (Aphidoidea) | | AAAATTTAGTCAAAATTTTCTTG |
| | | | TAGATTTGAGTGTGATTAAAAAA |
| | | | ATAATTAAATTTATTAATCCGCA |
| | | | GTTAAATGAAATATTGGTTGAAA |
| | | | TTGGACCGGGATTAGCTGCTAT |
| | | | CACTCGACCTATTTGTGATTTGA |
| | | | TAGATCATTTAATTGTGATTGAA |
| | | | ATTGATAAAATTTTATTAGATAG |
| | | | ATTAAAACAGTTCTCATTTTATT |
| | | | CAAAATTAACAGTATATCATCAA |
| | | | GATGCTTTAGCATTTGATTACAT |
| | | | AAAGTTATTTAATAAAAAAAATA |
| | | | AATTAGTTCGAATTTTTGGTAAT |
| | | | TTACCATATCATGTTTCTACGTC |
| | | | TTTAATATTGCATTTATTTAAAAG |
| | | | AATTAATATTATTAAAGATATGA |
| | | | ATTTTATGCTACAAAAAGAAGTT |
| | | | GCTGAACGTTTAATTGCAACTC |
| | | | CAGGTAGTAAATTATATGGTCGT |
| | | | TTAAGTATTATTTCTCAATATTAT |
| | | | TGTAATATAAAAGTTTTATTGCA |
| | | | TGTGTCTTCAAAATGTTTTAAAC |
| | | | CAGTTCCTAAAGTAGAATCAATT |
| | | | TTTCTTAATTTGACACCTTATAC |
| | | | TGATTATTTCCCTTATTTTACTTA |
| | | | TAATGTAAACGTTCTTAGTTATA |
| | | | TTACAAATTTAGCTTTTCAAAAA |
| | | | AGAAGAAAAATATTACGTCATAG |
| | | | TTTAGGTAAAATATTTTCTGAAA |
| | | | AAGTTTTTATAAAATTAAATATTA |
| | | | ATCCCAAATTAAGACCTGAGAAT |
| | | | ATTTCTATATTACAATATTGTCA |
| | | | GTTATCTAATTATATGATAGAAA |
| | | | ATAATATTCATCAGGAACATGTT |
| | | | TGTATTTAA |
| | | | (SEQ ID NO: 18) |
| Candidatus Annandia | (Phylloxeroidea) | bacteriocytes | AGATTGAACGCTGGCGGCATGC |
| pinicola | | | CTTACACATGCAAGTCGAACGG |
| | | | TAACAGGTCTTCGGACGCTGAC |
| | | | GAGTGGCGAACGGGTGAGTAAT |
| | | | ACATCGGAACGTGCCCAGTCGT |
| | | | GGGGGATAACTACTCGAAAGAG |
| | | | TAGCTAATACCGCATACGATCT |
| | | | GAGGATGAAAGCGGGGGACCT |
| | | | TCGGGCCTCGCGCGATTGGAG |
| | | | CGGCCGATGGCAGATTAGGTAG |
| | | | TTGGTGGGATAAAAGCTTACCA |
| | | | AGCCGACGATCTGTAGCTGGTC |
| | | | TGAGAGGACGACCAGCCACACT |
| | | | GGAACTGAGATACGGTCCAGAC |
| | | | TCTTACGGGAGGCAGCAGTGG |
| | | | GGAATATTGCACAATGGGCGCA |
| | | | AGCCTGATGCAGCTATGTCGCG |
| | | | TGTATGAAGAAGACCTTAGGGT |
| | | | TGTAAAGTACTTTCGATAGCATA |
| | | | AGAAGATAATGAGACTAATAATT |
| | | | TTATTGTCTGACGTTAGCTATAG |
| | | | AAGAAGCACCGGCTAACTCCGT |
| | | | GCCAGCAGCCGCGGTAATACG |
| | | | GGGGGTGCTAGCGTTAATCGGA |
| | | | ATTACTGGGCGTAAAGAGCATG |
| | | | TAGGTGGTTTATTAAGTCAGATG |
| | | | TGAAATCCCTGGACTTAATCTAG |
| | | | GAACTGCATTTGAAACTAATAG |
| | | | GCTAGAGTTTCGTAGAGGGAGG |
| | | | TAGAATTCTAGGTGTAGCGGTG |
| | | | AAATGCATAGATATCTAGAGGA |
| | | | ATATCAGTGGCGAAGGCGACCT |
| | | | TCTGGACGATAACTGACGCTAA |
| | | | AATGCGAAAGCATGGGTAGCAA |
| | | | ACAGGATTAGATACCCTGGTAG |
| | | | TCCATGCTGTAAACGATGTCGA |
| | | | CTAAGAGGTTGGAGGTATAACT |
| | | | TTTAATCTCTGTAGCTAACGCGT |
| | | | TAAGTCGACCGCCTGGGGAGTA |
| | | | CGGTCGCAAGGCTAAAACTCAA |
| | | | ATGAATTGACGGGGGCCTGCAC |
| | | | AAGCGGTGGAGCATGTGGTTTA |
| | | | ATTCGATGCAACGCGTAAAACC |
| | | | TTACCTGGTCTTGACATCCACA |
| | | | GAATTTTACAGAAATGTAGAAGT |
| | | | GCAATTTGAACTGTGAGACAGG |
| | | | TGCTGCATGGCTGTCGTCAGCT |
| | | | CGTGTTGTGAAATGTTGGGTTA |
| | | | AGTCCCGCAACGAGCGCAACC |
| | | | CTTGTCCTTTGTTACCATAAGAT |
| | | | TTAAGGAACTCAAAGGAGACTG |
| | | | CCGGTGATAAACTGGAGGAAGG |
| | | | CGGGGACGACGTCAAGTCATCA |
| | | | TGGCCCTTATGACCAGGGCTAC |
| | | | ACACGTGCTACAATGGCATATA |
| | | | CAAAGAGATGCAATATTGCGAA |
| | | | ATAAAGCCAATCTTATAAAATAT |
| | | | GTCCTAGTTCGGACTGGAGTCT |
| | | | GCAACTCGACTCCACGAAGTCG |
| | | | GAATCGCTAGTAATCGTGGATC |
| | | | AGCATGCCACGGTGAATATGTT |
| | | | TCCAGGCCTTGTACACACCGCC |
| | | | CGTCACACCATGGAAGTGGATT |
| | | | GCAAAAGAAGTAAGAAAATTAA |
| | | | CCTTCTTAACAAGGAAATAACTT |
| | | | ACCACTTTGTGACTCATAACTG |
| | | | GGGTGA |
| | | | (SEQ ID NO: 19) |
| Moranella endobia | (Coccoidea) | bacteriocytes | TCTTTTTGGTAAGGAGGTGATC |
| | | | CAACCGCAGGTTCCCCTACGGT |
| | | | TACCTTGTTACGACTTCACCCCA |
| | | | GTCATGAATCACAAAGTGGTAA |
| | | | GCGCCCTCCTAAAAGGTTAGGC |
| | | | TACCTACTTCTTTTGCAACCCAC |
| | | | TTCCATGGTGTGACGGGCGGTG |
| | | | TGTACAAGGCCCGGGAACGTAT |
| | | | TCACCGTGGCATTCTGATCCAC |
| | | | GATTACTAGCGATTCCTACTTCA |
| | | | TGGAGTCGAGTTGCAGACTCCA |
| | | | ATCCGGACTACGACGCACTTTA |
| | | | TGAGGTCCGCTAACTCTCGCGA |
| | | | GCTTGCTTCTCTTTGTATGCGC |
| | | | CATTGTAGCACGTGTGTAGCCC |
| | | | TACTCGTAAGGGCCATGATGAC |
| | | | TTGACGTCATCCCCACCTTCCT |
| | | | CCGGTTTATCACCGGCAGTCTC |
| | | | CTTTGAGTTCCCGACCGAATCG |
| | | | CTGGCAAAAAAGGATAAGGGTT |
| | | | GCGCTCGTTGCGGGACTTAACC |
| | | | CAACATTTCACAACACGAGCTG |
| | | | ACGACAGCCATGCAGCACCTGT |
| | | | CTCAGAGTTCCCGAAGGTACCA |
| | | | AAACATCTCTGCTAAGTTCTCTG |
| | | | GATGTCAAGAGTAGGTAAGGTT |
| | | | CTTCGCGTTGCATCGAATTAAA |
| | | | CCACATGCTCCACCGCTTGTGC |
| | | | GGGCCCCCGTCAATTCATTTGA |
| | | | GTTTTAACCTTGCGGCCGTACT |
| | | | CCCCAGGCGGTCGATTTAACGC |
| | | | GTTAACTACGAAAGCCACAGTT |
| | | | CAAGACCACAGCTTTCAAATCG |
| | | | ACATAGTTTACGGCGTGGACTA |
| | | | CCAGGGTATCTAATCCTGTTTG |
| | | | CTCCCCACGCTTTCGTACCTGA |
| | | | GCGTCAGTATTCGTCCAGGGGG |
| | | | CCGCCTTCGCCACTGGTATTCC |
| | | | TCCAGATATCTACACATTTCACC |
| | | | GCTACACCTGGAATTCTACCCC |
| | | | CCTCTACGAGACTCTAGCCTAT |
| | | | CAGTTTCAAATGCAGTTCCTAG |
| | | | GTTAAGCCCAGGGATTTCACAT |
| | | | CTGACTTAATAAACCGCCTACG |
| | | | TACTCTTTACGCCCAGTAATTCC |
| | | | GATTAACGCTTGCACCCTCCGT |
| | | | ATTACCGCGGCTGCTGGCACG |
| | | | GAGTTAGCCGGTGCTTCTTCTG |
| | | | TAGGTAACGTCAATCAATAACC |
| | | | GTATTAAGGATATTGCCTTCCTC |
| | | | CCTACTGAAAGTGCTTTACAAC |
| | | | CCGAAGGCCTTCTTCACACACG |
| | | | CGGCATGGCTGCATCAGGGTTT |
| | | | CCCCCATTGTGCAATATTCCCC |
| | | | ACTGCTGCCTCCCGTAGGAGTC |
| | | | TGGACCGTGTCTCAGTTCCAGT |
| | | | GTGGCTGGTCATCCTCTCAGAC |
| | | | CAGCTAGGGATCGTCGCCTAGG |
| | | | TAAGCTATTACCTCACCTACTAG |
| | | | CTAATCCCATCTGGGTTCATCT |
| | | | GAAGGTGTGAGGCCAAAAGGTC |
| | | | CCCCACTTTGGTCTTACGACATT |
| | | | ATGCGGTATTAGCTACCGTTTC |
| | | | CAGCAGTTATCCCCCTCCATCA |
| | | | GGCAGATCCCCAGACTTTACTC |
| | | | ACCCGTTCGCTGCTCGCCGGCA |
| | | | AAAAAGTAAACTTTTTTCCGTTG |
| | | | CCGCTCAACTTGCATGTGTTAG |
| | | | GCCTGCCGCCAGCGTTCAATCT |
| | | | GAGCCATGATCAAACTCTTCAAT |
| | | | TAAA (SEQ ID NO: 20) |
| Ishikawaella capsulata | (Heteroptera) | bacteriocytes | AAATTGAAGAGTTTGATCATGG |
| Mpkobe | | | CTCAGATTGAACGCTAGCGGCA |
| | | | AGCTTAACACATGCAAGTCGAA |
| | | | CGGTAACAGAAAAAAGCTTGCT |
| | | | TTTTTGCTGACGAGTGGCGGAC |
| | | | GGGTGAGTAATGTCTGGGGATC |
| | | | TACCTAATGGCGGGGGATAACT |
| | | | ACTGGAAACGGTAGCTAATACC |
| | | | GCATAATGTTGTAAAACCAAAGT |
| | | | GGGGGACCTTATGGCCTCACAC |
| | | | CATTAGATGAACCTAGATGGGA |
| | | | TTAGCTTGTAGGTGGGGTAAAG |
| | | | GCTCACCTAGGCAACGATCCCT |
| | | | AGCTGGTCTGAGAGGATGACCA |
| | | | GCCACACTGGAACTGAGATACG |
| | | | GTCCAGACTCCTACGGGAGGCA |
| | | | GCAGTGGGGAATCTTGCACAAT |
| | | | GGGCGCAAGCCTGATGCAGCT |
| | | | ATGTCGCGTGTATGAAGAAGGC |
| | | | CTTAGGGTTGTAAAGTACTTTCA |
| | | | TCGGGGAAGAAGGATATGAGCC |
| | | | TAATATTCTCATATATTGACGTT |
| | | | ACCTGCAGAAGAAGCACCGGCT |
| | | | AACTCCGTGCCAGCAGCCGCG |
| | | | GTAACACGGAGGGTGCGAGCG |
| | | | TTAATCGGAATTACTGGGCGTA |
| | | | AAGAGCACGTAGGTGGTTTATT |
| | | | AAGTCATATGTGAAATCCCTGG |
| | | | GCTTAACCTAGGAACTGCATGT |
| | | | GAAACTGATAAACTAGAGTTTC |
| | | | GTAGAGGGAGGTGGAATTCCAG |
| | | | GTGTAGCGGTGAAATGCGTAGA |
| | | | TATCTGGAGGAATATCAGAGGC |
| | | | GAAGGCGACCTTCTGGACGAAA |
| | | | ACTGACACTCAGGTGCGAAAGC |
| | | | GTGGGGAGCAAACAGGATTAGA |
| | | | TACCCTGGTAGTCCACGCTGTA |
| | | | AACAATGTCGACTAAAAAACTGT |
| | | | GAGCTTGACTTGTGGTTTTTGTA |
| | | | GCTAACGCATTAAGTCGACCGC |
| | | | CTGGGGAGTACGGCCGCAAGG |
| | | | TTAAAACTCAAATGAATTGACGG |
| | | | GGGTCCGCACAAGCGGTGGAG |
| | | | CATGTGGTTTAATTCGATGCAAC |
| | | | GCGAAAAACCTTACCTGGTCTT |
| | | | GACATCCAGCGAATTATATAGA |
| | | | AATATATAAGTGCCTTTCGGGG |
| | | | AACTCTGAGACGCTGCATGGCT |
| | | | GTCGTCAGCTCGTGTTGTGAAA |
| | | | TGTTGGGTTAAGTCCCGCAACG |
| | | | AGCGCCCTTATCCTCTGTTGCC |
| | | | AGCGGCATGGCCGGGAACTCA |
| | | | GAGGAGACTGCCAGTATTAAAC |
| | | | TGGAGGAAGGTGGGGATGACG |
| | | | TCAAGTCATCATGGCCCTTATG |
| | | | ACCAGGGCTACACACGTGCTAC |
| | | | AATGGTGTATACAAAGAGAAGC |
| | | | AATCTCGCAAGAGTAAGCAAAA |
| | | | CTCAAAAAGTACATCGTAGTTC |
| | | | GGATTAGAGTCTGCAACTCGAC |
| | | | TCTATGAAGTAGGAATCGCTAG |
| | | | TAATCGTGGATCAGAATGCCAC |
| | | | GGTGAATACGTTCTCTGGCCTT |
| | | | GTACACACCGCCCGTCACACCA |
| | | | TGGGAGTAAGTTGCAAAAGAAG |
| | | | TAGGTAGCTTAACCTTTATAGGA |
| | | | GGGCGCTTACCACTTTGTGATT |
| | | | TATGACTGGGGTGAAGTCGTAA |
| | | | CAAGGTAACTGTAGGGGAACCT |
| | | | GTGGTTGGATTACCTCCTTA |
| | | | (SEQ ID NO: 38) |
| Baumannia | sharpshooter | bacteriocytes | TTCAATTGAAGAGTTTGATCATG |
| cicadellinicola | leafhoppers | | GCTCAGATTGAACGCTGGCGGT |
| | (Cicadellinae) | | AAGCTTAACACATGCAAGTCGA |
| | | | GCGGCATCGGAAAGTAAATTAA |
| | | | TTACTTTGCCGGCAAGCGGCGA |
| | | | ACGGGTGAGTAATATCTGGGGA |
| | | | TCTACCTTATGGAGAGGGATAA |
| | | | CTATTGGAAACGATAGCTAACA |
| | | | CCGCATAATGTCGTCAGACCAA |
| | | | AATGGGGGACCTAATTTAGGCC |
| | | | TCATGCCATAAGATGAACCCAG |
| | | | ATGAGATTAGCTAGTAGGTGAG |
| | | | ATAATAGCTCACCTAGGCAACG |
| | | | ATCTCTAGTTGGTCTGAGAGGA |
| | | | TGACCAGCCACACTGGAACTGA |
| | | | GACACGGTCCAGACTCCTACGG |
| | | | GAGGCAGCAGTGGGGAATCTT |
| | | | GCACAATGGGGGAAACCCTGAT |
| | | | GCAGCTATACCGCGTGTGTGAA |
| | | | GAAGGCCTTCGGGTTGTAAAGC |
| | | | ACTTTCAGCGGGGAAGAAAATG |
| | | | AAGTTACTAATAATAATTGTCAA |
| | | | TTGACGTTACCCGCAAAAGAAG |
| | | | CACCGGCTAACTCCGTGCCAGC |
| | | | AGCCGCGGTAAGACGGAGGGT |
| | | | GCAAGCGTTAATCGGAATTACT |
| | | | GGGCGTAAAGCGTATGTAGGC |
| | | | GGTTTATTTAGTCAGGTGTGAAA |
| | | | GCCCTAGGCTTAACCTAGGAAT |
| | | | TGCATTTGAAACTGGTAAGCTA |
| | | | GAGTCTCGTAGAGGGGGGGAG |
| | | | AATTCCAGGTGTAGCGGTGAAA |
| | | | TGCGTAGAGATCTGGAAGAATA |
| | | | CCAGTGGCGAAGGCGCCCCCC |
| | | | TGGACGAAAACTGACGCTCAAG |
| | | | TACGAAAGCGTGGGGAGCAAAC |
| | | | AGGATTAGATACCCTGGTAGTC |
| | | | CACGCTGTAAACGATGTCGATT |
| | | | TGAAGGTTGTAGCCTTGAGCTA |
| | | | TAGCTTTCGAAGCTAACGCATTA |
| | | | AATCGACCGCCTGGGGAGTAC |
| | | | GACCGCAAGGTTAAAACTCAAA |
| | | | TGAATTGACGGGGGCCCGCAC |
| | | | AAGCGGTGGAGCATGTGGTTTA |
| | | | ATTCGATACAACGCGAAAAACC |
| | | | TTACCTACTCTTGACATCCAGAG |
| | | | TATAAAGCAGAAAAGCTTTAGTG |
| | | | CCTTCGGGAACTCTGAGACAGG |
| | | | TGCTGCATGGCTGTCGTCAGCT |
| | | | CGTGTTGTGAAATGTTGGGTTA |
| | | | AGTCCCGCAACGAGCGCAACC |
| | | | CTTATCCTTTGTTGCCAACGATT |
| | | | AAGTCGGGAACTCAAAGGAGAC |
| | | | TGCCGGTGATAAACCGGAGGAA |
| | | | GGTGAGGATAACGTCAAGTCAT |
| | | | CATGGCCCTTACGAGTAGGGCT |
| | | | ACACACGTGCTACAATGGTGCA |
| | | | TACAAAGAGAAGCAATCTCGTA |
| | | | AGAGTTAGCAAACCTCATAAAG |
| | | | TGCATCGTAGTCCGGATTAGAG |
| | | | TCTGCAACTCGACTCTATGAAG |
| | | | TCGGAATCGCTAGTAATCGTGG |
| | | | ATCAGAATGCCACGGTGAATAC |
| | | | GTTCCCGGGCCTTGTACACACC |
| | | | GCCCGTCACACCATGGGAGTGT |
| | | | ATTGCAAAAGAAGTTAGTAGCTT |
| | | | AACTCATAATACGAGAGGGCGC |
| | | | TTACCACTTTGTGATTCATAACT |
| | | | GGGGTGAAGTCGTAACAAGGTA |
| | | | ACCGTAGGGGAACCTGCGGTT |
| | | | GGATCACCTCCTTACACTAAA |
| | | | (SEQ ID NO: 21) |
| Sodalis-like bacterium | Rhopalus | wider tissue | ATTGAACGCTGGCGGCAGGCCT |
| | sapporensis | tropism | AACACATGCAAGTCGAGCGGCA |
| | | | GCGGGAAGAAGCTTGCTTCTTT |
| | | | GCCGGCGAGCGGCGGACGGGT |
| | | | GAGTAATGTCTGGGGATCTGCC |
| | | | CGATGGAGGGGGATAACTACTG |
| | | | GAAACGGTAGCTAATACCGCAT |
| | | | AACGTCGCAAGACCAAAGTGGG |
| | | | GGACCTTCGGGCCTCACACCAT |
| | | | CGGATGAACCCAGGTGGGATTA |
| | | | GCTAGTAGGTGGGGTAATGGCT |
| | | | CACCTAGGCGACGATCCCTAGC |
| | | | TGGTCTGAGAGGATGACCAGTC |
| | | | ACACTGGAACTGAGACACGGTC |
| | | | CAGACTCCTACGGGAGGCAGC |
| | | | AGTGGGGAATATTGCACAATGG |
| | | | GGGAAACCCTGATGCAGCCATG |
| | | | CCGCGTGTGTGAAGAAGGCCTT |
| | | | CGGGTTGTAAAGCACTTTCAGC |
| | | | GGGGAGGAAGGCGATGGCGTT |
| | | | AATAGCGCTATCGATTGACGTT |
| | | | ACCCGCAGAAGAAGCACCGGC |
| | | | TAACTCCGTGCCAGCAGCCGCG |
| | | | GTAATACGGAGGGTGCGAGCG |
| | | | TTAATCGGAATTACTGGGCGTA |
| | | | AAGCGTACGCAGGCGGTCTGTT |
| | | | AAGTCAGATGTGAAATCCCCGG |
| | | | GCTCAACCTGGGAACTGCATTT |
| | | | GAAACTGGCAGGCTAGAGTCTC |
| | | | GTAGAGGGGGGTAGAATTCCAG |
| | | | GTGTAGCGGTGAAATGCGTAGA |
| | | | GATCTGGAGGAATACCGGTGGC |
| | | | GAAGGCGGCCCCCTGGACGAA |
| | | | GACTGACGCTCAGGTACGAAAG |
| | | | CGTGGGGAGCAAACAGGATTAG |
| | | | ATACCCTGGTAGTCCACGCTGT |
| | | | AAACGATGTCGATTTGAAGGTT |
| | | | GTGGCCTTGAGCCGTGGCTTTC |
| | | | GGAGCTAACGTGTTAAATCGAC |
| | | | CGCCTGGGGAGTACGGCCGCA |
| | | | AGGTTAAAACTCAAATGAATTGA |
| | | | CGGGGGCCCGCACAAGCGGTG |
| | | | GAGCATGTGGTTTAATTCGATG |
| | | | CAACGCGAAGAACCTTACCTAC |
| | | | TCTTGACATCCAGAGAACTTGG |
| | | | CAGAGATGCTTTGGTGCCTTCG |
| | | | GGAACTCTGAGACAGGTGCTGC |
| | | | ATGGCTGTCGTCAGCTCGTGTT |
| | | | GTGAAATGTTGGGTTAAGTCCC |
| | | | GCAACGAGCGCAACCCTTATCC |
| | | | TTTATTGCCAGCGATTCGGTCG |
| | | | GGAACTCAAAGGAGACTGCCG |
| | | | GTGATAAACCGGAGGAAGGTG |
| | | | GGGATGACGTCAAGTCATCATG |
| | | | GCCCTTACGAGTAGGGCTACAC |
| | | | ACGTGCTACAATGGCGCATACA |
| | | | AAGAGAAGCGATCTCGCGAGAG |
| | | | TCAGCGGACCTCATAAAGTGCG |
| | | | TCGTAGTCCGGATTGGAGTCTG |
| | | | CAACTCGACTCCATGAAGTCGG |
| | | | AATCGCTAGTAATCGTGGATCA |
| | | | GAATGCCACGGTGAATACGTTC |
| | | | CCGGGCCTTGTACACACCGCCC |
| | | | GTCACACCATGGGAGTGGGTTG |
| | | | CAAAAGAAGTAGGTAGCTTAAC |
| | | | CTTCGGGAGGGCGCTTACCACT |
| | | | TTGTGATTCATGACTGGGGTG |
| | | | (SEQ ID NO: 22) |
| Candidatus Hartigia | The pine bark | bacteriocytes | AGATTTAACGCTGGCGGCAGGC |
| pinicola | adelgid | | CTAACACATGCAAGTCGAGCGG |
| | | | TACCAGAAGAAGCTTGCTTCTT |
| | | | GCTGACGAGCGGCGGACGGGT |
| | | | GAGTAATGTATGGGGATCTGCC |
| | | | CGACAGAGGGGGATAACTATTG |
| | | | GAAACGGTAGCTAATACCGCAT |
| | | | AATCTCTGAGGAGCAAAGCAGG |
| | | | GGAACTTCGGTCCTTGCGCTAT |
| | | | CGGATGAACCCATATGGGATTA |
| | | | GCTAGTAGGTGAGGTAATGGCT |
| | | | CCCCTAGGCAACGATCCCTAGC |
| | | | TGGTCTGAGAGGATGATCAGCC |
| | | | ACACTGGGACTGAGACACGGC |
| | | | CCAGACTCCTACGGGAGGCAG |
| | | | CAGTGGGGAATATTGCACAATG |
| | | | GGCGAAAGCCTGATGCAGCCAT |
| | | | GCCGCGTGTATGAAGAAGGCTT |
| | | | TAGGGTTGTAAAGTACTTTCAGT |
| | | | CGAGAGGAAAACATTGATGCTA |
| | | | ATATCATCAATTATTGACGTTTC |
| | | | CGACAGAAGAAGCACCGGCTAA |
| | | | CTCCGTGCCAGCAGCCGCGGT |
| | | | AATACGGAGGGTGCAAGCGTTA |
| | | | ATCGGAATTACTGGGCGTAAAG |
| | | | CGCACGCAGGCGGTTAATTAAG |
| | | | TTAGATGTGAAAGCCCCGGGCT |
| | | | TAACCCAGGAATAGCATATAAAA |
| | | | CTGGTCAACTAGAGTATTGTAG |
| | | | AGGGGGGTAGAATTCCATGTGT |
| | | | AGCGGTGAAATGCGTAGAGATG |
| | | | TGGAGGAATACCAGTGGCGAAG |
| | | | GCGGCCCCCTGGACAAAAACTG |
| | | | ACGCTCAAATGCGAAAGCGTGG |
| | | | GGAGCAAACAGGATTAGATACC |
| | | | CTGGTAGTCCATGCTGTAAACG |
| | | | ATGTCGATTTGGAGGTTGTTCC |
| | | | CTTGAGGAGTAGCTTCCGTAGC |
| | | | TAACGCGTTAAATCGACCGCCT |
| | | | GGGGGAGTACGACTGCAAGGT |
| | | | TAAAACTCAAATGAATTGACGG |
| | | | GGGCCCGCACAAGCGGTGGAG |
| | | | CATGTGGTTTAATTCGATGCAAC |
| | | | GCGAAAAACCTTACCTACTCTT |
| | | | GACATCCAGATAATTTAGCAGA |
| | | | AATGCTTTAGTACCTTCGGGAA |
| | | | ATCTGAGACAGGTGCTGCATGG |
| | | | CTGTCGTCAGCTCGTGTTGTGA |
| | | | AATGTTGGGTTAAGTCCCGCAA |
| | | | CGAGCGCAACCCTTATCCTTTG |
| | | | TTGCCAGCGATTAGGTCGGGAA |
| | | | CTCAAAGGAGACTGCCGGTGAT |
| | | | AAACCGGAGGAAGGTGGGGAT |
| | | | GACGTCAAGTCATCATGGCCCT |
| | | | TACGAGTAGGGCTACACACGTG |
| | | | CTACAATGGCATATACAAAGGG |
| | | | AAGCAACCTCGCGAGAGCAAGC |
| | | | GAAACTCATAAATTATGTCGTAG |
| | | | TTCAGATTGGAGTCTGCAACTC |
| | | | GACTCCATGAAGTCGGAATCGC |
| | | | TAGTAATCGTAGATCAGAATGCT |
| | | | ACGGTGAATACGTTCCCGGGCC |
| | | | TTGTACACACCGCCCGTCACAC |
| | | | CATGGGAGTGGGTTGCAAAAGA |
| | | | AGTAGGTAACTTAACCTTATGGA |
| | | | AAGCGCTTACCACTTTGTGATTC |
| | | | ATAACTGGGGTG |
| | | | (SEQ ID NO: 23) |
| Wigglesworthia | tsetse fly | bacteriocytes | |
| glossinidia | (Diptera: | | |
| | Glossinidae) | | |
| Beta proteobacteria | | | |
| Tremblaya phenacola | Phenacoccus | bacteriomes | AGGTAATCCAGCCACACCTTCC |
| | avenae | | AGTACGGCTACCTTGTTACGAC |
| | (TPPAVE). | | TTCACCCCAGTCACAACCCTTA |
| | | | CCTTCGGAACTGCCCTCCTCAC |
| | | | AACTCAAACCACCAAACACTTTT |
| | | | AAATCAGGTTGAGAGAGGTTAG |
| | | | GCCTGTTACTTCTGGCAAGAAT |
| | | | TATTTCCATGGTGTGACGGGCG |
| | | | GTGTGTACAAGACCCGAGAACA |
| | | | TATTCACCGTGGCATGCTGATC |
| | | | CACGATTACTAGCAATTCCAACT |
| | | | TCATGCACTCGAGTTTCAGAGT |
| | | | ACAATCCGAACTGAGGCCGGCT |
| | | | TTGTGAGATTAGCTCCCTTTTGC |
| | | | AAGTTGGCAACTCTTTGGTCCG |
| | | | GCCATTGTATGATGTGTGAAGC |
| | | | CCCACCCATAAAGGCCATGAGG |
| | | | ACTTGACGTCATCCCCACCTTC |
| | | | CTCCAACTTATCGCTGGCAGTC |
| | | | TCTTTAAGGTAACTGACTAATCC |
| | | | AGTAGCAATTAAAGACAGGGGT |
| | | | TGCGCTCGTTACAGGACTTAAC |
| | | | CCAACATCTCACGACACGAGCT |
| | | | GACGACAGCCATGCAGCACCTG |
| | | | TGCACTAATTCTCTTTCAAGCAC |
| | | | TCCCGCTTCTCAACAGGATCTT |
| | | | AGCCATATCAAAGGTAGGTAAG |
| | | | GTTTTTCGCGTTGCATCGAATTA |
| | | | ATCCACATCATCCACTGCTTGT |
| | | | GCGGGTCCCCGTCAATTCCTTT |
| | | | GAGTTTTAACCTTGCGGCCGTA |
| | | | CTCCCCAGGCGGTCGACTTGTG |
| | | | CGTTAGCTGCACCACTGAAAAG |
| | | | GAAAACTGCCCAATGGTTAGTC |
| | | | AACATCGTTTAGGGCATGGACT |
| | | | ACCAGGGTATCTAATCCTGTTT |
| | | | GCTCCCCATGCTTTAGTGTCTG |
| | | | AGCGTCAGTAACGAACCAGGAG |
| | | | GCTGCCTACGCTTTCGGTATTC |
| | | | CTCCACATCTCTACACATTTCAC |
| | | | TGCTACATGCGGAATTCTACCT |
| | | | CCCCCTCTCGTACTCCAGCCTG |
| | | | CCAGTAACTGCCGCATTCTGAG |
| | | | GTTAAGCCTCAGCCTTTCACAG |
| | | | CAATCTTAACAGGCAGCCTGCA |
| | | | CACCCTTTACGCCCAATAAATCT |
| | | | GATTAACGCTCGCACCCTACGT |
| | | | ATTACCGCGGCTGCTGGCACGT |
| | | | AGTTTGCCGGTGCTTATTCTTTC |
| | | | GGTACAGTCACACCACCAAATT |
| | | | GTTAGTTGGGTGGCTTTCTTTC |
| | | | CGAACAAAAGTGCTTTACAACC |
| | | | CAAAGGCCTTCTTCACACACGC |
| | | | GGCATTGCTGGATCAGGCTTCC |
| | | | GCCCATTGTCCAAGATTCCTCA |
| | | | CTGCTGCCTTCCTCAGAAGTCT |
| | | | GGGCCGTGTCTCAGTCCCAGTG |
| | | | TGGCTGGCCGTCCTCTCAGACC |
| | | | AGCTACCGATCATTGCCTTGGG |
| | | | AAGCCATTACCTTTCCAACAAG |
| | | | CTAATCAGACATCAGCCAATCT |
| | | | CAGAGCGCAAGGCAATTGGTCC |
| | | | CCTGCTTTCATTCTGCTTGGTAG |
| | | | AGAACTTTATGCGGTATTAATTA |
| | | | GGCTTTCACCTAGCTGTCCCCC |
| | | | ACTCTGAGGCATGTTCTGATGC |
| | | | ATTACTCACCCGTTTGCCACTTG |
| | | | CCACCAAGCCTAAGCCCGTGTT |
| | | | GCCGTTCGACTTGCATGTGTAA |
| | | | GGCATGCCGCTAGCGTTCAATC |
| | | | TGAGCCAGGATCAAACTCT |
| | | | (SEQ ID NO: 24) |
| Candidatus Tremblaya | citrus mealybug | bacteriomes | AGAGTTTGATCCTGGCTCAGAT |
| princeps | Planococcus citri | | TGAACGCTAGCGGCATGCATTA |
| | | | CACATGCAAGTCGTACGGCAGC |
| | | | ACGGGCTTAGGCCTGGTGGCG |
| | | | AGTGGCGAACGGGTGAGTAAC |
| | | | GCCTCGGAACGTGCCTTGTAGT |
| | | | GGGGGATAGCCTGGCGAAAGC |
| | | | CAGATTAATACCGCATGAAGCC |
| | | | GCACAGCATGCGCGGTGAAAGT |
| | | | GGGGGATTCTAGCCTCACGCTA |
| | | | CTGGATCGGCCGGGGTCTGATT |
| | | | AGCTAGTTGGCGGGGTAATGGC |
| | | | CCACCAAGGCTTAGATCAGTAG |
| | | | CTGGTCTGAGAGGACGATCAGC |
| | | | CACACTGGGACTGAGACACGG |
| | | | CCCAGACTCCTACGGGAGGCA |
| | | | GCAGTGGGGAATCTTGGACAAT |
| | | | GGGCGCAAGCCTGATCCAGCA |
| | | | ATGCCGCGTGTGTGAAGAAGGC |
| | | | CTTCGGGTCGTAAAGCACTTTT |
| | | | GTTCGGGATGAAGGGGGGCGT |
| | | | GCAAACACCATGCCCTCTTGAC |
| | | | GATACCGAAAGAATAAGCACCG |
| | | | GCTAACTACGTGCCAGCAGCCG |
| | | | CGGTAATACGTAGGGTGCGAGC |
| | | | GTTAATCGGAATCACTGGGCGT |
| | | | AAAGGGTGCGCGGGTGGTTTG |
| | | | CCAAGACCCCTGTAAAATCCTA |
| | | | CGGCCCAACCGTAGTGCTGCG |
| | | | GAGGTTACTGGTAAGCTTGAGT |
| | | | ATGGCAGAGGGGGGTAGAATTC |
| | | | CAGGTGTAGCGGTGAAATGCGT |
| | | | AGATATCTGGAGGAATACCGAA |
| | | | GGCGAAGGCAACCCCCTGGGC |
| | | | CATCACTGACACTGAGGCACGA |
| | | | AAGCGTGGGGAGCAAACAGGA |
| | | | TTAGATACCCTGGTAGTCCACG |
| | | | CCCTAAACCATGTCGACTAGTT |
| | | | GTCGGGGGGAGCCCTTTTTCCT |
| | | | CGGTGACGAAGCTAACGCATGA |
| | | | AGTCGACCGCCTGGGGAGTAC |
| | | | GACCGCAAGGTTAAAACTCAAA |
| | | | GGAATTGACGGGGACCCGCAC |
| | | | AAGCGGTGGATGATGTGGATTA |
| | | | ATTCGATGCAACGCGAAAAACC |
| | | | TTACCTACCCTTGACATGGCGG |
| | | | AGATTCTGCCGAGAGGCGGAA |
| | | | GTGCTCGAAAGAGAATCCGTGC |
| | | | ACAGGTGCTGCATGGCTGTCGT |
| | | | CAGCTCGTGTCGTGAGATGTTG |
| | | | GGTTAAGTCCCATAACGAGCGC |
| | | | AACCCCCGTCTTTAGTTGCTAC |
| | | | CACTGGGGCACTCTATAGAGAC |
| | | | TGCCGGTGATAAACCGGAGGAA |
| | | | GGTGGGGACGACGTCAAGTCAT |
| | | | CATGGCCTTTATGGGTAGGGCT |
| | | | TCACACGTCATACAATGGCTGG |
| | | | AGCAAAGGGTCGCCAACTCGAG |
| | | | AGAGGGAGCTAATCCCACAAAC |
| | | | CCAGCCCCAGTTCGGATTGCAC |
| | | | TCTGCAACTCGAGTGCATGAAG |
| | | | TCGGAATCGCTAGTAATCGTGG |
| | | | ATCAGCATGCCACGGTGAATAC |
| | | | GTTCTCGGGTCTTGTACACACC |
| | | | GCCCGTCACACCATGGGAGTAA |
| | | | GCCGCATCAGAAGCAGCCTCCC |
| | | | TAACCCTATGCTGGGAAGGAGG |
| | | | CTGCGAAGGTGGGGTCTATGAC |
| | | | TGGGGTGAAGTCGTAACAAGGT |
| | | | AGCCGTACCGGAAGGTGCGGC |
| | | | TGGATTACCT |
| | | | (SEQ ID NO: 25) |
| Vidania | | bacteriomes | |
| Nasuia deltocephalinicola | pestiferous insect | bacteriomes | AGTTTAATCCTGGCTCAGATTTA |
| | host, Macrosteles | | ACGCTTGCGACATGCCTAACAC |
| | quadripunctulatus | | ATGCAAGTTGAACGTTGAAAATA |
| | (Hemiptera: | | TTTCAAAGTAGCGTATAGGTGA |
| | Cicadellidae) | | GTATAACATTTAAACATACCTTA |
| | | | AAGTTCGGAATACCCCGATGAA |
| | | | AATCGGTATAATACCGTATAAAA |
| | | | GTATTTAAGAATTAAAGCGGGG |
| | | | AAAACCTCGTGCTATAAGATTGT |
| | | | TAAATGCCTGATTAGTTTGTTGG |
| | | | TTTTTAAGGTAAAAGCTTACCAA |
| | | | GACTTTGATCAGTAGCTATTCTG |
| | | | TGAGGATGTATAGCCACATTGG |
| | | | GATTGAAATAATGCCCAAACCT |
| | | | CTACGGAGGGCAGCAGTGGGG |
| | | | AATATTGGACAATGAGCGAAAG |
| | | | CTTGATCCAGCAATGTCGCGTG |
| | | | TGCGATTAAGGGAAACTGTAAA |
| | | | GCACTTTTTTTTAAGAATAAGAA |
| | | | ATTTTAATTAATAATTAAAATTTT |
| | | | TGAATGTATTAAAAGAATAAGTA |
| | | | CCGACTAATCACGTGCCAGCAG |
| | | | TCGCGGTAATACGTGGGGTGC |
| | | | GAGCGTTAATCGGATTTATTGG |
| | | | GCGTAAAGTGTATTCAGGCTGC |
| | | | TTAAAAAGATTTATATTAAATATT |
| | | | TAAATTAAATTTAAAAAATGTATA |
| | | | AATTACTATTAAGCTAGAGTTTA |
| | | | GTATAAGAAAAAAGAATTTTATG |
| | | | TGTAGCAGTGAAATGCGTTGAT |
| | | | ATATAAAGGAACGCCGAAAGCG |
| | | | AAAGCATTTTTCTGTAATAGAAC |
| | | | TGACGCTTATATACGAAAGCGT |
| | | | GGGTAGCAAACAGGATTAGATA |
| | | | CCCTGGTAGTCCACGCCCTAAA |
| | | | CTATGTCAATTAACTATTAGAAT |
| | | | TTTTTTTAGTGGTGTAGCTAACG |
| | | | CGTTAAATTGACCGCCTGGGTA |
| | | | TTACGATCGCAAGATTAAAACTC |
| | | | AAAGGAATTGACGGGGACCAGC |
| | | | ACAAGCGGTGGATGATGTGGAT |
| | | | TAATTCGATGATACGCGAAAAA |
| | | | CCTTACCTGCCCTTGACATGGT |
| | | | TAGAATTTTATTGAAAAATAAAA |
| | | | GTGCTTGGAAAAGAGCTAACAC |
| | | | ACAGGTGCTGCATGGCTGTCGT |
| | | | CAGCTCGTGTCGTGAGATGTTG |
| | | | GGTTAAGTCCCGCAACGAGCGC |
| | | | AACCCCTACTCTTAGTTGCTAAT |
| | | | TAAAGAACTTTAAGAGAACAGCT |
| | | | AACAATAAGTTTAGAGGAAGGA |
| | | | GGGGATGACTTCAAGTCCTCAT |
| | | | GGCCCTTATGGGCAGGGCTTCA |
| | | | CACGTCATACAATGGTTAATACA |
| | | | AAAAGTTGCAATATCGTAAGATT |
| | | | GAGCTAATCTTTAAAATTAATCT |
| | | | TAGTTCGGATTGTACTCTGCAA |
| | | | CTCGAGTACATGAAGTTGGAAT |
| | | | CGCTAGTAATCGCGGATCAGCA |
| | | | TGCCGCGGTGAATAGTTTAACT |
| | | | GGTCTTGTACACACCGCCCGTC |
| | | | ACACCATGGAAATAAATCTTGTT |
| | | | TTAAATGAAGTAATATATTTTATC |
| | | | AAAACAGGTTTTGTAACCGGGG |
| | | | TGAAGTCGTAACA |
| | | | (SEQ ID NO: 26) |
| Candidatus Zinderia | spittlebug | bacteriocytes | ATATAAATAAGAGTTTGATCCTG |
| insecticola CARI | Clastoptera | | GCTCAGATTGAACGCTAGCGGT |
| | arizonana | | ATGCTTTACACATGCAAGTCGA |
| | | | ACGACAATATTAAAGCTTGCTTT |
| | | | AATATAAAGTGGCGAACGGGTG |
| | | | AGTAATATATCAAAACGTACCTT |
| | | | AAAGTGGGGGATAACTAATTGA |
| | | | AAAATTAGATAATACCGCATATT |
| | | | AATCTTAGGATGAAAATAGGAAT |
| | | | AATATCTTATGCTTTTAGATCGG |
| | | | TTGATATCTGATTAGCTAGTTGG |
| | | | TAGGGTAAATGCTTACCAAGGC |
| | | | AATGATCAGTAGCTGGTTTTAG |
| | | | CGAATGATCAGCCACACTGGAA |
| | | | CTGAGACACGGTCCAGACTTCT |
| | | | ACGGAAGGCAGCAGTGGGGAA |
| | | | TATTGGACAATGGGAGAAATCC |
| | | | TGATCCAGCAATACCGCGTGAG |
| | | | TGATGAAGGCCTTAGGGTCGTA |
| | | | AAACTCTTTTGTTAGGAAAGAAA |
| | | | TAATTTTAAATAATATTTAAAATT |
| | | | GATGACGGTACCTAAAGAATAA |
| | | | GCACCGGCTAACTACGTGCCAG |
| | | | CAGCCGCGGTAATACGTAGGGT |
| | | | GCAAGCGTTAATCGGAATTATT |
| | | | GGGCGTAAAGAGTGCGTAGGC |
| | | | TGTTATATAAGATAGATGTGAAA |
| | | | TACTTAAGCTTAACTTAAGAACT |
| | | | GCATTTATTACTGTTTAACTAGA |
| | | | GTTTATTAGAGAGAAGTGGAATT |
| | | | TTATGTGTAGCAGTGAAATGCG |
| | | | TAGATATATAAAGGAATATCGAT |
| | | | GGCGAAGGCAGCTTCTTGGAAT |
| | | | AATACTGACGCTGAGGCACGAA |
| | | | AGCGTGGGGAGCAAACAGGATT |
| | | | AGATACCCTGGTAGTCCACGCC |
| | | | CTAAACTATGTCTACTAGTTATT |
| | | | AAATTAAAAATAAAATTTAGTAA |
| | | | CGTAGCTAACGCATTAAGTAGA |
| | | | CCGCCTGGGGAGTACGATCGC |
| | | | AAGATTAAAACTCAAAGGAATTG |
| | | | ACGGGGACCCGCACAAGCGGT |
| | | | GGATGATGTGGATTAATTCGAT |
| | | | GCAACACGAAAAACCTTACCTA |
| | | | CTCTTGACATGTTTGGAATTTTA |
| | | | AAGAAATTTAAAAGTGCTTGAAA |
| | | | AAGAACCAAAACACAGGTGCTG |
| | | | CATGGCTGTCGTCAGCTCGTGT |
| | | | CGTGAGATGTTGGGTTAAGTCC |
| | | | CGCAACGAGCGCAACCCTTGTT |
| | | | ATTATTTGCTAATAAAAAGAACT |
| | | | TTAATAAGACTGCCAATGACAAA |
| | | | TTGGAGGAAGGTGGGGATGAC |
| | | | GTCAAGTCCTCATGGCCCTTAT |
| | | | GAGTAGGGCTTCACACGTCATA |
| | | | CAATGATATATACAATGGGTAG |
| | | | CAAATTTGTGAAAATGAGCCAAT |
| | | | CCTTAAAGTATATCTTAGTTCGG |
| | | | ATTGTAGTCTGCAACTCGACTA |
| | | | CATGAAGTTGGAATCGCTAGTA |
| | | | ATCGCGGATCAGCATGCCGCG |
| | | | GTGAATACGTTCTCGGGTCTTG |
| | | | TACACACCGCCCGTCACACCAT |
| | | | GGAAGTGATTTTTACCAGAAATT |
| | | | ATTTGTTTAACCTTTATTGGAAA |
| | | | AAAATAATTAAGGTAGAATTCAT |
| | | | GACTGGGGTGAAGTCGTAACAA |
| | | | GGTAGCAGTATCGGAAGGTGC |
| | | | GGCTGGATTACATTTTAAAT |
| | | | (SEQ ID NO: 27) |
| Profftella armatura | Diaphorina citri, | bacteriomes | |
| | the Asian citrus | | |
| | psyllid | | |
| Alpha proteobacteria | | | |
| Hodgkinia | Cicada | bacteriome | AATGCTGGCGGCAGGCCTAACA |
| | Diceroprocta | | CATGCAAGTCGAGCGGACAACG |
| | semicincta | | TTCAAACGTTGTTAGCGGCGAA |
| | | | CGGGTGAGTAATACGTGAGAAT |
| | | | CTACCCATCCCAACGTGATAAC |
| | | | ATAGTCAACACCATGTCAATAAC |
| | | | GTATGATTCCTGCAACAGGTAA |
| | | | AGATTTTATCGGGGATGGATGA |
| | | | GCTCACGCTAGATTAGCTAGTT |
| | | | GGTGAGATAAAAGCCCACCAAG |
| | | | GCCAAGATCTATAGCTGGTCTG |
| | | | GAAGGATGGACAGCCACATTGG |
| | | | GACTGAGACAAGGCCCAACCCT |
| | | | CTAAGGAGGGCAGCAGTGAGG |
| | | | AATATTGGACAATGGGCGTAAG |
| | | | CCTGATCCAGCCATGCCGCATG |
| | | | AGTGATTGAAGGTCCAACGGAC |
| | | | TGTAAAACTCTTTTCTCCAGAGA |
| | | | TCATAAATGATAGTATCTGGTGA |
| | | | TATAAGCTCCGGCCAACTTCGT |
| | | | GCCAGCAGCCGCGGTAATACG |
| | | | AGGGGAGCGAGTATTGTTCGGT |
| | | | TTTATTGGGCGTAAAGGGTGTC |
| | | | CAGGTTGCTAAGTAAGTTAACA |
| | | | ACAAAATCTTGAGATTCAACCTC |
| | | | ATAACGTTCGGTTAATACTACTA |
| | | | AGCTCGAGCTTGGATAGAGACA |
| | | | AACGGAATTCCGAGTGTAGAGG |
| | | | TGAAATTCGTTGATACTTGGAG |
| | | | GAACACCAGAGGCGAAGGCGG |
| | | | TTTGTCATACCAAGCTGACACT |
| | | | GAAGACACGAAAGCATGGGGA |
| | | | GCAAACAGGATTAGATACCCTG |
| | | | GTAGTCCATGCCCTAAACGTTG |
| | | | AGTGCTAACAGTTCGATCAAGC |
| | | | CACATGCTATGATCCAGGATTG |
| | | | TACAGCTAACGCGTTAAGCACT |
| | | | CCGCCTGGGTATTACGACCGCA |
| | | | AGGTTAAAACTCAAAGGAATTG |
| | | | ACGGAGACCCGCACAAGCGGT |
| | | | GGAGCATGTGGTTTAATTCGAA |
| | | | GCTACACGAAGAACCTTACCAG |
| | | | CCCTTGACATACCATGGCCAAC |
| | | | CATCCTGGAAACAGGATGTTGT |
| | | | TCAAGTTAAACCCTTGAAATGCC |
| | | | AGGAACAGGTGCTGCATGGCTG |
| | | | TTGTCAGTTCGTGTCGTGAGAT |
| | | | GTATGGTTAAGTCCCAAAACGA |
| | | | ACACAACCCTCACCCATAGTTG |
| | | | CCATAAACACAATTGGGTTCTCT |
| | | | ATGGGTACTGCTAACGTAAGTT |
| | | | AGAGGAAGGTGAGGACCACAA |
| | | | CAAGTCATCATGGCCCTTATGG |
| | | | GCTGGGCCACACACATGCTACA |
| | | | ATGGTGGTTACAAAGAGCCGCA |
| | | | ACGTTGTGAGACCGAGCAAATC |
| | | | TCCAAAGACCATCTCAGTCCGG |
| | | | ATTGTACTCTGCAACCCGAGTA |
| | | | CATGAAGTAGGAATCGCTAGTA |
| | | | ATCGTGGATCAGCATGCCACGG |
| | | | TGAATACGTTCTCGGGTCTTGT |
| | | | ACACGCCGCCCGTCACACCATG |
| | | | GGAGCTTCGCTCCGATCGAAGT |
| | | | CAAGTTACCCTTGACCACATCTT |
| | | | GGCAAGTGACCGA |
| | | | (SEQ ID NO: 28) |
| Wolbachia strain wPip | Mosquito | bacteriome | AAATTTGAGAGTTTGATCCTGG |
| | Culex | | CTCAGAATGAACGCTGGCGGCA |
| | quinquefasciatus | | GGCCTAACACATGCAAGTCGAA |
| | | | CGGAGTTATATTGTAGCTTGCTA |
| | | | TGGTATAACTTAGTGGCAGACG |
| | | | GGTGAGTAATGTATAGGAATCT |
| | | | ACCTAGTAGTACGGAATAATTGT |
| | | | TGGAAACGACAACTAATACCGT |
| | | | ATACGCCCTACGGGGGAAAAAT |
| | | | TTATTGCTATTAGATGAGCCTAT |
| | | | ATTAGATTAGCTAGTTGGTGGG |
| | | | GTAATAGCCTACCAAGGTAATG |
| | | | ATCTATAGCTGATCTGAGAGGA |
| | | | TGATCAGCCACACTGGAACTGA |
| | | | GATACGGTCCAGACTCCTACGG |
| | | | GAGGCAGCAGTGGGGAATATTG |
| | | | GACAATGGGCGAAAGCCTGATC |
| | | | CAGCCATGCCGCATGAGTGAAG |
| | | | AAGGCCTTTGGGTTGTAAAGCT |
| | | | CTTTTAGTGAGGAAGATAATGA |
| | | | CGGTACTCACAGAAGAAGTCCT |
| | | | GGCTAACTCCGTGCCAGCAGCC |
| | | | GCGGTAATACGGAGAGGGCTA |
| | | | GCGTTATTCGGAATTATTGGGC |
| | | | GTAAAGGGCGCGTAGGCTGGTT |
| | | | AATAAGTTAAAAGTGAAATCCCG |
| | | | AGGCTTAACCTTGGAATTGCTTT |
| | | | TAAAACTATTAATCTAGAGATTG |
| | | | AAAGAGGATAGAGGAATTCCTG |
| | | | ATGTAGAGGTAAAATTCGTAAAT |
| | | | ATTAGGAGGAACACCAGTGGCG |
| | | | AAGGCGTCTATCTGGTTCAAAT |
| | | | CTGACGCTGAAGCGCGAAGGC |
| | | | GTGGGGAGCAAACAGGATTAGA |
| | | | TACCCTGGTAGTCCACGCTGTA |
| | | | AACGATGAATGTTAAATATGGG |
| | | | GAGTTTACTTTCTGTATTACAGC |
| | | | TAACGCGTTAAACATTCCGCCT |
| | | | GGGGACTACGGTCGCAAGATTA |
| | | | AAACTCAAAGGAATTGACGGGG |
| | | | ACCCGCACAAGCGGTGGAGCA |
| | | | TGTGGTTTAATTCGATGCAACG |
| | | | CGAAAAACCTTACCACTTCTTGA |
| | | | CATGAAAATCATACCTATTCGAA |
| | | | GGGATAGGGTCGGTTCGGCCG |
| | | | GATTTTACACAAGTGTTGCATG |
| | | | GCTGTCGTCAGCTCGTGTCGTG |
| | | | AGATGTTGGGTTAAGTCCCGCA |
| | | | ACGAGCGCAACCCTCATCCTTA |
| | | | GTTGCCATCAGGTAATGCTGAG |
| | | | TACTTTAAGGAAACTGCCAGTG |
| | | | ATAAGCTGGAGGAAGGTGGGG |
| | | | ATGATGTCAAGTCATCATGGCC |
| | | | TTTATGGAGTGGGCTACACACG |
| | | | TGCTACAATGGTGTCTACAATG |
| | | | GGCTGCAAGGTGCGCAAGCCT |
| | | | AAGCTAATCCCTAAAAGACATCT |
| | | | CAGTTCGGATTGTACTCTGCAA |
| | | | CTCGAGTACATGAAGTTGGAAT |
| | | | CGCTAGTAATCGTGGATCAGCA |
| | | | TGCCACGGTGAATACGTTCTCG |
| | | | GGTCTTGTACACACTGCCCGTC |
| | | | ACGCCATGGGAATTGGTTTCAC |
| | | | TCGAAGCTAATGGCCTAACCGC |
| | | | AAGGAAGGAGTTATTTAAAGTG |
| | | | GGATCAGTGACTGGGGTGAAGT |
| | | | CGTAACAAGGTAGCAGTAGGGG |
| | | | AATCTGCAGCTGGATTACCTCC |
| | | | TTA |
| | | | (SEQ ID NO: 29) |
| Bacteroidetes | | | |
| Candidatus Uzinura | armoured scale | bacteriocytes | AAAGGAGATATTCCAACCACAC |
| diaspidicola | insects | | CTTCCGGTACGGTTACCTTGTT |
| | | | ACGACTTAGCCCTAGTCATCAA |
| | | | GTTTACCTTAGGCAGACCACTG |
| | | | AAGGATTACTGACTTCAGGTAC |
| | | | CCCCGACTCCCATGGCTTGACG |
| | | | GGCGGTGTGTACAAGGTTCGAG |
| | | | AACATATTCACCGCGCCATTGC |
| | | | TGATGCGCGATTACTAGCGATT |
| | | | CCTGCTTCATAGAGTCGAATTG |
| | | | CAGACTCCAATCCGAACTGAGA |
| | | | CTGGTTTTAGAGATTAGCTCCT |
| | | | GATCACCCAGTGGCTGCCCTTT |
| | | | GTAACCAGCCATTGTAGCACGT |
| | | | GTGTAGCCCAAGGCATAGAGGC |
| | | | CATGATGATTTGACATCATCCCC |
| | | | ACCTTCCTCACAGTTTACACCG |
| | | | GCAGTTTTGTTAGAGTCCCCGG |
| | | | CTTTACCCGATGGCAACTAACA |
| | | | ATAGGGGTTGCGCTCGTTATAG |
| | | | GACTTAACCAAACACTTCACAG |
| | | | CACGAACTGAAGACAACCATGC |
| | | | AGCACCTTGTAATACGTCGTATA |
| | | | GACTAAGCTGTTTCCAGCTTATT |
| | | | CGTAATACATTTAAGCCTTGGTA |
| | | | AGGTTCCTCGCGTATCATCGAA |
| | | | TTAAACCACATGCTCCACCGCT |
| | | | TGTGCGAACCCCCGTCAATTCC |
| | | | TTTGAGTTTCAATCTTGCGACTG |
| | | | TACTTCCCAGGTGGATCACTTAT |
| | | | CGCTTTCGCTAAGCCACTGAAT |
| | | | ATCGTTTTTCCAATAGCTAGTGA |
| | | | TCATCGTTTAGGGCGTGGACTA |
| | | | CCAGGGTATCTAATCCTGTTTG |
| | | | CTCCCCACGCTTTCGTGCACTG |
| | | | AGCGTCAGTAAAGATTTAGCAA |
| | | | CCTGCCTTCGCTATCGGTGTTC |
| | | | TGTATGATATCTATGCATTTCAC |
| | | | CGCTACACCATACATTCCAGAT |
| | | | GCTCCAATCTTACTCAAGTTTAC |
| | | | CAGTATCAATAGCAATTTTACAG |
| | | | TTAAGCTGTAAGCTTTCACTACT |
| | | | GACTTAATAAACAGCCTACACA |
| | | | CCCTTTAAACCCAATAAATCCGA |
| | | | ATAACGCTTGTGTCATCCGTATT |
| | | | GCCGCGGCTGCTGGCACGGAA |
| | | | TTAGCCGACACTTATTCGTATAG |
| | | | TACCTTCAATCTCCTATCACGTA |
| | | | AGATATTTTATTTCTATACAAAA |
| | | | GCAGTTTACAACCTAAAAGACC |
| | | | TTCATCCTGCACGCGACGTAGC |
| | | | TGGTTCAGAGTTTCCTCCATTGA |
| | | | CCAATATTCCTCACTGCTGCCT |
| | | | CCCGTAGGAGTCTGGTCCGTGT |
| | | | CTCAGTACCAGTGTGGAGGTAC |
| | | | ACCCTCTTAGGCCCCCTACTGA |
| | | | TCATAGTCTTGGTAGAGCCATTA |
| | | | CCTCACCAACTAACTAATCAAAC |
| | | | GCAGGCTCATCTTTTGCCACCT |
| | | | AAGTTTTAATAAAGGCTCCATGC |
| | | | AGAAACTTTATATTATGGGGGAT |
| | | | TAATCAGAATTTCTTCTGGCTAT |
| | | | ACCCCAGCAAAAGGTAGATTGC |
| | | | ATACGTGTTACTCACCCATTCG |
| | | | CCGGTCGCCGACAAATTAAAAA |
| | | | TTTTTCGATGCCCCTCGACTTG |
| | | | CATGTGTTAAGCTCGCCGCTAG |
| | | | CGTTAATTCTGAGCCAGGATCA |
| | | | AACTCTTCGTTGTAG |
| | | | (SEQ ID NO: 30) |
| Sulcia muelleri | Blue-Green | bacteriocytes | CTCAGGATAAACGCTAGCGGAG |
| | Sharpshooter | | GGCTTAACACATGCAAGTCGAG |
| | and several other | | GGGCAGCAAAAATAATTATTTTT |
| | leafhopper | | GGCGACCGGCAAACGGGTGAG |
| | species | | TAATACATACGTAACTTTCCTTA |
| | | | TGCTGAGGAATAGCCTGAGGAA |
| | | | ACTTGGATTAATACCTCATAATA |
| | | | CAATTTTTTAGAAAGAAAAATTG |
| | | | TTAAAGTTTTATTATGGCATAAG |
| | | | ATAGGCGTATGTCCAATTAGTTA |
| | | | GTTGGTAAGGTAATGGCTTACC |
| | | | AAGACGATGATTGGTAGGGGGC |
| | | | CTGAGAGGGGCGTTCCCCCAC |
| | | | ATTGGTACTGAGACACGGACCA |
| | | | AACTTCTACGGAAGGCTGCAGT |
| | | | GAGGAATATTGGTCAATGGAGG |
| | | | AAACTCTGAACCAGCCACTCCG |
| | | | CGTGCAGGATGAAAGAAAGCCT |
| | | | TATTGGTTGTAAACTGCTTTTGT |
| | | | ATATGAATAAAAAATTCTAATTAT |
| | | | AGAAATAATTGAAGGTAATATAC |
| | | | GAATAAGTATCGACTAACTCTGT |
| | | | GCCAGCAGTCGCGGTAAGACA |
| | | | GAGGATACAAGCGTTATCCGGA |
| | | | TTTATTGGGTTTAAAGGGTGCG |
| | | | TAGGCGGTTTTTAAAGTCAGTA |
| | | | GTGAAATCTTAAAGCTTAACTTT |
| | | | AAAAGTGCTATTGATACTGAAAA |
| | | | ACTAGAGTAAGGTTGGAGTAAC |
| | | | TGGAATGTGTGGTGTAGCGGTG |
| | | | AAATGCATAGATATCACACAGAA |
| | | | CACCGATAGCGAAAGCAAGTTA |
| | | | CTAACCCTATACTGACGCTGAG |
| | | | TCACGAAAGCATGGGGAGCAAA |
| | | | CAGGATTAGATACCCTGGTAGT |
| | | | CCATGCCGTAAACGATGATCAC |
| | | | TAACTATTGGGTTTTATACGTTG |
| | | | TAATTCAGTGGTGAAGCGAAAG |
| | | | TGTTAAGTGATCCACCTGAGGA |
| | | | GTACGACCGCAAGGTTGAAACT |
| | | | CAAAGGAATTGACGGGGGCCC |
| | | | GCACAATCGGTGGAGCATGTGG |
| | | | TTTAATTCGATGATACACGAGGA |
| | | | ACCTTACCAAGACTTAAATGTAC |
| | | | TACGAATAAATTGGAAACAATTT |
| | | | AGTCAAGCGACGGAGTACAAGG |
| | | | TGCTGCATGGTTGTCGTCAGCT |
| | | | CGTGCCGTGAGGTGTAAGGTTA |
| | | | AGTCCTTTAAACGAGCGCAACC |
| | | | CTTATTATTAGTTGCCATCGAGT |
| | | | AATGTCAGGGGACTCTAATAAG |
| | | | ACTGCCGGCGCAAGCCGAGAG |
| | | | GAAGGTGGGGATGACGTCAAAT |
| | | | CATCACGGCCCTTACGTCTTGG |
| | | | GCCACACACGTGCTACAATGAT |
| | | | CGGTACAAAAGGGAGCGACTG |
| | | | GGTGACCAGGAGCAAATCCAGA |
| | | | AAGCCGATCTAAGTTCGGATTG |
| | | | GAGTCTGAAACTCGACTCCATG |
| | | | AAGCTGGAATCGCTAGTAATCG |
| | | | TGCATCAGCCATGGCACGGTGA |
| | | | ATATGTTCCCGGGCCTTGTACA |
| | | | CACCGCCCGTCAAGCCATGGAA |
| | | | GTTGGAAGTACCTAAAGTTGGT |
| | | | TCGCTACCTAAGGTAAGTCTAAT |
| | | | AACTGGGGCTAAGTCGTAACAA |
| | | | GGTA |
| | | | (SEQ ID NO: 31) |
| Yeast like | | | |
| Symbiotaphrina buchneri | Anobiid beetles | mycetome | AGATTAAGCCATGCAAGTCTAA |
| voucher JCM9740 | Stegobium | between the | GTATAAGNAATCTATACNGTGAA |
| | paniceum | foregut and | ACTGCGAATGGCTCATTAAATC |
| | | midgut | AGTTATCGTTTATTTGATAGTAC |
| | | | CTTACTACATGGATAACCGTGG |
| | | | TAATTCTAGAGCTAATACATGCT |
| | | | AAAAACCCCGACTTCGGAAGGG |
| | | | GTGTATTTATTAGATAAAAAACC |
| | | | AATGCCCTTCGGGGCTCCTTGG |
| | | | TGATTCATGATAACTTAACGAAT |
| | | | CGCATGGCCTTGCGCCGGCGA |
| | | | TGGTTCATTCAAATTTCTGCCCT |
| | | | ATCAACTTTCGATGGTAGGATA |
| | | | GTGGCCTACCATGGTTTTAACG |
| | | | GGTAACGGGGAATTAGGGTTCG |
| | | | ATTCCGGAGAGGGAGCCTGAG |
| | | | AAACGGCTACCACATCCAAGGA |
| | | | AGGCAGCAGGCGCGCAAATTAC |
| | | | CCAATCCCGACACGGGGAGGT |
| | | | AGTGACAATAAATACTGATACAG |
| | | | GGCTCTTTTGGGTCTTGTAATTG |
| | | | GAATGAGTACAATTTAAATCCCT |
| | | | TAACGAGGAACAATTGGAGGGC |
| | | | AAGTCTGGTGCCAGCAGCCGC |
| | | | GGTAATTCCAGCTCCAATAGCG |
| | | | TATATTAAAGTTGTTGCAGTTAA |
| | | | AAAGCTCGTAGTTGAACCTTGG |
| | | | GCCTGGCTGGCCGGTCCGCCT |
| | | | AACCGCGTGTACTGGTCCGGCC |
| | | | GGGCCTTTCCTTCTGGGGAGCC |
| | | | GCATGCCCTTCACTGGGTGTGT |
| | | | CGGGGAACCAGGACTTTTACTT |
| | | | TGAAAAAATTAGAGTGTTCAAAG |
| | | | CAGGCCTATGCTCGAATACATT |
| | | | AGCATGGAATAATAGAATAGGA |
| | | | CGTGCGGTTCTATTTTGTTGGTT |
| | | | TCTAGGACCGCCGTAATGATTA |
| | | | ATAGGGATAGTCGGGGGCATCA |
| | | | GTATTCAATTGTCAGAGGTGAA |
| | | | ATTCTTGGATTTATTGAAGACTA |
| | | | ACTACTGCGAAAGCATTTGCCA |
| | | | AGGATGTTTTCATTAATCAGTGA |
| | | | ACGAAAGTTAGGGGATCGAAGA |
| | | | CGATCAGATACCGTCGTAGTCT |
| | | | TAACCATAAACTATGCCGACTA |
| | | | GGGATCGGGCGATGTTATTATT |
| | | | TTGACTCGCTCGGCACCTTACG |
| | | | AGAAATCAAAGTCTTTGGGTTCT |
| | | | GGGGGGAGTATGGTCGCAAGG |
| | | | CTGAAACTTAAAGAAATTGACG |
| | | | GAAGGGCACCACCAGGAGTGG |
| | | | AGCCTGCGGCTTAATTTGACTC |
| | | | AACACGGGGAAACTCACCAGGT |
| | | | CCAGACACATTAAGGATTGACA |
| | | | GATTGAGAGCTCTTTCTTGATTA |
| | | | TGTGGGTGGTGGTGCATGGCC |
| | | | GTTCTTAGTTGGTGGAGTGATTT |
| | | | GTCTGCTTAATTGCGATAACGA |
| | | | ACGAGACCTTAACCTGCTAAAT |
| | | | AGCCCGGTCCGCTTTGGCGGG |
| | | | CCGCTGGCTTCTTAGAGGGACT |
| | | | ATCGGCTCAAGCCGATGGAAGT |
| | | | TTGAGGCAATAACAGGTCTGTG |
| | | | ATGCCCTTAGATGTTCTGGGCC |
| | | | GCACGCGCGCTACACTGACAGA |
| | | | GCCAACGAGTAAATCACCTTGG |
| | | | CCGGAAGGTCTGGGTAATCTTG |
| | | | TTAAACTCTGTCGTGCTGGGGA |
| | | | TAGAGCATTGCAATTATTGCTCT |
| | | | TCAACGAGGAATTCCTAGTAAG |
| | | | CGCAAGTCATCAGCTTGCGCTG |
| | | | ATTACGTCCCTGCCCTTTGTACA |
| | | | CACCGCCCGTCGCTACTACCGA |
| | | | TTGAATGGCTCAGTGAGGCCTT |
| | | | CGGACTGGCACAGGGACGTTG |
| | | | GCAACGACGACCCAGTGCCGG |
| | | | AAAGTTGGTCAAACTTGGTCATT |
| | | | TAGAGGAAGTAAAAGTCGTAAC |
| | | | AAGGTTTCCGTAGGTGAACCTG |
| | | | CGGAAGGATCATTA |
| | | | (SEQ ID NO: 32) |
| Symbiotaphrina kochii | Anobiid beetles | mycetome | TACCTGGTTGATTCTGCCAGTA |
| voucher CBS 589.63 | Lasioderma | | GTCATATGCTTGTCTCAAAGATT |
| | serricome | | AAGCCATGCAAGTCTAAGTATA |
| | | | AGCAATCTATACGGTGAAACTG |
| | | | CGAATGGCTCATTAAATCAGTTA |
| | | | TCGTTTATTTGATAGTACCTTAC |
| | | | TACATGGATAACCGTGGTAATT |
| | | | CTAGAGCTAATACATGCTAAAAA |
| | | | CCTCGACTTCGGAAGGGGTGTA |
| | | | TTTATTAGATAAAAAACCAATGC |
| | | | CCTTCGGGGCTCCTTGGTGATT |
| | | | CATGATAACTTAACGAATCGCAT |
| | | | GGCCTTGCGCCGGCGATGGTT |
| | | | CATTCAAATTTCTGCCCTATCAA |
| | | | CTTTCGATGGTAGGATAGTGGC |
| | | | CTACCATGGTTTCAACGGGTAA |
| | | | CGGGGAATTAGGGTTCGATTCC |
| | | | GGAGAGGGAGCCTGAGAAACG |
| | | | GCTACCACATCCAAGGAAGGCA |
| | | | GCAGGCGCGCAAATTACCCAAT |
| | | | CCCGACACGGGGAGGTAGTGA |
| | | | CAATAAATACTGATACAGGGCT |
| | | | CTTTTGGGTCTTGTAATTGGAAT |
| | | | GAGTACAATTTAAATCCCTTAAC |
| | | | GAGGAACAATTGGAGGGCAAGT |
| | | | CTGGTGCCAGCAGCCGCGGTA |
| | | | ATTCCAGCTCCAATAGCGTATAT |
| | | | TAAAGTTGTTGCAGTTAAAAAGC |
| | | | TCGTAGTTGAACCTTGGGCCTG |
| | | | GCTGGCCGGTCCGCCTAACCG |
| | | | CGTGTACTGGTCCGGCCGGGC |
| | | | CTTTCCTTCTGGGGAGCCGCAT |
| | | | GCCCTTCACTGGGTGTGTCGGG |
| | | | GAACCAGGACTTTTACTTTGAAA |
| | | | AAATTAGAGTGTTCAAAGCAGG |
| | | | CCTATGCTCGAATACATTAGCAT |
| | | | GGAATAATAGAATAGGACGTGT |
| | | | GGTTCTATTTTGTTGGTTTCTAG |
| | | | GACCGCCGTAATGATTAATAGG |
| | | | GATAGTCGGGGGCATCAGTATT |
| | | | CAATTGTCAGAGGTGAAATTCTT |
| | | | GGATTTATTGAAGACTAACTACT |
| | | | GCGAAAGCATTTGCCAAGGATG |
| | | | TTTTCATTAATCAGTGAACGAAA |
| | | | GTTAGGGGATCGAAGACGATCA |
| | | | GATACCGTCGTAGTCTTAACCA |
| | | | TAAACTATGCCGACTAGGGATC |
| | | | GGGCGATGTTATTATTTTGACTC |
| | | | GCTCGGCACCTTACGAGAAATC |
| | | | AAAGTCTTTGGGTTCTGGGGGG |
| | | | AGTATGGTCGCAAGGCTGAAAC |
| | | | TTAAAGAAATTGACGGAAGGGC |
| | | | ACCACCAGGAGTGGAGCCTGC |
| | | | GGCTTAATTTGACTCAACACGG |
| | | | GGAAACTCACCAGGTCCAGACA |
| | | | CATTAAGGATTGACAGATTGAG |
| | | | AGCTCTTTCTTGATTATGTGGGT |
| | | | GGTGGTGCATGGCCGTTCTTAG |
| | | | TTGGTGGAGTGATTTGTCTGCT |
| | | | TAATTGCGATAACGAACGAGAC |
| | | | CTTAACCTGCTAAATAGCCCGG |
| | | | TCCGCTTTGGCGGGCCGCTGG |
| | | | CTTCTTAGAGGGACTATCGGCT |
| | | | CAAGCCGATGGAAGTTTGAGGC |
| | | | AATAACAGGTCTGTGATGCCCT |
| | | | TAGATGTTCTGGGCCGCACGCG |
| | | | CGCTACACTGACAGAGCCAACG |
| | | | AGTACATCACCTTGGCCGGAAG |
| | | | GTCTGGGTAATCTTGTTAAACTC |
| | | | TGTCGTGCTGGGGATAGAGCAT |
| | | | TGCAATTATTGCTCTTCAACGAG |
| | | | GAATTCCTAGTAAGCGCAAGTC |
| | | | ATCAGCTTGCGCTGATTACGTC |
| | | | CCTGCCCTTTGTACACACCGCC |
| | | | CGTCGCTACTACCGATTGAATG |
| | | | GCTCAGTGAGGCCTTCGGACTG |
| | | | GCACAGGGACGTTGGCAACGA |
| | | | CGACCCAGTGCCGGAAAGTTCG |
| | | | TCAAACTTGGTCATTTAGAGGAA |
| | | | GNNNAAGTCGTAACAAGGTTTC |
| | | | CGTAGGTGAACCTGCGGAAGG |
| | | | ATCATTA |
| | | | (SEQ ID NO: 33) |
| Primary extracelullar | | | |
| symbiont | Host | Location | 16 rRNA |
| Burkholderia strain SFA1 | Riptortus | Gut | AGTTTGATCCTGGCTCAGATTG |
| | pedestris | | AACGCTGGCGGCATGCCTTACA |
| | | | CATGCAAGTCGAACGGCAGCAC |
| | | | GGGGGCAACCCTGGTGGCGAG |
| | | | TGGCGAACGGGTGAGTAATACA |
| | | | TCGGAACGTGTCCTGTAGTGGG |
| | | | GGATAGCCCGGCGAAAGCCGG |
| | | | ATTAATACCGCATACGACCTAA |
| | | | GGGAGAAAGCGGGGGATCTTC |
| | | | GGACCTCGCGCTATAGGGGCG |
| | | | GCCGATGGCAGATTAGCTAGTT |
| | | | GGTGGGGTAAAGGCCTACCAA |
| | | | GGCGACGATCTGTAGCTGGTCT |
| | | | GAGAGGACGACCAGCCACACT |
| | | | GGGACTGAGACACGGCCCAGA |
| | | | CTCCTACGGGAGGCAGCAGTG |
| | | | GGGAATTTTGGACAATGGGGGC |
| | | | AACCCTGATCCAGCAATGCCGC |
| | | | GTGTGTGAAGAAGGCTTCGGGT |
| | | | TGTAAAGCACTTTTGTCCGGAA |
| | | | AGAAAACTTCGTCCCTAATATG |
| | | | GATGGAGGATGACGGTACCGG |
| | | | AAGAATAAGCACCGGCTAACTA |
| | | | CGTGCCAGCAGCCGCGGTAATA |
| | | | CGTAGGGTGCGAGCGTTAATCG |
| | | | GAATTACTGGGCGTAAAGCGTG |
| | | | CGCAGGCGGTCTGTTAAGACCG |
| | | | ATGTGAAATCCCCGGGCTTAAC |
| | | | CTGGGAACTGCATTGGTGACTG |
| | | | GCAGGCTTTGAGTGTGGCAGAG |
| | | | GGGGGTAGAATTCCACGTGTAG |
| | | | CAGTGAAATGCGTAGAGATGTG |
| | | | GAGGAATACCGATGGCGAAGG |
| | | | CAGCCCCCTGGGCCAACTACTG |
| | | | ACGCTCATGCACGAAAGCGTGG |
| | | | GGAGCAAACAGGATTAGATACC |
| | | | CTGGTAGTCCACGCCCTAAACG |
| | | | ATGTCAACTAGTTGTTGGGGAT |
| | | | TCATTTCCTTAGTAACGTAGCTA |
| | | | ACGCGTGAAGTTGACCGCCTGG |
| | | | GGAGTACGGTCGCAAGATTAAA |
| | | | ACTCAAAGGAATTGACGGGGAC |
| | | | CCGCACAAGCGGTGGATGATGT |
| | | | GGATTAATTCGATGCAACGCGA |
| | | | AAAACCTTACCTACCCTTGACAT |
| | | | GGTCGGAACCCTGCTGAAAGGT |
| | | | GGGGGTGCTCGAAAGAGAACC |
| | | | GGCGCACAGGTGCTGCATGGC |
| | | | TGTCGTCAGCTCGTGTCGTGAG |
| | | | ATGTTGGGTTAAGTCCCGCAAC |
| | | | GAGCGCAACCCTTGTCCTTAGT |
| | | | TGCTACGCAAGAGCACTCTAAG |
| | | | GAGACTGCCGGTGACAAACCG |
| | | | GAGGAAGGTGGGGATGACGTC |
| | | | AAGTCCTCATGGCCCTTATGGG |
| | | | TAGGGCTTCACACGTCATACAA |
| | | | TGGTCGGAACAGAGGGTTGCCA |
| | | | AGCCGCGAGGTGGAGCCAATC |
| | | | CCAGAAAACCGATCGTAGTCCG |
| | | | GATCGCAGTCTGCAACTCGACT |
| | | | GCGTGAAGCTGGAATCGCTAGT |
| | | | AATCGCGGATCAGCATGCCGCG |
| | | | GTGAATACGTTCCCGGGTCTTG |
| | | | TACACACCGCCCGTCACACCAT |
| | | | GGGAGTGGGTTTCACCAGAAGT |
| | | | AGGTAGCCTAACCGCAAGGAG |
| | | | GGCGCTTACCACGGTGGGATTC |
| | | | ATGACTGGGGTGAAGTCGTAAC |
| | | | AAGGTAGC |
| | | | (SEQ ID NO: 34) |
| Burkholderia strain KM-A | Riptortus | Gut | GCAACCCTGGTGGCGAGTGGC |
| | pedestris | | GAACGGGTGAGTAATACATCGG |
| | | | AACGTGTCCTGTAGTGGGGGAT |
| | | | AGCCCGGCGAAAGCCGGATTAA |
| | | | TACCGCATACGATCTACGGAAG |
| | | | AAAGCGGGGGATCCTTCGGGA |
| | | | CCTCGCGCTATAGGGGCGGCC |
| | | | GATGGCAGATTAGCTAGTTGGT |
| | | | GGGGTAAAGGCCTACCAAGGC |
| | | | GACGATCTGTAGCTGGTCTGAG |
| | | | AGGACGACCAGCCACACTGGG |
| | | | ACTGAGACACGGCCCAGACTCC |
| | | | TACGGGAGGCAGCAGTGGGGA |
| | | | ATTTTGGACAATGGGGGCAACC |
| | | | CTGATCCAGCAATGCCGCGTGT |
| | | | GTGAAGAAGGCCTTCGGGTTGT |
| | | | AAAGCACTTTTGTCCGGAAAGA |
| | | | AAACGTCTTGGTTAATACCTGA |
| | | | GGCGGATGACGGTACCGGAAG |
| | | | AATAAGCACCGGCTAACTACGT |
| | | | GCCAGCAGCCGCGGTAATACGT |
| | | | AGGGTGCGAGCGTTAATCGGAA |
| | | | TTACTGGGCGTAAAGCGTGCGC |
| | | | AGGCGGTCTGTTAAGACCGATG |
| | | | TGAAATCCCCGGGCTTAACCTG |
| | | | GGAACTGCATTGGTGACTGGCA |
| | | | GGCTTTGAGTGTGGCAGAGGG |
| | | | GGGTAGAATTCCACGTGTAGCA |
| | | | GTGAAATGCGTAGAGATGTGGA |
| | | | GGAATACCGATGGCGAAGGCA |
| | | | GCCCCCTGGGCCAACACTGAC |
| | | | GCTCATGCACGAAAGCGTGGG |
| | | | GAGCAAACAGGATTAGATACCC |
| | | | TGGTAGTCCACGCCCTAAACGA |
| | | | TGTCAACTAGTTGTTGGGGATT |
| | | | CATTTCCTTAGTAACGTAGCTAA |
| | | | CGCGTGAAGTTGACCGCCTGG |
| | | | GGAGTACGGTCGCAAGATTAAA |
| | | | ACTCAAAGGAATTGACGGGGAC |
| | | | CCGCACAAGCGGTGGATGATGT |
| | | | GGATTAATTCGATGCAACGCGA |
| | | | AAAACCTTACCTACCCTTGACAT |
| | | | GGTCGGAAGTCTGCTGAGAGGT |
| | | | GGACGTGCTCGAAAGAGAACC |
| | | | GGCGCACAGGTGCTGCATGGC |
| | | | TGTCGTCAGCTCGTGTCGTGAG |
| | | | ATGTTGGGTTAAGTCCCGCAAC |
| | | | GAGCGCAACCCTTGTCCTTAGT |
| | | | TGCTACGCAAGAGCACTCTAAG |
| | | | GAGACTGCCGGTGACAAACCG |
| | | | GAGGAAGGTGGGGATGACGTC |
| | | | AAGTCCTCATGGCCCTTATGGG |
| | | | TAGGGCTTCACACGTCATACAA |
| | | | TGGTCGGAACAGAGGGTTGCCA |
| | | | AGCCGCGAGGTGGAGCCAATC |
| | | | CCAGAAAACCGATCGTAGTCCG |
| | | | GATCGCAGTCTGCAACTCGACT |
| | | | GCGTGAAGCTGGAATCGCTAG |
| | | | TAATCGCGGATCAGCATGCCGC |
| | | | GGTGAATACGTTCCCGGGTCTT |
| | | | GTACACACCGCCCGTCACACCA |
| | | | TGGGAGTGGGTTTCACCAGAAG |
| | | | TAGGTAGCCTAACCGCAAGGAG |
| | | | GGCGCTTACCACGGTGGGATTC |
| | | | ATGACTGGGGTGAAGT |
| | | | (SEQ ID NO: 35) |
| Burkholderia strain KM-G | Riptortus | Gut | GCAACCCTGGTGGCGAGTGGC |
| | pedestris | | GAACGGGTGAGTAATACATCGG |
| | | | AACGTGTCCTGTAGTGGGGGAT |
| | | | AGCCCGGCGAAAGCCGGATTAA |
| | | | TACCGCATACGACCTAAGGGAG |
| | | | AAAGCGGGGGATCTTCGGACCT |
| | | | CGCGCTATAGGGGCGGCCGAT |
| | | | GGCAGATTAGCTAGTTGGTGGG |
| | | | GTAAAGGCCTACCAAGGCGACG |
| | | | ATCTGTAGCTGGTCTGAGAGGA |
| | | | CGACCAGCCACACTGGGACTGA |
| | | | GACACGGCCCAGACTCCTACG |
| | | | GGAGGCAGCAGTGGGGAATTTT |
| | | | GGACAATGGGGGCAACCCTGAT |
| | | | CCAGCAATGCCGCGTGTGTGAA |
| | | | GAAGGCCTTCGGGTTGTAAAGC |
| | | | ACTTTTGTCCGGAAAGAAAACTT |
| | | | CGAGGTTAATACCCTTGGAGGA |
| | | | TGACGGTACCGGAAGAATAAGC |
| | | | ACCGGCTAACTACGTGCCAGCA |
| | | | GCCGCGGTAATACGTAGGGTG |
| | | | CGAGCGTTAATCGGAATTACTG |
| | | | GGCGTAAAGCGTGCGCAGGCG |
| | | | GTCTGTTAAGACCGATGTGAAA |
| | | | TCCCCGGGCTTAACCTGGGAAC |
| | | | TGCATTGGTGACTGGCAGGCTT |
| | | | TGAGTGTGGCAGAGGGGGGTA |
| | | | GAATTCCACGTGTAGCAGTGAA |
| | | | ATGCGTAGAGATGTGGAGGAAT |
| | | | ACCGATGGCGAAGGCAGCCCC |
| | | | CTGGGCCAACACTGACGCTCAT |
| | | | GCACGAAAGCGTGGGGAGCAA |
| | | | ACAGGATTAGATACCCTGGTAG |
| | | | TCCACGCCCTAAACGATGTCAA |
| | | | CTAGTTGTTGGGGATTCATTTCC |
| | | | TTAGTAACGTAGCTAACGCGTG |
| | | | AAGTTGACCGCCTGGGGAGTAC |
| | | | GGTCGCAAGATTAAAACTCAAA |
| | | | GGAATTGACGGGGACCCGCAC |
| | | | AAGCGGTGGATGATGTGGATTA |
| | | | ATTCGATGCAACGCGAAAAACC |
| | | | TTACCTACCCTTGACATGGTCG |
| | | | GAAGTCTGCTGAGAGGTGGAC |
| | | | GTGCTCGAAAGAGAACCGGCG |
| | | | CACAGGTGCTGCATGGCTGTC |
| | | | GTCAGCTCGTGTCGTGAGATGT |
| | | | TGGGTTAAGTCCCGCAACGAGC |
| | | | GCAACCCTTGTCCTTAGTTGCT |
| | | | ACGCAAGAGCACTCTAAGGAGA |
| | | | CTGCCGGTGACAAACCGGAGG |
| | | | AAGGTGGGGATGACGTCAAGTC |
| | | | CTCATGGCCCTTATGGGTAGGG |
| | | | CTTCACACGTCATACAATGGTC |
| | | | GGAACAGAGGGTTGCCAAGCC |
| | | | GCGAGGTGGAGCCAATCCCAG |
| | | | AAAACCGATCGTAGTCCGGATC |
| | | | GCAGTCTGCAACTCGACTGCGT |
| | | | GAAGCTGGAATCGCTAGTAATC |
| | | | GCGGATCAGCATGCCGCGGTG |
| | | | AATACGTTCCCGGGTCTTGTAC |
| | | | ACACCGCCCGTCACACCATGGG |
| | | | AGTGGGTTTCACCAGAAGTAGG |
| | | | TAGCCTAACCTGCAAAGGAGGG |
| | | | CGCTTACCACG |
| | | | (SEQ ID NO: 36) |

### IV. Formulations and Compositions

The compositions described herein may be formulated either in pure form (e.g., the composition contains only the bacterial colonization-disrupting agent) or together with one or more additional agents (such as excipient, delivery vehicle, carrier, diluent, stabilizer, etc.) to facilitate application or delivery of the compositions. Examples of suitable excipients and diluents include, but are not limited to, lactose, dextrose, sucrose, sorbitol, mannitol, starches, gum acacia, calcium phosphate, alginates, tragacanth, gelatin, calcium silicate, microcrystalline cellulose, polyvinylpyrrolidone, cellulose, water, saline solution, syrup, methylcellulose, methyl- and propylhydroxybenzoates, talc, magnesium stearate, and mineral oil. The composition may include a wetting solution (e.g., a non-ionic wetting solution), e.g., SilWet®.

To allow ease of application, handling, transportation, storage, and maximum activity, the bacterial colonization-disrupting agent can be formulated with other substances. The bacterial colonization-disrupting agent can be formulated into, for example, baits, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra-low volume solutions.

The bacterial colonization-disrupting agent can be applied as aqueous suspensions or emulsions prepared from concentrated formulations of such agents. Such water-soluble, water-suspendable, or emulsifiable formulations are either solids, usually known as wettable powders, or water dispersible granules, or liquids usually known as emulsifiable concentrates, or aqueous suspensions. Wettable powders, which may be compacted to form water dispersible granules, comprise an intimate mixture of the bacterial colonization-disrupting agent, a carrier, and surfactants. The carrier is usually selected from among the attapulgite clays, the montmorillonite clays, the diatomaceous earths, or the purified silicates.

Effective surfactants, including from about 0.5% to about 10% of the wettable powder, are found among sulfonated lignins, condensed naphthalenesulfonates, naphthalenesulfonates, alkylbenzenesulfonates, alkyl sulfates, and non-ionic surfactants such as ethylene oxide adducts of alkyl phenols.

Emulsifiable concentrates can comprise a suitable concentration of a bacterial colonization-disrupting agent, such as from about 50 to about 500 grams per liter of liquid dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are selected from conventional anionic and non-ionic surfactants.

Aqueous suspensions comprise suspensions of a water-insoluble bacterial colonization-disrupting agent dispersed in an aqueous carrier at a concentration in the range from about 5% to about 50% by weight. Suspensions are prepared by finely grinding the active agent and vigorously mixing it into a carrier comprised of water and surfactants. Ingredients, such as inorganic salts and synthetic or natural gums may also be added, to increase the density and viscosity of the aqueous carrier.

The bacterial colonization-disrupting agent may also be applied as granular compositions that are particularly useful for applications to the soil. Granular compositions can contain, for example, from about 0.5% to about 10% by weight of the bacterial colonization-disrupting agent, dispersed in a carrier that comprises clay or a similar substance. Such compositions are usually prepared by dissolving the formulation in a suitable solvent and applying it to a granular carrier which has been pre-formed to the appropriate particle size, in the range of from about 0.5 to about 3 mm. Such compositions may also be formulated by making a dough or paste of the carrier and compound and crushing and drying to obtain the desired granular particle size.

Dusts containing the present compositions are prepared by intimately mixing the bacterial colonization-disrupting agent in powdered form with a suitable dusty agricultural carrier, such as kaolin clay, ground volcanic rock, and the like. Dusts can suitably contain from about 1% to about 10% of the packets. They can be applied as a seed dressing or as a foliage application with a dust blower machine.

It is equally practical to apply the present formulation in the form of a solution in an appropriate organic solvent, usually petroleum oil, such as the spray oils, which are widely used in agricultural chemistry.

The bacterial colonization-disrupting agent can also be applied in the form of an aerosol composition. In such compositions the packets are dissolved or dispersed in a carrier, which is a pressure-generating propellant mixture. The aerosol composition is packaged in a container from which the mixture is dispensed through an atomizing valve.

Another embodiment is an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer including: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007. For ease of use, this embodiment will be referred to as “OIWE.”

Additionally, generally, when the molecules disclosed above are used in a formulation, such formulation can also contain other components. These components include, but are not limited to, (this is a non-exhaustive and non-mutually exclusive list) wetters, spreaders, stickers, penetrants, buffers, sequestering agents, drift reduction agents, compatibility agents, anti-foam agents, cleaning agents, and emulsifiers. A few components are described forthwith.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulfate; sodium dioctyl sulfosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulfonates. For suspension concentrates, very good adsorption and stabilization are obtained using polyelectrolytes, such as sodium naphthalene sulfonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulfonates; sodium naphthalene sulfonate formaldehyde condensates; tristyrylphenol ethoxylate phosphate esters; aliphatic alcohol ethoxylates; alkyl ethoxylates; EO-PO (ethylene oxide-propylene oxide) block copolymers; and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends contain alkylphenol or aliphatic alcohol with twelve or more ethylene oxide units and the oil-soluble calcium salt of dodecylbenzenesulfonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The types of surfactants usually used for solubilization are non-ionics, sorbitan monooleates, sorbitan monooleate ethoxylates, and methyl oleate esters.

Surfactants are sometimes used, either alone or with other additives such as mineral or vegetable oils as adjuvants to spray-tank mixes to improve the biological performance of the bacterial colonization-disrupting agent on the target. The types of surfactants used for bioenhancement depend generally on the nature and mode of action of the bacterial colonization-disrupting agent. However, they are often non-ionics such as: alkyl ethoxylates; linear aliphatic alcohol ethoxylates; aliphatic amine ethoxylates.

A carrier or diluent in an agricultural formulation is a material added to the bacterial colonization-disrupting agent to give a product of the required strength. Carriers are usually materials with high absorptive capacities, while diluents are usually materials with low absorptive capacities. Carriers and diluents are used in the formulation of dusts, wettable powders, granules, and water-dispersible granules.

Organic solvents are used mainly in the formulation of emulsifiable concentrates, oil-in-water emulsions, suspoemulsions, and ultra low volume formulations, and to a lesser extent, granular formulations. Sometimes mixtures of solvents are used. The first main groups of solvents are aliphatic paraffinic oils such as kerosene or refined paraffins. The second main group (and the most common) comprises the aromatic solvents such as xylene and higher molecular weight fractions of C9 and C10 aromatic solvents. Chlorinated hydrocarbons are useful as cosolvents to prevent crystallization of the bacterial colonization-disrupting agent when the formulation is emulsified into water. Alcohols are sometimes used as cosolvents to increase solvent power. Other solvents may include vegetable oils, seed oils, and esters of vegetable and seed oils.

Thickeners or gelling agents are used mainly in the formulation of suspension concentrates, emulsions, and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are not limited to, montmorillonite, bentonite, magnesium aluminum silicate, and attapulgite. Water-soluble polysaccharides have been used as thickening-gelling agents for many years. The types of polysaccharides most commonly used are natural extracts of seeds and seaweeds or are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol, and polyethylene oxide. Another good anti-settling agent is xanthan gum.

Microorganisms can cause spoilage of formulated products. Therefore preservation agents are used to eliminate or reduce their effect. Examples of such agents include, but are not limited to: propionic acid and its sodium salt; sorbic acid and its sodium or potassium salts; benzoic acid and its sodium salt; p-hydroxybenzoic acid sodium salt; methyl p-hydroxybenzoate; and 1,2-benzisothiazolin-3-one (BIT).

The presence of surfactants often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane, while the non-silicone anti-foam agents are water-insoluble oils, such as octanol and nonanol, or silica. In both cases, the function of the anti-foam agent is to displace the surfactant from the air-water interface.

“Green” agents (e.g., adjuvants, surfactants, solvents) can reduce the overall environmental footprint of crop protection formulations. Green agents are biodegradable and generally derived from natural and/or sustainable sources, e.g., plant and animal sources. Specific examples are: vegetable oils, seed oils, and esters thereof, also alkoxylated alkyl polyglucosides.

In some instances, the bacterial colonization-disrupting agent can be freeze-dried or lyophilized. See U.S. Pat. No. 4,311,712. The bacterial colonization-disrupting agent can later be reconstituted on contact with water or another liquid. Other components can be added to the lyophilized or reconstituted, for example, other agricultural agents, agriculturally acceptable carriers, or other materials in accordance with the formulations described herein.

Other optional features of the composition include carriers or delivery vehicles that protect the bacterial colonization-disrupting agent against UV and/or acidic conditions. In some instances, the delivery vehicle contains a pH buffer. In some instances, the composition is formulated to have a pH in the range of about 4.5 to about 9.0, including for example pH ranges of about any one of 5.0 to about 8.0, about 6.5 to about 7.5, or about 6.5 to about 7.0.

In some instances, the composition includes a bait. The bait can be in any suitable form, such as a solid, paste, pellet or powdered form. The bait can also be carried away by the insect back to a population of said insect (e.g., a colony or hive). The bait can then act as a food source for other members of the colony, thus providing an effective amount of a bacterial colonization-disrupting agent for a large number of insects and potentially an entire insect colony.

The baits can be provided in a suitable “housing” or “trap.” Such housings and traps are commercially available and existing traps can be adapted to include the compositions described herein. The housing or trap can be box-shaped for example, and can be provided in pre-formed condition or can be formed of foldable cardboard for example. Suitable materials for a housing or trap include plastics and cardboard, particularly corrugated cardboard. The inside surfaces of the traps can be lined with a sticky substance in order to restrict movement of the insect once inside the trap. The housing or trap can contain a suitable trough inside which can hold the bait in place. A trap is distinguished from a housing because the insect cannot readily leave a trap following entry, whereas a housing acts as a “feeding station” which provides the insect with a preferred environment in which they can feed and feel safe from predators.

In some instances, the composition includes an attractant (e.g., a chemoattractant). The attractant may attract an adult insect or immature insect (e.g., larva) to the vicinity of the composition. Attractants include pheromones, a chemical that is secreted by an animal, especially an insect, which influences the behavior or development of others of the same species. Other attractants include sugar and protein hydrolysate syrups, yeasts, and rotting meat. Attractants also can be combined with an active ingredient and sprayed onto foliage or other items in the treatment area.

Various attractants are known which influence insect behavior as an insect's search for food, oviposition or mating sites, or mates. Attractants useful in the methods and compositions described herein include, for example, eugenol, phenethyl propionate, ethyl dimethylisobutyl-cyclopropane carboxylate, propyl benszodioxancarboxylate, cis-7,8-epoxy-2-methyloctadecane, trans-8,trans-0-dodecadienol, cis-9-tetradecenal (with cis-11-hexadecenal), trans-11-tetradecenal, cis-11-hexadecenal, (Z)-11,12-hexadecadienal, cis-7-dodecenyl acetate, cis-8-dodecenyul acetate, cis-9-dodecenyl acetate, cis-9-tetradecenyl acetate, cis-11-tetradecenyl acetate, trans-11-tetradecenyl acetate (with cis-11), cis-9,trans-11-tetradecadienyl acetate (with cis-9,trans-12), cis-9,trans-12-tetradecadienyl acetate, cis-7,cis-11-hexadecadienyl acetate (with cis-7,trans-11), cis-3,cis-13-octadecadienyl acetate, trans-3,cis-13-octadecadienyl acetate, anethole and isoamyl salicylate. Additionally, means other than chemoattractants may also be used to attract insects, including lights in various wavelengths or colors.

The bacterial colonization-disrupting agent can also be incorporated into the medium in which the insect grows, lives, reproduces, feeds, or infests. For example, a bacterial colonization-disrupting agent can be incorporated into a food container, feeding station, protective wrapping, or a hive. For some applications the bacterial colonization-disrupting agent may be bound to a solid support for application in powder form or in a trap or feeding station. As an example, for applications where the composition is to be used in a trap or as bait for a particular insect, the compositions may also be bound to a solid support or encapsulated in a time-release material. In some instances, the bacterial colonization-disrupting agent is formulated in a fog, smoke, or other treatment suitable for application to an insect habitat.

In formulations and in the use forms prepared from these formulations, the bacterial colonization-disrupting agent may be in a mixture with other agricultural agents or otherwise applied in coincidence with other agricultural agents, such as pesticidal agents (e.g., insecticides, antihelminthics, sterilants, acaricides, nematicides, molluscicides, or fungicides), attractants, plant growth-regulating substances, pollen, sucrose, fertilizers, plant growth regulators, safeners, semiochemicals, or herbicides.

For further information on agricultural formulations, see “Chemistry and Technology of Agrochemical Formulations” edited by D. A. Knowles, copyright 1998 by Kluwer Academic Publishers. Also see “Insecticides in Agriculture and Environment—Retrospects and Prospects” by A. S. Perry, I. Yamamoto, I. Ishaaya, and R. Perry, copyright 1998 by Springer-Verlag.

### EXAMPLES

The following is an example of the methods of the invention. It is understood that various other embodiments may be practiced, given the general description provided above.

### Example 1: Disruption of Gut Symbiont Colonization in Insects by Altering Symbiont Cell Wall Properties

This Example demonstrates the disruption of colonization of the gut symbiont Burkholderia in a hemipteran insect, the bean bug (Riptortus pedestris), to descrease insect fitness through the administration of polyhydroxyalkanoate (PHA) synthesis inhibitors. The bean bug R. pedestris (Hemiptera: Heteroptera: Coreoidea) is a notorious pest of leguminous crops, such as soy-bean and cowpea.

Experimental Design:

Insect Rearing and Burkholderia Infection

The R. pedestris bean bugs are reared in the insect incubator at 28° C. under a long-day condition of 16 h light and 8 h dark. Briefly, nymphs are reared in clean plastic containers supplied with soybean seeds and distilled water containing 0.05% ascorbic acid (DWA). The plastic containers are cleaned every day, and the soybean seeds and DWA are changed with fresh ones every 2 days. When the insects emerge as adults, they are transferred to larger plastic containers with soybean seeds and DWA. In addition, cotton pads are attached to the walls of the plastic containers for egg laying. Eggs are collected every day and transferred to new cages for hatching. When newborn nymphs molt to second-instar nymphs, DWA containing 10⁷ cells/ml cultured Burkholderia is provided for the colonization of Burkholderia in a small petri dish. Burkholderia symbiont used is a rifampicin-resistant (Rfr) spontaneous mutant strain RPE75.

Administration of Burkholderia cultured with PHA synthesis inhibitor vanillin A PHA synthesis inhibitor, vanillin is purchased from Sigma-Aldrich (Cat no. V1104-2G). The working concentration of vanillin made in the YG medium is 1 g/ml. The symbiont strain is grown to an early log phase in YG medium (containing rifampicin at 50 ug/ml) on a gyratory shaker (150 rpm) at 30° C. For the positive control Burkholderia is cultured in YG medium only. Colony-forming unit (CFU) values are estimated by plating the culture media on YG agar plates containing adequate antibiotics. Symbiont cells are harvested by centrifuging the culture media, suspended in DWA and adjusted to 10⁴ CFU/mL in DWA.

Immediately after first instar nymphs molt to the second instar, DWA is removed from the rearing containers so that the nymphs are kept without drinking water overnight. Then, DWA containing 10⁴ CFU/mL symbiont cells is supplied to the rearing containers for 24 h, which the second instar nymphs can immediately exploit to acquire the Burkholderia symbionts cultured with PHA synthase inhibitors or the positive control Burkholderia cultured in YG medium only. Then, the symbiont-containing DWA is replaced by symbiont-free DWA, and the nymphs are reared to adulthood.

Direct Feeding of PHA Synthesis Inhibitor Vanillin to R. pedestris

The vanillin working solution (1 g/ml) is made from the stock solution into the distilled water. The vanillin working solution is dispensed into a feeding tube and put into the plastic rearing container for bean bug feeding. Immediately after first instar nymphs molt to the second instar, DWA is removed from the rearing containers so that the nymphs are kept without drinking water overnight. The following day, the vanillin solution along with 10⁴ CFU/mL symbiont cells is supplied to the rearing containers for 24 h, which the second instar nymphs can immediately exploit to acquire the PHA synthase inhibitor vanillin and Burkholderia symbionts. The positive controls are the nymphs fed with 10⁴ CFU/mL symbiont cells only. Then, the symbiont-containing DWA is replaced by DWA, and the nymphs are reared to adulthood.

Quantification of Burkholderia Colonized in R. pedestris Midgut by qPCR

Quantitative PCR (qCPR) is performed using iTaq SYBR green (Biorad) and Applied Biosystems QuantStudio 7 Flex QPCR system (Thermo Fisher) with primers BSdnaA-F and BSdnaA-R targeting a 0.15 kb region of the dnaA gene of the Burkholderia symbiont as described in (Kikuchi et al. 2011; Kikuchi and Fukatsu, 2014). Total DNA is extracted from M4 and M4B parts by using the Blood & Cell Culture DNA Mini Kit (Qiagen, Cat number 13323). and the extracted DNA is eluted in 200 μL water. Each of the PCR mixtures contains 10 μL in volume. qPCR is performed using a qPCR amplification ramp of 1.6 degrees C./s and the following conditions: 1) 95° C. for 10 minutes, 2) 95° C. for 15 seconds, 3) 60° C. for 30 seconds, 4) repeat steps 2-3 40×, 5) 95° C. for 15 seconds, 6) 60° C. for 1 minute, 7) ramp change to 0.15 degrees C./s, 8) 95° C. for 1 second. A standard curve for the dnaA gene is generated with standard samples of the target PCR fragment amplified with the primers BSdnaA-F and BSdnaA-R. qPCR data is analyzed using analytical software (Thermo Fisher Scientific, QuantStudio Design and Analysis).

Measurement of R. pedestris Fitness

The survival rates after administration of Burkholderia cultured with PHA synthase inhibitor vanillin or direct feeding of vanillin to the second-instar nymphs and both positive controls are estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and are dried completely in a 70° C. oven for 30 min. Soybean seeds are not supplied to insects 24 h before sacrificing to exclude the weight of the soybean.

In comparison with the positive controls of R. pedestris fed with Burkholderia cultured in YG medium only and direct feeding of Burkholderia only, the titers of Burkholderia in the midgut of R. pedestris offspring are expected to be reduced by either administration of Burkholderia cultured with vanillin or direct feeding of vanillin to R. pedestris.

### Example 2: Disruption of Symbiont Colonization in Insects by Administration of Sugar Analogs

This example demonstrate the disruption of Burkholderia colonization in a hemipteran model, the bean bug, Riptortus pedestris to decrease fitness in the insect through the administration of sugar analogs, ADP-2-fluoroheptose (AFH) and 2-aryl-5-methyl-4-(5-aryl-furan-2-yl-methylene)-2,4-dihydro-pyrazol-3-ones (DHPO).

Experimental Design:

Insect Rearing and Burkholderia Infection

The R. pedestris bean bugs are reared in the insect incubator at 28° C. under a long-day condition of 16 h light and 8 h dark. Briefly, nymphs are reared in clean plastic containers supplied with soybean seeds and distilled water containing 0.05% ascorbic acid (DWA). The plastic containers are cleaned every day, and the soybean seeds and DWA are changed with fresh ones every 2 days. When the insects emerge as adults, they are transferred to larger plastic containers with soybean seeds and DWA. In addition, cotton pads are attached to the walls of the plastic containers for egg laying. Eggs are collected every day and transferred to new cages for hatching. When newborn nymphs molted to second-instar nymphs, DWA containing 10⁷ cells/ml cultured Burkholderia is provided for the colonization of Burkholderia in a small petri dish. Burkholderia symbiont is a rifampicin-resistant (Rfr) spontaneous mutant strain RPE75.

Administration of Burkholderia Cultured with Sugar Analogs

Two sugar analogs, ADP-2-fluoroheptose (AFH) (Dohi et al., 2008, Chemistry 14, 9530-9539) and 2-aryl-5-methyl-4-(5-aryl-furan-2-yl-methylene)-2,4-dihydro-pyrazol-3-ones (DHPO) (Moreau et al., 2008. Bioorg. Med. Chem. Lett. 18, 4022-4026) inhibiting L-Heptoses synthesis are synthesized by CRO. The working concentration of AHF and DHPO made in the YG medium is 1 g/ml. The symbiont strain is grown to an early log phase in YG medium (containing rifampicin at 50 ug/ml) on a gyratory shaker (150 rpm) at 30° C. The positive control of Burkholderia is cultured in YG medium only. Colony-forming unit (CFU) values are estimated by plating the culture media on YG agar plates containing adequate antibiotics. Symbiont cells are harvested by centrifuging the culture media, suspended in DWA and adjusted to 10⁴ CFU/mL in DWA.

Immediately after first instar nymphs molt to the second instar, DWA is removed from the rearing containers so that the nymphs are kept without drinking water overnight. Then, DWA containing 10⁴ CFU/mL symbiont cells is supplied to the rearing containers for 24 h, which the second instar nymphs can immediately exploit to acquire the Burkholderia symbionts cultured with AHF or DHPO or the positive control Burkholderia cultured in YG medium only. Then, the symbiont-containing DWA is replaced by symbiont-free DWA, and the nymphs are reared to adulthood.

Direct Feeding of Sugar Analogs to R. pedestris

Two sugar analogs, AFH and DHPO (Moreau et al., 2008. Bioorg. Med. Chem. Lett. 18, 4022-4026) inhibiting L-Heptoses synthesis are synthesized by CRO. The working solutions (1 g/ml) for AFH and DHPO are made from the stock into the distilled water. The two sugar analogs working solution are dispensed into the feeding tube and put into the plastic rearing container for bean bug feeding. Immediately after first instar nymphs molted to the second instar, DWA is removed from the rearing containers so that the nymphs are kept without drinking water overnight. The following day, the vanillin solution along with 10⁴ CFU/mL symbiont cells is supplied to the rearing containers for 24 h, which the second instar nymphs immediately exploited, leading to the acquisition of AFH or DHPO and Burkholderia symbionts. The positive control is the nymphs fed with 10⁴ CFU/mL symbiont cells only. Then, the symbiont-containing DWA is replaced by DWA, and the nymphs are reared to adulthood.

Quantification of Burkholderia Colonized in R. pedestris Midgut by qPCR

Quantitative PCR (qCPR) is performed using iTaq SYBR green (Biorad) and Applied Biosystems QuantStudio 7 Flex QPCR system (Thermo Fisher) with primers BSdnaA-F and BSdnaA-R targeting a 0.15 kb region of the dnaA gene of the Burkholderia symbiont as described (Kikuchi et al. 2011; Kikuchi and Fukatsu, 2014). Total DNA is extracted from M4 and M4B parts by using the Blood & Cell Culture DNA Mini Kit (Qiagen, Cat number 13323). and the extracted DNA is eluted in 200 μL water. Each of the PCR mixtures contains 10 μL in volume. qPCR is performed using a qPCR amplification ramp of 1.6 degrees C./s and the following conditions: 1) 95° C. for 10 minutes, 2) 95° C. for 15 seconds, 3) 60° C. for 30 seconds, 4) repeat steps 2-3 40×, 5) 95° C. for 15 seconds, 6) 60° C. for 1 minute, 7) ramp change to 0.15 degrees C./s, 8) 95° C. for 1 second. A standard curve for the dnaA gene is generated with standard samples of the target PCR fragment amplified with the primers BSdnaA-F and BSdnaA-R. qPCR data is analyzed using analytic (Thermo Fisher Scientific, QuantStudio Design and Analysis) software.

Measurement of R. pedestris Fitness

The survival rates after administration of Burkholderia cultured with AFH or DHPO or direct feeding of AFH or DHPO to the second-instar nymphs and both positive controls are estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and are dried completely in a 70° C. oven for 30 min. Finally, all fitness parameters are recorded. Soybean seeds are not supplied to insects 24 h before sacrificing to exclude the weight of the soybean.

In comparison with the positive controls of R. pedestris fed with Burkholderia cultured in YG medium only and direct feeding of Burkholderia only, the titers of Burkholderia in the midgut of R. pedestris offspring are expected to be reduced by either administration of Burkholderia cultured with two sugar analogs, AFH and DHPO, or direct feeding of AFH and DHPO to R. pedestris.

### Example 3: Disruption of Symbiont Colonization in Stink Bugs Using Sugar Analogs

This example describes disruption of the gut symbiont Candidatus Pantoea carbekii colonization in the hemipteran brown marmorated stink bug, Halyomorpha halys (St\dot{a}l) to decrease insect fitness by administration of sugar analogs.

Experimental Design:

Identification of Genes Required for Synthesizing Core Oligosaccharides of Candidatus Pantoea Carbekii

By searching the Candidatus Pantoea carbekii genome (AB012554.1) in Genbank, four genes for synthesizing core oligosaccharide have been identified (Table 9). The identification of these four genes suggests the P. carbekii synthesizes the core oligosaccharide on its cell surface. In addition, these four genes share high similarity to the genes in the core oligosaccharide pathways of the gut symbiont Burkholderia from the bean bug, Riptortus pedestris.

TABLE 9
Core oligosaccharide-related genes from the symbiont
Candidatus Pantoea carbekii in the brown marmorated
stink bug, Halyomorpha halys.

| Essential enzymes | | Gene location in |
|---|---|---|
| for synthesis of | Gene | Candidatus Pantoea carbekii |
| core oligosaccharide | ID | genome (AB012554.1) |
| WaaA | KdtA | 126758 to 128047 |
| WaaC | RfaC | 130803 to 131774 |
| WaaF | RfaF | 131780 to 132826 |
| WaaG | RfaG | 128127 to 129263 |

Halyomorpha halys Lab Colony Rearing and Maintenance

Halyomorpha halys no-diapause lab colony is originally from Phillip Alampi Beneficial Insect Laboratory, New Jersey Department of Agriculture, and is maintained in rearing cages (299 cm cube with 24 by 24 mesh, BioQuip Products, Rancho Dominguez, Calif.) in the laboratory. They are held in a growth chamber (28° C., 60-70% relative humidity, and a photoperiod of 16:8 [L:D] h) and are provided diet that included green beans and egg based artificial diet. A green bean plant and Euonymus japonicus plant are provided in the cage for H. halys oviposition and resting, respectively.

Administration Sugar Analogs by Spraying on Egg Masses of Halyomorpha halys

The working concentrations AHF and DHPO are 100 μg/ml in water. A total of 30 egg masses on leaf disks are removed from the colony in a single day during peak egg production. There are two sugar analogs, AHF and DHPO treatments and a water-sprayed negative control, each containing 10 egg masses are setup in a petri dish. Ten egg masses are laid face-up in each of the deep petri dish (15 mm×100 mm). AHF, DHPO or the water (negative control) are applied on the egg masses (1 ML per petri dish) using a Master Airbrush Brand Compressor Model C-16-B Black Mini Airbrush Air Compressor. The compressor is cleaned with ethanol before, after, and between treatments. The liquid is feed through the compressor using a quarter inch tube. A new tube is used for each treatment.

Measurement of Halyomorpha halys Fitness and Fecundity

The sprayed egg masses are reared under the same conditions as in the laboratory colony rearing section above. The number of hatched eggs is recorded for each egg mass and then averaged over all masses per replicate. The newly hatched nymphs in each container are reared to determine the number surviving to the second instar. The survival rate of the nymphs at each stadium is estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and dried completely in a 70° C. oven for 30 min. Finally, all fitness parameters are recorded. Green beans are not supplied to insects 24 h before sacrificing to exclude the weight of the diet.

Quantification of Candidatus Pantoea Carbekii Titers by qPCR

Total DNA is extracted from M4 and M4B parts of midgut by using the Blood & Cell Culture DNA Mini Kit (Qiagen, Cat number 13323). and the extracted DNA is eluted in 200 μL water. Quantitative PCR (qCPR) is performed using iTaq SYBR green (Biorad) and Applied Biosystems QuantStudio 7 Flex QPCR system (Thermo Fisher) with primers (forward: GCATATAAAGATTTTACTCTTTAGGTGGC (SEQ ID NO: 5) and reverse: CTCGAAAGCACCAATCCATTTCT (SEQ ID NO: 6)) (Bansal et al. 2014). Two control primers for stink bug mitochondrial DNA are used (forward: CGAATCCCATTGTTTGTGTG (SEQ ID NO: 7) and reverse: AGGGTCTCCTCCTCCTGATG (SEQ ID NO: 8) (Bansal et al. 2014). Each of the PCR mixtures contains 10 μL in volume. qPCR is performed using a qPCR amplification ramp of 1.6 degrees C./s and the following conditions: 1) 95° C. for 10 minutes, 2) 95° C. for 15 seconds, 3) 60° C. for 30 seconds, 4) repeat steps 2-3 40×, 5) 95° C. for 15 seconds, 6) 60° C. for 1 minute, 7) ramp change to 0.15 degrees C./s, 8) 95° C. for 1 second. qPCR data is analyzed using analytic (Thermo Fisher Scientific, QuantStudio Design and Analysis) software.

In comparison with the negative control offspring hatched from the eggs sprayed with water only, the titers of P. carbekii in the midgut of H. halys offspring are expected to be reduced by spraying on egg masses with two sugar analogs, AFH and DHPO.

In comparison with the negative control offspring hatched from the eggs sprayed with water only, the fitness and fecundity of H. halys offspring are expected to be reduced by spraying on egg masses with two sugar analogs, AFH and DHPO.

Together, the data described in these Examples are expected to demonstrate the ability to kill and decrease the development, reproductive ability, longevity, and/or endogenous bacterial populations, e.g., fitness, of several hemipterans by treating them with colonization disrupting agents using multiple delivery methods.

Below are provided examples demonstrating that reducing the bacterial symbionts Candidatus Pantoea carbekii (hereafter referred to as “P. carbekii”) and Burkholderia in their respective hemipteran insect hosts, the brown marmorated stink bug (Halyomorpha halys (St\dot{a}l)) and the bean bug (Riptortus pedestris), reduces the fitness of each insect.

### Example 4. Removal of Gut Symbionts in Insects Reduces Host Fitness

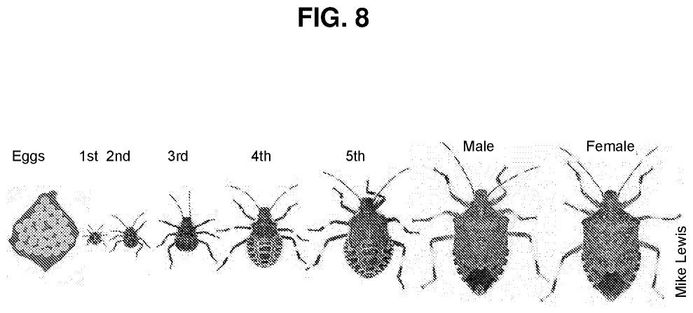

This example demonstrates that disruption of colonization of the bacterial symbiont Candidatus Pantoea carbekii (hereafter referred to as “P. carbekii”) in a hemipteran insect host, the brown marmorated stink bug Halyomorpha halys (St\dot{a}l), reduces the fitness of the host. Developmental stages of H. halys are shown in FIG. 8.

Experimental Design:

Halyomorpha halys Lab Colony Rearing and Maintenance

A Halyomorpha halys no-diapause lab colony was obtained from the Phillip Alampi Beneficial Insect Rearing Laboratory (BIRL), State of New Jersey Department of Agriculture. Following receipt from the BIRL, the lab colony was maintained in Thermo Fisher Scientific environmental incubators (24° C., ambient humidity, and 16:8 [L:D] photoperiod). Adult cages were fed fresh green beans and a seed mixture of peanuts, sunflower seeds, and buckwheat; green beans were changed every other day and the seed mixture was changed weekly. Egg clutches were collected daily from colony cages and placed into hatching containers (all egg clutches into a single container) that contained only 5 mL water tubes (stuffed with cotton). Upon hatching, nymphs were provided diet pellets (ad libitum) that contained split pea, almonds, buckwheat, sunflower seeds, wheat germ, ascorbic acid, and Wesson's salt.

Treatment of Eggs to Remove Symbionts

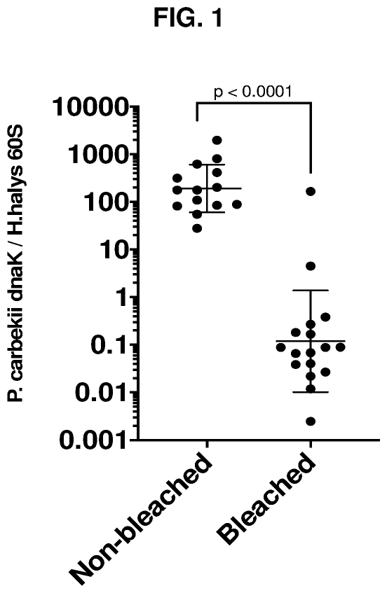

Four- to five-day-old H. halys egg clutches were submerged in absolute (˜95%) ethanol for 5 minutes, then submerged in 8% sodium hypochlorite (extra strength bleach) for 45 seconds, and were finally gently rinsed with purified water before being placed on a paper towel to dry. Control eggs were left untreated. To confirm the efficacy of the treatments, DNA was extracted from a subset of treated vs. control nymphs at the 2^{nd}, 3^{rd} and 4^{th} instars and was screened for the P. carbekii symbionts using qPCR, as described below. P. carbekii abundance was reduced in the treated group (FIG. 1).

Quantification of P. carbekii Titers by RT-qPCR

Total RNA was extracted from nymphs using total RNA isolation and purification kits (both from Thermo Fisher Scientific), and the extracted RNA was eluted in 100 μL water. Quantitative reverse transcription PCR (RT-qCPR) was performed using RT-qPCR kits (Thermo Fisher Scientific) with primers targeting the P. carbekii DNAK gene (forward primer sequence: TGCAGAAATTTGTGGCGGTG (SEQ ID NO: 1); reverse primer sequence: CGTTGCCTCAGAAAACGGTG (SEQ ID NO: 2)). Primers for the stink bug 60S rRNA gene (forward primer sequence: AACAGGCAAGCTGCTATCTC (SEQ ID NO: 3) and reverse primer sequence: CTGTCCCTTGGTGGTTCTTT (SEQ ID NO: 4)) were used to normalize the bacterial quantities. Each of the PCR mixtures was 10 μL in volume. RT-qPCR was performed using a PCR amplification ramp of 1.6° C./s and the following conditions: 1) 48° C. for 30 min; 2) 95° C. for 10 minutes; 3) 95° C. for 15 seconds; 4) 55° C. for 30 seconds; 5) repeat steps 3-4 40×, 6); 95° C. for 15 seconds; 7) 55° C. for 1 minute; 8) ramp change to 0.15° C./s; 9) 95° C. for 1 second. RT-qPCR data was analyzed using analytic software (Thermo Fisher Scientific).

Set-Up of Replicates and Data Collection

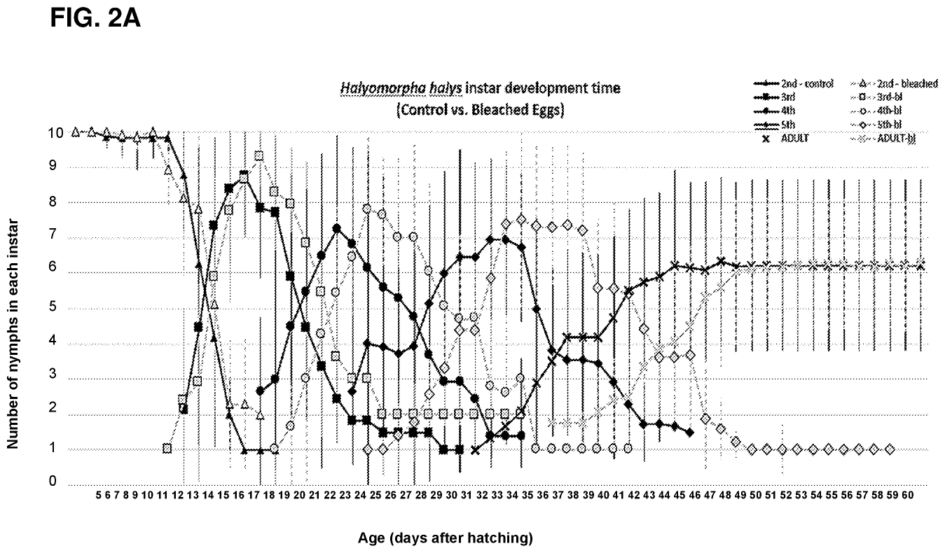

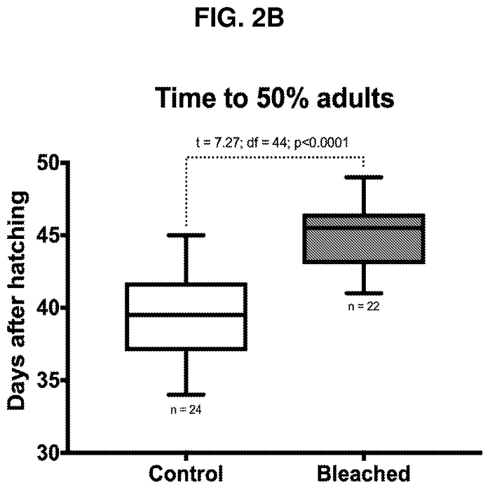

After egg treatment, eggs were allowed to hatch and develop to the second instar (larvae only require drinking water during this period). For each replicate, ten second instars from each treatment were placed in plastic cages containing a paper towel, water tube, and a green bean; water tubes were changed weekly, and green beans were changed every other day. Total replicates were 28 for the control treatment and 23 for the bleach/ethanol treatment. The number of survivors and the number of insects in each instar were recorded for each replicate daily. Symbiont removal increased the average amount of time between successive developmental instars compared to the control group (FIG. 2A) and increased the average time to adulthood by 6 days (FIG. 2B).

Once nymphs reached adulthood, adults from each treatment group were respectively pooled into large colony cages where the number of adults (male and female), egg masses, and eggs per mass were counted daily.

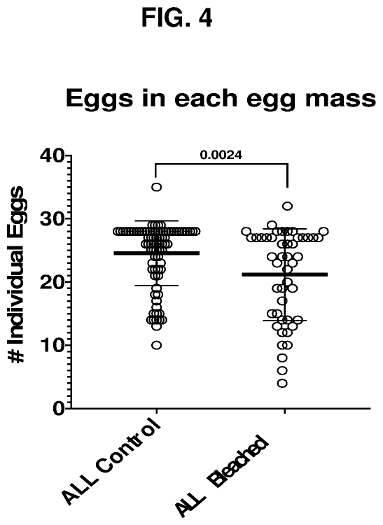

The average number of eggs in each egg mass was significantly lower for females reared from ethanol-treated and bleached eggs compared to controls (FIG. 4). Table 10 shows a comparison of fecundity in females from the control and bleached groups. Females reared from bleach and ethanol-treated eggs (Bleached) produced 42% fewer egg masses and 48.1% fewer total eggs than controls.

TABLE 10
Fecundity comparison of treated vs. control
adult female H. halys individuals.

| | Control | Bleached |
|---|---|---|
| Total Females *(survived to | 62 *(48) | 58 *(48) |
| reproductive maturity) | | |
| Avg Eggs per mass | 24.6 | 21.1 |
| Total Egg Masses | 81 | 47 |
| * Egg Masses per | * 1.69 | * 0.98 |
| reproductive Female | | |
| Total Eggs | 2100 | 1090 |
| * Eggs per reproductive | * 43.75 | * 22.7 |
| Female | | |

* indicates measures that were averaged from the number of females present when the first eggs were laid (reproductive maturity) in each replicate.

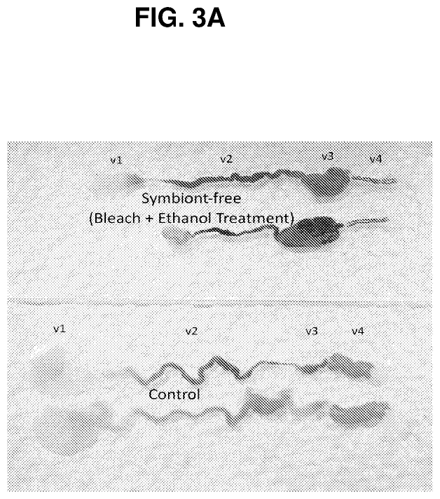

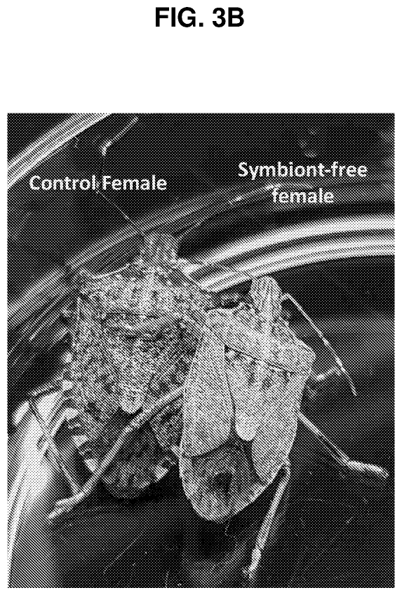

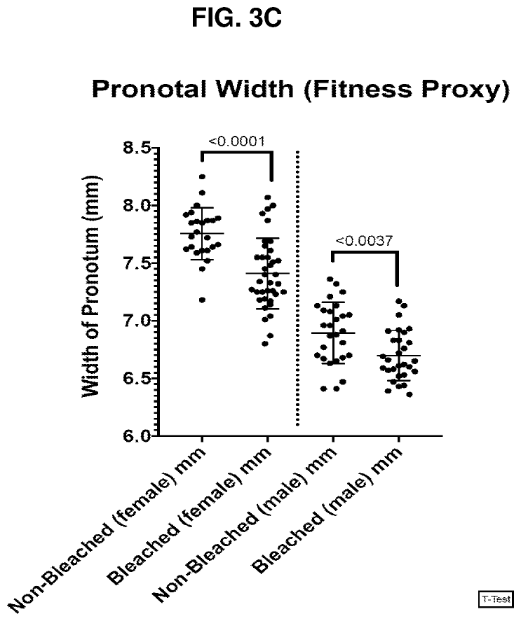

Guts were dissected from H. halys individuals of the same age from the bleach/ethanol treatment group or the control group. Gut health was observed to be inferior and the symbiont-containing v4 region of the gut was degenerated in the bleach/ethanol treatment group (FIG. 3A).

Insect size and coloring were observed to differ between H. halys individuals of the same age from the bleach/ethanol treatment group or the control group (FIG. 3B).

The width of the pronotum (standard fitness measure for stinkbugs) was measured for all males and females for comparison. Pronotal width was significantly reduced in male and female individuals hatched from bleached eggs (FIG. 3C).

### Example 5: Disruption of Gut Symbiont Colonization in Insects by Altering Polyhydroxyalkanoate (PHA) Synthesis Capability in the Symbionts

This example demonstrates the disruption of colonization of the gut symbiont P. carbekii in the brown marmorated stink bug (Halyomorpha halys (St\dot{a}l)) through the administration of polyhydroxyalkanoate (PHA) synthesis inhibitors.

Experimental Design:

The polyhydroxyalkanoate (PHA) synthesis inhibitors used were vanillin, levulinic acid, acrylic acid (AA), and 2-bromooctanoic acid (2BA).

Halyomorpha halys Lab Colony Rearing and Maintenance

A Halyomorpha halys no-diapause lab colony was reared as described in Example 4. Egg clutches were collected daily from colony cages and placed into hatching containers (5 egg clutches per container, maximum) that contained 30 mL water tubes (stuffed with cotton), fresh green beans, and a seed mixture of peanuts.

Administration of PHA Synthesis Inhibitors by Egg Mass Treatment:

Working concentrations of the PHA synthesis inhibitors (vanillin, levulinic acid, acrylic acid (AA), and 2-bromooctanoic acid (2BA)) were made up to 100 μg/ml in water. The solutions of PHA inhibitors were spiked with a non-ionic wetting solution to a final concentration of 0.025% to increase the wettability and spreading of the agents on the eggs. As a negative control, no agents were added to the 0.025% non-ionic wetting solution, and as a positive control, 100 μg/ml of the antibiotic rifamycin S was used. Egg masses on leaf disks were removed from the colony in a single day during peak egg production. Each egg mass was then placed in a container with a paper towel at the bottom, and a tube of water plugged with cotton was provided as a water source for the hatchlings. 100 μl of the agent was pipetted onto the eggs to wet them completely. This allowed the agent to interact directly with the bacteria before the bacteria was able to colonize the host. Once the 1^{st} instar hatchlings molted to the 2nd instar stage, food was provided in the form of 500 mg diet pellets (see “Halyomorpha halys lab colony rearing and maintenance” above). Late 2^{nd} instars were collected and frozen to extract DNA to assay for the symbiont levels, as described in Example 4.

Results

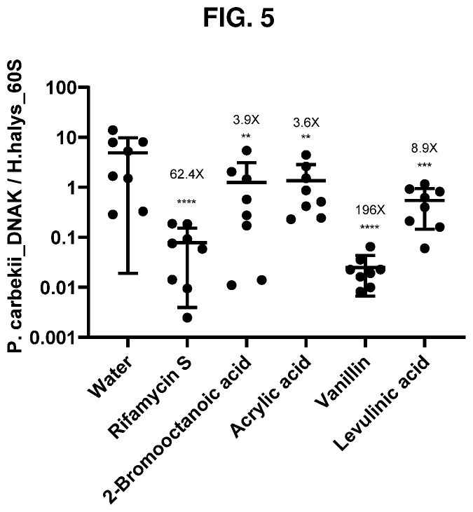

The levels of P. carbekii were significantly lower in the positive control (Rifamycin S) compared to the negative (water) control. All the four PHA inhibitors (vanillin, levulinic acid, acrylic acid (AA), and 2-bromooctanoic acid (2BA)) used caused a reduction in the symbiont levels per host relative to the water control (FIG. 5).

Based on the results from Example 4 showing decreased fitness in H. halys having reduced colonization by P. carbekii, the lower levels of the symbionts may lead to decreased fitness in the PHA inhibitor-treated insects. PHA synthase inhibitors are taken as being useful in the invention.

### Example 6. Disruption of Gut Symbiont Colonization in Insects by Altering the Biosynthesis of Cell Wall Components in the Symbionts

This example demonstrates the disruption of colonization of the gut symbiont P. carbekii in the brown marmorated stink bug, Halyomorpha halys (St\dot{a}l), through the administration of a UppP inhibitor, bacitracin.

Experimental Design

Halyomorpha halys Lab Colony Rearing and Maintenance

A Halyomorpha halys no-diapause lab colony was reared as described in Example 4. Egg clutches were collected daily from colony cages and placed into hatching containers (5 egg clutches per container, maximum) that contained 30 mL water tubes (stuffed with cotton), fresh green beans, and a seed mixture of peanuts.

Administration of a UppP Inhibitor by Egg Mass Treatment

A working concentration of bacitracin was made up to 100 μg/ml in water and spiked with Silwet® L-77 to a final concentration of 0.025% to increase the wettability and spreading of the agents on the eggs. As a negative control, no agents were added to the wetting solution, and as a positive control, 100 μg/ml of the antibiotic rifamycin S was used. Egg masses on leaf disks were removed from the colony in a single day during peak egg production. Each egg mass was then placed in a container with a paper towel at the bottom, and a tube of water plugged with cotton was provided as a water source for the hatchlings. 100 μl of the agent was pipetted onto the eggs to wet them completely. This allowed the agent to interact directly with the bacteria before the bacteria was able to colonize the host. Once the 1^{st} instar hatchlings molted to the 2^{nd} instar stage, food was provided in the form of 500 mg pellets of the artificial diet described above. The same food was provided to the 2^{nd} instars until they molted to the 3^{rd} instar stage. The third instars were collected and frozen to extract DNA to assay for the symbiont levels, as described in Example 4.

Results

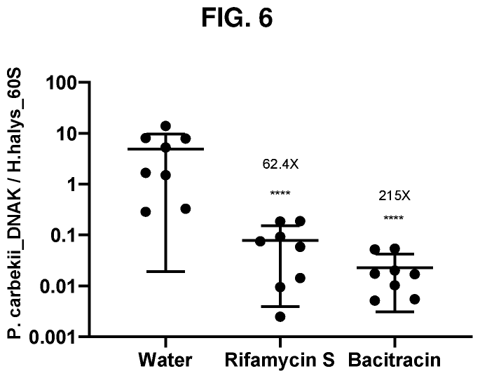

The levels of P. carbekii were significantly lower in the positive control (Rifamycin S) and the bacitracin treatment group compared to the negative control (FIG. 6). Based on the results from Example 4 showing decreased fitness in H. halys having reduced colonization by P. carbekii, the lower levels of the symbionts may lead to decreased fitness in the UppP inhibitor-treated insects. UppP inhibitors are taken as being useful in the invention.

### Example 7. Disruption of Gut Symbiont Colonization in Insects by Interfering with the Flagellar Machinery in the Symbionts

This example demonstrates the disruption of colonization of the gut symbiont P. carbekii in a hemipteran insect host, the brown marmorated stink bug (Halyomorpha halys (St\dot{a}l)), through the administration of a flagellar function inhibitor, cellulose.

Experimental Design

Halyomorpha halys Lab Colony Rearing and Maintenance

A Halyomorpha halys no-diapause lab colony was reared as described in Example 4. Egg clutches were collected daily from colony cages and placed into hatching containers (5 egg clutches per container, maximum) that contained 30 mL water tubes (stuffed with cotton), fresh green beans, and a seed mixture of peanuts.

Administration of Flagellar Function Inhibitors by Egg Mass Treatment

A working concentration of cellulose was made up to 100 μg/ml in water. The solution of cellulose was spiked with a non-ionic wetting solution to a final concentration of 0.025% to increase the wettability and spreading of the agent on the eggs. As a negative control, no agents were added to the wetting solution, and as a positive control, 100 μg/ml of the antibiotic rifamycin S was used. Egg masses on leaf disks were removed from the colony in a single day during peak egg production. Each egg mass was then placed in a container with a paper towel at the bottom, and a tube of water plugged with cotton was provided as a water source for the hatchlings. 100 μl of the agent was pipetted onto the eggs to wet them completely. This allowed the agent to interact directly with the bacteria even before the bacteria is able to colonize the host. Once the 1^{st} instar hatchlings molted to 2^{nd} instar stage, food was provided in the form of 500 mg pellets of the artificial diet described above. The same food was provided to the 2^{nd} instars until they molted to the 3rd instar stage. The third instars were collected and frozen to extract DNA to assay for the symbiont levels, as described in Example 4.

Results

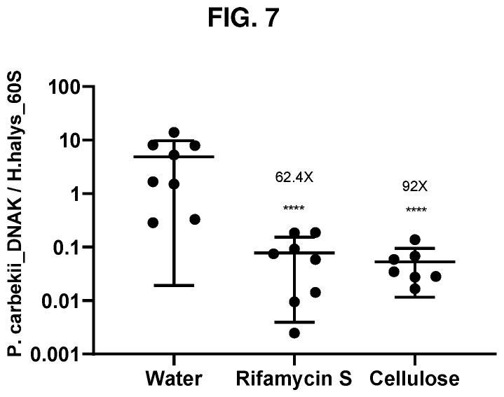

The levels of P. carbekii were significantly lower in the positive control (Rifamycin S) and in the cellulose treatment group compared to the negative control (FIG. 7). The bacterial flagellar function inhibitor used caused a reduction in the symbiont levels per host. Based on the results from Example 4 showing decreased fitness in H. halys having reduced colonization by P. carbekii, the lower levels of the symbionts may lead to decreased fitness in the bacterial flagellar function inhibitor-treated insects. Flagellar function inhibitors are taken as being useful in the invention.

### Example 8. Disruption of Symbiont Colonization in Stink Bugs Using Sugar Analogs

This example describes disruption of the gut symbiont P. carbekii colonization in the hemipteran brown marmorated stink bug, Halyomorpha halys (St\dot{a}l) by administration of sugar analogs. This example is provided to evaluate the ability of sugar analogs to kill and decrease the development, reproductive ability, longevity and endogenous bacterial populations, e.g., fitness, of a hemipteran insect.

Experimental Design

Identification of Genes Required for Synthesizing Core Oligosaccharides of P. carbekii

By searching the P. carbekii genome (AB012554.1) in Genbank, four genes for synthesizing core oligosaccharide have been identified (Table 11). The identification of these four genes suggests that P. carbekii could synthesize the core oligosaccharide on its cell surface. These data provide the grounds for disrupting P. carbekii colonization in Halyomorpha halys by inhibiting the core oligosaccharide synthesis process via administration of sugar analogs.

TABLE 11
Core oligosaccharide-related genes from the symbiont
Candidatus Pantoea carbekii in the brown
marmorated stink bug, Halyomorpha halys

| Essential enzymes | | Gene location in |
|---|---|---|
| for synthesis of | Gene | Candidatus Pantoea carbekii |
| core oligosaccharide | ID | genome (AB012554.1) |
| WaaA | KdtA | 126758 to 128047 |
| WaaC | RfaC | 130803 to 131774 |
| WaaF | RfaF | 131780 to 132826 |
| WaaG | RfaG | 128127 to 129263 |

Halyomorpha halys Lab Colony Rearing and Maintenance

A Halyomorpha halys no-diapause lab colony is obtained as described in Example 4. Following receipt from the BIRL, the insects are held in a growth chamber as described above and are provided a pellet diet. A green bean plant and a Euonymus japonicus plant are provided in the cage for H. halys oviposition and resting, respectively.

Administration of Sugar Analogs by Spraying on Egg Masses of Halyomorpha halys

Two sugar analogs, ADP-2-fluoroheptose (AFH) (Dohi et al., Chemistry, 14(31): 9530-9539, 2008) and 2-aryl-5-methyl-4-(5-aryl-furan-2-yl-methylene)-2,4-dihydro-pyrazol-3-ones (DHPO) (Moreau et al., Bioorg. Med. Chem. Lett., 18(14): 4022-4026, 2008), which inhibit the function of WaaC (heptosyl transferase), are synthesized by a Contract Research Organization (CRO).

The working concentrations of AFH and DHPO are 100 μg/ml in water. A total of 30 egg masses on leaf disks are removed from the colony in a single day during peak egg production. Ten egg masses are laid face-up in each well of a deep petri dish (15 mm×100 mm). AFH, DHPO or water (negative control) are applied on the egg masses (1 mL per petri dish) using a Master Airbrush Brand Compressor Model C-16-B Black Mini Airbrush Air Compressor. The compressor is cleaned with ethanol before, after, and between treatments. The liquid is fed through the compressor using a quarter inch tube. A new tube is used for each treatment.

Measurement of Halyomorpha halys Fitness and Fecundity

The sprayed egg masses are reared under the conditions described above. The number of hatched eggs is recorded for each egg mass and then averaged over all masses per replicate. The newly hatched nymphs in each container are reared to determine the number surviving to the second instar. The survival rate of the nymphs at each stadium is estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and dried completely in a 70° C. oven for 30 min. Finally, all fitness parameters are recorded. Green beans are not supplied to insects 24 h before sacrificing to exclude the weight of the diet.

Quantification of P. carbekii Titers by RT-qPCR

Total RNA is extracted from nymphs using RNA isolation and purification kits (both from Thermo Fisher Scientific), and the extracted RNA is eluted in 100 μL water. Quantitative reverse transcription PCR (RT-qCPR) is performed using a RT-qPCR kit (Thermo Fisher Scientific) with primers targeting the P. carbekii DNAKgene (forward primer sequence: TGCAGAAATTTGTGGCGGTG (SEQ ID NO: 1); reverse primer sequence: CGTTGCCTCAGAAAACGGTG (SEQ ID NO: 2)). Primers for the stink bug 60S rRNA gene (forward primer sequence: AACAGGCAAGCTGCTATCTC (SEQ ID NO: 3) and reverse primer sequence: CTGTCCCTTGGTGGTTCTTT (SEQ ID NO: 4)) are used to normalize the bacterial quantities. Each of the PCR mixtures is 10 μL in volume. RT-qPCR is performed using a PCR amplification ramp of 1.6° C./s and the following conditions: 1) 48° C. for 30 min; 2) 95° C. for 10 minutes; 3) 95° C. for 15 seconds; 4) 55° C. for 30 seconds; 5) repeat steps 3-4 40×, 6); 95° C. for 15 seconds; 7) 55° C. for 1 minute; 8) ramp change to 0.15° C./s; 9) 95° C. for 1 second. RT-qPCR data is analyzed using analytic software (Thermo Fisher Scientific).

Sugar analogs reducing the fitness or fecundity or both of H. halys offspring, in view of appropriate controls, are taken as useful in the invention.

### Example 9. Disruption of Gut Symbiont Colonization in the Bean Bug, Riptortus pedestris, by Altering Symbionts' Cell Wall Properties

This example demonstrates the disruption of colonization of the gut symbiont Burkholderia in a hemipteran insect, the bean bug (Riptortus pedestris) through the administration of the polyhydroxyalkanoate (PHA) synthesis inhibitor vanillin or a vanillin analog. This example is provided to evaluate the ability of this disruption to cause a fitness decrease in the insect.

The bean bug R. pedestris (Hemiptera: Heteroptera: Coreoidea) is a notorious pest of leguminous crops, such as soy-bean and cowpea. R. pedestris harbors a specific gut symbiont of the genus Burkholderia, which is acquired orally from the environment by second-instar nymphs. Bean bugs have a specialized symbiotic organ (crypts) in a posterior midgut fourth region (M4) to host the symbionts.

Experimental Design:

Insect Rearing and Burkholderia Infection

The R. pedestris bean bugs are reared in an insect incubator at 28° C. under a long-day condition of 16 h light and 8 h dark. Briefly, nymphs are reared in clean plastic containers supplied with soybean seeds and distilled water containing 0.05% ascorbic acid (DWA). The plastic containers are cleaned every day, and the soybean seeds and DWA are changed with fresh ones every 2 days. When the insects emerge as adults, they are transferred to larger plastic containers with soybean seeds and DWA. In addition, cotton pads are attached to the walls of the plastic containers for egg laying. Eggs are collected every day and transferred to new cages for hatching. When newborn nymphs molt to second-instar nymphs, DWA containing 10⁷ cells/ml cultured Burkholderia is provided in a small petri dish for the colonization by Burkholderia of the bean bugs. The Burkholderia symbiont used is the rifampicin-resistant (Rfr) spontaneous mutant strain RPE75 (provided by Dr. Takema Fukatsu, National Institute of Advanced Industrial Science and Technology (AIST), Tsukuba Center, Tsukuba, Japan).

Administration of Burkholderia Cultured with PHA Synthesis Inhibitor Vanillin

A PHA synthesis inhibitor, vanillin, is purchased from Sigma-Aldrich (Cat. no. V1104-2G). A working concentration of vanillin is made at 1 g/ml in YG medium (0.5% yeast extract, 0.4% glucose, and 0.1% NaCl). The symbiont strain is grown to an early log phase in YG medium (containing rifampicin at 50 μg/ml) on a gyratory shaker (150 rpm) at 30° C. For the positive control, Burkholderia is cultured in YG medium only. Colony-forming unit (CFU) values are estimated by plating the culture media on YG agar plates containing adequate antibiotics. Symbiont cells are harvested by centrifuging the culture media, suspended in DWA, and adjusted to 10⁴ CFU/mL in DWA.

Immediately after first instar nymphs molt to the second instar, DWA is removed from the rearing containers so that the nymphs are kept without drinking water overnight. Then, DWA containing 10⁴ CFU/mL symbiont cells is supplied to the rearing containers for 24 h, which the second instar nymphs can exploit to acquire the Burkholderia symbionts cultured with PHA synthase inhibitors or the positive control Burkholderia cultured in YG medium only. Then, the symbiont-containing DWA is replaced by symbiont-free DWA, and the nymphs are reared to adulthood.

Direct Feeding of PHA Synthesis Inhibitor Vanillin to R. pedestris

Immediately after first instar nymphs molt to the second instar, DWA is removed from the rearing containers so that the nymphs are kept without drinking water overnight. The following day, the vanillin solution (1 mg/ml) along with 10⁴ CFU/mL symbiont cells is supplied to the rearing containers for 24 h, which the second instar nymphs can exploit to acquire the PHA synthase inhibitor vanillin and Burkholderia symbionts. Positive controls are nymphs fed with 10⁴ CFU/mL symbiont cells only. Then, the symbiont-containing DWA is replaced by DWA, and the nymphs are reared to adulthood.

Quantification of Burkholderia Colonized in R. pedestris Midgut by qPCR

Quantitative PCR (qPCR) is performed using qPCR kits (Thermo Fisher) with primers BSdnaA-F and BSdnaA-R targeting a 0.15 kb region of the dnaA gene of the Burkholderia symbiont, as described in (Kikuchi et al., Applied and Environmental Microbiology, 77: 4075-4081, 2011; Kikuchi and Fukatsu, Molecular Ecology, 23: 1445-1456, 2014). Total DNA is extracted from the M4 and M4B parts of the midgut by using Blood & Cell Culture DNA Mini Kit (Qiagen, Cat number 13323). and the extracted DNA is eluted in 200 μL water. Each of the PCR mixtures contains 10 μL in volume. qPCR is performed using a qPCR amplification ramp of 1.6° C./s and the following conditions: 1) 95° C. for 10 minutes; 2) 95° C. for 15 seconds; 3) 60° C. for 30 seconds; 4) repeat steps 2-3 40×; 5) 95° C. for 15 seconds; 6) 60° C. for 1 minute; 7) ramp change to 0.15° C./s; 8) 95° C. for 1 second. A standard curve for the dnaA gene is generated with standard samples of the target PCR fragment amplified with the primers BSdnaA-F and BSdnaA-R. qPCR data is analyzed using analytical software (Thermo Fisher Scientific).

Measurement of R. pedestris Fitness

The survival rates after administration of Burkholderia cultured with PHA synthase inhibitor vanillin or direct feeding of vanillin to the second-instar nymphs and both positive controls are estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and are dried completely in a 70° C. oven for 30 min. Soybean seeds are not supplied to insects 24 h before sacrificing to exclude the weight of the soybean.

Vanillin or analogs thereof which reduce titers of Burkholderia in R. pedestris offspring, in view of appropriate controls, are taken as useful in the invention.

### Example 10. Disruption of Symbiont Colonization in the Bean Bug by Administration of Sugar Analogs

This example demonstrates the disruption of Burkholderia colonization in a hemipteran model, the bean bug (Riptortus pedestris) through the administration of the sugar analogs ADP-2-fluoroheptose (AFH) and 2-aryl-5-methyl-4-(5-aryl-furan-2-yl-methylene)-2,4-dihydro-pyrazol-3-ones (DHPO). This example is provided to evaluate the ability of this disruption to cause a fitness decrease in the insect.

Experimental Design

Insect Rearing and Burkholderia Infection

R. pedestris is reared as described in Example 6.

Administration of Burkholderia Cultured with Sugar Analogs

Two sugar analogs, ADP-2-fluoroheptose (AFH) (Dohi et al., Chemistry, 14(31): 9530-9539, 2008) and 2-aryl-5-methyl-4-(5-aryl-furan-2-yl-methylene)-2,4-dihydro-pyrazol-3-ones (DHPO) (Moreau et al., Bioorg. Med. Chem. Lett., 18(14): 4022-4026, 2008), which inhibit the function of WaaC (heptosyl transferase), are synthesized by a Contract Research Organization (CRO).

The working concentration of AFH and DHPO made in the YG medium is 1 g/ml. The symbiont strain is grown to an early log phase in YG medium (containing rifampicin at 50 μg/ml) on a gyratory shaker (150 rpm) at 30° C. The positive control of Burkholderia is cultured in YG medium only. Colony-forming unit (CFU) values are estimated by plating the culture media on YG agar plates containing adequate antibiotics. Symbiont cells are harvested by centrifuging the culture media, suspended in DWA, and adjusted to 10⁴ CFU/mL in DWA.

Immediately after first instar nymphs molt to the second instar, DWA is removed from the rearing containers so that the nymphs are kept without drinking water overnight. Then, DWA containing 10⁴ CFU/mL symbiont cells is supplied to the rearing containers for 24 h, which the second instar nymphs can exploit to acquire the Burkholderia symbionts cultured with AFH or DHPO or the positive control Burkholderia cultured in YG medium only. Then, the symbiont-containing DWA is replaced by symbiont-free DWA, and the nymphs are reared to adulthood.

Direct Feeding of Sugar Analogs to R. pedestris

AFH and DHPO are synthesized by CRO. The working solutions (1 g/ml) for AFH and DHPO are made from the stock into the distilled water. The two sugar analog working solutions are dispensed into the feeding tube and put into the plastic rearing container for bean bug feeding. Immediately after first instar nymphs molt to the second instar, DWA is removed from the rearing containers so that the nymphs are kept without drinking water overnight. The following day, the AFH and DHPO solution along with 10⁴ CFU/mL symbiont cells is supplied to the rearing containers for 24 h, which the second instar nymphs can exploit, leading to the acquisition of AFH or DHPO and Burkholderia symbionts. The positive control is nymphs fed with 10⁴ CFU/mL symbiont cells only. Then, the symbiont-containing DWA is replaced by DWA, and the nymphs are reared to adulthood.

Quantification of Burkholderia Colonized in R. pedestris Midgut by qPCR

Quantitative PCR (qCPR) is performed as described in Example 6.

Measurement of R. pedestris Fitness

The survival rates after administration of Burkholderia cultured with AFH or DHPO or direct feeding of AFH or DHPO to the second-instar nymphs and both positive controls are estimated every day until 25 days after hatching by counting the dead insects. The adult emergence rate is estimated by counting the newly molted adult insects from the late-fifth-instar nymphs. To measure the body length and weight, adult insects (3 days after molting) are sacrificed by submerging in acetone for 5 min and are dried completely in a 70° C. oven for 30 min. Finally, all fitness parameters are recorded. Soybean seeds are not supplied to insects 24 h before sacrificing to exclude the weight of the soybean.

Sugar analogs reducing titers of Burkholderia in R. pedestris offspring, in view of appropriate controls, are taken as useful in the invention.

### Other Embodiments

Some embodiments of the invention are within the following numbered paragraphs.

1. A method of decreasing the fitness of an insect comprising delivering to the insect an effective amount of a composition comprising a bacterial colonization-disrupting agent.

2. A method of inhibiting bacterial colonization in the gut of an insect comprising delivering to the insect an effective amount of a composition comprising a bacterial colonization-disrupting agent.

3. The method of paragraph 2, wherein the method is effective to increase the fitness of the insect relative to an untreated insect.

4. The method of any one of paragraphs 1-3, wherein the bacterial colonization-disrupting agent is a polyhydroxyalkanoate (PHA) synthesis inhibitor.

5. A method of decreasing the fitness of an insect comprising delivering to the insect an effective amount of a composition comprising a PHA synthesis inhibitor.

6. The method of paragraph 4 or 5, wherein the PHA synthesis inhibitor is vanillin.

7. The method of paragraph 4 or 5, wherein the PHA synthesis inhibitor is one or more compounds in Table 1.

8. The method of paragraph 4 or 5, wherein the PHA synthesis inhibitor is levulinic acid.

9. The method of paragraph 4 or 5, wherein the PHA synthesis inhibitor is acrylic acid.

10. The method of paragraph 4 or 5, wherein the PHA synthesis inhibitor is 2-bromooctanoic acid.

11. The method of any one of paragraphs 1-3, wherein the bacterial colonization-disrupting agent is an inhibitor of bacterial cell envelope biogenesis.

12. The method of paragraph 11, wherein the inhibitor of bacterial cell envelope biogenesis is a lipopolysaccharide (LPS) synthesis inhibitor.

13. A method of decreasing the fitness of an insect comprising delivering to the insect an effective amount of a composition comprising an LPS synthesis inhibitor.

14. The method of paragraph 12 or 13, wherein the LPS synthesis inhibitor is an inhibitor of core oligosaccharide synthesis in the bacteria.

15. The method of paragraph 14, wherein the LPS synthesis inhibitor inhibits an enzyme involved in core oligosaccharide synthesis in the bacteria.

16. The method of paragraph 15, wherein the enzyme has at least 40%, 50%, 60%, 70%, 80%, 90%, 95%, 98%, 99%, or 100% sequence identity to a polypeptide having the amino acid sequence of WaaA, WaaC, WaaF, or WaaG.

17. The method of any one of paragraphs 12-16, wherein the LPS synthesis inhibitor is a sugar.

18. The method of paragraph 17, wherein the sugar is ADP-2-fluoroheptose (AFH).

19. The method of paragraph 17, wherein the sugar is 2-aryl-5-methyl-4-(5-aryl-furan-2-yl-methylene)-2,4-dihydro-pyrazol-3-ones (DHPO).

20. The method of paragraph 17, wherein the sugar is AFH and DHPO.

21. The method of paragraph 17, wherein the sugar is one or more compounds in Table 7.

22. The method of paragraph 14, wherein the LPS synthesis inhibitor inhibits expression of a gene involved in core oligosaccharide synthesis in the bacteria.

23. The method of paragraph 22, wherein the gene has at least 40%, 50%, 60%, 70%, 80%, 90%, 95%, 98%, 99%, or 100% sequence identity to a polynucleotide having the nucleotide sequence of waaA, waaC, waaF, or waaG.

24. The method of any one of paragraphs 1-3, wherein the bacterial colonization-disrupting agent is an inhibitor of bacterial cell wall biogenesis.

25. The method of paragraph 24, wherein the inhibitor of bacterial cell wall biogenesis is an inhibitor of undecaprenyl pyrophosphate phosphatase (UppP).

26. The method of paragraph 25, wherein the inhibitor of UppP is bacitracin.

27. The method of any one of paragraphs 1-3, wherein the bacterial colonization-disrupting agent is an inhibitor of flagellar function.

28. The method of paragraph 27, wherein the inhibitor of flagellar function is cellulose.

29. The method of any one of paragraphs 1-28, wherein the insect is a plant pest.

30. The method of paragraph 29, wherein the plant pest is of the order Coleoptera, Diptera, Hemiptera, Lepidoptera, Orthoptera, Thysanoptera, or Acarina.

31. The method of paragraph 30, wherein the insect is a stink bug, bean bug, beetle, weevil, fly, aphid, whitefly, leafhopper, scale, moth, butterfly, grasshopper, cricket, thrip, or mite.

32. The method of paragraph 31, wherein the insect is of the genus Riptortus.

33. The method of paragraph 32, wherein the insect is of the genus Halyomorpha.

34. The method of any one of paragraphs 1-33, wherein the insect is a vector of an animal pathogen and/or a human pathogen.

35. The method of paragraph 34, wherein the insect is a mosquito, a midge, a louse, a sandfly, a tick, a triatomine bug, a tsetse fly, or flea.

36. The method of any one of paragraphs 1-35, wherein the bacteria is an endosymbiotic bacteria.

37. The method of paragraph 36, wherein the endosymbiont resides in the gut of the insect.

38. The method of paragraph 37, wherein the bacteria resides in a specialized cell or a specialized organ in the gut of the insect.

39. The method of paragraph 38, wherein the specialized organ is a midgut crypt or a bacteriome.

40. The method of paragraph 38, wherein the specialized cell is a bacteriocyte.

41. The method of any one of paragraphs 36-40, wherein the endosymbiotic bacteria is of the genus

Burkholderia.

42. The method of any one of paragraphs 36-40, wherein the endosymbiotic bacteria is of the genus Pantoea.

43. The method of any one of paragraphs 1, 2, and 4-41, wherein the method is effective to decrease the fitness of the insect relative to an untreated insect.

44. The method of paragraph 43, wherein the decrease in fitness of the insect is a decrease in reproductive ability, survival, rate of development, number of hatched eggs, adult emergence rate, body length, or weight.

45. The method of any one of paragraphs 1-44, wherein the method is effective to decrease bacterial colonization in the gut of the insect relative to an untreated insect.

46. The method of any one of paragraphs 1-45, wherein the composition is delivered to the insect to at least one habitat where the insect grows, lives, or reproduces.

47. The method of any one of paragraphs 1-46, wherein the composition is a liquid, a solid, an aerosol, a paste, a gel, or a gas composition.

48. The method of any one of paragraphs 1-47, wherein the composition is delivered as an insect comestible composition for ingestion by the insect.

49. The method of any one of paragraphs 1-48, wherein the composition is delivered to eggs of the insect.

50. The method of any one of paragraphs 1-49, wherein the composition is delivered to the insect by ingestion, infusion, injection, or spraying.

51. The method of any one of paragraphs 1-50, wherein the composition comprises an agriculturally acceptable carrier.

52. A modified insect produced by a method comprising contacting the insect with a composition comprising a bacterial colonization-disrupting agent in accordance with the methods of any one of paragraphs 1-51.

53. A screening assay to identify a bacterial colonization-disrupting agent, comprising the steps of

(a) exposing a target insect to one or more agents; and

(b) identifying an agent that:
(i) decreases the fitness of the target insect, and
(ii) inhibits colonization of a bacterium in the gut of the target insect.

54. The assay of paragraph 53, wherein the decrease in fitness is decreased survival of the target insect.

55. The assay of paragraph 53, wherein the decrease in fitness is a decrease in reproductive ability, survival, rate of development, number of hatched eggs, adult emergence rate, body length, or body mass.

56. The assay of any one of paragraphs 53-55, wherein the bacteria is an endosymbiotic bacteria.

57. The assay of paragraph 56, wherein the endosymbiotic bacteria resides in the gut of the insect.

58. The assay of paragraph 57, wherein the bacteria resides in a specialized cell or a specialized organ in the gut of the insect.

59. The assay of paragraph 58, wherein the specialized organ is a midgut crypt or a bacteriome.

60. The assay of paragraph 58, wherein the specialized cell is a bacteriocyte.

61. The assay of any one of paragraphs 53-58, wherein the bacterium is of the genus Burkholderia.

62. The assay of any one of paragraphs 53-60, wherein the bacterium is of the genus Pantoea.

63. The assay of any one of paragraphs 53-62, wherein the insect is a plant pest.

64. The assay of paragraph 63, wherein the plant pest is of the order Coleoptera, Diptera, Hemiptera, Lepidoptera, Orthoptera, Thysanoptera, or Acarina.

65. The assay of any one of paragraphs 53-62, wherein the insect is a vector of an animal pathogen and/or a human pathogen.

66. The assay of paragraph 65, wherein the insect is a mosquito, a midge, a louse, a sandfly, a tick, a triatomine bug, a tsetse fly, or flea.

67. A modified insect produced by a method comprising contacting the insect with a composition comprising a bacterial colonization-disrupting agent identified by the screening assay of any one of paragraphs 53-66.

68. A method of decreasing the fitness of an insect comprising delivering to the insect an effective amount of a composition comprising a bacterial colonization-disrupting agent identified by the screening assay of any one of paragraphs 53-66.

69. A composition comprising a bacterial colonization-disrupting agent and a carrier, wherein the composition is formulated for delivery to an insect, or a habitat thereof.

70. The composition of paragraph 69, wherein the bacterial colonization-disrupting agent is a polyhydroxyalkanoate (PHA) synthesis inhibitor.

71. The composition of paragraph 70, wherein the PHA synthesis inhibitor is vanillin.

72. The composition of paragraph 70, wherein the PHA synthesis inhibitor is one or more compounds in Table 1.

73. The composition of paragraph 70, wherein the PHA synthesis inhibitor is levulinic acid.

74. The composition of paragraph 70, wherein the PHA synthesis inhibitor is acrylic acid.

75. The composition of paragraph 70, wherein the PHA synthesis inhibitor is 2-bromooctanoic acid.

76. The composition of paragraph 69, wherein the bacterial colonization-disrupting agent is an inhibitor of bacterial cell envelope biogenesis.

77. The composition of paragraph 76, wherein the inhibitor of bacterial cell envelope biogenesis is a lipopolysaccharide (LPS) synthesis inhibitor.

78. The composition of paragraph 77, wherein the LPS synthesis inhibitor is an inhibitor of core oligosaccharide synthesis in the bacteria.

79. The composition of paragraph 77 or 78, wherein the LPS synthesis inhibitor inhibits an enzyme involved in core oligosaccharide synthesis in the bacteria.

80. The composition of paragraph 79, wherein the enzyme has at least 40%, 50%, 60%, 70%, 80%, 90%, 95%, 98%, 99%, or 100% sequence identity to a polypeptide having the amino acid sequence of WaaA, WaaC, WaaF, or WaaG.

81. The composition of any one of paragraphs 78-80, wherein the LPS synthesis inhibitor is a sugar.

82. The composition of paragraph 81, wherein the sugar is ADP-2-fluoroheptose (AFH).

83. The composition of paragraph 81, wherein the sugar is 2-aryl-5-methyl-4-(5-aryl-furan-2-yl-methylene)-2,4-dihydro-pyrazol-3-ones (DHPO).

84. The composition of paragraph 81, wherein the sugar is AFH and DHPO.

85. The composition of paragraph 81, wherein the sugar is one or more compounds in Table 7.

86. The composition of paragraph 77 or 78, wherein the LPS synthesis inhibitor inhibits expression of a gene involved in core oligosaccharide synthesis in the bacteria.

87. The composition of paragraph 86, wherein the gene has at least 40%, 50%, 60%, 70%, 80%, 90%, 95%, 98%, 99%, or 100% sequence identity to a polynucleotide having the nucleotide sequence of waaA, waaC, waaF, or waaG.

88. The composition of paragraph 69, wherein the bacterial colonization-disrupting agent is an inhibitor of bacterial cell wall biogenesis.

89. The composition of paragraph 88, wherein the inhibitor of bacterial cell wall biogenesis is an inhibitor of UppP.

90. The composition of paragraph 89, wherein the inhibitor of UppP is bacitracin.

91. The composition of paragraph 69, wherein the bacterial colonization-disrupting agent is an inhibitor of flagellar function.

92. The composition of paragraph 91, wherein the inhibitor of flagellar function is cellulose.

93. The composition of any one of paragraphs 69-92, wherein the bacterial colonization-disrupting agent is at least 0.1%, 0.2%, 0.4%, 0.5%, 0.8%, 1%, 2%, 5%, 10%, 20%, 30%, 40%, 50%, 60%, 70%, 80%, or 90% of the composition.

94. The composition of any one of paragraphs 69-93, wherein the carrier is a liquid, a solid, an aerosol, a paste, a gel, or a gas composition.

95. The composition of any one of paragraphs 69-93, wherein the carrier is a sugar syrup, corn syrup, or honey.

96. The composition of any one of paragraphs 69-93, wherein the carrier is a nanoparticle or lipid membrane.

97. The composition of any one of paragraphs 69-96, wherein the composition is formulated for delivery to the insect by ingestion, infusion, injection, spraying, smoking, or fogging.

98. The composition of any one of paragraphs 69-97, wherein the composition is formulated for delivery to at least one habitat where the insect grows, lives, reproduces, or feeds.

99. The composition of any one of paragraphs 69-98, wherein the composition is formulated for delivery to a plant ingested by the insect.

100. A method for decreasing colonization by a bacterium of a gut of a stink bug, the method comprising:
(a) providing a composition comprising vanillin or an analog thereof; and
(b) delivering said composition to a stink bug egg, wherein the gut of the stink bug hatched from the egg has decreased colonization by the bacterium relative to the gut of a stink bug hatched from an untreated egg.

101. The method of paragraph 100, wherein the composition is delivered to an egg mass of a stink bug.

102. The method of paragraph 100, wherein the decrease in colonization by the bacterium decreases the fitness of the stink bug.

103. The method of paragraph 102, wherein the decrease in the fitness of the stink bug is a decrease in reproductive ability, survival, rate of development, number of eggs, number of hatched eggs, adult emergence rate, body length, body width, body mass, or cuticle thickness.

104. The method of paragraph 100, wherein the colonization is in the v4 region of the gut.

105. The method of paragraph 104, wherein colonization by the bacterium of the v4 region of the gut is decreased by at least 10%.

106. The method of paragraph 104, wherein the size of the v4 region of the gut is decreased.

107. The method of paragraph 100, wherein the stink bug is a Halyomorpha species.

108. The method of paragraph 107, wherein the stink bug is Halyomorpha halys.

109. The method of paragraph 100, wherein the bacterium is an endosymbiont.

110. The method of paragraph 109, wherein the endosymbiont is of the genus Pantoea.

111. The method of paragraph 110, wherein the endosymbiont is Candidatus Pantoea carbekii.

112. The method of paragraph 100, wherein the composition is a liquid, a solid, an aerosol, a paste, a gel, or a gas composition.

113. The method of paragraph 100, wherein the composition is delivered as a spray.

114. The method of paragraph 100, wherein the composition comprises an agriculturally acceptable carrier.

115. The method of paragraph 100, wherein the composition comprises a wetting solution.

Although the foregoing invention has been described in some detail by way of illustration and example for purposes of clarity of understanding, the descriptions and examples should not be construed as limiting the scope of the invention. The disclosures of all patent and scientific literature cited herein are expressly incorporated in their entirety by reference.

What is claimed is:

1. A method for decreasing colonization by a bacterium of a gut of a stink bug, the method comprising:
(a) providing a composition comprising vanillin or an analog thereof; and
(b) delivering said composition to a stink bug egg, wherein the gut of the stink bug hatched from the egg has decreased colonization by the bacterium relative to the gut of a stink bug hatched from an untreated egg.

2. The method of claim 1, wherein the composition is delivered to an egg mass of a stink bug.

3. The method of claim 1, wherein the decrease in colonization by the bacterium decreases the fitness of the stink bug.

4. The method of claim 3, wherein the decrease in the fitness of the stink bug is a decrease in reproductive ability, survival, rate of development, number of eggs, number of hatched eggs, adult emergence rate, body length, body width, body mass, or cuticle thickness.

5. The method of claim 1, wherein the colonization is in the v4 region of the gut.

6. The method of claim 5, wherein colonization by the bacterium of the v4 region of the gut is decreased by at least 10%.

7. The method of claim 5, wherein the size of the v4 region of the gut is decreased.

8. The method of claim 1, wherein the stink bug is a Halyomorpha species.

9. The method of claim 8, wherein the stink bug is Halyomorpha halys.

10. The method of claim 1, wherein the bacterium is an endosymbiont.

11. The method of claim 10, wherein the endosymbiont is of the genus Pantoea.

12. The method of claim 11, wherein the endosymbiont is Candidatus Pantoea carbekii.

13. The method of claim 1, wherein the composition is a liquid, a solid, an aerosol, a paste, a gel, or a gas composition.

14. The method of claim 1, wherein the composition is delivered as a spray.

15. The method of claim 1, wherein the composition comprises an agriculturally acceptable carrier.

16. The method of claim 1, wherein the composition comprises a wetting solution.


SEQUENCE LISTING (38 sequences)

SEQ ID NO: 1 - DNA, 20 bp, Artificial Sequence
  Synthetic Construct
tgcagaaatttgtggcggtg

SEQ ID NO: 2 - DNA, 20 bp, Artificial Sequence
  Synthetic Construct
cgttgcctcagaaaacggtg

SEQ ID NO: 3 - DNA, 20 bp, Artificial Sequence
  Synthetic Construct
aacaggcaagctgctatctc

SEQ ID NO: 4 - DNA, 20 bp, Artificial Sequence
  Synthetic Construct
ctgtcccttggtggttcttt

SEQ ID NO: 5 - DNA, 29 bp, Artificial Sequence
  Synthetic Construct
gcatataaagattttactctttaggtggc

SEQ ID NO: 6 - DNA, 23 bp, Artificial Sequence
  Synthetic Construct
ctcgaaagcaccaatccatttct

SEQ ID NO: 7 - DNA, 20 bp, Artificial Sequence
  Synthetic Construct
cgaatcccattgtttgtgtg

SEQ ID NO: 8 - DNA, 20 bp, Artificial Sequence
  Synthetic Construct
agggtctcctcctcctgatg

SEQ ID NO: 9 - DNA, 1526 bp, Carsonella ruddii
tatccagccacaggttcccctacagctaccttgttacgacttcaccccagttacaaatcataccgttgtaatagtaaaattacttatgatacaatttacttccatggtgtgacgggcggtgtgtacaaggctcgagaacgtattcaccgtaacattctgatttacgattactagcgattccaacttcatgaaatcgagttacagatttcaatccgaactaagaatattttttaagattagcattatgttgccatatagcatataactttttgtaatactcattgtagcacgtgtgtagccctacttataagggccatgatgacttgacgtcgtcctcaccttcctccaatttatcattggcagtttcttattagttctaatatatttttagtaaaataagataagggttgcgctcgttataggacttaacccaacatttcacaacacgagctgacgacagccatgcagcacctgtctcaaagctaaaaaagctttattatttctaataaattctttggatgtcaaaagtaggtaagatttttcgtgttgtatcgaattaaaccacatgctccaccgcttgtgcgagcccccgtcaattcatttgagttttaaccttgcggtcgtaatccccaggcggtcaacttaacgcgttagctttttcactaaaaatatataactttttttcataaaacaaaattacaattataatatttaataaatagttgacatcgtttactgcatggactaccagggtatctaatcctgtttgctccccatgctttcgtgtattagtgtcagtattaaaatagaaatacgccttcgccactagtattctttcagatatctaagcatttcactgctactcctgaaattctaatttcttcttttatactcaagtttataagtattaatttcaatattaaattactttaataaatttaaaaattaatttttaaaaacaacctgcacaccctttacgcccaataattccgattaacgcttgcacccctcgtattaccgcggctgctggcacgaagttagccggtgcttcttttacaaataacgtcaaagataatatttttttattataaaatctcttcttactttgttgaaagtgttttacaaccctaaggccttcttcacacacgcgatatagctggatcaagctttcgctcattgtccaatatcccccactgctgccttccgtaaaagtttgggccgtgtctcagtcccaatgtggttgttcatcctctaagatcaactacgaatcatagtcttgttaagcttttactttaacaactaactaattcgatataagctcttctattagcgaacgacattctcgttctttatccattaggatacatattgaattactatacatttctatatacttttctaatactaataggtagattcttatatattactcacccgttcgctgctaattatttttttaataattcgcacaacttgcatgtgttaagcttatcgctagcgttcaatctgagctatgatcaaactca

SEQ ID NO: 10 - DNA, 1536 bp, Candidatus Portiera aleyrodidarum BT-B
aagagtttgatcatggctcagattgaacgctagcggcagacataacacatgcaagtcgagcggcatcatacaggttggcaagcggcgcacgggtgagtaatacatgtaaatatacctaaaagtggggaataacgtacggaaacgtacgctaataccgcataattattacgagataaagcaggggcttgataaaaaaaatcaaccttgcgcttttagaaaattacatgccggattagctagttggtagagtaaaagcctaccaaggtaacgatccgtagctggtctgagaggatgatcagccacactgggactgagaaaaggcccagactcctacgggaggcagcagtggggaatattggacaatggggggaaccctgatccagtcatgccgcgtgtgtgaagaaggcctttgggttgtaaagcactttcagcgaagaagaaaagttagaaaataaaaagttataactatgacggtactcgcagaagaagcaccggctaactccgtgccagcagccgcggtaagacggagggtgcaagcgttaatcagaattactgggcgtaaagggcatgtaggtggtttgttaagctttatgtgaaagccctatgcttaacataggaacggaataaagaactgacaaactagagtgcagaagaggaaggtagaattcccggtgtagcggtgaaatgcgtagatatctggaggaataccagttgcgaaggcgaccttctgggctgacactgacactgagatgcgaaagcgtggggagcaaacaggattagataccctggtagtccacgctgtaaacgatatcaactagccgttggattcttaaagaattttgtggcgtagctaacgcgataagttgatcgcctggggagtacggtcgcaaggctaaaactcaaatgaattgacgggggcccgcacaagcggtggagcatgtggtttaattcgatgcaacgcgcaaaaccttacctactcttgacatccaaagtactttccagagatggaagggtgccttagggaactttgagacaggtgctgcatggctgtcgtcagctcgtgttgtgaaatgttgggttaagtcccgtaacgagcgcaacccttgtccttagttgccaacgcataaggcgggaactttaaggagactgctggtgataaaccggaggaaggtggggacgacgtcaagtcatcatggcccttaagagtagggcaacacacgtgctacaatggcaaaaacaaagggtcgcaaaatggtaacatgaagctaatcccaaaaaaattgtcttagttcggattggagtctgaaactcgactccataaagtcggaatcgctagtaatcgtgaatcagaatgtcacggtgaatacgttctcgggccttgtacacaccgcccgtcacaccatggaagtgaaatgcaccagaagtggcaagtttaaccaaaaaacaggagaacagtcactacggtgtggttcatgactggggtgaagtcgtaacaaggtagctgtaggggaacctgtggctggatcacctccttaa

SEQ ID NO: 11 - DNA, 1540 bp, Buchnera aphidicola str. APS (Acyrthosiphon pisum)
agagtttgatcatggctcagattgaacgctggcggcaagcctaacacatgcaagtcgagcggcagcgagaagagagcttgctctctttgtcggcaagcggcaaacgggtgagtaatatctggggatctacccaaaagagggggataactactagaaatggtagctaataccgcataatgttgaaaaaccaaagtgggggaccttttggcctcatgcttttggatgaacccagacgagattagcttgttggtagagtaatagcctaccaaggcaacgatctctagctggtctgagaggataaccagccacactggaactgagacacggtccagactcctacgggaggcagcagtggggaatattgcacaatgggcgaaagcctgatgcagctatgccgcgtgtatgaagaaggccttagggttgtaaagtactttcagcggggaggaaaaaaataaaactaataattttatttcgtgacgttacccgcagaagaagcaccggctaactccgtgccagcagccgcggtaatacggagggtgcaagcgttaatcagaattactgggcgtaaagagcgcgtaggtggttttttaagtcaggtgtgaaatccctaggctcaacctaggaactgcatttgaaactggaaaactagagtttcgtagagggaggtagaattctaggtgtagcggtgaaatgcgtagatatctggaggaatacccgtggcgaaagcggcctcctaaacgaaaactgacactgaggcgcgaaagcgtggggagcaaacaggattagataccctggtagtccatgccgtaaacgatgtcgacttggaggttgtttccaagagaagtgacttccgaagctaacgcattaagtcgaccgcctggggagtacggccgcaaggctaaaactcaaatgaattgacgggggcccgcacaagcggtggagcatgtggtttaattcgatgcaacgcgaaaaaccttacctggtcttgacatccacagaattctttagaaataaagaagtgccttcgggagctgtgagacaggtgctgcatggctgtcgtcagctcgtgttgtgaaatgttgggttaagtcccgcaacgagcgcaacccttatcccctgttgccagcggttcggccgggaactcagaggagactgccggttataaaccggaggaaggtggggacgacgtcaagtcatcatggcccttacgaccagggctacacacgtgctacaatggtttatacaaagagaagcaaatctgcaaagacaagcaaacctcataaagtaaatcgtagtccggactggagtctgcaactcgactccacgaagtcggaatcgctagtaatcgtggatcagaatgccacggtgaatacgttcccgggccttgtacacaccgcccgtcacaccatgggagtgggttgcaaaagaagcaggtatcctaaccctttaaaaggaaggcgcttaccactttgtgattcatgactggggtgaagtcgtaacaaggtaaccgtaggggaacctgcggttggatcacctcctt

SEQ ID NO: 12 - DNA, 1552 bp, Buchnera aphidicola str. Sg (Schizaphis graminum)
aaactgaagagtttgatcatggctcagattgaacgctggcggcaagcctaacacatgcaagtcgagcggcagcgaaaagaaagcttgctttcttgtcggcgagcggcaaacgggtgagtaatatctggggatctgcccaaaagagggggataactactagaaatggtagctaataccgcataaagttgaaaaaccaaagtgggggaccttttttaaaggcctcatgcttttggatgaacccagacgagattagcttgttggtaaggtaaaagcttaccaaggcaacgatctctagctggtctgagaggataaccagccacactggaactgagacacggtccagactcctacgggaggcagcagtggggaatattgcacaatgggcgaaagcctgatgcagctatgccgcgtgtatgaagaaggccttagggttgtaaagtactttcagcggggaggaaaaaattaaaactaataattttattttgtgacgttacccgcagaagaagcaccggctaactccgtgccagcagccgcggtaatacggagggtgcgagcgttaatcagaattactgggcgtaaagagcacgtaggtggttttttaagtcagatgtgaaatccctaggcttaacctaggaactgcatttgaaactgaaatgctagagtatcgtagagggaggtagaattctaggtgtagcggtgaaatgcgtagatatctggaggaatacccgtggcgaaagcggcctcctaaacgaatactgacactgaggtgcgaaagcgtggggagcaaacaggattagataccctggtagtccatgccgtaaacgatgtcgacttggaggttgtttccaagagaagtgacttccgaagctaacgcgttaagtcgaccgcctggggagtacggccgcaaggctaaaactcaaatgaattgacgggggcccgcacaagcggtggagcatgtggtttaattcgatgcaacgcgaaaaaccttacctggtcttgacatccacagaattttttagaaataaaaaagtgccttcgggaactgtgagacaggtgctgcatggctgtcgtcagctcgtgttgtgaaatgttgggttaagtcccgcaacgagcgcaacccttatcccctgttgccagcggttcggccgggaactcagaggagactgccggttataaaccggaggaaggtggggacgacgtcaagtcatcatggcccttacgaccagggctacacacgtgctacaatggtttatacaaagagaagcaaatctgtaaagacaagcaaacctcataaagtaaatcgtagtccggactggagtctgcaactcgactccacgaagtcggaatcgctagtaatcgtggatcagaatgccacggtgaatacgttcccgggccttgtacacaccgcccgtcacaccatgggagtgggttgcaaaagaagcagatttcctaaccacgaaagtggaaggcgtctaccactttgtgattcatgactggggtgaagtcgtaacaaggtaaccgtaggggaacctgcggttggatcacctcctta

SEQ ID NO: 13 - DNA, 828 bp, Buchnera aphidicola BCc
atgagatcattaatatataaaaatcatgttccaattaaaaaattaggacaaaattttttacagaataaagaaattattaatcagataattaatttaataaatattaataaaaatgataatattattgaaataggatcaggattaggagcgttaacttttcctatttgtagaatcattaaaaaaatgatagtattagaaattgatgaagatcttgtgttttttttaactcaaagtttatttattaaaaaattacaaattataattgctgatattataaaatttgatttttgttgttttttttctttacagaaatataaaaaatataggtttattggtaatttaccatataatattgctactatattttttttaaaaacaattaaatttctttataatataattgatatgcattttatgtttcaaaaagaagtagcaaagagattattagctactcctggtactaaagaatatggtagattaagtattattgcacaatatttttataagatagaaactgttattaatgttaataaatttaatttttttcctactcctaaagtagattctacttttttacgatttactcctaaatattttaatagtaaatataaaatagataaacatttttctgttttagaattaattactagattttcttttcaacatagaagaaaatttttaaataataatttaatatctttattttctacaaaagaattaatttctttagatattgatccatattcaagagcagaaaatgtttctttaattcaatattgtaaattaatgaaatattatttgaaaagaaaaattttatgtttagattaa

SEQ ID NO: 14 - DNA, 921 bp, Buchnera aphidicola (Cinara tujafilina)
ttatcttatttcacatatacgtaatattgcgctgcgtgcacgaggatttttttgaatttcagatatatttggtttaatacgtttaataaaacgtatttttttttttatttttcttatttgcaattcagtaataggaagttttttaggtatatttggataattactgtaattcttaataaagttttttacaatcctatcttcaatagaatgaaaactaataatagcaatttttgatccggaatgtaatatgttaataataatttttaatattttatgtaattcatttatttcttggttaatatatattcgaaaagcttgaaatgttctcgtagctggatgtttaaatttgtcatattttgggattgatttttttatgatttgaactaactctaacgtgcttgttatggtttttttttttatttgtaatatgatggctcgggatattttttttgcgtatttttcttcgccaaaattttttattacctgttctattgttttttggtttgttttttttaaccattgactaactgatattccagatttagggttcatacgcatatctaaaggtccatcattcataaatgaaaatcctcggatactagaatttaactgtattgaagaaatacctaaatctaataatattccatctattttatctctatttttttctttttttaatattttttcaatattagaaaatttacctaaaaatattttaaatcgcgaatcttttattttttttccgatttttatagattgtgggtcttgatcaatactatataactttccattaacccctaattcttgaagaattgcttttgaatgaccaccacctccaaatgtacaatcaacatatgtaccgtctttttttatttttaagtattgtatgatttcttttgttaaaacaggtttatgaatcat

SEQ ID NO: 15 - DNA, 822 bp, Buchnera aphidicola str. G002 (Myzus persicae)
atgaaaagtataaaaacttttaaaaaacactttcctgtgaaaaaatatggacaaaattttcttattaataaagagatcataaaaaatattgttaaaaaaattaatccaaatatagaacaaacattagtagaaatcggaccaggattagctgcattaactgagcccatatctcagttattaaaagagttaatagttattgaaatagactgtaatctattatattttttaaaaaaacaaccattttattcaaaattaatagttttttgtcaagatgctttaaactttaattatacaaatttattttataaaaaaaataaattaattcgtatttttggtaatttaccatataatatctctacatctttaattatttttttatttcaacacattagagtaattcaagatatgaattttatgcttcaaaaagaagttgctgcaagattaattgcattacctggaaataaatattacggtcgtttgagcattatatctcaatattattgtgatatcaaaattttattaaatgttgctcctgaagatttttggcctattccgagagttcattctatatttgtaaatttaacacctcatcataattctccttattttgtttatgatattaatattttaagccttattacaaataaggctttccaaaatagaagaaaaatattacgtcatagtttaaaaaatttattttctgaaacaactttattaaatttagatattaatcccagattaagagctgaaaatatttctgtttttcagtattgtcaattagctaattatttgtataaaaaaaattatactaaaaaaaattaa

SEQ ID NO: 16 - DNA, 822 bp, Buchnera aphidicola str. Ak (Acyrthosiphon kondoi)
attataaaaaattttaaaaaacattttcctttaaaaaggtatggacaaaattttcttgtcaatacaaaaactattcaaaagataattaatataattaatccaaacaccaaacaaacattagtggaaattggacctggattagctgcattaacaaaaccaatttgtcaattattagaagaattaattgttattgaaatagatcctaatttattgtttttattaaaaaaacgttcattttattcaaaattaacagttttttatcaagacgctttaaatttcaattatacagatttgttttataagaaaaatcaattaattcgtgtttttggaaacttgccatataatatttctacatctttaattatttctttattcaatcatattaaagttattcaagatatgaattttatgttacagaaagaggttgctgaaagattaatttctattcctggaaataaatcttatggccgtttaagcattatttctcagtattattgtaaaattaaaatattattaaatgttgtacctgaagattttcgacctataccgaaagtgcattctgtttttatcaatttaactcctcataccaattctccatattttgtttatgatacaaatatcctcagttctatcacaagaaatgcttttcaaaatagaaggaaaattttgcgtcatagtttaaaaaatttattttctgaaaaagaactaattcaattagaaattaatccaaatttacgagctgaaaatatttctatctttcagtattgtcaattagctgattatttatataaaaaattaaataatcttgtaaaaatcaattaa

SEQ ID NO: 17 - DNA, 822 bp, Buchnera aphidicola str. Ua (Uroleucon ambrosiae)
atgatactaaataaatataaaaaatttattcctttaaaaagatacggacaaaattttcttgtaaatagagaaataatcaaaaatattatcaaaataattaatcctaaaaaaacgcaaacattattagaaattggaccgggtttaggtgcgttaacaaaacctatttgtgaatttttaaatgaacttatcgtcattgaaatagatcctaatatattatcttttttaaagaaatgtatattttttgataaattaaaaatatattgtcataatgctttagattttaattataaaaatatattctataaaaaaagtcaattaattcgtatttttggaaatttaccatataatatttctacatctttaataatatatttatttcggaatattgatattattcaagatatgaattttatgttacaacaagaagtggctaaaagattagttgctattcctggtgaaaaactttatggtcgtttaagtattatatctcaatattattgtaatattaaaatattattacatattcgacctgaaaattttcaacctattcctaaagttaattcaatgtttgtaaatttaactccgcatattcattctccttattttgtttatgatattaatttattaactagtattacaaaacatgcttttcaacatagaagaaaaatattgcgtcatagtttaagaaattttttttctgagcaagatttaattcatttagaaattaatccaaatttaagagctgaaaatgtttctattattcaatattgtcaattggctaataatttatataaaaaacataaacagtttattaataattaa

SEQ ID NO: 18 - DNA, 816 bp, Buchnera aphidicola (Aphis glycines)
atgaaaaagcatattcctataaaaaaatttagtcaaaattttcttgtagatttgagtgtgattaaaaaaataattaaatttattaatccgcagttaaatgaaatattggttgaaattggaccgggattagctgctatcactcgacctatttgtgatttgatagatcatttaattgtgattgaaattgataaaattttattagatagattaaaacagttctcattttattcaaaattaacagtatatcatcaagatgctttagcatttgattacataaagttatttaataaaaaaaataaattagttcgaatttttggtaatttaccatatcatgtttctacgtctttaatattgcatttatttaaaagaattaatattattaaagatatgaattttatgctacaaaaagaagttgctgaacgtttaattgcaactccaggtagtaaattatatggtcgtttaagtattatttctcaatattattgtaatataaaagttttattgcatgtgtcttcaaaatgttttaaaccagttcctaaagtagaatcaatttttcttaatttgacaccttatactgattatttcccttattttacttataatgtaaacgttcttagttatattacaaatttagcttttcaaaaaagaagaaaaatattacgtcatagtttaggtaaaatattttctgaaaaagtttttataaaattaaatattaatcccaaattaagacctgagaatatttctatattacaatattgtcagttatctaattatatgatagaaaataatattcatcaggaacatgtttgtatttaa

SEQ ID NO: 19 - DNA, 1463 bp, Candidatus Annandia pinicola
agattgaacgctggcggcatgccttacacatgcaagtcgaacggtaacaggtcttcggacgctgacgagtggcgaacgggtgagtaatacatcggaacgtgcccagtcgtgggggataactactcgaaagagtagctaataccgcatacgatctgaggatgaaagcgggggaccttcgggcctcgcgcgattggagcggccgatggcagattaggtagttggtgggataaaagcttaccaagccgacgatctgtagctggtctgagaggacgaccagccacactggaactgagatacggtccagactcttacgggaggcagcagtggggaatattgcacaatgggcgcaagcctgatgcagctatgtcgcgtgtatgaagaagaccttagggttgtaaagtactttcgatagcataagaagataatgagactaataattttattgtctgacgttagctatagaagaagcaccggctaactccgtgccagcagccgcggtaatacggggggtgctagcgttaatcggaattactgggcgtaaagagcatgtaggtggtttattaagtcagatgtgaaatccctggacttaatctaggaactgcatttgaaactaataggctagagtttcgtagagggaggtagaattctaggtgtagcggtgaaatgcatagatatctagaggaatatcagtggcgaaggcgaccttctggacgataactgacgctaaaatgcgaaagcatgggtagcaaacaggattagataccctggtagtccatgctgtaaacgatgtcgactaagaggttggaggtataacttttaatctctgtagctaacgcgttaagtcgaccgcctggggagtacggtcgcaaggctaaaactcaaatgaattgacgggggcctgcacaagcggtggagcatgtggtttaattcgatgcaacgcgtaaaaccttacctggtcttgacatccacagaattttacagaaatgtagaagtgcaatttgaactgtgagacaggtgctgcatggctgtcgtcagctcgtgttgtgaaatgttgggttaagtcccgcaacgagcgcaacccttgtcctttgttaccataagatttaaggaactcaaaggagactgccggtgataaactggaggaaggcggggacgacgtcaagtcatcatggcccttatgaccagggctacacacgtgctacaatggcatatacaaagagatgcaatattgcgaaataaagccaatcttataaaatatgtcctagttcggactggagtctgcaactcgactccacgaagtcggaatcgctagtaatcgtggatcagcatgccacggtgaatatgtttccaggccttgtacacaccgcccgtcacaccatggaagtggattgcaaaagaagtaagaaaattaaccttcttaacaaggaaataacttaccactttgtgactcataactggggtga

SEQ ID NO: 20 - DNA, 1554 bp, Moranella endobia
tctttttggtaaggaggtgatccaaccgcaggttcccctacggttaccttgttacgacttcaccccagtcatgaatcacaaagtggtaagcgccctcctaaaaggttaggctacctacttcttttgcaacccacttccatggtgtgacgggcggtgtgtacaaggcccgggaacgtattcaccgtggcattctgatccacgattactagcgattcctacttcatggagtcgagttgcagactccaatccggactacgacgcactttatgaggtccgctaactctcgcgagcttgcttctctttgtatgcgccattgtagcacgtgtgtagccctactcgtaagggccatgatgacttgacgtcatccccaccttcctccggtttatcaccggcagtctcctttgagttcccgaccgaatcgctggcaaaaaaggataagggttgcgctcgttgcgggacttaacccaacatttcacaacacgagctgacgacagccatgcagcacctgtctcagagttcccgaaggtaccaaaacatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgatttaacgcgttaactacgaaagccacagttcaagaccacagctttcaaatcgacatagtttacggcgtggactaccagggtatctaatcctgtttgctccccacgctttcgtacctgagcgtcagtattcgtccagggggccgccttcgccactggtattcctccagatatctacacatttcaccgctacacctggaattctacccccctctacgagactctagcctatcagtttcaaatgcagttcctaggttaagcccagggatttcacatctgacttaataaaccgcctacgtactctttacgcccagtaattccgattaacgcttgcaccctccgtattaccgcggctgctggcacggagttagccggtgcttcttctgtaggtaacgtcaatcaataaccgtattaaggatattgccttcctccctactgaaagtgctttacaacccgaaggccttcttcacacacgcggcatggctgcatcagggtttcccccattgtgcaatattccccactgctgcctcccgtaggagtctggaccgtgtctcagttccagtgtggctggtcatcctctcagaccagctagggatcgtcgcctaggtaagctattacctcacctactagctaatcccatctgggttcatctgaaggtgtgaggccaaaaggtcccccactttggtcttacgacattatgcggtattagctaccgtttccagcagttatccccctccatcaggcagatccccagactttactcacccgttcgctgctcgccggcaaaaaagtaaacttttttccgttgccgctcaacttgcatgtgttaggcctgccgccagcgttcaatctgagccatgatcaaactcttcaattaaa

SEQ ID NO: 21 - DNA, 1561 bp, Baumannia cicadellinicola
ttcaattgaagagtttgatcatggctcagattgaacgctggcggtaagcttaacacatgcaagtcgagcggcatcggaaagtaaattaattactttgccggcaagcggcgaacgggtgagtaatatctggggatctaccttatggagagggataactattggaaacgatagctaacaccgcataatgtcgtcagaccaaaatgggggacctaatttaggcctcatgccataagatgaacccagatgagattagctagtaggtgagataatagctcacctaggcaacgatctctagttggtctgagaggatgaccagccacactggaactgagacacggtccagactcctacgggaggcagcagtggggaatcttgcacaatgggggaaaccctgatgcagctataccgcgtgtgtgaagaaggccttcgggttgtaaagcactttcagcggggaagaaaatgaagttactaataataattgtcaattgacgttacccgcaaaagaagcaccggctaactccgtgccagcagccgcggtaagacggagggtgcaagcgttaatcggaattactgggcgtaaagcgtatgtaggcggtttatttagtcaggtgtgaaagccctaggcttaacctaggaattgcatttgaaactggtaagctagagtctcgtagagggggggagaattccaggtgtagcggtgaaatgcgtagagatctggaagaataccagtggcgaaggcgcccccctggacgaaaactgacgctcaagtacgaaagcgtggggagcaaacaggattagataccctggtagtccacgctgtaaacgatgtcgatttgaaggttgtagccttgagctatagctttcgaagctaacgcattaaatcgaccgcctggggagtacgaccgcaaggttaaaactcaaatgaattgacgggggcccgcacaagcggtggagcatgtggtttaattcgatacaacgcgaaaaaccttacctactcttgacatccagagtataaagcagaaaagctttagtgccttcgggaactctgagacaggtgctgcatggctgtcgtcagctcgtgttgtgaaatgttgggttaagtcccgcaacgagcgcaacccttatcctttgttgccaacgattaagtcgggaactcaaaggagactgccggtgataaaccggaggaaggtgaggataacgtcaagtcatcatggcccttacgagtagggctacacacgtgctacaatggtgcatacaaagagaagcaatctcgtaagagttagcaaacctcataaagtgcatcgtagtccggattagagtctgcaactcgactctatgaagtcggaatcgctagtaatcgtggatcagaatgccacggtgaatacgttcccgggccttgtacacaccgcccgtcacaccatgggagtgtattgcaaaagaagttagtagcttaactcataatacgagagggcgcttaccactttgtgattcataactggggtgaagtcgtaacaaggtaaccgtaggggaacctgcggttggatcacctccttacactaaa

SEQ ID NO: 22 - DNA, 1464 bp, Sodalis-like bacterium
attgaacgctggcggcaggcctaacacatgcaagtcgagcggcagcgggaagaagcttgcttctttgccggcgagcggcggacgggtgagtaatgtctggggatctgcccgatggagggggataactactggaaacggtagctaataccgcataacgtcgcaagaccaaagtgggggaccttcgggcctcacaccatcggatgaacccaggtgggattagctagtaggtggggtaatggctcacctaggcgacgatccctagctggtctgagaggatgaccagtcacactggaactgagacacggtccagactcctacgggaggcagcagtggggaatattgcacaatgggggaaaccctgatgcagccatgccgcgtgtgtgaagaaggccttcgggttgtaaagcactttcagcggggaggaaggcgatggcgttaatagcgctatcgattgacgttacccgcagaagaagcaccggctaactccgtgccagcagccgcggtaatacggagggtgcgagcgttaatcggaattactgggcgtaaagcgtacgcaggcggtctgttaagtcagatgtgaaatccccgggctcaacctgggaactgcatttgaaactggcaggctagagtctcgtagaggggggtagaattccaggtgtagcggtgaaatgcgtagagatctggaggaataccggtggcgaaggcggccccctggacgaagactgacgctcaggtacgaaagcgtggggagcaaacaggattagataccctggtagtccacgctgtaaacgatgtcgatttgaaggttgtggccttgagccgtggctttcggagctaacgtgttaaatcgaccgcctggggagtacggccgcaaggttaaaactcaaatgaattgacgggggcccgcacaagcggtggagcatgtggtttaattcgatgcaacgcgaagaaccttacctactcttgacatccagagaacttggcagagatgctttggtgccttcgggaactctgagacaggtgctgcatggctgtcgtcagctcgtgttgtgaaatgttgggttaagtcccgcaacgagcgcaacccttatcctttattgccagcgattcggtcgggaactcaaaggagactgccggtgataaaccggaggaaggtggggatgacgtcaagtcatcatggcccttacgagtagggctacacacgtgctacaatggcgcatacaaagagaagcgatctcgcgagagtcagcggacctcataaagtgcgtcgtagtccggattggagtctgcaactcgactccatgaagtcggaatcgctagtaatcgtggatcagaatgccacggtgaatacgttcccgggccttgtacacaccgcccgtcacaccatgggagtgggttgcaaaagaagtaggtagcttaaccttcgggagggcgcttaccactttgtgattcatgactggggtg

SEQ ID NO: 23 - DNA, 1465 bp, Candidatus Hartigia pinicola
agatttaacgctggcggcaggcctaacacatgcaagtcgagcggtaccagaagaagcttgcttcttgctgacgagcggcggacgggtgagtaatgtatggggatctgcccgacagagggggataactattggaaacggtagctaataccgcataatctctgaggagcaaagcaggggaacttcggtccttgcgctatcggatgaacccatatgggattagctagtaggtgaggtaatggctcccctaggcaacgatccctagctggtctgagaggatgatcagccacactgggactgagacacggcccagactcctacgggaggcagcagtggggaatattgcacaatgggcgaaagcctgatgcagccatgccgcgtgtatgaagaaggctttagggttgtaaagtactttcagtcgagaggaaaacattgatgctaatatcatcaattattgacgtttccgacagaagaagcaccggctaactccgtgccagcagccgcggtaatacggagggtgcaagcgttaatcggaattactgggcgtaaagcgcacgcaggcggttaattaagttagatgtgaaagccccgggcttaacccaggaatagcatataaaactggtcaactagagtattgtagaggggggtagaattccatgtgtagcggtgaaatgcgtagagatgtggaggaataccagtggcgaaggcggccccctggacaaaaactgacgctcaaatgcgaaagcgtggggagcaaacaggattagataccctggtagtccatgctgtaaacgatgtcgatttggaggttgttcccttgaggagtagcttccgtagctaacgcgttaaatcgaccgcctgggggagtacgactgcaaggttaaaactcaaatgaattgacgggggcccgcacaagcggtggagcatgtggtttaattcgatgcaacgcgaaaaaccttacctactcttgacatccagataatttagcagaaatgctttagtaccttcgggaaatctgagacaggtgctgcatggctgtcgtcagctcgtgttgtgaaatgttgggttaagtcccgcaacgagcgcaacccttatcctttgttgccagcgattaggtcgggaactcaaaggagactgccggtgataaaccggaggaaggtggggatgacgtcaagtcatcatggcccttacgagtagggctacacacgtgctacaatggcatatacaaagggaagcaacctcgcgagagcaagcgaaactcataaattatgtcgtagttcagattggagtctgcaactcgactccatgaagtcggaatcgctagtaatcgtagatcagaatgctacggtgaatacgttcccgggccttgtacacaccgcccgtcacaccatgggagtgggttgcaaaagaagtaggtaacttaaccttatggaaagcgcttaccactttgtgattcataactggggtg

SEQ ID NO: 24 - DNA, 1571 bp, Tremblaya phenacola
aggtaatccagccacaccttccagtacggctaccttgttacgacttcaccccagtcacaacccttaccttcggaactgccctcctcacaactcaaaccaccaaacacttttaaatcaggttgagagaggttaggcctgttacttctggcaagaattatttccatggtgtgacgggcggtgtgtacaagacccgagaacatattcaccgtggcatgctgatccacgattactagcaattccaacttcatgcactcgagtttcagagtacaatccgaactgaggccggctttgtgagattagctcccttttgcaagttggcaactctttggtccggccattgtatgatgtgtgaagccccacccataaaggccatgaggacttgacgtcatccccaccttcctccaacttatcgctggcagtctctttaaggtaactgactaatccagtagcaattaaagacaggggttgcgctcgttacaggacttaacccaacatctcacgacacgagctgacgacagccatgcagcacctgtgcactaattctctttcaagcactcccgcttctcaacaggatcttagccatatcaaaggtaggtaaggtttttcgcgttgcatcgaattaatccacatcatccactgcttgtgcgggtccccgtcaattcctttgagttttaaccttgcggccgtactccccaggcggtcgacttgtgcgttagctgcaccactgaaaaggaaaactgcccaatggttagtcaacatcgtttagggcatggactaccagggtatctaatcctgtttgctccccatgctttagtgtctgagcgtcagtaacgaaccaggaggctgcctacgctttcggtattcctccacatctctacacatttcactgctacatgcggaattctacctccccctctcgtactccagcctgccagtaactgccgcattctgaggttaagcctcagcctttcacagcaatcttaacaggcagcctgcacaccctttacgcccaataaatctgattaacgctcgcaccctacgtattaccgcggctgctggcacgtagtttgccggtgcttattctttcggtacagtcacaccaccaaattgttagttgggtggctttctttccgaacaaaagtgctttacaacccaaaggccttcttcacacacgcggcattgctggatcaggcttccgcccattgtccaagattcctcactgctgccttcctcagaagtctgggccgtgtctcagtcccagtgtggctggccgtcctctcagaccagctaccgatcattgccttgggaagccattacctttccaacaagctaatcagacatcagccaatctcagagcgcaaggcaattggtcccctgctttcattctgcttggtagagaactttatgcggtattaattaggctttcacctagctgtcccccactctgaggcatgttctgatgcattactcacccgtttgccacttgccaccaagcctaagcccgtgttgccgttcgacttgcatgtgtaaggcatgccgctagcgttcaatctgagccaggatcaaactct

SEQ ID NO: 25 - DNA, 1535 bp, Candidatus Tremblaya princeps
agagtttgatcctggctcagattgaacgctagcggcatgcattacacatgcaagtcgtacggcagcacgggcttaggcctggtggcgagtggcgaacgggtgagtaacgcctcggaacgtgccttgtagtgggggatagcctggcgaaagccagattaataccgcatgaagccgcacagcatgcgcggtgaaagtgggggattctagcctcacgctactggatcggccggggtctgattagctagttggcggggtaatggcccaccaaggcttagatcagtagctggtctgagaggacgatcagccacactgggactgagacacggcccagactcctacgggaggcagcagtggggaatcttggacaatgggcgcaagcctgatccagcaatgccgcgtgtgtgaagaaggccttcgggtcgtaaagcacttttgttcgggatgaaggggggcgtgcaaacaccatgccctcttgacgataccgaaagaataagcaccggctaactacgtgccagcagccgcggtaatacgtagggtgcgagcgttaatcggaatcactgggcgtaaagggtgcgcgggtggtttgccaagacccctgtaaaatcctacggcccaaccgtagtgctgcggaggttactggtaagcttgagtatggcagaggggggtagaattccaggtgtagcggtgaaatgcgtagatatctggaggaataccgaaggcgaaggcaaccccctgggccatcactgacactgaggcacgaaagcgtggggagcaaacaggattagataccctggtagtccacgccctaaaccatgtcgactagttgtcggggggagccctttttcctcggtgacgaagctaacgcatgaagtcgaccgcctggggagtacgaccgcaaggttaaaactcaaaggaattgacggggacccgcacaagcggtggatgatgtggattaattcgatgcaacgcgaaaaaccttacctacccttgacatggcggagattctgccgagaggcggaagtgctcgaaagagaatccgtgcacaggtgctgcatggctgtcgtcagctcgtgtcgtgagatgttgggttaagtcccataacgagcgcaacccccgtctttagttgctaccactggggcactctatagagactgccggtgataaaccggaggaaggtggggacgacgtcaagtcatcatggcctttatgggtagggcttcacacgtcatacaatggctggagcaaagggtcgccaactcgagagagggagctaatcccacaaacccagccccagttcggattgcactctgcaactcgagtgcatgaagtcggaatcgctagtaatcgtggatcagcatgccacggtgaatacgttctcgggtcttgtacacaccgcccgtcacaccatgggagtaagccgcatcagaagcagcctccctaaccctatgctgggaaggaggctgcgaaggtggggtctatgactggggtgaagtcgtaacaaggtagccgtaccggaaggtgcggctggattacct

SEQ ID NO: 26 - DNA, 1450 bp, Nasuia deltocephalinicola
agtttaatcctggctcagatttaacgcttgcgacatgcctaacacatgcaagttgaacgttgaaaatatttcaaagtagcgtataggtgagtataacatttaaacataccttaaagttcggaataccccgatgaaaatcggtataataccgtataaaagtatttaagaattaaagcggggaaaacctcgtgctataagattgttaaatgcctgattagtttgttggtttttaaggtaaaagcttaccaagactttgatcagtagctattctgtgaggatgtatagccacattgggattgaaataatgcccaaacctctacggagggcagcagtggggaatattggacaatgagcgaaagcttgatccagcaatgtcgcgtgtgcgattaagggaaactgtaaagcacttttttttaagaataagaaattttaattaataattaaaatttttgaatgtattaaaagaataagtaccgactaatcacgtgccagcagtcgcggtaatacgtggggtgcgagcgttaatcggatttattgggcgtaaagtgtattcaggctgcttaaaaagatttatattaaatatttaaattaaatttaaaaaatgtataaattactattaagctagagtttagtataagaaaaaagaattttatgtgtagcagtgaaatgcgttgatatataaaggaacgccgaaagcgaaagcatttttctgtaatagaactgacgcttatatacgaaagcgtgggtagcaaacaggattagataccctggtagtccacgccctaaactatgtcaattaactattagaattttttttagtggtgtagctaacgcgttaaattgaccgcctgggtattacgatcgcaagattaaaactcaaaggaattgacggggaccagcacaagcggtggatgatgtggattaattcgatgatacgcgaaaaaccttacctgcccttgacatggttagaattttattgaaaaataaaagtgcttggaaaagagctaacacacaggtgctgcatggctgtcgtcagctcgtgtcgtgagatgttgggttaagtcccgcaacgagcgcaacccctactcttagttgctaattaaagaactttaagagaacagctaacaataagtttagaggaaggaggggatgacttcaagtcctcatggcccttatgggcagggcttcacacgtcatacaatggttaatacaaaaagttgcaatatcgtaagattgagctaatctttaaaattaatcttagttcggattgtactctgcaactcgagtacatgaagttggaatcgctagtaatcgcggatcagcatgccgcggtgaatagtttaactggtcttgtacacaccgcccgtcacaccatggaaataaatcttgttttaaatgaagtaatatattttatcaaaacaggttttgtaaccggggtgaagtcgtaaca

SEQ ID NO: 27 - DNA, 1536 bp, Candidatus Zinderia insecticola CARI
atataaataagagtttgatcctggctcagattgaacgctagcggtatgctttacacatgcaagtcgaacgacaatattaaagcttgctttaatataaagtggcgaacgggtgagtaatatatcaaaacgtaccttaaagtgggggataactaattgaaaaattagataataccgcatattaatcttaggatgaaaataggaataatatcttatgcttttagatcggttgatatctgattagctagttggtagggtaaatgcttaccaaggcaatgatcagtagctggttttagcgaatgatcagccacactggaactgagacacggtccagacttctacggaaggcagcagtggggaatattggacaatgggagaaatcctgatccagcaataccgcgtgagtgatgaaggccttagggtcgtaaaactcttttgttaggaaagaaataattttaaataatatttaaaattgatgacggtacctaaagaataagcaccggctaactacgtgccagcagccgcggtaatacgtagggtgcaagcgttaatcggaattattgggcgtaaagagtgcgtaggctgttatataagatagatgtgaaatacttaagcttaacttaagaactgcatttattactgtttaactagagtttattagagagaagtggaattttatgtgtagcagtgaaatgcgtagatatataaaggaatatcgatggcgaaggcagcttcttggaataatactgacgctgaggcacgaaagcgtggggagcaaacaggattagataccctggtagtccacgccctaaactatgtctactagttattaaattaaaaataaaatttagtaacgtagctaacgcattaagtagaccgcctggggagtacgatcgcaagattaaaactcaaaggaattgacggggacccgcacaagcggtggatgatgtggattaattcgatgcaacacgaaaaaccttacctactcttgacatgtttggaattttaaagaaatttaaaagtgcttgaaaaagaaccaaaacacaggtgctgcatggctgtcgtcagctcgtgtcgtgagatgttgggttaagtcccgcaacgagcgcaacccttgttattatttgctaataaaaagaactttaataagactgccaatgacaaattggaggaaggtggggatgacgtcaagtcctcatggcccttatgagtagggcttcacacgtcatacaatgatatatacaatgggtagcaaatttgtgaaaatgagccaatccttaaagtatatcttagttcggattgtagtctgcaactcgactacatgaagttggaatcgctagtaatcgcggatcagcatgccgcggtgaatacgttctcgggtcttgtacacaccgcccgtcacaccatggaagtgatttttaccagaaattatttgtttaacctttattggaaaaaaataattaaggtagaattcatgactggggtgaagtcgtaacaaggtagcagtatcggaaggtgcggctggattacattttaaat

SEQ ID NO: 28 - DNA, 1423 bp, Hodgkinia
aatgctggcggcaggcctaacacatgcaagtcgagcggacaacgttcaaacgttgttagcggcgaacgggtgagtaatacgtgagaatctacccatcccaacgtgataacatagtcaacaccatgtcaataacgtatgattcctgcaacaggtaaagattttatcggggatggatgagctcacgctagattagctagttggtgagataaaagcccaccaaggccaagatctatagctggtctggaaggatggacagccacattgggactgagacaaggcccaaccctctaaggagggcagcagtgaggaatattggacaatgggcgtaagcctgatccagccatgccgcatgagtgattgaaggtccaacggactgtaaaactcttttctccagagatcataaatgatagtatctggtgatataagctccggccaacttcgtgccagcagccgcggtaatacgaggggagcgagtattgttcggttttattgggcgtaaagggtgtccaggttgctaagtaagttaacaacaaaatcttgagattcaacctcataacgttcggttaatactactaagctcgagcttggatagagacaaacggaattccgagtgtagaggtgaaattcgttgatacttggaggaacaccagaggcgaaggcggtttgtcataccaagctgacactgaagacacgaaagcatggggagcaaacaggattagataccctggtagtccatgccctaaacgttgagtgctaacagttcgatcaagccacatgctatgatccaggattgtacagctaacgcgttaagcactccgcctgggtattacgaccgcaaggttaaaactcaaaggaattgacggagacccgcacaagcggtggagcatgtggtttaattcgaagctacacgaagaaccttaccagcccttgacataccatggccaaccatcctggaaacaggatgttgttcaagttaaacccttgaaatgccaggaacaggtgctgcatggctgttgtcagttcgtgtcgtgagatgtatggttaagtcccaaaacgaacacaaccctcacccatagttgccataaacacaattgggttctctatgggtactgctaacgtaagttagaggaaggtgaggaccacaacaagtcatcatggcccttatgggctgggccacacacatgctacaatggtggttacaaagagccgcaacgttgtgagaccgagcaaatctccaaagaccatctcagtccggattgtactctgcaacccgagtacatgaagtaggaatcgctagtaatcgtggatcagcatgccacggtgaatacgttctcgggtcttgtacacgccgcccgtcacaccatgggagcttcgctccgatcgaagtcaagttacccttgaccacatcttggcaagtgaccga

SEQ ID NO: 29 - DNA, 1504 bp, Wolbachia strain wPip
aaatttgagagtttgatcctggctcagaatgaacgctggcggcaggcctaacacatgcaagtcgaacggagttatattgtagcttgctatggtataacttagtggcagacgggtgagtaatgtataggaatctacctagtagtacggaataattgttggaaacgacaactaataccgtatacgccctacgggggaaaaatttattgctattagatgagcctatattagattagctagttggtggggtaatagcctaccaaggtaatgatctatagctgatctgagaggatgatcagccacactggaactgagatacggtccagactcctacgggaggcagcagtggggaatattggacaatgggcgaaagcctgatccagccatgccgcatgagtgaagaaggcctttgggttgtaaagctcttttagtgaggaagataatgacggtactcacagaagaagtcctggctaactccgtgccagcagccgcggtaatacggagagggctagcgttattcggaattattgggcgtaaagggcgcgtaggctggttaataagttaaaagtgaaatcccgaggcttaaccttggaattgcttttaaaactattaatctagagattgaaagaggatagaggaattcctgatgtagaggtaaaattcgtaaatattaggaggaacaccagtggcgaaggcgtctatctggttcaaatctgacgctgaagcgcgaaggcgtggggagcaaacaggattagataccctggtagtccacgctgtaaacgatgaatgttaaatatggggagtttactttctgtattacagctaacgcgttaaacattccgcctggggactacggtcgcaagattaaaactcaaaggaattgacggggacccgcacaagcggtggagcatgtggtttaattcgatgcaacgcgaaaaaccttaccacttcttgacatgaaaatcatacctattcgaagggatagggtcggttcggccggattttacacaagtgttgcatggctgtcgtcagctcgtgtcgtgagatgttgggttaagtcccgcaacgagcgcaaccctcatccttagttgccatcaggtaatgctgagtactttaaggaaactgccagtgataagctggaggaaggtggggatgatgtcaagtcatcatggcctttatggagtgggctacacacgtgctacaatggtgtctacaatgggctgcaaggtgcgcaagcctaagctaatccctaaaagacatctcagttcggattgtactctgcaactcgagtacatgaagttggaatcgctagtaatcgtggatcagcatgccacggtgaatacgttctcgggtcttgtacacactgcccgtcacgccatgggaattggtttcactcgaagctaatggcctaaccgcaaggaaggagttatttaaagtgggatcagtgactggggtgaagtcgtaacaaggtagcagtaggggaatctgcagctggattacctcctta

SEQ ID NO: 30 - DNA, 1532 bp, Candidatus Uzinura diaspidicola
aaaggagatattccaaccacaccttccggtacggttaccttgttacgacttagccctagtcatcaagtttaccttaggcagaccactgaaggattactgacttcaggtacccccgactcccatggcttgacgggcggtgtgtacaaggttcgagaacatattcaccgcgccattgctgatgcgcgattactagcgattcctgcttcatagagtcgaattgcagactccaatccgaactgagactggttttagagattagctcctgatcacccagtggctgccctttgtaaccagccattgtagcacgtgtgtagcccaaggcatagaggccatgatgatttgacatcatccccaccttcctcacagtttacaccggcagttttgttagagtccccggctttacccgatggcaactaacaataggggttgcgctcgttataggacttaaccaaacacttcacagcacgaactgaagacaaccatgcagcaccttgtaatacgtcgtatagactaagctgtttccagcttattcgtaatacatttaagccttggtaaggttcctcgcgtatcatcgaattaaaccacatgctccaccgcttgtgcgaacccccgtcaattcctttgagtttcaatcttgcgactgtacttcccaggtggatcacttatcgctttcgctaagccactgaatatcgtttttccaatagctagtgatcatcgtttagggcgtggactaccagggtatctaatcctgtttgctccccacgctttcgtgcactgagcgtcagtaaagatttagcaacctgccttcgctatcggtgttctgtatgatatctatgcatttcaccgctacaccatacattccagatgctccaatcttactcaagtttaccagtatcaatagcaattttacagttaagctgtaagctttcactactgacttaataaacagcctacacaccctttaaacccaataaatccgaataacgcttgtgtcatccgtattgccgcggctgctggcacggaattagccgacacttattcgtatagtaccttcaatctcctatcacgtaagatattttatttctatacaaaagcagtttacaacctaaaagaccttcatcctgcacgcgacgtagctggttcagagtttcctccattgaccaatattcctcactgctgcctcccgtaggagtctggtccgtgtctcagtaccagtgtggaggtacaccctcttaggccccctactgatcatagtcttggtagagccattacctcaccaactaactaatcaaacgcaggctcatcttttgccacctaagttttaataaaggctccatgcagaaactttatattatgggggattaatcagaatttcttctggctataccccagcaaaaggtagattgcatacgtgttactcacccattcgccggtcgccgacaaattaaaaatttttcgatgcccctcgacttgcatgtgttaagctcgccgctagcgttaattctgagccaggatcaaactcttcgttgtag

SEQ ID NO: 31 - DNA, 1470 bp, Sulcia muelleri
ctcaggataaacgctagcggagggcttaacacatgcaagtcgaggggcagcaaaaataattatttttggcgaccggcaaacgggtgagtaatacatacgtaactttccttatgctgaggaatagcctgaggaaacttggattaatacctcataatacaattttttagaaagaaaaattgttaaagttttattatggcataagataggcgtatgtccaattagttagttggtaaggtaatggcttaccaagacgatgattggtagggggcctgagaggggcgttcccccacattggtactgagacacggaccaaacttctacggaaggctgcagtgaggaatattggtcaatggaggaaactctgaaccagccactccgcgtgcaggatgaaagaaagccttattggttgtaaactgcttttgtatatgaataaaaaattctaattatagaaataattgaaggtaatatacgaataagtatcgactaactctgtgccagcagtcgcggtaagacagaggatacaagcgttatccggatttattgggtttaaagggtgcgtaggcggtttttaaagtcagtagtgaaatcttaaagcttaactttaaaagtgctattgatactgaaaaactagagtaaggttggagtaactggaatgtgtggtgtagcggtgaaatgcatagatatcacacagaacaccgatagcgaaagcaagttactaaccctatactgacgctgagtcacgaaagcatggggagcaaacaggattagataccctggtagtccatgccgtaaacgatgatcactaactattgggttttatacgttgtaattcagtggtgaagcgaaagtgttaagtgatccacctgaggagtacgaccgcaaggttgaaactcaaaggaattgacgggggcccgcacaatcggtggagcatgtggtttaattcgatgatacacgaggaaccttaccaagacttaaatgtactacgaataaattggaaacaatttagtcaagcgacggagtacaaggtgctgcatggttgtcgtcagctcgtgccgtgaggtgtaaggttaagtcctttaaacgagcgcaacccttattattagttgccatcgagtaatgtcaggggactctaataagactgccggcgcaagccgagaggaaggtggggatgacgtcaaatcatcacggcccttacgtcttgggccacacacgtgctacaatgatcggtacaaaagggagcgactgggtgaccaggagcaaatccagaaagccgatctaagttcggattggagtctgaaactcgactccatgaagctggaatcgctagtaatcgtgcatcagccatggcacggtgaatatgttcccgggccttgtacacaccgcccgtcaagccatggaagttggaagtacctaaagttggttcgctacctaaggtaagtctaataactggggctaagtcgtaacaaggta

SEQ ID NO: 32 - DNA, 1761 bp, Symbiotaphrina buchneri voucher JCM9740
  misc_feature (30)..(30): n is a, c, g, or t
  misc_feature (40)..(40): n is a, c, g, or t
agattaagccatgcaagtctaagtataagnaatctatacngtgaaactgcgaatggctcattaaatcagttatcgtttatttgatagtaccttactacatggataaccgtggtaattctagagctaatacatgctaaaaaccccgacttcggaaggggtgtatttattagataaaaaaccaatgcccttcggggctccttggtgattcatgataacttaacgaatcgcatggccttgcgccggcgatggttcattcaaatttctgccctatcaactttcgatggtaggatagtggcctaccatggttttaacgggtaacggggaattagggttcgattccggagagggagcctgagaaacggctaccacatccaaggaaggcagcaggcgcgcaaattacccaatcccgacacggggaggtagtgacaataaatactgatacagggctcttttgggtcttgtaattggaatgagtacaatttaaatcccttaacgaggaacaattggagggcaagtctggtgccagcagccgcggtaattccagctccaatagcgtatattaaagttgttgcagttaaaaagctcgtagttgaaccttgggcctggctggccggtccgcctaaccgcgtgtactggtccggccgggcctttccttctggggagccgcatgcccttcactgggtgtgtcggggaaccaggacttttactttgaaaaaattagagtgttcaaagcaggcctatgctcgaatacattagcatggaataatagaataggacgtgcggttctattttgttggtttctaggaccgccgtaatgattaatagggatagtcgggggcatcagtattcaattgtcagaggtgaaattcttggatttattgaagactaactactgcgaaagcatttgccaaggatgttttcattaatcagtgaacgaaagttaggggatcgaagacgatcagataccgtcgtagtcttaaccataaactatgccgactagggatcgggcgatgttattattttgactcgctcggcaccttacgagaaatcaaagtctttgggttctggggggagtatggtcgcaaggctgaaacttaaagaaattgacggaagggcaccaccaggagtggagcctgcggcttaatttgactcaacacggggaaactcaccaggtccagacacattaaggattgacagattgagagctctttcttgattatgtgggtggtggtgcatggccgttcttagttggtggagtgatttgtctgcttaattgcgataacgaacgagaccttaacctgctaaatagcccggtccgctttggcgggccgctggcttcttagagggactatcggctcaagccgatggaagtttgaggcaataacaggtctgtgatgcccttagatgttctgggccgcacgcgcgctacactgacagagccaacgagtaaatcaccttggccggaaggtctgggtaatcttgttaaactctgtcgtgctggggatagagcattgcaattattgctcttcaacgaggaattcctagtaagcgcaagtcatcagcttgcgctgattacgtccctgccctttgtacacaccgcccgtcgctactaccgattgaatggctcagtgaggccttcggactggcacagggacgttggcaacgacgacccagtgccggaaagttggtcaaacttggtcatttagaggaagtaaaagtcgtaacaaggtttccgtaggtgaacctgcggaaggatcatta

SEQ ID NO: 33 - DNA, 1801 bp, Symbiotaphrina kochii voucher CBS 589.63
  misc_feature (1753)..(1755): n is a, c, g, or t
tacctggttgattctgccagtagtcatatgcttgtctcaaagattaagccatgcaagtctaagtataagcaatctatacggtgaaactgcgaatggctcattaaatcagttatcgtttatttgatagtaccttactacatggataaccgtggtaattctagagctaatacatgctaaaaacctcgacttcggaaggggtgtatttattagataaaaaaccaatgcccttcggggctccttggtgattcatgataacttaacgaatcgcatggccttgcgccggcgatggttcattcaaatttctgccctatcaactttcgatggtaggatagtggcctaccatggtttcaacgggtaacggggaattagggttcgattccggagagggagcctgagaaacggctaccacatccaaggaaggcagcaggcgcgcaaattacccaatcccgacacggggaggtagtgacaataaatactgatacagggctcttttgggtcttgtaattggaatgagtacaatttaaatcccttaacgaggaacaattggagggcaagtctggtgccagcagccgcggtaattccagctccaatagcgtatattaaagttgttgcagttaaaaagctcgtagttgaaccttgggcctggctggccggtccgcctaaccgcgtgtactggtccggccgggcctttccttctggggagccgcatgcccttcactgggtgtgtcggggaaccaggacttttactttgaaaaaattagagtgttcaaagcaggcctatgctcgaatacattagcatggaataatagaataggacgtgtggttctattttgttggtttctaggaccgccgtaatgattaatagggatagtcgggggcatcagtattcaattgtcagaggtgaaattcttggatttattgaagactaactactgcgaaagcatttgccaaggatgttttcattaatcagtgaacgaaagttaggggatcgaagacgatcagataccgtcgtagtcttaaccataaactatgccgactagggatcgggcgatgttattattttgactcgctcggcaccttacgagaaatcaaagtctttgggttctggggggagtatggtcgcaaggctgaaacttaaagaaattgacggaagggcaccaccaggagtggagcctgcggcttaatttgactcaacacggggaaactcaccaggtccagacacattaaggattgacagattgagagctctttcttgattatgtgggtggtggtgcatggccgttcttagttggtggagtgatttgtctgcttaattgcgataacgaacgagaccttaacctgctaaatagcccggtccgctttggcgggccgctggcttcttagagggactatcggctcaagccgatggaagtttgaggcaataacaggtctgtgatgcccttagatgttctgggccgcacgcgcgctacactgacagagccaacgagtacatcaccttggccggaaggtctgggtaatcttgttaaactctgtcgtgctggggatagagcattgcaattattgctcttcaacgaggaattcctagtaagcgcaagtcatcagcttgcgctgattacgtccctgccctttgtacacaccgcccgtcgctactaccgattgaatggctcagtgaggccttcggactggcacagggacgttggcaacgacgacccagtgccggaaagttcgtcaaacttggtcatttagaggaagnnnaagtcgtaacaaggtttccgtaggtgaacctgcggaaggatcatta

SEQ ID NO: 34 - DNA, 1490 bp, Burkholderia strain SFA1
agtttgatcctggctcagattgaacgctggcggcatgccttacacatgcaagtcgaacggcagcacgggggcaaccctggtggcgagtggcgaacgggtgagtaatacatcggaacgtgtcctgtagtgggggatagcccggcgaaagccggattaataccgcatacgacctaagggagaaagcgggggatcttcggacctcgcgctataggggcggccgatggcagattagctagttggtggggtaaaggcctaccaaggcgacgatctgtagctggtctgagaggacgaccagccacactgggactgagacacggcccagactcctacgggaggcagcagtggggaattttggacaatgggggcaaccctgatccagcaatgccgcgtgtgtgaagaaggcttcgggttgtaaagcacttttgtccggaaagaaaacttcgtccctaatatggatggaggatgacggtaccggaagaataagcaccggctaactacgtgccagcagccgcggtaatacgtagggtgcgagcgttaatcggaattactgggcgtaaagcgtgcgcaggcggtctgttaagaccgatgtgaaatccccgggcttaacctgggaactgcattggtgactggcaggctttgagtgtggcagaggggggtagaattccacgtgtagcagtgaaatgcgtagagatgtggaggaataccgatggcgaaggcagccccctgggccaactactgacgctcatgcacgaaagcgtggggagcaaacaggattagataccctggtagtccacgccctaaacgatgtcaactagttgttggggattcatttccttagtaacgtagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatggtcggaaccctgctgaaaggtgggggtgctcgaaagagaaccggcgcacaggtgctgcatggctgtcgtcagctcgtgtcgtgagatgttgggttaagtcccgcaacgagcgcaacccttgtccttagttgctacgcaagagcactctaaggagactgccggtgacaaaccggaggaaggtggggatgacgtcaagtcctcatggcccttatgggtagggcttcacacgtcatacaatggtcggaacagagggttgccaagccgcgaggtggagccaatcccagaaaaccgatcgtagtccggatcgcagtctgcaactcgactgcgtgaagctggaatcgctagtaatcgcggatcagcatgccgcggtgaatacgttcccgggtcttgtacacaccgcccgtcacaccatgggagtgggtttcaccagaagtaggtagcctaaccgcaaggagggcgcttaccacggtgggattcatgactggggtgaagtcgtaacaaggtagc

SEQ ID NO: 35 - DNA, 1408 bp, Burkholderia strain KM-A
gcaaccctggtggcgagtggcgaacgggtgagtaatacatcggaacgtgtcctgtagtgggggatagcccggcgaaagccggattaataccgcatacgatctacggaagaaagcgggggatccttcgggacctcgcgctataggggcggccgatggcagattagctagttggtggggtaaaggcctaccaaggcgacgatctgtagctggtctgagaggacgaccagccacactgggactgagacacggcccagactcctacgggaggcagcagtggggaattttggacaatgggggcaaccctgatccagcaatgccgcgtgtgtgaagaaggccttcgggttgtaaagcacttttgtccggaaagaaaacgtcttggttaatacctgaggcggatgacggtaccggaagaataagcaccggctaactacgtgccagcagccgcggtaatacgtagggtgcgagcgttaatcggaattactgggcgtaaagcgtgcgcaggcggtctgttaagaccgatgtgaaatccccgggcttaacctgggaactgcattggtgactggcaggctttgagtgtggcagaggggggtagaattccacgtgtagcagtgaaatgcgtagagatgtggaggaataccgatggcgaaggcagccccctgggccaacactgacgctcatgcacgaaagcgtggggagcaaacaggattagataccctggtagtccacgccctaaacgatgtcaactagttgttggggattcatttccttagtaacgtagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatggtcggaagtctgctgagaggtggacgtgctcgaaagagaaccggcgcacaggtgctgcatggctgtcgtcagctcgtgtcgtgagatgttgggttaagtcccgcaacgagcgcaacccttgtccttagttgctacgcaagagcactctaaggagactgccggtgacaaaccggaggaaggtggggatgacgtcaagtcctcatggcccttatgggtagggcttcacacgtcatacaatggtcggaacagagggttgccaagccgcgaggtggagccaatcccagaaaaccgatcgtagtccggatcgcagtctgcaactcgactgcgtgaagctggaatcgctagtaatcgcggatcagcatgccgcggtgaatacgttcccgggtcttgtacacaccgcccgtcacaccatgggagtgggtttcaccagaagtaggtagcctaaccgcaaggagggcgcttaccacggtgggattcatgactggggtgaagt

SEQ ID NO: 36 - DNA, 1383 bp, Burkholderia strain KM-G
gcaaccctggtggcgagtggcgaacgggtgagtaatacatcggaacgtgtcctgtagtgggggatagcccggcgaaagccggattaataccgcatacgacctaagggagaaagcgggggatcttcggacctcgcgctataggggcggccgatggcagattagctagttggtggggtaaaggcctaccaaggcgacgatctgtagctggtctgagaggacgaccagccacactgggactgagacacggcccagactcctacgggaggcagcagtggggaattttggacaatgggggcaaccctgatccagcaatgccgcgtgtgtgaagaaggccttcgggttgtaaagcacttttgtccggaaagaaaacttcgaggttaatacccttggaggatgacggtaccggaagaataagcaccggctaactacgtgccagcagccgcggtaatacgtagggtgcgagcgttaatcggaattactgggcgtaaagcgtgcgcaggcggtctgttaagaccgatgtgaaatccccgggcttaacctgggaactgcattggtgactggcaggctttgagtgtggcagaggggggtagaattccacgtgtagcagtgaaatgcgtagagatgtggaggaataccgatggcgaaggcagccccctgggccaacactgacgctcatgcacgaaagcgtggggagcaaacaggattagataccctggtagtccacgccctaaacgatgtcaactagttgttggggattcatttccttagtaacgtagctaacgcgtgaagttgaccgcctggggagtacggtcgcaagattaaaactcaaaggaattgacggggacccgcacaagcggtggatgatgtggattaattcgatgcaacgcgaaaaaccttacctacccttgacatggtcggaagtctgctgagaggtggacgtgctcgaaagagaaccggcgcacaggtgctgcatggctgtcgtcagctcgtgtcgtgagatgttgggttaagtcccgcaacgagcgcaacccttgtccttagttgctacgcaagagcactctaaggagactgccggtgacaaaccggaggaaggtggggatgacgtcaagtcctcatggcccttatgggtagggcttcacacgtcatacaatggtcggaacagagggttgccaagccgcgaggtggagccaatcccagaaaaccgatcgtagtccggatcgcagtctgcaactcgactgcgtgaagctggaatcgctagtaatcgcggatcagcatgccgcggtgaatacgttcccgggtcttgtacacaccgcccgtcacaccatgggagtgggtttcaccagaagtaggtagcctaacctgcaaaggagggcgcttaccacg

SEQ ID NO: 37 - DNA, 1566 bp, Buchnera aphidicola str. Bp (Baizongia pistaciae)
acttaaaattgaagagtttgatcatggctcagattgaacgctggcggcaagcttaacacatgcaagtcgagcggcatcgaagaaaagtttacttttctggcggcgagcggcaaacgggtgagtaacatctggggatctacctaaaagagggggacaaccattggaaacgatggctaataccgcataatgtttttaaataaaccaaagtaggggactaaaatttttagccttatgcttttagatgaacccagacgagattagcttgatggtaaggtaatggcttaccaaggcgacgatctctagctggtctgagaggataaccagccacactggaactgagatacggtccagactcctacgggaggcagcagtggggaatattgcacaatgggctaaagcctgatgcagctatgccgcgtgtatgaagaaggccttagggttgtaaagtactttcagcggggaggaaagaattatgtctaatatacatattttgtgacgttacccgaagaagaagcaccggctaactccgtgccagcagccgcggtaatacggagggtgcgagcgttaatcagaattactgggcgtaaagagcacgtaggcggtttattaagtcagatgtgaaatccctaggcttaacttaggaactgcatttgaaactaatagactagagtctcatagagggaggtagaattctaggtgtagcggtgaaatgcgtagatatctagaggaatacccgtggcgaaagcgacctcctaaatgaaaactgacgctgaggtgcgaaagcgtggggagcaaacaggattagataccctggtagtccatgctgtaaacgatgtcgacttggaggttgtttcctagagaagtggcttccgaagctaacgcattaagtcgaccgcctggggagtacggtcgcaaggctaaaactcaaatgaattgacgggggcccgcacaagcggtggagcatgtggtttaattcgatgcaacgcgaagaaccttacctggtcttgacatccatagaattttttagagataaaagagtgccttagggaactatgagacaggtgctgcatggctgtcgtcagctcgtgttgtgaaatgttgggttaagtcccgcaacgagcgcaacccctatcctttgttgccatcaggttatgctgggaactcagaggagactgccggttataaaccggaggaaggtggggatgacgtcaagtcatcatggcccttacgaccagggctacacacgtgctacaatggcatatacaaagagatgcaactctgcgaagataagcaaacctcataaagtatgtcgtagtccggactggagtctgcaactcgactccacgaagtaggaatcgctagtaatcgtggatcagaatgccacggtgaatacgttcccgggccttgtacacaccgcccgtcacaccatgggagtgggttgcaaaagaagcaggtagcttaaccagattattttattggagggcgcttaccactttgtgattcatgactggggtgaagtcgtaacaaggtaaccgtaggggaacctgcggttggatcacctcctta

SEQ ID NO: 38 - DNA, 1539 bp, Ishikawaella capsulata Mpkobe
aaattgaagagtttgatcatggctcagattgaacgctagcggcaagcttaacacatgcaagtcgaacggtaacagaaaaaagcttgcttttttgctgacgagtggcggacgggtgagtaatgtctggggatctacctaatggcgggggataactactggaaacggtagctaataccgcataatgttgtaaaaccaaagtgggggaccttatggcctcacaccattagatgaacctagatgggattagcttgtaggtggggtaaaggctcacctaggcaacgatccctagctggtctgagaggatgaccagccacactggaactgagatacggtccagactcctacgggaggcagcagtggggaatcttgcacaatgggcgcaagcctgatgcagctatgtcgcgtgtatgaagaaggccttagggttgtaaagtactttcatcggggaagaaggatatgagcctaatattctcatatattgacgttacctgcagaagaagcaccggctaactccgtgccagcagccgcggtaacacggagggtgcgagcgttaatcggaattactgggcgtaaagagcacgtaggtggtttattaagtcatatgtgaaatccctgggcttaacctaggaactgcatgtgaaactgataaactagagtttcgtagagggaggtggaattccaggtgtagcggtgaaatgcgtagatatctggaggaatatcagaggcgaaggcgaccttctggacgaaaactgacactcaggtgcgaaagcgtggggagcaaacaggattagataccctggtagtccacgctgtaaacaatgtcgactaaaaaactgtgagcttgacttgtggtttttgtagctaacgcattaagtcgaccgcctggggagtacggccgcaaggttaaaactcaaatgaattgacgggggtccgcacaagcggtggagcatgtggtttaattcgatgcaacgcgaaaaaccttacctggtcttgacatccagcgaattatatagaaatatataagtgcctttcggggaactctgagacgctgcatggctgtcgtcagctcgtgttgtgaaatgttgggttaagtcccgcaacgagcgcccttatcctctgttgccagcggcatggccgggaactcagaggagactgccagtattaaactggaggaaggtggggatgacgtcaagtcatcatggcccttatgaccagggctacacacgtgctacaatggtgtatacaaagagaagcaatctcgcaagagtaagcaaaactcaaaaagtacatcgtagttcggattagagtctgcaactcgactctatgaagtaggaatcgctagtaatcgtggatcagaatgccacggtgaatacgttctctggccttgtacacaccgcccgtcacaccatgggagtaagttgcaaaagaagtaggtagcttaacctttataggagggcgcttaccactttgtgatttatgactggggtgaagtcgtaacaaggtaactgtaggggaacctgtggttggattacctcctta